(19) United States
(12) Patent Application Publication
(10) Pub. No.: US 2007/0244073 A1
(43) Pub. Date: Oct. 18, 2007

(54) Pesticidal Mixtures

(75) Inventors: Max Angst, Basel (CH); Ana Cristina Dutton, Stein (CH)

Correspondence Address: SYNGENTA CROP PROTECTION , INC.;PATENT AND TRADEMARK DEPARTMENT, 410 SWING ROAD, GREENSBORO, NC, 27409, US

(73) Assignee: SYNGENTA CROP PROTECTION, INC., Greensboro, NC (US)

(21) Appl. No.: 11/568,859

(22) PCT Filed: May 10, 2005
(86) PCT No.: PCT/EP05/05058

§ 371 Date: Jul. 2, 2007

(30) Foreign Application Priority Data
May 10, 2004 (CH) 00834/04

(51) Int. Cl. A01N 43/40; A01N 43/66; A01N 57/10

(52) U.S. Cl. 514/86; 514/245; 514/341

(57) ABSTRACT

The invention relates to a pesticidal composition comprising as active ingredient a mixture consisting of one antranil-amide compound (A) as defined in the patent claims and at least one compound (B) as defined in the patent claims, to a process for the preparation of and to the use of such a composition, to a method of controlling pests using such a composition and to plant propagation material treated with such a composition.

The invention relates to a pesticidal composition comprising as active ingredient a mixture consisting of at least two substances, to a process for the preparation of and to the use of such a composition, to a method of controlling pests using such a composition, to plant propagation material treated with such a composition, to the use of a compound (A) as mentioned hereinbelow in the preparation of such a composition and to the use of a compound (B) as mentioned hereinbelow in the preparation of such a composition.

Certain pesticidal compositions are proposed in the literature, for example in WO 03/015518. The properties of those known compositions in the field of pest control are not, however, entirely satisfactory, for which reason there is a need to make available further compositions having pesticidal properties, that problem being solved in accordance with the invention by provision of the present pesticidal compositions.

The invention accordingly relates to {1} a pesticidal composition comprising as active ingredient a mixture consisting of at least two substances, namely a compound (A) as mentioned hereinbelow and one or more than one compound (B) as mentioned hereinbelow.

A preferred embodiment of the subject-matter {1} of the invention is {1.1.1} a pesticidal composition comprising as active ingredient a mixture consisting of at least two active substances, namely one compound (A) as mentioned hereinbelow and at least one compound (B) as mentioned hereinbelow.

A preferred embodiment of the subject-matter {1.1} of the invention is {1.1.1} a pesticidal composition comprising a mixture consisting of at least two substances, namely one compound (A) and at least one compound (B), as active ingredient and at least one auxiliary, wherein the compound (A) is the compound of formula (A-1) 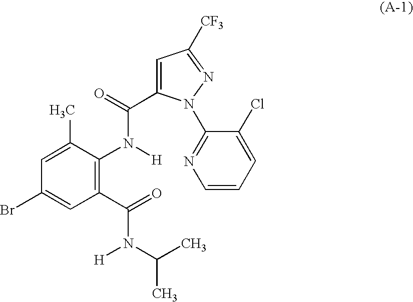
and the compound (B) is a compound selected from the group of substances consisting of an adjuvant, an acaricide, an algicide, an anthelmintic, an avicide, a bactericide, a biological agent, a soil sterilant, a chemosterilant, an insect pheromone, an insect repellent, an insecticide, a molluscicide, a nematicide, a nitrification inhibitor, a plant activator, a rodenticide, a synergist, an animal repellent, a virucide and a wound protectant.

An especially preferred embodiment of the subject-matter {1.1.1} of the invention is {1.1.1.1} a pesticidal composition comprising a mixture consisting of at least two substances, namely one compound (A) and at least one compound (B), as active ingredient and at least one auxiliary, wherein the compound (A) is the compound of formula (A-1) and the compound (B) is a compound selected from the group of substances consisting of
an adjuvant selected from the group of substances consisting of petroleum oils (alternative name) (628),
an acaricide selected from the group of substances consisting of 1,1-bis(4-chlorophenyl)-2-ethoxyethanol (IUPAC name) (910), 2,4-dichlorophenyl benzenesulfonate (IUPAC/Chemical Abstracts name) (1059), 2-fluoro-N-methyl-N-1-naphthylacetamide (IUPAC name) (1295), 4-chlorophenyl phenyl sulfone (IUPAC name) (981), abamectin (1), acequinocyl (3), acetoprole [CCN], acrinathrin (9), aldicarb (16), aldoxycarb (863), alpha-cypermethrin (202), amidithion (870), amidoflumet [CCN], amidothioate (872), amiton (875), amiton hydrogen oxalate (875), amitraz (24), aramite (881), arsenous oxide (882), AVI 382 (compound code), AZ 60541 (compound code), azinphos-ethyl (44), azinphos-methyl (45), azobenzene (IUPAC name) (888), azocyclotin (46), azothoate (889), benomyl (62), benoxafos (alternative name) [CCN], benzoximate (71), benzyl benzoate (IUPAC name) [CCN], bifenazate (74), bifenthrin (76), binapacryl (907), brofenvalerate (alternative name), bromocyclen (918), bromophos (920), bromophos-ethyl (921), bromopropylate (94), buprofezin (99), butocarboxim (103), butoxycarboxim (104), butylpyridaben (alternative name), calcium polysulfide (IUPAC name) (111), camphechlor (941), carbanolate (943), carbaryl (115), carbofuran (118), carbophenothion (947), CGA 50'439 (development code) (125), chinomethionat (126), chlorbenside (959), chlordimeform (964), chlordimeform hydrochloride (964), chlorfenapyr (130), chlorfenethol (968), chlorfenson (970), chlorfensulphide (971), chlorfenvinphos (131), chlorobenzilate (975), chloromebuform (977), chloromethiuron (978), chloropropylate (983), chlorpyrifos (145), chlorpyrifos-methyl (146), chlorthiophos (994), cinerin I (696), cinerin II (696), cinerins (696), clofentezine (158), closantel (alternative name) [CCN], coumaphos (174), crotamiton (alternative name) [CCN], crotoxyphos (1010), cufraneb (1013), cyanthoate (1020), cyhalothrin (196), cyhexatin (199), cypermethrin (201), DCPM (1032), DDT (219), demephion (1037), demephion-O (1037), demephion-S (1037), demeton (1038), demeton-methyl (224), demeton-O (1038), demeton-O-methyl (224), demeton-S (1038), demeton-5-methyl (224), demeton-5-methylsulphon (1039), diafenthiuron (226), dialifos (1042), diazinon (227), dichlofluanid (230), dichlorvos (236), dicliphos (alternative name), dicofol (242), dicrotophos (243), dienochlor (1071), dimefox (1081), dimethoate (262), dinactin (alternative name) (653), dinex (1089), dinex-diclexine (1089), dinobuton (269), dinocap (270), dinocap-4 [CCN], dinocap-6 [CCN], dinocton (1090), dinopenton (1092), dinosulfon (1097), dinoterbon (1098), dioxathion (1102), diphenyl sulfone (IUPAC name) (1103), disulfuram (alternative name) [CCN], disulfoton (278), DNOC (282), dofenapyn (1113), doramectin (alternative name) [CCN], endosulfan (294), endothion (1121), EPN (297), eprinomectin (alternative name) [CCN], ethion (309), ethoate-methyl (1134), etoxazole (320), etrimfos (1142), fenazaflor (1147), fenazaquin (328), fenbutatin oxide (330), fenothiocarb (337), fenpropathrin (342), fenpyrad (alternative name), fenpyroximate (345), fenson (1157), fentrifanil (1161), fenvalerate (349), fipronil (354), fluacrypyrim (360), fluazuron (1166), flubenzimine (1167), flucycloxuron (366), flucythrinate (367), fluenetil (1169), flufenoxuron (370), flumethrin (372), fluorbenside (1174), fluvalinate (1184), FMC 1137 (development code) (1185), formetanate (405), formetanate hydrochloride (405), formothion (1192), formparanate (1193), gamma-HCH (430), glyodin (1205), halfenprox (424), heptenophos (432), hexadecyl cyclopropanecarboxylate (IUPAC/Chemical Abstracts name) (1216), hexythiazox (441), iodomethane (IUPAC name) (542), isocarbophos (alternative name) (473), isopropyl O-(methoxyaminothiophosphoryl)salicylate (IUPAC name) (473), ivermectin (alternative name) [CCN], jasmolin I (696), jasmolin II (696), jodfenphos (1248), lindane (430), lufenuron (490), malathion (492), malonoben (1254), mecarbam (502), mephosfolan (1261), mesulfen (alternative name) [CCN], methacrifos (1266), methamidophos (527), methidathion (529), methiocarb (530), methomyl (531), methyl bromide (537), metolcarb (550), mevinphos (556), mexacarbate (1290), milbemectin (557), milbemycin oxime (alternative name) [CCN], mipafox (1293), monocrotophos (561), morphothion (1300), moxidectin (alternative name) [CCN], naled (567), NC-184 (compound code), nifluridide (1309), nikkomycins (alternative name) [CCN], nitrilacarb (1313), nitrilacarb 1:1 zinc chloride complex (1313), NNI-0101 (compound code), NNI-0250 (compound code), omethoate (594), oxamyl (602), oxydeprofos (1324), oxydisulfoton (1325), pp′-DDT (219), parathion (615), permethrin (626), petroleum oils (alternative name) (628), phenkapton (1330), phenthoate (631), phorate (636), phosalone (637), phosfolan (1338), phosmet (638), phosphamidon (639), phoxim (642), pirimiphos-methyl (652), polychloroterpenes (traditional name) (1347), polynactins (alternative name) (653), proclonol (1350), profenofos (662), promacyl (1354), propargite (671), propetamphos (673), propoxur (678), prothidathion (1360), prothoate (1362), pyrethrin I (696), pyrethrin II (696), pyrethrins (696), pyridaben (699), pyridaphenthion (701), pyrimidifen (706), pyrimitate (1370), quinalphos (711), quintiofos (1381), R-1492 (development code) (1382), RA-17 (development code) (1383), rotenone (722), schradan (1389), sebufos (alternative name), selamectin (alternative name) [CCN], SI-0009 (compound code), sophamide (1402), spirodiclofen (738), spiromesifen (739), SSI-121 (development code) (1404), sulfuram (alternative name) [CCN], sulfluramid (750), sulfotep (753), sulfur (754), SZI-121 (development code) (757), tau-fluvalinate (398), tebufenpyrad (763), TEPP (1417), terbam (alternative name), tetrachlorvinphos (777), tetradifon (786), tetranactin (alternative name) (653), tetrasul (1425), thiafenox (alternative name), thiocarboxime (1431), thiofanox (800), thiometon (801), thioquinox (1436), thuringiensin (alternative name) [CCN], triamiphos (1441), triarathene (1443), triazophos (820), triazuron (alternative name), trichlorfon (824), trifenofos (1455), trinactin (alternative name) (653), vamidothion (847), vaniliprole [CCN] and YI-5302 (compound code),
an algicide selected from the group of substances consisting of bethoxazin [CCN], copper dioctanoate (IUPAC name) (170), copper sulfate (172), cybutryne [CCN], dichlone (1052), dichlorophen (232), endothal (295), fentin (347), hydrated lime [CCN], nabam (566), quinoclamine (714), quinonamid (1379), simazine (730), triphenyltin acetate (IUPAC name) (347) and triphenyltin hydroxide (IUPAC name) (347),
an anthelmintic selected from the group of substances consisting of abamectin (1), crufomate (1011), doramectin (alternative name) [CCN], emamectin (291), emamectin benzoate (291), eprinomectin (alternative name) [CCN], ivermectin (alternative name) [CCN], milbemycin oxime (alternative name) [CCN], moxidectin (alternative name) [CCN], piperazine [CCN], selamectin (alternative name) [CCN], spinosad (737) and thiophanate (1435),
an avicide selected from the group of substances consisting of chloralose (127), endrin (1122), fenthion (346), pyridin-4-amine (IUPAC name) (23) and strychnine (745),
a bactericide selected from the group of substances consisting of 1-hydroxy-1H-pyridine-2-thione (IUPAC name) (1222), 4-(quinoxalin-2-ylamino)benzenesulfonamide (IUPAC name) (748), 8-hydroxyquinoline sulfate (446), bronopol (97), copper dioctanoate (IUPAC name) (170), copper hydroxide (IUPAC name) (169), cresol [CCN], dichlorophen (232), dipyrithione (1105), dodicin (1112), fenaminosulf (1144), formaldehyde (404), hydrargaphen (alternative name) [CCN], kasugamycin (483), kasugamycin hydrochloride hydrate (483), nickel bis(dimethyldithiocarbamate) (IUPAC name) (1308), nitrapyrin (580), octhilinone (590), oxolinic acid (606), oxytetracycline (611), potassium hydroxyquinoline sulfate (446), probenazole (658), streptomycin (744), streptomycin sesquisulfate (744), tecloftalam (766) and thiomersal (alternative name) [CCN],
a biological agent selected from the group of substances consisting of Adoxophyes orana GV (alternative name) (12), Agrobacterium radiobacter (alternative name) (13), Amblyselus spp. (alternative name) (19), Anagrapha falcifera NPV (alternative name) (28), Anagrus atomus (alternative name) (29), Aphelinus abdominalis (alternative name) (33), Aphidius colemani (alternative name) (34), Aphidoletes aphidimyza (alternative name) (35), Autographa californica NPV (alternative name) (38), Bacillus firmus (alternative name) (48), Bacillus sphaericus Neide (scientific name) (49), Bacillus thuringiensis Berliner (scientific name) (51), Bacillus thuringiensis subsp. aizawai (scientific name) (51), Bacillus thuringiensis subsp. israelensis (scientific name) (51), Bacillus thuringiensis subsp. japonensis (scientific name) (51), Bacillus thuringiensis subsp. kurstaki (scientific name) (51), Bacillus thuringiensis subsp. tenebrionis (scientific name) (51), Beauveria bassiana (alternative name) (53), Beauveria brongniartii (alternative name) (54), Chrysoperla carnea (alternative name) (151), Cryptolaemus montrouzieri (alternative name) (178), Cydia pomonella GV (alternative name) (191), Dacnusa sibirica (alternative name) (212), Diglyphus isaea (alternative name) (254), Encarsia formosa (scientific name) (293), Eretmocerus eremicus (alternative name) (300), Helicoverpa zea NPV (alternative name) (431), Heterorhabditis bacteriophora and H. megidis (alternative name) (433), Hippodamia convergens (alternative name) (442), Leptomastix dactylopii (alternative name) (488), Macrolophus caliginosus (alternative name) (491), Mamestra brassicae NPV (alternative name) (494), Metaphycus helvolus (alternative name) (522), Metarhizium anisopliae var. acridum (scientific name) (523), Metarhizium anisopliae var. anisopliae (scientific name) (523), Neodiprion sertifer NPV and N. lecontei NPV (alternative name) (575), Orius spp. (alternative name) (596), Paecilomyces fumosoroseus (alternative name) (613), Phytoseiulus persimilis (alternative name) (644), Spodoptera exigua multicapsid nuclear polyhedrosis virus (scientific name) (741), Steinernema bibionis (alternative name) (742), Steinernema carpocapsae (alternative name) (742), Steinernema feltiae (alternative name) (742), Steinernema glaseri (alternative name) (742), Steinernema riobrave (alternative name) (742), Steinernema riobravis (alternative name) (742), Steinernema scapterisci (alternative name) (742), Steinernema spp. (alternative name) (742), Trichogramma spp. (alternative name) (826), Typhlodromus occidentalis (alternative name) (844) and Verticillium lecanii (alternative name) (848),
a soil sterilant selected from the group of substances consisting of iodomethane (IUPAC name) (542) and methyl bromide (537),
a chemosterilant selected from the group of substances consisting of apholate [CCN], bisazir (alternative name) [CCN], busulfan (alternative name) [CCN], diflubenzuron (250), dimatif (alternative name) [CCN], hemel [CCN], hempa [CCN], metepa [CCN], methiotepa [CCN], methyl apholate [CCN], morzid [CCN], penfluoron (alternative name) [CCN], tepa [CCN], thiohempa (alternative name) [CCN], thiotepa (alternative name) [CCN], tretamine (alternative name) [CCN] and uredepa (alternative name) [CCN],
an insect pheromone selected from the group of substances consisting of (E)-dec-5-en-1-yl acetate with (E)-dec-5-en-1-ol (IUPAC name) (222), (E)-tridec-4-en-1-yl acetate (IUPAC name) (829), (E)-6-methylhept-2-en-4-ol (IUPAC name) (541), (E,Z)-tetradeca-4,10-dien-1-yl acetate (IUPAC name) (779), (Z)-dodec-7-en-1-yl acetate (IUPAC name) (285), (Z)-hexadec-11-enal (IUPAC name) (436), (Z)-hexadec-11-en-1-yl acetate (IUPAC name) (437), (Z)-hexadec-13-en-11-yn-1-yl acetate (IUPAC name) (438), (Z)-icos-13-en-10-one (IUPAC name) (448), (Z)-tetradec-7-en-1-al (IUPAC name) (782), (Z)-tetradec-9-en-1-ol (IUPAC name) (783), (Z)-tetradec-9-en-1-yl acetate (IUPAC name) (784), (7E,9Z)-dodeca-7,9-dien-1-yl acetate (IUPAC name) (283), (9Z,11E)-tetradeca-9,11-dien-1-yl acetate (IUPAC name) (780), (9Z,12E)-tetradeca-9,12-dien-1-yl acetate (IUPAC name) (781), 14-methyloctadec-1-ene (IUPAC name) (545), 4-methylnonan-5-ol with 4-methylnonan-5-one (IUPAC name) (544), alpha-multistriatin (alternative name) [CCN], brevicomin (alternative name) [CCN], codlelure (alternative name) [CCN], codlemone (alternative name) (167), cuelure (alternative name) (179), disparlure (277), dodec-8-en-1-yl acetate (IUPAC name) (286), dodec-9-en-1-yl acetate (IUPAC name) (287), dodeca-8,10-dien-1-yl acetate (IUPAC name) (284), dominicalure (alternative name) [CCN], ethyl 4-methyloctanoate (IUPAC name) (317), eugenol (alternative name) [CCN], frontalin (alternative name) [CCN], gossyplure (alternative name) (420), grandlure (421), grandlure I (alternative name) (421), grandlure II (alternative name) (421), grandlure III (alternative name) (421), grandlure IV (alternative name) (421), hexylure [CCN], ipsdienol (alternative name) [CCN], ipsenol (alternative name) [CCN], japonilure (alternative name) (481), lineatin (alternative name) [CCN], litlure (alternative name) [CCN], looplure (alternative name) [CCN], medlure [CCN], megatomoic acid (alternative name) [CCN], methyl eugenol (alternative name) (540), muscalure (563), octadeca-2,13-dien-1-yl acetate (IUPAC name) (588), octadeca-3,13-dien-1-yl acetate (IUPAC name) (589), orfralure (alternative name) [CCN], oryctalure (alternative name) (317), ostramone (alternative name) [CCN], siglure [CCN], sordidin (alternative name) (736), sulcatol (alternative name) [CCN], tetradec-11-en-1-yl acetate (IUPAC name) (785), trimedlure (839), trimedlure A (alternative name) (839), trimedlure B₁ (alternative name) (839), trimedlure B₂ (alternative name) (839), trimedlure C (alternative name) (839) and trunc-call (alternative name) [CCN],
an insect repellent selected from the group of substances consisting of 2-(octylthio)-ethanol (IUPAC name) (591), butopyronoxyl (933), butoxy(polypropylene glycol) (936), dibutyl adipate (IUPAC name) (1046), dibutyl phthalate (1047), dibutyl succinate (IUPAC name) (1048), diethyltoluamide [CCN], dimethyl carbate [CCN], dimethyl phthalate [CCN], ethyl hexanediol (1137), hexamide [CCN], methoquin-butyl (1276), methylneodecanamide [CCN], oxamate [CCN] and picaridin [CCN],
an insecticide selected from the group of substances consisting of 1,1-dichloro-1-nitroethane (IUPAC/Chemical Abstracts name) (1058), 1,1-dichloro-2,2-bis(4-ethylphenyl)-ethane (IUPAC name) (1056), 1,2-dichloropropane (IUPAC/Chemical Abstracts name) (1062), 1,2-dichloropropane with 1,3-dichloropropene (IUPAC name) (1063), 1-bromo-2-chloroethane (IUPAC/Chemical Abstracts name) (916), 2,2,2-trichloro-1-(3,4-dichloro-phenyl)ethyl acetate (IUPAC name) (1451), 2,2-dichlorovinyl 2-ethylsulfinylethyl methyl phosphate (IUPAC name) (1066), 2-(1,3-dithiolan-2-yl)phenyl dimethylcarbamate (IUPAC/Chemical Abstracts name) (1109), 2-(2-butoxyethoxy)ethyl thiocyanate (IUPAC/Chemical Abstracts name) (935), 2-(4,5-dimethyl-1,3-dioxolan-2-yl)phenyl methylcarbamate (IUPAC/Chemical Abstracts name) (1084), 2-(4-chloro-3,5-xylyloxy)ethanol (IUPAC name) (986), 2-chlorovinyl diethyl phosphate (IUPAC name) (984), 2-imidazolidone (IUPAC name) (1225), 2-isovalerylindan-1,3-dione (IUPAC name) (1246), 2-methyl(prop-2-ynyl)aminophenyl methylcarbamate (IUPAC name) (1284), 2-thiocyanatoethyl laurate (IUPAC name) (1433), 3-bromo-1-chloroprop-1-ene (IUPAC name) (917), 3-methyl-1-phenylpyrazol-5-yl dimethyl-carbamate (IUPAC name) (1283), 4-methyl(prop-2-ynyl)amino-3,5-xylyl methylcarbamate (IUPAC name) (1285), 5,5-dimethyl-3-oxocyclohex-1-enyl dimethylcarbamate (IUPAC name) (1085), abamectin (1), acephate (2), acetamiprid (4), acethion (alternative name) [CCN], acetoprole [CCN], acrinathrin (9), acrylonitrile (IUPAC name) (861), alanycarb (15), aldicarb (16), aldoxycarb (863), aldrin (864), allethrin (17), allosamidin (alternative name) [CCN], allyxycarb (866), alpha-cypermethrin (202), alpha-ecdysone (alternative name) [CCN], aluminium phosphide (640), amidithion (870), amidothioate (872), aminocarb (873), amiton (875), amiton hydrogen oxalate (875), amitraz (24), anabasine (877), athidathion (883), AVI 382 (compound code), AZ 60541 (compound code), azadirachtin (alternative name) (41), azamethiphos (42), azinphos-ethyl (44), azinphos-methyl (45), azothoate (889), Bacillus thuringiensis delta endotoxins (alternative name) (52), barium hexafluorosilicate (alternative name) [CCN], barium polysulfide (IUPAC/Chemical Abstracts name) (892), barthrin [CCN], BAS 320 I (compound code), Bayer 22/190 (development code) (893), Bayer 22408 (development code) (894), bendiocarb (58), benfuracarb (60), bensultap (66), beta-cyfluthrin (194), beta-cypermethrin (203), bifenthrin (76), bioallethrin (78), bioallethrin S-cyclopentenyl isomer (alternative name) (79), bioethanomethrin [CCN], biopermethrin (908), bioresmethrin (80), bis(2-chloroethyl)ether (IUPAC name) (909), bistrifluoron (83), borax (86), brofenvalerate (alternative name), bromfenvinfos (914), bromocyclen (918), bromo-DDT (alternative name) [CCN], bromophos (920), bromophos-ethyl (921), bufencarb (924), buprofezin (99), butacarb (926), butathiofos (927), butocarboxim (103), butonate (932), butoxycarboxim (104), butylpyridaben (alternative name), cadusafos (109), calcium arsenate [CCN], calcium cyamide (444), calcium polysulfide (IUPAC name) (111), camphechlor (941), carbanolate (943), carbaryl (115), carbofuran (118), carbon disulfide (IUPAC/Chemical Abstracts name) (945), carbon tetrachloride (IUPAC name) (946), carbophenothion (947), carbosulfan (119), cartap (123), cartap hydrochloride (123), cevadine (alternative name) (725), chlorbicyclen (960), chlordane (128), chlordecone (963), chlordimeform (964), chlordimeform hydrochloride (964), chlorethoxyfos (129), chlorfenapyr (130), chlorfenvinphos (131), chlorfluazuron (132), chlormephos (136), chloroform [CCN], chloropicrin (141), chlorphoxim (989), chlorprazophos (990), chlorpyrifos (145), chlorpyrifos-methyl (146), chlorthiophos (994), chromafenozide (150), cinerin I (696), cinerin II (696), cinerins (696), cis-resmethrin (alternative name), cismethrin (80), clocythrin (alternative name), cloethocarb (999), closantel (alternative name) [CCN], clothianidin (165), copper acetoarsenite [CCN], copper arsenate [CCN], copper oleate [CCN], coumaphos (174), coumithoate (1006), crotamiton (alternative name) [CCN], crotoxyphos (1010), crufomate (1011), cryolite (alternative name) (177), CS 708 (development code) (1012), cyanofenphos (1019), cyanophos (184), cyanthoate (1020), cyclethrin [CCN], cycloprothrin (188), cyfluthrin (193), cyhalothrin (196), cypermethrin (201), cyphenothrin (206), cyromazine (209), cythioate (alternative name) [CCN], d-limonene (alternative name) [CCN], d-tetramethrin (alternative name) (788), DAEP (1031), dazomet (216), DDT (219), decarbofuran (1034), deltamethrin (223), demephion (1037), demephion-O (1037), demephion-S (1037), demeton (1038), demeton-methyl (224), demeton-O (1038), demeton-O-methyl (224), demeton-S (1038), demeton-5-methyl (224), demeton-5-methylsulphon (1039), diafenthiuron (226), dialifos (1042), diamidafos (1044), diazinon (227), dicapthon (1050), dichlofenthion (1051), dichlorvos (236), dicliphos (alternative name), dicresyl (alternative name) [CCN], dicrotophos (243), dicyclanil (244), dieldrin (1070), diethyl 5-methylpyrazol-3-yl phosphate (IUPAC name) (1076), diflubenzuron (250), dilor (alternative name) [CCN], dimefluthrin [CCN], dimefox (1081), dimetan (1085), dimethoate (262), dimethrin (1083), dimethylvinphos (265), dimetilan (1086), dinex (1089), dinex-diclexine (1089), dinoprop (1093), dinosam (1094), dinoseb (1095), dinotefuran (271), diofenolan (1099), dioxabenzofos (1100), dioxacarb (1101), dioxathion (1102), disulfoton (278), dithicrofos (1108), DNOC (282), doramectin (alternative name) [CCN], DSP (1115), ecdysterone (alternative name) [CCN], EI 1642 (development code) (1118), emamectin (291), emamectin benzoate (291), EMPC (1120), empenthrin (292), endosulfan (294), endothion (1121), endrin (1122), EPBP (1123), EPN (297), epofenonane (1124), eprinomectin (alternative name) [CCN], esfenvalerate (302), etaphos (alternative name) [CCN], ethiofencarb (308), ethion (309), ethiprole (310), ethoate-methyl (1134), ethoprophos (312), ethyl formate (IUPAC name) [CCN], ethyl-DDD (alternative name) (1056), ethylene dibromide (316), ethylene dichloride (chemical name) (1136), ethylene oxide [CCN], etofenprox (319), etrimfos (1142), EXD (1143), famphur (323), fenamiphos (326), fenazaflor (1147), fenchlorphos (1148), fenethacarb (1149), fenfluthrin (1150), fenitrothion (335), fenobucarb (336), fenoxacrim (1153), fenoxycarb (340), fenpirithrin (1155), fenpropathrin (342), fenpyrad (alternative name), fensulfothion (1158), fenthion (346), fenthion-ethyl [CCN], fenvalerate (349), fipronil (354), flonicamid (358), flucofuron (1168), flucycloxuron (366), flucythrinate (367), fluenetil (1169), flufenerim [CCN], flufenoxuron (370), flufenprox (1171), flumethrin (372), fluvalinate (1184), FMC 1137 (development code) (1185), fonofos (1191), formetanate (405), formetanate hydrochloride (405), formothion (1192), formparanate (1193), fosmethilan (1194), fospirate (1195), fosthiazate (408), fosthietan (1196), furathiocarb (412), furethrin (1200), gamma-cyhalothrin (197), gamma-HCH (430), guazatine (422), guazatine acetates (422), GY-81 (development code) (423), halfenprox (424), halofenozide (425), HCH (430), HEOD (1070), heptachlor (1211), heptenophos (432), heterophos [CCN], hexaflumuron (439), HHDN (864), hydramethylnon (443), hydrogen cyamide (444), hydroprene (445), hyquincarb (1223), imidacloprid (458), imiprothrin (460), indoxacarb (465), iodomethane (IUPAC name) (542), IPSP (1229), isazofos (1231), isobenzan (1232), isocarbophos (alternative name) (473), isodrin (1235), isofenphos (1236), isolane (1237), isoprocarb (472), isopropyl O-(methoxyaminothiophosphoryl)salicylate (IUPAC name) (473), isoprothiolane (474), isothioate (1244), isoxathion (480), ivermectin (alternative name) [CCN], jasmolin I (696), jasmolin II (696), jodfenphos (1248), juvenile hormone I (alternative name) [CCN], juvenile hormone II (alternative name) [CCN], juvenile hormone III (alternative name) [CCN], kelevan (1249), kinoprene (484), lambda-cyhalothrin (198), lead arsenate [CCN], leptophos (1250), lindane (430), lirimfos (1251), lufenuron (490), lythidathion (1253), m-cumenyl methylcarbamate (IUPAC name) (1014), magnesium phosphide (IUPAC name) (640), malathion (492), malonoben (1254), mazidox (1255), mecarbam (502), mecarphon (1258), menazon (1260), mephosfolan (1261), mercurous chloride (513), mesulfenfos (1263), metam (519), metam-potassium (alternative name) (519), metam-sodium (519), methacrifos (1266), methamidophos (527), methanesulfonyl fluoride (IUPAC/Chemical Abstracts name) (1268), methidathion (529), methiocarb (530), methocrotophos (1273), methomyl (531), methoprene (532), methoquin-butyl (1276), methothrin (alternative name) (533), methoxychlor (534), methoxyfenozide (535), methyl bromide (537), methyl isothiocyanate (543), methylchloroform (alternative name) [CCN], methylene chloride [CCN], metofluthrin [CCN], metolcarb (550), metoxadiazone (1288), mevinphos (556), mexacarbate (1290), milbemectin (557), milbemycin oxime (alternative name) [CCN], mipafox (1293), mirex (1294), monocrotophos (561), morphothion (1300), moxidectin (alternative name) [CCN], naftalofos (alternative name) [CCN], naled (567), naphthalene (IUPAC/Chemical Abstracts name) (1303), NC-170 (development code) (1306), NC-184 (compound code), nicotine (578), nicotine sulfate (578), nifluridide (1309), nitenpyram (579), nithiazine (1311), nitrilacarb (1313), nitrilacarb 1:1 zinc chloride complex (1313), NNI-0101 (compound code), NNI-0250 (compound code), nornicotine (traditional name) (1319), novaluron (585), noviflumuron (586), O-2,5-dichloro-4-iodophenyl O-ethyl ethylphosphonothioate (IUPAC name) (1057), O,O-diethyl O-4-methyl-2-oxo-2H-chromen-7-yl phosphorothioate (IUPAC name) (1074), O,O-diethyl O-6-methyl-2-propylpyrimidin-4-yl phosphorothioate (IUPAC name) (1075), O,O,O′,O′-tetrapropyl dithiopyrophosphate (IUPAC name) (1424), oleic acid (IUPAC name) (593), omethoate (594), oxamyl (602), oxydemeton-methyl (609), oxydeprofos (1324), oxydisulfoton (1325), pp′-DDT (219), para-dichlorobenzene [CCN], parathion (615), parathion-methyl (616), penfluoron (alternative name) [CCN], pentachlorophenol (623), pentachlorophenyl laurate (IUPAC name) (623), permethrin (626), petroleum oils (alternative name) (628), PH 60-38 (development code) (1328), phenkapton (1330), phenothrin (630), phenthoate (631), phorate (636), phosalone (637), phosfolan (1338), phosmet (638), phosnichlor (1339), phosphamidon (639), phosphine (IUPAC name) (640), phoxim (642), phoxim-methyl (1340), pirimetaphos (1344), pirimicarb (651), pirimiphos-ethyl (1345), pirimiphos-methyl (652), polychlorodicyclopentadiene isomers (IUPAC name) (1346), polychloroterpenes (traditional name) (1347), potassium arsenite [CCN], potassium thiocyanate [CCN], prallethrin (655), precocene I (alternative name) [CCN], precocene II (alternative name) [CCN], precocene III (alternative name) [CCN], primidophos (1349), profenofos (662), profluthrin [CCN], promacyl (1354), promecarb (1355), propaphos (1356), propetamphos (673), propoxur (678), prothidathion (1360), prothiofos (686), prothoate (1362), protrifenbute [CCN], pymetrozine (688), pyraclofos (689), pyrazophos (693), pyresmethrin (1367), pyrethrin I (696), pyrethrin II (696), pyrethrins (696), pyridaben (699), pyridalyl (700), pyridaphenthion (701), pyrimidifen (706), pyrimitate (1370), pyriproxyfen (708), quassia (alternative name) [CCN], quinalphos (711), quinalphos-methyl (1376), quinothion (1380), quintiofos (1381), R-1492 (development code) (1382), rafoxanide (alternative name) [CCN], resmethrin (719), rotenone (722), RU 15525 (development code) (723), RU 25475 (development code) (1386), ryania (alternative name) (1387), ryanodine (traditional name) (1387), sabadilla (alternative name) (725), schradan (1389), sebufos (alternative name), selamectin (alternative name) [CCN], SI-0009 (compound code), silafluofen (728), SN 72129 (development code) (1397), sodium arsenite [CCN], sodium cyamide (444), sodium fluoride (IUPAC/Chemical Abstracts name) (1399), sodium hexafluorosilicate (1400), sodium pentachlorophenoxide (623), sodium selenate (IUPAC name) (1401), sodium thiocyanate [CCN], sophamide (1402), spinosad (737), spiromesifen (739), sulcofuron (746), sulcofuron-sodium (746), sulfluramid (750), sulfotep (753), sulfuryl fluoride (756), sulprofos (1408), tar oils (alternative name) (758), tau-fluvalinate (398), tazimcarb (1412), TDE (1414), tebufenozide (762), tebufenpyrad (763), tebupirimfos (764), teflubenzuron (768), tefluthrin (769), temephos (770), TEPP (1417), terallethrin (1418), terbam (alternative name), terbufos (773), tetrachloroethane [CCN], tetrachlorvinphos (777), tetramethrin (787), theta-cypermethrin (204), thiacloprid (791), thiafenox (alternative name), thiamethoxam (792), thicrofos (1428), thiocarboxime (1431), thiocyclam (798), thiocyclam hydrogen oxalate (798), thiodicarb (799), thiofanox (800), thiometon (801), thionazin (1434), thiosultap (803), thiosultap-sodium (803), thuringiensin (alternative name) [CCN], tolfenpyrad (809), tralomethrin (812), transfluthrin (813), transpermethrin (1440), triamiphos (1441), triazamate (818), triazophos (820), triazuron (alternative name), trichlorfon (824), trichlormetaphos-3 (alternative name) [CCN], trichloronat (1452), trifenofos (1455), triflumuron (835), trimethacarb (840), triprene (1459), vamidothion (847), vaniliprole [CCN], veratridine (alternative name) (725), veratrine (alternative name) (725), XMC (853), xylylcarb (854), YI-5302 (compound code), zeta-cypermethrin (205), zetamethrin (alternative name), zinc phosphide (640), zolaprofos (1469) and ZXI 8901 (development code) (858),
a molluscicide selected from the group of substances consisting of bis(tributyltin)oxide (IUPAC name) (913), bromoacetamide [CCN], calcium arsenate [CCN], cloethocarb (999), copper acetoarsenite [CCN], copper sulfate (172), fentin (347), ferric phosphate (IUPAC name) (352), metaldehyde (518), methiocarb (530), niclosamide (576), niclosamide-olamine (576), pentachlorophenol (623), sodium pentachlorophenoxide (623), tazimcarb (1412), thiodicarb (799), tributyltin oxide (913), trifenmorph (1454), trimethacarb (840), triphenyltin acetate (IUPAC name) (347) and triphenyltin hydroxide (IUPAC name) (347),
a nematicide selected from the group of substances consisting of 1,2-dibromo-3-chloropropane (IUPAC/Chemical Abstracts name) (1045), 1,2-dichloropropane (IUPAC/Chemical Abstracts name) (1062), 1,2-dichloropropane with 1,3-dichloropropene (IUPAC name) (1063), 1,3-dichloropropene (233), 3,4-dichlorotetrahydrothiophene 1,1-dioxide (IUPAC/Chemical Abstracts name) (1065), 3-(4-chlorophenyl)-5-methylrhodanine (IUPAC name) (980), 5-methyl-6-thioxo-1,3,5-thiadiazinan-3-ylacetic acid (IUPAC name) (1286), 6-isopentenylaminopurine (alternative name) (210), abamectin (1), acetoprole [CCN], alanycarb (15), aldicarb (16), aldoxycarb (863), AZ 60541 (compound code), benclothiaz [CCN], benomyl (62), butylpyridaben (alternative name), cadusafos (109), carbofuran (118), carbon disulfide (945), carbosulfan (119), chloropicrin (141), chlorpyrifos (145), cloethocarb (999), cytokinins (alternative name) (210), dazomet (216), DBCP (1045), DCIP (218), diamidafos (1044), dichlofenthion (1051), dicliphos (alternative name), dimethoate (262), doramectin (alternative name) [CCN], emamectin (291), emamectin benzoate (291), eprinomectin (alternative name) [CCN], ethoprophos (312), ethylene dibromide (316), fenamiphos (326), fenpyrad (alternative name), fensulfothion (1158), fosthiazate (408), fosthietan (1196), furfural (alternative name) [CCN], GY-81 (development code) (423), heterophos [CCN], iodomethane (IUPAC name) (542), isamidofos (1230), isazofos (1231), ivermectin (alternative name) [CCN], kinetin (alternative name) (210), mecarphon (1258), metam (519), metam-potassium (alternative name) (519), metam-sodium (519), methyl bromide (537), methyl isothiocyanate (543), milbemycin oxime (alternative name) [CCN], moxidectin (alternative name) [CCN], Myrothecium verrucaria composition (alternative name) (565), NC-184 (compound code), oxamyl (602), phorate (636), phosphamidon (639), phosphocarb [CCN], sebufos (alternative name), selamectin (alternative name) [CCN], spinosad (737), terbam (alternative name), terbufos (773), tetrachlorothiophene (IUPAC/Chemical Abstracts name) (1422), thiafenox (alternative name), thionazin (1434), triazophos (820), triazuron (alternative name), xylenols [CCN], YI-5302 (compound code) and zeatin (alternative name) (210),
a nitrification inhibitor selected from the group of substances consisting of potassium ethylxanthate [CCN] and nitrapyrin (580),
a plant activator selected from the group of substances consisting of acibenzolar (6), acibenzolar-5-methyl (6), probenazole (658) and Reynoutria sachalinensis extract (alternative name) (720),
a rodenticide selected from the group of substances consisting of 2-isovalerylindan-1,3-dione (IUPAC name) (1246), 4-(quinoxalin-2-ylamino)benzenesulfonamide (IUPAC name) (748), alpha-chlorohydrin [CCN], aluminium phosphide (640), antu (880), arsenous oxide (882), barium carbonate (891), bisthiosemi (912), brodifacoum (89), bromadiolone (91), bromethalin (92), calcium cyamide (444), chloralose (127), chlorophacinone (140), cholecalciferol (alternative name) (850), coumachlor (1004), coumafuryl (1005), coumatetralyl (175), crimidine (1009), difenacoum (246), difethialone (249), diphacinone (273), ergocalciferol (301), flocoumafen (357), fluoroacetamide (379), flupropadine (1183), flupropadine hydrochloride (1183), gamma-HCH (430), HCH (430), hydrogen cyamide (444), iodomethane (IUPAC name) (542), lindane (430), magnesium phosphide (IUPAC name) (640), methyl bromide (537), norbormide (1318), phosacetim (1336), phosphine (IUPAC name) (640), phosphorus [CCN], pindone (1341), potassium arsenite [CCN], pyrinuron (1371), scilliroside (1390), sodium arsenite [CCN], sodium cyamide (444), sodium fluoro-acetate (735), strychnine (745), thallium sulfate [CCN], warfarin (851) and zinc phosphide (640),
a synergist selected from the group of substances consisting of 2-(2-butoxyethoxy)ethyl piperonylate (IUPAC name) (934), 5-(1,3-benzodioxol-5-yl)-3-hexylcyclohex-2-enone (IUPAC name) (903), farnesol with nerolidol (alternative name) (324), MB-599 (development code) (498), MGK 264 (development code) (296), piperonyl butoxide (649), piprotal (1343), propyl isomer (1358), S421 (development code) (724), sesamex (1393), sesasmolin (1394) and sulfoxide (1406),
an animal repellent selected from the group of substances consisting of anthraquinone (32), chloralose (127), copper naphthenate [CCN], copper oxychloride (171), diazinon (227), dicyclopentadiene (chemical name) (1069), guazatine (422), guazatine acetates (422), methiocarb (530), pyridin-4-amine (IUPAC name) (23), thiram (804), trimethacarb (840), zinc naphthenate [CCN] and ziram (856),
a virucide selected from the group of substances consisting of imanin (alternative name) [CCN] and ribavirin (alternative name) [CCN],
and a wound protectant selected from the group of substances consisting of mercuric oxide (512), octhilinone (590) and thiophanate-methyl (802).

A very especially preferred embodiment of the subject-matter {1.1.1} of the invention is {1.1.1.2} a pesticidal composition comprising a mixture consisting of at least two substances, namely one compound (A) and at least one compound (B), as active ingredient and at least one auxiliary, wherein the compound (A) is the compound of formula (A-1) and the compound (B) is a compound selected from the group of substances consisting of abamectin (1), cyromazine (209), diafenthiuron (226), diazinon (227), emamectin benzoate (291), fenoxycarb (340), fosthiazate (408), lambda-cyhalothrin (198), lufenuron (490), methidathion (529), profenofos (662), pymetrozine (688), tefluthrin (769) and thiamethoxam (792).

The compound of formula (A-1) is known, for example, from PCT Application WO-03/015519.

A preferred embodiment of the subject-matter {1.1} of the invention is {1.1.2} a pesticidal composition comprising a mixture consisting of at least two substances, namely one compound (A) and at least one compound (B), as active ingredient and at least one auxiliary, wherein the compound (A) is the compound of formula (A-2) 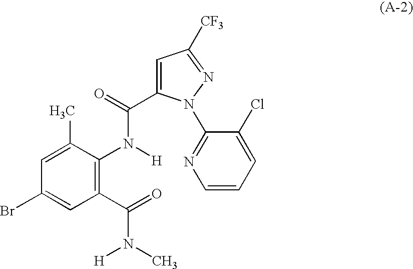
and the compound (B) is a compound selected from the group of substances consisting of an adjuvant, an acaricide, an algicide, an anthelmintic, an avicide, a bactericide, a biological agent, a soil sterilant, a chemosterilant, an insect pheromone, an insect repellent, an insecticide, a molluscicide, a nematicide, a nitrification inhibitor, a plant activator, a rodenticide, a synergist, an animal repellent, a virucide and a wound protectant.

An especially preferred embodiment of the subject-matter {1.1.2} of the invention is {1.1.2.1} a pesticidal composition comprising a mixture consisting of at least two substances, namely one compound (A) and at least one compound (B), as active ingredient and at least one auxiliary, wherein the compound (A) is the compound of formula (A-2) and the compound (B) is a compound selected from the group of substances consisting of
an adjuvant selected from the group of substances consisting of petroleum oils (alternative name) (628),
an acaricide selected from the group of substances consisting of 1,1-bis(4-chlorophenyl)-2-ethoxyethanol (IUPAC name) (910), 2,4-dichlorophenyl benzenesulfonate (IUPAC/Chemical Abstracts name) (1059), 2-fluoro-N-methyl-N-1-naphthylacetamide (IUPAC name) (1295), 4-chlorophenyl phenyl sulfone (IUPAC name) (981), abamectin (1), acequinocyl (3), acetoprole [CCN], acrinathrin (9), aldicarb (16), aldoxycarb (863), alpha-cypermethrin (202), amidithion (870), amidoflumet [CCN], amidothioate (872), amiton (875), amiton hydrogen oxalate (875), amitraz (24), aramite (881), arsenous oxide (882), AVI 382 (compound code), AZ 60541 (compound code), azinphos-ethyl (44), azinphos-methyl (45), azobenzene (IUPAC name) (888), azocyclotin (46), azothoate (889), benomyl (62), benoxafos (alternative name) [CCN], benzoximate (71), benzyl benzoate (IUPAC name) [CCN], bifenazate (74), bifenthrin (76), binapacryl (907), brofenvalerate (alternative name), bromocyclen (918), bromophos (920), bromophos-ethyl (921), bromopropylate (94), buprofezin (99), butocarboxim (103), butoxycarboxim (104), butylpyridaben (alternative name), calcium polysulfide (IUPAC name) (111), camphechlor (941), carbanolate (943), carbaryl (115), carbofuran (118), carbophenothion (947), CGA 50'439 (development code) (125), chinomethionat (126), chlorbenside (959), chlordimeform (964), chlordimeform hydrochloride (964), chlorfenapyr (130), chlorfenethol (968), chlorfenson (970), chlorfensulphide (971), chlorfenvinphos (131), chlorobenzilate (975), chloromebuform (977), chloromethiuron (978), chloropropylate (983), chlorpyrifos (145), chlorpyrifos-methyl (146), chlorthiophos (994), cinerin I (696), cinerin II (696), cinerins (696), clofentezine (158), closantel (alternative name) [CCN], coumaphos (174), crotamiton (alternative name) [CCN], crotoxyphos (1010), cufraneb (1013), cyanthoate (1020), cyhalothrin (196), cyhexatin (199), cypermethrin (201), DCPM (1032), DDT (219), demephion (1037), demephion-O (1037), demephion-S (1037), demeton (1038), demeton-methyl (224), demeton-O (1038), demeton-O-methyl (224), demeton-S (1038), demeton-5-methyl (224), demeton-5-methylsulphon (1039), diafenthiuron (226), dialifos (1042), diazinon (227), dichlofluanid (230), dichlorvos (236), dicliphos (alternative name), dicofol (242), dicrotophos (243), dienochlor (1071), dimefox (1081), dimethoate (262), dinactin (alternative name) (653), dinex (1089), dinex-diclexine (1089), dinobuton (269), dinocap (270), dinocap-4 [CCN], dinocap-6 [CCN], dinocton (1090), dinopenton (1092), dinosulfon (1097), dinoterbon (1098), dioxathion (1102), diphenyl sulfone (IUPAC name) (1103), disulfuram (alternative name) [CCN], disulfoton (278), DNOC (282), dofenapyn (1113), doramectin (alternative name) [CCN], endosulfan (294), endothion (1121), EPN (297), eprinomectin (alternative name) [CCN], ethion (309), ethoate-methyl (1134), etoxazole (320), etrimfos (1142), fenazaflor (1147), fenazaquin (328), fenbutatin oxide (330), fenothiocarb (337), fenpropathrin (342), fenpyrad (alternative name), fenpyroximate (345), fenson (1157), fentrifanil (1161), fenvalerate (349), fipronil (354), fluacrypyrim (360), fluazuron (1166), flubenzimine (1167), flucycloxuron (366), flucythrinate (367), fluenetil (1169), flufenoxuron (370), flumethrin (372), fluorbenside (1174), fluvalinate (1184), FMC 1137 (development code) (1185), formetanate (405), formetanate hydrochloride (405), formothion (1192), formparanate (1193), gamma-HCH (430), glyodin (1205), halfenprox (424), heptenophos (432), hexadecyl cyclopropanecarboxylate (IUPAC/Chemical Abstracts name) (1216), hexythiazox (441), iodomethane (IUPAC name) (542), isocarbophos (alternative name) (473), isopropyl O-(methoxyaminothiophosphoryl)salicylate (IUPAC name) (473), ivermectin (alternative name) [CCN], jasmolin I (696), jasmolin II (696), jodfenphos (1248), lindane (430), lufenuron (490), malathion (492), malonoben (1254), mecarbam (502), mephosfolan (1261), mesulfen (alternative name) [CCN], methacrifos (1266), methamidophos (527), methidathion (529), methiocarb (530), methomyl (531), methyl bromide (537), metolcarb (550), mevinphos (556), mexacarbate (1290), milbemectin (557), milbemycin oxime (alternative name) [CCN], mipafox (1293), monocrotophos (561), morphothion (1300), moxidectin (alternative name) [CCN], naled (567), NC-184 (compound code), nifluridide (1309), nikkomycins (alternative name) [CCN], nitrilacarb (1313), nitrilacarb 1:1 zinc chloride complex (1313), NNI-0101 (compound code), NNI-0250 (compound code), omethoate (594), oxamyl (602), oxydeprofos (1324), oxydisulfoton (1325), pp′-DDT (219), parathion (615), permethrin (626), petroleum oils (alternative name) (628), phenkapton (1330), phenthoate (631), phorate (636), phosalone (637), phosfolan (1338), phosmet (638), phosphamidon (639), phoxim (642), pirimiphos-methyl (652), polychloroterpenes (traditional name) (1347), polynactins (alternative name) (653), proclonol (1350), profenofos (662), promacyl (1354), propargite (671), propetamphos (673), propoxur (678), prothidathion (1360), prothoate (1362), pyrethrin I (696), pyrethrin II (696), pyrethrins (696), pyridaben (699), pyridaphenthion (701), pyrimidifen (706), pyrimitate (1370), quinalphos (711), quintiofos (1381), R-1492 (development code) (1382), RA-17 (development code) (1383), rotenone (722), schradan (1389), sebufos (alternative name), selamectin (alternative name) [CCN], SI-0009 (compound code), sophamide (1402), spirodiclofen (738), spiromesifen (739), SSI-121 (development code) (1404), sulfuram (alternative name) [CCN], sulfluramid (750), sulfotep (753), sulfur (754), SZI-121 (development code) (757), tau-fluvalinate (398), tebufenpyrad (763), TEPP (1417), terbam (alternative name), tetrachlorvinphos (777), tetradifon (786), tetranactin (alternative name) (653), tetrasul (1425), thiafenox (alternative name), thiocarboxime (1431), thiofanox (800), thiometon (801), thioquinox (1436), thuringiensin (alternative name) [CCN], triamiphos (1441), triarathene (1443), triazophos (820), triazuron (alternative name), trichlorfon (824), trifenofos (1455), trinactin (alternative name) (653), vamidothion (847), vaniliprole [CCN] and YI-5302 (compound code),
an algicide selected from the group of substances consisting of bethoxazin [CCN], copper dioctanoate (IUPAC name) (170), copper sulfate (172), cybutryne [CCN], dichlone (1052), dichlorophen (232), endothal (295), fentin (347), hydrated lime [CCN], nabam (566), quinoclamine (714), quinonamid (1379), simazine (730), triphenyltin acetate (IUPAC name) (347) and triphenyltin hydroxide (IUPAC name) (347),
an anthelmintic selected from the group of substances consisting of abamectin (1), crufomate (1011), doramectin (alternative name) [CCN], emamectin (291), emamectin benzoate (291), eprinomectin (alternative name) [CCN], ivermectin (alternative name) [CCN], milbemycin oxime (alternative name) [CCN], moxidectin (alternative name) [CCN], piperazine [CCN], selamectin (alternative name) [CCN], spinosad (737) and thiophanate (1435),
an avicide selected from the group of substances consisting of chloralose (127), endrin (1122), fenthion (346), pyridin-4-amine (IUPAC name) (23) and strychnine (745),
a bactericide selected from the group of substances consisting of 1-hydroxy-1H-pyridine-2-thione (IUPAC name) (1222), 4-(quinoxalin-2-ylamino)benzenesulfonamide (IUPAC name) (748), 8-hydroxyquinoline sulfate (446), bronopol (97), copper dioctanoate (IUPAC name) (170), copper hydroxide (IUPAC name) (169), cresol [CCN], dichlorophen (232), dipyrithione (1105), dodicin (1112), fenaminosulf (1144), formaldehyde (404), hydrargaphen (alternative name) [CCN], kasugamycin (483), kasugamycin hydrochloride hydrate (483), nickel bis(dimethyldithiocarbamate) (IUPAC name) (1308), nitrapyrin (580), octhilinone (590), oxolinic acid (606), oxytetracycline (611), potassium hydroxyquinoline sulfate (446), probenazole (658), streptomycin (744), streptomycin sesquisulfate (744), tecloftalam (766) and thiomersal (alternative name) [CCN],
a biological agent selected from the group of substances consisting of Adoxophyes orana GV (alternative name) (12), Agrobacterium radiobacter (alternative name) (13), Amblyseius spp. (alternative name) (19), Anagrapha falcifera NPV (alternative name) (28), Anagrus atomus (alternative name) (29), Aphelinus abdominalis (alternative name) (33), Aphidius colemani (alternative name) (34), Aphidoletes aphidimyza (alternative name) (35), Autographa californica NPV (alternative name) (38), Bacillus firmus (alternative name) (48), Bacillus sphaericus Neide (scientific name) (49), Bacillus thuringiensis Berliner (scientific name) (51), Bacillus thuringiensis subsp. aizawai (scientific name) (51), Bacillus thuringiensis subsp. israelensis (scientific name) (51), Bacillus thuringiensis subsp. japonensis (scientific name) (51), Bacillus thuringiensis subsp. kurstaki (scientific name) (51), Bacillus thuringiensis subsp. tenebrionis (scientific name) (51), Beauveria bassiana (alternative name) (53), Beauveria brongniartii (alternative name) (54), Chrysoperla carnea (alternative name) (151), Cryptolaemus montrouzieri (alternative name) (178), Cydia pomonella GV (alternative name) (191), Dacnusa sibirica (alternative name) (212), Diglyphus isaea (alternative name) (254), Encarsia formosa (scientific name) (293), Eretmocerus eremicus (alternative name) (300), Helicoverpa zea NPV (alternative name) (431), Heterorhabditis bacteriophora and H. megidis (alternative name) (433), Hippodamia convergens (alternative name) (442), Leptomastix dactylopii (alternative name) (488), Macrolophus caliginosus (alternative name) (491), Mamestra brassicae NPV (alternative name) (494), Metaphycus helvolus (alternative name) (522), Metarhizium anisopliae var. acridum (scientific name) (523), Metarhizium anisopliae var. anisopliae (scientific name) (523), Neodiprion sertifer NPV and N. lecontei NPV (alternative name) (575), Orius spp. (alternative name) (596), Paecilomyces fumosoroseus (alternative name) (613), Phytoseiulus persimilis (alternative name) (644), Spodoptera exigua multicapsid nuclear polyhedrosis virus (scientific name) (741), Steinernema bibionis (alternative name) (742), Steinernema carpocapsae (alternative name) (742), Steinernema feltiae (alternative name) (742), Steinernema glaseri (alternative name) (742), Steinernema riobrave (alternative name) (742), Steinernema riobravis (alternative name) (742), Steinernema scapterisci (alternative name) (742), Steinernema spp. (alternative name) (742), Trichogramma spp. (alternative name) (826), Typhlodromus occidentalis (alternative name) (844) and Verticillium lecanii (alternative name) (848),
a soil sterilant selected from the group of substances consisting of iodomethane (IUPAC name) (542) and methyl bromide (537),
a chemosterilant selected from the group of substances consisting of apholate [CCN], bisazir (alternative name) [CCN], busulfan (alternative name) [CCN], diflubenzuron (250), dimatif (alternative name) [CCN], hemel [CCN], hempa [CCN], metepa [CCN], methiotepa [CCN], methyl apholate [CCN], morzid [CCN], penfluoron (alternative name) [CCN], tepa [CCN], thiohempa (alternative name) [CCN], thiotepa (alternative name) [CCN], tretamine (alternative name) [CCN] and uredepa (alternative name) [CCN],
an insect pheromone selected from the group of substances consisting of (E)-dec-5-en-1-yl acetate with (E)-dec-5-en-1-ol (IUPAC name) (222), (E)-tridec-4-en-1-yl acetate (IUPAC name) (829), (E)-6-methylhept-2-en-4-ol (IUPAC name) (541), (E,Z)-tetradeca-4,10-dien-1-yl acetate (IUPAC name) (779), (Z)-dodec-7-en-1-yl acetate (IUPAC name) (285), (Z)-hexadec-11-enal (IUPAC name) (436), (Z)-hexadec-11-en-1-yl acetate (IUPAC name) (437), (Z)-hexadec-13-en-11-yn-1-yl acetate (IUPAC name) (438), (Z)-icos-13-en-10-one (IUPAC name) (448), (Z)-tetradec-7-en-1-al (IUPAC name) (782), (Z)-tetradec-9-en-1-ol (IUPAC name) (783), (Z)-tetradec-9-en-1-yl acetate (IUPAC name) (784), (7E,9Z)-dodeca-7,9-dien-1-yl acetate (IUPAC name) (283), (9Z,11E)-tetradeca-9,11-dien-1-yl acetate (IUPAC name) (780), (9Z,12E)-tetradeca-9,12-dien-1-yl acetate (IUPAC name) (781), 14-methyloctadec-1-ene (IUPAC name) (545), 4-methylnonan-5-ol with 4-methylnonan-5-one (IUPAC name) (544), alpha-multistriatin (alternative name) [CCN], brevicomin (alternative name) [CCN], codlelure (alternative name) [CCN], codlemone (alternative name) (167), cuelure (alternative name) (179), disparlure (277), dodec-8-en-1-yl acetate (IUPAC name) (286), dodec-9-en-1-yl acetate (IUPAC name) (287), dodeca-8,10-dien-1-yl acetate (IUPAC name) (284), dominicalure (alternative name) [CCN], ethyl 4-methyloctanoate (IUPAC name) (317), eugenol (alternative name) [CCN], frontalin (alternative name) [CCN], gossyplure (alternative name) (420), grandlure (421), grandlure I (alternative name) (421), grandlure II (alternative name) (421), grandlure III (alternative name) (421), grandlure IV (alternative name) (421), hexylure [CCN], ipsdienol (alternative name) [CCN], ipsenol (alternative name) [CCN], japonilure (alternative name) (481), lineatin (alternative name) [CCN], litlure (alternative name) [CCN], looplure (alternative name) [CCN], medlure [CCN], megatomoic acid (alternative name) [CCN], methyl eugenol (alternative name) (540), muscalure (563), octadeca-2,13-dien-1-yl acetate (IUPAC name) (588), octadeca-3,13-dien-1-yl acetate (IUPAC name) (589), orfralure (alternative name) [CCN], oryctalure (alternative name) (317), ostramone (alternative name) [CCN], siglure [CCN], sordidin (alternative name) (736), sulcatol (alternative name) [CCN], tetradec-11-en-1-yl acetate (IUPAC name) (785), trimedlure (839), trimedlure A (alternative name) (839), trimedlure B₁ (alternative name) (839), trimedlure B₂ (alternative name) (839), trimedlure C (alternative name) (839) and trunc-call (alternative name) [CCN],
an insect repellent selected from the group of substances consisting of 2-(octylthio)-ethanol (IUPAC name) (591), butopyronoxyl (933), butoxy(polypropylene glycol) (936), dibutyl adipate (IUPAC name) (1046), dibutyl phthalate (1047), dibutyl succinate (IUPAC name) (1048), diethyltoluamide [CCN], dimethyl carbate [CCN], dimethyl phthalate [CCN], ethyl hexanediol (1137), hexamide [CCN], methoquin-butyl (1276), methylneodecanamide [CCN], oxamate [CCN] and picaridin [CCN],
an insecticide selected from the group of substances consisting of 1,1-dichloro-1-nitroethane (IUPAC/Chemical Abstracts name) (1058), 1,1-dichloro-2,2-bis(4-ethylphenyl)-ethane (IUPAC name) (1056), 1,2-dichloropropane (IUPAC/Chemical Abstracts name) (1062), 1,2-dichloropropane with 1,3-dichloropropene (IUPAC name) (1063), 1-bromo-2-chloroethane (IUPAC/Chemical Abstracts name) (916), 2,2,2-trichloro-1-(3,4-dichloro-phenyl)ethyl acetate (IUPAC name) (1451), 2,2-dichlorovinyl 2-ethylsulfinylethyl methyl phosphate (IUPAC name) (1066), 2-(1,3-dithiolan-2-yl)phenyl dimethylcarbamate (IUPAC/Chemical Abstracts name) (1109), 2-(2-butoxyethoxy)ethyl thiocyanate (IUPAC/Chemical Abstracts name) (935), 2-(4,5-dimethyl-1,3-dioxolan-2-yl)phenyl methylcarbamate (IUPAC/Chemical Abstracts name) (1084), 2-(4-chloro-3,5-xylyloxy)ethanol (IUPAC name) (986), 2-chlorovinyl diethyl phosphate (IUPAC name) (984), 2-imidazolidone (IUPAC name) (1225), 2-isovalerylindan-1,3-dione (IUPAC name) (1246), 2-methyl(prop-2-ynyl)aminophenyl methylcarbamate (IUPAC name) (1284), 2-thiocyanatoethyl laurate (IUPAC name) (1433), 3-bromo-1-chloroprop-1-ene (IUPAC name) (917), 3-methyl-1-phenylpyrazol-5-yl dimethyl-carbamate (IUPAC name) (1283), 4-methyl(prop-2-ynyl)amino-3,5-xylyl methylcarbamate (IUPAC name) (1285), 5,5-dimethyl-3-oxocyclohex-1-enyl dimethylcarbamate (IUPAC name) (1085), abamectin (1), acephate (2), acetamiprid (4), acethion (alternative name) [CCN], acetoprole [CCN], acrinathrin (9), acrylonitrile (IUPAC name) (861), alanycarb (15), aldicarb (16), aldoxycarb (863), aldrin (864), allethrin (17), allosamidin (alternative name) [CCN], allyxycarb (866), alpha-cypermethrin (202), alpha-ecdysone (alternative name) [CCN], aluminium phosphide (640), amidithion (870), amidothioate (872), aminocarb (873), amiton (875), amiton hydrogen oxalate (875), amitraz (24), anabasine (877), athidathion (883), AVI 382 (compound code), AZ 60541 (compound code), azadirachtin (alternative name) (41), azamethiphos (42), azinphos-ethyl (44), azinphos-methyl (45), azothoate (889), Bacillus thuringiensis delta endotoxins (alternative name) (52), barium hexafluorosilicate (alternative name) [CCN], barium polysulfide (IUPAC/Chemical Abstracts name) (892), barthrin [CCN], BAS 320 I (compound code), Bayer 22/190 (development code) (893), Bayer 22408 (development code) (894), bendiocarb (58), benfuracarb (60), bensultap (66), beta-cyfluthrin (194), beta-cypermethrin (203), bifenthrin (76), bioallethrin (78), bioallethrin S-cyclopentenyl isomer (alternative name) (79), bioethanomethrin [CCN], biopermethrin (908), bioresmethrin (80), bis(2-chloroethyl)ether (IUPAC name) (909), bistrifluoron (83), borax (86), brofenvalerate (alternative name), bromfenvinfos (914), bromocyclen (918), bromo-DDT (alternative name) [CCN], bromophos (920), bromophos-ethyl (921), bufencarb (924), buprofezin (99), butacarb (926), butathiofos (927), butocarboxim (103), butonate (932), butoxycarboxim (104), butylpyridaben (alternative name), cadusafos (109), calcium arsenate [CCN], calcium cyamide (444), calcium polysulfide (IUPAC name) (111), camphechlor (941), carbanolate (943), carbaryl (115), carbofuran (118), carbon disulfide (IUPAC/Chemical Abstracts name) (945), carbon tetrachloride (IUPAC name) (946), carbophenothion (947), carbosulfan (119), cartap (123), cartap hydrochloride (123), cevadine (alternative name) (725), chlorbicyclen (960), chlordane (128), chlordecone (963), chlordimeform (964), chlordimeform hydrochloride (964), chlorethoxyfos (129), chlorfenapyr (130), chlorfenvinphos (131), chlorfluazuron (132), chlormephos (136), chloroform [CCN], chloropicrin (141), chlorphoxim (989), chlorprazophos (990), chlorpyrifos (145), chlorpyrifos-methyl (146), chlorthiophos (994), chromafenozide (150), cinerin I (696), cinerin II (696), cinerins (696), cis-resmethrin (alternative name), cismethrin (80), clocythrin (alternative name), cloethocarb (999), closantel (alternative name) [CCN], clothianidin (165), copper acetoarsenite [CCN], copper arsenate [CCN], copper oleate [CCN], coumaphos (174), coumithoate (1006), crotamiton (alternative name) [CCN], crotoxyphos (1010), crufomate (1011), cryolite (alternative name) (177), CS 708 (development code) (1012), cyanofenphos (1019), cyanophos (184), cyanthoate (1020), cyclethrin [CCN], cycloprothrin (188), cyfluthrin (193), cyhalothrin (196), cypermethrin (201), cyphenothrin (206), cyromazine (209), cythioate (alternative name) [CCN], d-limonene (alternative name) [CCN], d-tetramethrin (alternative name) (788), DAEP (1031), dazomet (216), DDT (219), decarbofuran (1034), deltamethrin (223), demephion (1037), demephion-O (1037), demephion-S (1037), demeton (1038), demeton-methyl (224), demeton-O (1038), demeton-O-methyl (224), demeton-S (1038), demeton-5-methyl (224), demeton-5-methylsulphon (1039), diafenthiuron (226), dialifos (1042), diamidafos (1044), diazinon (227), dicapthon (1050), dichlofenthion (1051), dichlorvos (236), dicliphos (alternative name), dicresyl (alternative name) [CCN], dicrotophos (243), dicyclanil (244), dieldrin (1070), diethyl 5-methylpyrazol-3-yl phosphate (IUPAC name) (1076), diflubenzuron (250), dilor (alternative name) [CCN], dimefluthrin [CCN], dimefox (1081), dimetan (1085), dimethoate (262), dimethrin (1083), dimethylvinphos (265), dimetilan (1086), dinex (1089), dinex-diclexine (1089), dinoprop (1093), dinosam (1094), dinoseb (1095), dinotefuran (271), diofenolan (1099), dioxabenzofos (1100), dioxacarb (1101), dioxathion (1102), disulfoton (278), dithicrofos (1108), DNOC (282), doramectin (alternative name) [CCN], DSP (1115), ecdysterone (alternative name) [CCN], EI 1642 (development code) (1118), emamectin (291), emamectin benzoate (291), EMPC (1120), empenthrin (292), endosulfan (294), endothion (1121), endrin (1122), EPBP (1123), EPN (297), epofenonane (1124), eprinomectin (alternative name) [CCN], esfenvalerate (302), etaphos (alternative name) [CCN], ethiofencarb (308), ethion (309), ethiprole (310), ethoate-methyl (1134), ethoprophos (312), ethyl formate (IUPAC name) [CCN], ethyl-DDD (alternative name) (1056), ethylene dibromide (316), ethylene dichloride (chemical name) (1136), ethylene oxide [CCN], etofenprox (319), etrimfos (1142), EXD (1143), famphur (323), fenamiphos (326), fenazaflor (1147), fenchlorphos (1148), fenethacarb (1149), fenfluthrin (1150), fenitrothion (335), fenobucarb (336), fenoxacrim (1153), fenoxycarb (340), fenpirithrin (1155), fenpropathrin (342), fenpyrad (alternative name), fensulfothion (1158), fenthion (346), fenthion-ethyl [CCN], fenvalerate (349), fipronil (354), flonicamid (358), flucofuron (1168), flucycloxuron (366), flucythrinate (367), fluenetil (1169), flufenerim [CCN], flufenoxuron (370), flufenprox (1171), flumethrin (372), fluvalinate (1184), FMC 1137 (development code) (1185), fonofos (1191), formetanate (405), formetanate hydrochloride (405), formothion (1192), formparanate (1193), fosmethilan (1194), fospirate (1195), fosthiazate (408), fosthietan (1196), furathiocarb (412), furethrin (1200), gamma-cyhalothrin (197), gamma-HCH (430), guazatine (422), guazatine acetates (422), GY-81 (development code) (423), halfenprox (424), halofenozide (425), HCH (430), HEOD (1070), heptachlor (1211), heptenophos (432), heterophos [CCN], hexaflumuron (439), HHDN (864), hydramethylnon (443), hydrogen cyamide (444), hydroprene (445), hyquincarb (1223), imidacloprid (458), imiprothrin (460), indoxacarb (465), iodomethane (IUPAC name) (542), IPSP (1229), isazofos (1231), isobenzan (1232), isocarbophos (alternative name) (473), isodrin (1235), isofenphos (1236), isolane (1237), isoprocarb (472), isopropyl O-(methoxyaminothiophosphoryl)salicylate (IUPAC name) (473), isoprothiolane (474), isothioate (1244), isoxathion (480), ivermectin (alternative name) [CCN], jasmolin I (696), jasmolin II (696), jodfenphos (1248), juvenile hormone I (alternative name) [CCN], juvenile hormone II (alternative name) [CCN], juvenile hormone III (alternative name) [CCN], kelevan (1249), kinoprene (484), lambda-cyhalothrin (198), lead arsenate [CCN], leptophos (1250), lindane (430), lirimfos (1251), lufenuron (490), lythidathion (1253), m-cumenyl methylcarbamate (IUPAC name) (1014), magnesium phosphide (IUPAC name) (640), malathion (492), malonoben (1254), mazidox (1255), mecarbam (502), mecarphon (1258), menazon (1260), mephosfolan (1261), mercurous chloride (513), mesulfenfos (1263), metam (519), metam-potassium (alternative name) (519), metam-sodium (519), methacrifos (1266), methamidophos (527), methanesulfonyl fluoride (IUPAC/Chemical Abstracts name) (1268), methidathion (529), methiocarb (530), methocrotophos (1273), methomyl (531), methoprene (532), methoquin-butyl (1276), methothrin (alternative name) (533), methoxychlor (534), methoxyfenozide (535), methyl bromide (537), methyl isothiocyanate (543), methylchloroform (alternative name) [CCN], methylene chloride [CCN], metofluthrin [CCN], metolcarb (550), metoxadiazone (1288), mevinphos (556), mexacarbate (1290), milbemectin (557), milbemycin oxime (alternative name) [CCN], mipafox (1293), mirex (1294), monocrotophos (561), morphothion (1300), moxidectin (alternative name) [CCN], naftalofos (alternative name) [CCN], naled (567), naphthalene (IUPAC/Chemical Abstracts name) (1303), NC-170 (development code) (1306), NC-184 (compound code), nicotine (578), nicotine sulfate (578), nifluridide (1309), nitenpyram (579), nithiazine (1311), nitrilacarb (1313), nitrilacarb 1:1 zinc chloride complex (1313), NNI-0101 (compound code), NNI-0250 (compound code), nornicotine (traditional name) (1319), novaluron (585), noviflumuron (586), O-2,5-dichloro-4-iodophenyl O-ethyl ethylphosphonothioate (IUPAC name) (1057), O,O-diethyl O-4-methyl-2-oxo-2H-chromen-7-yl phosphorothioate (IUPAC name) (1074), O,O-diethyl O-6-methyl-2-propylpyrimidin-4-yl phosphorothioate (IUPAC name) (1075), O,O,O′,O′-tetrapropyl dithiopyrophosphate (IUPAC name) (1424), oleic acid (IUPAC name) (593), omethoate (594), oxamyl (602), oxydemeton-methyl (609), oxydeprofos (1324), oxydisulfoton (1325), pp′-DDT (219), para-dichlorobenzene [CCN], parathion (615), parathion-methyl (616), penfluoron (alternative name) [CCN], pentachlorophenol (623), pentachlorophenyl laurate (IUPAC name) (623), permethrin (626), petroleum oils (alternative name) (628), PH 60-38 (development code) (1328), phenkapton (1330), phenothrin (630), phenthoate (631), phorate (636), phosalone (637), phosfolan (1338), phosmet (638), phosnichlor (1339), phosphamidon (639), phosphine (IUPAC name) (640), phoxim (642), phoxim-methyl (1340), pirimetaphos (1344), pirimicarb (651), pirimiphos-ethyl (1345), pirimiphos-methyl (652), polychlorodicyclopentadiene isomers (IUPAC name) (1346), polychloroterpenes (traditional name) (1347), potassium arsenite [CCN], potassium thiocyanate [CCN], prallethrin (655), precocene I (alternative name) [CCN], precocene II (alternative name) [CCN], precocene III (alternative name) [CCN], primidophos (1349), profenofos (662), profluthrin [CCN], promacyl (1354), promecarb (1355), propaphos (1356), propetamphos (673), propoxur (678), prothidathion (1360), prothiofos (686), prothoate (1362), protrifenbute [CCN], pymetrozine (688), pyraclofos (689), pyrazophos (693), pyresmethrin (1367), pyrethrin I (696), pyrethrin II (696), pyrethrins (696), pyridaben (699), pyridalyl (700), pyridaphenthion (701), pyrimidifen (706), pyrimitate (1370), pyriproxyfen (708), quassia (alternative name) [CCN], quinalphos (711), quinalphos-methyl (1376), quinothion (1380), quintiofos (1381), R-1492 (development code) (1382), rafoxanide (alternative name) [CCN], resmethrin (719), rotenone (722), RU 15525 (development code) (723), RU 25475 (development code) (1386), ryania (alternative name) (1387), ryanodine (traditional name) (1387), sabadilla (alternative name) (725), schradan (1389), sebufos (alternative name), selamectin (alternative name) [CCN], SI-0009 (compound code), silafluofen (728), SN 72129 (development code) (1397), sodium arsenite [CCN], sodium cyamide (444), sodium fluoride (IUPAC/Chemical Abstracts name) (1399), sodium hexafluorosilicate (1400), sodium pentachlorophenoxide (623), sodium selenate (IUPAC name) (1401), sodium thiocyanate [CCN], sophamide (1402), spinosad (737), spiromesifen (739), sulcofuron (746), sulcofuron-sodium (746), sulfluramid (750), sulfotep (753), sulfuryl fluoride (756), sulprofos (1408), tar oils (alternative name) (758), tau-fluvalinate (398), tazimcarb (1412), TDE (1414), tebufenozide (762), tebufenpyrad (763), tebupirimfos (764), teflubenzuron (768), tefluthrin (769), temephos (770), TEPP (1417), terallethrin (1418), terbam (alternative name), terbufos (773), tetrachloroethane [CCN], tetrachlorvinphos (777), tetramethrin (787), theta-cypermethrin (204), thiacloprid (791), thiafenox (alternative name), thiamethoxam (792), thicrofos (1428), thiocarboxime (1431), thiocyclam (798), thiocyclam hydrogen oxalate (798), thiodicarb (799), thiofanox (800), thiometon (801), thionazin (1434), thiosultap (803), thiosultap-sodium (803), thuringiensin (alternative name) [CCN], tolfenpyrad (809), tralomethrin (812), transfluthrin (813), transpermethrin (1440), triamiphos (1441), triazamate (818), triazophos (820), triazuron (alternative name), trichlorfon (824), trichlormetaphos-3 (alternative name) [CCN], trichloronat (1452), trifenofos (1455), triflumuron (835), trimethacarb (840), triprene (1459), vamidothion (847), vaniliprole [CCN], veratridine (alternative name) (725), veratrine (alternative name) (725), XMC (853), xylylcarb (854), YI-5302 (compound code), zeta-cypermethrin (205), zetamethrin (alternative name), zinc phosphide (640), zolaprofos (1469) and ZXI 8901 (development code) (858),
a molluscicide selected from the group of substances consisting of bis(tributyltin)oxide (IUPAC name) (913), bromoacetamide [CCN], calcium arsenate [CCN], cloethocarb (999), copper acetoarsenite [CCN], copper sulfate (172), fentin (347), ferric phosphate (IUPAC name) (352), metaldehyde (518), methiocarb (530), niclosamide (576), niclosamide-olamine (576), pentachlorophenol (623), sodium pentachlorophenoxide (623), tazimcarb (1412), thiodicarb (799), tributyltin oxide (913), trifenmorph (1454), trimethacarb (840), triphenyltin acetate (IUPAC name) (347) and triphenyltin hydroxide (IUPAC name) (347),
a nematicide selected from the group of substances consisting of 1,2-dibromo-3-chloropropane (IUPAC/Chemical Abstracts name) (1045), 1,2-dichloropropane (IUPAC/Chemical Abstracts name) (1062), 1,2-dichloropropane with 1,3-dichloropropene (IUPAC name) (1063), 1,3-dichloropropene (233), 3,4-dichlorotetrahydrothiophene 1,1-dioxide (IUPAC/Chemical Abstracts name) (1065), 3-(4-chlorophenyl)-5-methylrhodanine (IUPAC name) (980), 5-methyl-6-thioxo-1,3,5-thiadiazinan-3-ylacetic acid (IUPAC name) (1286), 6-isopentenylaminopurine (alternative name) (210), abamectin (1), acetoprole [CCN], alanycarb (15), aldicarb (16), aldoxycarb (863), AZ 60541 (compound code), benclothiaz [CCN], benomyl (62), butylpyridaben (alternative name), cadusafos (109), carbofuran (118), carbon disulfide (945), carbosulfan (119), chloropicrin (141), chlorpyrifos (145), cloethocarb (999), cytokinins (alternative name) (210), dazomet (216), DBCP (1045), DCIP (218), diamidafos (1044), dichlofenthion (1051), dicliphos (alternative name), dimethoate (262), doramectin (alternative name) [CCN], emamectin (291), emamectin benzoate (291), eprinomectin (alternative name) [CCN], ethoprophos (312), ethylene dibromide (316), fenamiphos (326), fenpyrad (alternative name), fensulfothion (1158), fosthiazate (408), fosthietan (1196), furfural (alternative name) [CCN], GY-81 (development code) (423), heterophos [CCN], iodomethane (IUPAC name) (542), isamidofos (1230), isazofos (1231), ivermectin (alternative name) [CCN], kinetin (alternative name) (210), mecarphon (1258), metam (519), metam-potassium (alternative name) (519), metam-sodium (519), methyl bromide (537), methyl isothiocyanate (543), milbemycin oxime (alternative name) [CCN], moxidectin (alternative name) [CCN], Myrothecium verrucaria composition (alternative name) (565), NC-184 (compound code), oxamyl (602), phorate (636), phosphamidon (639), phosphocarb [CCN], sebufos (alternative name), selamectin (alternative name) [CCN], spinosad (737), terbam (alternative name), terbufos (773), tetrachlorothiophene (IUPAC/Chemical Abstracts name) (1422), thiafenox (alternative name), thionazin (1434), triazophos (820), triazuron (alternative name), xylenols [CCN], YI-5302 (compound code) and zeatin (alternative name) (210),
a nitrification inhibitor selected from the group of substances consisting of potassium ethylxanthate [CCN] and nitrapyrin (580),
a plant activator selected from the group of substances consisting of acibenzolar (6), acibenzolar-5-methyl (6), probenazole (658) and Reynoutria sachalinensis extract (alternative name) (720),
a rodenticide selected from the group of substances consisting of 2-isovalerylindan-1,3-dione (IUPAC name) (1246), 4-(quinoxalin-2-ylamino)benzenesulfonamide (IUPAC name) (748), alpha-chlorohydrin [CCN], aluminium phosphide (640), antu (880), arsenous oxide (882), barium carbonate (891), bisthiosemi (912), brodifacoum (89), bromadiolone (91), bromethalin (92), calcium cyamide (444), chloralose (127), chlorophacinone (140), cholecalciferol (alternative name) (850), coumachlor (1004), coumafuryl (1005), coumatetralyl (175), crimidine (1009), difenacoum (246), difethialone (249), diphacinone (273), ergocalciferol (301), flocoumafen (357), fluoroacetamide (379), flupropadine (1183), flupropadine hydrochloride (1183), gamma-HCH (430), HCH (430), hydrogen cyamide (444), iodomethane (IUPAC name) (542), lindane (430), magnesium phosphide (IUPAC name) (640), methyl bromide (537), norbormide (1318), phosacetim (1336), phosphine (IUPAC name) (640), phosphorus [CCN], pindone (1341), potassium arsenite [CCN], pyrinuron (1371), scilliroside (1390), sodium arsenite [CCN], sodium cyamide (444), sodium fluoro-acetate (735), strychnine (745), thallium sulfate [CCN], warfarin (851) and zinc phosphide (640),
a synergist selected from the group of substances consisting of 2-(2-butoxyethoxy)ethyl piperonylate (IUPAC name) (934), 5-(1,3-benzodioxol-5-yl)-3-hexylcyclohex-2-enone (IUPAC name) (903), farnesol with nerolidol (alternative name) (324), MB-599 (development code) (498), MGK 264 (development code) (296), piperonyl butoxide (649), piprotal (1343), propyl isomer (1358), S421 (development code) (724), sesamex (1393), sesasmolin (1394) and sulfoxide (1406),
an animal repellent selected from the group of substances consisting of anthraquinone (32), chloralose (127), copper naphthenate [CCN], copper oxychloride (171), diazinon (227), dicyclopentadiene (chemical name) (1069), guazatine (422), guazatine acetates (422), methiocarb (530), pyridin-4-amine (IUPAC name) (23), thiram (804), trimethacarb (840), zinc naphthenate [CCN] and ziram (856),
a virucide selected from the group of substances consisting of imanin (alternative name) [CCN] and ribavirin (alternative name) [CCN],
and a wound protectant selected from the group of substances consisting of mercuric oxide (512), octhilinone (590) and thiophanate-methyl (802).

A very especially preferred embodiment of the subject-matter {1.1.2} of the invention is {1.1.2.2} a pesticidal composition comprising a mixture consisting of at least two substances, namely one compound (A) and at least one compound (B), as active ingredient and at least one auxiliary, wherein the compound (A) is the compound of formula (A-2) and the compound (B) is a compound selected from the group of substances consisting of abamectin (1), cyromazine (209), diafenthiuron (226), diazinon (227), emamectin benzoate (291), fenoxycarb (340), fosthiazate (408), lambda-cyhalothrin (198), lufenuron (490), methidathion (529), profenofos (662), pymetrozine (688), tefluthrin (769) and thiamethoxam (792).

The compound of formula (A-2) is known, for example, from the PCT Application WO-03/015519.

A preferred embodiment of the subject-matter {1.1} of the invention is {1.1.3} a pesticidal composition comprising a mixture consisting of at least two substances, namely one compound (A) and at least one compound (B), as active ingredient and at least one auxiliary, wherein the compound (A) is the compound of formula (A-3) 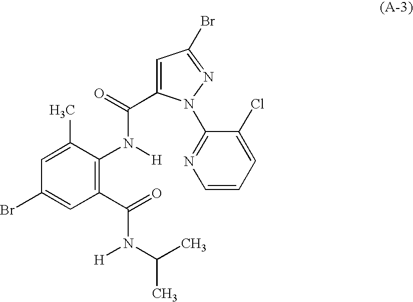
and the compound (B) is a compound selected from the group of substances consisting of an adjuvant, an acaricide, an algicide, an anthelmintic, an avicide, a bactericide, a biological agent, a soil sterilant, a chemosterilant, an insect pheromone, an insect repellent, an insecticide, a molluscicide, a nematicide, a nitrification inhibitor, a plant activator, a rodenticide, a synergist, an animal repellent, a virucide and a wound protectant.

An especially preferred embodiment of the subject-matter {1.1.3} of the invention is {1.1.3.1} a pesticidal composition comprising a mixture consisting of at least two substances, namely one compound (A) and at least one compound (B), as active ingredient and at least one auxiliary, wherein the compound (A) is the compound of formula (A-3) and the compound (B) is a compound selected from the group of substances consisting of
an adjuvant selected from the group of substances consisting of petroleum oils (alternative name) (628),
an acaricide selected from the group of substances consisting of 1,1-bis(4-chlorophenyl)-2-ethoxyethanol (IUPAC name) (910), 2,4-dichlorophenyl benzenesulfonate (IUPAC/Chemical Abstracts name) (1059), 2-fluoro-N-methyl-N-1-naphthylacetamide (IUPAC name) (1295), 4-chlorophenyl phenyl sulfone (IUPAC name) (981), abamectin (1), acequinocyl (3), acetoprole [CCN], acrinathrin (9), aldicarb (16), aldoxycarb (863), alpha-cypermethrin (202), amidithion (870), amidoflumet [CCN], amidothioate (872), amiton (875), amiton hydrogen oxalate (875), amitraz (24), aramite (881), arsenous oxide (882), AVI 382 (compound code), AZ 60541 (compound code), azinphos-ethyl (44), azinphos-methyl (45), azobenzene (IUPAC name) (888), azocyclotin (46), azothoate (889), benomyl (62), benoxafos (alternative name) [CCN], benzoximate (71), benzyl benzoate (IUPAC name) [CCN], bifenazate (74), bifenthrin (76), binapacryl (907), brofenvalerate (alternative name), bromocyclen (918), bromophos (920), bromophos-ethyl (921), bromopropylate (94), buprofezin (99), butocarboxim (103), butoxycarboxim (104), butylpyridaben (alternative name), calcium polysulfide (IUPAC name) (111), camphechlor (941), carbanolate (943), carbaryl (115), carbofuran (118), carbophenothion (947), CGA 50'439 (development code) (125), chinomethionat (126), chlorbenside (959), chlordimeform (964), chlordimeform hydrochloride (964), chlorfenapyr (130), chlorfenethol (968), chlorfenson (970), chlorfensulphide (971), chlorfenvinphos (131), chlorobenzilate (975), chloromebuform (977), chloromethiuron (978), chloropropylate (983), chlorpyrifos (145), chlorpyrifos-methyl (146), chlorthiophos (994), cinerin I (696), cinerin II (696), cinerins (696), clofentezine (158), closantel (alternative name) [CCN], coumaphos (174), crotamiton (alternative name) [CCN], crotoxyphos (1010), cufraneb (1013), cyanthoate (1020), cyhalothrin (196), cyhexatin (199), cypermethrin (201), DCPM (1032), DDT (219), demephion (1037), demephion-O (1037), demephion-S (1037), demeton (1038), demeton-methyl (224), demeton-O (1038), demeton-O-methyl (224), demeton-S (1038), demeton-5-methyl (224), demeton-5-methylsulphon (1039), diafenthiuron (226), dialifos (1042), diazinon (227), dichlofluanid (230), dichlorvos (236), dicliphos (alternative name), dicofol (242), dicrotophos (243), dienochlor (1071), dimefox (1081), dimethoate (262), dinactin (alternative name) (653), dinex (1089), dinex-diclexine (1089), dinobuton (269), dinocap (270), dinocap-4 [CCN], dinocap-6 [CCN], dinocton (1090), dinopenton (1092), dinosulfon (1097), dinoterbon (1098), dioxathion (1102), diphenyl sulfone. (IUPAC name) (1103), disulfuram (alternative name) [CCN], disulfoton (278), DNOC (282), dofenapyn (1113), doramectin (alternative name) [CCN], endosulfan (294), endothion (1121), EPN (297), eprinomectin (alternative name) [CCN], ethion (309), ethoate-methyl (1134), etoxazole (320), etrimfos (1142), fenazaflor (1147), fenazaquin (328), fenbutatin oxide (330), fenothiocarb (337), fenpropathrin (342), fenpyrad (alternative name), fenpyroximate (345), fenson (1157), fentrifanil (1161), fenvalerate (349), fipronil (354), fluacrypyrim (360), fluazuron (1166), flubenzimine (1167), flucycloxuron (366), flucythrinate (367), fluenetil (1169), flufenoxuron (370), flumethrin (372), fluorbenside (1174), fluvalinate (1184), FMC 1137 (development code) (1185), formetanate (405), formetanate hydrochloride (405), formothion (1192), formparanate (1193), gamma-HCH (430), glyodin (1205), halfenprox (424), heptenophos (432), hexadecyl cyclopropanecarboxylate (IUPAC/Chemical Abstracts name) (1216), hexythiazox (441), iodomethane (IUPAC name) (542), isocarbophos (alternative name) (473), isopropyl O-(methoxyaminothiophosphoryl)salicylate (IUPAC name) (473), ivermectin (alternative name) [CCN], jasmolin I (696), jasmolin II (696), jodfenphos (1248), lindane (430), lufenuron (490), malathion (492), malonoben (1254), mecarbam (502), mephosfolan (1261), mesulfen (alternative name) [CCN], methacrifos (1266), methamidophos (527), methidathion (529), methiocarb (530), methomyl (531), methyl bromide (537), metolcarb (550), mevinphos (556), mexacarbate (1290), milbemectin (557), milbemycin oxime (alternative name) [CCN], mipafox (1293), monocrotophos (561), morphothion (1300), moxidectin (alternative name) [CCN], naled (567), NC-184 (compound code), nifluridide (1309), nikkomycins (alternative name) [CCN], nitrilacarb (1313), nitrilacarb 1:1 zinc chloride complex (1313), NNI-0101 (compound code), NNI-0250 (compound code), omethoate (594), oxamyl (602), oxydeprofos (1324), oxydisulfoton (1325), pp′-DDT (219), parathion (615), permethrin (626), petroleum oils (alternative name) (628), phenkapton (1330), phenthoate (631), phorate (636), phosalone (637), phosfolan (1338), phosmet (638), phosphamidon (639), phoxim (642), pirimiphos-methyl (652), polychloroterpenes (traditional name) (1347), polynactins (alternative name) (653), proclonol (1350), profenofos (662), promacyl (1354), propargite (671), propetamphos (673), propoxur (678), prothidathion (1360), prothoate (1362), pyrethrin I (696), pyrethrin II (696), pyrethrins (696), pyridaben (699), pyridaphenthion (701), pyrimidifen (706), pyrimitate (1370), quinalphos (711), quintiofos (1381), R-1492 (development code) (1382), RA-17 (development code) (1383), rotenone (722), schradan (1389), sebufos (alternative name), selamectin (alternative name) [CCN], SI-0009 (compound code), sophamide (1402), spirodiclofen (738), spiromesifen (739), SSI-121 (development code) (1404), sulfuram (alternative name) [CCN], sulfluramid (750), sulfotep (753), sulfur (754), SZI-121 (development code) (757), tau-fluvalinate (398), tebufenpyrad (763), TEPP (1417), terbam (alternative name), tetrachlorvinphos (777), tetradifon (786), tetranactin (alternative name) (653), tetrasul (1425), thiafenox (alternative name), thiocarboxime (1431), thiofanox (800), thiometon (801), thioquinox (1436), thuringiensin (alternative name) [CCN], triamiphos (1441), triarathene (1443), triazophos (820), triazuron (alternative name), trichlorfon (824), trifenofos (1455), trinactin (alternative name) (653), vamidothion (847), vaniliprole [CCN] and YI-5302 (compound code),
an algicide selected from the group of substances consisting of bethoxazin [CCN], copper dioctanoate (IUPAC name) (170), copper sulfate (172), cybutryne [CCN], dichlone (1052), dichlorophen (232), endothal (295), fentin (347), hydrated lime [CCN], nabam (566), quinoclamine (714), quinonamid (1379), simazine (730), triphenyltin acetate (IUPAC name) (347) and triphenyltin hydroxide (IUPAC name) (347),
an anthelmintic selected from the group of substances consisting of abamectin (1), crufomate (1011), doramectin (alternative name) [CCN], emamectin (291), emamectin benzoate (291), eprinomectin (alternative name) [CCN], ivermectin (alternative name) [CCN], milbemycin oxime (alternative name) [CCN], moxidectin (alternative name) [CCN], piperazine [CCN], selamectin (alternative name) [CCN], spinosad (737) and thiophanate (1435),
an avicide selected from the group of substances consisting of chloralose (127), endrin (1122), fenthion (346), pyridin-4-amine (IUPAC name) (23) and strychnine (745),
a bactericide selected from the group of substances consisting of 1-hydroxy-1H-pyridine-2-thione (IUPAC name) (1222), 4-(quinoxalin-2-ylamino)benzenesulfonamide (IUPAC name) (748), 8-hydroxyquinoline sulfate (446), bronopol (97), copper dioctanoate (IUPAC name) (170), copper hydroxide (IUPAC name) (169), cresol [CCN], dichlorophen (232), dipyrithione (1105), dodicin (1112), fenaminosulf (1144), formaldehyde (404), hydrargaphen (alternative name) [CCN], kasugamycin (483), kasugamycin hydrochloride hydrate (483), nickel bis(dimethyldithiocarbamate) (IUPAC name) (1308), nitrapyrin (580), octhilinone (590), oxolinic acid (606), oxytetracycline (611), potassium hydroxyquinoline sulfate (446), probenazole (658), streptomycin (744), streptomycin sesquisulfate (744), tecloftalam (766) and thiomersal (alternative name) [CCN],
a biological agent selected from the group of substances consisting of Adoxophyes orana GV (alternative name) (12), Agrobacterium radiobacter (alternative name) (13), Amblyseius spp. (alternative name) (19), Anagrapha falcifera NPV (alternative name) (28), Anagrus atomus (alternative name) (29), Aphelinus abdominalis (alternative name) (33), Aphidius colemani (alternative name) (34), Aphidoletes aphidimyza (alternative name) (35), Autographa californica NPV (alternative name) (38), Bacillus firmus (alternative name) (48), Bacillus sphaericus Neide (scientific name) (49), Bacillus thuringiensis Berliner (scientific name) (51), Bacillus thuringiensis subsp. aizawai (scientific name) (51), Bacillus thuringiensis subsp. israelensis (scientific name) (51), Bacillus thuringiensis subsp. japonensis (scientific name) (51), Bacillus thuringiensis subsp. kurstaki (scientific name) (51), Bacillus thuringiensis subsp. tenebrionis (scientific name) (51), Beauveria bassiana (alternative name) (53), Beauveria brongniartii (alternative name) (54), Chrysoperla carnea (alternative name) (151), Cryptolaemus montrouzieri (alternative name) (178), Cydia pomonella GV (alternative name) (191), Dacnusa sibirica (alternative name) (212), Diglyphus isaea (alternative name) (254), Encarsia formosa (scientific name) (293), Eretmocerus eremicus (alternative name) (300), Helicoverpa zea NPV (alternative name) (431), Heterorhabditis bacteriophora and H. megidis (alternative name) (433), Hippodamia convergens (alternative name) (442), Leptomastix dactylopii (alternative name) (488), Macrolophus caliginosus (alternative name) (491), Mamestra brassicae NPV (alternative name) (494), Metaphycus helvolus (alternative name) (522), Metarhizium anisopliae var. acridum (scientific name) (523), Metarhizium anisopliae var. anisopliae (scientific name) (523), Neodiprion sertifer NPV and N. lecontei NPV (alternative name) (575), Orius spp. (alternative name) (596), Paecilomyces fumosoroseus (alternative name) (613), Phytoseiulus persimilis (alternative name) (644), Spodoptera exigua multicapsid nuclear polyhedrosis virus (scientific name) (741), Steinernema bibionis (alternative name) (742), Steinernema carpocapsae (alternative name) (742), Steinernema feltiae (alternative name) (742), Steinernema glaseri (alternative name) (742), Steinernema riobrave (alternative name) (742), Steinernema riobravis (alternative name) (742), Steinernema scapterisci (alternative name) (742), Steinernema spp. (alternative name) (742), Trichogramma spp. (alternative name) (826), Typhlodromus occidentalis (alternative name) (844) and Verticillium lecanii (alternative name) (848),
a soil sterilant selected from the group of substances consisting of iodomethane (IUPAC name) (542) and methyl bromide (537),
a chemosterilant selected from the group of substances consisting of apholate [CCN], bisazir (alternative name) [CCN], busulfan (alternative name) [CCN], diflubenzuron (250), dimatif (alternative name) [CCN], hemel [CCN], hempa [CCN], metepa [CCN], methiotepa [CCN], methyl apholate [CCN], morzid [CCN], penfluoron (alternative name) [CCN], tepa [CCN], thiohempa (alternative name) [CCN], thiotepa (alternative name) [CCN], tretamine (alternative name) [CCN] and uredepa (alternative name) [CCN],
an insect pheromone selected from the group of substances consisting of (E)-dec-5-en-1-yl acetate with (E)-dec-5-en-1-ol (IUPAC name) (222), (E)-tridec-4-en-1-yl acetate (IUPAC name) (829), (E)-6-methylhept-2-en-4-ol (IUPAC name) (541), (E,Z)-tetradeca-4,10-dien-1-yl acetate (IUPAC name) (779), (Z)-dodec-7-en-1-yl acetate (IUPAC name) (285), (Z)-hexadec-11-enal (IUPAC name) (436), (Z)-hexadec-11-en-1-yl acetate (IUPAC name) (437), (Z)-hexadec-13-en-11-yn-1-yl acetate (IUPAC name) (438), (Z)-icos-13-en-10-one (IUPAC name) (448), (Z)-tetradec-7-en-1-al (IUPAC name) (782), (Z)-tetradec-9-en-1-ol (IUPAC name) (783), (Z)-tetradec-9-en-1-yl acetate (IUPAC name) (784), (7E,9Z)-dodeca-7,9-dien-1-yl acetate (IUPAC name) (283), (9Z,11E)-tetradeca-9,11-dien-1-yl acetate (IUPAC name) (780), (9Z,12E)-tetradeca-9,12-dien-1-yl acetate (IUPAC name) (781), 14-methyloctadec-1-ene (IUPAC name) (545), 4-methylnonan-5-ol with 4-methylnonan-5-one (IUPAC name) (544), alpha-multistriatin (alternative name) [CCN], brevicomin (alternative name) [CCN], codlelure (alternative name) [CCN], codlemone (alternative name) (167), cuelure (alternative name) (179), disparlure (277), dodec-8-en-1-yl acetate (IUPAC name) (286), dodec-9-en-1-yl acetate (IUPAC name) (287), dodeca-8,10-dien-1-yl acetate (IUPAC name) (284), dominicalure (alternative name) [CCN], ethyl 4-methyloctanoate (IUPAC name) (317), eugenol (alternative name) [CCN], frontalin (alternative name) [CCN], gossyplure (alternative name) (420), grandlure (421), grandlure I (alternative name) (421), grandlure II (alternative name) (421), grandlure III (alternative name) (421), grandlure IV (alternative name) (421), hexylure [CCN], ipsdienol (alternative name) [CCN], ipsenol (alternative name) [CCN], japonilure (alternative name) (481), lineatin (alternative name) [CCN], litlure (alternative name) [CCN], looplure (alternative name) [CCN], medlure [CCN], megatomoic acid (alternative name) [CCN], methyl eugenol (alternative name) (540), muscalure (563), octadeca-2,13-dien-1-yl acetate (IUPAC name) (588), octadeca-3,13-dien-1-yl acetate (IUPAC name) (589), orfralure (alternative name) [CCN], oryctalure (alternative name) (317), ostramone (alternative name) [CCN], siglure [CCN], sordidin (alternative name) (736), sulcatol (alternative name) [CCN], tetradec-11-en-1-yl acetate (IUPAC name) (785), trimedlure (839), trimedlure A (alternative name) (839), trimedlure B₁ (alternative name) (839), trimedlure B₂ (alternative name) (839), trimedlure C (alternative name) (839) and trunc-call (alternative name) [CCN],
an insect repellent selected from the group of substances consisting of 2-(octylthio)-ethanol (IUPAC name) (591), butopyronoxyl (933), butoxy(polypropylene glycol) (936), dibutyl adipate (IUPAC name) (1046), dibutyl phthalate (1047), dibutyl succinate (IUPAC name) (1048), diethyltoluamide [CCN], dimethyl carbate [CCN], dimethyl phthalate [CCN], ethyl hexanediol (1137), hexamide [CCN], methoquin-butyl (1276), methylneodecanamide [CCN], oxamate [CCN] and picaridin [CCN],
an insecticide selected from the group of substances consisting of 1,1-dichloro-1-nitroethane (IUPAC/Chemical Abstracts name) (1058), 1,1-dichloro-2,2-bis(4-ethylphenyl)-ethane (IUPAC name) (1056), 1,2-dichloropropane (IUPAC/Chemical Abstracts name) (1062), 1,2-dichloropropane with 1,3-dichloropropene (IUPAC name) (1063), 1-bromo-2-chloroethane (IUPAC/Chemical Abstracts name) (916), 2,2,2-trichloro-1-(3,4-dichloro-phenyl)ethyl acetate (IUPAC name) (1451), 2,2-dichlorovinyl 2-ethylsulfinylethyl methyl phosphate (IUPAC name) (1066), 2-(1,3-dithiolan-2-yl)phenyl dimethylcarbamate (IUPAC/Chemical Abstracts name) (1109), 2-(2-butoxyethoxy)ethyl thiocyanate (IUPAC/Chemical Abstracts name) (935), 2-(4,5-dimethyl-1,3-dioxolan-2-yl)phenyl methylcarbamate (IUPAC/Chemical Abstracts name) (1084), 2-(4-chloro-3,5-xylyloxy)ethanol (IUPAC name) (986), 2-chlorovinyl diethyl phosphate (IUPAC name) (984), 2-imidazolidone (IUPAC name) (1225), 2-isovalerylindan-1,3-dione (IUPAC name) (1246), 2-methyl(prop-2-ynyl)aminophenyl methylcarbamate (IUPAC name) (1284), 2-thiocyanatoethyl laurate (IUPAC name) (1433), 3-bromo-1-chloroprop-1-ene (IUPAC name) (917), 3-methyl-1-phenylpyrazol-5-yl dimethyl-carbamate (IUPAC name) (1283), 4-methyl(prop-2-ynyl)amino-3,5-xylyl methylcarbamate (IUPAC name) (1285), 5,5-dimethyl-3-oxocyclohex-1-enyl dimethylcarbamate (IUPAC name) (1085), abamectin (1), acephate (2), acetamiprid (4), acethion (alternative name) [CCN], acetoprole [CCN], acrinathrin (9), acrylonitrile (IUPAC name) (861), alanycarb (15), aldicarb (16), aldoxycarb (863), aldrin (864), allethrin (17), allosamidin (alternative name) [CCN], allyxycarb (866), alpha-cypermethrin (202), alpha-ecdysone (alternative name) [CCN], aluminium phosphide (640), amidithion (870), amidothioate (872), aminocarb (873), amiton (875), amiton hydrogen oxalate (875), amitraz (24), anabasine (877), athidathion (883), AVI 382 (compound code), AZ 60541 (compound code), azadirachtin (alternative name) (41), azamethiphos (42), azinphos-ethyl (44), azinphos-methyl (45), azothoate (889), Bacillus thuringiensis delta endotoxins (alternative name) (52), barium hexafluorosilicate (alternative name) [CCN], barium polysulfide (IUPAC/Chemical Abstracts name) (892), barthrin [CCN], BAS 320 I (compound code), Bayer 22/190 (development code) (893), Bayer 22408 (development code) (894), bendiocarb (58), benfuracarb (60), bensultap (66), beta-cyfluthrin (194), beta-cypermethrin (203), bifenthrin (76), bioallethrin (78), bioallethrin S-cyclopentenyl isomer (alternative name) (79), bioethanomethrin [CCN], biopermethrin (908), bioresmethrin (80), bis(2-chloroethyl)ether (IUPAC name) (909), bistrifluoron (83), borax (86), brofenvalerate (alternative name), bromfenvinfos (914), bromocyclen (918), bromo-DDT (alternative name) [CCN], bromophos (920), bromophos-ethyl (921), bufencarb (924), buprofezin (99), butacarb (926), butathiofos (927), butocarboxim (103), butonate (932), butoxycarboxim (104), butylpyridaben (alternative name), cadusafos (109), calcium arsenate [CCN], calcium cyamide (444), calcium polysulfide (IUPAC name) (111), camphechlor (941), carbanolate (943), carbaryl (115), carbofuran (118), carbon disulfide (IUPAC/Chemical Abstracts name) (945), carbon tetrachloride (IUPAC name) (946), carbophenothion (947), carbosulfan (119), cartap (123), cartap hydrochloride (123), cevadine (alternative name) (725), chlorbicyclen (960), chlordane (128), chlordecone (963), chlordimeform (964), chlordimeform hydrochloride (964), chlorethoxyfos (129), chlorfenapyr (130), chlorfenvinphos (131), chlorfluazuron (132), chlormephos (136), chloroform [CCN], chloropicrin (141), chlorphoxim (989), chlorprazophos (990), chlorpyrifos (145), chlorpyrifos-methyl (146), chlorthiophos (994), chromafenozide (150), cinerin I (696), cinerin II (696), cinerins (696), cis-resmethrin (alternative name), cismethrin (80), clocythrin (alternative name), cloethocarb (999), closantel (alternative name) [CCN], clothianidin (165), copper acetoarsenite [CCN], copper arsenate [CCN], copper oleate [CCN], coumaphos (174), coumithoate (1006), crotamiton (alternative name) [CCN], crotoxyphos (1010), crufomate (1011), cryolite (alternative name) (177), CS 708 (development code) (1012), cyanofenphos (1019), cyanophos (184), cyanthoate (1020), cyclethrin [CCN], cycloprothrin (188), cyfluthrin (193), cyhalothrin (196), cypermethrin (201), cyphenothrin (206), cyromazine (209), cythioate (alternative name) [CCN], d-limonene (alternative name) [CCN], d-tetramethrin (alternative name) (788), DAEP (1031), dazomet (216), DDT (219), decarbofuran (1034), deltamethrin (223), demephion (1037), demephion-O (1037), demephion-S (1037), demeton (1038), demeton-methyl (224), demeton-O (1038), demeton-O-methyl (224), demeton-S (1038), demeton-5-methyl (224), demeton-5-methylsulphon (1039), diafenthiuron (226), dialifos (1042), diamidafos (1044), diazinon (227), dicapthon (1050), dichlofenthion (1051), dichlorvos (236), dicliphos (alternative name), dicresyl (alternative name) [CCN], dicrotophos (243), dicyclanil (244), dieldrin (1070), diethyl 5-methylpyrazol-3-yl phosphate (IUPAC name) (1076), diflubenzuron (250), dilor (alternative name) [CCN], dimefluthrin [CCN], dimefox (1081), dimetan (1085), dimethoate (262), dimethrin (1083), dimethylvinphos (265), dimetilan (1086), dinex (1089), dinex-diclexine (1089), dinoprop (1093), dinosam (1094), dinoseb (1095), dinotefuran (271), diofenolan (1099), dioxabenzofos (1100), dioxacarb (1101), dioxathion (1102), disulfoton (278), dithicrofos (1108), DNOC (282), doramectin (alternative name) [CCN], DSP (1115), ecdysterone (alternative name) [CCN], EI 1642 (development code) (1118), emamectin (291), emamectin benzoate (291), EMPC (1120), empenthrin (292), endosulfan (294), endothion (1121), endrin (1122), EPBP (1123), EPN (297), epofenonane (1124), eprinomectin (alternative name) [CCN], esfenvalerate (302), etaphos (alternative name) [CCN], ethiofencarb (308), ethion (309), ethiprole (310), ethoate-methyl (1134), ethoprophos (312), ethyl formate (IUPAC name) [CCN], ethyl-DDD (alternative name) (1056), ethylene dibromide (316), ethylene dichloride (chemical name) (1136), ethylene oxide [CCN], etofenprox (319), etrimfos (1142), EXD (1143), famphur (323), fenamiphos (326), fenazaflor (1147), fenchlorphos (1148), fenethacarb (1149), fenfluthrin (1150), fenitrothion (335), fenobucarb (336), fenoxacrim (1153), fenoxycarb (340), fenpirithrin (1155), fenpropathrin (342), fenpyrad (alternative name), fensulfothion (1158), fenthion (346), fenthion-ethyl [CCN], fenvalerate (349), fipronil (354), flonicamid (358), flucofuron (1168), flucycloxuron (366), flucythrinate (367), fluenetil (1169), flufenerim [CCN], flufenoxuron (370), flufenprox (1171), flumethrin (372), fluvalinate (1184), FMC 1137 (development code) (1185), fonofos (1191), formetanate (405), formetanate hydrochloride (405), formothion (1192), formparanate (1193), fosmethilan (1194), fospirate (1195), fosthiazate (408), fosthietan (1196), furathiocarb (412), furethrin (1200), gamma-cyhalothrin (197), gamma-HCH (430), guazatine (422), guazatine acetates (422), GY-81 (development code) (423), halfenprox (424), halofenozide (425), HCH (430), HEOD (1070), heptachlor (1211), heptenophos (432), heterophos [CCN], hexaflumuron (439), HHDN (864), hydramethylnon (443), hydrogen cyamide (444), hydroprene (445), hyquincarb (1223), imidacloprid (458), imiprothrin (460), indoxacarb (465), iodomethane (IUPAC name) (542), IPSP (1229), isazofos (1231), isobenzan (1232), isocarbophos (alternative name) (473), isodrin (1235), isofenphos (1236), isolane (1237), isoprocarb (472), isopropyl O-(methoxyaminothiophosphoryl)salicylate (IUPAC name) (473), isoprothiolane (474), isothioate (1244), isoxathion (480), ivermectin (alternative name) [CCN], jasmolin I (696), jasmolin II (696), jodfenphos (1248), juvenile hormone I (alternative name) [CCN], juvenile hormone II (alternative name) [CCN], juvenile hormone III (alternative name) [CCN], kelevan (1249), kinoprene (484), lambda-cyhalothrin (198), lead arsenate [CCN], leptophos (1250), lindane (430), lirimfos (1251), lufenuron (490), lythidathion (1253), m-cumenyl methylcarbamate (IUPAC name) (1014), magnesium phosphide (IUPAC name) (640), malathion (492), malonoben (1254), mazidox (1255), mecarbam (502), mecarphon (1258), menazon (1260), mephosfolan (1261), mercurous chloride (513), mesulfenfos (1263), metam (519), metam-potassium (alternative name) (519), metam-sodium (519), methacrifos (1266), methamidophos (527), methanesulfonyl fluoride (IUPAC/Chemical Abstracts name) (1268), methidathion (529), methiocarb (530), methocrotophos (1273), methomyl (531), methoprene (532), methoquin-butyl (1276), methothrin (alternative name) (533), methoxychlor (534), methoxyfenozide (535), methyl bromide (537), methyl isothiocyanate (543), methylchloroform (alternative name) [CCN], methylene chloride [CCN], metofluthrin [CCN], metolcarb (550), metoxadiazone (1288), mevinphos (556), mexacarbate (1290), milbemectin (557), milbemycin oxime (alternative name) [CCN], mipafox (1293), mirex (1294), monocrotophos (561), morphothion (1300), moxidectin (alternative name) [CCN], naftalofos (alternative name) [CCN], naled (567), naphthalene (IUPAC/Chemical Abstracts name) (1303), NC-170 (development code) (1306), NC-184 (compound code), nicotine (578), nicotine sulfate (578), nifluridide (1309), nitenpyram (579), nithiazine (1311), nitrilacarb (1313), nitrilacarb 1:1 zinc chloride complex (1313), NNI-0101 (compound code), NNI-0250 (compound code), nornicotine (traditional name) (1319), novaluron (585), noviflumuron (586), O-2,5-dichloro-4-iodophenyl O-ethyl ethylphosphonothioate (IUPAC name) (1057), O,O-diethyl O-4-methyl-2-oxo-2H-chromen-7-yl phosphorothioate (IUPAC name) (1074), O,O-diethyl O-6-methyl-2-propylpyrimidin-4-yl phosphorothioate (IUPAC name) (1075), O,O,O′,O′-tetrapropyl dithiopyrophosphate (IUPAC name) (1424), oleic acid (IUPAC name) (593), omethoate (594), oxamyl (602), oxydemeton-methyl (609), oxydeprofos (1324), oxydisulfoton (1325), pp′-DDT (219), para-dichlorobenzene [CCN], parathion (615), parathion-methyl (616), penfluoron (alternative name) [CCN], pentachlorophenol (623), pentachlorophenyl laurate (IUPAC name) (623), permethrin (626), petroleum oils (alternative name) (628), PH 60-38 (development code) (1328), phenkapton (1330), phenothrin (630), phenthoate (631), phorate (636), phosalone (637), phosfolan (1338), phosmet (638), phosnichlor (1339), phosphamidon (639), phosphine (IUPAC name) (640), phoxim (642), phoxim-methyl (1340), pirimetaphos (1344), pirimicarb (651), pirimiphos-ethyl (1345), pirimiphos-methyl (652), polychlorodicyclopentadiene isomers (IUPAC name) (1346), polychloroterpenes (traditional name) (1347), potassium arsenite [CCN], potassium thiocyanate [CCN], prallethrin (655), precocene I (alternative name) [CCN], precocene II (alternative name) [CCN], precocene III (alternative name) [CCN], primidophos (1349), profenofos (662), profluthrin [CCN], promacyl (1354), promecarb (1355), propaphos (1356), propetamphos (673), propoxur (678), prothidathion (1360), prothiofos (686), prothoate (1362), protrifenbute [CCN], pymetrozine (688), pyraclofos (689), pyrazophos (693), pyresmethrin (1367), pyrethrin I (696), pyrethrin II (696), pyrethrins (696), pyridaben (699), pyridalyl (700), pyridaphenthion (701), pyrimidifen (706), pyrimitate (1370), pyriproxyfen (708), quassia (alternative name) [CCN], quinalphos (711), quinalphos-methyl (1376), quinothion (1380), quintiofos (1381), R-1492 (development code) (1382), rafoxanide (alternative name) [CCN], resmethrin (719), rotenone (722), RU 15525 (development code) (723), RU 25475 (development code) (1386), ryania (alternative name) (1387), ryanodine (traditional name) (1387), sabadilla (alternative name) (725), schradan (1389), sebufos (alternative name), selamectin (alternative name) [CCN], SI-0009 (compound code), silafluofen (728), SN 72129 (development code) (1397), sodium arsenite [CCN], sodium cyamide (444), sodium fluoride (IUPAC/Chemical Abstracts name) (1399), sodium hexafluorosilicate (1400), sodium pentachlorophenoxide (623), sodium selenate (IUPAC name) (1401), sodium thiocyanate [CCN], sophamide (1402), spinosad (737), spiromesifen (739), sulcofuron (746), sulcofuron-sodium (746), sulfluramid (750), sulfotep (753), sulfuryl fluoride (756), sulprofos (1408), tar oils (alternative name) (758), tau-fluvalinate (398), tazimcarb (1412), TDE (1414), tebufenozide (762), tebufenpyrad (763), tebupirimfos (764), teflubenzuron (768), tefluthrin (769), temephos (770), TEPP (1417), terallethrin (1418), terbam (alternative name), terbufos (773), tetrachloroethane [CCN], tetrachlorvinphos (777), tetramethrin (787), theta-cypermethrin (204), thiacloprid (791), thiafenox (alternative name), thiamethoxam (792), thicrofos (1428), thiocarboxime (1431), thiocyclam (798), thiocyclam hydrogen oxalate (798), thiodicarb (799), thiofanox (800), thiometon (801), thionazin (1434), thiosultap (803), thiosultap-sodium (803), thuringiensin (alternative name) [CCN], tolfenpyrad (809), tralomethrin (812), transfluthrin (813), transpermethrin (1440), triamiphos (1441), triazamate (818), triazophos (820), triazuron (alternative name), trichlorfon (824), trichlormetaphos-3 (alternative name) [CCN], trichloronat (1452), trifenofos (1455), triflumuron (835), trimethacarb (840), triprene (1459), vamidothion (847), vaniliprole [CCN], veratridine (alternative name) (725), veratrine (alternative name) (725), XMC (853), xylylcarb (854), YI-5302 (compound code), zeta-cypermethrin (205), zetamethrin (alternative name), zinc phosphide (640), zolaprofos (1469) and ZXI 8901 (development code) (858),
a molluscicide selected from the group of substances consisting of bis(tributyltin)oxide (IUPAC name) (913), bromoacetamide [CCN], calcium arsenate [CCN], cloethocarb (999), copper acetoarsenite [CCN], copper sulfate (172), fentin (347), ferric phosphate (IUPAC name) (352), metaldehyde (518), methiocarb (530), niclosamide (576), niclosamide-olamine (576), pentachlorophenol (623), sodium pentachlorophenoxide (623), tazimcarb (1412), thiodicarb (799), tributyltin oxide (913), trifenmorph (1454), trimethacarb (840), triphenyltin acetate (IUPAC name) (347) and triphenyltin hydroxide (IUPAC name) (347),
a nematicide selected from the group of substances consisting of 1,2-dibromo-3-chloropropane (IUPAC/Chemical Abstracts name) (1045), 1,2-dichloropropane (IUPAC/Chemical Abstracts name) (1062), 1,2-dichloropropane with 1,3-dichloropropene (IUPAC name) (1063), 1,3-dichloropropene (233), 3,4-dichlorotetrahydrothiophene 1,1-dioxide (IUPAC/Chemical Abstracts name) (1065), 3-(4-chlorophenyl)-5-methylrhodanine (IUPAC name) (980), 5-methyl-6-thioxo-1,3,5-thiadiazinan-3-ylacetic acid (IUPAC name) (1286), 6-isopentenylaminopurine (alternative name) (210), abamectin (1), acetoprole [CCN], alanycarb (15), aldicarb (16), aldoxycarb (863), AZ 60541 (compound code), benclothiaz [CCN], benomyl (62), butylpyridaben (alternative name), cadusafos (109), carbofuran (118), carbon disulfide (945), carbosulfan (119), chloropicrin (141), chlorpyrifos (145), cloethocarb (999), cytokinins (alternative name) (210), dazomet (216), DBCP (1045), DCIP (218), diamidafos (1044), dichlofenthion (1051), dicliphos (alternative name), dimethoate (262), doramectin (alternative name) [CCN], emamectin (291), emamectin benzoate (291), eprinomectin (alternative name) [CCN], ethoprophos (312), ethylene dibromide (316), fenamiphos (326), fenpyrad (alternative name), fensulfothion (1158), fosthiazate (408), fosthietan (1196), furfural (alternative name) [CCN], GY-81 (development code) (423), heterophos [CCN], iodomethane (IUPAC name) (542), isamidofos (1230), isazofos (1231), ivermectin (alternative name) [CCN], kinetin (alternative name) (210), mecarphon (1258), metam (519), metam-potassium (alternative name) (519), metam-sodium (519), methyl bromide (537), methyl isothiocyanate (543), milbemycin oxime (alternative name) [CCN], moxidectin (alternative name) [CCN], Myrothecium verrucaria composition (alternative name) (565), NC-184 (compound code), oxamyl (602), phorate (636), phosphamidon (639), phosphocarb [CCN], sebufos (alternative name), selamectin (alternative name) [CCN], spinosad (737), terbam (alternative name), terbufos (773), tetrachlorothiophene (IUPAC/Chemical Abstracts name) (1422), thiafenox (alternative name), thionazin (1434), triazophos (820), triazuron (alternative name), xylenols [CCN], YI-5302 (compound code) and zeatin (alternative name) (210),
a nitrification inhibitor selected from the group of substances consisting of potassium ethylxanthate [CCN] and nitrapyrin (580),
a plant activator selected from the group of substances consisting of acibenzolar (6), acibenzolar-5-methyl (6), probenazole (658) and Reynoutria sachalinensis extract (alternative name) (720),
a rodenticide selected from the group of substances consisting of 2-isovalerylindan-1,3-dione (IUPAC name) (1246), 4-(quinoxalin-2-ylamino)benzenesulfonamide (IUPAC name) (748), alpha-chlorohydrin [CCN], aluminium phosphide (640), antu (880), arsenous oxide (882), barium carbonate (891), bisthiosemi (912), brodifacoum (89), bromadiolone (91), bromethalin (92), calcium cyamide (444), chloralose (127), chlorophacinone (140), cholecalciferol (alternative name) (850), coumachlor (1004), coumafuryl (1005), coumatetralyl (175), crimidine (1009), difenacoum (246), difethialone (249), diphacinone (273), ergocalciferol (301), flocoumafen (357), fluoroacetamide (379), flupropadine (1183), flupropadine hydrochloride (1183), gamma-HCH (430), HCH (430), hydrogen cyamide (444), iodomethane (IUPAC name) (542), lindane (430), magnesium phosphide (IUPAC name) (640), methyl bromide (537), norbormide (1318), phosacetim (1336), phosphine (IUPAC name) (640), phosphorus [CCN], pindone (1341), potassium arsenite [CCN], pyrinuron (1371), scilliroside (1390), sodium arsenite [CCN], sodium cyamide (444), sodium fluoro-acetate (735), strychnine (745), thallium sulfate [CCN], warfarin (851) and zinc phosphide (640),
a synergist selected from the group of substances consisting of 2-(2-butoxyethoxy)ethyl piperonylate (IUPAC name) (934), 5-(1,3-benzodioxol-5-yl)-3-hexylcyclohex-2-enone (IUPAC name) (903), farnesol with nerolidol (alternative name) (324), MB-599 (development code) (498), MGK 264 (development code) (296), piperonyl butoxide (649), piprotal (1343), propyl isomer (1358), S421 (development code) (724), sesamex (1393), sesasmolin (1394) and sulfoxide (1406),
an animal repellent selected from the group of substances consisting of anthraquinone (32), chloralose (127), copper naphthenate [CCN], copper oxychloride (171), diazinon (227), dicyclopentadiene (chemical name) (1069), guazatine (422), guazatine acetates (422), methiocarb (530), pyridin-4-amine (IUPAC name) (23), thiram (804), trimethacarb (840), zinc naphthenate [CCN] and ziram (856),
a virucide selected from the group of substances consisting of imanin (alternative name) [CCN] and ribavirin (alternative name) [CCN], and a wound protectant selected from the group of substances consisting of mercuric oxide (512), octhilinone (590) and thiophanate-methyl (802).

A very especially preferred embodiment of the subject-matter {1.1.3} of the invention is {1.1.3.2} a pesticidal composition comprising a mixture consisting of at least two substances, namely one compound (A) and at least one compound (B), as active ingredient and at least one auxiliary, wherein the compound (A) is the compound of formula (A-3) and the compound (B) is a compound selected from the group of substances consisting of abamectin (1), cyromazine (209), diafenthiuron (226), diazinon (227), emamectin benzoate (291), fenoxycarb (340), fosthiazate (408), lambda-cyhalothrin (198), lufenuron (490), methidathion (529), profenofos (662), pymetrozine (688), tefluthrin (769) and thiamethoxam (792).

The compound of formula (A-3) is known, for example, from the PCT Application WO-03/015519.

A preferred embodiment of the subject-matter {1.1} of the invention is {1.1.4} a pesticidal composition comprising a mixture consisting of at least two substances, namely one compound (A) and at least one compound (B), as active ingredient and at least one auxiliary, wherein the compound (A) is the compound of formula (A-4) 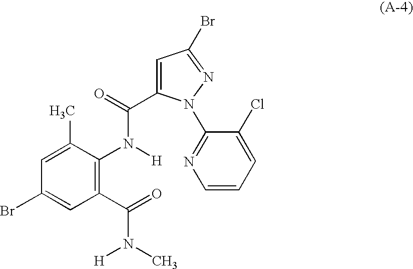
and the compound (B) is a compound selected from the group of substances consisting of an adjuvant, an acaricide, an algicide, an anthelmintic, an avicide, a bactericide, a biological agent, a soil sterilant, a chemosterilant, an insect pheromone, an insect repellent, an insecticide, a molluscicide, a nematicide, a nitrification inhibitor, a plant activator, a rodenticide, a synergist, an animal repellent, a virucide and a wound protectant.

An especially preferred embodiment of the subject-matter {1.1.4} of the invention is {1.1.4.1} a pesticidal composition comprising a mixture consisting of at least two substances, namely one compound (A) and at least one compound (B), as active ingredient and at least one auxiliary, wherein the compound (A) is the compound of formula (A-4) and the compound (B) is a compound selected from the group of substances consisting of
an adjuvant selected from the group of substances consisting of petroleum oils (alternative name) (628),
an acaricide selected from the group of substances consisting of 1,1-bis(4-chlorophenyl)-2-ethoxyethanol (IUPAC name) (910), 2,4-dichlorophenyl benzenesulfonate (IUPAC/Chemical Abstracts name) (1059), 2-fluoro-N-methyl-N-1-naphthylacetamide (IUPAC name) (1295), 4-chlorophenyl phenyl sulfone (IUPAC name) (981), abamectin (1), acequinocyl (3), acetoprole [CCN], acrinathrin (9), aldicarb (16), aldoxycarb (863), alpha-cypermethrin (202), amidithion (870), amidoflumet [CCN], amidothioate (872), amiton (875), amiton hydrogen oxalate (875), amitraz (24), aramite (881), arsenous oxide (882), AVI 382 (compound code), AZ 60541 (compound code), azinphos-ethyl (44), azinphos-methyl (45), azobenzene (IUPAC name) (888), azocyclotin (46), azothoate (889), benomyl (62), benoxafos (alternative name) [CCN], benzoximate (71), benzyl benzoate (IUPAC name) [CCN], bifenazate (74), bifenthrin (76), binapacryl (907), brofenvalerate (alternative name), bromocyclen (918), bromophos (920), bromophos-ethyl (921), bromopropylate (94), buprofezin (99), butocarboxim (103), butoxycarboxim (104), butylpyridaben (alternative name), calcium polysulfide (IUPAC name) (111), camphechlor (941), carbanolate (943), carbaryl (115), carbofuran (118), carbophenothion (947), CGA 50'439 (development code) (125), chinomethionat (126), chlorbenside (959), chlordimeform (964), chlordimeform hydrochloride (964), chlorfenapyr (130), chlorfenethol (968), chlorfenson (970), chlorfensulphide (971), chlorfenvinphos (131), chlorobenzilate (975), chloromebuform (977), chloromethiuron (978), chloropropylate (983), chlorpyrifos (145), chlorpyrifos-methyl (146), chlorthiophos (994), cinerin I (696), cinerin II (696), cinerins (696), clofentezine (158), closantel (alternative name) [CCN], coumaphos (174), crotamiton (alternative name) [CCN], crotoxyphos (1010), cufraneb (1013), cyanthoate (1020), cyhalothrin (196), cyhexatin (199), cypermethrin (201), DCPM (1032), DDT (219), demephion (1037), demephion-O (1037), demephion-S (1037), demeton (1038), demeton-methyl (224), demeton-O (1038), demeton-O-methyl (224), demeton-S (1038), demeton-5-methyl (224), demeton-5-methylsulphon (1039), diafenthiuron (226), dialifos (1042), diazinon (227), dichlofluanid (230), dichlorvos (236), dicliphos (alternative name), dicofol (242), dicrotophos (243), dienochlor (1071), dimefox (1081), dimethoate (262), dinactin (alternative name) (653), dinex (1089), dinex-diclexine (1089), dinobuton (269), dinocap (270), dinocap-4 [CCN], dinocap-6 [CCN], dinocton (1090), dinopenton (1092), dinosulfon (1097), dinoterbon (1098), dioxathion (1102), diphenyl sulfone (IUPAC name) (1103), disulfuram (alternative name) [CCN], disulfoton (278), DNOC (282), dofenapyn (1113), doramectin (alternative name) [CCN], endosulfan (294), endothion (1121), EPN (297), eprinomectin (alternative name) [CCN], ethion (309), ethoate-methyl (1134), etoxazole (320), etrimfos (1142), fenazaflor (1147), fenazaquin (328), fenbutatin oxide (330), fenothiocarb (337), fenpropathrin (342), fenpyrad (alternative name), fenpyroximate (345), fenson (1157), fentrifanil (1161), fenvalerate (349), fipronil (354), fluacrypyrim (360), fluazuron (1166), flubenzimine (1167), flucycloxuron (366), flucythrinate (367), fluenetil (1169), flufenoxuron (370), flumethrin (372), fluorbenside (1174), fluvalinate (1184), FMC 1137 (development code) (1185), formetanate (405), formetanate hydrochloride (405), formothion (1192), formparanate (1193), gamma-HCH (430), glyodin (1205), halfenprox (424), heptenophos (432), hexadecyl cyclopropanecarboxylate (IUPAC/Chemical Abstracts name) (1216), hexythiazox (441), iodomethane (IUPAC name) (542), isocarbophos (alternative name) (473), isopropyl O-(methoxyaminothiophosphoryl)salicylate (IUPAC name) (473), ivermectin (alternative name) [CCN], jasmolin I (696), jasmolin II (696), jodfenphos (1248), lindane (430), lufenuron (490), malathion (492), malonoben (1254), mecarbam (502), mephosfolan (1261), mesulfen (alternative name) [CCN], methacrifos (1266), methamidophos (527), methidathion (529), methiocarb (530), methomyl (531), methyl bromide (537), metolcarb (550), mevinphos (556), mexacarbate (1290), milbemectin (557), milbemycin oxime (alternative name) [CCN], mipafox (1293), monocrotophos (561), morphothion (1300), moxidectin (alternative name) [CCN], naled (567), NC-184 (compound code), nifluridide (1309), nikkomycins (alternative name) [CCN], nitrilacarb (1313), nitrilacarb 1:1 zinc chloride complex (1313), NNI-0101 (compound code), NNI-0250 (compound code), omethoate (594), oxamyl (602), oxydeprofos (1324), oxydisulfoton (1325), pp′-DDT (219), parathion (615), permethrin (626), petroleum oils (alternative name) (628), phenkapton (1330), phenthoate (631), phorate (636), phosalone (637), phosfolan (1338), phosmet (638), phosphamidon (639), phoxim (642), pirimiphos-methyl (652), polychloroterpenes (traditional name) (1347), polynactins (alternative name) (653), proclonol (1350), profenofos (662), promacyl (1354), propargite (671), propetamphos (673), propoxur (678), prothidathion (1360), prothoate (1362), pyrethrin I (696), pyrethrin II (696), pyrethrins (696), pyridaben (699), pyridaphenthion (701), pyrimidifen (706), pyrimitate (1370), quinalphos (711), quintiofos (1381), R-1492 (development code) (1382), RA-17 (development code) (1383), rotenone (722), schradan (1389), sebufos (alternative name), selamectin (alternative name) [CCN], SI-0009 (compound code), sophamide (1402), spirodiclofen (738), spiromesifen (739), SSI-121 (development code) (1404), sulfuram (alternative name) [CCN], sulfluramid (750), sulfotep (753), sulfur (754), SZI-121 (development code) (757), tau-fluvalinate (398), tebufenpyrad (763), TEPP (1417), terbam (alternative name), tetrachlorvinphos (777), tetradifon (786), tetranactin (alternative name) (653), tetrasul (1425), thiafenox (alternative name), thiocarboxime (1431), thiofanox (800), thiometon (801), thioquinox (1436), thuringiensin (alternative name) [CCN], triamiphos (1441), triarathene (1443), triazophos (820), triazuron (alternative name), trichlorfon (824), trifenofos (1455), trinactin (alternative name) (653), vamidothion (847), vaniliprole [CCN] and YI-5302 (compound code),
an algicide selected from the group of substances consisting of bethoxazin [CCN], copper dioctanoate (IUPAC name) (170), copper sulfate (172), cybutryne [CCN], dichlone (1052), dichlorophen (232), endothal (295), fentin (347), hydrated lime [CCN], nabam (566), quinoclamine (714), quinonamid (1379), simazine (730), triphenyltin acetate (IUPAC name) (347) and triphenyltin hydroxide (IUPAC name) (347),
an anthelmintic selected from the group of substances consisting of abamectin (1), crufomate (1011), doramectin (alternative name) [CCN], emamectin (291), emamectin benzoate (291), eprinomectin (alternative name) [CCN], ivermectin (alternative name) [CCN], milbemycin oxime (alternative name) [CCN], moxidectin (alternative name) [CCN], piperazine [CCN], selamectin (alternative name) [CCN], spinosad (737) and thiophanate (1435),
an avicide selected from the group of substances consisting of chloralose (127), endrin (1122), fenthion (346), pyridin-4-amine (IUPAC name) (23) and strychnine (745),
a bactericide selected from the group of substances consisting of 1-hydroxy-1H-pyridine-2-thione (IUPAC name) (1222), 4-(quinoxalin-2-ylamino)benzenesulfonamide (IUPAC name) (748), 8-hydroxyquinoline sulfate (446), bronopol (97), copper dioctanoate (IUPAC name) (170), copper hydroxide (IUPAC name) (169), cresol [CCN], dichlorophen (232), dipyrithione (1105), dodicin (1112), fenaminosulf (1144), formaldehyde (404), hydrargaphen (alternative name) [CCN], kasugamycin (483), kasugamycin hydrochloride hydrate (483), nickel bis(dimethyldithiocarbamate) (IUPAC name) (1308), nitrapyrin (580), octhilinone (590), oxolinic acid (606), oxytetracycline (611), potassium hydroxyquinoline sulfate (446), probenazole (658), streptomycin (744), streptomycin sesquisulfate (744), tecloftalam (766) and thiomersal (alternative name) [CCN],
a biological agent selected from the group of substances consisting of Adoxophyes orana GV (alternative name) (12), Agrobacterium radiobacter (alternative name) (13), Amblyseius spp. (alternative name) (19), Anagrapha falcifera NPV (alternative name) (28), Anagrus atomus (alternative name) (29), Aphelinus abdominalis (alternative name) (33), Aphidius colemani (alternative name) (34), Aphidoletes aphidimyza (alternative name) (35), Autographa californica NPV (alternative name) (38), Bacillus firmus (alternative name) (48), Bacillus sphaericus Neide (scientific name) (49), Bacillus thuringiensis Berliner (scientific name) (51), Bacillus thuringiensis subsp. aizawai (scientific name) (51), Bacillus thuringiensis subsp. israelensis (scientific name) (51), Bacillus thuringiensis subsp. japonensis (scientific name) (51), Bacillus thuringiensis subsp. kurstaki (scientific name) (51), Bacillus thuringiensis subsp. tenebrionis (scientific name) (51), Beauveria bassiana (alternative name) (53), Beauveria brongniartii (alternative name) (54), Chrysoperla carnea (alternative name) (151), Cryptolaemus montrouzieri (alternative name) (178), Cydia pomonella GV (alternative name) (191), Dacnusa sibirica (alternative name) (212), Diglyphus isaea (alternative name) (254), Encarsia formosa (scientific name) (293), Eretmocerus eremicus (alternative name) (300), Helicoverpa zea NPV (alternative name) (431), Heterorhabditis bacteriophora and H. megidis (alternative name) (433), Hippodamia convergens (alternative name) (442), Leptomastix dactylopii (alternative name) (488), Macrolophus caliginosus (alternative name) (491), Mamestra brassicae NPV (alternative name) (494), Metaphycus helvolus (alternative name) (522), Metarhizium anisopliae var. acridum (scientific name) (523), Metarhizium anisopliae var. anisopliae (scientific name) (523), Neodiprion sertifer NPV and N. lecontei NPV (alternative name) (575), Orius spp. (alternative name) (596), Paecilomyces fumosoroseus (alternative name) (613), Phytoseiulus persimilis (alternative name) (644), Spodoptera exigua multicapsid nuclear polyhedrosis virus (scientific name) (741), Steinernema bibionis (alternative name) (742), Steinernema carpocapsae (alternative name) (742), Steinernema feltiae (alternative name) (742), Steinernema glaseri (alternative name) (742), Steinernema riobrave (alternative name) (742), Steinernema riobravis (alternative name) (742), Steinernema scapterisci (alternative name) (742), Steinernema spp. (alternative name) (742), Trichogramma spp. (alternative name) (826), Typhlodromus occidentalis (alternative name) (844) and Verticillium lecanii (alternative name) (848),
a soil sterilant selected from the group of substances consisting of iodomethane (IUPAC name) (542) and methyl bromide (537),
a chemosterilant selected from the group of substances consisting of apholate [CCN], bisazir (alternative name) [CCN], busulfan (alternative name) [CCN], diflubenzuron (250), dimatif (alternative name) [CCN], hemel [CCN], hempa [CCN], metepa [CCN], methiotepa [CCN], methyl apholate [CCN], morzid [CCN], penfluoron (alternative name) [CCN], tepa [CCN], thiohempa (alternative name) [CCN], thiotepa (alternative name) [CCN], tretamine (alternative name) [CCN] and uredepa (alternative name) [CCN],
an insect pheromone selected from the group of substances consisting of (E)-dec-5-en-1-yl acetate with (E)-dec-5-en-1-ol (IUPAC name) (222), (E)-tridec-4-en-1-yl acetate (IUPAC name) (829), (E)-6-methylhept-2-en-4-ol (IUPAC name) (541), (E,Z)-tetradeca-4,10-dien-1-yl acetate (IUPAC name) (779), (Z)-dodec-7-en-1-yl acetate (IUPAC name) (285), (Z)-hexadec-11-enal (IUPAC name) (436), (Z)-hexadec-11-en-1-yl acetate (IUPAC name) (437), (Z)-hexadec-13-en-11-yn-1-yl acetate (IUPAC name) (438), (Z)-icos-13-en-10-one (IUPAC name) (448), (Z)-tetradec-7-en-1-al (IUPAC name) (782), (Z)-tetradec-9-en-1-ol (IUPAC name) (783), (Z)-tetradec-9-en-1-yl acetate (IUPAC name) (784), (7E,9Z)-dodeca-7,9-dien-1-yl acetate (IUPAC name) (283), (9Z,11E)-tetradeca-9,11-dien-1-yl acetate (IUPAC name) (780), (9Z,12E)-tetradeca-9,12-dien-1-yl acetate (IUPAC name) (781), 14-methyloctadec-1-ene (IUPAC name) (545), 4-methylnonan-5-ol with 4-methylnonan-5-one (IUPAC name) (544), alpha-multistriatin (alternative name) [CCN], brevicomin (alternative name) [CCN], codlelure (alternative name) [CCN], codlemone (alternative name) (167), cuelure (alternative name) (179), disparlure (277), dodec-8-en-1-yl acetate (IUPAC name) (286), dodec-9-en-1-yl acetate (IUPAC name) (287), dodeca-8,10-dien-1-yl acetate (IUPAC name) (284), dominicalure (alternative name) [CCN], ethyl 4-methyloctanoate (IUPAC name) (317), eugenol (alternative name) [CCN], frontalin (alternative name) [CCN], gossyplure (alternative name) (420), grandlure (421), grandlure I (alternative name) (421), grandlure II (alternative name) (421), grandlure III (alternative name) (421), grandlure IV (alternative name) (421), hexylure [CCN], ipsdienol (alternative name) [CCN], ipsenol (alternative name) [CCN], japonilure (alternative name) (481), lineatin (alternative name) [CCN], litlure (alternative name) [CCN], looplure (alternative name) [CCN], medlure [CCN], megatomoic acid (alternative name) [CCN], methyl eugenol (alternative name) (540), muscalure (563), octadeca-2,13-dien-1-yl acetate (IUPAC name) (588), octadeca-3,13-dien-1-yl acetate (IUPAC name) (589), orfralure (alternative name) [CCN], oryctalure (alternative name) (317), ostramone (alternative name) [CCN], siglure [CCN], sordidin (alternative name) (736), sulcatol (alternative name) [CCN], tetradec-11-en-1-yl acetate (IUPAC name) (785), trimedlure (839), trimedlure A (alternative name) (839), trimedlure B₁ (alternative name) (839), trimedlure B₂ (alternative name) (839), trimedlure C (alternative name) (839) and trunc-call (alternative name) [CCN],
an insect repellent selected from the group of substances consisting of 2-(octylthio)-ethanol (IUPAC name) (591), butopyronoxyl (933), butoxy(polypropylene glycol) (936), dibutyl adipate (IUPAC name) (1046), dibutyl phthalate (1047), dibutyl succinate (IUPAC name) (1048), diethyltoluamide [CCN], dimethyl carbate [CCN], dimethyl phthalate [CCN], ethyl hexanediol (1137), hexamide [CCN], methoquin-butyl (1276), methylneodecanamide [CCN], oxamate [CCN] and picaridin [CCN],
an insecticide selected from the group of substances consisting of 1,1-dichloro-1-nitroethane (IUPAC/Chemical Abstracts name) (1058), 1,1-dichloro-2,2-bis(4-ethylphenyl)-ethane (IUPAC name) (1056), 1,2-dichloropropane (IUPAC/Chemical Abstracts name) (1062), 1,2-dichloropropane with 1,3-dichloropropene (IUPAC name) (1063), 1-bromo-2-chloroethane (IUPAC/Chemical Abstracts name) (916), 2,2,2-trichloro-1-(3,4-dichloro-phenyl)ethyl acetate (IUPAC name) (1451), 2,2-dichlorovinyl 2-ethylsulfinylethyl methyl phosphate (IUPAC name) (1066), 2-(1,3-dithiolan-2-yl)phenyl dimethylcarbamate (IUPAC/Chemical Abstracts name) (1109), 2-(2-butoxyethoxy)ethyl thiocyanate (IUPAC/Chemical Abstracts name) (935), 2-(4,5-dimethyl-1,3-dioxolan-2-yl)phenyl methylcarbamate (IUPAC/Chemical Abstracts name) (1084), 2-(4-chloro-3,5-xylyloxy)ethanol (IUPAC name) (986), 2-chlorovinyl diethyl phosphate (IUPAC name) (984), 2-imidazolidone (IUPAC name) (1225), 2-isovalerylindan-1,3-dione (IUPAC name) (1246), 2-methyl(prop-2-ynyl)aminophenyl methylcarbamate (IUPAC name) (1284), 2-thiocyanatoethyl laurate (IUPAC name) (1433), 3-bromo-1-chloroprop-1-ene (IUPAC name) (917), 3-methyl-1-phenylpyrazol-5-yl dimethyl-carbamate (IUPAC name) (1283), 4-methyl(prop-2-ynyl)amino-3,5-xylyl methylcarbamate (IUPAC name) (1285), 5,5-dimethyl-3-oxocyclohex-1-enyl dimethylcarbamate (IUPAC name) (1085), abamectin (1), acephate (2), acetamiprid (4), acethion (alternative name) [CCN], acetoprole [CCN], acrinathrin (9), acrylonitrile (IUPAC name) (861), alanycarb (15), aldicarb (16), aldoxycarb (863), aldrin (864), allethrin (17), allosamidin (alternative name) [CCN], allyxycarb (866), alpha-cypermethrin (202), alpha-ecdysone (alternative name) [CCN], aluminium phosphide (640), amidithion (870), amidothioate (872), aminocarb (873), amiton (875), amiton hydrogen oxalate (875), amitraz (24), anabasine (877), athidathion (883), AVI 382 (compound code), AZ 60541 (compound code), azadirachtin (alternative name) (41), azamethiphos (42), azinphos-ethyl (44), azinphos-methyl (45), azothoate (889), Bacillus thuringiensis delta endotoxins (alternative name) (52), barium hexafluorosilicate (alternative name) [CCN], barium polysulfide (IUPAC/Chemical Abstracts name) (892), barthrin [CCN], BAS 320 I (compound code), Bayer 22/190 (development code) (893), Bayer 22408 (development code) (894), bendiocarb (58), benfuracarb (60), bensultap (66), beta-cyfluthrin (194), beta-cypermethrin (203), bifenthrin (76), bioallethrin (78), bioallethrin S-cyclopentenyl isomer (alternative name) (79), bioethanomethrin [CCN], biopermethrin (908), bioresmethrin (80), bis(2-chloroethyl)ether (IUPAC name) (909), bistrifluoron (83), borax (86), brofenvalerate (alternative name), bromfenvinfos (914), bromocyclen (918), bromo-DDT (alternative name) [CCN], bromophos (920), bromophos-ethyl (921), bufencarb (924), buprofezin (99), butacarb (926), butathiofos (927), butocarboxim (103), butonate (932), butoxycarboxim (104), butylpyridaben (alternative name), cadusafos (109), calcium arsenate [CCN], calcium cyamide (444), calcium polysulfide (IUPAC name) (111), camphechlor (941), carbanolate (943), carbaryl (115), carbofuran (118), carbon disulfide (IUPAC/Chemical Abstracts name) (945), carbon tetrachloride (IUPAC name) (946), carbophenothion (947), carbosulfan (119), cartap (123), cartap hydrochloride (123), cevadine (alternative name) (725), chlorbicyclen (960), chlordane (128), chlordecone (963), chlordimeform (964), chlordimeform hydrochloride (964), chlorethoxyfos (129), chlorfenapyr (130), chlorfenvinphos (131), chlorfluazuron (132), chlormephos (136), chloroform [CCN], chloropicrin (141), chlorphoxim (989), chlorprazophos (990), chlorpyrifos (145), chlorpyrifos-methyl (146), chlorthiophos (994), chromafenozide (150), cinerin I (696), cinerin II (696), cinerins (696), cis-resmethrin (alternative name), cismethrin (80), clocythrin (alternative name), cloethocarb (999), closantel (alternative name) [CCN], clothianidin (165), copper acetoarsenite [CCN], copper arsenate [CCN], copper oleate [CCN], coumaphos (174), coumithoate (1006), crotamiton (alternative name) [CCN], crotoxyphos (1010), crufomate (1011), cryolite (alternative name) (177), CS 708 (development code) (1012), cyanofenphos (1019), cyanophos (184), cyanthoate (1020), cyclethrin [CCN], cycloprothrin (188), cyfluthrin (193), cyhalothrin (196), cypermethrin (201), cyphenothrin (206), cyromazine (209), cythioate (alternative name) [CCN], d-limonene (alternative name) [CCN], d-tetramethrin (alternative name) (788), DAEP (1031), dazomet (216), DDT (219), decarbofuran (1034), deltamethrin (223), demephion (1037), demephion-O (1037), demephion-S (1037), demeton (1038), demeton-methyl (224), demeton-O (1038), demeton-O-methyl (224), demeton-S (1038), demeton-5-methyl (224), demeton-5-methylsulphon (1039), diafenthiuron (226), dialifos (1042), diamidafos (1044), diazinon (227), dicapthon (1050), dichlofenthion (1051), dichlorvos (236), dicliphos (alternative name), dicresyl (alternative name) [CCN], dicrotophos (243), dicyclanil (244), dieldrin (1070), diethyl 5-methylpyrazol-3-yl phosphate (IUPAC name) (1076), diflubenzuron (250), dilor (alternative name) [CCN], dimefluthrin [CCN], dimefox (1081), dimetan (1085), dimethoate (262), dimethrin (1083), dimethylvinphos (265), dimetilan (1086), dinex (1089), dinex-diclexine (1089), dinoprop (1093), dinosam (1094), dinoseb (1095), dinotefuran (271), diofenolan (1099), dioxabenzofos (1100), dioxacarb (1101), dioxathion (1102), disulfoton (278), dithicrofos (1108), DNOC (282), doramectin (alternative name) [CCN], DSP (1115), ecdysterone (alternative name) [CCN], EI 1642 (development code) (1118), emamectin (291), emamectin benzoate (291), EMPC (1120), empenthrin (292), endosulfan (294), endothion (1121), endrin (1122), EPBP (1123), EPN (297), epofenonane (1124), eprinomectin (alternative name) [CCN], esfenvalerate (302), etaphos (alternative name) [CCN], ethiofencarb (308), ethion (309), ethiprole (310), ethoate-methyl (1134), ethoprophos (312), ethyl formate (IUPAC name) [CCN], ethyl-DDD (alternative name) (1056), ethylene dibromide (316), ethylene dichloride (chemical name) (1136), ethylene oxide [CCN], etofenprox (319), etrimfos (1142), EXD (1143), famphur (323), fenamiphos (326), fenazaflor (1147), fenchlorphos (1148), fenethacarb (1149), fenfluthrin (1150), fenitrothion (335), fenobucarb (336), fenoxacrim (1153), fenoxycarb (340), fenpirithrin (1155), fenpropathrin (342), fenpyrad (alternative name), fensulfothion (1158), fenthion (346), fenthion-ethyl [CCN], fenvalerate (349), fipronil (354), flonicamid (358), flucofuron (1168), flucycloxuron (366), flucythrinate (367), fluenetil (1169), flufenerim [CCN], flufenoxuron (370), flufenprox (1171), flumethrin (372), fluvalinate (1184), FMC 1137 (development code) (1185), fonofos (1191), formetanate (405), formetanate hydrochloride (405), formothion (1192), formparanate (1193), fosmethilan (1194), fospirate (1195), fosthiazate (408), fosthietan (1196), furathiocarb (412), furethrin (1200), gamma-cyhalothrin (197), gamma-HCH (430), guazatine (422), guazatine acetates (422), GY-81 (development code) (423), halfenprox (424), halofenozide (425), HCH (430), HEOD (1070), heptachlor (1211), heptenophos (432), heterophos [CCN], hexaflumuron (439), HHDN (864), hydramethylnon (443), hydrogen cyamide (444), hydroprene (445), hyquincarb (1223), imidacloprid (458), imiprothrin (460), indoxacarb (465), iodomethane (IUPAC name) (542), IPSP (1229), isazofos (1231), isobenzan (1232), isocarbophos (alternative name) (473), isodrin (1235), isofenphos (1236), isolane (1237), isoprocarb (472), isopropyl O-(methoxyaminothiophosphoryl)salicylate (IUPAC name) (473), isoprothiolane (474), isothioate (1244), isoxathion (480), ivermectin (alternative name) [CCN], jasmolin I (696), jasmolin II (696), jodfenphos (1248), juvenile hormone I (alternative name) [CCN], juvenile hormone II (alternative name) [CCN], juvenile hormone III (alternative name) [CCN], kelevan (1249), kinoprene (484), lambda-cyhalothrin (198), lead arsenate [CCN], leptophos (1250), lindane (430), lirimfos (1251), lufenuron (490), lythidathion (1253), m-cumenyl methylcarbamate (IUPAC name) (1014), magnesium phosphide (IUPAC name) (640), malathion (492), malonoben (1254), mazidox (1255), mecarbam (502), mecarphon (1258), menazon (1260), mephosfolan (1261), mercurous chloride (513), mesulfenfos (1263), metam (519), metam-potassium (alternative name) (519), metam-sodium (519), methacrifos (1266), methamidophos (527), methanesulfonyl fluoride (IUPAC/Chemical Abstracts name) (1268), methidathion (529), methiocarb (530), methocrotophos (1273), methomyl (531), methoprene (532), methoquin-butyl (1276), methothrin (alternative name) (533), methoxychlor (534), methoxyfenozide (535), methyl bromide (537), methyl isothiocyanate (543), methylchloroform (alternative name) [CCN], methylene chloride [CCN], metofluthrin [CCN], metolcarb (550), metoxadiazone (1288), mevinphos (556), mexacarbate (1290), milbemectin (557), milbemycin oxime (alternative name) [CCN], mipafox (1293), mirex (1294), monocrotophos (561), morphothion (1300), moxidectin (alternative name) [CCN], naftalofos (alternative name) [CCN], naled (567), naphthalene (IUPAC/Chemical Abstracts name) (1303), NC-170 (development code) (1306), NC-184 (compound code), nicotine (578), nicotine sulfate (578), nifluridide (1309), nitenpyram (579), nithiazine (1311), nitrilacarb (1313), nitrilacarb 1:1 zinc chloride complex (1313), NNI-0101 (compound code), NNI-0250 (compound code), nornicotine (traditional name) (1319), novaluron (585), noviflumuron (586), O-2,5-dichloro-4-iodophenyl O-ethyl ethylphosphonothioate (IUPAC name) (1057), O,O-diethyl O-4-methyl-2-oxo-2H-chromen-7-yl phosphorothioate (IUPAC name) (1074), O,O-diethyl O-6-methyl-2-propylpyrimidin-4-yl phosphorothioate (IUPAC name) (1075), O,O,O′,O′-tetrapropyl dithiopyrophosphate (IUPAC name) (1424), oleic acid (IUPAC name) (593), omethoate (594), oxamyl (602), oxydemeton-methyl (609), oxydeprofos (1324), oxydisulfoton (1325), pp′-DDT (219), para-dichlorobenzene [CCN], parathion (615), parathion-methyl (616), penfluoron (alternative name) [CCN], pentachlorophenol (623), pentachlorophenyl laurate (IUPAC name) (623), permethrin (626), petroleum oils (alternative name) (628), PH 60-38 (development code) (1328), phenkapton (1330), phenothrin (630), phenthoate (631), phorate (636), phosalone (637), phosfolan (1338), phosmet (638), phosnichlor (1339), phosphamidon (639), phosphine (IUPAC name) (640), phoxim (642), phoxim-methyl (1340), pirimetaphos (1344), pirimicarb (651), pirimiphos-ethyl (1345), pirimiphos-methyl (652), polychlorodicyclopentadiene isomers (IUPAC name) (1346), polychloroterpenes (traditional name) (1347), potassium arsenite [CCN], potassium thiocyanate [CCN], prallethrin (655), precocene I (alternative name) [CCN], precocene II (alternative name) [CCN], precocene III (alternative name) [CCN], primidophos (1349), profenofos (662), profluthrin [CCN], promacyl (1354), promecarb (1355), propaphos (1356), propetamphos (673), propoxur (678), prothidathion (1360), prothiofos (686), prothoate (1362), protrifenbute [CCN], pymetrozine (688), pyraclofos (689), pyrazophos (693), pyresmethrin (1367), pyrethrin I (696), pyrethrin II (696), pyrethrins (696), pyridaben (699), pyridalyl (700), pyridaphenthion (701), pyrimidifen (706), pyrimitate (1370), pyriproxyfen (708), quassia (alternative name) [CCN], quinalphos (711), quinalphos-methyl (1376), quinothion (1380), quintiofos (1381), R-1492 (development code) (1382), rafoxanide (alternative name) [CCN], resmethrin (719), rotenone (722), RU 15525 (development code) (723), RU 25475 (development code) (1386), ryania (alternative name) (1387), ryanodine (traditional name) (1387), sabadilla (alternative name) (725), schradan (1389), sebufos (alternative name), selamectin (alternative name) [CCN], SI-0009 (compound code), silafluofen (728), SN 72129 (development code) (1397), sodium arsenite [CCN], sodium cyamide (444), sodium fluoride (IUPAC/Chemical Abstracts name) (1399), sodium hexafluorosilicate (1400), sodium pentachlorophenoxide (623), sodium selenate (IUPAC name) (1401), sodium thiocyanate [CCN], sophamide (1402), spinosad (737), spiromesifen (739), sulcofuron (746), sulcofuron-sodium (746), sulfluramid (750), sulfotep (753), sulfuryl fluoride (756), sulprofos (1408), tar oils (alternative name) (758), tau-fluvalinate (398), tazimcarb (1412), TDE (1414), tebufenozide (762), tebufenpyrad (763), tebupirimfos (764), teflubenzuron (768), tefluthrin (769), temephos (770), TEPP (1417), terallethrin (1418), terbam (alternative name), terbufos (773), tetrachloroethane [CCN], tetrachlorvinphos (777), tetramethrin (787), theta-cypermethrin (204), thiacloprid (791), thiafenox (alternative name), thiamethoxam (792), thicrofos (1428), thiocarboxime (1431), thiocyclam (798), thiocyclam hydrogen oxalate (798), thiodicarb (799), thiofanox (800), thiometon (801), thionazin (1434), thiosultap (803), thiosultap-sodium (803), thuringiensin (alternative name) [CCN], tolfenpyrad (809), tralomethrin (812), transfluthrin (813), transpermethrin (1440), triamiphos (1441), triazamate (818), triazophos (820), triazuron (alternative name), trichlorfon (824), trichlormetaphos-3 (alternative name) [CCN], trichloronat (1452), trifenofos (1455), triflumuron (835), trimethacarb (840), triprene (1459), vamidothion (847), vaniliprole [CCN], veratridine (alternative name) (725), veratrine (alternative name) (725), XMC (853), xylylcarb (854), YI-5302 (compound code), zeta-cypermethrin (205), zetamethrin (alternative name), zinc phosphide (640), zolaprofos (1469) and ZXI 8901 (development code) (858),
a molluscicide selected from the group of substances consisting of bis(tributyltin)oxide (IUPAC name) (913), bromoacetamide [CCN], calcium arsenate [CCN], cloethocarb (999), copper acetoarsenite [CCN], copper sulfate (172), fentin (347), ferric phosphate (IUPAC name) (352), metaldehyde (518), methiocarb (530), niclosamide (576), niclosamide-olamine (576), pentachlorophenol (623), sodium pentachlorophenoxide (623), tazimcarb (1412), thiodicarb (799), tributyltin oxide (913), trifenmorph (1454), trimethacarb (840), triphenyltin acetate (IUPAC name) (347) and triphenyltin hydroxide (IUPAC name) (347),
a nematicide selected from the group of substances consisting of 1,2-dibromo-3-chloropropane (IUPAC/Chemical Abstracts name) (1045), 1,2-dichloropropane (IUPAC/Chemical Abstracts name) (1062), 1,2-dichloropropane with 1,3-dichloropropene (IUPAC name) (1063), 1,3-dichloropropene (233), 3,4-dichlorotetrahydrothiophene 1,1-dioxide (IUPAC/Chemical Abstracts name) (1065), 3-(4-chlorophenyl)-5-methylrhodanine (IUPAC name) (980), 5-methyl-6-thioxo-1,3,5-thiadiazinan-3-ylacetic acid (IUPAC name) (1286), 6-isopentenylaminopurine (alternative name) (210), abamectin (1), acetoprole [CCN], alanycarb (15), aldicarb (16), aldoxycarb (863), AZ 60541 (compound code), benclothiaz [CCN], benomyl (62), butylpyridaben (alternative name), cadusafos (109), carbofuran (118), carbon disulfide (945), carbosulfan (119), chloropicrin (141), chlorpyrifos (145), cloethocarb (999), cytokinins (alternative name) (210), dazomet (216), DBCP (1045), DCIP (218), diamidafos (1044), dichlofenthion (1051), dicliphos (alternative name), dimethoate (262), doramectin (alternative name) [CCN], emamectin (291), emamectin benzoate (291), eprinomectin (alternative name) [CCN], ethoprophos (312), ethylene dibromide (316), fenamiphos (326), fenpyrad (alternative name), fensulfothion (1158), fosthiazate (408), fosthietan (1196), furfural (alternative name) [CCN], GY-81 (development code) (423), heterophos [CCN], iodomethane (IUPAC name) (542), isamidofos (1230), isazofos (1231), ivermectin (alternative name) [CCN], kinetin (alternative name) (210), mecarphon (1258), metam (519), metam-potassium (alternative name) (519), metam-sodium (519), methyl bromide (537), methyl isothiocyanate (543), milbemycin oxime (alternative name) [CCN], moxidectin (alternative name) [CCN], Myrothecium verrucaria composition (alternative name) (565), NC-184 (compound code), oxamyl (602), phorate (636), phosphamidon (639), phosphocarb [CCN], sebufos (alternative name), selamectin (alternative name) [CCN], spinosad (737), terbam (alternative name), terbufos (773), tetrachlorothiophene (IUPAC/Chemical Abstracts name) (1422), thiafenox (alternative name), thionazin (1434), triazophos (820), triazuron (alternative name), xylenols [CCN], YI-5302 (compound code) and zeatin (alternative name) (210),
a nitrification inhibitor selected from the group of substances consisting of potassium ethylxanthate [CCN] and nitrapyrin (580),
a plant activator selected from the group of substances consisting of acibenzolar (6), acibenzolar-5-methyl (6), probenazole (658) and Reynoutria sachalinensis extract (alternative name) (720),
a rodenticide selected from the group of substances consisting of 2-isovalerylindan-1,3-dione (IUPAC name) (1246), 4-(quinoxalin-2-ylamino)benzenesulfonamide (IUPAC name) (748), alpha-chlorohydrin [CCN], aluminium phosphide (640), antu (880), arsenous oxide (882), barium carbonate (891), bisthiosemi (912), brodifacoum (89), bromadiolone (91), bromethalin (92), calcium cyamide (444), chloralose (127), chlorophacinone (140), cholecalciferol (alternative name) (850), coumachlor (1004), coumafuryl (1005), coumatetralyl (175), crimidine (1009), difenacoum (246), difethialone (249), diphacinone (273), ergocalciferol (301), flocoumafen (357), fluoroacetamide (379), flupropadine (1183), flupropadine hydrochloride (1183), gamma-HCH (430), HCH (430), hydrogen cyamide (444), iodomethane (IUPAC name) (542), lindane (430), magnesium phosphide (IUPAC name) (640), methyl bromide (537), norbormide (1318), phosacetim (1336), phosphine (IUPAC name) (640), phosphorus [CCN], pindone (1341), potassium arsenite [CCN], pyrinuron (1371), scilliroside (1390), sodium arsenite [CCN], sodium cyamide (444), sodium fluoro-acetate (735), strychnine (745), thallium sulfate [CCN], warfarin (851) and zinc phosphide (640),
a synergist selected from the group of substances consisting of 2-(2-butoxyethoxy)ethyl piperonylate (IUPAC name) (934), 5-(1,3-benzodioxol-5-yl)-3-hexylcyclohex-2-enone (IUPAC name) (903), farnesol with nerolidol (alternative name) (324), MB-599 (development code) (498), MGK 264 (development code) (296), piperonyl butoxide (649), piprotal (1343), propyl isomer (1358), S421 (development code) (724), sesamex (1393), sesasmolin (1394) and sulfoxide (1406),
an animal repellent selected from the group of substances consisting of anthraquinone (32), chloralose (127), copper naphthenate [CCN], copper oxychloride (171), diazinon (227), dicyclopentadiene (chemical name) (1069), guazatine (422), guazatine acetates (422), methiocarb (530), pyridin-4-amine (IUPAC name) (23), thiram (804), trimethacarb (840), zinc naphthenate [CCN] and ziram (856),
a virucide selected from the group of substances consisting of imanin (alternative name) [CCN] and ribavirin (alternative name) [CCN],
and a wound protectant selected from the group of substances consisting of mercuric oxide (512), octhilinone (590) and thiophanate-methyl (802).

A very especially preferred embodiment of the subject-matter {1.1.4} of the invention is {1.1.4.2} a pesticidal composition comprising a mixture consisting of at least two substances, namely one compound (A) and at least one compound (B), as active ingredient and at least one auxiliary, wherein the compound (A) is the compound of formula (A-4) and the compound (B) is a compound selected from the group of substances consisting of abamectin (1), cyromazine (209), diafenthiuron (226), diazinon (227), emamectin benzoate (291), fenoxycarb (340), fosthiazate (408), lambda-cyhalothrin (198), lufenuron (490), methidathion (529), profenofos (662), pymetrozine (688), tefluthrin (769) and thiamethoxam (792).

The compound of formula (A-4) is known, for example, from the PCT Application WO-03/015519.

A preferred embodiment of the subject-matter {1.1} of the invention is {1.1.5} a pesticidal composition comprising a mixture consisting of at least two substances, namely one compound (A) and at least one compound (B), as active ingredient and at least one auxiliary, wherein the compound (A) is the compound of formula (A-5) 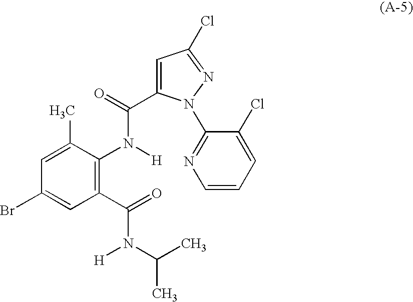
and the compound (B) is a compound selected from the group of substances consisting of an adjuvant, an acaricide, an algicide, an anthelmintic, an avicide, a bactericide, a biological agent, a soil sterilant, a chemosterilant, an insect pheromone, an insect repellent, an insecticide, a molluscicide, a nematicide, a nitrification inhibitor, a plant activator, a rodenticide, a synergist, an animal repellent, a virucide and a wound protectant.

An especially preferred embodiment of the subject-matter {1.1.5} of the invention is {1.1.5.1} a pesticidal composition comprising a mixture consisting of at least two substances, namely one compound (A) and at least one compound (B), as active ingredient and at least one auxiliary, wherein the compound (A) is the compound of formula (A-5) and the compound (B) is a compound selected from the group of substances consisting of
an adjuvant selected from the group of substances consisting of petroleum oils (alternative name) (628),
an acaricide selected from the group of substances consisting of 1,1-bis(4-chlorophenyl)-2-ethoxyethanol (IUPAC name) (910), 2,4-dichlorophenyl benzenesulfonate (IUPAC/Chemical Abstracts name) (1059), 2-fluoro-N-methyl-N-1-naphthylacetamide (IUPAC name) (1295), 4-chlorophenyl phenyl sulfone (IUPAC name) (981), abamectin (1), acequinocyl (3), acetoprole [CCN], acrinathrin (9), aldicarb (16), aldoxycarb (863), alpha-cypermethrin (202), amidithion (870), amidoflumet [CCN], amidothioate (872), amiton (875), amiton hydrogen oxalate (875), amitraz (24), aramite (881), arsenous oxide (882), AVI 382 (compound code), AZ 60541 (compound code), azinphos-ethyl (44), azinphos-methyl (45), azobenzene (IUPAC name) (888), azocyclotin (46), azothoate (889), benomyl (62), benoxafos (alternative name) [CCN], benzoximate (71), benzyl benzoate (IUPAC name) [CCN], bifenazate (74), bifenthrin (76), binapacryl (907), brofenvalerate (alternative name), bromocyclen (918), bromophos (920), bromophos-ethyl (921), bromopropylate (94), buprofezin (99), butocarboxim (103), butoxycarboxim (104), butylpyridaben (alternative name), calcium polysulfide (IUPAC name) (111), camphechlor (941), carbanolate (943), carbaryl (115), carbofuran (118), carbophenothion (947), CGA 50'439 (development code) (125), chinomethionat (126), chlorbenside (959), chlordimeform (964), chlordimeform hydrochloride (964), chlorfenapyr (130), chlorfenethol (968), chlorfenson (970), chlorfensulphide (971), chlorfenvinphos (131), chlorobenzilate (975), chloromebuform (977), chloromethiuron (978), chloropropylate (983), chlorpyrifos (145), chlorpyrifos-methyl (146), chlorthiophos (994), cinerin I (696), cinerin II (696), cinerins (696), clofentezine (158), closantel (alternative name) [CCN], coumaphos (174), crotamiton (alternative name) [CCN], crotoxyphos (1010), cufraneb (1013), cyanthoate (1020), cyhalothrin (196), cyhexatin (199), cypermethrin (201), DCPM (1032), DDT (219), demephion (1037), demephion-O (1037), demephion-S (1037), demeton (1038), demeton-methyl (224), demeton-O (1038), demeton-O-methyl (224), demeton-S (1038), demeton-5-methyl (224), demeton-5-methylsulphon (1039), diafenthiuron (226), dialifos (1042), diazinon (227), dichlofluanid (230), dichlorvos (236), dicliphos (alternative name), dicofol (242), dicrotophos (243), dienochlor (1071), dimefox (1081), dimethoate (262), dinactin (alternative name) (653), dinex (1089), dinex-diclexine (1089), dinobuton (269), dinocap (270), dinocap-4 [CCN], dinocap-6 [CCN], dinocton (1090), dinopenton (1092), dinosulfon (1097), dinoterbon (1098), dioxathion (1102), diphenyl sulfone (IUPAC name) (1103), disulfuram (alternative name) [CCN], disulfoton (278), DNOC (282), dofenapyn (1113), doramectin (alternative name) [CCN], endosulfan (294), endothion (1121), EPN (297), eprinomectin (alternative name) [CCN], ethion (309), ethoate-methyl (1134), etoxazole (320), etrimfos (1142), fenazaflor (1147), fenazaquin (328), fenbutatin oxide (330), fenothiocarb (337), fenpropathrin (342), fenpyrad (alternative name), fenpyroximate (345), fenson (1157), fentrifanil (1161), fenvalerate (349), fipronil (354), fluacrypyrim (360), fluazuron (1166), flubenzimine (1167), flucycloxuron (366), flucythrinate (367), fluenetil (1169), flufenoxuron (370), flumethrin (372), fluorbenside (1174), fluvalinate (1184), FMC 1137 (development code) (1185), formetanate (405), formetanate hydrochloride (405), formothion (1192), formparanate (1193), gamma-HCH (430), glyodin (1205), halfenprox (424), heptenophos (432), hexadecyl cyclopropanecarboxylate (IUPAC/Chemical Abstracts name) (1216), hexythiazox (441), iodomethane (IUPAC name) (542), isocarbophos (alternative name) (473), isopropyl O-(methoxyaminothiophosphoryl)salicylate (IUPAC name) (473), ivermectin (alternative name) [CCN], jasmolin I (696), jasmolin II (696), jodfenphos (1248), lindane (430), lufenuron (490), malathion (492), malonoben (1254), mecarbam (502), mephosfolan (1261), mesulfen (alternative name) [CCN], methacrifos (1266), methamidophos (527), methidathion (529), methiocarb (530), methomyl (531), methyl bromide (537), metolcarb (550), mevinphos (556), mexacarbate (1290), milbemectin (557), milbemycin oxime (alternative name) [CCN], mipafox (1293), monocrotophos (561), morphothion (1300), moxidectin (alternative name) [CCN], naled (567), NC-184 (compound code), nifluridide (1309), nikkomycins (alternative name) [CCN], nitrilacarb (1313), nitrilacarb 1:1 zinc chloride complex (1313), NNI-0101 (compound code), NNI-0250 (compound code), omethoate (594), oxamyl (602), oxydeprofos (1324), oxydisulfoton (1325), pp′-DDT (219), parathion (615), permethrin (626), petroleum oils (alternative name) (628), phenkapton (1330), phenthoate (631), phorate (636), phosalone (637), phosfolan (1338), phosmet (638), phosphamidon (639), phoxim (642), pirimiphos-methyl (652), polychloroterpenes (traditional name) (1347), polynactins (alternative name) (653), proclonol (1350), profenofos (662), promacyl (1354), propargite (671), propetamphos (673), propoxur (678), prothidathion (1360), prothoate (1362), pyrethrin I (696), pyrethrin II (696), pyrethrins (696), pyridaben (699), pyridaphenthion (701), pyrimidifen (706), pyrimitate (1370), quinalphos (711), quintiofos (1381), R-1492 (development code) (1382), RA-17 (development code) (1383), rotenone (722), schradan (1389), sebufos (alternative name), selamectin (alternative name) [CCN], SI-0009 (compound code), sophamide (1402), spirodiclofen (738), spiromesifen (739), SSI-121 (development code) (1404), sulfuram (alternative name) [CCN], sulfluramid (750), sulfotep (753), sulfur (754), SZI-121 (development code) (757), tau-fluvalinate (398), tebufenpyrad (763), TEPP (1417), terbam (alternative name), tetrachlorvinphos (777), tetradifon (786), tetranactin (alternative name) (653), tetrasul (1425), thiafenox (alternative name), thiocarboxime (1431), thiofanox (800), thiometon (801), thioquinox (1436), thuringiensin (alternative name) [CCN], triamiphos (1441), triarathene (1443), triazophos (820), triazuron (alternative name), trichlorfon (824), trifenofos (1455), trinactin (alternative name) (653), vamidothion (847), vaniliprole [CCN] and YI-5302 (compound code),
an algicide selected from the group of substances consisting of bethoxazin [CCN], copper dioctanoate (IUPAC name) (170), copper sulfate (172), cybutryne [CCN], dichlone (1052), dichlorophen (232), endothal (295), fentin (347), hydrated lime [CCN], nabam (566), quinoclamine (714), quinonamid (1379), simazine (730), triphenyltin acetate (IUPAC name) (347) and triphenyltin hydroxide (IUPAC name) (347),
an anthelmintic selected from the group of substances consisting of abamectin (1), crufomate (1011), doramectin (alternative name) [CCN], emamectin (291), emamectin benzoate (291), eprinomectin (alternative name) [CCN], ivermectin (alternative name) [CCN], milbemycin oxime (alternative name) [CCN], moxidectin (alternative name) [CCN], piperazine [CCN], selamectin (alternative name) [CCN], spinosad (737) and thiophanate (1435),
an avicide selected from the group of substances consisting of chloralose (127), endrin (1122), fenthion (346), pyridin-4-amine (IUPAC name) (23) and strychnine (745),
a bactericide selected from the group of substances consisting of 1-hydroxy-1H-pyridine-2-thione (IUPAC name) (1222), 4-(quinoxalin-2-ylamino)benzenesulfonamide (IUPAC name) (748), 8-hydroxyquinoline sulfate (446), bronopol (97), copper dioctanoate (IUPAC name) (170), copper hydroxide (IUPAC name) (169), cresol [CCN], dichlorophen (232), dipyrithione (1105), dodicin (1112), fenaminosulf (1144), formaldehyde (404), hydrargaphen (alternative name) [CCN], kasugamycin (483), kasugamycin hydrochloride hydrate (483), nickel bis(dimethyldithiocarbamate) (IUPAC name) (1308), nitrapyrin (580), octhilinone (590), oxolinic acid (606), oxytetracycline (611), potassium hydroxyquinoline sulfate (446), probenazole (658), streptomycin (744), streptomycin sesquisulfate (744), tecloftalam (766) and thiomersal (alternative name) [CCN],
a biological agent selected from the group of substances consisting of Adoxophyes orana GV (alternative name) (12), Agrobacterium radiobacter (alternative name) (13), Amblyseius spp. (alternative name) (19), Anagrapha falcifera NPV (alternative name) (28), Anagrus atomus (alternative name) (29), Aphelinus abdominalis (alternative name) (33), Aphidius colemani (alternative name) (34), Aphidoletes aphidimyza (alternative name) (35), Autographa californica NPV (alternative name) (38), Bacillus firmus (alternative name) (48), Bacillus sphaericus Neide (scientific name) (49), Bacillus thuringiensis Berliner (scientific name) (51), Bacillus thuringiensis subsp. aizawai (scientific name) (51), Bacillus thuringiensis subsp. israelensis (scientific name) (51), Bacillus thuringiensis subsp. japonensis (scientific name) (51), Bacillus thuringiensis subsp. kurstaki (scientific name) (51), Bacillus thuringiensis subsp. tenebrionis (scientific name) (51), Beauveria bassiana (alternative name) (53), Beauveria brongniartii (alternative name) (54), Chrysoperla carnea (alternative name) (151), Cryptolaemus montrouzieri (alternative name) (178), Cydia pomonella GV (alternative name) (191), Dacnusa sibirica (alternative name) (212), Diglyphus isaea (alternative name) (254), Encarsia formosa (scientific name) (293), Eretmocerus eremicus (alternative name) (300), Helicoverpa zea NPV (alternative name) (431), Heterorhabditis bacteriophora and H. megidis (alternative name) (433), Hippodamia convergens (alternative name) (442), Leptomastix dactylopii (alternative name) (488), Macrolophus caliginosus (alternative name) (491), Mamestra brassicae NPV (alternative name) (494), Metaphycus helvolus (alternative name) (522), Metarhizium anisopliae var. acridum (scientific name) (523), Metarhizium anisopliae var. anisopliae (scientific name) (523), Neodiprion sertifer NPV and N. lecontei NPV (alternative name) (575), Orius spp. (alternative name) (596), Paecilomyces fumosoroseus (alternative name) (613), Phytoseiulus persimilis (alternative name) (644), Spodoptera exigua multicapsid nuclear polyhedrosis virus (scientific name) (741), Steinernema bibionis (alternative name) (742), Steinernema carpocapsae (alternative name) (742), Steinernema feltiae (alternative name) (742), Steinernema glaseri (alternative name) (742), Steinernema riobrave (alternative name) (742), Steinernema riobravis (alternative name) (742), Steinernema scapterisci (alternative name) (742), Steinernema spp. (alternative name) (742), Trichogramma spp. (alternative name) (826), Typhlodromus occidentalis (alternative name) (844) and Verticillium lecanii (alternative name) (848),
a soil sterilant selected from the group of substances consisting of iodomethane (IUPAC name) (542) and methyl bromide (537),
a chemosterilant selected from the group of substances consisting of apholate [CCN], bisazir (alternative name) [CCN], busulfan (alternative name) [CCN], diflubenzuron (250), dimatif (alternative name) [CCN], hemel [CCN], hempa [CCN], metepa [CCN], methiotepa [CCN], methyl apholate [CCN], morzid [CCN], penfluoron (alternative name) [CCN], tepa [CCN], thiohempa (alternative name) [CCN], thiotepa (alternative. name) [CCN], tretamine (alternative name) [CCN] and uredepa (alternative name) [CCN],
an insect pheromone selected from the group of substances consisting of (E)-dec-5-en-1-yl acetate with (E)-dec-5-en-1-ol (IUPAC name) (222), (E)-tridec-4-en-1-yl acetate (IUPAC name) (829), (E)-6-methylhept-2-en-4-ol (IUPAC name) (541), (E,Z)-tetradeca-4,10-dien-1-yl acetate (IUPAC name) (779), (Z)-dodec-7-en-1-yl acetate (IUPAC name) (285), (Z)-hexadec-11-enal (IUPAC name) (436), (Z)-hexadec-11-en-1-yl acetate (IUPAC name) (437), (Z)-hexadec-13-en-11-yn-1-yl acetate (IUPAC name) (438), (Z)-icos-13-en-10-one (IUPAC name) (448), (Z)-tetradec-7-en-1-al (IUPAC name) (782), (Z)-tetradec-9-en-1-ol (IUPAC name) (783), (Z)-tetradec-9-en-1-yl acetate (IUPAC name) (784), (7E,9Z)-dodeca-7,9-dien-1-yl acetate (IUPAC name) (283), (9Z,11E)-tetradeca-9,11-dien-1-yl acetate (IUPAC name) (780), (9Z,12E)-tetradeca-9,12-dien-1-yl acetate (IUPAC name) (781), 14-methyloctadec-1-ene (IUPAC name) (545), 4-methylnonan-5-ol with 4-methylnonan-5-one (IUPAC name) (544), alpha-multistriatin (alternative name) [CCN], brevicomin (alternative name) [CCN], codlelure (alternative name) [CCN], codlemone (alternative name) (167), cuelure (alternative name) (179), disparlure (277), dodec-8-en-1-yl acetate (IUPAC name) (286), dodec-9-en-1-yl acetate (IUPAC name) (287), dodeca-8,10-dien-1-yl acetate (IUPAC name) (284), dominicalure (alternative name) [CCN], ethyl 4-methyloctanoate (IUPAC name) (317), eugenol (alternative name) [CCN], frontalin (alternative name) [CCN], gossyplure (alternative name) (420), grandlure (421), grandlure I (alternative name) (421), grandlure II (alternative name) (421), grandlure III (alternative name) (421), grandlure IV (alternative name) (421), hexylure [CCN], ipsdienol (alternative name) [CCN], ipsenol (alternative name) [CCN], japonilure (alternative name) (481), lineatin (alternative name) [CCN], litlure (alternative name) [CCN], looplure (alternative name) [CCN], medlure [CCN], megatomoic acid (alternative name) [CCN], methyl eugenol (alternative name) (540), muscalure (563), octadeca-2,13-dien-1-yl acetate (IUPAC name) (588), octadeca-3,13-dien-1-yl acetate (IUPAC name) (589), orfralure (alternative name) [CCN], oryctalure (alternative name) (317), ostramone (alternative name) [CCN], siglure [CCN], sordidin (alternative name) (736), sulcatol (alternative name) [CCN], tetradec-11-en-1-yl acetate (IUPAC name) (785), trimedlure (839), trimedlure A (alternative name) (839), trimedlure B₁ (alternative name) (839), trimedlure B₂ (alternative name) (839), trimedlure C (alternative name) (839) and trunc-call (alternative name) [CCN],
an insect repellent selected from the group of substances consisting of 2-(octylthio)-ethanol (IUPAC name) (591), butopyronoxyl (933), butoxy(polypropylene glycol) (936), dibutyl adipate (IUPAC name) (1046), dibutyl phthalate (1047), dibutyl succinate (IUPAC name) (1048), diethyltoluamide [CCN], dimethyl carbate [CCN], dimethyl phthalate [CCN], ethyl hexanediol (1137), hexamide [CCN], methoquin-butyl (1276), methylneodecanamide [CCN], oxamate [CCN] and picaridin [CCN],
an insecticide selected from the group of substances consisting of 1,1-dichloro-1-nitroethane (IUPAC/Chemical Abstracts name) (1058), 1,1-dichloro-2,2-bis(4-ethylphenyl)-ethane (IUPAC name) (1056), 1,2-dichloropropane (IUPAC/Chemical Abstracts name) (1062), 1,2-dichloropropane with 1,3-dichloropropene (IUPAC name) (1063), 1-bromo-2-chloroethane (IUPAC/Chemical Abstracts name) (916), 2,2,2-trichloro-1-(3,4-dichloro-phenyl)ethyl acetate (IUPAC name) (1451), 2,2-dichlorovinyl 2-ethylsulfinylethyl methyl phosphate (IUPAC name) (1066), 2-(1,3-dithiolan-2-yl)phenyl dimethylcarbamate (IUPAC/Chemical Abstracts name) (1109), 2-(2-butoxyethoxy)ethyl thiocyanate (IUPAC/Chemical Abstracts name) (935), 2-(4,5-dimethyl-1,3-dioxolan-2-yl)phenyl methylcarbamate (IUPAC/Chemical Abstracts name) (1084), 2-(4-chloro-3,5-xylyloxy)ethanol (IUPAC name) (986), 2-chlorovinyl diethyl phosphate (IUPAC name) (984), 2-imidazolidone (IUPAC name) (1225), 2-isovalerylindan-1,3-dione (IUPAC name) (1246), 2-methyl(prop-2-ynyl)aminophenyl methylcarbamate (IUPAC name) (1284), 2-thiocyanatoethyl laurate (IUPAC name) (1433), 3-bromo-1-chloroprop-1-ene (IUPAC name) (917), 3-methyl-1-phenylpyrazol-5-yl dimethyl-carbamate (IUPAC name) (1283), 4-methyl(prop-2-ynyl)amino-3,5-xylyl methylcarbamate (IUPAC name) (1285), 5,5-dimethyl-3-oxocyclohex-1-enyl dimethylcarbamate (IUPAC name) (1085), abamectin (1), acephate (2), acetamiprid (4), acethion (alternative name) [CCN], acetoprole [CCN], acrinathrin (9), acrylonitrile (IUPAC name) (861), alanycarb (15), aldicarb (16), aldoxycarb (863), aldrin (864), allethrin (17), allosamidin (alternative name) [CCN], allyxycarb (866), alpha-cypermethrin (202), alpha-ecdysone (alternative name) [CCN], aluminium phosphide (640), amidithion (870), amidothioate (872), aminocarb (873), amiton (875), amiton hydrogen oxalate (875), amitraz (24), anabasine (877), athidathion (883), AVI 382 (compound code), AZ 60541 (compound code), azadirachtin (alternative name) (41), azamethiphos (42), azinphos-ethyl (44), azinphos-methyl (45), azothoate (889), Bacillus thuringiensis delta endotoxins (alternative name) (52), barium hexafluorosilicate (alternative name) [CCN], barium polysulfide (IUPAC/Chemical Abstracts name) (892), barthrin [CCN], BAS 320 I (compound code), Bayer 22/190 (development code) (893), Bayer 22408 (development code) (894), bendiocarb (58), benfuracarb (60), bensultap (66), beta-cyfluthrin (194), beta-cypermethrin (203), bifenthrin (76), bioallethrin (78), bioallethrin S-cyclopentenyl isomer (alternative name) (79), bioethanomethrin [CCN], biopermethrin (908), bioresmethrin (80), bis(2-chloroethyl)ether (IUPAC name) (909), bistrifluoron (83), borax (86), brofenvalerate (alternative name), bromfenvinfos (914), bromocyclen (918), bromo-DDT (alternative name) [CCN], bromophos (920), bromophos-ethyl (921), bufencarb (924), buprofezin (99), butacarb (926), butathiofos (927), butocarboxim (103), butonate (932), butoxycarboxim (104), butylpyridaben (alternative name), cadusafos (109), calcium arsenate [CCN], calcium cyamide (444), calcium polysulfide (IUPAC name) (111), camphechlor (941), carbanolate (943), carbaryl (115), carbofuran (118), carbon disulfide (IUPAC/Chemical Abstracts name) (945), carbon tetrachloride (IUPAC name) (946), carbophenothion (947), carbosulfan (119), cartap (123), cartap hydrochloride (123), cevadine (alternative name) (725), chlorbicyclen (960), chlordane (128), chlordecone (963), chlordimeform (964), chlordimeform hydrochloride (964), chlorethoxyfos (129), chlorfenapyr (130), chlorfenvinphos (131), chlorfluazuron (132), chlormephos (136), chloroform [CCN], chloropicrin (141), chlorphoxim (989), chlorprazophos (990), chlorpyrifos (145), chlorpyrifos-methyl (146), chlorthiophos (994), chromafenozide (150), cinerin I (696), cinerin II (696), cinerins (696), cis-resmethrin (alternative name), cismethrin (80), clocythrin (alternative name), cloethocarb (999), closantel (alternative name) [CCN], clothianidin (165), copper acetoarsenite [CCN], copper arsenate [CCN], copper oleate [CCN], coumaphos (174), coumithoate (1006), crotamiton (alternative name) [CCN], crotoxyphos (1010), crufomate (1011), cryolite (alternative name) (177), CS 708 (development code) (1012), cyanofenphos (1019), cyanophos (184), cyanthoate (1020), cyclethrin [CCN], cycloprothrin (188), cyfluthrin (193), cyhalothrin (196), cypermethrin (201), cyphenothrin (206), cyromazine (209), cythioate (alternative name) [CCN], d-limonene (alternative name) [CCN], d-tetramethrin (alternative name) (788), DAEP (1031), dazomet (216), DDT (219), decarbofuran (1034), deltamethrin (223), demephion (1037), demephion-O (1037), demephion-S (1037), demeton (1038), demeton-methyl (224), demeton-O (1038), demeton-O-methyl (224), demeton-S (1038), demeton-5-methyl (224), demeton-5-methylsulphon (1039), diafenthiuron (226), dialifos (1042), diamidafos (1044), diazinon (227), dicapthon (1050), dichlofenthion (1051), dichlorvos (236), dicliphos (alternative name), dicresyl (alternative name) [CCN], dicrotophos (243), dicyclanil (244), dieldrin (1070), diethyl 5-methylpyrazol-3-yl phosphate (IUPAC name) (1076), diflubenzuron (250), dilor (alternative name) [CCN], dimefluthrin [CCN], dimefox (1081), dimetan (1085), dimethoate (262), dimethrin (1083), dimethylvinphos (265), dimetilan (1086), dinex (1089), dinex-diclexine (1089), dinoprop (1093), dinosam (1094), dinoseb (1095), dinotefuran (271), diofenolan (1099), dioxabenzofos (1100), dioxacarb (1101), dioxathion (1102), disulfoton (278), dithicrofos (1108), DNOC (282), doramectin (alternative name) [CCN], DSP (1115), ecdysterone (alternative name) [CCN], EI 1642 (development code) (1118), emamectin (291), emamectin benzoate (291), EMPC (1120), empenthrin (292), endosulfan (294), endothion (1121), endrin (1122), EPBP (1123), EPN (297), epofenonane (1124), eprinomectin (alternative name) [CCN], esfenvalerate (302), etaphos (alternative name) [CCN], ethiofencarb (308), ethion (309), ethiprole (310), ethoate-methyl (1134), ethoprophos (312), ethyl formate (IUPAC name) [CCN], ethyl-DDD (alternative name) (1056), ethylene dibromide (316), ethylene dichloride (chemical name) (1136), ethylene oxide [CCN], etofenprox (319), etrimfos (1142), EXD (1143), famphur (323), fenamiphos (326), fenazaflor (1147), fenchlorphos (1148), fenethacarb (1149), fenfluthrin (1150), fenitrothion (335), fenobucarb (336), fenoxacrim (1153), fenoxycarb (340), fenpirithrin (1155), fenpropathrin (342), fenpyrad (alternative name), fensulfothion (1158), fenthion (346), fenthion-ethyl [CCN], fenvalerate (349), fipronil (354), flonicamid (358), flucofuron (1168), flucycloxuron (366), flucythrinate (367), fluenetil (1169), flufenerim [CCN], flufenoxuron (370), flufenprox (1171), flumethrin (372), fluvalinate (1184), FMC 1137 (development code) (1185), fonofos (1191), formetanate (405), formetanate hydrochloride (405), formothion (1192), formparanate (1193), fosmethilan (1194), fospirate (1195), fosthiazate (408), fosthietan (1196), furathiocarb (412), furethrin (1200), gamma-cyhalothrin (197), gamma-HCH (430), guazatine (422), guazatine acetates (422), GY-81 (development code) (423), halfenprox (424), halofenozide (425), HCH (430), HEOD (1070), heptachlor (1211), heptenophos (432), heterophos [CCN], hexaflumuron (439), HHDN (864), hydramethylnon (443), hydrogen cyamide (444), hydroprene (445), hyquincarb (1223), imidacloprid (458), imiprothrin (460), indoxacarb (465), iodomethane (IUPAC name) (542), IPSP (1229), isazofos (1231), isobenzan (1232), isocarbophos (alternative name) (473), isodrin (1235), isofenphos (1236), isolane (1237), isoprocarb (472), isopropyl O-(methoxyaminothiophosphoryl)salicylate (IUPAC name) (473), isoprothiolane (474), isothioate (1244), isoxathion (480), ivermectin (alternative name) [CCN], jasmolin I (696), jasmolin II (696), jodfenphos (1248), juvenile hormone I (alternative name) [CCN], juvenile hormone II (alternative name) [CCN], juvenile hormone III (alternative name) [CCN], kelevan (1249), kinoprene (484), lambda-cyhalothrin (198), lead arsenate [CCN], leptophos (1250), lindane (430), lirimfos (1251), lufenuron (490), lythidathion (1253), m-cumenyl methylcarbamate (IUPAC name) (1014), magnesium phosphide (IUPAC name) (640), malathion (492), malonoben (1254), mazidox (1255), mecarbam (502), mecarphon (1258), menazon (1260), mephosfolan (1261), mercurous chloride (513), mesulfenfos (1263), metam (519), metam-potassium (alternative name) (519), metam-sodium (519), methacrifos (1266), methamidophos (527), methanesulfonyl fluoride (IUPAC/Chemical Abstracts name) (1268), methidathion (529), methiocarb (530), methocrotophos (1273), methomyl (531), methoprene (532), methoquin-butyl (1276), methothrin (alternative name) (533), methoxychlor (534), methoxyfenozide (535), methyl bromide (537), methyl isothiocyanate (543), methylchloroform (alternative name) [CCN], methylene chloride [CCN], metofluthrin [CCN], metolcarb (550), metoxadiazone (1288), mevinphos (556), mexacarbate (1290), milbemectin (557), milbemycin oxime (alternative name) [CCN], mipafox (1293), mirex (1294), monocrotophos (561), morphothion (1300), moxidectin (alternative name) [CCN], naftalofos (alternative name) [CCN], naled (567), naphthalene (IUPAC/Chemical Abstracts name) (1303), NC-170 (development code) (1306), NC-184 (compound code), nicotine (578), nicotine sulfate (578), nifluridide (1309), nitenpyram (579), nithiazine (1311), nitrilacarb (1313), nitrilacarb 1:1 zinc chloride complex (1313), NNI-0101 (compound code), NNI-0250 (compound code), nornicotine (traditional name) (1319), novaluron (585), noviflumuron (586), O-2,5-dichloro-4-iodophenyl O-ethyl ethylphosphonothioate (IUPAC name) (1057), O,O-diethyl O-4-methyl-2-oxo-2H-chromen-7-yl phosphorothioate (IUPAC name) (1074), O,O-diethyl O-6-methyl-2-propylpyrimidin-4-yl phosphorothioate (IUPAC name) (1075), O,O,O′,O′-tetrapropyl dithiopyrophosphate (IUPAC name) (1424), oleic acid (IUPAC name) (593), omethoate (594), oxamyl (602), oxydemeton-methyl (609), oxydeprofos (1324), oxydisulfoton (1325), pp′-DDT (219), para-dichlorobenzene [CCN], parathion (615), parathion-methyl (616), penfluoron (alternative name) [CCN], pentachlorophenol (623), pentachlorophenyl laurate (IUPAC name) (623), permethrin (626), petroleum oils (alternative name) (628), PH 60-38 (development code) (1328), phenkapton (1330), phenothrin (630), phenthoate (631), phorate (636), phosalone (637), phosfolan (1338), phosmet (638), phosnichlor (1339), phosphamidon (639), phosphine (IUPAC name) (640), phoxim (642), phoxim-methyl (1340), pirimetaphos (1344), pirimicarb (651), pirimiphos-ethyl (1345), pirimiphos-methyl (652), polychlorodicyclopentadiene isomers (IUPAC name) (1346), polychloroterpenes (traditional name) (1347), potassium arsenite [CCN], potassium thiocyanate [CCN], prallethrin (655), precocene I (alternative name) [CCN], precocene II (alternative name) [CCN], precocene III (alternative name) [CCN], primidophos (1349), profenofos (662), profluthrin [CCN], promacyl (1354), promecarb (1355), propaphos (1356), propetamphos (673), propoxur (678), prothidathion (1360), prothiofos (686), prothoate (1362), protrifenbute [CCN], pymetrozine (688), pyraclofos (689), pyrazophos (693), pyresmethrin (1367), pyrethrin I (696), pyrethrin II (696), pyrethrins (696), pyridaben (699), pyridalyl (700), pyridaphenthion (701), pyrimidifen (706), pyrimitate (1370), pyriproxyfen (708), quassia (alternative name) [CCN], quinalphos (711), quinalphos-methyl (1376), quinothion (1380), quintiofos (1381), R-1492 (development code) (1382), rafoxanide (alternative name) [CCN], resmethrin (719), rotenone (722), RU 15525 (development code) (723), RU 25475 (development code) (1386), ryania (alternative name) (1387), ryanodine (traditional name) (1387), sabadilla (alternative name) (725), schradan (1389), sebufos (alternative name), selamectin (alternative name) [CCN], SI-0009 (compound code), silafluofen (728), SN 72129 (development code) (1397), sodium arsenite [CCN], sodium cyamide (444), sodium fluoride (IUPAC/Chemical Abstracts name) (1399), sodium hexafluorosilicate (1400), sodium pentachlorophenoxide (623), sodium selenate (IUPAC name) (1401), sodium thiocyanate [CCN], sophamide (1402), spinosad (737), spiromesifen (739), sulcofuron (746), sulcofuron-sodium (746), sulfluramid (750), sulfotep (753), sulfuryl fluoride (756), sulprofos (1408), tar oils (alternative name) (758), tau-fluvalinate (398), tazimcarb (1412), TDE (1414), tebufenozide (762), tebufenpyrad (763), tebupirimfos (764), teflubenzuron (768), tefluthrin (769), temephos (770), TEPP (1417), terallethrin (1418), terbam (alternative name), terbufos (773), tetrachloroethane [CCN], tetrachlorvinphos (777), tetramethrin (787), theta-cypermethrin (204), thiacloprid (791), thiafenox (alternative name), thiamethoxam (792), thicrofos (1428), thiocarboxime (1431), thiocyclam (798), thiocyclam hydrogen oxalate (798), thiodicarb (799), thiofanox (800), thiometon (801), thionazin (1434), thiosultap (803), thiosultap-sodium (803), thuringiensin (alternative name) [CCN], tolfenpyrad (809), tralomethrin (812), transfluthrin (813), transpermethrin (1440), triamiphos (1441), triazamate (818), triazophos (820), triazuron (alternative name), trichlorfon (824), trichlormetaphos-3 (alternative name) [CCN], trichloronat (1452), trifenofos (1455), triflumuron (835), trimethacarb (840), triprene (1459), vamidothion (847), vaniliprole [CCN], veratridine (alternative name) (725), veratrine (alternative name) (725), XMC (853), xylylcarb (854), YI-5302 (compound code), zeta-cypermethrin (205), zetamethrin (alternative name), zinc phosphide (640), zolaprofos (1469) and ZXI 8901 (development code) (858),
a molluscicide selected from the group of substances consisting of bis(tributyltin)oxide (IUPAC name) (913), bromoacetamide [CCN], calcium arsenate [CCN], cloethocarb (999), copper acetoarsenite [CCN], copper sulfate (172), fentin (347), ferric phosphate (IUPAC name) (352), metaldehyde (518), methiocarb (530), niclosamide (576), niclosamide-olamine (576), pentachlorophenol (623), sodium pentachlorophenoxide (623), tazimcarb (1412), thiodicarb (799), tributyltin oxide (913), trifenmorph (1454), trimethacarb (840), triphenyltin acetate (IUPAC name) (347) and triphenyltin hydroxide (IUPAC name) (347),
a nematicide selected from the group of substances consisting of 1,2-dibromo-3-chloropropane (IUPAC/Chemical Abstracts name) (1045), 1,2-dichloropropane (IUPAC/Chemical Abstracts name) (1062), 1,2-dichloropropane with 1,3-dichloropropene (IUPAC name) (1063), 1,3-dichloropropene (233), 3,4-dichlorotetrahydrothiophene 1,1-dioxide (IUPAC/Chemical Abstracts name) (1065), 3-(4-chlorophenyl)-5-methylrhodanine (IUPAC name) (980), 5-methyl-6-thioxo-1,3,5-thiadiazinan-3-ylacetic acid (IUPAC name) (1286), 6-isopentenylaminopurine (alternative name) (210), abamectin (1), acetoprole [CCN], alanycarb (15), aldicarb (16), aldoxycarb (863), AZ 60541 (compound code), benclothiaz [CCN], benomyl (62), butylpyridaben (alternative name), cadusafos (109), carbofuran (118), carbon disulfide (945), carbosulfan (119), chloropicrin (141), chlorpyrifos (145), cloethocarb (999), cytokinins (alternative name) (210), dazomet (216), DBCP (1045), DCIP (218), diamidafos (1044), dichlofenthion (1051), dicliphos (alternative name), dimethoate (262), doramectin (alternative name) [CCN], emamectin (291), emamectin benzoate (291), eprinomectin (alternative name) [CCN], ethoprophos (312), ethylene dibromide (316), fenamiphos (326), fenpyrad (alternative name), fensulfothion (1158), fosthiazate (408), fosthietan (1196), furfural (alternative name) [CCN], GY-81 (development code) (423), heterophos [CCN], iodomethane (IUPAC name) (542), isamidofos (1230), isazofos (1231), ivermectin (alternative name) [CCN], kinetin (alternative name) (210), mecarphon (1258), metam (519), metam-potassium (alternative name) (519), metam-sodium (519), methyl bromide (537), methyl isothiocyanate (543), milbemycin oxime (alternative name) [CCN], moxidectin (alternative name) [CCN], Myrothecium verrucaria composition (alternative name) (565), NC-184 (compound code), oxamyl (602), phorate (636), phosphamidon (639), phosphocarb [CCN], sebufos (alternative name), selamectin (alternative name) [CCN], spinosad (737), terbam (alternative name), terbufos (773), tetrachlorothiophene (IUPAC/Chemical Abstracts name) (1422), thiafenox (alternative name), thionazin (1434), triazophos (820), triazuron (alternative name), xylenols [CCN], YI-5302 (compound code) and zeatin (alternative name) (210),
a nitrification inhibitor selected from the group of substances consisting of potassium ethylxanthate [CCN] and nitrapyrin (580),
a plant activator selected from the group of substances consisting of acibenzolar (6), acibenzolar-5-methyl (6), probenazole (658) and Reynoutria sachalinensis extract (alternative name) (720),
a rodenticide selected from the group of substances consisting of 2-isovalerylindan-1,3-dione (IUPAC name) (1246), 4-(quinoxalin-2-ylamino)benzenesulfonamide (IUPAC name) (748), alpha-chlorohydrin [CCN], aluminium phosphide (640), antu (880), arsenous oxide (882), barium carbonate (891), bisthiosemi (912), brodifacoum (89), bromadiolone (91), bromethalin (92), calcium cyamide (444), chloralose (127), chlorophacinone (140), cholecalciferol (alternative name) (850), coumachlor (1004), coumafuryl (1005), coumatetralyl (175), crimidine (1009), difenacoum (246), difethialone (249), diphacinone (273), ergocalciferol (301), flocoumafen (357), fluoroacetamide (379), flupropadine (1183), flupropadine hydrochloride (1183), gamma-HCH (430), HCH (430), hydrogen cyamide (444), iodomethane (IUPAC name) (542), lindane (430), magnesium phosphide (IUPAC name) (640), methyl bromide (537), norbormide (1318), phosacetim (1336), phosphine (IUPAC name) (640), phosphorus [CCN], pindone (1341), potassium arsenite [CCN], pyrinuron (1371), scilliroside (1390), sodium arsenite [CCN], sodium cyamide (444), sodium fluoro-acetate (735), strychnine (745), thallium sulfate [CCN], warfarin (851) and zinc phosphide (640),
a synergist selected from the group of substances consisting of 2-(2-butoxyethoxy)ethyl piperonylate (IUPAC name) (934), 5-(1,3-benzodioxol-5-yl)-3-hexylcyclohex-2-enone (IUPAC name) (903), farnesol with nerolidol (alternative name) (324), MB-599 (development code) (498), MGK 264 (development code) (296), piperonyl butoxide (649), piprotal (1343), propyl isomer (1358), S421 (development code) (724), sesamex (1393), sesasmolin (1394) and sulfoxide (1406),
an animal repellent selected from the group of substances consisting of anthraquinone (32), chloralose (127), copper naphthenate [CCN], copper oxychloride (171), diazinon (227), dicyclopentadiene (chemical name) (1069), guazatine (422), guazatine acetates (422), methiocarb (530), pyridin-4-amine (IUPAC name) (23), thiram (804), trimethacarb (840), zinc naphthenate [CCN] and ziram (856),
a virucide selected from the group of substances consisting of imanin (alternative name) [CCN] and ribavirin (alternative name) [CCN],
and a wound protectant selected from the group of substances consisting of mercuric oxide (512), octhilinone (590) and thiophanate-methyl (802).

A very especially preferred embodiment of the subject-matter {1.1.5} of the invention is {1.1.5.2} a pesticidal composition comprising a mixture consisting of at least two substances, namely one compound (A) and at least one compound (B), as active ingredient and at least one auxiliary, wherein the compound (A) is the compound of formula (A-5) and the compound (B) is a compound selected from the group of substances consisting of abamectin (1), cyromazine (209), diafenthiuron (226), diazinon (227), emamectin benzoate (291), fenoxycarb (340), fosthiazate (408), lambda-cyhalothrin (198), lufenuron (490), methidathion (529), profenofos (662), pymetrozine (688), tefluthrin (769) and thiamethoxam (792).

The compound of formula (A-5) is known, for example, from the PCT Application WO-03/015519.

A preferred embodiment of the subject-matter {1.1} of the invention is {1.1.6} a pesticidal composition comprising a mixture consisting of at least two substances, namely one compound (A) and at least one compound (B), as active ingredient and at least one auxiliary, wherein the compound (A) is the compound of formula (A-6) 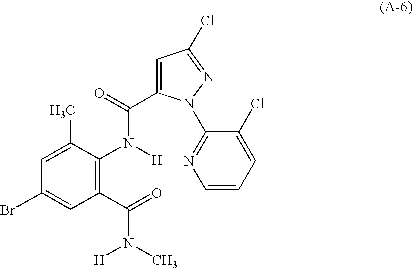
and the compound (B) is a compound selected from the group of substances consisting of an adjuvant, an acaricide, an algicide, an anthelmintic, an avicide, a bactericide, a biological agent, a soil sterilant, a chemosterilant, an insect pheromone, an insect repellent, an insecticide, a molluscicide, a nematicide, a nitrification inhibitor, a plant activator, a rodenticide, a synergist, an animal repellent, a virucide and a wound protectant.

An especially preferred embodiment of the subject-matter {1.1.6} of the invention is {1.1.6.1} a pesticidal composition comprising a mixture consisting of at least two substances, namely one compound (A) and at least one compound (B), as active ingredient and at least one auxiliary, wherein the compound (A) is the compound of formula (A-6) and the compound (B) is a compound selected from the group of substances consisting of
an adjuvant selected from the group of substances consisting of petroleum oils (alternative name) (628),
an acaricide selected from the group of substances consisting of 1,1-bis(4-chlorophenyl)-2-ethoxyethanol (IUPAC name) (910), 2,4-dichlorophenyl benzenesulfonate (IUPAC/Chemical Abstracts name) (1059), 2-fluoro-N-methyl-N-1-naphthylacetamide (IUPAC name) (1295), 4-chlorophenyl phenyl sulfone (IUPAC name) (981), abamectin (1), acequinocyl (3), acetoprole [CCN], acrinathrin (9), aldicarb (16), aldoxycarb (863), alpha-cypermethrin (202), amidithion (870), amidoflumet [CCN], amidothioate (872), amiton (875), amiton hydrogen oxalate (875), amitraz (24), aramite (881), arsenous oxide (882), AVI 382 (compound code), AZ 60541 (compound code), azinphos-ethyl (44), azinphos-methyl (45), azobenzene (IUPAC name) (888), azocyclotin (46), azothoate (889), benomyl (62), benoxafos (alternative name) [CCN], benzoximate (71), benzyl benzoate (IUPAC name) [CCN], bifenazate (74), bifenthrin (76), binapacryl (907), brofenvalerate (alternative name), bromocyclen (918), bromophos (920), bromophos-ethyl (921), bromopropylate (94), buprofezin (99), butocarboxim (103), butoxycarboxim (104), butylpyridaben (alternative name), calcium polysulfide (IUPAC name) (111), camphechlor (941), carbanolate (943), carbaryl (115), carbofuran (118), carbophenothion (947), CGA 50'439 (development code) (125), chinomethionat (126), chlorbenside (959), chlordimeform (964), chlordimeform hydrochloride (964), chlorfenapyr (130), chlorfenethol (968), chlorfenson (970), chlorfensulphide (971), chlorfenvinphos (131), chlorobenzilate (975), chloromebuform (977), chloromethiuron (978), chloropropylate (983), chlorpyrifos (145), chlorpyrifos-methyl (146), chlorthiophos (994), cinerin I (696), cinerin II (696), cinerins (696), clofentezine (158), closantel (alternative name) [CCN], coumaphos (174), crotamiton (alternative name) [CCN], crotoxyphos (1010), cufraneb (1013), cyanthoate (1020), cyhalothrin (196), cyhexatin (199), cypermethrin (201), DCPM (1032), DDT (219), demephion (1037), demephion-O (1037), demephion-S (1037), demeton (1038), demeton-methyl (224), demeton-O (1038), demeton-O-methyl (224), demeton-S (1038), demeton-5-methyl (224), demeton-5-methylsulphon (1039), diafenthiuron (226), dialifos (1042), diazinon (227), dichlofluanid (230), dichlorvos (236), dicliphos (alternative name), dicofol (242), dicrotophos (243), dienochlor (1071), dimefox (1081), dimethoate (262), dinactin (alternative name) (653), dinex (1089), dinex-diclexine (1089), dinobuton (269), dinocap (270), dinocap-4 [CCN], dinocap-6 [CCN], dinocton (1090), dinopenton (1092), dinosulfon (1097), dinoterbon (1098), dioxathion (1102), diphenyl sulfone (IUPAC name) (1103), disulfuram (alternative name) [CCN], disulfoton (278), DNOC (282), dofenapyn (1113), doramectin (alternative name) [CCN], endosulfan (294), endothion (1121), EPN (297), eprinomectin (alternative name) [CCN], ethion (309), ethoate-methyl (1134), etoxazole (320), etrimfos (1142), fenazaflor (1147), fenazaquin (328), fenbutatin oxide (330), fenothiocarb (337), fenpropathrin (342), fenpyrad (alternative name), fenpyroximate (345), fenson (1157), fentrifanil (1161), fenvalerate (349), fipronil (354), fluacrypyrim (360), fluazuron (1166), flubenzimine (1167), flucycloxuron (366), flucythrinate (367), fluenetil (1169), flufenoxuron (370), flumethrin (372), fluorbenside (1174), fluvalinate (1184), FMC 1137 (development code) (1185), formetanate (405), formetanate hydrochloride (405), formothion (1192), formparanate (1193), gamma-HCH (430), glyodin (1205), halfenprox (424), heptenophos (432), hexadecyl cyclopropanecarboxylate (IUPAC/Chemical Abstracts name) (1216), hexythiazox (441), iodomethane (IUPAC name) (542), isocarbophos (alternative name) (473), isopropyl O-(methoxyaminothiophosphoryl)salicylate (IUPAC name) (473), ivermectin (alternative name) [CCN], jasmolin I (696), jasmolin II (696), jodfenphos (1248), lindane (430), lufenuron (490), malathion (492), malonoben (1254), mecarbam (502), mephosfolan (1261), mesulfen (alternative name) [CCN], methacrifos (1266), methamidophos (527), methidathion (529), methiocarb (530), methomyl (531), methyl bromide (537), metolcarb (550), mevinphos (556), mexacarbate (1290), milbemectin (557), milbemycin oxime (alternative name) [CCN], mipafox (1293), monocrotophos (561), morphothion (1300), moxidectin (alternative name) [CCN], naled (567), NC-184 (compound code), nifluridide (1309), nikkomycins (alternative name) [CCN], nitrilacarb (1313), nitrilacarb 1:1 zinc chloride complex (1313), NNI-0101 (compound code), NNI-0250 (compound code), omethoate (594), oxamyl (602), oxydeprofos (1324), oxydisulfoton (1325), pp′-DDT (219), parathion (615), permethrin (626), petroleum oils (alternative name) (628), phenkapton (1330), phenthoate (631), phorate (636), phosalone (637), phosfolan (1338), phosmet (638), phosphamidon (639), phoxim (642), pirimiphos-methyl (652), polychloroterpenes (traditional name) (1347), polynactins (alternative name) (653), proclonol (1350), profenofos (662), promacyl (1354), propargite (671), propetamphos (673), propoxur (678), prothidathion (1360), prothoate (1362), pyrethrin I (696), pyrethrin II (696), pyrethrins (696), pyridaben (699), pyridaphenthion (701), pyrimidifen (706), pyrimitate (1370), quinalphos (711), quintiofos (1381), R-1492 (development code) (1382), RA-17 (development code) (1383), rotenone (722), schradan (1389), sebufos (alternative name), selamectin (alternative name) [CCN], SI-0009 (compound code), sophamide (1402), spirodiclofen (738), spiromesifen (739), SSI-121 (development code) (1404), sulfuram (alternative name) [CCN], sulfluramid (750), sulfotep (753), sulfur (754), SZI-121 (development code) (757), tau-fluvalinate (398), tebufenpyrad (763), TEPP (1417), terbam (alternative name), tetrachlorvinphos (777), tetradifon (786), tetranactin (alternative name) (653), tetrasul (1425), thiafenox (alternative name), thiocarboxime (1431), thiofanox (800), thiometon (801), thioquinox (1436), thuringiensin (alternative name) [CCN], triamiphos (1441), triarathene (1443), triazophos (820), triazuron (alternative name), trichlorfon (824), trifenofos (1455), trinactin (alternative name) (653), vamidothion (847), vaniliprole [CCN] and YI-5302 (compound code),
an algicide selected from the group of substances consisting of bethoxazin [CCN], copper dioctanoate (IUPAC name) (170), copper sulfate (172), cybutryne [CCN], dichlone (1052), dichlorophen (232), endothal (295), fentin (347), hydrated lime [CCN], nabam (566), quinoclamine (714), quinonamid (1379), simazine (730), triphenyltin acetate (IUPAC name) (347) and triphenyltin hydroxide (IUPAC name) (347),
an anthelmintic selected from the group of substances consisting of abamectin (1), crufomate (1011), doramectin (alternative name) [CCN], emamectin (291), emamectin benzoate (291), eprinomectin (alternative name) [CCN], ivermectin (alternative name) [CCN], milbemycin oxime (alternative name) [CCN], moxidectin (alternative name) [CCN], piperazine [CCN], selamectin (alternative name) [CCN], spinosad (737) and thiophanate (1435),
an avicide selected from the group of substances consisting of chloralose (127), endrin (1122), fenthion (346), pyridin-4-amine (IUPAC name) (23) and strychnine (745),
a bactericide selected from the group of substances consisting of 1-hydroxy-1H-pyridine-2-thione (IUPAC name) (1222), 4-(quinoxalin-2-ylamino)benzenesulfonamide (IUPAC name) (748), 8-hydroxyquinoline sulfate (446), bronopol (97), copper dioctanoate (IUPAC name) (170), copper hydroxide (IUPAC name) (169), cresol [CCN], dichlorophen (232), dipyrithione (1105), dodicin (1112), fenaminosulf (1144), formaldehyde (404), hydrargaphen (alternative name) [CCN], kasugamycin (483), kasugamycin hydrochloride hydrate (483), nickel bis(dimethyldithiocarbamate) (IUPAC name) (1308), nitrapyrin (580), octhilinone (590), oxolinic acid (606), oxytetracycline (611), potassium hydroxyquinoline sulfate (446), probenazole (658), streptomycin (744), streptomycin sesquisulfate (744), tecloftalam (766) and thiomersal (alternative name) [CCN],
a biological agent selected from the group of substances consisting of Adoxophyes orana GV (alternative name) (12), Agrobacterium radiobacter (alternative name) (13), Amblyseius spp. (alternative name) (19), Anagrapha falcifera NPV (alternative name) (28), Anagrus atomus (alternative name) (29), Aphelinus abdominalis (alternative name) (33), Aphidius colemani (alternative name) (34), Aphidoletes aphidimyza (alternative name) (35), Autographa californica NPV (alternative name) (38), Bacillus firmus (alternative name) (48), Bacillus sphaericus Neide (scientific name) (49), Bacillus thuringiensis Berliner (scientific name) (51), Bacillus thuringiensis subsp. aizawai (scientific name) (51), Bacillus thuringiensis subsp. israelensis (scientific name) (51), Bacillus thuringiensis subsp. japonensis (scientific name) (51), Bacillus thuringiensis subsp. kurstaki (scientific name) (51), Bacillus thuringiensis subsp. tenebrionis (scientific name) (51), Beauveria bassiana (alternative name) (53), Beauveria brongniartii (alternative name) (54), Chrysoperla carnea (alternative name) (151), Cryptolaemus montrouzieri (alternative name) (178), Cydia pomonella GV (alternative name) (191), Dacnusa sibirica (alternative name) (212), Diglyphus isaea (alternative name) (254), Encarsia formosa (scientific name) (293), Eretmocerus eremicus (alternative name) (300), Helicoverpa zea NPV (alternative name) (431), Heterorhabditis bacteriophora and H. megidis (alternative name) (433), Hippodamia convergens (alternative name) (442), Leptomastix dactylopii (alternative name) (488), Macrolophus caliginosus (alternative name) (491), Mamestra brassicae NPV (alternative name) (494), Metaphycus helvolus (alternative name) (522), Metarhizium anisopliae var. acridum (scientific name) (523), Metarhizium anisopliae var. anisopliae (scientific name) (523), Neodiprion sertifer NPV and N. lecontei NPV (alternative name) (575), Orius spp. (alternative name) (596), Paecilomyces fumosoroseus (alternative name) (613), Phytoseiulus persimilis (alternative name) (644), Spodoptera exigua multicapsid nuclear polyhedrosis virus (scientific name) (741), Steinernema bibionis (alternative name) (742), Steinernema carpocapsae (alternative name) (742), Steinernema feltiae (alternative name) (742), Steinernema glaseri (alternative name) (742), Steinernema riobrave (alternative name) (742), Steinernema riobravis (alternative name) (742), Steinernema scapterisci (alternative name) (742), Steinernema spp. (alternative name) (742), Trichogramma spp. (alternative name) (826), Typhlodromus occidentalis (alternative name) (844) and Verticillium lecanii (alternative name) (848),
a soil sterilant selected from the group of substances consisting of iodomethane (IUPAC name) (542) and methyl bromide (537),
a chemosterilant selected from the group of substances consisting of apholate [CCN], bisazir (alternative name) [CCN], busulfan (alternative name) [CCN], diflubenzuron (250), dimatif (alternative name) [CCN], hemel [CCN], hempa [CCN], metepa [CCN], methiotepa [CCN], methyl apholate [CCN], morzid [CCN], penfluoron (alternative name) [CCN], tepa [CCN], thiohempa (alternative name) [CCN], thiotepa (alternative name) [CCN], tretamine (alternative name) [CCN] and uredepa (alternative name) [CCN],
an insect pheromone selected from the group of substances consisting of (E)-dec-5-en-1-yl acetate with (E)-dec-5-en-1-ol (IUPAC name) (222), (E)-tridec-4-en-1-yl acetate (IUPAC name) (829), (E)-6-methylhept-2-en-4-ol (IUPAC name) (541), (E,Z)-tetradeca-4,10-dien-1-yl acetate (IUPAC name) (779), (Z)-dodec-7-en-1-yl acetate (IUPAC name) (285), (Z)-hexadec-11-enal (IUPAC name) (436), (Z)-hexadec-11-en-1-yl acetate (IUPAC name) (437), (Z)-hexadec-13-en-11-yn-1-yl acetate (IUPAC name) (438), (Z)-icos-13-en-10-one (IUPAC name) (448), (Z)-tetradec-7-en-1-al (IUPAC name) (782), (Z)-tetradec-9-en-1-ol (IUPAC name) (783), (Z)-tetradec-9-en-1-yl acetate (IUPAC name) (784), (7E,9Z)-dodeca-7,9-dien-1-yl acetate (IUPAC name) (283), (9Z,11E)-tetradeca-9,11-dien-1-yl acetate (IUPAC name) (780), (9Z,12E)-tetradeca-9,12-dien-1-yl acetate (IUPAC name) (781), 14-methyloctadec-1-ene (IUPAC name) (545), 4-methylnonan-5-ol with 4-methylnonan-5-one (IUPAC name) (544), alpha-multistriatin (alternative name) [CCN], brevicomin (alternative name) [CCN], codlelure (alternative name) [CCN], codlemone (alternative name) (167), cuelure (alternative name) (179), disparlure (277), dodec-8-en-1-yl acetate (IUPAC name) (286), dodec-9-en-1-yl acetate (IUPAC name) (287), dodeca-8,10-dien-1-yl acetate (IUPAC name) (284), dominicalure (alternative name) [CCN], ethyl 4-methyloctanoate (IUPAC name) (317), eugenol (alternative name) [CCN], frontalin (alternative name) [CCN], gossyplure (alternative name) (420), grandlure (421), grandlure I (alternative name) (421), grandlure II (alternative name) (421), grandlure III (alternative name) (421), grandlure IV (alternative name) (421), hexylure [CCN], ipsdienol (alternative name) [CCN], ipsenol (alternative name) [CCN], japonilure (alternative name) (481), lineatin (alternative name) [CCN], litlure (alternative name) [CCN], looplure (alternative name) [CCN], medlure [CCN], megatomoic acid (alternative name) [CCN], methyl eugenol (alternative name) (540), muscalure (563), octadeca-2,13-dien-1-yl acetate (IUPAC name) (588), octadeca-3,13-dien-1-yl acetate (IUPAC name) (589), orfralure (alternative name) [CCN], oryctalure (alternative name) (317), ostramone (alternative name) [CCN], siglure [CCN], sordidin (alternative name) (736), sulcatol (alternative name) [CCN], tetradec-11-en-1-yl acetate (IUPAC name) (785), trimedlure (839), trimedlure A (alternative name) (839), trimedlure B₁ (alternative name) (839), trimedlure B₂ (alternative name) (839), trimedlure C (alternative name) (839) and trunc-call (alternative name) [CCN],
an insect repellent selected from the group of substances consisting of 2-(octylthio)-ethanol (IUPAC name) (591), butopyronoxyl (933), butoxy(polypropylene glycol) (936), dibutyl adipate (IUPAC name) (1046), dibutyl phthalate (1047), dibutyl succinate (IUPAC name) (1048), diethyltoluamide [CCN], dimethyl carbate [CCN], dimethyl phthalate [CCN], ethyl hexanediol (1137), hexamide [CCN], methoquin-butyl (1276), methylneodecanamide [CCN], oxamate [CCN] and picaridin [CCN],
an insecticide selected from the group of substances consisting of 1,1-dichloro-1-nitroethane (IUPAC/Chemical Abstracts name) (1058), 1,1-dichloro-2,2-bis(4-ethylphenyl)-ethane (IUPAC name) (1056), 1,2-dichloropropane (IUPAC/Chemical Abstracts name) (1062), 1,2-dichloropropane with 1,3-dichloropropene (IUPAC name) (1063), 1-bromo-2-chloroethane (IUPAC/Chemical Abstracts name) (916), 2,2,2-trichloro-1-(3,4-dichloro-phenyl)ethyl acetate (IUPAC name) (1451), 2,2-dichlorovinyl 2-ethylsulfinylethyl methyl phosphate (IUPAC name) (1066), 2-(1,3-dithiolan-2-yl)phenyl dimethylcarbamate (IUPAC/Chemical Abstracts name) (1109), 2-(2-butoxyethoxy)ethyl thiocyanate (IUPAC/Chemical Abstracts name) (935), 2-(4,5-dimethyl-1,3-dioxolan-2-yl)phenyl methylcarbamate (IUPAC/Chemical Abstracts name) (1084), 2-(4-chloro-3,5-xylyloxy)ethanol (IUPAC name) (986), 2-chlorovinyl diethyl phosphate (IUPAC name) (984), 2-imidazolidone (IUPAC name) (1225), 2-isovalerylindan-1,3-dione (IUPAC name) (1246), 2-methyl(prop-2-ynyl)aminophenyl methylcarbamate (IUPAC name) (1284), 2-thiocyanatoethyl laurate (IUPAC name) (1433), 3-bromo-1-chloroprop-1-ene (IUPAC name) (917), 3-methyl-1-phenylpyrazol-5-yl dimethyl-carbamate (IUPAC name) (1283), 4-methyl(prop-2-ynyl)amino-3,5-xylyl methylcarbamate (IUPAC name) (1285), 5,5-dimethyl-3-oxocyclohex-1-enyl dimethylcarbamate (IUPAC name) (1085), abamectin (1), acephate (2), acetamiprid (4), acethion (alternative name) [CCN], acetoprole [CCN], acrinathrin (9), acrylonitrile (IUPAC name) (861), alanycarb (15), aldicarb (16), aldoxycarb (863), aldrin (864), allethrin (17), allosamidin (alternative name) [CCN], allyxycarb (866), alpha-cypermethrin (202), alpha-ecdysone (alternative name) [CCN], aluminium phosphide (640), amidithion (870), amidothioate (872), aminocarb (873), amiton (875), amiton hydrogen oxalate (875), amitraz (24), anabasine (877), athidathion (883), AVI 382 (compound code), AZ 60541 (compound code), azadirachtin (alternative name) (41), azamethiphos (42), azinphos-ethyl (44), azinphos-methyl (45), azothoate (889), Bacillus thuringiensis delta endotoxins (alternative name) (52), barium hexafluorosilicate (alternative name) [CCN], barium polysulfide (IUPAC/Chemical Abstracts name) (892), barthrin [CCN], BAS 320 I (compound code), Bayer 22/190 (development code) (893), Bayer 22408 (development code) (894), bendiocarb (58), benfuracarb (60), bensultap (66), beta-cyfluthrin (194), beta-cypermethrin (203), bifenthrin (76), bioallethrin (78), bioallethrin S-cyclopentenyl isomer (alternative name) (79), bioethanomethrin [CCN], biopermethrin (908), bioresmethrin (80), bis(2-chloroethyl)ether (IUPAC name) (909), bistrifluoron (83), borax (86), brofenvalerate (alternative name), bromfenvinfos (914), bromocyclen (918), bromo-DDT (alternative name) [CCN], bromophos (920), bromophos-ethyl (921), bufencarb (924), buprofezin (99), butacarb (926), butathiofos (927), butocarboxim (103), butonate (932), butoxycarboxim (104), butylpyridaben (alternative name), cadusafos (109), calcium arsenate [CCN], calcium cyamide (444), calcium polysulfide (IUPAC name) (111), camphechlor (941), carbanolate (943), carbaryl (115), carbofuran (118), carbon disulfide (IUPAC/Chemical Abstracts name) (945), carbon tetrachloride (IUPAC name) (946), carbophenothion (947), carbosulfan (119), cartap (123), cartap hydrochloride (123), cevadine (alternative name) (725), chlorbicyclen (960), chlordane (128), chlordecone (963), chlordimeform (964), chlordimeform hydrochloride (964), chlorethoxyfos (129), chlorfenapyr (130), chlorfenvinphos (131), chlorfluazuron (132), chlormephos (136), chloroform [CCN], chloropicrin (141), chlorphoxim (989), chlorprazophos (990), chlorpyrifos (145), chlorpyrifos-methyl (146), chlorthiophos (994), chromafenozide (150), cinerin I (696), cinerin II (696), cinerins (696), cis-resmethrin (alternative name), cismethrin (80), clocythrin (alternative name), cloethocarb (999), closantel (alternative name) [CCN], clothianidin (165), copper acetoarsenite [CCN], copper arsenate [CCN], copper oleate [CCN], coumaphos (174), coumithoate (1006), crotamiton (alternative name) [CCN], crotoxyphos (1010), crufomate (1011), cryolite (alternative name) (177), CS 708 (development code) (1012), cyanofenphos (1019), cyanophos (184), cyanthoate (1020), cyclethrin [CCN], cycloprothrin (188), cyfluthrin (193), cyhalothrin (196), cypermethrin (201), cyphenothrin (206), cyromazine (209), cythioate (alternative name) [CCN], d-limonene (alternative name) [CCN], d-tetramethrin (alternative name) (788), DAEP (1031), dazomet (216), DDT (219), decarbofuran (1034), deltamethrin (223), demephion (1037), demephion-O (1037), demephion-S (1037), demeton (1038), demeton-methyl (224), demeton-O (1038), demeton-O-methyl (224), demeton-S (1038), demeton-5-methyl (224), demeton-5-methylsulphon (1039), diafenthiuron (226), dialifos (1042), diamidafos (1044), diazinon (227), dicapthon (1050), dichlofenthion (1051), dichlorvos (236), dicliphos (alternative name), dicresyl (alternative name) [CCN], dicrotophos (243), dicyclanil (244), dieldrin (1070), diethyl 5-methylpyrazol-3-yl phosphate (IUPAC name) (1076), diflubenzuron (250), dilor (alternative name) [CCN], dimefluthrin [CCN], dimefox (1081), dimetan (1085), dimethoate (262), dimethrin (1083), dimethylvinphos (265), dimetilan (1086), dinex (1089), dinex-diclexine (1089), dinoprop (1093), dinosam (1094), dinoseb (1095), dinotefuran (271), diofenolan (1099), dioxabenzofos (1100), dioxacarb (1101), dioxathion (1102), disulfoton (278), dithicrofos (1108), DNOC (282), doramectin (alternative name) [CCN], DSP (1115), ecdysterone (alternative name) [CCN], EI 1642 (development code) (1118), emamectin (291), emamectin benzoate (291), EMPC (1120), empenthrin (292), endosulfan (294), endothion (1121), endrin (1122), EPBP (1123), EPN (297), epofenonane (1124), eprinomectin (alternative name) [CCN], esfenvalerate (302), etaphos (alternative name) [CCN], ethiofencarb (308), ethion (309), ethiprole (310), ethoate-methyl (1134), ethoprophos (312), ethyl formate (IUPAC name) [CCN], ethyl-DDD (alternative name) (1056), ethylene dibromide (316), ethylene dichloride (chemical name) (1136), ethylene oxide [CCN], etofenprox (319), etrimfos (1142), EXD (1143), famphur (323), fenamiphos (326), fenazaflor (1147), fenchlorphos (1148), fenethacarb (1149), fenfluthrin (1150), fenitrothion (335), fenobucarb (336), fenoxacrim (1153), fenoxycarb (340), fenpirithrin (1155), fenpropathrin (342), fenpyrad (alternative name), fensulfothion (1158), fenthion (346), fenthion-ethyl [CCN], fenvalerate (349), fipronil (354), flonicamid (358), flucofuron (1168), flucycloxuron (366), flucythrinate (367), fluenetil (1169), flufenerim [CCN], flufenoxuron (370), flufenprox (1171), flumethrin (372), fluvalinate (1184), FMC 1137 (development code) (1185), fonofos (1191), formetanate (405), formetanate hydrochloride (405), formothion (1192), formparanate (1193), fosmethilan (1194), fospirate (1195), fosthiazate (408), fosthietan (1196), furathiocarb (412), furethrin (1200), gamma-cyhalothrin (197), gamma-HCH (430), guazatine (422), guazatine acetates (422), GY-81 (development code) (423), halfenprox (424), halofenozide (425), HCH (430), HEOD (1070), heptachlor (1211), heptenophos (432), heterophos [CCN], hexaflumuron (439), HHDN (864), hydramethylnon (443), hydrogen cyamide (444), hydroprene (445), hyquincarb (1223), imidacloprid (458), imiprothrin (460), indoxacarb (465), iodomethane (IUPAC name) (542), IPSP (1229), isazofos (1231), isobenzan (1232), isocarbophos (alternative name) (473), isodrin (1235), isofenphos (1236), isolane (1237), isoprocarb (472), isopropyl O-(methoxyaminothiophosphoryl)salicylate (IUPAC name) (473), isoprothiolane (474), isothioate (1244), isoxathion (480), ivermectin (alternative name) [CCN], jasmolin I (696), jasmolin II (696), jodfenphos (1248), juvenile hormone I (alternative name) [CCN], juvenile hormone II (alternative name) [CCN], juvenile hormone III (alternative name) [CCN], kelevan (1249), kinoprene (484), lambda-cyhalothrin (198), lead arsenate [CCN], leptophos (1250), lindane (430), lirimfos (1251), lufenuron (490), lythidathion (1253), m-cumenyl methylcarbamate (IUPAC name) (1014), magnesium phosphide (IUPAC name) (640), malathion (492), malonoben (1254), mazidox (1255), mecarbam (502), mecarphon (1258), menazon (1260), mephosfolan (1261), mercurous chloride (513), mesulfenfos (1263), metam (519), metam-potassium (alternative name) (519), metam-sodium (519), methacrifos (1266), methamidophos (527), methanesulfonyl fluoride (IUPAC/Chemical Abstracts name) (1268), methidathion (529), methiocarb (530), methocrotophos (1273), methomyl (531), methoprene (532), methoquin-butyl (1276), methothrin (alternative name) (533), methoxychlor (534), methoxyfenozide (535), methyl bromide (537), methyl isothiocyanate (543), methylchloroform (alternative name) [CCN], methylene chloride [CCN], metofluthrin [CCN], metolcarb (550), metoxadiazone (1288), mevinphos (556), mexacarbate (1290), milbemectin (557), milbemycin oxime (alternative name) [CCN], mipafox (1293), mirex (1294), monocrotophos (561), morphothion (1300), moxidectin (alternative name) [CCN], naftalofos (alternative name) [CCN], naled (567), naphthalene (IUPAC/Chemical Abstracts name) (1303), NC-170 (development code) (1306), NC-184 (compound code), nicotine (578), nicotine sulfate (578), nifluridide (1309), nitenpyram (579), nithiazine (1311), nitrilacarb (1313), nitrilacarb 1:1 zinc chloride complex (1313), NNI-0101 (compound code), NNI-0250 (compound code), nornicotine (traditional name) (1319), novaluron (585), noviflumuron (586), O-2,5-dichloro-4-iodophenyl O-ethyl ethylphosphonothioate (IUPAC name) (1057), O,O-diethyl O-4-methyl-2-oxo-2H-chromen-7-yl phosphorothioate (IUPAC name) (1074), O,O-diethyl O-6-methyl-2-propylpyrimidin-4-yl phosphorothioate (IUPAC name) (1075), O,O,O′,O′-tetrapropyl dithiopyrophosphate (IUPAC name) (1424), oleic acid (IUPAC name) (593), omethoate (594), oxamyl (602), oxydemeton-methyl (609), oxydeprofos (1324), oxydisulfoton (1325), pp′-DDT (219), para-dichlorobenzene [CCN], parathion (615), parathion-methyl (616), penfluoron (alternative name) [CCN], pentachlorophenol (623), pentachlorophenyl laurate (IUPAC name) (623), permethrin (626), petroleum oils (alternative name) (628), PH 60-38 (development code) (1328), phenkapton (1330), phenothrin (630), phenthoate (631), phorate (636), phosalone (637), phosfolan (1338), phosmet (638), phosnichlor (1339), phosphamidon (639), phosphine (IUPAC name) (640), phoxim (642), phoxim-methyl (1340), pirimetaphos (1344), pirimicarb (651), pirimiphos-ethyl (1345), pirimiphos-methyl (652), polychlorodicyclopentadiene isomers (IUPAC name) (1346), polychloroterpenes (traditional name) (1347), potassium arsenite [CCN], potassium thiocyanate [CCN], prallethrin (655), precocene I (alternative name) [CCN], precocene II (alternative name) [CCN], precocene III (alternative name) [CCN], primidophos (1349), profenofos (662), profluthrin [CCN], promacyl (1354), promecarb (1355), propaphos (1356), propetamphos (673), propoxur (678), prothidathion (1360), prothiofos (686), prothoate (1362), protrifenbute [CCN], pymetrozine (688), pyraclofos (689), pyrazophos (693), pyresmethrin (1367), pyrethrin I (696), pyrethrin II (696), pyrethrins (696), pyridaben (699), pyridalyl (700), pyridaphenthion (701), pyrimidifen (706), pyrimitate (1370), pyriproxyfen (708), quassia (alternative name) [CCN], quinalphos (711), quinalphos-methyl (1376), quinothion (1380), quintiofos (1381), R-1492 (development code) (1382), rafoxanide (alternative name) [CCN], resmethrin (719), rotenone (722), RU 15525 (development code) (723), RU 25475 (development code) (1386), ryania (alternative name) (1387), ryanodine (traditional name) (1387), sabadilla (alternative name) (725), schradan (1389), sebufos (alternative name), selamectin (alternative name) [CCN], SI-0009 (compound code), silafluofen (728), SN 72129 (development code) (1397), sodium arsenite [CCN], sodium cyamide (444), sodium fluoride (IUPAC/Chemical Abstracts name) (1399), sodium hexafluorosilicate (1400), sodium pentachlorophenoxide (623), sodium selenate (IUPAC name) (1401), sodium thiocyanate [CCN], sophamide (1402), spinosad (737), spiromesifen (739), sulcofuron (746), sulcofuron-sodium (746), sulfluramid (750), sulfotep (753), sulfuryl fluoride (756), sulprofos (1408), tar oils (alternative name) (758), tau-fluvalinate (398), tazimcarb (1412), TDE (1414), tebufenozide (762), tebufenpyrad (763), tebupirimfos (764), teflubenzuron (768), tefluthrin (769), temephos (770), TEPP (1417), terallethrin (1418), terbam (alternative name), terbufos (773), tetrachloroethane [CCN], tetrachlorvinphos (777), tetramethrin (787), theta-cypermethrin (204), thiacloprid (791), thiafenox (alternative name), thiamethoxam (792), thicrofos (1428), thiocarboxime (1431), thiocyclam (798), thiocyclam hydrogen oxalate (798), thiodicarb (799), thiofanox (800), thiometon (801), thionazin (1434), thiosultap (803), thiosultap-sodium (803), thuringiensin (alternative name) [CCN], tolfenpyrad (809), tralomethrin (812), transfluthrin (813), transpermethrin (1440), triamiphos (1441), triazamate (818), triazophos (820), triazuron (alternative name), trichlorfon (824), trichlormetaphos-3 (alternative name) [CCN], trichloronat (1452), trifenofos (1455), triflumuron (835), trimethacarb (840), triprene (1459), vamidothion (847), vaniliprole [CCN], veratridine (alternative name) (725), veratrine (alternative name) (725), XMC (853), xylylcarb (854), YI-5302 (compound code), zeta-cypermethrin (205), zetamethrin (alternative name), zinc phosphide (640), zolaprofos (1469) and ZXI 8901 (development code) (858),
a molluscicide selected from the group of substances consisting of bis(tributyltin)oxide (IUPAC name) (913), bromoacetamide [CCN], calcium arsenate [CCN], cloethocarb (999), copper acetoarsenite [CCN], copper sulfate (172), fentin (347), ferric phosphate (IUPAC name) (352), metaldehyde (518), methiocarb (530), niclosamide (576), niclosamide-olamine (576), pentachlorophenol (623), sodium pentachlorophenoxide (623), tazimcarb (1412), thiodicarb (799), tributyltin oxide (913), trifenmorph (1454), trimethacarb (840), triphenyltin acetate (IUPAC name) (347) and triphenyltin hydroxide (IUPAC name) (347),
a nematicide selected from the group of substances consisting of 1,2-dibromo-3-chloropropane (IUPAC/Chemical Abstracts name) (1045), 1,2-dichloropropane (IUPAC/Chemical Abstracts name) (1062), 1,2-dichloropropane with 1,3-dichloropropene (IUPAC name) (1063), 1,3-dichloropropene (233), 3,4-dichlorotetrahydrothiophene 1,1-dioxide (IUPAC/Chemical Abstracts name) (1065), 3-(4-chlorophenyl)-5-methylrhodanine (IUPAC name) (980), 5-methyl-6-thioxo-1,3,5-thiadiazinan-3-ylacetic acid (IUPAC name) (1286), 6-isopentenylaminopurine (alternative name) (210), abamectin (1), acetoprole [CCN], alanycarb (15), aldicarb (16), aldoxycarb (863), AZ 60541 (compound code), benclothiaz [CCN], benomyl (62), butylpyridaben (alternative name), cadusafos (109), carbofuran (118), carbon disulfide (945), carbosulfan (119), chloropicrin (141), chlorpyrifos (145), cloethocarb (999), cytokinins (alternative name) (210), dazomet (216), DBCP (1045), DCIP (218), diamidafos (1044), dichlofenthion (1051), dicliphos (alternative name), dimethoate (262), doramectin (alternative name) [CCN], emamectin (291), emamectin benzoate (291), eprinomectin (alternative name) [CCN], ethoprophos (312), ethylene dibromide (316), fenamiphos (326), fenpyrad (alternative name), fensulfothion (1158), fosthiazate (408), fosthietan (1196), furfural (alternative name) [CCN], GY-81 (development code) (423), heterophos [CCN], iodomethane (IUPAC name) (542), isamidofos (1230), isazofos (1231), ivermectin (alternative name) [CCN], kinetin (alternative name) (210), mecarphon (1258), metam (519), metam-potassium (alternative name) (519), metam-sodium (519), methyl bromide (537), methyl isothiocyanate (543), milbemycin oxime (alternative name) [CCN], moxidectin (alternative name) [CCN], Myrothecium verrucaria composition (alternative name) (565), NC-184 (compound code), oxamyl (602), phorate (636), phosphamidon (639), phosphocarb [CCN], sebufos (alternative name), selamectin (alternative name) [CCN], spinosad (737), terbam (alternative name), terbufos (773), tetrachlorothiophene (IUPAC/Chemical Abstracts name) (1422), thiafenox (alternative name), thionazin (1434), triazophos (820), triazuron (alternative name), xylenols [CCN], YI-5302 (compound code) and zeatin (alternative name) (210),
a nitrification inhibitor selected from the group of substances consisting of potassium ethylxanthate [CCN] and nitrapyrin (580),
a plant activator selected from the group of substances consisting of acibenzolar (6), acibenzolar-5-methyl (6), probenazole (658) and Reynoutria sachalinensis extract (alternative name) (720),
a rodenticide selected from the group of substances consisting of 2-isovalerylindan-1,3-dione (IUPAC name) (1246), 4-(quinoxalin-2-ylamino)benzenesulfonamide (IUPAC name) (748), alpha-chlorohydrin [CCN], aluminium phosphide (640), antu (880), arsenous oxide (882), barium carbonate (891), bisthiosemi (912), brodifacoum (89), bromadiolone (91), bromethalin (92), calcium cyamide (444), chloralose (127), chlorophacinone (140), cholecalciferol (alternative name) (850), coumachlor (1004), coumafuryl (1005), coumatetralyl (175), crimidine (1009), difenacoum (246), difethialone (249), diphacinone (273), ergocalciferol (301), flocoumafen (357), fluoroacetamide (379), flupropadine (1183), flupropadine hydrochloride (1183), gamma-HCH (430), HCH (430), hydrogen cyamide (444), iodomethane (IUPAC name) (542), lindane (430), magnesium phosphide (IUPAC name) (640), methyl bromide (537), norbormide (1318), phosacetim (1336), phosphine (IUPAC name) (640), phosphorus [CCN], pindone (1341), potassium arsenite [CCN], pyrinuron (1371), scilliroside (1390), sodium arsenite [CCN], sodium cyamide (444), sodium fluoro-acetate (735), strychnine (745), thallium sulfate [CCN], warfarin (851) and zinc phosphide (640),
a synergist selected from the group of substances consisting of 2-(2-butoxyethoxy)ethyl piperonylate (IUPAC name) (934), 5-(1,3-benzodioxol-5-yl)-3-hexylcyclohex-2-enone (IUPAC name) (903), farnesol with nerolidol (alternative name) (324), MB-599 (development code) (498), MGK 264 (development code) (296), piperonyl butoxide (649), piprotal (1343), propyl isomer (1358), S421 (development code) (724), sesamex (1393), sesasmolin (1394) and sulfoxide (1406),
an animal repellent selected from the group of substances consisting of anthraquinone (32), chloralose (127), copper naphthenate [CCN], copper oxychloride (171), diazinon (227), dicyclopentadiene (chemical name) (1069), guazatine (422), guazatine acetates (422), methiocarb (530), pyridin-4-amine (IUPAC name) (23), thiram (804), trimethacarb (840), zinc naphthenate [CCN] and ziram (856),
a virucide selected from the group of substances consisting of imanin (alternative name) [CCN] and ribavirin (alternative name) [CCN],
and a wound protectant selected from the group of substances consisting of mercuric oxide (512), octhilinone (590) and thiophanate-methyl (802).

A very especially preferred embodiment of the subject-matter {1.1.6} of the invention is {1.1.6.2} a pesticidal composition comprising a mixture consisting of at least two substances, namely one compound (A) and at least one compound (B), as active ingredient and at least one auxiliary, wherein the compound (A) is the compound of formula (A-6) and the compound (B) is a compound selected from the group of substances consisting of abamectin (1), cyromazine (209), diafenthiuron (226), diazinon (227), emamectin benzoate (291), fenoxycarb (340), fosthiazate (408), lambda-cyhalothrin (198), lufenuron (490), methidathion (529), profenofos (662), pymetrozine (688), tefluthrin (769) and thiamethoxam (792).

The compound of formula (A-6) is known, for example, from the PCT Application WO-03/015519.

A preferred embodiment of the subject-matter {1.1} of the invention is {1.1.7} a pesticidal composition comprising a mixture consisting of at least two substances, namely one compound (A) and at least one compound (B), as active ingredient and at least one auxiliary, wherein the compound (A) is the compound of formula (A-7) 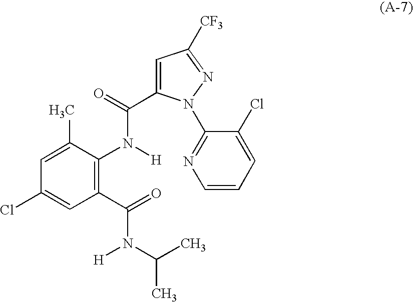
and the compound (B) is a compound selected from the group of substances consisting of an adjuvant, an acaricide, an algicide, an anthelmintic, an avicide, a bactericide, a biological agent, a soil sterilant, a chemosterilant, an insect pheromone, an insect repellent, an insecticide, a molluscicide, a nematicide, a nitrification inhibitor, a plant activator, a rodenticide, a synergist, an animal repellent, a virucide and a wound protectant.

An especially preferred embodiment of the subject-matter {1.1.7} of the invention is {1.1.7.1} a pesticidal composition comprising a mixture consisting of at least two substances, namely one compound (A) and at least one compound (B), as active ingredient and at least one auxiliary, wherein the compound (A) is the compound of formula (A-7) and the compound (B) is a compound selected from the group of substances consisting of
an adjuvant selected from the group of substances consisting of petroleum oils (alternative name) (628),
an acaricide selected from the group of substances consisting of 1,1-bis(4-chlorophenyl)-2-ethoxyethanol (IUPAC name) (910), 2,4-dichlorophenyl benzenesulfonate (IUPAC/Chemical Abstracts name) (1059), 2-fluoro-N-methyl-N-1-naphthylacetamide (IUPAC name) (1295), 4-chlorophenyl phenyl sulfone (IUPAC name) (981), abamectin (1), acequinocyl (3), acetoprole [CCN], acrinathrin (9), aldicarb (16), aldoxycarb (863), alpha-cypermethrin (202), amidithion (870), amidoflumet [CCN], amidothioate (872), amiton (875), amiton hydrogen oxalate (875), amitraz (24), aramite (881), arsenous oxide (882), AVI 382 (compound code), AZ 60541 (compound code), azinphos-ethyl (44), azinphos-methyl (45), azobenzene (IUPAC name) (888), azocyclotin (46), azothoate (889), benomyl (62), benoxafos (alternative name) [CCN], benzoximate (71), benzyl benzoate (IUPAC name) [CCN], bifenazate (74), bifenthrin (76), binapacryl (907), brofenvalerate (alternative name), bromocyclen (918), bromophos (920), bromophos-ethyl (921), bromopropylate (94), buprofezin (99), butocarboxim (103), butoxycarboxim (104), butylpyridaben (alternative name), calcium polysulfide (IUPAC name) (111), camphechlor (941), carbanolate (943), carbaryl (115), carbofuran (118), carbophenothion (947), CGA 50'439 (development code) (125), chinomethionat (126), chlorbenside (959), chlordimeform (964), chlordimeform hydrochloride (964), chlorfenapyr (130), chlorfenethol (968), chlorfenson (970), chlorfensulphide (971), chlorfenvinphos (131), chlorobenzilate (975), chloromebuform (977), chloromethiuron (978), chloropropylate (983), chlorpyrifos (145), chlorpyrifos-methyl (146), chlorthiophos (994), cinerin I (696), cinerin II (696), cinerins (696), clofentezine (158), closantel (alternative name) [CCN], coumaphos (174), crotamiton (alternative name) [CCN], crotoxyphos (1010), cufraneb (1013), cyanthoate (1020), cyhalothrin (196), cyhexatin (199), cypermethrin (201), DCPM (1032), DDT (219), demephion (1037), demephion-O (1037), demephion-S (1037), demeton (1038), demeton-methyl (224), demeton-O (1038), demeton-O-methyl (224), demeton-S (1038), demeton-5-methyl (224), demeton-5-methylsulphon (1039), diafenthiuron (226), dialifos (1042), diazinon (227), dichlofluanid (230), dichlorvos (236), dicliphos (alternative name), dicofol (242), dicrotophos (243), dienochlor (1071), dimefox (1081), dimethoate (262), dinactin (alternative name) (653), dinex (1089), dinex-diclexine (1089), dinobuton (269), dinocap (270), dinocap-4 [CCN], dinocap-6 [CCN], dinocton (1090), dinopenton (1092), dinosulfon (1097), dinoterbon (1098), dioxathion (1102), diphenyl sulfone (IUPAC name) (1103), disulfuram (alternative name) [CCN], disulfoton (278), DNOC (282), dofenapyn (1113), doramectin (alternative name) [CCN], endosulfan (294), endothion (1121), EPN (297), eprinomectin (alternative name) [CCN], ethion (309), ethoate-methyl (1134), etoxazole (320), etrimfos (1142), fenazaflor (1147), fenazaquin (328), fenbutatin oxide (330), fenothiocarb (337), fenpropathrin (342), fenpyrad (alternative name), fenpyroximate (345), fenson (1157), fentrifanil (1161), fenvalerate (349), fipronil (354), fluacrypyrim (360), fluazuron (1166), flubenzimine (1167), flucycloxuron (366), flucythrinate (367), fluenetil (1169), flufenoxuron (370), flumethrin (372), fluorbenside (1174), fluvalinate (1184), FMC 1137 (development code) (1185), formetanate (405), formetanate hydrochloride (405), formothion (1192), formparanate (1193), gamma-HCH (430), glyodin (1205), halfenprox (424), heptenophos (432), hexadecyl cyclopropanecarboxylate (IUPAC/Chemical Abstracts name) (1216), hexythiazox (441), iodomethane (IUPAC name) (542), isocarbophos (alternative name) (473), isopropyl O-(methoxyaminothiophosphoryl)salicylate (IUPAC name) (473), ivermectin (alternative name) [CCN], jasmolin I (696), jasmolin II (696), jodfenphos (1248), lindane (430), lufenuron (490), malathion (492), malonoben (1254), mecarbam (502), mephosfolan (1261), mesulfen (alternative name) [CCN], methacrifos (1266), methamidophos (527), methidathion (529), methiocarb (530), methomyl (531), methyl bromide (537), metolcarb (550), mevinphos (556), mexacarbate (1290), milbemectin (557), milbemycin oxime (alternative name) [CCN], mipafox (1293), monocrotophos (561), morphothion (1300), moxidectin (alternative name) [CCN], naled (567), NC-184 (compound code), nifluridide (1309), nikkomycins (alternative name) [CCN], nitrilacarb (1313), nitrilacarb 1:1 zinc chloride complex (1313), NNI-0101 (compound code), NNI-0250 (compound code), omethoate (594), oxamyl (602), oxydeprofos (1324), oxydisulfoton (1325), pp′-DDT (219), parathion (615), permethrin (626), petroleum oils (alternative name) (628), phenkapton (1330), phenthoate (631), phorate (636), phosalone (637), phosfolan (1338), phosmet (638), phosphamidon (639), phoxim (642), pirimiphos-methyl (652), polychloroterpenes (traditional name) (1347), polynactins (alternative name) (653), proclonol (1350), profenofos (662), promacyl (1354), propargite (671), propetamphos (673), propoxur (678), prothidathion (1360), prothoate (1362), pyrethrin I (696), pyrethrin II (696), pyrethrins (696), pyridaben (699), pyridaphenthion (701), pyrimidifen (706), pyrimitate (1370), quinalphos (711), quintiofos (1381), R-1492 (development code) (1382), RA-17 (development code) (1383), rotenone (722), schradan (1389), sebufos (alternative name), selamectin (alternative name) [CCN], SI-0009 (compound code), sophamide (1402), spirodiclofen (738), spiromesifen (739), SSI-121 (development code) (1404), sulfuram (alternative name) [CCN], sulfluramid (750), sulfotep (753), sulfur (754), SZI-121 (development code) (757), tau-fluvalinate (398), tebufenpyrad (763), TEPP (1417), terbam (alternative name), tetrachlorvinphos (777), tetradifon (786), tetranactin (alternative name) (653), tetrasul (1425), thiafenox (alternative name), thiocarboxime (1431), thiofanox (800), thiometon (801), thioquinox (1436), thuringiensin (alternative name) [CCN], triamiphos (1441), triarathene (1443), triazophos (820), triazuron (alternative name), trichlorfon (824), trifenofos (1455), trinactin (alternative name) (653), vamidothion (847), vaniliprole [CCN] and YI-5302 (compound code),
an algicide selected from the group of substances consisting of bethoxazin [CCN], copper dioctanoate (IUPAC name) (170), copper sulfate (172), cybutryne [CCN], dichlone (1052), dichlorophen (232), endothal (295), fentin (347), hydrated lime [CCN], nabam (566), quinoclamine (714), quinonamid (1379), simazine (730), triphenyltin acetate (IUPAC name) (347) and triphenyltin hydroxide (IUPAC name) (347),
an anthelmintic selected from the group of substances consisting of abamectin (1), crufomate (1011), doramectin (alternative name) [CCN], emamectin (291), emamectin benzoate (291), eprinomectin (alternative name) [CCN], ivermectin (alternative name) [CCN], milbemycin oxime (alternative name) [CCN], moxidectin (alternative name) [CCN], piperazine [CCN], selamectin (alternative name) [CCN], spinosad (737) and thiophanate (1435),
an avicide selected from the group of substances consisting of chloralose (127), endrin (1122), fenthion (346), pyridin-4-amine (IUPAC name) (23) and strychnine (745),
a bactericide selected from the group of substances consisting of 1-hydroxy-1H-pyridine-2-thione (IUPAC name) (1222), 4-(quinoxalin-2-ylamino)benzenesulfonamide (IUPAC name) (748), 8-hydroxyquinoline sulfate (446), bronopol (97), copper dioctanoate (IUPAC name) (170), copper hydroxide (IUPAC name) (169), cresol [CCN], dichlorophen (232), dipyrithione (1105), dodicin (1112), fenaminosulf (1144), formaldehyde (404), hydrargaphen (alternative name) [CCN], kasugamycin (483), kasugamycin hydrochloride hydrate (483), nickel bis(dimethyldithiocarbamate) (IUPAC name) (1308), nitrapyrin (580), octhilinone (590), oxolinic acid (606), oxytetracycline (611), potassium hydroxyquinoline sulfate (446), probenazole (658), streptomycin (744), streptomycin sesquisulfate (744), tecloftalam (766) and thiomersal (alternative name) [CCN],
a biological agent selected from the group of substances consisting of Adoxophyes orana GV (alternative name) (12), Agrobacterium radiobacter (alternative name) (13), Amblyseius spp. (alternative name) (19), Anagrapha falcifera NPV (alternative name) (28), Anagrus atomus (alternative name) (29), Aphelinus abdominalis (alternative name) (33), Aphidius colemani (alternative name) (34), Aphidoletes aphidimyza (alternative name) (35), Autographa californica NPV (alternative name) (38), Bacillus firmus (alternative name) (48), Bacillus sphaericus Neide (scientific name) (49), Bacillus thuringiensis Berliner (scientific name) (51), Bacillus thuringiensis subsp. aizawai (scientific name) (51), Bacillus thuringiensis subsp. israelensis (scientific name) (51), Bacillus thuringiensis subsp. japonensis (scientific name) (51), Bacillus thuringiensis subsp. kurstaki (scientific name) (51), Bacillus thuringiensis subsp. tenebrionis (scientific name) (51), Beauveria bassiana (alternative name) (53), Beauveria brongniartii (alternative name) (54), Chrysoperla carnea (alternative name) (151), Cryptolaemus montrouzieri (alternative name) (178), Cydia pomonella GV (alternative name) (191), Dacnusa sibirica (alternative name) (212), Diglyphus isaea (alternative name) (254), Encarsia formosa (scientific name) (293), Eretmocerus eremicus (alternative name) (300), Helicoverpa zea NPV (alternative name) (431), Heterorhabditis bacteriophora and H. megidis (alternative name) (433), Hippodamia convergens (alternative name) (442), Leptomastix dactylopii (alternative name) (488), Macrolophus caliginosus (alternative name) (491), Mamestra brassicae NPV (alternative name) (494), Metaphycus helvolus (alternative name) (522), Metarhizium anisopliae var. acridum (scientific name) (523), Metarhizium anisopliae var. anisopliae (scientific name) (523), Neodiprion sertifer NPV and N. lecontei NPV (alternative name) (575), Orius spp. (alternative name) (596), Paecilomyces fumosoroseus (alternative name) (613), Phytoseiulus persimilis (alternative name) (644), Spodoptera exigua multicapsid nuclear polyhedrosis virus (scientific name) (741), Steinernema bibionis (alternative name) (742), Steinernema carpocapsae (alternative name) (742), Steinernema feltiae (alternative name) (742), Steinernema glaseri (alternative name) (742), Steinernema riobrave (alternative name) (742), Steinernema riobravis (alternative name) (742), Steinernema scapterisci (alternative name) (742), Steinernema spp. (alternative name) (742), Trichogramma spp. (alternative name) (826), Typhlodromus occidentalis (alternative name) (844) and Verticillium lecanii (alternative name) (848),
a soil sterilant selected from the group of substances consisting of iodomethane (IUPAC name) (542) and methyl bromide (537),
a chemosterilant selected from the group of substances consisting of apholate [CCN], bisazir (alternative name) [CCN], busulfan (alternative name) [CCN], diflubenzuron (250), dimatif (alternative name) [CCN], hemel [CCN], hempa [CCN], metepa [CCN], methiotepa [CCN], methyl apholate [CCN], morzid [CCN], penfluoron (alternative name) [CCN], tepa [CCN], thiohempa (alternative name) [CCN], thiotepa (alternative name) [CCN], tretamine (alternative name) [CCN] and uredepa (alternative name) [CCN],
an insect pheromone selected from the group of substances consisting of (E)-dec-5-en-1-yl acetate with (E)-dec-5-en-1-ol (IUPAC name) (222), (E)-tridec-4-en-1-yl acetate (IUPAC name) (829), (E)-6-methylhept-2-en-4-ol (IUPAC name) (541), (E,Z)-tetradeca-4,10-dien-1-yl acetate (IUPAC name) (779), (Z)-dodec-7-en-1-yl acetate (IUPAC name) (285), (Z)-hexadec-11-enal (IUPAC name) (436), (Z)-hexadec-11-en-1-yl acetate (IUPAC name) (437), (Z)-hexadec-13-en-11-yn-1-yl acetate (IUPAC name) (438), (Z)-icos-13-en-10-one (IUPAC name) (448), (Z)-tetradec-7-en-1-al (IUPAC name) (782), (Z)-tetradec-9-en-1-ol (IUPAC name) (783), (Z)-tetradec-9-en-1-yl acetate (IUPAC name) (784), (7E,9Z)-dodeca-7,9-dien-1-yl acetate (IUPAC name) (283), (9Z,11E)-tetradeca-9,11-dien-1-yl acetate (IUPAC name) (780), (9Z,12E)-tetradeca-9,12-dien-1-yl acetate (IUPAC name) (781), 14-methyloctadec-1-ene (IUPAC name) (545), 4-methylnonan-5-ol with 4-methylnonan-5-one (IUPAC name) (544), alpha-multistriatin (alternative name) [CCN], brevicomin (alternative name) [CCN], codlelure (alternative name) [CCN], codlemone (alternative name) (167), cuelure (alternative name) (179), disparlure (277), dodec-8-en-1-yl acetate (IUPAC name) (286), dodec-9-en-1-yl acetate (IUPAC name) (287), dodeca-8,10-dien-1-yl acetate (IUPAC name) (284), dominicalure (alternative name) [CCN], ethyl 4-methyloctanoate (IUPAC name) (317), eugenol (alternative name) [CCN], frontalin (alternative name) [CCN], gossyplure (alternative name) (420), grandlure (421), grandlure I (alternative name) (421), grandlure II (alternative name) (421), grandlure III (alternative name) (421), grandlure IV (alternative name) (421), hexylure [CCN], ipsdienol (alternative name) [CCN], ipsenol (alternative name) [CCN], japonilure (alternative name) (481), lineatin (alternative name) [CCN], litlure (alternative name) [CCN], looplure (alternative name) [CCN], medlure [CCN], megatomoic acid (alternative name) [CCN], methyl eugenol (alternative name) (540), muscalure (563), octadeca-2,13-dien-1-yl acetate (IUPAC name) (588), octadeca-3,13-dien-1-yl acetate (IUPAC name) (589), orfralure (alternative name) [CCN], oryctalure (alternative name) (317), ostramone (alternative name) [CCN], siglure [CCN], sordidin (alternative name) (736), sulcatol (alternative name) [CCN], tetradec-11-en-1-yl acetate (IUPAC name) (785), trimedlure (839), trimedlure A (alternative name) (839), trimedlure B₁ (alternative name) (839), trimedlure B₂ (alternative name) (839), trimedlure C (alternative name) (839) and trunc-call (alternative name) [CCN],
an insect repellent selected from the group of substances consisting of 2-(octylthio)-ethanol (IUPAC name) (591), butopyronoxyl (933), butoxy(polypropylene glycol) (936), dibutyl adipate (IUPAC name) (1046), dibutyl phthalate (1047), dibutyl succinate (IUPAC name) (1048), diethyltoluamide [CCN], dimethyl carbate [CCN], dimethyl phthalate [CCN], ethyl hexanediol (1137), hexamide [CCN], methoquin-butyl (1276), methylneodecanamide [CCN], oxamate [CCN] and picaridin [CCN],
an insecticide selected from the group of substances consisting of 1,1-dichloro-1-nitroethane (IUPAC/Chemical Abstracts name) (1058), 1,1-dichloro-2,2-bis(4-ethylphenyl)-ethane (IUPAC name) (1056), 1,2-dichloropropane (IUPAC/Chemical Abstracts name) (1062), 1,2-dichloropropane with 1,3-dichloropropene (IUPAC name) (1063), 1-bromo-2-chloroethane (IUPAC/Chemical Abstracts name) (916), 2,2,2-trichloro-1-(3,4-dichloro-phenyl)ethyl acetate (IUPAC name) (1451), 2,2-dichlorovinyl 2-ethylsulfinylethyl methyl phosphate (IUPAC name) (1066), 2-(1,3-dithiolan-2-yl)phenyl dimethylcarbamate (IUPAC/Chemical Abstracts name) (1109), 2-(2-butoxyethoxy)ethyl thiocyanate (IUPAC/Chemical Abstracts name) (935), 2-(4,5-dimethyl-1,3-dioxolan-2-yl)phenyl methylcarbamate (IUPAC/Chemical Abstracts name) (1084), 2-(4-chloro-3,5-xylyloxy)ethanol (IUPAC name) (986), 2-chlorovinyl diethyl phosphate (IUPAC name) (984), 2-imidazolidone (IUPAC name) (1225), 2-isovalerylindan-1,3-dione (IUPAC name) (1246), 2-methyl(prop-2-ynyl)aminophenyl methylcarbamate (IUPAC name) (1284), 2-thiocyanatoethyl laurate (IUPAC name) (1433), 3-bromo-1-chloroprop-1-ene (IUPAC name) (917), 3-methyl-1-phenylpyrazol-5-yl dimethyl-carbamate (IUPAC name) (1283), 4-methyl(prop-2-ynyl)amino-3,5-xylyl methylcarbamate (IUPAC name) (1285), 5,5-dimethyl-3-oxocyclohex-1-enyl dimethylcarbamate (IUPAC name) (1085), abamectin (1), acephate (2), acetamiprid (4), acethion (alternative name) [CCN], acetoprole [CCN], acrinathrin (9), acrylonitrile (IUPAC name) (861), alanycarb (15), aldicarb (16), aldoxycarb (863), aldrin (864), allethrin (17), allosamidin (alternative name) [CCN], allyxycarb (866), alpha-cypermethrin (202), alpha-ecdysone (alternative name) [CCN], aluminium phosphide (640), amidithion (870), amidothioate (872), aminocarb (873), amiton (875), amiton hydrogen oxalate (875), amitraz (24), anabasine (877), athidathion (883), AVI 382 (compound code), AZ 60541 (compound code), azadirachtin (alternative name) (41), azamethiphos (42), azinphos-ethyl (44), azinphos-methyl (45), azothoate (889), Bacillus thuringiensis delta endotoxins (alternative name) (52), barium hexafluorosilicate (alternative name) [CCN], barium polysulfide (IUPAC/Chemical Abstracts name) (892), barthrin [CCN], BAS 320 I (compound code), Bayer 22/190 (development code) (893), Bayer 22408 (development code) (894), bendiocarb (58), benfuracarb (60), bensultap (66), beta-cyfluthrin (194), beta-cypermethrin (203), bifenthrin (76), bioallethrin (78), bioallethrin S-cyclopentenyl isomer (alternative name) (79), bioethanomethrin [CCN], biopermethrin (908), bioresmethrin (80), bis(2-chloroethyl)ether (IUPAC name) (909), bistrifluoron (83), borax (86), brofenvalerate (alternative name), bromfenvinfos (914), bromocyclen (918), bromo-DDT (alternative name) [CCN], bromophos (920), bromophos-ethyl (921), bufencarb (924), buprofezin (99), butacarb (926), butathiofos (927), butocarboxim (103), butonate (932), butoxycarboxim (104), butylpyridaben (alternative name), cadusafos (109), calcium arsenate [CCN], calcium cyamide (444), calcium polysulfide (IUPAC name) (111), camphechlor (941), carbanolate (943), carbaryl (115), carbofuran (118), carbon disulfide (IUPAC/Chemical Abstracts name) (945), carbon tetrachloride (IUPAC name) (946), carbophenothion (947), carbosulfan (119), cartap (123), cartap hydrochloride (123), cevadine (alternative name) (725), chlorbicyclen (960), chlordane (128), chlordecone (963), chlordimeform (964), chlordimeform hydrochloride (964), chlorethoxyfos (129), chlorfenapyr (130), chlorfenvinphos (131), chlorfluazuron (132), chlormephos (136), chloroform [CCN], chloropicrin (141), chlorphoxim (989), chlorprazophos (990), chlorpyrifos (145), chlorpyrifos-methyl (146), chlorthiophos (994), chromafenozide (150), cinerin I (696), cinerin II (696), cinerins (696), cis-resmethrin (alternative name), cismethrin (80), clocythrin (alternative name), cloethocarb (999), closantel (alternative name) [CCN], clothianidin (165), copper acetoarsenite [CCN], copper arsenate [CCN], copper oleate [CCN], coumaphos (174), coumithoate (1006), crotamiton (alternative name) [CCN], crotoxyphos (1010), crufomate (1011), cryolite (alternative name) (177), CS 708 (development code) (1012), cyanofenphos (1019), cyanophos (184), cyanthoate (1020), cyclethrin [CCN], cycloprothrin (188), cyfluthrin (193), cyhalothrin (196), cypermethrin (201), cyphenothrin (206), cyromazine (209), cythioate (alternative name) [CCN], d-limonene (alternative name) [CCN], d-tetramethrin (alternative name) (788), DAEP (1031), dazomet (216), DDT (219), decarbofuran (1034), deltamethrin (223), demephion (1037), demephion-O (1037), demephion-S (1037), demeton (1038), demeton-methyl (224), demeton-O (1038), demeton-O-methyl (224), demeton-S (1038), demeton-5-methyl (224), demeton-5-methylsulphon (1039), diafenthiuron (226), dialifos (1042), diamidafos (1044), diazinon (227), dicapthon (1050), dichlofenthion (1051), dichlorvos (236), dicliphos (alternative name), dicresyl (alternative name) [CCN], dicrotophos (243), dicyclanil (244), dieldrin (1070), diethyl 5-methylpyrazol-3-yl phosphate (IUPAC name) (1076), diflubenzuron (250), dilor (alternative name) [CCN], dimefluthrin [CCN], dimefox (1081), dimetan (1085), dimethoate (262), dimethrin (1083), dimethylvinphos (265), dimetilan (1086), dinex (1089), dinex-diclexine (1089), dinoprop (1093), dinosam (1094), dinoseb (1095), dinotefuran (271), diofenolan (1099), dioxabenzofos (1100), dioxacarb (1101), dioxathion (1102), disulfoton (278), dithicrofos (1108), DNOC (282), doramectin (alternative name) [CCN], DSP (1115), ecdysterone (alternative name) [CCN], EI 1642 (development code) (1118), emamectin (291), emamectin benzoate (291), EMPC (1120), empenthrin (292), endosulfan (294), endothion (1121), endrin (1122), EPBP (1123), EPN (297), epofenonane (1124), eprinomectin (alternative name) [CCN], esfenvalerate (302), etaphos (alternative name) [CCN], ethiofencarb (308), ethion (309), ethiprole (310), ethoate-methyl (1134), ethoprophos (312), ethyl formate (IUPAC name) [CCN], ethyl-DDD (alternative name) (1056), ethylene dibromide (316), ethylene dichloride (chemical name) (1136), ethylene oxide [CCN], etofenprox (319), etrimfos (1142), EXD (1143), famphur (323), fenamiphos (326), fenazaflor (1147), fenchlorphos (1148), fenethacarb (1149), fenfluthrin (1150), fenitrothion (335), fenobucarb (336), fenoxacrim (1153), fenoxycarb (340), fenpirithrin (1155), fenpropathrin (342), fenpyrad (alternative name), fensulfothion (1158), fenthion (346), fenthion-ethyl [CCN], fenvalerate (349), fipronil (354), flonicamid (358), flucofuron (1168), flucycloxuron (366), flucythrinate (367), fluenetil (1169), flufenerim [CCN], flufenoxuron (370), flufenprox (1171), flumethrin (372), fluvalinate (1184), FMC 1137 (development code) (1185), fonofos (1191), formetanate (405), formetanate hydrochloride (405), formothion (1192), formparanate (1193), fosmethilan (1194), fospirate (1195), fosthiazate (408), fosthietan (1196), furathiocarb (412), furethrin (1200), gamma-cyhalothrin (197), gamma-HCH (430), guazatine (422), guazatine acetates (422), GY-81 (development code) (423), halfenprox (424), halofenozide (425), HCH (430), HEOD (1070), heptachlor (1211), heptenophos (432), heterophos [CCN], hexaflumuron (439), HHDN (864), hydramethylnon (443), hydrogen cyamide (444), hydroprene (445), hyquincarb (1223), imidacloprid (458), imiprothrin (460), indoxacarb (465), iodomethane (IUPAC name) (542), IPSP (1229), isazofos (1231), isobenzan (1232), isocarbophos (alternative name) (473), isodrin (1235), isofenphos (1236), isolane (1237), isoprocarb (472), isopropyl O-(methoxyaminothiophosphoryl)salicylate (IUPAC name) (473), isoprothiolane (474), isothioate (1244), isoxathion (480), ivermectin (alternative name) [CCN], jasmolin I (696), jasmolin II (696), jodfenphos (1248), juvenile hormone I (alternative name) [CCN], juvenile hormone II (alternative name) [CCN], juvenile hormone III (alternative name) [CCN], kelevan (1249), kinoprene (484), lambda-cyhalothrin (198), lead arsenate [CCN], leptophos (1250), lindane (430), lirimfos (1251), lufenuron (490), lythidathion (1253), m-cumenyl methylcarbamate (IUPAC name) (1014), magnesium phosphide (IUPAC name) (640), malathion (492), malonoben (1254), mazidox (1255), mecarbam (502), mecarphon (1258), menazon (1260), mephosfolan (1261), mercurous chloride (513), mesulfenfos (1263), metam (519), metam-potassium (alternative name) (519), metam-sodium (519), methacrifos (1266), methamidophos (527), methanesulfonyl fluoride (IUPAC/Chemical Abstracts name) (1268), methidathion (529), methiocarb (530), methocrotophos (1273), methomyl (531), methoprene (532), methoquin-butyl (1276), methothrin (alternative name) (533), methoxychlor (534), methoxyfenozide (535), methyl bromide (537), methyl isothiocyanate (543), methylchloroform (alternative name) [CCN], methylene chloride [CCN], metofluthrin [CCN], metolcarb (550), metoxadiazone (1288), mevinphos (556), mexacarbate (1290), milbemectin (557), milbemycin oxime (alternative name) [CCN], mipafox (1293), mirex (1294), monocrotophos (561), morphothion (1300), moxidectin (alternative name) [CCN], naftalofos (alternative name) [CCN], naled (567), naphthalene (IUPAC/Chemical Abstracts name) (1303), NC-170 (development code) (1306), NC-184 (compound code), nicotine (578), nicotine sulfate (578), nifluridide (1309), nitenpyram (579), nithiazine (1311), nitrilacarb (1313), nitrilacarb 1:1 zinc chloride complex (1313), NNI-0101 (compound code), NNI-0250 (compound code), nornicotine (traditional name) (1319), novaluron (585), noviflumuron (586), O-2,5-dichloro-4-iodophenyl O-ethyl ethylphosphonothioate (IUPAC name) (1057), O,O-diethyl O-4-methyl-2-oxo-2H-chromen-7-yl phosphorothioate (IUPAC name) (1074), O,O-diethyl O-6-methyl-2-propylpyrimidin-4-yl phosphorothioate (IUPAC name) (1075), O,O,O′,O′-tetrapropyl dithiopyrophosphate (IUPAC name) (1424), oleic acid (IUPAC name) (593), omethoate (594), oxamyl (602), oxydemeton-methyl (609), oxydeprofos (1324), oxydisulfoton (1325), pp′-DDT (219), para-dichlorobenzene [CCN], parathion (615), parathion-methyl (616), penfluoron (alternative name) [CCN], pentachlorophenol (623), pentachlorophenyl laurate (IUPAC name) (623), permethrin (626), petroleum oils (alternative name) (628), PH 60-38 (development code) (1328), phenkapton (1330), phenothrin (630), phenthoate (631), phorate (636), phosalone (637), phosfolan (1338), phosmet (638), phosnichlor (1339), phosphamidon (639), phosphine (IUPAC name) (640), phoxim (642), phoxim-methyl (1340), pirimetaphos (1344), pirimicarb (651), pirimiphos-ethyl (1345), pirimiphos-methyl (652), polychlorodicyclopentadiene isomers (IUPAC name) (1346), polychloroterpenes (traditional name) (1347), potassium arsenite [CCN], potassium thiocyanate [CCN], prallethrin (655), precocene I (alternative name) [CCN], precocene II (alternative name) [CCN], precocene III (alternative name) [CCN], primidophos (1349), profenofos (662), profluthrin [CCN], promacyl (1354), promecarb (1355), propaphos (1356), propetamphos (673), propoxur (678), prothidathion (1360), prothiofos (686), prothoate (1362), protrifenbute [CCN], pymetrozine (688), pyraclofos (689), pyrazophos (693), pyresmethrin (1367), pyrethrin I (696), pyrethrin II (696), pyrethrins (696), pyridaben (699), pyridalyl (700), pyridaphenthion (701), pyrimidifen (706), pyrimitate (1370), pyriproxyfen (708), quassia (alternative name) [CCN], quinalphos (711), quinalphos-methyl (1376), quinothion (1380), quintiofos (1381), R-1492 (development code) (1382), rafoxanide (alternative name) [CCN], resmethrin (719), rotenone (722), RU 15525 (development code) (723), RU 25475 (development code) (1386), ryania (alternative name) (1387), ryanodine (traditional name) (1387), sabadilla (alternative name) (725), schradan (1389), sebufos (alternative name), selamectin (alternative name) [CCN], SI-0009 (compound code), silafluofen (728), SN 72129 (development code) (1397), sodium arsenite [CCN], sodium cyamide (444), sodium fluoride (IUPAC/Chemical Abstracts name) (1399), sodium hexafluorosilicate (1400), sodium pentachlorophenoxide (623), sodium selenate (IUPAC name) (1401), sodium thiocyanate [CCN], sophamide (1402), spinosad (737), spiromesifen (739), sulcofuron (746), sulcofuron-sodium (746), sulfluramid (750), sulfotep (753), sulfuryl fluoride (756), sulprofos (1408), tar oils (alternative name) (758), tau-fluvalinate (398), tazimcarb (1412), TDE (1414), tebufenozide (762), tebufenpyrad (763), tebupirimfos (764), teflubenzuron (768), tefluthrin (769), temephos (770), TEPP (1417), terallethrin (1418), terbam (alternative name), terbufos (773), tetrachloroethane [CCN], tetrachlorvinphos (777), tetramethrin (787), theta-cypermethrin (204), thiacloprid (791), thiafenox (alternative name), thiamethoxam (792), thicrofos (1428), thiocarboxime (1431), thiocyclam (798), thiocyclam hydrogen oxalate (798), thiodicarb (799), thiofanox (800), thiometon (801), thionazin (1434), thiosultap (803), thiosultap-sodium (803), thuringiensin (alternative name) [CCN], tolfenpyrad (809), tralomethrin (812), transfluthrin (813), transpermethrin (1440), triamiphos (1441), triazamate (818), triazophos (820), triazuron (alternative name), trichlorfon (824), trichlormetaphos-3 (alternative name) [CCN], trichloronat (1452), trifenofos (1455), triflumuron (835), trimethacarb (840), triprene (1459), vamidothion (847), vaniliprole [CCN], veratridine (alternative name) (725), veratrine (alternative name) (725), XMC (853), xylylcarb (854), YI-5302 (compound code), zeta-cypermethrin (205), zetamethrin (alternative name), zinc phosphide (640), zolaprofos (1469) and ZXI 8901 (development code) (858),
a molluscicide selected from the group of substances consisting of bis(tributyltin)oxide (IUPAC name) (913), bromoacetamide [CCN], calcium arsenate [CCN], cloethocarb (999), copper acetoarsenite [CCN], copper sulfate (172), fentin (347), ferric phosphate (IUPAC name) (352), metaldehyde (518), methiocarb (530), niclosamide (576), niclosamide-olamine (576), pentachlorophenol (623), sodium pentachlorophenoxide (623), tazimcarb (1412), thiodicarb (799), tributyltin oxide (913), trifenmorph (1454), trimethacarb (840), triphenyltin acetate (IUPAC name) (347) and triphenyltin hydroxide (IUPAC name) (347),
a nematicide selected from the group of substances consisting of 1,2-dibromo-3-chloropropane (IUPAC/Chemical Abstracts name) (1045), 1,2-dichloropropane (IUPAC/Chemical Abstracts name) (1062), 1,2-dichloropropane with 1,3-dichloropropene (IUPAC name) (1063), 1,3-dichloropropene (233), 3,4-dichlorotetrahydrothiophene 1,1-dioxide (IUPAC/Chemical Abstracts name) (1065), 3-(4-chlorophenyl)-5-methylrhodanine (IUPAC name) (980), 5-methyl-6-thioxo-1,3,5-thiadiazinan-3-ylacetic acid (IUPAC name) (1286), 6-isopentenylaminopurine (alternative name) (210), abamectin (1), acetoprole [CCN], alanycarb (15), aldicarb (16), aldoxycarb (863), AZ 60541 (compound code), benclothiaz [CCN], benomyl (62), butylpyridaben (alternative name), cadusafos (109), carbofuran (118), carbon disulfide (945), carbosulfan (119), chloropicrin (141), chlorpyrifos (145), cloethocarb (999), cytokinins (alternative name) (210), dazomet (216), DBCP (1045), DCIP (218), diamidafos (1044), dichlofenthion (1051), dicliphos (alternative name), dimethoate (262), doramectin (alternative name) [CCN], emamectin (291), emamectin benzoate (291), eprinomectin (alternative name) [CCN], ethoprophos (312), ethylene dibromide (316), fenamiphos (326), fenpyrad (alternative name), fensulfothion (1158), fosthiazate (408), fosthietan (1196), furfural (alternative name) [CCN], GY-81 (development code) (423), heterophos [CCN], iodomethane (IUPAC name) (542), isamidofos (1230), isazofos (1231), ivermectin (alternative name) [CCN], kinetin (alternative name) (210), mecarphon (1258), metam (519), metam-potassium (alternative name) (519), metam-sodium (519), methyl bromide (537), methyl isothiocyanate (543), milbemycin oxime (alternative name) [CCN], moxidectin (alternative name) [CCN], Myrothecium verrucaria composition (alternative name) (565), NC-184 (compound code), oxamyl (602), phorate (636), phosphamidon (639), phosphocarb [CCN], sebufos (alternative name), selamectin (alternative name) [CCN], spinosad (737), terbam (alternative name), terbufos (773), tetrachlorothiophene (IUPAC/Chemical Abstracts name) (1422), thiafenox (alternative name), thionazin (1434), triazophos (820), triazuron (alternative name), xylenols [CCN], YI-5302 (compound code) and zeatin (alternative name) (210),
a nitrification inhibitor selected from the group of substances consisting of potassium ethylxanthate [CCN] and nitrapyrin (580),
a plant activator selected from the group of substances consisting of acibenzolar (6), acibenzolar-5-methyl (6), probenazole (658) and Reynoutria sachalinensis extract (alternative name) (720),
a rodenticide selected from the group of substances consisting of 2-isovalerylindan-1,3-dione (IUPAC name) (1246), 4-(quinoxalin-2-ylamino)benzenesulfonamide (IUPAC name) (748), alpha-chlorohydrin [CCN], aluminium phosphide (640), antu (880), arsenous oxide (882), barium carbonate (891), bisthiosemi (912), brodifacoum (89), bromadiolone (91), bromethalin (92), calcium cyamide (444), chloralose (127), chlorophacinone (140), cholecalciferol (alternative name) (850), coumachlor (1004), coumafuryl (1005), coumatetralyl (175), crimidine (1009), difenacoum (246), difethialone (249), diphacinone (273), ergocalciferol (301), flocoumafen (357), fluoroacetamide (379), flupropadine (1183), flupropadine hydrochloride (1183), gamma-HCH (430), HCH (430), hydrogen cyamide (444), iodomethane (IUPAC name) (542), lindane (430), magnesium phosphide (IUPAC name) (640), methyl bromide (537), norbormide (1318), phosacetim (1336), phosphine (IUPAC name) (640), phosphorus [CCN], pindone (1341), potassium arsenite [CCN], pyrinuron (1371), scilliroside (1390), sodium arsenite [CCN], sodium cyamide (444), sodium fluoro-acetate (735), strychnine (745), thallium sulfate [CCN], warfarin (851) and zinc phosphide (640),
a synergist selected from the group of substances consisting of 2-(2-butoxyethoxy)ethyl piperonylate (IUPAC name) (934), 5-(1,3-benzodioxol-5-yl)-3-hexylcyclohex-2-enone (IUPAC name) (903), farnesol with nerolidol (alternative name) (324), MB-599 (development code) (498), MGK 264 (development code) (296), piperonyl butoxide (649), piprotal (1343), propyl isomer (1358), S421 (development code) (724), sesamex (1393), sesasmolin (1394) and sulfoxide (1406),
an animal repellent selected from the group of substances consisting of anthraquinone (32), chloralose (127), copper naphthenate [CCN], copper oxychloride (171), diazinon (227), dicyclopentadiene (chemical name) (1069), guazatine (422), guazatine acetates (422), methiocarb (530), pyridin-4-amine (IUPAC name) (23), thiram (804), trimethacarb (840), zinc naphthenate [CCN] and ziram (856),
a virucide selected from the group of substances consisting of imanin (alternative name) [CCN] and ribavirin (alternative name) [CCN],
and a wound protectant selected from the group of substances consisting of mercuric oxide (512), octhilinone (590) and thiophanate-methyl (802).

A very especially preferred embodiment of the subject-matter {1.1.7} of the invention is {1.1.7.2} a pesticidal composition comprising a mixture consisting of at least two substances, namely one compound (A) and at least one compound (B), as active ingredient and at least one auxiliary, wherein the compound (A) is the compound of formula (A-7) and the compound (B) is a compound selected from the group of substances consisting of abamectin (1), cyromazine (209), diafenthiuron (226), diazinon (227), emamectin benzoate (291), fenoxycarb (340), fosthiazate (408), lambda-cyhalothrin (198), lufenuron (490), methidathion (529), profenofos (662), pymetrozine (688), tefluthrin (769) and thiamethoxam (792).

The compound of formula (A-7) is known, for example, from the PCT Application WO-03/015519.

A preferred embodiment of the subject-matter {1.1} of the invention is {1.1.8} a pesticidal composition comprising a mixture consisting of at least two substances, namely one compound (A) and at least one compound (B), as active ingredient and at least one auxiliary, wherein the compound (A) is the compound of formula (A-8) 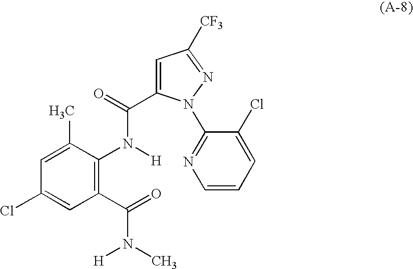
and the compound (B) is a compound selected from the group of substances consisting of an adjuvant, an acaricide, an algicide, an anthelmintic, an avicide, a bactericide, a biological agent, a soil sterilant, a chemosterilant, an insect pheromone, an insect repellent, an insecticide, a molluscicide, a nematicide, a nitrification inhibitor, a plant activator, a rodenticide, a synergist, an animal repellent, a virucide and a wound protectant.

An especially preferred embodiment of the subject-matter {1.1.8} of the invention is {1.1.8.1} a pesticidal composition comprising a mixture consisting of at least two substances, namely one compound (A) and at least one compound (B), as active ingredient and at least one auxiliary, wherein the compound (A) is the compound of formula (A-8) and the compound (B) is a compound selected from the group of substances consisting of
an adjuvant selected from the group of substances consisting of petroleum oils (alternative name) (628),
an acaricide selected from the group of substances consisting of 1,1-bis(4-chlorophenyl)-2-ethoxyethanol (IUPAC name) (910), 2,4-dichlorophenyl benzenesulfonate (IUPAC/Chemical Abstracts name) (1059), 2-fluoro-N-methyl-N-1-naphthylacetamide (IUPAC name) (1295), 4-chlorophenyl phenyl sulfone (IUPAC name) (981), abamectin (1), acequinocyl (3), acetoprole [CCN], acrinathrin (9), aldicarb (16), aldoxycarb (863), alpha-cypermethrin (202), amidithion (870), amidoflumet [CCN], amidothioate (872), amiton (875), amiton hydrogen oxalate (875), amitraz (24), aramite (881), arsenous oxide (882), AVI 382 (compound code), AZ 60541 (compound code), azinphos-ethyl (44), azinphos-methyl (45), azobenzene (IUPAC name) (888), azocyclotin (46), azothoate (889), benomyl (62), benoxafos (alternative name) [CCN], benzoximate (71), benzyl benzoate (IUPAC name) [CCN], bifenazate (74), bifenthrin (76), binapacryl (907), brofenvalerate (alternative name), bromocyclen (918), bromophos (920), bromophos-ethyl (921), bromopropylate (94), buprofezin (99), butocarboxim (103), butoxycarboxim (104), butylpyridaben (alternative name), calcium polysulfide (IUPAC name) (111), camphechlor (941), carbanolate (943), carbaryl (115), carbofuran (118), carbophenothion (947), CGA 50'439 (development code) (125), chinomethionat (126), chlorbenside (959), chlordimeform (964), chlordimeform hydrochloride (964), chlorfenapyr (130), chlorfenethol (968), chlorfenson (970), chlorfensulphide (971), chlorfenvinphos (131), chlorobenzilate (975), chloromebuform (977), chloromethiuron (978), chloropropylate (983), chlorpyrifos (145), chlorpyrifos-methyl (146), chlorthiophos (994), cinerin I (696), cinerin II (696), cinerins (696), clofentezine (158), closantel (alternative name) [CCN], coumaphos (174), crotamiton (alternative name) [CCN], crotoxyphos (1010), cufraneb (1013), cyanthoate (1020), cyhalothrin (196), cyhexatin (199), cypermethrin (201), DCPM (1032), DDT (219), demephion (1037), demephion-O (1037), demephion-S (1037), demeton (1038), demeton-methyl (224), demeton-O (1038), demeton-O-methyl (224), demeton-S (1038), demeton-5-methyl (224), demeton-5-methylsulphon (1039), diafenthiuron (226), dialifos (1042), diazinon (227), dichlofluanid (230), dichlorvos (236), dicliphos (alternative name), dicofol (242), dicrotophos (243), dienochlor (1071), dimefox (1081), dimethoate (262), dinactin (alternative name) (653), dinex (1089), dinex-diclexine (1089), dinobuton (269), dinocap (270), dinocap-4 [CCN], dinocap-6 [CCN], dinocton (1090), dinopenton (1092), dinosulfon (1097), dinoterbon (1098), dioxathion (1102), diphenyl sulfone (IUPAC name) (1103), disulfuram (alternative name) [CCN], disulfoton (278), DNOC (282), dofenapyn (1113), doramectin (alternative name) [CCN], endosulfan (294), endothion (1121), EPN (297), eprinomectin (alternative name) [CCN], ethion (309), ethoate-methyl (1134), etoxazole (320), etrimfos (1142), fenazaflor (1147), fenazaquin (328), fenbutatin oxide (330), fenothiocarb (337), fenpropathrin (342), fenpyrad (alternative name), fenpyroximate (345), fenson (1157), fentrifanil (1161), fenvalerate (349), fipronil (354), fluacrypyrim (360), fluazuron (1166), flubenzimine (1167), flucycloxuron (366), flucythrinate (367), fluenetil (1169), flufenoxuron (370), flumethrin (372), fluorbenside (1174), fluvalinate (1184), FMC 1137 (development code) (1185), formetanate (405), formetanate hydrochloride (405), formothion (1192), formparanate (1193), gamma-HCH (430), glyodin (1205), halfenprox (424), heptenophos (432), hexadecyl cyclopropanecarboxylate (IUPAC/Chemical Abstracts name) (1216), hexythiazox (441), iodomethane (IUPAC name) (542), isocarbophos (alternative name) (473), isopropyl O-(methoxyaminothiophosphoryl)salicylate (IUPAC name) (473), ivermectin (alternative name) [CCN], jasmolin I (696), jasmolin II (696), jodfenphos (1248), lindane (430), lufenuron (490), malathion (492), malonoben (1254), mecarbam (502), mephosfolan (1261), mesulfen (alternative name) [CCN], methacrifos (1266), methamidophos (527), methidathion (529), methiocarb (530), methomyl (531), methyl bromide (537), metolcarb (550), mevinphos (556), mexacarbate (1290), milbemectin (557), milbemycin oxime (alternative name) [CCN], mipafox (1293), monocrotophos (561), morphothion (1300), moxidectin (alternative name) [CCN], naled (567), NC-184 (compound code), nifluridide (1309), nikkomycins (alternative name) [CCN], nitrilacarb (1313), nitrilacarb 1:1 zinc chloride complex (1313), NNI-0101 (compound code), NNI-0250 (compound code), omethoate (594), oxamyl (602), oxydeprofos (1324), oxydisulfoton (1325), pp′-DDT (219), parathion (615), permethrin (626), petroleum oils (alternative name) (628), phenkapton (1330), phenthoate (631), phorate (636), phosalone (637), phosfolan (1338), phosmet (638), phosphamidon (639), phoxim (642), pirimiphos-methyl (652), polychloroterpenes (traditional name) (1347), polynactins (alternative name) (653), proclonol (1350), profenofos (662), promacyl (1354), propargite (671), propetamphos (673), propoxur (678), prothidathion (1360), prothoate (1362), pyrethrin I (696), pyrethrin II (696), pyrethrins (696), pyridaben (699), pyridaphenthion (701), pyrimidifen (706), pyrimitate (1370), quinalphos (711), quintiofos (1381), R-1492 (development code) (1382), RA-17 (development code) (1383), rotenone (722), schradan (1389), sebufos (alternative name), selamectin (alternative name) [CCN], SI-0009 (compound code), sophamide (1402), spirodiclofen (738), spiromesifen (739), SSI-121 (development code) (1404), sulfuram (alternative name) [CCN], sulfluramid (750), sulfotep (753), sulfur (754), SZI-121 (development code) (757), tau-fluvalinate (398), tebufenpyrad (763), TEPP (1417), terbam (alternative name), tetrachlorvinphos (777), tetradifon (786), tetranactin (alternative name) (653), tetrasul (1425), thiafenox (alternative name), thiocarboxime (1431), thiofanox (800), thiometon (801), thioquinox (1436), thuringiensin (alternative name) [CCN], triamiphos (1441), triarathene (1443), triazophos (820), triazuron (alternative name), trichlorfon (824), trifenofos (1455), trinactin (alternative name) (653), vamidothion (847), vaniliprole [CCN] and YI-5302 (compound code),
an algicide selected from the group of substances consisting of bethoxazin [CCN], copper dioctanoate (IUPAC name) (170), copper sulfate (172), cybutryne [CCN], dichlone (1052), dichlorophen (232), endothal (295), fentin (347), hydrated lime [CCN], nabam (566), quinoclamine (714), quinonamid (1379), simazine (730), triphenyltin acetate (IUPAC name) (347) and triphenyltin hydroxide (IUPAC name) (347),
an anthelmintic selected from the group of substances consisting of abamectin (1), crufomate (1011), doramectin (alternative name) [CCN], emamectin (291), emamectin benzoate (291), eprinomectin (alternative name) [CCN], ivermectin (alternative name) [CCN], milbemycin oxime (alternative name) [CCN], moxidectin (alternative name) [CCN], piperazine [CCN], selamectin (alternative name) [CCN], spinosad (737) and thiophanate (1435),
an avicide selected from the group of substances consisting of chloralose (127), endrin (1122), fenthion (346), pyridin-4-amine (IUPAC name) (23) and strychnine (745),
a bactericide selected from the group of substances consisting of 1-hydroxy-1H-pyridine-2-thione (IUPAC name) (1222), 4-(quinoxalin-2-ylamino)benzenesulfonamide (IUPAC name) (748), 8-hydroxyquinoline sulfate (446), bronopol (97), copper dioctanoate (IUPAC name) (170), copper hydroxide (IUPAC name) (169), cresol [CCN], dichlorophen (232), dipyrithione (1105), dodicin (1112), fenaminosulf (1144), formaldehyde (404), hydrargaphen (alternative name) [CCN], kasugamycin (483), kasugamycin hydrochloride hydrate (483), nickel bis(dimethyldithiocarbamate) (IUPAC name) (1308), nitrapyrin (580), octhilinone (590), oxolinic acid (606), oxytetracycline (611), potassium hydroxyquinoline sulfate (446), probenazole (658), streptomycin (744), streptomycin sesquisulfate (744), tecloftalam (766) and thiomersal (alternative name) [CCN],
a biological agent selected from the group of substances consisting of Adoxophyes orana GV (alternative name) (12), Agrobacterium radiobacter (alternative name) (13), Amblyseius spp. (alternative name) (19), Anagrapha falcifera NPV (alternative name) (28), Anagrus atomus (alternative name) (29), Aphelinus abdominalis (alternative name) (33), Aphidius colemani (alternative name) (34), Aphidoletes aphidimyza (alternative name) (35), Autographa californica NPV (alternative name) (38), Bacillus firmus (alternative name) (48), Bacillus sphaericus Neide (scientific name) (49), Bacillus thuringiensis Berliner (scientific name) (51), Bacillus thuringiensis subsp. aizawai (scientific name) (51), Bacillus thuringiensis subsp. israelensis (scientific name) (51), Bacillus thuringiensis subsp. japonensis (scientific name) (51), Bacillus thuringiensis subsp. kurstaki (scientific name) (51), Bacillus thuringiensis subsp. tenebrionis (scientific name) (51), Beauveria bassiana (alternative name) (53), Beauveria brongniartii (alternative name) (54), Chrysoperla carnea (alternative name) (151), Cryptolaemus montrouzieri (alternative name) (178), Cydia pomonella GV (alternative name) (191), Dacnusa sibirica (alternative name) (212), Diglyphus isaea (alternative name) (254), Encarsia formosa (scientific name) (293), Eretmocerus eremicus (alternative name) (300), Helicoverpa zea NPV (alternative name) (431), Heterorhabditis bacteriophora and H. megidis (alternative name) (433), Hippodamia convergens (alternative name) (442), Leptomastix dactylopii (alternative name) (488), Macrolophus caliginosus (alternative name) (491), Mamestra brassicae NPV (alternative name) (494), Metaphycus helvolus (alternative name) (522), Metarhizium anisopliae var. acridum (scientific name) (523), Metarhizium anisopliae var. anisopliae (scientific name) (523), Neodiprion sertifer NPV and N. lecontei NPV (alternative name) (575), Orius spp. (alternative name) (596), Paecilomyces fumosoroseus (alternative name) (613), Phytoseiulus persimilis (alternative name) (644), Spodoptera exigua multicapsid nuclear polyhedrosis virus (scientific name) (741), Steinernema bibionis (alternative name) (742), Steinernema carpocapsae (alternative name) (742), Steinernema feltiae (alternative name) (742), Steinernema glaseri (alternative name) (742), Steinernema riobrave (alternative name) (742), Steinernema riobravis (alternative name) (742), Steinernema scapterisci (alternative name) (742), Steinernema spp. (alternative name) (742), Trichogramma spp. (alternative name) (826), Typhlodromus occidentalis (alternative name) (844) and Verticillium lecanii (alternative name) (848),
a soil sterilant selected from the group of substances consisting of iodomethane (IUPAC name) (542) and methyl bromide (537),
a chemosterilant selected from the group of substances consisting of apholate [CCN], bisazir (alternative name) [CCN], busulfan (alternative name) [CCN], diflubenzuron (250), dimatif (alternative name) [CCN], hemel [CCN], hempa [CCN], metepa [CCN], methiotepa [CCN], methyl apholate [CCN], morzid [CCN], penfluoron (alternative name) [CCN], tepa [CCN], thiohempa (alternative name) [CCN], thiotepa (alternative name) [CCN], tretamine (alternative name) [CCN] and uredepa (alternative name) [CCN],
an insect pheromone selected from the group of substances consisting of (E)-dec-5-en-1-yl acetate with (E)-dec-5-en-1-ol (IUPAC name) (222), (E)-tridec-4-en-1-yl acetate (IUPAC name) (829), (E)-6-methylhept-2-en-4-ol (IUPAC name) (541), (E,Z)-tetradeca-4,10-dien-1-yl acetate (IUPAC name) (779), (Z)-dodec-7-en-1-yl acetate (IUPAC name) (285), (Z)-hexadec-11-enal (IUPAC name) (436), (Z)-hexadec-11-en-1-yl acetate (IUPAC name) (437), (Z)-hexadec-13-en-11-yn-1-yl acetate (IUPAC name) (438), (Z)-icos-13-en-10-one (IUPAC name) (448), (Z)-tetradec-7-en-1-al (IUPAC name) (782), (Z)-tetradec-9-en-1-ol (IUPAC name) (783), (Z)-tetradec-9-en-1-yl acetate (IUPAC name) (784), (7E,9Z)-dodeca-7,9-dien-1-yl acetate (IUPAC name) (283), (9Z,11E)-tetradeca-9,11-dien-1-yl acetate (IUPAC name) (780), (9Z,12E)-tetradeca-9,12-dien-1-yl acetate (IUPAC name) (781), 14-methyloctadec-1-ene (IUPAC name) (545), 4-methylnonan-5-ol with 4-methylnonan-5-one (IUPAC name) (544), alpha-multistriatin (alternative name) [CCN], brevicomin (alternative name) [CCN], codlelure (alternative name) [CCN], codlemone (alternative name) (167), cuelure (alternative name) (179), disparlure (277), dodec-8-en-1-yl acetate (IUPAC name) (286), dodec-9-en-1-yl acetate (IUPAC name) (287), dodeca-8,10-dien-1-yl acetate (IUPAC name) (284), dominicalure (alternative name) [CCN], ethyl 4-methyloctanoate (IUPAC name) (317), eugenol (alternative name) [CCN], frontalin (alternative name) [CCN], gossyplure (alternative name) (420), grandlure (421), grandlure I (alternative name) (421), grandlure II (alternative name) (421), grandlure III (alternative name) (421), grandlure IV (alternative name) (421), hexylure [CCN], ipsdienol (alternative name) [CCN], ipsenol (alternative name) [CCN], japonilure (alternative name) (481), lineatin (alternative name) [CCN], litlure (alternative name) [CCN], looplure (alternative name) [CCN], medlure [CCN], megatomoic acid (alternative name) [CCN], methyl eugenol (alternative name) (540), muscalure (563), octadeca-2,13-dien-1-yl acetate (IUPAC name) (588), octadeca-3,13-dien-1-yl acetate (IUPAC name) (589), orfralure (alternative name) [CCN], oryctalure (alternative name) (317), ostramone (alternative name) [CCN], siglure [CCN], sordidin (alternative name) (736), sulcatol (alternative name) [CCN], tetradec-11-en-1-yl acetate (IUPAC name) (785), trimedlure (839), trimedlure A (alternative name) (839), trimedlure B₁ (alternative name) (839), trimedlure B₂ (alternative name) (839), trimedlure C (alternative name) (839) and trunc-call (alternative name) [CCN],
an insect repellent selected from the group of substances consisting of 2-(octylthio)-ethanol (IUPAC name) (591), butopyronoxyl (933), butoxy(polypropylene glycol) (936), dibutyl adipate (IUPAC name) (1046), dibutyl phthalate (1047), dibutyl succinate (IUPAC name) (1048), diethyltoluamide [CCN], dimethyl carbate [CCN], dimethyl phthalate [CCN], ethyl hexanediol (1137), hexamide [CCN], methoquin-butyl (1276), methylneodecanamide [CCN], oxamate [CCN] and picaridin [CCN],
an insecticide selected from the group of substances consisting of 1,1-dichloro-1-nitroethane (IUPAC/Chemical Abstracts name) (1058), 1,1-dichloro-2,2-bis(4-ethylphenyl)-ethane (IUPAC name) (1056), 1,2-dichloropropane (IUPAC/Chemical Abstracts name) (1062), 1,2-dichloropropane with 1,3-dichloropropene (IUPAC name) (1063), 1-bromo-2-chloroethane (IUPAC/Chemical Abstracts name) (916), 2,2,2-trichloro-1-(3,4-dichloro-phenyl)ethyl acetate (IUPAC name) (1451), 2,2-dichlorovinyl 2-ethylsulfinylethyl methyl phosphate (IUPAC name) (1066), 2-(1,3-dithiolan-2-yl)phenyl dimethylcarbamate (IUPAC/Chemical Abstracts name) (1109), 2-(2-butoxyethoxy)ethyl thiocyanate (IUPAC/Chemical Abstracts name) (935), 2-(4,5-dimethyl-1,3-dioxolan-2-yl)phenyl methylcarbamate (IUPAC/Chemical Abstracts name) (1084), 2-(4-chloro-3,5-xylyloxy)ethanol (IUPAC name) (986), 2-chlorovinyl diethyl phosphate (IUPAC name) (984), 2-imidazolidone (IUPAC name) (1225), 2-isovalerylindan-1,3-dione (IUPAC name) (1246), 2-methyl(prop-2-ynyl)aminophenyl methylcarbamate (IUPAC name) (1284), 2-thiocyanatoethyl laurate (IUPAC name) (1433), 3-bromo-1-chloroprop-1-ene (IUPAC name) (917), 3-methyl-1-phenylpyrazol-5-yl dimethyl-carbamate (IUPAC name) (1283), 4-methyl(prop-2-ynyl)amino-3,5-xylyl methylcarbamate (IUPAC name) (1285), 5,5-dimethyl-3-oxocyclohex-1-enyl dimethylcarbamate (IUPAC name) (1085), abamectin (1), acephate (2), acetamiprid (4), acethion (alternative name) [CCN], acetoprole [CCN], acrinathrin (9), acrylonitrile (IUPAC name) (861), alanycarb (15), aldicarb (16), aldoxycarb (863), aldrin (864), allethrin (17), allosamidin (alternative name) [CCN], allyxycarb (866), alpha-cypermethrin (202), alpha-ecdysone (alternative name) [CCN], aluminium phosphide (640), amidithion (870), amidothioate (872), aminocarb (873), amiton (875), amiton hydrogen oxalate (875), amitraz (24), anabasine (877), athidathion (883), AVI 382 (compound code), AZ 60541 (compound code), azadirachtin (alternative name) (41), azamethiphos (42), azinphos-ethyl (44), azinphos-methyl (45), azothoate (889), Bacillus thuringiensis delta endotoxins (alternative name) (52), barium hexafluorosilicate (alternative name) [CCN], barium polysulfide (IUPAC/Chemical Abstracts name) (892), barthrin [CCN], BAS 320 I (compound code), Bayer 22/190 (development code) (893), Bayer 22408 (development code) (894), bendiocarb (58), benfuracarb (60), bensultap (66), beta-cyfluthrin (194), beta-cypermethrin (203), bifenthrin (76), bioallethrin (78), bioallethrin S-cyclopentenyl isomer (alternative name) (79), bioethanomethrin [CCN], biopermethrin (908), bioresmethrin (80), bis(2-chloroethyl)ether (IUPAC name) (909), bistrifluoron (83), borax (86), brofenvalerate (alternative name), bromfenvinfos (914), bromocyclen (918), bromo-DDT (alternative name) [CCN], bromophos (920), bromophos-ethyl (921), bufencarb (924), buprofezin (99), butacarb (926), butathiofos (927), butocarboxim (103), butonate (932), butoxycarboxim (104), butylpyridaben (alternative name), cadusafos (109), calcium arsenate [CCN], calcium cyamide (444), calcium polysulfide (IUPAC name) (111), camphechlor (941), carbanolate (943), carbaryl (115), carbofuran (118), carbon disulfide (IUPAC/Chemical Abstracts name) (945), carbon tetrachloride (IUPAC name) (946), carbophenothion (947), carbosulfan (119), cartap (123), cartap hydrochloride (123), cevadine (alternative name) (725), chlorbicyclen (960), chlordane (128), chlordecone (963), chlordimeform (964), chlordimeform hydrochloride (964), chlorethoxyfos (129), chlorfenapyr (130), chlorfenvinphos (131), chlorfluazuron (132), chlormephos (136), chloroform [CCN], chloropicrin (141), chlorphoxim (989), chlorprazophos (990), chlorpyrifos (145), chlorpyrifos-methyl (146), chlorthiophos (994), chromafenozide (150), cinerin I (696), cinerin II (696), cinerins (696), cis-resmethrin (alternative name), cismethrin (80), clocythrin (alternative name), cloethocarb (999), closantel (alternative name) [CCN], clothianidin (165), copper acetoarsenite [CCN], copper arsenate [CCN], copper oleate [CCN], coumaphos (174), coumithoate (1006), crotamiton (alternative name) [CCN], crotoxyphos (1010), crufomate (1011), cryolite (alternative name) (177), CS 708 (development code) (1012), cyanofenphos (1019), cyanophos (184), cyanthoate (1020), cyclethrin [CCN], cycloprothrin (188), cyfluthrin (193), cyhalothrin (196), cypermethrin (201), cyphenothrin (206), cyromazine (209), cythioate (alternative name) [CCN], d-limonene (alternative name) [CCN], d-tetramethrin (alternative name) (788), DAEP (1031), dazomet (216), DDT (219), decarbofuran (1034), deltamethrin (223), demephion (1037), demephion-O (1037), demephion-S (1037), demeton (1038), demeton-methyl (224), demeton-O (1038), demeton-O-methyl (224), demeton-S (1038), demeton-5-methyl (224), demeton-5-methylsulphon (1039), diafenthiuron (226), dialifos (1042), diamidafos (1044), diazinon (227), dicapthon (1050), dichlofenthion (1051), dichlorvos (236), dicliphos (alternative name), dicresyl (alternative name) [CCN], dicrotophos (243), dicyclanil (244), dieldrin (1070), diethyl 5-methylpyrazol-3-yl phosphate (IUPAC name) (1076), diflubenzuron (250), dilor (alternative name) [CCN], dimefluthrin [CCN], dimefox (1081), dimetan (1085), dimethoate (262), dimethrin (1083), dimethylvinphos (265), dimetilan (1086), dinex (1089), dinex-diclexine (1089), dinoprop (1093), dinosam (1094), dinoseb (1095), dinotefuran (271), diofenolan (1099), dioxabenzofos (1100), dioxacarb (1101), dioxathion (1102), disulfoton (278), dithicrofos (1108), DNOC (282), doramectin (alternative name) [CCN], DSP (1115), ecdysterone (alternative name) [CCN], EI 1642 (development code) (1118), emamectin (291), emamectin benzoate (291), EMPC (1120), empenthrin (292), endosulfan (294), endothion (1121), endrin (1122), EPBP (1123), EPN (297), epofenonane (1124), eprinomectin (alternative name) [CCN], esfenvalerate (302), etaphos (alternative name) [CCN], ethiofencarb (308), ethion (309), ethiprole (310), ethoate-methyl (1134), ethoprophos (312), ethyl formate (IUPAC name) [CCN], ethyl-DDD (alternative name) (1056), ethylene dibromide (316), ethylene dichloride (chemical name) (1136), ethylene oxide [CCN], etofenprox (319), etrimfos (1142), EXD (1143), famphur (323), fenamiphos (326), fenazaflor (1147), fenchlorphos (1148), fenethacarb (1149), fenfluthrin (1150), fenitrothion (335), fenobucarb (336), fenoxacrim (1153), fenoxycarb (340), fenpirithrin (1155), fenpropathrin (342), fenpyrad (alternative name), fensulfothion (1158), fenthion (346), fenthion-ethyl [CCN], fenvalerate (349), fipronil (354), flonicamid (358), flucofuron (1168), flucycloxuron (366), flucythrinate (367), fluenetil (1169), flufenerim [CCN], flufenoxuron (370), flufenprox (1171), flumethrin (372), fluvalinate (1184), FMC 1137 (development code) (1185), fonofos (1191), formetanate (405), formetanate hydrochloride (405), formothion (1192), formparanate (1193), fosmethilan (1194), fospirate (1195), fosthiazate (408), fosthietan (1196), furathiocarb (412), furethrin (1200), gamma-cyhalothrin (197), gamma-HCH (430), guazatine (422), guazatine acetates (422), GY-81 (development code) (423), halfenprox (424), halofenozide (425), HCH (430), HEOD (1070), heptachlor (1211), heptenophos (432), heterophos [CCN], hexaflumuron (439), HHDN (864), hydramethylnon (443), hydrogen cyamide (444), hydroprene (445), hyquincarb (1223), imidacloprid (458), imiprothrin (460), indoxacarb (465), iodomethane (IUPAC name) (542), IPSP (1229), isazofos (1231), isobenzan (1232), isocarbophos (alternative name) (473), isodrin (1235), isofenphos (1236), isolane (1237), isoprocarb (472), isopropyl O-(methoxyaminothiophosphoryl)salicylate (IUPAC name) (473), isoprothiolane (474), isothioate (1244), isoxathion (480), ivermectin (alternative name) [CCN], jasmolin I (696), jasmolin II (696), jodfenphos (1248), juvenile hormone I (alternative name) [CCN], juvenile hormone II (alternative name) [CCN], juvenile hormone III (alternative name) [CCN], kelevan (1249), kinoprene (484), lambda-cyhalothrin (198), lead arsenate [CCN], leptophos (1250), lindane (430), lirimfos (1251), lufenuron (490), lythidathion (1253), m-cumenyl methylcarbamate (IUPAC name) (1014), magnesium phosphide (IUPAC name) (640), malathion (492), malonoben (1254), mazidox (1255), mecarbam (502), mecarphon (1258), menazon (1260), mephosfolan (1261), mercurous chloride (513), mesulfenfos (1263), metam (519), metam-potassium (alternative name) (519), metam-sodium (519), methacrifos (1266), methamidophos (527), methanesulfonyl fluoride (IUPAC/Chemical Abstracts name) (1268), methidathion (529), methiocarb (530), methocrotophos (1273), methomyl (531), methoprene (532), methoquin-butyl (1276), methothrin (alternative name) (533), methoxychlor (534), methoxyfenozide (535), methyl bromide (537), methyl isothiocyanate (543), methylchloroform (alternative name) [CCN], methylene chloride [CCN], metofluthrin [CCN], metolcarb (550), metoxadiazone (1288), mevinphos (556), mexacarbate (1290), milbemectin (557), milbemycin oxime (alternative name) [CCN], mipafox (1293), mirex (1294), monocrotophos (561), morphothion (1300), moxidectin (alternative name) [CCN], naftalofos (alternative name) [CCN], naled (567), naphthalene (IUPAC/Chemical Abstracts name) (1303), NC-170 (development code) (1306), NC-184 (compound code), nicotine (578), nicotine sulfate (578), nifluridide (1309), nitenpyram (579), nithiazine (1311), nitrilacarb (1313), nitrilacarb 1:1 zinc chloride complex (1313), NNI-0101 (compound code), NNI-0250 (compound code), nornicotine (traditional name) (1319), novaluron (585), noviflumuron (586), O-2,5-dichloro-4-iodophenyl O-ethyl ethylphosphonothioate (IUPAC name) (1057), O,O-diethyl O-4-methyl-2-oxo-2H-chromen-7-yl phosphorothioate (IUPAC name) (1074), O,O-diethyl O-6-methyl-2-propylpyrimidin-4-yl phosphorothioate (IUPAC name) (1075), O,O,O′,O′-tetrapropyl dithiopyrophosphate (IUPAC name) (1424), oleic acid (IUPAC name) (593), omethoate (594), oxamyl (602), oxydemeton-methyl (609), oxydeprofos (1324), oxydisulfoton (1325), pp′-DDT (219), para-dichlorobenzene [CCN], parathion (615), parathion-methyl (616), penfluoron (alternative name) [CCN], pentachlorophenol (623), pentachlorophenyl laurate (IUPAC name) (623), permethrin (626), petroleum oils (alternative name) (628), PH 60-38 (development code) (1328), phenkapton (1330), phenothrin (630), phenthoate (631), phorate (636), phosalone (637), phosfolan (1338), phosmet (638), phosnichlor (1339), phosphamidon (639), phosphine (IUPAC name) (640), phoxim (642), phoxim-methyl (1340), pirimetaphos (1344), pirimicarb (651), pirimiphos-ethyl (1345), pirimiphos-methyl (652), polychlorodicyclopentadiene isomers (IUPAC name) (1346), polychloroterpenes (traditional name) (1347), potassium arsenite [CCN], potassium thiocyanate [CCN], prallethrin (655), precocene I (alternative name) [CCN], precocene II (alternative name) [CCN], precocene III (alternative name) [CCN], primidophos (1349), profenofos (662), profluthrin [CCN], promacyl (1354), promecarb (1355), propaphos (1356), propetamphos (673), propoxur (678), prothidathion (1360), prothiofos (686), prothoate (1362), protrifenbute [CCN], pymetrozine (688), pyraclofos (689), pyrazophos (693), pyresmethrin (1367), pyrethrin I (696), pyrethrin II (696), pyrethrins (696), pyridaben (699), pyridalyl (700), pyridaphenthion (701), pyrimidifen (706), pyrimitate (1370), pyriproxyfen (708), quassia (alternative name) [CCN], quinalphos (711), quinalphos-methyl (1376), quinothion (1380), quintiofos (1381), R-1492 (development code) (1382), rafoxanide (alternative name) [CCN], resmethrin (719), rotenone (722), RU 15525 (development code) (723), RU 25475 (development code) (1386), ryania (alternative name) (1387), ryanodine (traditional name) (1387), sabadilla (alternative name) (725), schradan (1389), sebufos (alternative name), selamectin (alternative name) [CCN], SI-0009 (compound code), silafluofen (728), SN 72129 (development code) (1397), sodium arsenite [CCN], sodium cyamide (444), sodium fluoride (IUPAC/Chemical Abstracts name) (1399), sodium hexafluorosilicate (1400), sodium pentachlorophenoxide (623), sodium selenate (IUPAC name) (1401), sodium thiocyanate [CCN], sophamide (1402), spinosad (737), spiromesifen (739), sulcofuron (746), sulcofuron-sodium (746), sulfluramid (750), sulfotep (753), sulfuryl fluoride (756), sulprofos (1408), tar oils (alternative name) (758), tau-fluvalinate (398), tazimcarb (1412), TDE (1414), tebufenozide (762), tebufenpyrad (763), tebupirimfos (764), teflubenzuron (768), tefluthrin (769), temephos (770), TEPP (1417), terallethrin (1418), terbam (alternative name), terbufos (773), tetrachloroethane [CCN], tetrachlorvinphos (777), tetramethrin (787), theta-cypermethrin (204), thiacloprid (791), thiafenox (alternative name), thiamethoxam (792), thicrofos (1428), thiocarboxime (1431), thiocyclam (798), thiocyclam hydrogen oxalate (798), thiodicarb (799), thiofanox (800), thiometon (801), thionazin (1434), thiosultap (803), thiosultap-sodium (803), thuringiensin (alternative name) [CCN], tolfenpyrad (809), tralomethrin (812), transfluthrin (813), transpermethrin (1440), triamiphos (1441), triazamate (818), triazophos (820), triazuron (alternative name), trichlorfon (824), trichlormetaphos-3 (alternative name) [CCN], trichloronat (1452), trifenofos (1455), triflumuron (835), trimethacarb (840), triprene (1459), vamidothion (847), vaniliprole [CCN], veratridine (alternative name) (725), veratrine (alternative name) (725), XMC (853), xylylcarb (854), YI-5302 (compound code), zeta-cypermethrin (205), zetamethrin (alternative name), zinc phosphide (640), zolaprofos (1469) and ZXI 8901 (development code) (858),
a molluscicide selected from the group of substances consisting of bis(tributyltin)oxide (IUPAC name) (913), bromoacetamide [CCN], calcium arsenate [CCN], cloethocarb (999), copper acetoarsenite [CCN], copper sulfate (172), fentin (347), ferric phosphate (IUPAC name) (352), metaldehyde (518), methiocarb (530), niclosamide (576), niclosamide-olamine (576), pentachlorophenol (623), sodium pentachlorophenoxide (623), tazimcarb (1412), thiodicarb (799), tributyltin oxide (913), trifenmorph (1454), trimethacarb (840), triphenyltin acetate (IUPAC name) (347) and triphenyltin hydroxide (IUPAC name) (347),
a nematicide selected from the group of substances consisting of 1,2-dibromo-3-chloropropane (IUPAC/Chemical Abstracts name) (1045), 1,2-dichloropropane (IUPAC/Chemical Abstracts name) (1062), 1,2-dichloropropane with 1,3-dichloropropene (IUPAC name) (1063), 1,3-dichloropropene (233), 3,4-dichlorotetrahydrothiophene 1,1-dioxide (IUPAC/Chemical Abstracts name) (1065), 3-(4-chlorophenyl)-5-methylrhodanine (IUPAC name) (980), 5-methyl-6-thioxo-1,3,5-thiadiazinan-3-ylacetic acid (IUPAC name) (1286), 6-isopentenylaminopurine (alternative name) (210), abamectin (1), acetoprole [CCN], alanycarb (15), aldicarb (16), aldoxycarb (863), AZ 60541 (compound code), benclothiaz [CCN], benomyl (62), butylpyridaben (alternative name), cadusafos (109), carbofuran (118), carbon disulfide (945), carbosulfan (119), chloropicrin (141), chlorpyrifos (145), cloethocarb (999), cytokinins (alternative name) (210), dazomet (216), DBCP (1045), DCIP (218), diamidafos (1044), dichlofenthion (1051), dicliphos (alternative name), dimethoate (262), doramectin (alternative name) [CCN], emamectin (291), emamectin benzoate (291), eprinomectin (alternative name) [CCN], ethoprophos (312), ethylene dibromide (316), fenamiphos (326), fenpyrad (alternative name), fensulfothion (1158), fosthiazate (408), fosthietan (1196), furfural (alternative name) [CCN], GY-81 (development code) (423), heterophos [CCN], iodomethane (IUPAC name) (542), isamidofos (1230), isazofos (1231), ivermectin (alternative name) [CCN], kinetin (alternative name) (210), mecarphon (1258), metam (519), metam-potassium (alternative name) (519), metam-sodium (519), methyl bromide (537), methyl isothiocyanate (543), milbemycin oxime (alternative name) [CCN], moxidectin (alternative name) [CCN], Myrothecium verrucaria composition (alternative name) (565), NC-184 (compound code), oxamyl (602), phorate (636), phosphamidon (639), phosphocarb [CCN], sebufos (alternative name), selamectin (alternative name) [CCN], spinosad (737), terbam (alternative name), terbufos (773), tetrachlorothiophene (IUPAC/Chemical Abstracts name) (1422), thiafenox (alternative name), thionazin (1434), triazophos (820), triazuron (alternative name), xylenols [CCN], YI-5302 (compound code) and zeatin (alternative name) (210),
a nitrification inhibitor selected from the group of substances consisting of potassium ethylxanthate [CCN] and nitrapyrin (580),
a plant activator selected from the group of substances consisting of acibenzolar (6), acibenzolar-5-methyl (6), probenazole (658) and Reynoutria sachalinensis extract (alternative name) (720),
a rodenticide selected from the group of substances consisting of 2-isovalerylindan-1,3-dione (IUPAC name) (1246), 4-(quinoxalin-2-ylamino)benzenesulfonamide (IUPAC name) (748), alpha-chlorohydrin [CCN], aluminium phosphide (640), antu (880), arsenous oxide (882), barium carbonate (891), bisthiosemi (912), brodifacoum (89), bromadiolone (91), bromethalin (92), calcium cyamide (444), chloralose (127), chlorophacinone (140), cholecalciferol (alternative name) (850), coumachlor (1004), coumafuryl (1005), coumatetralyl (175), crimidine (1009), difenacoum (246), difethialone (249), diphacinone (273), ergocalciferol (301), flocoumafen (357), fluoroacetamide (379), flupropadine (1183), flupropadine hydrochloride (1183), gamma-HCH (430), HCH (430), hydrogen cyamide (444), iodomethane (IUPAC name) (542), lindane (430), magnesium phosphide (IUPAC name) (640), methyl bromide (537), norbormide (1318), phosacetim (1336), phosphine (IUPAC name) (640), phosphorus [CCN], pindone (1341), potassium arsenite [CCN], pyrinuron (1371), scilliroside (1390), sodium arsenite [CCN], sodium cyamide (444), sodium fluoro-acetate (735), strychnine (745), thallium sulfate [CCN], warfarin (851) and zinc phosphide (640),
a synergist selected from the group of substances consisting of 2-(2-butoxyethoxy)ethyl piperonylate (IUPAC name) (934), 5-(1,3-benzodioxol-5-yl)-3-hexylcyclohex-2-enone (IUPAC name) (903), farnesol with nerolidol (alternative name) (324), MB-599 (development code) (498), MGK 264 (development code) (296), piperonyl butoxide (649), piprotal (1343), propyl isomer (1358), S421 (development code) (724), sesamex (1393), sesasmolin (1394) and sulfoxide (1406),
an animal repellent selected from the group of substances consisting of anthraquinone (32), chloralose (127), copper naphthenate [CCN], copper oxychloride (171), diazinon (227), dicyclopentadiene (chemical name) (1069), guazatine (422), guazatine acetates (422), methiocarb (530), pyridin-4-amine (IUPAC name) (23), thiram (804), trimethacarb (840), zinc naphthenate [CCN] and ziram (856),
a virucide selected from the group of substances consisting of imanin (alternative name) [CCN] and ribavirin (alternative name) [CCN],
and a wound protectant selected from the group of substances consisting of mercuric oxide (512), octhilinone (590) and thiophanate-methyl (802).

A very especially preferred embodiment of the subject-matter {1.1.8} of the invention is {1.1.8.2} a pesticidal composition comprising a mixture consisting of at least two substances, namely one compound (A) and at least one compound (B), as active ingredient and at least one auxiliary, wherein the compound (A) is the compound of formula (A-8) and the compound (B) is a compound selected from the group of substances consisting of abamectin (1), cyromazine (209), diafenthiuron (226), diazinon (227), emamectin benzoate (291), fenoxycarb (340), fosthiazate (408), lambda-cyhalothrin (198), lufenuron (490), methidathion (529), profenofos (662), pymetrozine (688), tefluthrin (769) and thiamethoxam (792).

The compound of formula (A-8) is known, for example, from the PCT Application WO-03/015519.

A preferred embodiment of the subject-matter {1.1} of the invention is {1.1.9} a pesticidal composition comprising a mixture consisting of at least two substances, namely one compound (A) and at least one compound (B), as active ingredient and at least one auxiliary, wherein the compound (A) is the compound of formula (A-9) 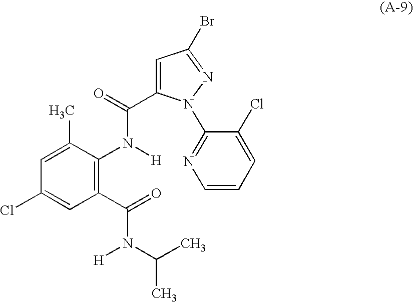
and the compound (B) is a compound selected from the group of substances consisting of an adjuvant, an acaricide, an algicide, an anthelmintic, an avicide, a bactericide, a biological agent, a soil sterilant, a chemosterilant, an insect pheromone, an insect repellent, an insecticide, a molluscicide, a nematicide, a nitrification inhibitor, a plant activator, a rodenticide, a synergist, an animal repellent, a virucide and a wound protectant.

An especially preferred embodiment of the subject-matter {1.1.9} of the invention is {1.1.9.1} a pesticidal composition comprising a mixture consisting of at least two substances, namely one compound (A) and at least one compound (B), as active ingredient and at least one auxiliary, wherein the compound (A) is the compound of formula (A-9) and the compound (B) is a compound selected from the group of substances consisting of
an adjuvant selected from the group of substances consisting of petroleum oils (alternative name) (628),
an acaricide selected from the group of substances consisting of 1,1-bis(4-chlorophenyl)-2-ethoxyethanol (IUPAC name) (910), 2,4-dichlorophenyl benzenesulfonate (IUPAC/Chemical Abstracts name) (1059), 2-fluoro-N-methyl-N-1-naphthylacetamide (IUPAC name) (1295), 4-chlorophenyl phenyl sulfone (IUPAC name) (981), abamectin (1), acequinocyl (3), acetoprole [CCN], acrinathrin (9), aldicarb (16), aldoxycarb (863), alpha-cypermethrin (202), amidithion (870), amidoflumet [CCN], amidothioate (872), amiton (875), amiton hydrogen oxalate (875), amitraz (24), aramite (881), arsenous oxide (882), AVI 382 (compound code), AZ 60541 (compound code), azinphos-ethyl (44), azinphos-methyl (45), azobenzene (IUPAC name) (888), azocyclotin (46), azothoate (889), benomyl (62), benoxafos (alternative name) [CCN], benzoximate (71), benzyl benzoate (IUPAC name) [CCN], bifenazate (74), bifenthrin (76), binapacryl (907), brofenvalerate (alternative name), bromocyclen (918), bromophos (920), bromophos-ethyl (921), bromopropylate (94), buprofezin (99), butocarboxim (103), butoxycarboxim (104), butylpyridaben (alternative name), calcium polysulfide (IUPAC name) (111), camphechlor (941), carbanolate (943), carbaryl (115), carbofuran (118), carbophenothion (947), CGA 50'439 (development code) (125), chinomethionat (126), chlorbenside (959), chlordimeform (964), chlordimeform hydrochloride (964), chlorfenapyr (130), chlorfenethol (968), chlorfenson (970), chlorfensulphide (971), chlorfenvinphos (131), chlorobenzilate (975), chloromebuform (977), chloromethiuron (978), chloropropylate (983), chlorpyrifos (145), chlorpyrifos-methyl (146), chlorthiophos (994), cinerin I (696), cinerin II (696), cinerins (696), clofentezine (158), closantel (alternative name) [CCN], coumaphos (174), crotamiton (alternative name) [CCN], crotoxyphos (1010), cufraneb (1013), cyanthoate (1020), cyhalothrin (196), cyhexatin (199), cypermethrin (201), DCPM (1032), DDT (219), demephion (1037), demephion-O (1037), demephion-S (1037), demeton (1038), demeton-methyl (224), demeton-O (1038), demeton-O-methyl (224), demeton-S (1038), demeton-5-methyl (224), demeton-5-methylsulphon (1039), diafenthiuron (226), dialifos (1042), diazinon (227), dichlofluanid (230), dichlorvos (236), dicliphos (alternative name), dicofol (242), dicrotophos (243), dienochlor (1071), dimefox (1081), dimethoate (262), dinactin (alternative name) (653), dinex (1089), dinex-diclexine (1089), dinobuton (269), dinocap (270), dinocap-4 [CCN], dinocap-6 [CCN], dinocton (1090), dinopenton (1092), dinosulfon (1097), dinoterbon (1098), dioxathion (1102), diphenyl sulfone (IUPAC name) (1103), disulfuram (alternative name) [CCN], disulfoton (278), DNOC (282), dofenapyn (1113), doramectin (alternative name) [CCN], endosulfan (294), endothion (1121), EPN (297), eprinomectin (alternative name) [CCN], ethion (309), ethoate-methyl (1134), etoxazole (320), etrimfos (1142), fenazaflor (1147), fenazaquin (328), fenbutatin oxide (330), fenothiocarb (337), fenpropathrin (342), fenpyrad (alternative name), fenpyroximate (345), fenson (1157), fentrifanil (1161), fenvalerate (349), fipronil (354), fluacrypyrim (360), fluazuron (1166), flubenzimine (1167), flucycloxuron (366), flucythrinate (367), fluenetil (1169), flufenoxuron (370), flumethrin (372), fluorbenside (1174), fluvalinate (1184), FMC 1137 (development code) (1185), formetanate (405), formetanate hydrochloride (405), formothion (1192), formparanate (1193), gamma-HCH (430), glyodin (1205), halfenprox (424), heptenophos (432), hexadecyl cyclopropanecarboxylate (IUPAC/Chemical Abstracts name) (1216), hexythiazox (441), iodomethane (IUPAC name) (542), isocarbophos (alternative name) (473), isopropyl O-(methoxyaminothiophosphoryl)salicylate (IUPAC name) (473), ivermectin (alternative name) [CCN], jasmolin I (696), jasmolin II (696), jodfenphos (1248), lindane (430), lufenuron (490), malathion (492), malonoben (1254), mecarbam (502), mephosfolan (1261), mesulfen (alternative name) [CCN], methacrifos (1266), methamidophos (527), methidathion (529), methiocarb (530), methomyl (531), methyl bromide (537), metolcarb (550), mevinphos (556), mexacarbate (1290), milbemectin (557), milbemycin oxime (alternative name) [CCN], mipafox (1293), monocrotophos (561), morphothion (1300), moxidectin (alternative name) [CCN], naled (567), NC-184 (compound code), nifluridide (1309), nikkomycins (alternative name) [CCN], nitrilacarb (1313), nitrilacarb 1:1 zinc chloride complex (1313), NNI-0101 (compound code), NNI-0250 (compound code), omethoate (594), oxamyl (602), oxydeprofos (1324), oxydisulfoton (1325), pp′-DDT (219), parathion (615), permethrin (626), petroleum oils (alternative name) (628), phenkapton (1330), phenthoate (631), phorate (636), phosalone (637), phosfolan (1338), phosmet (638), phosphamidon (639), phoxim (642), pirimiphos-methyl (652), polychloroterpenes (traditional name) (1347), polynactins (alternative name) (653), proclonol (1350), profenofos (662), promacyl (1354), propargite (671), propetamphos (673), propoxur (678), prothidathion (1360), prothoate (1362), pyrethrin I (696), pyrethrin II (696), pyrethrins (696), pyridaben (699), pyridaphenthion (701), pyrimidifen (706), pyrimitate (1370), quinalphos (711), quintiofos (1381), R-1492 (development code) (1382), RA-17 (development code) (1383), rotenone (722), schradan (1389), sebufos (alternative name), selamectin (alternative name) [CCN], SI-0009 (compound code), sophamide (1402), spirodiclofen (738), spiromesifen (739), SSI-121 (development code) (1404), sulfuram (alternative name) [CCN], sulfluramid (750), sulfotep (753), sulfur (754), SZI-121 (development code) (757), tau-fluvalinate (398), tebufenpyrad (763), TEPP (1417), terbam (alternative name), tetrachlorvinphos (777), tetradifon (786), tetranactin (alternative name) (653), tetrasul (1425), thiafenox (alternative name), thiocarboxime (1431), thiofanox (800), thiometon (801), thioquinox (1436), thuringiensin (alternative name) [CCN], triamiphos (1441), triarathene (1443), triazophos (820), triazuron (alternative name), trichlorfon (824), trifenofos (1455), trinactin (alternative name) (653), vamidothion (847), vaniliprole [CCN] and YI-5302 (compound code),
an algicide selected from the group of substances consisting of bethoxazin [CCN], copper dioctanoate (IUPAC name) (170), copper sulfate (172), cybutryne [CCN], dichlone (1052), dichlorophen (232), endothal (295), fentin (347), hydrated lime [CCN], nabam (566), quinoclamine (714), quinonamid (1379), simazine (730), triphenyltin acetate (IUPAC name) (347) and triphenyltin hydroxide (IUPAC name) (347),
an anthelmintic selected from the group of substances consisting of abamectin (1), crufomate (1011), doramectin (alternative name) [CCN], emamectin (291), emamectin benzoate (291), eprinomectin (alternative name) [CCN], ivermectin (alternative name) [CCN], milbemycin oxime (alternative name) [CCN], moxidectin (alternative name) [CCN], piperazine [CCN], selamectin (alternative name) [CCN], spinosad (737) and thiophanate (1435),
an avicide selected from the group of substances consisting of chloralose (127), endrin (1122), fenthion (346), pyridin-4-amine (IUPAC name) (23) and strychnine (745),
a bactericide selected from the group of substances consisting of 1-hydroxy-1H-pyridine-2-thione (IUPAC name) (1222), 4-(quinoxalin-2-ylamino)benzenesulfonamide (IUPAC name) (748), 8-hydroxyquinoline sulfate (446), bronopol (97), copper dioctanoate (IUPAC name) (170), copper hydroxide (IUPAC name) (169), cresol [CCN], dichlorophen (232), dipyrithione (1105), dodicin (1112), fenaminosulf (1144), formaldehyde (404), hydrargaphen (alternative name) [CCN], kasugamycin (483), kasugamycin hydrochloride hydrate (483), nickel bis(dimethyldithiocarbamate) (IUPAC name) (1308), nitrapyrin (580), octhilinone (590), oxolinic acid (606), oxytetracycline (611), potassium hydroxyquinoline sulfate (446), probenazole (658), streptomycin (744), streptomycin sesquisulfate (744), tecloftalam (766) and thiomersal (alternative name) [CCN],
a biological agent selected from the group of substances consisting of Adoxophyes orana GV (alternative name) (12), Agrobacterium radiobacter (alternative name) (13), Amblyseius spp. (alternative name) (19), Anagrapha falcifera NPV (alternative name) (28), Anagrus atomus (alternative name) (29), Aphelinus abdominalis (alternative name) (33), Aphidius colemani (alternative name) (34), Aphidoletes aphidimyza (alternative name) (35), Autographa californica NPV (alternative name) (38), Bacillus firmus (alternative name) (48), Bacillus sphaericus Neide (scientific name) (49), Bacillus thuringiensis Berliner (scientific name) (51), Bacillus thuringiensis subsp. aizawai (scientific name) (51), Bacillus thuringiensis subsp. israelensis (scientific name) (51), Bacillus thuringiensis subsp. japonensis (scientific name) (51), Bacillus thuringiensis subsp. kurstaki (scientific name) (51), Bacillus thuringiensis subsp. tenebrionis (scientific name) (51), Beauveria bassiana (alternative name) (53), Beauveria brongniartii (alternative name) (54), Chrysoperla carnea (alternative name) (151), Cryptolaemus montrouzieri (alternative name) (178), Cydia pomonella GV (alternative name) (191), Dacnusa sibirica (alternative name) (212), Diglyphus isaea (alternative name) (254), Encarsia formosa (scientific name) (293), Eretmocerus eremicus (alternative name) (300), Helicoverpa zea NPV (alternative name) (431), Heterorhabditis bacteriophora and H. megidis (alternative name) (433), Hippodamia convergens (alternative name) (442), Leptomastix dactylopii (alternative name) (488), Macrolophus caliginosus (alternative name) (491), Mamestra brassicae NPV (alternative name) (494), Metaphycus helvolus (alternative name) (522), Metarhizium anisopliae var. acridum (scientific name) (523), Metarhizium anisopliae var. anisopliae (scientific name) (523), Neodiprion sertifer NPV and N. lecontei NPV (alternative name) (575), Orius spp. (alternative name) (596), Paecilomyces fumosoroseus (alternative name) (613), Phytoseiulus persimilis (alternative name) (644), Spodoptera exigua multicapsid nuclear polyhedrosis virus (scientific name) (741), Steinernema bibionis (alternative name) (742), Steinernema carpocapsae (alternative name) (742), Steinernema feltiae (alternative name) (742), Steinernema glaseri (alternative name) (742), Steinernema riobrave (alternative name) (742), Steinernema riobravis (alternative name) (742), Steinernema scapterisci (alternative name) (742), Steinernema spp. (alternative name) (742), Trichogramma spp. (alternative name) (826), Typhlodromus occidentalis (alternative name) (844) and Verticillium lecanii (alternative name) (848),
a soil sterilant selected from the group of substances consisting of iodomethane (IUPAC name) (542) and methyl bromide (537),
a chemosterilant selected from the group of substances consisting of apholate [CCN], bisazir (alternative name) [CCN], busulfan (alternative name) [CCN], diflubenzuron (250), dimatif (alternative name) [CCN], hemel [CCN], hempa [CCN], metepa [CCN], methiotepa [CCN], methyl apholate [CCN], morzid [CCN], penfluoron (alternative name) [CCN], tepa [CCN], thiohempa (alternative name) [CCN], thiotepa (alternative name) [CCN], tretamine (alternative name) [CCN] and uredepa (alternative name) [CCN],
an insect pheromone selected from the group of substances consisting of (E)-dec-5-en-1-yl acetate with (E)-dec-5-en-1-ol (IUPAC name) (222), (E)-tridec-4-en-1-yl acetate (IUPAC name) (829), (E)-6-methylhept-2-en-4-ol (IUPAC name) (541), (E,Z)-tetradeca-4,10-dien-1-yl acetate (IUPAC name) (779), (Z)-dodec-7-en-1-yl acetate (IUPAC name) (285), (Z)-hexadec-11-enal (IUPAC name) (436), (Z)-hexadec-11-en-1-yl acetate (IUPAC name) (437), (Z)-hexadec-13-en-11-yn-1-yl acetate (IUPAC name) (438), (Z)-icos-13-en-10-one (IUPAC name) (448), (Z)-tetradec-7-en-1-al (IUPAC name) (782), (Z)-tetradec-9-en-1-ol (IUPAC name) (783), (Z)-tetradec-9-en-1-yl acetate (IUPAC name) (784), (7E,9Z)-dodeca-7,9-dien-1-yl acetate (IUPAC name) (283), (9Z,11E)-tetradeca-9,11-dien-1-yl acetate (IUPAC name) (780), (9Z,12E)-tetradeca-9,12-dien-1-yl acetate (IUPAC name) (781), 14-methyloctadec-1-ene (IUPAC name) (545), 4-methylnonan-5-ol with 4-methylnonan-5-one (IUPAC name) (544), alpha-multistriatin (alternative name) [CCN], brevicomin (alternative name) [CCN], codlelure (alternative name) [CCN], codlemone (alternative name) (167), cuelure (alternative name) (179), disparlure (277), dodec-8-en-1-yl acetate (IUPAC name) (286), dodec-9-en-1-yl acetate (IUPAC name) (287), dodeca-8,10-dien-1-yl acetate (IUPAC name) (284), dominicalure (alternative name) [CCN], ethyl 4-methyloctanoate (IUPAC name) (317), eugenol (alternative name) [CCN], frontalin (alternative name) [CCN], gossyplure (alternative name) (420), grandlure (421), grandlure I (alternative name) (421), grandlure II (alternative name) (421), grandlure III (alternative name) (421), grandlure IV (alternative name) (421), hexylure [CCN], ipsdienol (alternative name) [CCN], ipsenol (alternative name) [CCN], japonilure (alternative name) (481), lineatin (alternative name) [CCN], litlure (alternative name) [CCN], looplure (alternative name) [CCN], medlure [CCN], megatomoic acid (alternative name) [CCN], methyl eugenol (alternative name) (540), muscalure (563), octadeca-2,13-dien-1-yl acetate (IUPAC name) (588), octadeca-3,13-dien-1-yl acetate (IUPAC name) (589), orfralure (alternative name) [CCN], oryctalure (alternative name) (317), ostramone (alternative name) [CCN], siglure [CCN], sordidin (alternative name) (736), sulcatol (alternative name) [CCN], tetradec-11-en-1-yl acetate (IUPAC name) (785), trimedlure (839), trimedlure A (alternative name) (839), trimedlure B₁ (alternative name) (839), trimedlure B₂ (alternative name) (839), trimedlure C (alternative name) (839) and trunc-call (alternative name) [CCN],
an insect repellent selected from the group of substances consisting of 2-(octylthio)-ethanol (IUPAC name) (591), butopyronoxyl (933), butoxy(polypropylene glycol) (936), dibutyl adipate (IUPAC name) (1046), dibutyl phthalate (1047), dibutyl succinate (IUPAC name) (1048), diethyltoluamide [CCN], dimethyl carbate [CCN], dimethyl phthalate [CCN], ethyl hexanediol (1137), hexamide [CCN], methoquin-butyl (1276), methylneodecanamide [CCN], oxamate [CCN] and picaridin [CCN],
an insecticide selected from the group of substances consisting of 1,1-dichloro-1-nitroethane (IUPAC/Chemical Abstracts name) (1058), 1,1-dichloro-2,2-bis(4-ethylphenyl)-ethane (IUPAC name) (1056), 1,2-dichloropropane (IUPAC/Chemical Abstracts name) (1062), 1,2-dichloropropane with 1,3-dichloropropene (IUPAC name) (1063), 1-bromo-2-chloroethane (IUPAC/Chemical Abstracts name) (916), 2,2,2-trichloro-1-(3,4-dichloro-phenyl)ethyl acetate (IUPAC name) (1451), 2,2-dichlorovinyl 2-ethylsulfinylethyl methyl phosphate (IUPAC name) (1066), 2-(1,3-dithiolan-2-yl)phenyl dimethylcarbamate (IUPAC/Chemical Abstracts name) (1109), 2-(2-butoxyethoxy)ethyl thiocyanate (IUPAC/Chemical Abstracts name) (935), 2-(4,5-dimethyl-1,3-dioxolan-2-yl)phenyl methylcarbamate (IUPAC/Chemical Abstracts name) (1084), 2-(4-chloro-3,5-xylyloxy)ethanol (IUPAC name) (986), 2-chlorovinyl diethyl phosphate (IUPAC name) (984), 2-imidazolidone (IUPAC name) (1225), 2-isovalerylindan-1,3-dione (IUPAC name) (1246), 2-methyl(prop-2-ynyl)aminophenyl methylcarbamate (IUPAC name) (1284), 2-thiocyanatoethyl laurate (IUPAC name) (1433), 3-bromo-1-chloroprop-1-ene (IUPAC name) (917), 3-methyl-1-phenylpyrazol-5-yl dimethyl-carbamate (IUPAC name) (1283), 4-methyl(prop-2-ynyl)amino-3,5-xylyl methylcarbamate (IUPAC name) (1285), 5,5-dimethyl-3-oxocyclohex-1-enyl dimethylcarbamate (IUPAC name) (1085), abamectin (1), acephate (2), acetamiprid (4), acethion (alternative name) [CCN], acetoprole [CCN], acrinathrin (9), acrylonitrile (IUPAC name) (861), alanycarb (15), aldicarb (16), aldoxycarb (863), aldrin (864), allethrin (17), allosamidin (alternative name) [CCN], allyxycarb (866), alpha-cypermethrin (202), alpha-ecdysone (alternative name) [CCN], aluminium phosphide (640), amidithion (870), amidothioate (872), aminocarb (873), amiton (875), amiton hydrogen oxalate (875), amitraz (24), anabasine (877), athidathion (883), AVI 382 (compound code), AZ 60541 (compound code), azadirachtin (alternative name) (41), azamethiphos (42), azinphos-ethyl (44), azinphos-methyl (45), azothoate (889), Bacillus thuringiensis delta endotoxins (alternative name) (52), barium hexafluorosilicate (alternative name) [CCN], barium polysulfide (IUPAC/Chemical Abstracts name) (892), barthrin [CCN], BAS 320 I (compound code), Bayer 22/190 (development code) (893), Bayer 22408 (development code) (894), bendiocarb (58), benfuracarb (60), bensultap (66), beta-cyfluthrin (194), beta-cypermethrin (203), bifenthrin (76), bioallethrin (78), bioallethrin S-cyclopentenyl isomer (alternative name) (79), bioethanomethrin [CCN], biopermethrin (908), bioresmethrin (80), bis(2-chloroethyl)ether (IUPAC name) (909), bistrifluoron (83), borax (86), brofenvalerate (alternative name), bromfenvinfos (914), bromocyclen (918), bromo-DDT (alternative name) [CCN], bromophos (920), bromophos-ethyl (921), bufencarb (924), buprofezin (99), butacarb (926), butathiofos (927), butocarboxim (103), butonate (932), butoxycarboxim (104), butylpyridaben (alternative name), cadusafos (109), calcium arsenate [CCN], calcium cyamide (444), calcium polysulfide (IUPAC name) (111), camphechlor (941), carbanolate (943), carbaryl (115), carbofuran (118), carbon disulfide (IUPAC/Chemical Abstracts name) (945), carbon tetrachloride (IUPAC name) (946), carbophenothion (947), carbosulfan (119), cartap (123), cartap hydrochloride (123), cevadine (alternative name) (725), chlorbicyclen (960), chlordane (128), chlordecone (963), chlordimeform (964), chlordimeform hydrochloride (964), chlorethoxyfos (129), chlorfenapyr (130), chlorfenvinphos (131), chlorfluazuron (132), chlormephos (136), chloroform [CCN], chloropicrin (141), chlorphoxim (989), chlorprazophos (990), chlorpyrifos (145), chlorpyrifos-methyl (146), chlorthiophos (994), chromafenozide (150), cinerin I (696), cinerin II (696), cinerins (696), cis-resmethrin (alternative name), cismethrin (80), clocythrin (alternative name), cloethocarb (999), closantel (alternative name) [CCN], clothianidin (165), copper acetoarsenite [CCN], copper arsenate [CCN], copper oleate [CCN], coumaphos (174), coumithoate (1006), crotamiton (alternative name) [CCN], crotoxyphos (1010), crufomate (1011), cryolite (alternative name) (177), CS 708 (development code) (1012), cyanofenphos (1019), cyanophos (184), cyanthoate (1020), cyclethrin [CCN], cycloprothrin (188), cyfluthrin (193), cyhalothrin (196), cypermethrin (201), cyphenothrin (206), cyromazine (209), cythioate (alternative name) [CCN], d-limonene (alternative name) [CCN], d-tetramethrin (alternative name) (788), DAEP (1031), dazomet (216), DDT (219), decarbofuran (1034), deltamethrin (223), demephion (1037), demephion-O (1037), demephion-S (1037), demeton (1038), demeton-methyl (224), demeton-O (1038), demeton-O-methyl (224), demeton-S (1038), demeton-5-methyl (224), demeton-5-methylsulphon (1039), diafenthiuron (226), dialifos (1042), diamidafos (1044), diazinon (227), dicapthon (1050), dichlofenthion (1051), dichlorvos (236), dicliphos (alternative name), dicresyl (alternative name) [CCN], dicrotophos (243), dicyclanil (244), dieldrin (1070), diethyl 5-methylpyrazol-3-yl phosphate (IUPAC name) (1076), diflubenzuron (250), dilor (alternative name) [CCN], dimefluthrin [CCN], dimefox (1081), dimetan (1085), dimethoate (262), dimethrin (1083), dimethylvinphos (265), dimetilan (1086), dinex (1089), dinex-diclexine (1089), dinoprop (1093), dinosam (1094), dinoseb (1095), dinotefuran (271), diofenolan (1099), dioxabenzofos (1100), dioxacarb (1101), dioxathion (1102), disulfoton (278), dithicrofos (1108), DNOC (282), doramectin (alternative name) [CCN], DSP (1115), ecdysterone (alternative name) [CCN], EI 1642 (development code) (1118), emamectin (291), emamectin benzoate (291), EMPC (1120), empenthrin (292), endosulfan (294), endothion (1121), endrin (1122), EPBP (1123), EPN (297), epofenonane (1124), eprinomectin (alternative name) [CCN], esfenvalerate (302), etaphos (alternative name) [CCN], ethiofencarb (308), ethion (309), ethiprole (310), ethoate-methyl (1134), ethoprophos (312), ethyl formate (IUPAC name) [CCN], ethyl-DDD (alternative name) (1056), ethylene dibromide (316), ethylene dichloride (chemical name) (1136), ethylene oxide [CCN], etofenprox (319), etrimfos (1142), EXD (1143), famphur (323), fenamiphos (326), fenazaflor (1147), fenchlorphos (1148), fenethacarb (1149), fenfluthrin (1150), fenitrothion (335), fenobucarb (336), fenoxacrim (1153), fenoxycarb (340), fenpirithrin (1155), fenpropathrin (342), fenpyrad (alternative name), fensulfothion (1158), fenthion (346), fenthion-ethyl [CCN], fenvalerate (349), fipronil (354), flonicamid (358), flucofuron (1168), flucycloxuron (366), flucythrinate (367), fluenetil (1169), flufenerim [CCN], flufenoxuron (370), flufenprox (1171), flumethrin (372), fluvalinate (1184), FMC 1137 (development code) (1185), fonofos (1191), formetanate (405), formetanate hydrochloride (405), formothion (1192), formparanate (1193), fosmethilan (1194), fospirate (1195), fosthiazate (408), fosthietan (1196), furathiocarb (412), furethrin (1200), gamma-cyhalothrin (197), gamma-HCH (430), guazatine (422), guazatine acetates (422), GY-81 (development code) (423), halfenprox (424), halofenozide (425), HCH (430), HEOD (1070), heptachlor (1211), heptenophos (432), heterophos [CCN], hexaflumuron (439), HHDN (864), hydramethylnon (443), hydrogen cyamide (444), hydroprene (445), hyquincarb (1223), imidacloprid (458), imiprothrin (460), indoxacarb (465), iodomethane (IUPAC name) (542), IPSP (1229), isazofos (1231), isobenzan (1232), isocarbophos (alternative name) (473), isodrin (1235), isofenphos (1236), isolane (1237), isoprocarb (472), isopropyl O-(methoxyaminothiophosphoryl)salicylate (IUPAC name) (473), isoprothiolane (474), isothioate (1244), isoxathion (480), ivermectin (alternative name) [CCN], jasmolin I (696), jasmolin II (696), jodfenphos (1248), juvenile hormone I (alternative name) [CCN], juvenile hormone II (alternative name) [CCN], juvenile hormone III (alternative name) [CCN], kelevan (1249), kinoprene (484), lambda-cyhalothrin (198), lead arsenate [CCN], leptophos (1250), lindane (430), lirimfos (1251), lufenuron (490), lythidathion (1253), m-cumenyl methylcarbamate (IUPAC name) (1014), magnesium phosphide (IUPAC name) (640), malathion (492), malonoben (1254), mazidox (1255), mecarbam (502), mecarphon (1258), menazon (1260), mephosfolan (1261), mercurous chloride (513), mesulfenfos (1263), metam (519), metam-potassium (alternative name) (519), metam-sodium (519), methacrifos (1266), methamidophos (527), methanesulfonyl fluoride (IUPAC/Chemical Abstracts name) (1268), methidathion (529), methiocarb (530), methocrotophos (1273), methomyl (531), methoprene (532), methoquin-butyl (1276), methothrin (alternative name) (533), methoxychlor (534), methoxyfenozide (535), methyl bromide (537), methyl isothiocyanate (543), methylchloroform (alternative name) [CCN], methylene chloride [CCN], metofluthrin [CCN], metolcarb (550), metoxadiazone (1288), mevinphos (556), mexacarbate (1290), milbemectin (557), milbemycin oxime (alternative name) [CCN], mipafox (1293), mirex (1294), monocrotophos (561), morphothion (1300), moxidectin (alternative name) [CCN], naftalofos (alternative name) [CCN], naled (567), naphthalene (IUPAC/Chemical Abstracts name) (1303), NC-170 (development code) (1306), NC-184 (compound code), nicotine (578), nicotine sulfate (578), nifluridide (1309), nitenpyram (579), nithiazine (1311), nitrilacarb (1313), nitrilacarb 1:1 zinc chloride complex (1313), NNI-0101 (compound code), NNI-0250 (compound code), nornicotine (traditional name) (1319), novaluron (585), noviflumuron (586), O-2,5-dichloro-4-iodophenyl O-ethyl ethylphosphonothioate (IUPAC name) (1057), O,O-diethyl O-4-methyl-2-oxo-2H-chromen-7-yl phosphorothioate (IUPAC name) (1074), O,O-diethyl O-6-methyl-2-propylpyrimidin-4-yl phosphorothioate (IUPAC name) (1075), O,O,O′,O′-tetrapropyl dithiopyrophosphate (IUPAC name) (1424), oleic acid (IUPAC name) (593), omethoate (594), oxamyl (602), oxydemeton-methyl (609), oxydeprofos (1324), oxydisulfoton (1325), pp′-DDT (219), para-dichlorobenzene [CCN], parathion (615), parathion-methyl (616), penfluoron (alternative name) [CCN], pentachlorophenol (623), pentachlorophenyl laurate (IUPAC name) (623), permethrin (626), petroleum oils (alternative name) (628), PH 60-38 (development code) (1328), phenkapton (1330), phenothrin (630), phenthoate (631), phorate (636), phosalone (637), phosfolan (1338), phosmet (638), phosnichlor (1339), phosphamidon (639), phosphine (IUPAC name) (640), phoxim (642), phoxim-methyl (1340), pirimetaphos (1344), pirimicarb (651), pirimiphos-ethyl (1345), pirimiphos-methyl (652), polychlorodicyclopentadiene isomers (IUPAC name) (1346), polychloroterpenes (traditional name) (1347), potassium arsenite [CCN], potassium thiocyanate [CCN], prallethrin (655), precocene I (alternative name) [CCN], precocene II (alternative name) [CCN], precocene III (alternative name) [CCN], primidophos (1349), profenofos (662), profluthrin [CCN], promacyl (1354), promecarb (1355), propaphos (1356), propetamphos (673), propoxur (678), prothidathion (1360), prothiofos (686), prothoate (1362), protrifenbute [CCN], pymetrozine (688), pyraclofos (689), pyrazophos (693), pyresmethrin (1367), pyrethrin I (696), pyrethrin II (696), pyrethrins (696), pyridaben (699), pyridalyl (700), pyridaphenthion (701), pyrimidifen (706), pyrimitate (1370), pyriproxyfen (708), quassia (alternative name) [CCN], quinalphos (711), quinalphos-methyl (1376), quinothion (1380), quintiofos (1381), R-1492 (development code) (1382), rafoxanide (alternative name) [CCN], resmethrin (719), rotenone (722), RU 15525 (development code) (723), RU 25475 (development code) (1386), ryania (alternative name) (1387), ryanodine (traditional name) (1387), sabadilla (alternative name) (725), schradan (1389), sebufos (alternative name), selamectin (alternative name) [CCN], SI-0009 (compound code), silafluofen (728), SN 72129 (development code) (1397), sodium arsenite [CCN], sodium cyamide (444), sodium fluoride (IUPAC/Chemical Abstracts name) (1399), sodium hexafluorosilicate (1400), sodium pentachlorophenoxide (623), sodium selenate (IUPAC name) (1401), sodium thiocyanate [CCN], sophamide (1402), spinosad (737), spiromesifen (739), sulcofuron (746), sulcofuron-sodium (746), sulfluramid (750), sulfotep (753), sulfuryl fluoride (756), sulprofos (1408), tar oils (alternative name) (758), tau-fluvalinate (398), tazimcarb (1412), TDE (1414), tebufenozide (762), tebufenpyrad (763), tebupirimfos (764), teflubenzuron (768), tefluthrin (769), temephos (770), TEPP (1417), terallethrin (1418), terbam (alternative name), terbufos (773), tetrachloroethane [CCN], tetrachlorvinphos (777), tetramethrin (787), theta-cypermethrin (204), thiacloprid (791), thiafenox (alternative name), thiamethoxam (792), thicrofos (1428), thiocarboxime (1431), thiocyclam (798), thiocyclam hydrogen oxalate (798), thiodicarb (799), thiofanox (800), thiometon (801), thionazin (1434), thiosultap (803), thiosultap-sodium (803), thuringiensin (alternative name) [CCN], tolfenpyrad (809), tralomethrin (812), transfluthrin (813), transpermethrin (1440), triamiphos (1441), triazamate (818), triazophos (820), triazuron (alternative name), trichlorfon (824), trichlormetaphos-3 (alternative name) [CCN], trichloronat (1452), trifenofos (1455), triflumuron (835), trimethacarb (840), triprene (1459), vamidothion (847), vaniliprole [CCN], veratridine (alternative name) (725), veratrine (alternative name) (725), XMC (853), xylylcarb (854), YI-5302 (compound code), zeta-cypermethrin (205), zetamethrin (alternative name), zinc phosphide (640), zolaprofos (1469) and ZXI 8901 (development code) (858),
a molluscicide selected from the group of substances consisting of bis(tributyltin)oxide (IUPAC name) (913), bromoacetamide [CCN], calcium arsenate [CCN], cloethocarb (999), copper acetoarsenite [CCN], copper sulfate (172), fentin (347), ferric phosphate (IUPAC name) (352), metaldehyde (518), methiocarb (530), niclosamide (576), niclosamide-olamine (576), pentachlorophenol (623), sodium pentachlorophenoxide (623), tazimcarb (1412), thiodicarb (799), tributyltin oxide (913), trifenmorph (1454), trimethacarb (840), triphenyltin acetate (IUPAC name) (347) and triphenyltin hydroxide (IUPAC name) (347),
a nematicide selected from the group of substances consisting of 1,2-dibromo-3-chloropropane (IUPAC/Chemical Abstracts name) (1045), 1,2-dichloropropane (IUPAC/Chemical Abstracts name) (1062), 1,2-dichloropropane with 1,3-dichloropropene (IUPAC name) (1063), 1,3-dichloropropene (233), 3,4-dichlorotetrahydrothiophene 1,1-dioxide (IUPAC/Chemical Abstracts name) (1065), 3-(4-chlorophenyl)-5-methylrhodanine (IUPAC name) (980), 5-methyl-6-thioxo-1,3,5-thiadiazinan-3-ylacetic acid (IUPAC name) (1286), 6-isopentenylaminopurine (alternative name) (210), abamectin (1), acetoprole [CCN], alanycarb (15), aldicarb (16), aldoxycarb (863), AZ 60541 (compound code), benclothiaz [CCN], benomyl (62), butylpyridaben (alternative name), cadusafos (109), carbofuran (118), carbon disulfide (945), carbosulfan (119), chloropicrin (141), chlorpyrifos (145), cloethocarb (999), cytokinins (alternative name) (210), dazomet (216), DBCP (1045), DCIP (218), diamidafos (1044), dichlofenthion (1051), dicliphos (alternative name), dimethoate (262), doramectin (alternative name) [CCN], emamectin (291), emamectin benzoate (291), eprinomectin (alternative name) [CCN], ethoprophos (312), ethylene dibromide (316), fenamiphos (326), fenpyrad (alternative name), fensulfothion (1158), fosthiazate (408), fosthietan (1196), furfural (alternative name) [CCN], GY-81 (development code) (423), heterophos [CCN], iodomethane (IUPAC name) (542), isamidofos (1230), isazofos (1231), ivermectin (alternative name) [CCN], kinetin (alternative name) (210), mecarphon (1258), metam (519), metam-potassium (alternative name) (519), metam-sodium (519), methyl bromide (537), methyl isothiocyanate (543), milbemycin oxime (alternative name) [CCN], moxidectin (alternative name) [CCN], Myrothecium verrucaria composition (alternative name) (565), NC-184 (compound code), oxamyl (602), phorate (636), phosphamidon (639), phosphocarb [CCN], sebufos (alternative name), selamectin (alternative name) [CCN], spinosad (737), terbam (alternative name), terbufos (773), tetrachlorothiophene (IUPAC/Chemical Abstracts name) (1422), thiafenox (alternative name), thionazin (1434), triazophos (820), triazuron (alternative name), xylenols [CCN], YI-5302 (compound code) and zeatin (alternative name) (210),
a nitrification inhibitor selected from the group of substances consisting of potassium ethylxanthate [CCN] and nitrapyrin (580),
a plant activator selected from the group of substances consisting of acibenzolar (6), acibenzolar-5-methyl (6), probenazole (658) and Reynoutria sachalinensis extract (alternative name) (720),
a rodenticide selected from the group of substances consisting of 2-isovalerylindan-1,3-dione (IUPAC name) (1246), 4-(quinoxalin-2-ylamino)benzenesulfonamide (IUPAC name) (748), alpha-chlorohydrin [CCN], aluminium phosphide (640), antu (880), arsenous oxide (882), barium carbonate (891), bisthiosemi (912), brodifacoum (89), bromadiolone (91), bromethalin (92), calcium cyamide (444), chloralose (127), chlorophacinone (140), cholecalciferol (alternative name) (850), coumachlor (1004), coumafuryl (1005), coumatetralyl (175), crimidine (1009), difenacoum (246), difethialone (249), diphacinone (273), ergocalciferol (301), flocoumafen (357), fluoroacetamide (379), flupropadine (1183), flupropadine hydrochloride (1183), gamma-HCH (430), HCH (430), hydrogen cyamide (444), iodomethane (IUPAC name) (542), lindane (430), magnesium phosphide (IUPAC name) (640), methyl bromide (537), norbormide (1318), phosacetim (1336), phosphine (IUPAC name) (640), phosphorus [CCN], pindone (1341), potassium arsenite [CCN], pyrinuron (1371), scilliroside (1390), sodium arsenite [CCN], sodium cyamide (444), sodium fluoro-acetate (735), strychnine (745), thallium sulfate [CCN], warfarin (851) and zinc phosphide (640),
a synergist selected from the group of substances consisting of 2-(2-butoxyethoxy)ethyl piperonylate (IUPAC name) (934), 5-(1,3-benzodioxol-5-yl)-3-hexylcyclohex-2-enone (IUPAC name) (903), farnesol with nerolidol (alternative name) (324), MB-599 (development code) (498), MGK 264 (development code) (296), piperonyl butoxide (649), piprotal (1343), propyl isomer (1358), S421 (development code) (724), sesamex (1393), sesasmolin (1394) and sulfoxide (1406),
an animal repellent selected from the group of substances consisting of anthraquinone (32), chloralose (127), copper naphthenate [CCN], copper oxychloride (171), diazinon (227), dicyclopentadiene (chemical name) (1069), guazatine (422), guazatine acetates (422), methiocarb (530), pyridin-4-amine (IUPAC name) (23), thiram (804), trimethacarb (840), zinc naphthenate [CCN] and ziram (856),
a virucide selected from the group of substances consisting of imanin (alternative name) [CCN] and ribavirin (alternative name) [CCN], and a wound protectant selected from the group of substances consisting of mercuric oxide (512), octhilinone (590) and thiophanate-methyl (802).

A very especially preferred embodiment of the subject-matter {1.1.9} of the invention is {1.1.9.2} a pesticidal composition comprising a mixture consisting of at least two substances, namely one compound (A) and at least one compound (B), as active ingredient and at least one auxiliary, wherein the compound (A) is the compound of formula (A-9) and the compound (B) is a compound selected from the group of substances consisting of abamectin (1), cyromazine (209), diafenthiuron (226), diazinon (227), emamectin benzoate (291), fenoxycarb (340), fosthiazate (408), lambda-cyhalothrin (198), lufenuron (490), methidathion (529), profenofos (662), pymetrozine (688), tefluthrin (769) and thiamethoxam (792).

The compound of formula (A-9) is known, for example, from the PCT Application WO-03/015519.

A preferred embodiment of the subject-matter {1.1} of the invention is {1.1.10} a pesticidal composition comprising a mixture consisting of at least two substances, namely one compound (A) and at least one compound (B), as active ingredient and at least one auxiliary, wherein the compound (A) is the compound of formula (A-10) 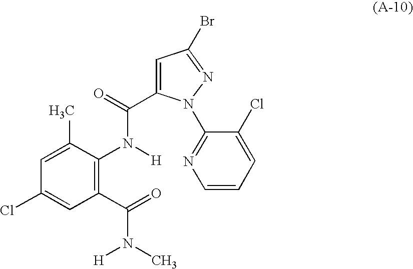
and the compound (B) is a compound selected from the group of substances consisting of an adjuvant, an acaricide, an algicide, an anthelmintic, an avicide, a bactericide, a biological agent, a soil sterilant, a chemosterilant, an insect pheromone, an insect repellent, an insecticide, a molluscicide, a nematicide, a nitrification inhibitor, a plant activator, a rodenticide, a synergist, an animal repellent, a virucide and a wound protectant.

An especially preferred embodiment of the subject-matter {1.1.10} of the invention is {1.1.10.1} a pesticidal composition comprising a mixture consisting of at least two substances, namely one compound (A) and at least one compound (B), as active ingredient and at least one auxiliary, wherein the compound (A) is the compound of formula (A-10) and the compound (B) is a compound selected from the group of substances consisting of
an adjuvant selected from the group of substances consisting of petroleum oils (alternative name) (628),
an acaricide selected from the group of substances consisting of 1,1-bis(4-chlorophenyl)-2-ethoxyethanol (IUPAC name) (910), 2,4-dichlorophenyl benzenesulfonate (IUPAC/Chemical Abstracts name) (1059), 2-fluoro-N-methyl-N-1-naphthylacetamide (IUPAC name) (1295), 4-chlorophenyl phenyl sulfone (IUPAC name) (981), abamectin (1), acequinocyl (3), acetoprole [CCN], acrinathrin (9), aldicarb (16), aldoxycarb (863), alpha-cypermethrin (202), amidithion (870), amidoflumet [CCN], amidothioate (872), amiton (875), amiton hydrogen oxalate (875), amitraz (24), aramite (881), arsenous oxide (882), AVI 382 (compound code), AZ 60541 (compound code), azinphos-ethyl (44), azinphos-methyl (45), azobenzene (IUPAC name) (888), azocyclotin (46), azothoate (889), benomyl (62), benoxafos (alternative name) [CCN], benzoximate (71), benzyl benzoate (IUPAC name) [CCN], bifenazate (74), bifenthrin (76), binapacryl (907), brofenvalerate (alternative name), bromocyclen (918), bromophos (920), bromophos-ethyl (921), bromopropylate (94), buprofezin (99), butocarboxim (103), butoxycarboxim (104), butylpyridaben (alternative name), calcium polysulfide (IUPAC name) (111), camphechlor (941), carbanolate (943), carbaryl (115), carbofuran (118), carbophenothion (947), CGA 50'439 (development code) (125), chinomethionat (126), chlorbenside (959), chlordimeform (964), chlordimeform hydrochloride (964), chlorfenapyr (130), chlorfenethol (968), chlorfenson (970), chlorfensulphide (971), chlorfenvinphos (131), chlorobenzilate (975), chloromebuform (977), chloromethiuron (978), chloropropylate (983), chlorpyrifos (145), chlorpyrifos-methyl (146), chlorthiophos (994), cinerin I (696), cinerin II (696), cinerins (696), clofentezine (158), closantel (alternative name) [CCN], coumaphos (174), crotamiton (alternative name) [CCN], crotoxyphos (1010), cufraneb (1013), cyanthoate (1020), cyhalothrin (196), cyhexatin (199), cypermethrin (201), DCPM (1032), DDT (219), demephion (1037), demephion-O (1037), demephion-S (1037), demeton (1038), demeton-methyl (224), demeton-O (1038), demeton-O-methyl (224), demeton-S (1038), demeton-5-methyl (224), demeton-5-methylsulphon (1039), diafenthiuron (226), dialifos (1042), diazinon (227), dichlofluanid (230), dichlorvos (236), dicliphos (alternative name), dicofol (242), dicrotophos (243), dienochlor (1071), dimefox (1081), dimethoate (262), dinactin (alternative name) (653), dinex (1089), dinex-diclexine (1089), dinobuton (269), dinocap (270), dinocap-4 [CCN], dinocap-6 [CCN], dinocton (1090), dinopenton (1092), dinosulfon (1097), dinoterbon (1098), dioxathion (1102), diphenyl sulfone (IUPAC name) (1103), disulfuram (alternative name) [CCN], disulfoton (278), DNOC (282), dofenapyn (1113), doramectin (alternative name) [CCN], endosulfan (294), endothion (1121), EPN (297), eprinomectin (alternative name) [CCN], ethion (309), ethoate-methyl (1134), etoxazole (320), etrimfos (1142), fenazaflor (1147), fenazaquin (328), fenbutatin oxide (330), fenothiocarb (337), fenpropathrin (342), fenpyrad (alternative name), fenpyroximate (345), fenson (1157), fentrifanil (1161), fenvalerate (349), fipronil (354), fluacrypyrim (360), fluazuron (1166), flubenzimine (1167), flucycloxuron (366), flucythrinate (367), fluenetil (1169), flufenoxuron (370), flumethrin (372), fluorbenside (1174), fluvalinate (1184), FMC 1137 (development code) (1185), formetanate (405), formetanate hydrochloride (405), formothion (1192), formparanate (1193), gamma-HCH (430), glyodin (1205), halfenprox (424), heptenophos (432), hexadecyl cyclopropanecarboxylate (IUPAC/Chemical Abstracts name) (1216), hexythiazox (441), iodomethane (IUPAC name) (542), isocarbophos (alternative name) (473), isopropyl O-(methoxyaminothiophosphoryl)salicylate (IUPAC name) (473), ivermectin (alternative name) [CCN], jasmolin I (696), jasmolin II (696), jodfenphos (1248), lindane (430), lufenuron (490), malathion (492), malonoben (1254), mecarbam (502), mephosfolan (1261), mesulfen (alternative name) [CCN], methacrifos (1266), methamidophos (527), methidathion (529), methiocarb (530), methomyl (531), methyl bromide (537), metolcarb (550), mevinphos (556), mexacarbate (1290), milbemectin (557), milbemycin oxime (alternative name) [CCN], mipafox (1293), monocrotophos (561), morphothion (1300), moxidectin (alternative name) [CCN], naled (567), NC-184 (compound code), nifluridide (1309), nikkomycins (alternative name) [CCN], nitrilacarb (1313), nitrilacarb 1:1 zinc chloride complex (1313), NNI-0101 (compound code), NNI-0250 (compound code), omethoate (594), oxamyl (602), oxydeprofos (1324), oxydisulfoton (1325), pp′-DDT (219), parathion (615), permethrin (626), petroleum oils (alternative name) (628), phenkapton (1330), phenthoate (631), phorate (636), phosalone (637), phosfolan (1338), phosmet (638), phosphamidon (639), phoxim (642), pirimiphos-methyl (652), polychloroterpenes (traditional name) (1347), polynactins (alternative name) (653), proclonol (1350), profenofos (662), promacyl (1354), propargite (671), propetamphos (673), propoxur (678), prothidathion (1360), prothoate (1362), pyrethrin I (696), pyrethrin II (696), pyrethrins (696), pyridaben (699), pyridaphenthion (701), pyrimidifen (706), pyrimitate (1370), quinalphos (711), quintiofos (1381), R-1492 (development code) (1382), RA-17 (development code) (1383), rotenone (722), schradan (1389), sebufos (alternative name), selamectin (alternative name) [CCN], SI-0009 (compound code), sophamide (1402), spirodiclofen (738), spiromesifen (739), SSI-121 (development code) (1404), sulfuram (alternative name) [CCN], sulfluramid (750), sulfotep (753), sulfur (754), SZI-121 (development code) (757), tau-fluvalinate (398), tebufenpyrad (763), TEPP (1417), terbam (alternative name), tetrachlorvinphos (777), tetradifon (786), tetranactin (alternative name) (653), tetrasul (1425), thiafenox (alternative name), thiocarboxime (1431), thiofanox (800), thiometon (801), thioquinox (1436), thuringiensin (alternative name) [CCN], triamiphos (1441), triarathene (1443), triazophos (820), triazuron (alternative name), trichlorfon (824), trifenofos (1455), trinactin (alternative name) (653), vamidothion (847), vaniliprole [CCN] and YI-5302 (compound code),
an algicide selected from the group of substances consisting of bethoxazin [CCN], copper dioctanoate (IUPAC name) (170), copper sulfate (172), cybutryne [CCN], dichlone (1052), dichlorophen (232), endothal (295), fentin (347), hydrated lime [CCN], nabam (566), quinoclamine (714), quinonamid (1379), simazine (730), triphenyltin acetate (IUPAC name) (347) and triphenyltin hydroxide (IUPAC name) (347),
an anthelmintic selected from the group of substances consisting of abamectin (1), crufomate (1011), doramectin (alternative name) [CCN], emamectin (291), emamectin benzoate (291), eprinomectin (alternative name) [CCN], ivermectin (alternative name) [CCN], milbemycin oxime (alternative name) [CCN], moxidectin (alternative name) [CCN], piperazine [CCN], selamectin (alternative name) [CCN], spinosad (737) and thiophanate (1435),
an avicide selected from the group of substances consisting of chloralose (127), endrin (1122), fenthion (346), pyridin-4-amine (IUPAC name) (23) and strychnine (745),
a bactericide selected from the group of substances consisting of 1-hydroxy-1H-pyridine-2-thione (IUPAC name) (1222), 4-(quinoxalin-2-ylamino)benzenesulfonamide (IUPAC name) (748), 8-hydroxyquinoline sulfate (446), bronopol (97), copper dioctanoate (IUPAC name) (170), copper hydroxide (IUPAC name) (169), cresol [CCN], dichlorophen (232), dipyrithione (1105), dodicin (1112), fenaminosulf (1144), formaldehyde (404), hydrargaphen (alternative name) [CCN], kasugamycin (483), kasugamycin hydrochloride hydrate (483), nickel bis(dimethyldithiocarbamate) (IUPAC name) (1308), nitrapyrin (580), octhilinone (590), oxolinic acid (606), oxytetracycline (611), potassium hydroxyquinoline sulfate (446), probenazole (658), streptomycin (744), streptomycin sesquisulfate (744), tecloftalam (766) and thiomersal (alternative name) [CCN],
a biological agent selected from the group of substances consisting of Adoxophyes orana GV (alternative name) (12), Agrobacterium radiobacter (alternative name) (13), Amblyseius spp. (alternative name) (19), Anagrapha falcifera NPV (alternative name) (28), Anagrus atomus (alternative name) (29), Aphelinus abdominalis (alternative name) (33), Aphidius colemani (alternative name) (34), Aphidoletes aphidimyza (alternative name) (35), Autographa californica NPV (alternative name) (38), Bacillus firmus (alternative name) (48), Bacillus sphaericus Neide (scientific name) (49), Bacillus thuringiensis Berliner (scientific name) (51), Bacillus thuringiensis subsp. aizawai (scientific name) (51), Bacillus thuringiensis subsp. israelensis (scientific name) (51), Bacillus thuringiensis subsp. japonensis (scientific name) (51), Bacillus thuringiensis subsp. kurstaki (scientific name) (51), Bacillus thuringiensis subsp. tenebrionis (scientific name) (51), Beauveria bassiana (alternative name) (53), Beauveria brongniartii (alternative name) (54), Chrysoperla carnea (alternative name) (151), Cryptolaemus montrouzieri (alternative name) (178), Cydia pomonella GV (alternative name) (191), Dacnusa sibirica (alternative name) (212), Diglyphus isaea (alternative name) (254), Encarsia formosa (scientific name) (293), Eretmocerus eremicus (alternative name) (300), Helicoverpa zea NPV (alternative name) (431), Heterorhabditis bacteriophora and H. megidis (alternative name) (433), Hippodamia convergens (alternative name) (442), Leptomastix dactylopii (alternative name) (488), Macrolophus caliginosus (alternative name) (491), Mamestra brassicae NPV (alternative name) (494), Metaphycus helvolus (alternative name) (522), Metarhizium anisopliae var. acridum (scientific name) (523), Metarhizium anisopliae var. anisopliae (scientific name) (523), Neodiprion sertifer NPV and N. lecontei NPV (alternative name) (575), Orius spp. (alternative name) (596), Paecilomyces fumosoroseus (alternative name) (613), Phytoseiulus persimilis (alternative name) (644), Spodoptera exigua multicapsid nuclear polyhedrosis virus (scientific name) (741), Steinernema bibionis (alternative name) (742), Steinernema carpocapsae (alternative name) (742), Steinernema feltiae (alternative name) (742), Steinernema glaseri (alternative name) (742), Steinernema riobrave (alternative name) (742), Steinernema riobravis (alternative name) (742), Steinernema scapterisci (alternative name) (742), Steinernema spp. (alternative name) (742), Trichogramma spp. (alternative name) (826), Typhlodromus occidentalis (alternative name) (844) and Verticillium lecanii (alternative name) (848),
a soil sterilant selected from the group of substances consisting of iodomethane (IUPAC name) (542) and methyl bromide (537),
a chemosterilant selected from the group of substances consisting of apholate [CCN], bisazir (alternative name) [CCN], busulfan (alternative name) [CCN], diflubenzuron (250), dimatif (alternative name) [CCN], hemel [CCN], hempa [CCN], metepa [CCN], methiotepa [CCN], methyl apholate [CCN], morzid [CCN], penfluoron (alternative name) [CCN], tepa [CCN], thiohempa (alternative name) [CCN], thiotepa (alternative name) [CCN], tretamine (alternative name) [CCN] and uredepa (alternative name) [CCN],
an insect pheromone selected from the group of substances consisting of (E)-dec-5-en-1-yl acetate with (E)-dec-5-en-1-ol (IUPAC name) (222), (E)-tridec-4-en-1-yl acetate (IUPAC name) (829), (E)-6-methylhept-2-en-4-ol (IUPAC name) (541), (E,Z)-tetradeca-4,10-dien-1-yl acetate (IUPAC name) (779), (Z)-dodec-7-en-1-yl acetate (IUPAC name) (285), (Z)-hexadec-11-enal (IUPAC name) (436), (Z)-hexadec-11-en-1-yl acetate (IUPAC name) (437), (Z)-hexadec-13-en-11-yn-1-yl acetate (IUPAC name) (438), (Z)-icos-13-en-10-one (IUPAC name) (448), (Z)-tetradec-7-en-1-al (IUPAC name) (782), (Z)-tetradec-9-en-1-ol (IUPAC name) (783), (Z)-tetradec-9-en-1-yl acetate (IUPAC name) (784), (7E,9Z)-dodeca-7,9-dien-1-yl acetate (IUPAC name) (283), (9Z,11E)-tetradeca-9,11-dien-1-yl acetate (IUPAC name) (780), (9Z,12E)-tetradeca-9,12-dien-1-yl acetate (IUPAC name) (781), 14-methyloctadec-1-ene (IUPAC name) (545), 4-methylnonan-5-ol with 4-methylnonan-5-one (IUPAC name) (544), alpha-multistriatin (alternative name) [CCN], brevicomin (alternative name) [CCN], codlelure (alternative name) [CCN], codlemone (alternative name) (167), cuelure (alternative name) (179), disparlure (277), dodec-8-en-1-yl acetate (IUPAC name) (286), dodec-9-en-1-yl acetate (IUPAC name) (287), dodeca-8,10-dien-1-yl acetate (IUPAC name) (284), dominicalure (alternative name) [CCN], ethyl 4-methyloctanoate (IUPAC name) (317), eugenol (alternative name) [CCN], frontalin (alternative name) [CCN], gossyplure (alternative name) (420), grandlure (421), grandlure I (alternative name) (421), grandlure II (alternative name) (421), grandlure III (alternative name) (421), grandlure IV (alternative name) (421), hexylure [CCN], ipsdienol (alternative name) [CCN], ipsenol (alternative name) [CCN], japonilure (alternative name) (481), lineatin (alternative name) [CCN], litlure (alternative name) [CCN], looplure (alternative name) [CCN], medlure [CCN], megatomoic acid (alternative name) [CCN], methyl eugenol (alternative name) (540), muscalure (563), octadeca-2,13-dien-1-yl acetate (IUPAC name) (588), octadeca-3,13-dien-1-yl acetate (IUPAC name) (589), orfralure (alternative name) [CCN], oryctalure (alternative name) (317), ostramone (alternative name) [CCN], siglure [CCN], sordidin (alternative name) (736), sulcatol (alternative name) [CCN], tetradec-11-en-1-yl acetate (IUPAC name) (785), trimedlure (839), trimedlure A (alternative name) (839), trimedlure B₁ (alternative name) (839), trimedlure B₂ (alternative name) (839), trimedlure C (alternative name) (839) and trunc-call (alternative name) [CCN],
an insect repellent selected from the group of substances consisting of 2-(octylthio)-ethanol (IUPAC name) (591), butopyronoxyl (933), butoxy(polypropylene glycol) (936), dibutyl adipate (IUPAC name) (1046), dibutyl phthalate (1047), dibutyl succinate (IUPAC name) (1048), diethyltoluamide [CCN], dimethyl carbate [CCN], dimethyl phthalate [CCN], ethyl hexanediol (1137), hexamide [CCN], methoquin-butyl (1276), methylneodecanamide [CCN], oxamate [CCN] and picaridin [CCN],
an insecticide selected from the group of substances consisting of 1,1-dichloro-1-nitroethane (IUPAC/Chemical Abstracts name) (1058), 1,1-dichloro-2,2-bis(4-ethylphenyl)-ethane (IUPAC name) (1056), 1,2-dichloropropane (IUPAC/Chemical Abstracts name) (1062), 1,2-dichloropropane with 1,3-dichloropropene (IUPAC name) (1063), 1-bromo-2-chloroethane (IUPAC/Chemical Abstracts name) (916), 2,2,2-trichloro-1-(3,4-dichloro-phenyl)ethyl acetate (IUPAC name) (1451), 2,2-dichlorovinyl 2-ethylsulfinylethyl methyl phosphate (IUPAC name) (1066), 2-(1,3-dithiolan-2-yl)phenyl dimethylcarbamate (IUPAC/Chemical Abstracts name) (1109), 2-(2-butoxyethoxy)ethyl thiocyanate (IUPAC/Chemical Abstracts name) (935), 2-(4,5-dimethyl-1,3-dioxolan-2-yl)phenyl methylcarbamate (IUPAC/Chemical Abstracts name) (1084), 2-(4-chloro-3,5-xylyloxy)ethanol (IUPAC name) (986), 2-chlorovinyl diethyl phosphate (IUPAC name) (984), 2-imidazolidone (IUPAC name) (1225), 2-isovalerylindan-1,3-dione (IUPAC name) (1246), 2-methyl(prop-2-ynyl)aminophenyl methylcarbamate (IUPAC name) (1284), 2-thiocyanatoethyl laurate (IUPAC name) (1433), 3-bromo-1-chloroprop-1-ene (IUPAC name) (917), 3-methyl-1-phenylpyrazol-5-yl dimethyl-carbamate (IUPAC name) (1283), 4-methyl(prop-2-ynyl)amino-3,5-xylyl methylcarbamate (IUPAC name) (1285), 5,5-dimethyl-3-oxocyclohex-1-enyl dimethylcarbamate (IUPAC name) (1085), abamectin (1), acephate (2), acetamiprid (4), acethion (alternative name) [CCN], acetoprole [CCN], acrinathrin (9), acrylonitrile (IUPAC name) (861), alanycarb (15), aldicarb (16), aldoxycarb (863), aldrin (864), allethrin (17), allosamidin (alternative name) [CCN], allyxycarb (866), alpha-cypermethrin (202), alpha-ecdysone (alternative name) [CCN], aluminium phosphide (640), amidithion (870), amidothioate (872), aminocarb (873), amiton (875), amiton hydrogen oxalate (875), amitraz (24), anabasine (877), athidathion (883), AVI 382 (compound code), AZ 60541 (compound code), azadirachtin (alternative name) (41), azamethiphos (42), azinphos-ethyl (44), azinphos-methyl (45), azothoate (889), Bacillus thuringiensis delta endotoxins (alternative name) (52), barium hexafluorosilicate (alternative name) [CCN], barium polysulfide (IUPAC/Chemical Abstracts name) (892), barthrin [CCN], BAS 320 I (compound code), Bayer 22/190 (development code) (893), Bayer 22408 (development code) (894), bendiocarb (58), benfuracarb (60), bensultap (66), beta-cyfluthrin (194), beta-cypermethrin (203), bifenthrin (76), bioallethrin (78), bioallethrin S-cyclopentenyl isomer (alternative name) (79), bioethanomethrin [CCN], biopermethrin (908), bioresmethrin (80), bis(2-chloroethyl)ether (IUPAC name) (909), bistrifluoron (83), borax (86), brofenvalerate (alternative name), bromfenvinfos (914), bromocyclen (918), bromo-DDT (alternative name) [CCN], bromophos (920), bromophos-ethyl (921), bufencarb (924), buprofezin (99), butacarb (926), butathiofos (927), butocarboxim (103), butonate (932), butoxycarboxim (104), butylpyridaben (alternative name), cadusafos (109), calcium arsenate [CCN], calcium cyamide (444), calcium polysulfide (IUPAC name) (111), camphechlor (941), carbanolate (943), carbaryl (115), carbofuran (118), carbon disulfide (IUPAC/Chemical Abstracts name) (945), carbon tetrachloride (IUPAC name) (946), carbophenothion (947), carbosulfan (119), cartap (123), cartap hydrochloride (123), cevadine (alternative name) (725), chlorbicyclen (960), chlordane (128), chlordecone (963), chlordimeform (964), chlordimeform hydrochloride (964), chlorethoxyfos (129), chlorfenapyr (130), chlorfenvinphos (131), chlorfluazuron (132), chlormephos (136), chloroform [CCN], chloropicrin (141), chlorphoxim (989), chlorprazophos (990), chlorpyrifos (145), chlorpyrifos-methyl (146), chlorthiophos (994), chromafenozide (150), cinerin I (696), cinerin II (696), cinerins (696), cis-resmethrin (alternative name), cismethrin (80), clocythrin (alternative name), cloethocarb (999), closantel (alternative name) [CCN], clothianidin (165), copper acetoarsenite [CCN], copper arsenate [CCN], copper oleate [CCN], coumaphos (174), coumithoate (1006), crotamiton (alternative name) [CCN], crotoxyphos (1010), crufomate (1011), cryolite (alternative name) (177), CS 708 (development code) (1012), cyanofenphos (1019), cyanophos (184), cyanthoate (1020), cyclethrin [CCN], cycloprothrin (188), cyfluthrin (193), cyhalothrin (196), cypermethrin (201), cyphenothrin (206), cyromazine (209), cythioate (alternative name) [CCN], d-limonene (alternative name) [CCN], d-tetramethrin (alternative name) (788), DAEP (1031), dazomet (216), DDT (219), decarbofuran (1034), deltamethrin (223), demephion (1037), demephion-O (1037), demephion-S (1037), demeton (1038), demeton-methyl (224), demeton-O (1038), demeton-O-methyl (224), demeton-S (1038), demeton-5-methyl (224), demeton-5-methylsulphon (1039), diafenthiuron (226), dialifos (1042), diamidafos (1044), diazinon (227), dicapthon (1050), dichlofenthion (1051), dichlorvos (236), dicliphos (alternative name), dicresyl (alternative name) [CCN], dicrotophos (243), dicyclanil (244), dieldrin (1070), diethyl 5-methylpyrazol-3-yl phosphate (IUPAC name) (1076), diflubenzuron (250), dilor (alternative name) [CCN], dimefluthrin [CCN], dimefox (1081), dimetan (1085), dimethoate (262), dimethrin (1083), dimethylvinphos (265), dimetilan (1086), dinex (1089), dinex-diclexine (1089), dinoprop (1093), dinosam (1094), dinoseb (1095), dinotefuran (271), diofenolan (1099), dioxabenzofos (1100), dioxacarb (1101), dioxathion (1102), disulfoton (278), dithicrofos (1108), DNOC (282), doramectin (alternative name) [CCN], DSP (1115), ecdysterone (alternative name) [CCN], EI 1642 (development code) (1118), emamectin (291), emamectin benzoate (291), EMPC (1120), empenthrin (292), endosulfan (294), endothion (1121), endrin (1122), EPBP (1123), EPN (297), epofenonane (1124), eprinomectin (alternative name) [CCN], esfenvalerate (302), etaphos (alternative name) [CCN], ethiofencarb (308), ethion (309), ethiprole (310), ethoate-methyl (1134), ethoprophos (312), ethyl formate (IUPAC name) [CCN], ethyl-DDD (alternative name) (1056), ethylene dibromide (316), ethylene dichloride (chemical name) (1136), ethylene oxide [CCN], etofenprox (319), etrimfos (1142), EXD (1143), famphur (323), fenamiphos (326), fenazaflor (1147), fenchlorphos (1148), fenethacarb (1149), fenfluthrin (1150), fenitrothion (335), fenobucarb (336), fenoxacrim (1153), fenoxycarb (340), fenpirithrin (1155), fenpropathrin (342), fenpyrad (alternative name), fensulfothion (1158), fenthion (346), fenthion-ethyl [CCN], fenvalerate (349), fipronil (354), flonicamid (358), flucofuron (1168), flucycloxuron (366), flucythrinate (367), fluenetil (1169), flufenerim [CCN], flufenoxuron (370), flufenprox (1171), flumethrin (372), fluvalinate (1184), FMC 1137 (development code) (1185), fonofos (1191), formetanate (405), formetanate hydrochloride (405), formothion (1192), formparanate (1193), fosmethilan (1194), fospirate (1195), fosthiazate (408), fosthietan (1196), furathiocarb (412), furethrin (1200), gamma-cyhalothrin (197), gamma-HCH (430), guazatine (422), guazatine acetates (422), GY-81 (development code) (423), halfenprox (424), halofenozide (425), HCH (430), HEOD (1070), heptachlor (1211), heptenophos (432), heterophos [CCN], hexaflumuron (439), HHDN (864), hydramethylnon (443), hydrogen cyamide (444), hydroprene (445), hyquincarb (1223), imidacloprid (458), imiprothrin (460), indoxacarb (465), iodomethane (IUPAC name) (542), IPSP (1229), isazofos (1231), isobenzan (1232), isocarbophos (alternative name) (473), isodrin (1235), isofenphos (1236), isolane (1237), isoprocarb (472), isopropyl O-(methoxyaminothiophosphoryl)salicylate (IUPAC name) (473), isoprothiolane (474), isothioate (1244), isoxathion (480), ivermectin (alternative name) [CCN], jasmolin I (696), jasmolin II (696), jodfenphos (1248), juvenile hormone I (alternative name) [CCN], juvenile hormone II (alternative name) [CCN], juvenile hormone III (alternative name) [CCN], kelevan (1249), kinoprene (484), lambda-cyhalothrin (198), lead arsenate [CCN], leptophos (1250), lindane (430), lirimfos (1251), lufenuron (490), lythidathion (1253), m-cumenyl methylcarbamate (IUPAC name) (1014), magnesium phosphide (IUPAC name) (640), malathion (492), malonoben (1254), mazidox (1255), mecarbam (502), mecarphon (1258), menazon (1260), mephosfolan (1261), mercurous chloride (513), mesulfenfos (1263), metam (519), metam-potassium (alternative name) (519), metam-sodium (519), methacrifos (1266), methamidophos (527), methanesulfonyl fluoride (IUPAC/Chemical Abstracts name) (1268), methidathion (529), methiocarb (530), methocrotophos (1273), methomyl (531), methoprene (532), methoquin-butyl (1276), methothrin (alternative name) (533), methoxychlor (534), methoxyfenozide (535), methyl bromide (537), methyl isothiocyanate (543), methylchloroform (alternative name) [CCN], methylene chloride [CCN], metofluthrin [CCN], metolcarb (550), metoxadiazone (1288), mevinphos (556), mexacarbate (1290), milbemectin (557), milbemycin oxime (alternative name) [CCN], mipafox (1293), mirex (1294), monocrotophos (561), morphothion (1300), moxidectin (alternative name) [CCN], naftalofos (alternative name) [CCN], naled (567), naphthalene (IUPAC/Chemical Abstracts name) (1303), NC-170 (development code) (1306), NC-184 (compound code), nicotine (578), nicotine sulfate (578), nifluridide (1309), nitenpyram (579), nithiazine (1311), nitrilacarb (1313), nitrilacarb 1:1 zinc chloride complex (1313), NNI-0101 (compound code), NNI-0250 (compound code), nornicotine (traditional name) (1319), novaluron (585), noviflumuron (586), O-2,5-dichloro-4-iodophenyl O-ethyl ethylphosphonothioate (IUPAC name) (1057), O,O-diethyl O-4-methyl-2-oxo-2H-chromen-7-yl phosphorothioate (IUPAC name) (1074), O,O-diethyl O-6-methyl-2-propylpyrimidin-4-yl phosphorothioate (IUPAC name) (1075), O,O,O′,O′-tetrapropyl dithiopyrophosphate (IUPAC name) (1424), oleic acid (IUPAC name) (593), omethoate (594), oxamyl (602), oxydemeton-methyl (609), oxydeprofos (1324), oxydisulfoton (1325), pp′-DDT (219), para-dichlorobenzene [CCN], parathion (615), parathion-methyl (616), penfluoron (alternative name) [CCN], pentachlorophenol (623), pentachlorophenyl laurate (IUPAC name) (623), permethrin (626), petroleum oils (alternative name) (628), PH 60-38 (development code) (1328), phenkapton (1330), phenothrin (630), phenthoate (631), phorate (636), phosalone (637), phosfolan (1338), phosmet (638), phosnichlor (1339), phosphamidon (639), phosphine (IUPAC name) (640), phoxim (642), phoxim-methyl (1340), pirimetaphos (1344), pirimicarb (651), pirimiphos-ethyl (1345), pirimiphos-methyl (652), polychlorodicyclopentadiene isomers (IUPAC name) (1346), polychloroterpenes (traditional name) (1347), potassium arsenite [CCN], potassium thiocyanate [CCN], prallethrin (655), precocene I (alternative name) [CCN], precocene II (alternative name) [CCN], precocene III (alternative name) [CCN], primidophos (1349), profenofos (662), profluthrin [CCN], promacyl (1354), promecarb (1355), propaphos (1356), propetamphos (673), propoxur (678), prothidathion (1360), prothiofos (686), prothoate (1362), protrifenbute [CCN], pymetrozine (688), pyraclofos (689), pyrazophos (693), pyresmethrin (1367), pyrethrin I (696), pyrethrin II (696), pyrethrins (696), pyridaben (699), pyridalyl (700), pyridaphenthion (701), pyrimidifen (706), pyrimitate (1370), pyriproxyfen (708), quassia (alternative name) [CCN], quinalphos (711), quinalphos-methyl (1376), quinothion (1380), quintiofos (1381), R-1492 (development code) (1382), rafoxanide (alternative name) [CCN], resmethrin (719), rotenone (722), RU 15525 (development code) (723), RU 25475 (development code) (1386), ryania (alternative name) (1387), ryanodine (traditional name) (1387), sabadilla (alternative name) (725), schradan (1389), sebufos (alternative name), selamectin (alternative name) [CCN], SI-0009 (compound code), silafluofen (728), SN 72129 (development code) (1397), sodium arsenite [CCN], sodium cyamide (444), sodium fluoride (IUPAC/Chemical Abstracts name) (1399), sodium hexafluorosilicate (1400), sodium pentachlorophenoxide (623), sodium selenate (IUPAC name) (1401), sodium thiocyanate [CCN], sophamide (1402), spinosad (737), spiromesifen (739), sulcofuron (746), sulcofuron-sodium (746), sulfluramid (750), sulfotep (753), sulfuryl fluoride (756), sulprofos (1408), tar oils (alternative name) (758), tau-fluvalinate (398), tazimcarb (1412), TDE (1414), tebufenozide (762), tebufenpyrad (763), tebupirimfos (764), teflubenzuron (768), tefluthrin (769), temephos (770), TEPP (1417), terallethrin (1418), terbam (alternative name), terbufos (773), tetrachloroethane [CCN], tetrachlorvinphos (777), tetramethrin (787), theta-cypermethrin (204), thiacloprid (791), thiafenox (alternative name), thiamethoxam (792), thicrofos (1428), thiocarboxime (1431), thiocyclam (798), thiocyclam hydrogen oxalate (798), thiodicarb (799), thiofanox (800), thiometon (801), thionazin (1434), thiosultap (803), thiosultap-sodium (803), thuringiensin (alternative name) [CCN], tolfenpyrad (809), tralomethrin (812), transfluthrin (813), transpermethrin (1440), triamiphos (1441), triazamate (818), triazophos (820), triazuron (alternative name), trichlorfon (824), trichlormetaphos-3 (alternative name) [CCN], trichloronat (1452), trifenofos (1455), triflumuron (835), trimethacarb (840), triprene (1459), vamidothion (847), vaniliprole [CCN], veratridine (alternative name) (725), veratrine (alternative name) (725), XMC (853), xylylcarb (854), YI-5302 (compound code), zeta-cypermethrin (205), zetamethrin (alternative name), zinc phosphide (640), zolaprofos (1469) and ZXI 8901 (development code) (858),
a molluscicide selected from the group of substances consisting of bis(tributyltin)oxide (IUPAC name) (913), bromoacetamide [CCN], calcium arsenate [CCN], cloethocarb (999), copper acetoarsenite [CCN], copper sulfate (172), fentin (347), ferric phosphate (IUPAC name) (352), metaldehyde (518), methiocarb (530), niclosamide (576), niclosamide-olamine (576), pentachlorophenol (623), sodium pentachlorophenoxide (623), tazimcarb (1412), thiodicarb (799), tributyltin oxide (913), trifenmorph (1454), trimethacarb (840), triphenyltin acetate (IUPAC name) (347) and triphenyltin hydroxide (IUPAC name) (347),
a nematicide selected from the group of substances consisting of 1,2-dibromo-3-chloropropane (IUPAC/Chemical Abstracts name) (1045), 1,2-dichloropropane (IUPAC/Chemical Abstracts name) (1062), 1,2-dichloropropane with 1,3-dichloropropene (IUPAC name) (1063), 1,3-dichloropropene (233), 3,4-dichlorotetrahydrothiophene 1,1-dioxide (IUPAC/Chemical Abstracts name) (1065), 3-(4-chlorophenyl)-5-methylrhodanine (IUPAC name) (980), 5-methyl-6-thioxo-1,3,5-thiadiazinan-3-ylacetic acid (IUPAC name) (1286), 6-isopentenylaminopurine (alternative name) (210), abamectin (1), acetoprole [CCN], alanycarb (15), aldicarb (16), aldoxycarb (863), AZ 60541 (compound code), benclothiaz [CCN], benomyl (62), butylpyridaben (alternative name), cadusafos (109), carbofuran (118), carbon disulfide (945), carbosulfan (119), chloropicrin (141), chlorpyrifos (145), cloethocarb (999), cytokinins (alternative name) (210), dazomet (216), DBCP (1045), DCIP (218), diamidafos (1044), dichlofenthion (1051), dicliphos (alternative name), dimethoate (262), doramectin (alternative name) [CCN], emamectin (291), emamectin benzoate (291), eprinomectin (alternative name) [CCN], ethoprophos (312), ethylene dibromide (316), fenamiphos (326), fenpyrad (alternative name), fensulfothion (1158), fosthiazate (408), fosthietan (1196), furfural (alternative name) [CCN], GY-81 (development code) (423), heterophos [CCN], iodomethane (IUPAC name) (542), isamidofos (1230), isazofos (1231), ivermectin (alternative name) [CCN], kinetin (alternative name) (210), mecarphon (1258), metam (519), metam-potassium (alternative name) (519), metam-sodium (519), methyl bromide (537), methyl isothiocyanate (543), milbemycin oxime (alternative name) [CCN], moxidectin (alternative name) [CCN], Myrothecium verrucaria composition (alternative name) (565), NC-184 (compound code), oxamyl (602), phorate (636), phosphamidon (639), phosphocarb [CCN], sebufos (alternative name), selamectin (alternative name) [CCN], spinosad (737), terbam (alternative name), terbufos (773), tetrachlorothiophene (IUPAC/Chemical Abstracts name) (1422), thiafenox (alternative name), thionazin (1434), triazophos (820), triazuron (alternative name), xylenols [CCN], YI-5302 (compound code) and zeatin (alternative name) (210),
a nitrification inhibitor selected from the group of substances consisting of potassium ethylxanthate [CCN] and nitrapyrin (580),
a plant activator selected from the group of substances consisting of acibenzolar (6), acibenzolar-5-methyl (6), probenazole (658) and Reynoutria sachalinensis extract (alternative name) (720),
a rodenticide selected from the group of substances consisting of 2-isovalerylindan-1,3-dione (IUPAC name) (1246), 4-(quinoxalin-2-ylamino)benzenesulfonamide (IUPAC name) (748), alpha-chlorohydrin [CCN], aluminium phosphide (640), antu (880), arsenous oxide (882), barium carbonate (891), bisthiosemi (912), brodifacoum (89), bromadiolone (91), bromethalin (92), calcium cyamide (444), chloralose (127), chlorophacinone (140), cholecalciferol (alternative name) (850), coumachlor (1004), coumafuryl (1005), coumatetralyl (175), crimidine (1009), difenacoum (246), difethialone (249), diphacinone (273), ergocalciferol (301), flocoumafen (357), fluoroacetamide (379), flupropadine (1183), flupropadine hydrochloride (1183), gamma-HCH (430), HCH (430), hydrogen cyamide (444), iodomethane (IUPAC name) (542), lindane (430), magnesium phosphide (IUPAC name) (640), methyl bromide (537), norbormide (1318), phosacetim (1336), phosphine (IUPAC name) (640), phosphorus [CCN], pindone (1341), potassium arsenite [CCN], pyrinuron (1371), scilliroside (1390), sodium arsenite [CCN], sodium cyamide (444), sodium fluoro-acetate (735), strychnine (745), thallium sulfate [CCN], warfarin (851) and zinc phosphide (640),
a synergist selected from the group of substances consisting of 2-(2-butoxyethoxy)ethyl piperonylate (IUPAC name) (934), 5-(1,3-benzodioxol-5-yl)-3-hexylcyclohex-2-enone (IUPAC name) (903), farnesol with nerolidol (alternative name) (324), MB-599 (development code) (498), MGK 264 (development code) (296), piperonyl butoxide (649), piprotal (1343), propyl isomer (1358), S421 (development code) (724), sesamex (1393), sesasmolin (1394) and sulfoxide (1406),
an animal repellent selected from the group of substances consisting of anthraquinone (32), chloralose (127), copper naphthenate [CCN], copper oxychloride (171), diazinon (227), dicyclopentadiene (chemical name) (1069), guazatine (422), guazatine acetates (422), methiocarb (530), pyridin-4-amine (IUPAC name) (23), thiram (804), trimethacarb (840), zinc naphthenate [CCN] and ziram (856),
a virucide selected from the group of substances consisting of imanin (alternative name) [CCN] and ribavirin (alternative name) [CCN],
and a wound protectant selected from the group of substances consisting of mercuric oxide (512), octhilinone (590) and thiophanate-methyl (802).

A very especially preferred embodiment of the subject-matter {1.1.10} of the invention is {1.1.10.2} a pesticidal composition comprising a mixture consisting of at least two substances, namely one compound (A) and at least one compound (B), as active ingredient and at least one auxiliary, wherein the compound (A) is the compound of formula (A-10) and the compound (B) is a compound selected from the group of substances consisting of abamectin (1), cyromazine (209), diafenthiuron (226), diazinon (227), emamectin benzoate (291), fenoxycarb (340), fosthiazate (408), lambda-cyhalothrin (198), lufenuron (490), methidathion (529), profenofos (662), pymetrozine (688), tefluthrin (769) and thiamethoxam (792).

The compound of formula (A-10) is known, for example, from the PCT Application WO-03/015519.

A preferred embodiment of the subject-matter {1.1} of the invention is {1.1.11} a pesticidal composition comprising a mixture consisting of at least two substances, namely one compound (A) and at least one compound (B), as active ingredient and at least one auxiliary, wherein the compound (A) is the compound of formula (A-11) 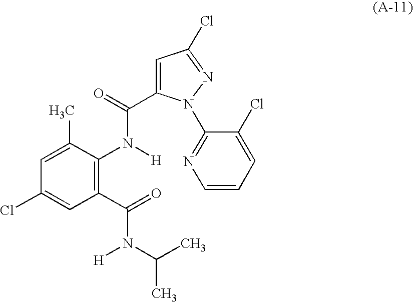
and the compound (B) is a compound selected from the group of substances consisting of an adjuvant, an acaricide, an algicide, an anthelmintic, an avicide, a bactericide, a biological agent, a soil sterilant, a chemosterilant, an insect pheromone, an insect repellent, an insecticide, a molluscicide, a nematicide, a nitrification inhibitor, a plant activator, a rodenticide, a synergist, an animal repellent, a virucide and a wound protectant.

An especially preferred embodiment of the subject-matter {1.1.11} of the invention is {1.1.11.1} a pesticidal composition comprising a mixture consisting of at least two substances, namely one compound (A) and at least one compound (B), as active ingredient and at least one auxiliary, wherein the compound (A) is the compound of formula (A-11) and the compound (B) is a compound selected from the group of substances consisting of
an adjuvant selected from the group of substances consisting of petroleum oils (alternative name) (628),
an acaricide selected from the group of substances consisting of 1,1-bis(4-chlorophenyl)-2-ethoxyethanol (IUPAC name) (910), 2,4-dichlorophenyl benzenesulfonate (IUPAC/Chemical Abstracts name) (1059), 2-fluoro-N-methyl-N-1-naphthylacetamide (IUPAC name) (1295), 4-chlorophenyl phenyl sulfone (IUPAC name) (981), abamectin (1), acequinocyl (3), acetoprole [CCN], acrinathrin (9), aldicarb (16), aldoxycarb (863), alpha-cypermethrin (202), amidithion (870), amidoflumet [CCN], amidothioate (872), amiton (875), amiton hydrogen oxalate (875), amitraz (24), aramite (881), arsenous oxide (882), AVI 382 (compound code), AZ 60541 (compound code), azinphos-ethyl (44), azinphos-methyl (45), azobenzene (IUPAC name) (888), azocyclotin (46), azothoate (889), benomyl (62), benoxafos (alternative name) [CCN], benzoximate (71), benzyl benzoate (IUPAC name) [CCN], bifenazate (74), bifenthrin (76), binapacryl (907), brofenvalerate (alternative name), bromocyclen (918), bromophos (920), bromophos-ethyl (921), bromopropylate (94), buprofezin (99), butocarboxim (103), butoxycarboxim (104), butylpyridaben (alternative name), calcium polysulfide (IUPAC name) (111), camphechlor (941), carbanolate (943), carbaryl (115), carbofuran (118), carbophenothion (947), CGA 50'439 (development code) (125), chinomethionat (126), chlorbenside (959), chlordimeform (964), chlordimeform hydrochloride (964), chlorfenapyr (130), chlorfenethol (968), chlorfenson (970), chlorfensulphide (971), chlorfenvinphos (131), chlorobenzilate (975), chloromebuform (977), chloromethiuron (978), chloropropylate (983), chlorpyrifos (145), chlorpyrifos-methyl (146), chlorthiophos (994), cinerin I (696), cinerin II (696), cinerins (696), clofentezine (158), closantel (alternative name) [CCN], coumaphos (174), crotamiton (alternative name) [CCN], crotoxyphos (1010), cufraneb (1013), cyanthoate (1020), cyhalothrin (196), cyhexatin (199), cypermethrin (201), DCPM (1032), DDT (219), demephion (1037), demephion-O (1037), demephion-S (1037), demeton (1038), demeton-methyl (224), demeton-O (1038), demeton-O-methyl (224), demeton-S (1038), demeton-5-methyl (224), demeton-5-methylsulphon (1039), diafenthiuron (226), dialifos (1042), diazinon (227), dichlofluanid (230), dichlorvos (236), dicliphos (alternative name), dicofol (242), dicrotophos (243), dienochlor (1071), dimefox (1081), dimethoate (262), dinactin (alternative name) (653), dinex (1089), dinex-diclexine (1089), dinobuton (269), dinocap (270), dinocap-4 [CCN], dinocap-6 [CCN], dinocton (1090), dinopenton (1092), dinosulfon (1097), dinoterbon (1098), dioxathion (1102), diphenyl sulfone (IUPAC name) (1103), disulfuram (alternative name) [CCN], disulfoton (278), DNOC (282), dofenapyn (1113), doramectin (alternative name) [CCN], endosulfan (294), endothion (1121), EPN (297), eprinomectin (alternative name) [CCN], ethion (309), ethoate-methyl (1134), etoxazole (320), etrimfos (1142), fenazaflor (1147), fenazaquin (328), fenbutatin oxide (330), fenothiocarb (337), fenpropathrin (342), fenpyrad (alternative name), fenpyroximate (345), fenson (1157), fentrifanil (1161), fenvalerate (349), fipronil (354), fluacrypyrim (360), fluazuron (1166), flubenzimine (1167), flucycloxuron (366), flucythrinate (367), fluenetil (1169), flufenoxuron (370), flumethrin (372), fluorbenside (1174), fluvalinate (1184), FMC 1137 (development code) (1185), formetanate (405), formetanate hydrochloride (405), formothion (1192), formparanate (1193), gamma-HCH (430), glyodin (1205), halfenprox (424), heptenophos (432), hexadecyl cyclopropanecarboxylate (IUPAC/Chemical Abstracts name) (1216), hexythiazox (441), iodomethane (IUPAC name) (542), isocarbophos (alternative name) (473), isopropyl O-(methoxyaminothiophosphoryl)salicylate (IUPAC name) (473), ivermectin (alternative name) [CCN], jasmolin I (696), jasmolin II (696), jodfenphos (1248), lindane (430), lufenuron (490), malathion (492), malonoben (1254), mecarbam (502), mephosfolan (1261), mesulfen (alternative name) [CCN], methacrifos (1266), methamidophos (527), methidathion (529), methiocarb (530), methomyl (531), methyl bromide (537), metolcarb (550), mevinphos (556), mexacarbate (1290), milbemectin (557), milbemycin oxime (alternative name) [CCN], mipafox (1293), monocrotophos (561), morphothion (1300), moxidectin (alternative name) [CCN], naled (567), NC-184 (compound code), nifluridide (1309), nikkomycins (alternative name) [CCN], nitrilacarb (1313), nitrilacarb 1:1 zinc chloride complex (1313), NNI-0101 (compound code), NNI-0250 (compound code), omethoate (594), oxamyl (602), oxydeprofos (1324), oxydisulfoton (1325), pp′-DDT (219), parathion (615), permethrin (626), petroleum oils (alternative name) (628), phenkapton (1330), phenthoate (631), phorate (636), phosalone (637), phosfolan (1338), phosmet (638), phosphamidon (639), phoxim (642), pirimiphos-methyl (652), polychloroterpenes (traditional name) (1347), polynactins (alternative name) (653), proclonol (1350), profenofos (662), promacyl (1354), propargite (671), propetamphos (673), propoxur (678), prothidathion (1360), prothoate (1362), pyrethrin I (696), pyrethrin II (696), pyrethrins (696), pyridaben (699), pyridaphenthion (701), pyrimidifen (706), pyrimitate (1370), quinalphos (711), quintiofos (1381), R-1492 (development code) (1382), RA-17 (development code) (1383), rotenone (722), schradan (1389), sebufos (alternative name), selamectin (alternative name) [CCN], SI-0009 (compound code), sophamide (1402), spirodiclofen (738), spiromesifen (739), SSI-121 (development code) (1404), sulfuram (alternative name) [CCN], sulfluramid (750), sulfotep (753), sulfur (754), SZI-121 (development code) (757), tau-fluvalinate (398), tebufenpyrad (763), TEPP (1417), terbam (alternative name), tetrachlorvinphos (777), tetradifon (786), tetranactin (alternative name) (653), tetrasul (1425), thiafenox (alternative name), thiocarboxime (1431), thiofanox (800), thiometon (801), thioquinox (1436), thuringiensin (alternative name) [CCN], triamiphos (1441), triarathene (1443), triazophos (820), triazuron (alternative name), trichlorfon (824), trifenofos (1455), trinactin (alternative name) (653), vamidothion (847), vaniliprole [CCN] and YI-5302 (compound code),
an algicide selected from the group of substances consisting of bethoxazin [CCN], copper dioctanoate (IUPAC name) (170), copper sulfate (172), cybutryne [CCN], dichlone (1052), dichlorophen (232), endothal (295), fentin (347), hydrated lime [CCN], nabam (566), quinoclamine (714), quinonamid (1379), simazine (730), triphenyltin acetate (IUPAC name) (347) and triphenyltin hydroxide (IUPAC name) (347),
an anthelmintic selected from the group of substances consisting of abamectin (1), crufomate (1011), doramectin (alternative name) [CCN], emamectin (291), emamectin benzoate (291), eprinomectin (alternative name) [CCN], ivermectin (alternative name) [CCN], milbemycin oxime (alternative name) [CCN], moxidectin (alternative name) [CCN], piperazine [CCN], selamectin (alternative name) [CCN], spinosad (737) and thiophanate (1435),
an avicide selected from the group of substances consisting of chloralose (127), endrin (1122), fenthion (346), pyridin-4-amine (IUPAC name) (23) and strychnine (745),
a bactericide selected from the group of substances consisting of 1-hydroxy-1H-pyridine-2-thione (IUPAC name) (1222), 4-(quinoxalin-2-ylamino)benzenesulfonamide (IUPAC name) (748), 8-hydroxyquinoline sulfate (446), bronopol (97), copper dioctanoate (IUPAC name) (170), copper hydroxide (IUPAC name) (169), cresol [CCN], dichlorophen (232), dipyrithione (1105), dodicin (1112), fenaminosulf (1144), formaldehyde (404), hydrargaphen (alternative name) [CCN], kasugamycin (483), kasugamycin hydrochloride hydrate (483), nickel bis(dimethyldithiocarbamate) (IUPAC name) (1308), nitrapyrin (580), octhilinone (590), oxolinic acid (606), oxytetracycline (611), potassium hydroxyquinoline sulfate (446), probenazole (658), streptomycin (744), streptomycin sesquisulfate (744), tecloftalam (766) and thiomersal (alternative name) [CCN],
a biological agent selected from the group of substances consisting of Adoxophyes orana GV (alternative name) (12), Agrobacterium radiobacter (alternative name) (13), Amblyseius spp. (alternative name) (19), Anagrapha falcifera NPV (alternative name) (28), Anagrus atomus (alternative name) (29), Aphelinus abdominalis (alternative name) (33), Aphidius colemani (alternative name) (34), Aphidoletes aphidimyza (alternative name) (35), Autographa californica NPV (alternative name) (38), Bacillus firmus (alternative name) (48), Bacillus sphaericus Neide (scientific name) (49), Bacillus thuringiensis Berliner (scientific name) (51), Bacillus thuringiensis subsp. aizawai (scientific name) (51), Bacillus thuringiensis subsp. israelensis (scientific name) (51), Bacillus thuringiensis subsp. japonensis (scientific name) (51), Bacillus thuringiensis subsp. kurstaki (scientific name) (51), Bacillus thuringiensis subsp. tenebrionis (scientific name) (51), Beauveria bassiana (alternative name) (53), Beauveria brongniartii (alternative name) (54), Chrysoperla carnea (alternative name) (151), Cryptolaemus montrouzieri (alternative name) (178), Cydia pomonella GV (alternative name) (191), Dacnusa sibirica (alternative name) (212), Diglyphus isaea (alternative name) (254), Encarsia formosa (scientific name) (293), Eretmocerus eremicus (alternative name) (300), Helicoverpa zea NPV (alternative name) (431), Heterorhabditis bacteriophora and H. megidis (alternative name) (433), Hippodamia convergens (alternative name) (442), Leptomastix dactylopii (alternative name) (488), Macrolophus caliginosus (alternative name) (491), Mamestra brassicae NPV (alternative name) (494), Metaphycus helvolus (alternative name) (522), Metarhizium anisopliae var. acridum (scientific name) (523), Metarhizium anisopliae var. anisopliae (scientific name) (523), Neodiprion sertifer NPV and N. lecontei NPV (alternative name) (575), Orius spp. (alternative name) (596), Paecilomyces fumosoroseus (alternative name) (613), Phytoseiulus persimilis (alternative name) (644), Spodoptera exigua multicapsid nuclear polyhedrosis virus (scientific name) (741), Steinernema bibionis (alternative name) (742), Steinernema carpocapsae (alternative name) (742), Steinernema feltiae (alternative name) (742), Steinernema glaseri (alternative name) (742), Steinernema riobrave (alternative name) (742), Steinernema riobravis (alternative name) (742), Steinernema scapterisci (alternative name) (742), Steinernema spp. (alternative name) (742), Trichogramma spp. (alternative name) (826), Typhlodromus occidentalis (alternative name) (844) and Verticillium lecanii (alternative name) (848),
a soil sterilant selected from the group of substances consisting of iodomethane (IUPAC name) (542) and methyl bromide (537),
a chemosterilant selected from the group of substances consisting of apholate [CCN], bisazir (alternative name) [CCN], busulfan (alternative name) [CCN], diflubenzuron (250), dimatif (alternative name) [CCN], hemel [CCN], hempa [CCN], metepa [CCN], methiotepa [CCN], methyl apholate [CCN], morzid [CCN], penfluoron (alternative name) [CCN], tepa [CCN], thiohempa (alternative name) [CCN], thiotepa (alternative name) [CCN], tretamine (alternative name) [CCN] and uredepa (alternative name) [CCN],
an insect pheromone selected from the group of substances consisting of (E)-dec-5-en-1-yl acetate with (E)-dec-5-en-1-ol (IUPAC name) (222), (E)-tridec-4-en-1-yl acetate (IUPAC name) (829), (E)-6-methylhept-2-en-4-ol (IUPAC name) (541), (E,Z)-tetradeca-4,10-dien-1-yl acetate (IUPAC name) (779), (Z)-dodec-7-en-1-yl acetate (IUPAC name) (285), (Z)-hexadec-11-enal (IUPAC name) (436), (Z)-hexadec-11-en-1-yl acetate (IUPAC name) (437), (Z)-hexadec-13-en-11-yn-1-yl acetate (IUPAC name) (438), (Z)-icos-13-en-10-one (IUPAC name) (448), (Z)-tetradec-7-en-1-al (IUPAC name) (782), (Z)-tetradec-9-en-1-ol (IUPAC name) (783), (Z)-tetradec-9-en-1-yl acetate (IUPAC name) (784), (7E,9Z)-dodeca-7,9-dien-1-yl acetate (IUPAC name) (283), (9Z,11E)-tetradeca-9,11-dien-1-yl acetate (IUPAC name) (780), (9Z,12E)-tetradeca-9,12-dien-1-yl acetate (IUPAC name) (781), 14-methyloctadec-1-ene (IUPAC name) (545), 4-methylnonan-5-ol with 4-methylnonan-5-one (IUPAC name) (544), alpha-multistriatin (alternative name) [CCN], brevicomin (alternative name) [CCN], codlelure (alternative name) [CCN], codlemone (alternative name) (167), cuelure (alternative name) (179), disparlure (277), dodec-8-en-1-yl acetate (IUPAC name) (286), dodec-9-en-1-yl acetate (IUPAC name) (287), dodeca-8,10-dien-1-yl acetate (IUPAC name) (284), dominicalure (alternative name) [CCN], ethyl 4-methyloctanoate (IUPAC name) (317), eugenol (alternative name) [CCN], frontalin (alternative name) [CCN], gossyplure (alternative name) (420), grandlure (421), grandlure I (alternative name) (421), grandlure II (alternative name) (421), grandlure III (alternative name) (421), grandlure IV (alternative name) (421), hexylure [CCN], ipsdienol (alternative name) [CCN], ipsenol (alternative name) [CCN], japonilure (alternative name) (481), lineatin (alternative name) [CCN], litlure (alternative name) [CCN], looplure (alternative name) [CCN], medlure [CCN], megatomoic acid (alternative name) [CCN], methyl eugenol (alternative name) (540), muscalure (563), octadeca-2,13-dien-1-yl acetate (IUPAC name) (588), octadeca-3,13-dien-1-yl acetate (IUPAC name) (589), orfralure (alternative name) [CCN], oryctalure (alternative name) (317), ostramone (alternative name) [CCN], siglure [CCN], sordidin (alternative name) (736), sulcatol (alternative name) [CCN], tetradec-11-en-1-yl acetate (IUPAC name) (785), trimedlure (839), trimedlure A (alternative name) (839), trimedlure B₁ (alternative name) (839), trimedlure B₂ (alternative name) (839), trimedlure C (alternative name) (839) and trunc-call (alternative name) [CCN],
an insect repellent selected from the group of substances consisting of 2-(octylthio)-ethanol (IUPAC name) (591), butopyronoxyl (933), butoxy(polypropylene glycol) (936), dibutyl adipate (IUPAC name) (1046), dibutyl phthalate (1047), dibutyl succinate (IUPAC name) (1048), diethyltoluamide [CCN], dimethyl carbate [CCN], dimethyl phthalate [CCN], ethyl hexanediol (1137), hexamide [CCN], methoquin-butyl (1276), methylneodecanamide [CCN], oxamate [CCN] and picaridin [CCN],
an insecticide selected from the group of substances consisting of 1,1-dichloro-1-nitroethane (IUPAC/Chemical Abstracts name) (1058), 1,1-dichloro-2,2-bis(4-ethylphenyl)-ethane (IUPAC name) (1056), 1,2-dichloropropane (IUPAC/Chemical Abstracts name) (1062), 1,2-dichloropropane with 1,3-dichloropropene (IUPAC name) (1063), 1-bromo-2-chloroethane (IUPAC/Chemical Abstracts name) (916), 2,2,2-trichloro-1-(3,4-dichloro-phenyl)ethyl acetate (IUPAC name) (1451), 2,2-dichlorovinyl 2-ethylsulfinylethyl methyl phosphate (IUPAC name) (1066), 2-(1,3-dithiolan-2-yl)phenyl dimethylcarbamate (IUPAC/Chemical Abstracts name) (1109), 2-(2-butoxyethoxy)ethyl thiocyanate (IUPAC/Chemical Abstracts name) (935), 2-(4,5-dimethyl-1,3-dioxolan-2-yl)phenyl methylcarbamate (IUPAC/Chemical Abstracts name) (1084), 2-(4-chloro-3,5-xylyloxy)ethanol (IUPAC name) (986), 2-chlorovinyl diethyl phosphate (IUPAC name) (984), 2-imidazolidone (IUPAC name) (1225), 2-isovalerylindan-1,3-dione (IUPAC name) (1246), 2-methyl(prop-2-ynyl)aminophenyl methylcarbamate (IUPAC name) (1284), 2-thiocyanatoethyl laurate (IUPAC name) (1433), 3-bromo-1-chloroprop-1-ene (IUPAC name) (917), 3-methyl-1-phenylpyrazol-5-yl dimethyl-carbamate (IUPAC name) (1283), 4-methyl(prop-2-ynyl)amino-3,5-xylyl methylcarbamate (IUPAC name) (1285), 5,5-dimethyl-3-oxocyclohex-1-enyl dimethylcarbamate (IUPAC name) (1085), abamectin (1), acephate (2), acetamiprid (4), acethion (alternative name) [CCN], acetoprole [CCN], acrinathrin (9), acrylonitrile (IUPAC name) (861), alanycarb (15), aldicarb (16), aldoxycarb (863), aldrin (864), allethrin (17), allosamidin (alternative name) [CCN], allyxycarb (866), alpha-cypermethrin (202), alpha-ecdysone (alternative name) [CCN], aluminium phosphide (640), amidithion (870), amidothioate (872), aminocarb (873), amiton (875), amiton hydrogen oxalate (875), amitraz (24), anabasine (877), athidathion (883), AVI 382 (compound code), AZ 60541 (compound code), azadirachtin (alternative name) (41), azamethiphos (42), azinphos-ethyl (44), azinphos-methyl (45), azothoate (889), Bacillus thuringiensis delta endotoxins (alternative name) (52), barium hexafluorosilicate (alternative name) [CCN], barium polysulfide (IUPAC/Chemical Abstracts name) (892), barthrin [CCN], BAS 320 I (compound code), Bayer 22/190 (development code) (893), Bayer 22408 (development code) (894), bendiocarb (58), benfuracarb (60), bensultap (66), beta-cyfluthrin (194), beta-cypermethrin (203), bifenthrin (76), bioallethrin (78), bioallethrin S-cyclopentenyl isomer (alternative name) (79), bioethanomethrin [CCN], biopermethrin (908), bioresmethrin (80), bis(2-chloroethyl)ether (IUPAC name) (909), bistrifluoron (83), borax (86), brofenvalerate (alternative name), bromfenvinfos (914), bromocyclen (918), bromo-DDT (alternative name) [CCN], bromophos (920), bromophos-ethyl (921), bufencarb (924), buprofezin (99), butacarb (926), butathiofos (927), butocarboxim (103), butonate (932), butoxycarboxim (104), butylpyridaben (alternative name), cadusafos (109), calcium arsenate [CCN], calcium cyamide (444), calcium polysulfide (IUPAC name) (111), camphechlor (941), carbanolate (943), carbaryl (115), carbofuran (118), carbon disulfide (IUPAC/Chemical Abstracts name) (945), carbon tetrachloride (IUPAC name) (946), carbophenothion (947), carbosulfan (119), cartap (123), cartap hydrochloride (123), cevadine (alternative name) (725), chlorbicyclen (960), chlordane (128), chlordecone (963), chlordimeform (964), chlordimeform hydrochloride (964), chlorethoxyfos (129), chlorfenapyr (130), chlorfenvinphos (131), chlorfluazuron (132), chlormephos (136), chloroform [CCN], chloropicrin (141), chlorphoxim (989), chlorprazophos (990), chlorpyrifos (145), chlorpyrifos-methyl (146), chlorthiophos (994), chromafenozide (150), cinerin I (696), cinerin II (696), cinerins (696), cis-resmethrin (alternative name), cismethrin (80), clocythrin (alternative name), cloethocarb (999), closantel (alternative name) [CCN], clothianidin (165), copper acetoarsenite [CCN], copper arsenate [CCN], copper oleate [CCN], coumaphos (174), coumithoate (1006), crotamiton (alternative name) [CCN], crotoxyphos (1010), crufomate (1011), cryolite (alternative name) (177), CS 708 (development code) (1012), cyanofenphos (1019), cyanophos (184), cyanthoate (1020), cyclethrin [CCN], cycloprothrin (188), cyfluthrin (193), cyhalothrin (196), cypermethrin (201), cyphenothrin (206), cyromazine (209), cythioate (alternative name) [CCN], d-limonene (alternative name) [CCN], d-tetramethrin (alternative name) (788), DAEP (1031), dazomet (216), DDT (219), decarbofuran (1034), deltamethrin (223), demephion (1037), demephion-O (1037), demephion-S (1037), demeton (1038), demeton-methyl (224), demeton-O (1038), demeton-O-methyl (224), demeton-S (1038), demeton-5-methyl (224), demeton-5-methylsulphon (1039), diafenthiuron (226), dialifos (1042), diamidafos (1044), diazinon (227), dicapthon (1050), dichlofenthion (1051), dichlorvos (236), dicliphos (alternative name), dicresyl (alternative name) [CCN], dicrotophos (243), dicyclanil (244), dieldrin (1070), diethyl 5-methylpyrazol-3-yl phosphate (IUPAC name) (1076), diflubenzuron (250), dilor (alternative name) [CCN], dimefluthrin [CCN], dimefox (1081), dimetan (1085), dimethoate (262), dimethrin (1083), dimethylvinphos (265), dimetilan (1086), dinex (1089), dinex-diclexine (1089), dinoprop (1093), dinosam (1094), dinoseb (1095), dinotefuran (271), diofenolan (1099), dioxabenzofos (1100), dioxacarb (1101), dioxathion (1102), disulfoton (278), dithicrofos (1108), DNOC (282), doramectin (alternative name) [CCN], DSP (1115), ecdysterone (alternative name) [CCN], EI 1642 (development code) (1118), emamectin (291), emamectin benzoate (291), EMPC (1120), empenthrin (292), endosulfan (294), endothion (1121), endrin (1122), EPBP (1123), EPN (297), epofenonane (1124), eprinomectin (alternative name) [CCN], esfenvalerate (302), etaphos (alternative name) [CCN], ethiofencarb (308), ethion (309), ethiprole (310), ethoate-methyl (1134), ethoprophos (312), ethyl formate (IUPAC name) [CCN], ethyl-DDD (alternative name) (1056), ethylene dibromide (316), ethylene dichloride (chemical name) (1136), ethylene oxide [CCN], etofenprox (319), etrimfos (1142), EXD (1143), famphur (323), fenamiphos (326), fenazaflor (1147), fenchlorphos (1148), fenethacarb (1149), fenfluthrin (1150), fenitrothion (335), fenobucarb (336), fenoxacrim (1153), fenoxycarb (340), fenpirithrin (1155), fenpropathrin (342), fenpyrad (alternative name), fensulfothion (1158), fenthion (346), fenthion-ethyl [CCN], fenvalerate (349), fipronil (354), flonicamid (358), flucofuron (1168), flucycloxuron (366), flucythrinate (367), fluenetil (1169), flufenerim [CCN], flufenoxuron (370), flufenprox (1171), flumethrin (372), fluvalinate (1184), FMC 1137 (development code) (1185), fonofos (1191), formetanate (405), formetanate hydrochloride (405), formothion (1192), formparanate (1193), fosmethilan (1194), fospirate (1195), fosthiazate (408), fosthietan (1196), furathiocarb (412), furethrin (1200), gamma-cyhalothrin (197), gamma-HCH (430), guazatine (422), guazatine acetates (422), GY-81 (development code) (423), halfenprox (424), halofenozide (425), HCH (430), HEOD (1070), heptachlor (1211), heptenophos (432), heterophos [CCN], hexaflumuron (439), HHDN (864), hydramethylnon (443), hydrogen cyamide (444), hydroprene (445), hyquincarb (1223), imidacloprid (458), imiprothrin (460), indoxacarb (465), iodomethane (IUPAC name) (542), IPSP (1229), isazofos (1231), isobenzan (1232), isocarbophos (alternative name) (473), isodrin (1235), isofenphos (1236), isolane (1237), isoprocarb (472), isopropyl O-(methoxyaminothiophosphoryl)salicylate (IUPAC name) (473), isoprothiolane (474), isothioate (1244), isoxathion (480), ivermectin (alternative name) [CCN], jasmolin I (696), jasmolin II (696), jodfenphos (1248), juvenile hormone I (alternative name) [CCN], juvenile hormone II (alternative name) [CCN], juvenile hormone III (alternative name) [CCN], kelevan (1249), kinoprene (484), lambda-cyhalothrin (198), lead arsenate [CCN], leptophos (1250), lindane (430), lirimfos (1251), lufenuron (490), lythidathion (1253), m-cumenyl methylcarbamate (IUPAC name) (1014), magnesium phosphide (IUPAC name) (640), malathion (492), malonoben (1254), mazidox (1255), mecarbam (502), mecarphon (1258), menazon (1260), mephosfolan (1261), mercurous chloride (513), mesulfenfos (1263), metam (519), metam-potassium (alternative name) (519), metam-sodium (519), methacrifos (1266), methamidophos (527), methanesulfonyl fluoride (IUPAC/Chemical Abstracts name) (1268), methidathion (529), methiocarb (530), methocrotophos (1273), methomyl (531), methoprene (532), methoquin-butyl (1276), methothrin (alternative name) (533), methoxychlor (534), methoxyfenozide (535), methyl bromide (537), methyl isothiocyanate (543), methylchloroform (alternative name) [CCN], methylene chloride [CCN], metofluthrin [CCN], metolcarb (550), metoxadiazone (1288), mevinphos (556), mexacarbate (1290), milbemectin (557), milbemycin oxime (alternative name) [CCN], mipafox (1293), mirex (1294), monocrotophos (561), morphothion (1300), moxidectin (alternative name) [CCN], naftalofos (alternative name) [CCN], naled (567), naphthalene (IUPAC/Chemical Abstracts name) (1303), NC-170 (development code) (1306), NC-184 (compound code), nicotine (578), nicotine sulfate (578), nifluridide (1309), nitenpyram (579), nithiazine (1311), nitrilacarb (1313), nitrilacarb 1:1 zinc chloride complex (1313), NNI-0101 (compound code), NNI-0250 (compound code), nornicotine (traditional name) (1319), novaluron (585), noviflumuron (586), O-2,5-dichloro-4-iodophenyl O-ethyl ethylphosphonothioate (IUPAC name) (1057), O,O-diethyl O-4-methyl-2-oxo-2H-chromen-7-yl phosphorothioate (IUPAC name) (1074), O,O-diethyl O-6-methyl-2-propylpyrimidin-4-yl phosphorothioate (IUPAC name) (1075), O,O,O′,O′-tetrapropyl dithiopyrophosphate (IUPAC name) (1424), oleic acid (IUPAC name) (593), omethoate (594), oxamyl (602), oxydemeton-methyl (609), oxydeprofos (1324), oxydisulfoton (1325), pp′-DDT (219), para-dichlorobenzene [CCN], parathion (615), parathion-methyl (616), penfluoron (alternative name) [CCN], pentachlorophenol (623), pentachlorophenyl laurate (IUPAC name) (623), permethrin (626), petroleum oils (alternative name) (628), PH 60-38 (development code) (1328), phenkapton (1330), phenothrin (630), phenthoate (631), phorate (636), phosalone (637), phosfolan (1338), phosmet (638), phosnichlor (1339), phosphamidon (639), phosphine (IUPAC name) (640), phoxim (642), phoxim-methyl (1340), pirimetaphos (1344), pirimicarb (651), pirimiphos-ethyl (1345), pirimiphos-methyl (652), polychlorodicyclopentadiene isomers (IUPAC name) (1346), polychloroterpenes (traditional name) (1347), potassium arsenite [CCN], potassium thiocyanate [CCN], prallethrin (655), precocene I (alternative name) [CCN], precocene II (alternative name) [CCN], precocene III (alternative name) [CCN], primidophos (1349), profenofos (662), profluthrin [CCN], promacyl (1354), promecarb (1355), propaphos (1356), propetamphos (673), propoxur (678), prothidathion (1360), prothiofos (686), prothoate (1362), protrifenbute [CCN], pymetrozine (688), pyraclofos (689), pyrazophos (693), pyresmethrin (1367), pyrethrin I (696), pyrethrin II (696), pyrethrins (696), pyridaben (699), pyridalyl (700), pyridaphenthion (701), pyrimidifen (706), pyrimitate (1370), pyriproxyfen (708), quassia (alternative name) [CCN], quinalphos (711), quinalphos-methyl (1376), quinothion (1380), quintiofos (1381), R-1492 (development code) (1382), rafoxanide (alternative name) [CCN], resmethrin (719), rotenone (722), RU 15525 (development code) (723), RU 25475 (development code) (1386), ryania (alternative name) (1387), ryanodine (traditional name) (1387), sabadilla (alternative name) (725), schradan (1389), sebufos (alternative name), selamectin (alternative name) [CCN], SI-0009 (compound code), silafluofen (728), SN 72129 (development code) (1397), sodium arsenite [CCN], sodium cyamide (444), sodium fluoride (IUPAC/Chemical Abstracts name) (1399), sodium hexafluorosilicate (1400), sodium pentachlorophenoxide (623), sodium selenate (IUPAC name) (1401), sodium thiocyanate [CCN], sophamide (1402), spinosad (737), spiromesifen (739), sulcofuron (746), sulcofuron-sodium (746), sulfluramid (750), sulfotep (753), sulfuryl fluoride (756), sulprofos (1408), tar oils (alternative name) (758), tau-fluvalinate (398), tazimcarb (1412), TDE (1414), tebufenozide (762), tebufenpyrad (763), tebupirimfos (764), teflubenzuron (768), tefluthrin (769), temephos (770), TEPP (1417), terallethrin (1418), terbam (alternative name), terbufos (773), tetrachloroethane [CCN], tetrachlorvinphos (777), tetramethrin (787), theta-cypermethrin (204), thiacloprid (791), thiafenox (alternative name), thiamethoxam (792), thicrofos (1428), thiocarboxime (1431), thiocyclam (798), thiocyclam hydrogen oxalate (798), thiodicarb (799), thiofanox (800), thiometon (801), thionazin (1434), thiosultap (803), thiosultap-sodium (803), thuringiensin (alternative name) [CCN], tolfenpyrad (809), tralomethrin (812), transfluthrin (813), transpermethrin (1440), triamiphos (1441), triazamate (818), triazophos (820), triazuron (alternative name), trichlorfon (824), trichlormetaphos-3 (alternative name) [CCN], trichloronat (1452), trifenofos (1455), triflumuron (835), trimethacarb (840), triprene (1459), vamidothion (847), vaniliprole [CCN], veratridine (alternative name) (725), veratrine (alternative name) (725), XMC (853), xylylcarb (854), YI-5302 (compound code), zeta-cypermethrin (205), zetamethrin (alternative name), zinc phosphide (640), zolaprofos (1469) and ZXI 8901 (development code) (858),
a molluscicide selected from the group of substances consisting of bis(tributyltin)oxide (IUPAC name) (913), bromoacetamide [CCN], calcium arsenate [CCN], cloethocarb (999), copper acetoarsenite [CCN], copper sulfate (172), fentin (347), ferric phosphate (IUPAC name) (352), metaldehyde (518), methiocarb (530), niclosamide (576), niclosamide-olamine (576), pentachlorophenol (623), sodium pentachlorophenoxide (623), tazimcarb (1412), thiodicarb (799), tributyltin oxide (913), trifenmorph (1454), trimethacarb (840), triphenyltin acetate (IUPAC name) (347) and triphenyltin hydroxide (IUPAC name) (347),
a nematicide selected from the group of substances consisting of 1,2-dibromo-3-chloropropane (IUPAC/Chemical Abstracts name) (1045), 1,2-dichloropropane (IUPAC/Chemical Abstracts name) (1062), 1,2-dichloropropane with 1,3-dichloropropene (IUPAC name) (1063), 1,3-dichloropropene (233), 3,4-dichlorotetrahydrothiophene 1,1-dioxide (IUPAC/Chemical Abstracts name) (1065), 3-(4-chlorophenyl)-5-methylrhodanine (IUPAC name) (980), 5-methyl-6-thioxo-1,3,5-thiadiazinan-3-ylacetic acid (IUPAC name) (1286), 6-isopentenylaminopurine (alternative name) (210), abamectin (1), acetoprole [CCN], alanycarb (15), aldicarb (16), aldoxycarb (863), AZ 60541 (compound code), benclothiaz [CCN], benomyl (62), butylpyridaben (alternative name), cadusafos (109), carbofuran (118), carbon disulfide (945), carbosulfan (119), chloropicrin (141), chlorpyrifos (145), cloethocarb (999), cytokinins (alternative name) (210), dazomet (216), DBCP (1045), DCIP (218), diamidafos (1044), dichlofenthion (1051), dicliphos (alternative name), dimethoate (262), doramectin (alternative name) [CCN], emamectin (291), emamectin benzoate (291), eprinomectin (alternative name) [CCN], ethoprophos (312), ethylene dibromide (316), fenamiphos (326), fenpyrad (alternative name), fensulfothion (1158), fosthiazate (408), fosthietan (1196), furfural (alternative name) [CCN], GY-81 (development code) (423), heterophos [CCN], iodomethane (IUPAC name) (542), isamidofos (1230), isazofos (1231), ivermectin (alternative name) [CCN], kinetin (alternative name) (210), mecarphon (1258), metam (519), metam-potassium (alternative name) (519), metam-sodium (519), methyl bromide (537), methyl isothiocyanate (543), milbemycin oxime (alternative name) [CCN], moxidectin (alternative name) [CCN], Myrothecium verrucaria composition (alternative name) (565), NC-184 (compound code), oxamyl (602), phorate (636), phosphamidon (639), phosphocarb [CCN], sebufos (alternative name), selamectin (alternative name) [CCN], spinosad (737), terbam (alternative name), terbufos (773), tetrachlorothiophene (IUPAC/Chemical Abstracts name) (1422), thiafenox (alternative name), thionazin (1434), triazophos (820), triazuron (alternative name), xylenols [CCN], YI-5302 (compound code) and zeatin (alternative name) (210),
a nitrification inhibitor selected from the group of substances consisting of potassium ethylxanthate [CCN] and nitrapyrin (580),
a plant activator selected from the group of substances consisting of acibenzolar (6), acibenzolar-5-methyl (6), probenazole (658) and Reynoutria sachalinensis extract (alternative name) (720),
a rodenticide selected from the group of substances consisting of 2-isovalerylindan-1,3-dione (IUPAC name) (1246), 4-(quinoxalin-2-ylamino)benzenesulfonamide (IUPAC name) (748), alpha-chlorohydrin [CCN], aluminium phosphide (640), antu (880), arsenous oxide (882), barium carbonate (891), bisthiosemi (912), brodifacoum (89), bromadiolone (91), bromethalin (92), calcium cyamide (444), chloralose (127), chlorophacinone (140), cholecalciferol (alternative name) (850), coumachlor (1004), coumafuryl (1005), coumatetralyl (175), crimidine (1009), difenacoum (246), difethialone (249), diphacinone (273), ergocalciferol (301), flocoumafen (357), fluoroacetamide (379), flupropadine (1183), flupropadine hydrochloride (1183), gamma-HCH (430), HCH (430), hydrogen cyamide (444), iodomethane (IUPAC name) (542), lindane (430), magnesium phosphide (IUPAC name) (640), methyl bromide (537), norbormide (1318), phosacetim (1336), phosphine (IUPAC name) (640), phosphorus [CCN], pindone (1341), potassium arsenite [CCN], pyrinuron (1371), scilliroside (1390), sodium arsenite [CCN], sodium cyamide (444), sodium fluoro-acetate (735), strychnine (745), thallium sulfate [CCN], warfarin (851) and zinc phosphide (640),
a synergist selected from the group of substances consisting of 2-(2-butoxyethoxy)ethyl piperonylate (IUPAC name) (934), 5-(1,3-benzodioxol-5-yl)-3-hexylcyclohex-2-enone (IUPAC name) (903), farnesol with nerolidol (alternative name) (324), MB-599 (development code) (498), MGK 264 (development code) (296), piperonyl butoxide (649), piprotal (1343), propyl isomer (1358), S421 (development code) (724), sesamex (1393), sesasmolin (1394) and sulfoxide (1406),
an animal repellent selected from the group of substances consisting of anthraquinone (32), chloralose (127), copper naphthenate [CCN], copper oxychloride (171), diazinon (227), dicyclopentadiene (chemical name) (1069), guazatine (422), guazatine acetates (422), methiocarb (530), pyridin-4-amine (IUPAC name) (23), thiram (804), trimethacarb (840), zinc naphthenate [CCN] and ziram (856),
a virucide selected from the group of substances consisting of imanin (alternative name) [CCN] and ribavirin (alternative name) [CCN],
and a wound protectant selected from the group of substances consisting of mercuric oxide (512), octhilinone (590) and thiophanate-methyl (802).

A very especially preferred embodiment of the subject-matter {1.1.11} of the invention is {1.1.11.2} a pesticidal composition comprising a mixture consisting of at least two substances, namely one compound (A) and at least one compound (B), as active ingredient and at least one auxiliary, wherein the compound (A) is the compound of formula (A-11) and the compound (B) is a compound selected from the group of substances consisting of abamectin (1), cyromazine (209), diafenthiuron (226), diazinon (227), emamectin benzoate (291), fenoxycarb (340), fosthiazate (408), lambda-cyhalothrin (198), lufenuron (490), methidathion (529), profenofos (662), pymetrozine (688), tefluthrin (769) and thiamethoxam (792).

The compound of formula (A-11) is known, for example, from the PCT Application WO-03/015519.

A preferred embodiment of the subject-matter {1.1} of the invention is {1.1.12} a pesticidal composition comprising a mixture consisting of at least two substances, namely one compound (A) and at least one compound (B), as active ingredient and at least one auxiliary, wherein the compound (A) is the compound of formula (A-12) 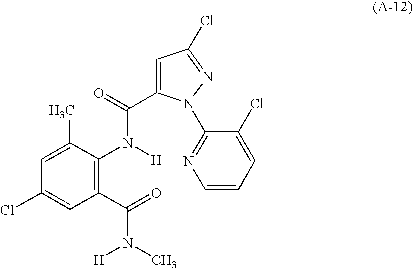
and the compound (B) is a compound selected from the group of substances consisting of an adjuvant, an acaricide, an algicide, an anthelmintic, an avicide, a bactericide, a biological agent, a soil sterilant, a chemosterilant, an insect pheromone, an insect repellent, an insecticide, a molluscicide, a nematicide, a nitrification inhibitor, a plant activator, a rodenticide, a synergist, an animal repellent, a virucide and a wound protectant.

An especially preferred embodiment of the subject-matter {1.1.12} of the invention is {1.1.12.1} a pesticidal composition comprising a mixture consisting of at least two substances, namely one compound (A) and at least one compound (B), as active ingredient and at least one auxiliary, wherein the compound (A) is the compound of formula (A-12) and the compound (B) is a compound selected from the group of substances consisting of
an adjuvant selected from the group of substances consisting of petroleum oils (alternative name) (628),
an acaricide selected from the group of substances consisting of 1,1-bis(4-chlorophenyl)-2-ethoxyethanol (IUPAC name) (910), 2,4-dichlorophenyl benzenesulfonate (IUPAC/Chemical Abstracts name) (1059), 2-fluoro-N-methyl-N-1-naphthylacetamide (IUPAC name) (1295), 4-chlorophenyl phenyl sulfone (IUPAC name) (981), abamectin (1), acequinocyl (3), acetoprole [CCN], acrinathrin (9), aldicarb (16), aldoxycarb (863), alpha-cypermethrin (202), amidithion (870), amidoflumet [CCN], amidothioate (872), amiton (875), amiton hydrogen oxalate (875), amitraz (24), aramite (881), arsenous oxide (882), AVI 382 (compound code), AZ 60541 (compound code), azinphos-ethyl (44), azinphos-methyl (45), azobenzene (IUPAC name) (888), azocyclotin (46), azothoate (889), benomyl (62), benoxafos (alternative name) [CCN], benzoximate (71), benzyl benzoate (IUPAC name) [CCN], bifenazate (74), bifenthrin (76), binapacryl (907), brofenvalerate (alternative name), bromocyclen (918), bromophos (920), bromophos-ethyl (921), bromopropylate (94), buprofezin (99), butocarboxim (103), butoxycarboxim (104), butylpyridaben (alternative name), calcium polysulfide (IUPAC name) (111), camphechlor (941), carbanolate (943), carbaryl (115), carbofuran (118), carbophenothion (947), CGA 50'439 (development code) (125), chinomethionat (126), chlorbenside (959), chlordimeform (964), chlordimeform hydrochloride (964), chlorfenapyr (130), chlorfenethol (968), chlorfenson (970), chlorfensulphide (971), chlorfenvinphos (131), chlorobenzilate (975), chloromebuform (977), chloromethiuron (978), chloropropylate (983), chlorpyrifos (145), chlorpyrifos-methyl (146), chlorthiophos (994), cinerin I (696), cinerin II (696), cinerins (696), clofentezine (158), closantel (alternative name) [CCN], coumaphos (174), crotamiton (alternative name) [CCN], crotoxyphos (1010), cufraneb (1013), cyanthoate (1020), cyhalothrin (196), cyhexatin (199), cypermethrin (201), DCPM (1032), DDT (219), demephion (1037), demephion-O (1037), demephion-S (1037), demeton (1038), demeton-methyl (224), demeton-O (1038), demeton-O-methyl (224), demeton-S (1038), demeton-5-methyl (224), demeton-5-methylsulphon (1039), diafenthiuron (226), dialifos (1042), diazinon (227), dichlofluanid (230), dichlorvos (236), dicliphos (alternative name), dicofol (242), dicrotophos (243), dienochlor (1071), dimefox (1081), dimethoate (262), dinactin (alternative name) (653), dinex (1089), dinex-diclexine (1089), dinobuton (269), dinocap (270), dinocap-4 [CCN], dinocap-6 [CCN], dinocton (1090), dinopenton (1092), dinosulfon (1097), dinoterbon (1098), dioxathion (1102), diphenyl sulfone (IUPAC name) (1103), disulfuram (alternative name) [CCN], disulfoton (278), DNOC (282), dofenapyn (1113), doramectin (alternative name) [CCN], endosulfan (294), endothion (1121), EPN (297), eprinomectin (alternative name) [CCN], ethion (309), ethoate-methyl (1134), etoxazole (320), etrimfos (1142), fenazaflor (1147), fenazaquin (328), fenbutatin oxide (330), fenothiocarb (337), fenpropathrin (342), fenpyrad (alternative name), fenpyroximate (345), fenson (1157), fentrifanil (1161), fenvalerate (349), fipronil (354), fluacrypyrim (360), fluazuron (1166), flubenzimine (1167), flucycloxuron (366), flucythrinate (367), fluenetil (1169), flufenoxuron (370), flumethrin (372), fluorbenside (1174), fluvalinate (1184), FMC 1137 (development code) (1185), formetanate (405), formetanate hydrochloride (405), formothion (1192), formparanate (1193), gamma-HCH (430), glyodin (1205), halfenprox (424), heptenophos (432), hexadecyl cyclopropanecarboxylate (IUPAC/Chemical Abstracts name) (1216), hexythiazox (441), iodomethane (IUPAC name) (542), isocarbophos (alternative name) (473), isopropyl O-(methoxyaminothiophosphoryl)salicylate (IUPAC name) (473), ivermectin (alternative name) [CCN], jasmolin I (696), jasmolin II (696), jodfenphos (1248), lindane (430), lufenuron (490), malathion (492), malonoben (1254), mecarbam (502), mephosfolan (1261), mesulfen (alternative name) [CCN], methacrifos (1266), methamidophos (527), methidathion (529), methiocarb (530), methomyl (531), methyl bromide (537), metolcarb (550), mevinphos (556), mexacarbate (1290), milbemectin (557), milbemycin oxime (alternative name) [CCN], mipafox (1293), monocrotophos (561), morphothion (1300), moxidectin (alternative name) [CCN], naled (567), NC-184 (compound code), nifluridide (1309), nikkomycins (alternative name) [CCN], nitrilacarb (1313), nitrilacarb 1:1 zinc chloride complex (1313), NNI-0101 (compound code), NNI-0250 (compound code), omethoate (594), oxamyl (602), oxydeprofos (1324), oxydisulfoton (1325), pp′-DDT (219), parathion (615), permethrin (626), petroleum oils (alternative name) (628), phenkapton (1330), phenthoate (631), phorate (636), phosalone (637), phosfolan (1338), phosmet (638), phosphamidon (639), phoxim (642), pirimiphos-methyl (652), polychloroterpenes (traditional name) (1347), polynactins (alternative name) (653), proclonol (1350), profenofos (662), promacyl (1354), propargite (671), propetamphos (673), propoxur (678), prothidathion (1360), prothoate (1362), pyrethrin I (696), pyrethrin II (696), pyrethrins (696), pyridaben (699), pyridaphenthion (701), pyrimidifen (706), pyrimitate (1370), quinalphos (711), quintiofos (1381), R-1492 (development code) (1382), RA-17 (development code) (1383), rotenone (722), schradan (1389), sebufos (alternative name), selamectin (alternative name) [CCN], SI-0009 (compound code), sophamide (1402), spirodiclofen (738), spiromesifen (739), SSI-121 (development code) (1404), sulfuram (alternative name) [CCN], sulfluramid (750), sulfotep (753), sulfur (754), SZI-121 (development code) (757), tau-fluvalinate (398), tebufenpyrad (763), TEPP (1417), terbam (alternative name), tetrachlorvinphos (777), tetradifon (786), tetranactin (alternative name) (653), tetrasul (1425), thiafenox (alternative name), thiocarboxime (1431), thiofanox (800), thiometon (801), thioquinox (1436), thuringiensin (alternative name) [CCN], triamiphos (1441), triarathene (1443), triazophos (820), triazuron (alternative name), trichlorfon (824), trifenofos (1455), trinactin (alternative name) (653), vamidothion (847), vaniliprole [CCN] and YI-5302 (compound code),
an algicide selected from the group of substances consisting of bethoxazin [CCN], copper dioctanoate (IUPAC name) (170), copper sulfate (172), cybutryne [CCN], dichlone (1052), dichlorophen (232), endothal (295), fentin (347), hydrated lime [CCN], nabam (566), quinoclamine (714), quinonamid (1379), simazine (730), triphenyltin acetate (IUPAC name) (347) and triphenyltin hydroxide (IUPAC name) (347),
an anthelmintic selected from the group of substances consisting of abamectin (1), crufomate (1011), doramectin (alternative name) [CCN], emamectin (291), emamectin benzoate (291), eprinomectin (alternative name) [CCN], ivermectin (alternative name) [CCN], milbemycin oxime (alternative name) [CCN], moxidectin (alternative name) [CCN], piperazine [CCN], selamectin (alternative name) [CCN], spinosad (737) and thiophanate (1435),
an avicide selected from the group of substances consisting of chloralose (127), endrin (1122), fenthion (346), pyridin-4-amine (IUPAC name) (23) and strychnine (745),
a bactericide selected from the group of substances consisting of 1-hydroxy-1H-pyridine-2-thione (IUPAC name) (1222), 4-(quinoxalin-2-ylamino)benzenesulfonamide (IUPAC name) (748), 8-hydroxyquinoline sulfate (446), bronopol (97), copper dioctanoate (IUPAC name) (170), copper hydroxide (IUPAC name) (169), cresol [CCN], dichlorophen (232), dipyrithione (1105), dodicin (1112), fenaminosulf (1144), formaldehyde (404), hydrargaphen (alternative name) [CCN], kasugamycin (483), kasugamycin hydrochloride hydrate (483), nickel bis(dimethyldithiocarbamate) (IUPAC name) (1308), nitrapyrin (580), octhilinone (590), oxolinic acid (606), oxytetracycline (611), potassium hydroxyquinoline sulfate (446), probenazole (658), streptomycin (744), streptomycin sesquisulfate (744), tecloftalam (766) and thiomersal (alternative name) [CCN],
a biological agent selected from the group of substances consisting of Adoxophyes orana GV (alternative name) (12), Agrobacterium radiobacter (alternative name) (13), Amblyseius spp. (alternative name) (19), Anagrapha falcifera NPV (alternative name) (28), Anagrus atomus (alternative name) (29), Aphelinus abdominalis (alternative name) (33), Aphidius colemani (alternative name) (34), Aphidoletes aphidimyza (alternative name) (35), Autographa californica NPV (alternative name) (38), Bacillus firmus (alternative name) (48), Bacillus sphaericus Neide (scientific name) (49), Bacillus thuringiensis Berliner (scientific name) (51), Bacillus thuringiensis subsp. aizawai (scientific name) (51), Bacillus thuringiensis subsp. israelensis (scientific name) (51), Bacillus thuringiensis subsp. japonensis (scientific name) (51), Bacillus thuringiensis subsp. kurstaki (scientific name) (51), Bacillus thuringiensis subsp. tenebrionis (scientific name) (51), Beauveria bassiana (alternative name) (53), Beauveria brongniartii (alternative name) (54), Chrysoperla carnea (alternative name) (151), Cryptolaemus montrouzieri (alternative name) (178), Cydia pomonella GV (alternative name) (191), Dacnusa sibirica (alternative name) (212), Diglyphus isaea (alternative name) (254), Encarsia formosa (scientific name) (293), Eretmocerus eremicus (alternative name) (300), Helicoverpa zea NPV (alternative name) (431), Heterorhabditis bacteriophora and H. megidis (alternative name) (433), Hippodamia convergens (alternative name) (442), Leptomastix dactylopii (alternative name) (488), Macrolophus caliginosus (alternative name) (491), Mamestra brassicae NPV (alternative name) (494), Metaphycus helvolus (alternative name) (522), Metarhizium anisopliae var. acridum (scientific name) (523), Metarhizium anisopliae var. anisopliae (scientific name) (523), Neodiprion sertifer NPV and N. lecontei NPV (alternative name) (575), Orius spp. (alternative name) (596), Paecilomyces fumosoroseus (alternative name) (613), Phytoseiulus persimilis (alternative name) (644), Spodoptera exigua multicapsid nuclear polyhedrosis virus (scientific name) (741), Steinernema bibionis (alternative name) (742), Steinernema carpocapsae (alternative name) (742), Steinernema feltiae (alternative name) (742), Steinernema glaseri (alternative name) (742), Steinernema riobrave (alternative name) (742), Steinernema riobravis (alternative name) (742), Steinernema scapterisci (alternative name) (742), Steinernema spp. (alternative name) (742), Trichogramma spp. (alternative name) (826), Typhlodromus occidentalis (alternative name) (844) and Verticillium lecanii (alternative name) (848),
a soil sterilant selected from the group of substances consisting of iodomethane (IUPAC name) (542) and methyl bromide (537),
a chemosterilant selected from the group of substances consisting of apholate [CCN], bisazir (alternative name) [CCN], busulfan (alternative name) [CCN], diflubenzuron (250), dimatif (alternative name) [CCN], hemel [CCN], hempa [CCN], metepa [CCN], methiotepa [CCN], methyl apholate [CCN], morzid [CCN], penfluoron (alternative name) [CCN], tepa [CCN], thiohempa (alternative name) [CCN], thiotepa (alternative name) [CCN], tretamine (alternative name) [CCN] and uredepa (alternative name) [CCN],
an insect pheromone selected from the group of substances consisting of (E)-dec-5-en-1-yl acetate with (E)-dec-5-en-1-ol (IUPAC name) (222), (E)-tridec-4-en-1-yl acetate (IUPAC name) (829), (E)-6-methylhept-2-en-4-ol (IUPAC name) (541), (E,Z)-tetradeca-4,10-dien-1-yl acetate (IUPAC name) (779), (Z)-dodec-7-en-1-yl acetate (IUPAC name) (285), (Z)-hexadec-11-enal (IUPAC name) (436), (Z)-hexadec-11-en-1-yl acetate (IUPAC name) (437), (Z)-hexadec-13-en-11-yn-1-yl acetate (IUPAC name) (438), (Z)-icos-13-en-10-one (IUPAC name) (448), (Z)-tetradec-7-en-1-al (IUPAC name) (782), (Z)-tetradec-9-en-1-ol (IUPAC name) (783), (Z)-tetradec-9-en-1-yl acetate (IUPAC name) (784), (7E,9Z)-dodeca-7,9-dien-1-yl acetate (IUPAC name) (283), (9Z,11E)-tetradeca-9,11-dien-1-yl acetate (IUPAC name) (780), (9Z,12E)-tetradeca-9,12-dien-1-yl acetate (IUPAC name) (781), 14-methyloctadec-1-ene (IUPAC name) (545), 4-methylnonan-5-ol with 4-methylnonan-5-one (IUPAC name) (544), alpha-multistriatin (alternative name) [CCN], brevicomin (alternative name) [CCN], codlelure (alternative name) [CCN], codlemone (alternative name) (167), cuelure (alternative name) (179), disparlure (277), dodec-8-en-1-yl acetate (IUPAC name) (286), dodec-9-en-1-yl acetate (IUPAC name) (287), dodeca-8,10-dien-1-yl acetate (IUPAC name) (284), dominicalure (alternative name) [CCN], ethyl 4-methyloctanoate (IUPAC name) (317), eugenol (alternative name) [CCN], frontalin (alternative name) [CCN], gossyplure (alternative name) (420), grandlure (421), grandlure I (alternative name) (421), grandlure II (alternative name) (421), grandlure III (alternative name) (421), grandlure IV (alternative name) (421), hexylure [CCN], ipsdienol (alternative name) [CCN], ipsenol (alternative name) [CCN], japonilure (alternative name) (481), lineatin (alternative name) [CCN], litlure (alternative name) [CCN], looplure (alternative name) [CCN], medlure [CCN], megatomoic acid (alternative name) [CCN], methyl eugenol (alternative name) (540), muscalure (563), octadeca-2,13-dien-1-yl acetate (IUPAC name) (588), octadeca-3,13-dien-1-yl acetate (IUPAC name) (589), orfralure (alternative name) [CCN], oryctalure (alternative name) (317), ostramone (alternative name) [CCN], siglure [CCN], sordidin (alternative name) (736), sulcatol (alternative name) [CCN], tetradec-11-en-1-yl acetate (IUPAC name) (785), trimedlure (839), trimedlure A (alternative name) (839), trimedlure B₁ (alternative name) (839), trimedlure B₂ (alternative name) (839), trimedlure C (alternative name) (839) and trunc-call (alternative name) [CCN],
an insect repellent selected from the group of substances consisting of 2-(octylthio)-ethanol (IUPAC name) (591), butopyronoxyl (933), butoxy(polypropylene glycol) (936), dibutyl adipate (IUPAC name) (1046), dibutyl phthalate (1047), dibutyl succinate (IUPAC name) (1048), diethyltoluamide [CCN], dimethyl carbate [CCN], dimethyl phthalate [CCN], ethyl hexanediol (1137), hexamide [CCN], methoquin-butyl (1276), methylneodecanamide [CCN], oxamate [CCN] and picaridin [CCN],
an insecticide selected from the group of substances consisting of 1,1-dichloro-1-nitroethane (IUPAC/Chemical Abstracts name) (1058), 1,1-dichloro-2,2-bis(4-ethylphenyl)-ethane (IUPAC name) (1056), 1,2-dichloropropane (IUPAC/Chemical Abstracts name) (1062), 1,2-dichloropropane with 1,3-dichloropropene (IUPAC name) (1063), 1-bromo-2-chloroethane (IUPAC/Chemical Abstracts name) (916), 2,2,2-trichloro-1-(3,4-dichloro-phenyl)ethyl acetate (IUPAC name) (1451), 2,2-dichlorovinyl 2-ethylsulfinylethyl methyl phosphate (IUPAC name) (1066), 2-(1,3-dithiolan-2-yl)phenyl dimethylcarbamate (IUPAC/Chemical Abstracts name) (1109), 2-(2-butoxyethoxy)ethyl thiocyanate (IUPAC/Chemical Abstracts name) (935), 2-(4,5-dimethyl-1,3-dioxolan-2-yl)phenyl methylcarbamate (IUPAC/Chemical Abstracts name) (1084), 2-(4-chloro-3,5-xylyloxy)ethanol (IUPAC name) (986), 2-chlorovinyl diethyl phosphate (IUPAC name) (984), 2-imidazolidone (IUPAC name) (1225), 2-isovalerylindan-1,3-dione (IUPAC name) (1246), 2-methyl(prop-2-ynyl)aminophenyl methylcarbamate (IUPAC name) (1284), 2-thiocyanatoethyl laurate (IUPAC name) (1433), 3-bromo-1-chloroprop-1-ene (IUPAC name) (917), 3-methyl-1-phenylpyrazol-5-yl dimethyl-carbamate (IUPAC name) (1283), 4-methyl(prop-2-ynyl)amino-3,5-xylyl methylcarbamate (IUPAC name) (1285), 5,5-dimethyl-3-oxocyclohex-1-enyl dimethylcarbamate (IUPAC name) (1085), abamectin (1), acephate (2), acetamiprid (4), acethion (alternative name) [CCN], acetoprole [CCN], acrinathrin (9), acrylonitrile (IUPAC name) (861), alanycarb (15), aldicarb (16), aldoxycarb (863), aldrin (864), allethrin (17), allosamidin (alternative name) [CCN], allyxycarb (866), alpha-cypermethrin (202), alpha-ecdysone (alternative name) [CCN], aluminium phosphide (640), amidithion (870), amidothioate (872), aminocarb (873), amiton (875), amiton hydrogen oxalate (875), amitraz (24), anabasine (877), athidathion (883), AVI 382 (compound code), AZ 60541 (compound code), azadirachtin (alternative name) (41), azamethiphos (42), azinphos-ethyl (44), azinphos-methyl (45), azothoate (889), Bacillus thuringiensis delta endotoxins (alternative name) (52), barium hexafluorosilicate (alternative name) [CCN], barium polysulfide (IUPAC/Chemical Abstracts name) (892), barthrin [CCN], BAS 320 I (compound code), Bayer 22/190 (development code) (893), Bayer 22408 (development code) (894), bendiocarb (58), benfuracarb (60), bensultap (66), beta-cyfluthrin (194), beta-cypermethrin (203), bifenthrin (76), bioallethrin (78), bioallethrin S-cyclopentenyl isomer (alternative name) (79), bioethanomethrin [CCN], biopermethrin (908), bioresmethrin (80), bis(2-chloroethyl)ether (IUPAC name) (909), bistrifluoron (83), borax (86), brofenvalerate (alternative name), bromfenvinfos (914), bromocyclen (918), bromo-DDT (alternative name) [CCN], bromophos (920), bromophos-ethyl (921), bufencarb (924), buprofezin (99), butacarb (926), butathiofos (927), butocarboxim (103), butonate (932), butoxycarboxim (104), butylpyridaben (alternative name), cadusafos (109), calcium arsenate [CCN], calcium cyamide (444), calcium polysulfide (IUPAC name) (111), camphechlor (941), carbanolate (943), carbaryl (115), carbofuran (118), carbon disulfide (IUPAC/Chemical Abstracts name) (945), carbon tetrachloride (IUPAC name) (946), carbophenothion (947), carbosulfan (119), cartap (123), cartap hydrochloride (123), cevadine (alternative name) (725), chlorbicyclen (960), chlordane (128), chlordecone (963), chlordimeform (964), chlordimeform hydrochloride (964), chlorethoxyfos (129), chlorfenapyr (130), chlorfenvinphos (131), chlorfluazuron (132), chlormephos (136), chloroform [CCN], chloropicrin (141), chlorphoxim (989), chlorprazophos (990), chlorpyrifos (145), chlorpyrifos-methyl (146), chlorthiophos (994), chromafenozide (150), cinerin I (696), cinerin II (696), cinerins (696), cis-resmethrin (alternative name), cismethrin (80), clocythrin (alternative name), cloethocarb (999), closantel (alternative name) [CCN], clothianidin (165), copper acetoarsenite [CCN], copper arsenate [CCN], copper oleate [CCN], coumaphos (174), coumithoate (1006), crotamiton (alternative name) [CCN], crotoxyphos (1010), crufomate (1011), cryolite (alternative name) (177), CS 708 (development code) (1012), cyanofenphos (1019), cyanophos (184), cyanthoate (1020), cyclethrin [CCN], cycloprothrin (188), cyfluthrin (193), cyhalothrin (196), cypermethrin (201), cyphenothrin (206), cyromazine (209), cythioate (alternative name) [CCN], d-limonene (alternative name) [CCN], d-tetramethrin (alternative name) (788), DAEP (1031), dazomet (216), DDT (219), decarbofuran (1034), deltamethrin (223), demephion (1037), demephion-O (1037), demephion-S (1037), demeton (1038), demeton-methyl (224), demeton-O (1038), demeton-O-methyl (224), demeton-S (1038), demeton-5-methyl (224), demeton-5-methylsulphon (1039), diafenthiuron (226), dialifos (1042), diamidafos (1044), diazinon (227), dicapthon (1050), dichlofenthion (1051), dichlorvos (236), dicliphos (alternative name), dicresyl (alternative name) [CCN], dicrotophos (243), dicyclanil (244), dieldrin (1070), diethyl 5-methylpyrazol-3-yl phosphate (IUPAC name) (1076), diflubenzuron (250), dilor (alternative name) [CCN], dimefluthrin [CCN], dimefox (1081), dimetan (1085), dimethoate (262), dimethrin (1083), dimethylvinphos (265), dimetilan (1086), dinex (1089), dinex-diclexine (1089), dinoprop (1093), dinosam (1094), dinoseb (1095), dinotefuran (271), diofenolan (1099), dioxabenzofos (1100), dioxacarb (1101), dioxathion (1102), disulfoton (278), dithicrofos (1108), DNOC (282), doramectin (alternative name) [CCN], DSP (1115), ecdysterone (alternative name) [CCN], EI 1642 (development code) (1118), emamectin (291), emamectin benzoate (291), EMPC (1120), empenthrin (292), endosulfan (294), endothion (1121), endrin (1122), EPBP (1123), EPN (297), epofenonane (1124), eprinomectin (alternative name) [CCN], esfenvalerate (302), etaphos (alternative name) [CCN], ethiofencarb (308), ethion (309), ethiprole (310), ethoate-methyl (1134), ethoprophos (312), ethyl formate (IUPAC name) [CCN], ethyl-DDD (alternative name) (1056), ethylene dibromide (316), ethylene dichloride (chemical name) (1136), ethylene oxide [CCN], etofenprox (319), etrimfos (1142), EXD (1143), famphur (323), fenamiphos (326), fenazaflor (1147), fenchlorphos (1148), fenethacarb (1149), fenfluthrin (1150), fenitrothion (335), fenobucarb (336), fenoxacrim (1153), fenoxycarb (340), fenpirithrin (1155), fenpropathrin (342), fenpyrad (alternative name), fensulfothion (1158), fenthion (346), fenthion-ethyl [CCN], fenvalerate (349), fipronil (354), flonicamid (358), flucofuron (1168), flucycloxuron (366), flucythrinate (367), fluenetil (1169), flufenerim [CCN], flufenoxuron (370), flufenprox (1171), flumethrin (372), fluvalinate (1184), FMC 1137 (development code) (1185), fonofos (1191), formetanate (405), formetanate hydrochloride (405), formothion (1192), formparanate (1193), fosmethilan (1194), fospirate (1195), fosthiazate (408), fosthietan (1196), furathiocarb (412), furethrin (1200), gamma-cyhalothrin (197), gamma-HCH (430), guazatine (422), guazatine acetates (422), GY-81 (development code) (423), halfenprox (424), halofenozide (425), HCH (430), HEOD (1070), heptachlor (1211), heptenophos (432), heterophos [CCN], hexaflumuron (439), HHDN (864), hydramethylnon (443), hydrogen cyamide (444), hydroprene (445), hyquincarb (1223), imidacloprid (458), imiprothrin (460), indoxacarb (465), iodomethane (IUPAC name) (542), IPSP (1229), isazofos (1231), isobenzan (1232), isocarbophos (alternative name) (473), isodrin (1235), isofenphos (1236), isolane (1237), isoprocarb (472), isopropyl O-(methoxyaminothiophosphoryl)salicylate (IUPAC name) (473), isoprothiolane (474), isothioate (1244), isoxathion (480), ivermectin (alternative name) [CCN], jasmolin I (696), jasmolin II (696), jodfenphos (1248), juvenile hormone I (alternative name) [CCN], juvenile hormone II (alternative name) [CCN], juvenile hormone III (alternative name) [CCN], kelevan (1249), kinoprene (484), lambda-cyhalothrin (198), lead arsenate [CCN], leptophos (1250), lindane (430), lirimfos (1251), lufenuron (490), lythidathion (1253), m-cumenyl methylcarbamate (IUPAC name) (1014), magnesium phosphide (IUPAC name) (640), malathion (492), malonoben (1254), mazidox (1255), mecarbam (502), mecarphon (1258), menazon (1260), mephosfolan (1261), mercurous chloride (513), mesulfenfos (1263), metam (519), metam-potassium (alternative name) (519), metam-sodium (519), methacrifos (1266), methamidophos (527), methanesulfonyl fluoride (IUPAC/Chemical Abstracts name) (1268), methidathion (529), methiocarb (530), methocrotophos (1273), methomyl (531), methoprene (532), methoquin-butyl (1276), methothrin (alternative name) (533), methoxychlor (534), methoxyfenozide (535), methyl bromide (537), methyl isothiocyanate (543), methylchloroform (alternative name) [CCN], methylene chloride [CCN], metofluthrin [CCN], metolcarb (550), metoxadiazone (1288), mevinphos (556), mexacarbate (1290), milbemectin (557), milbemycin oxime (alternative name) [CCN], mipafox (1293), mirex (1294), monocrotophos (561), morphothion (1300), moxidectin (alternative name) [CCN], naftalofos (alternative name) [CCN], naled (567), naphthalene (IUPAC/Chemical Abstracts name) (1303), NC-170 (development code) (1306), NC-184 (compound code), nicotine (578), nicotine sulfate (578), nifluridide (1309), nitenpyram (579), nithiazine (1311), nitrilacarb (1313), nitrilacarb 1:1 zinc chloride complex (1313), NNI-0101 (compound code), NNI-0250 (compound code), nornicotine (traditional name) (1319), novaluron (585), noviflumuron (586), O-2,5-dichloro-4-iodophenyl O-ethyl ethylphosphonothioate (IUPAC name) (1057), O,O-diethyl O-4-methyl-2-oxo-2H-chromen-7-yl phosphorothioate (IUPAC name) (1074), O,O-diethyl O-6-methyl-2-propylpyrimidin-4-yl phosphorothioate (IUPAC name) (1075), O,O,O′,O′-tetrapropyl dithiopyrophosphate (IUPAC name) (1424), oleic acid (IUPAC name) (593), omethoate (594), oxamyl (602), oxydemeton-methyl (609), oxydeprofos (1324), oxydisulfoton (1325), pp′-DDT (219), para-dichlorobenzene [CCN], parathion (615), parathion-methyl (616), penfluoron (alternative name) [CCN], pentachlorophenol (623), pentachlorophenyl laurate (IUPAC name) (623), permethrin (626), petroleum oils (alternative name) (628), PH 60-38 (development code) (1328), phenkapton (1330), phenothrin (630), phenthoate (631), phorate (636), phosalone (637), phosfolan (1338), phosmet (638), phosnichlor (1339), phosphamidon (639), phosphine (IUPAC name) (640), phoxim (642), phoxim-methyl (1340), pirimetaphos (1344), pirimicarb (651), pirimiphos-ethyl (1345), pirimiphos-methyl (652), polychlorodicyclopentadiene isomers (IUPAC name) (1346), polychloroterpenes (traditional name) (1347), potassium arsenite [CCN], potassium thiocyanate [CCN], prallethrin (655), precocene I (alternative name) [CCN], precocene II (alternative name) [CCN], precocene III (alternative name) [CCN], primidophos (1349), profenofos (662), profluthrin [CCN], promacyl (1354), promecarb (1355), propaphos (1356), propetamphos (673), propoxur (678), prothidathion (1360), prothiofos (686), prothoate (1362), protrifenbute [CCN], pymetrozine (688), pyraclofos (689), pyrazophos (693), pyresmethrin (1367), pyrethrin I (696), pyrethrin II (696), pyrethrins (696), pyridaben (699), pyridalyl (700), pyridaphenthion (701), pyrimidifen (706), pyrimitate (1370), pyriproxyfen (708), quassia (alternative name) [CCN], quinalphos (711), quinalphos-methyl (1376), quinothion (1380), quintiofos (1381), R-1492 (development code) (1382), rafoxanide (alternative name) [CCN], resmethrin (719), rotenone (722), RU 15525 (development code) (723), RU 25475 (development code) (1386), ryania (alternative name) (1387), ryanodine (traditional name) (1387), sabadilla (alternative name) (725), schradan (1389), sebufos (alternative name), selamectin (alternative name) [CCN], SI-0009 (compound code), silafluofen (728), SN 72129 (development code) (1397), sodium arsenite [CCN], sodium cyamide (444), sodium fluoride (IUPAC/Chemical Abstracts name) (1399), sodium hexafluorosilicate (1400), sodium pentachlorophenoxide (623), sodium selenate (IUPAC name) (1401), sodium thiocyanate [CCN], sophamide (1402), spinosad (737), spiromesifen (739), sulcofuron (746), sulcofuron-sodium (746), sulfluramid (750), sulfotep (753), sulfuryl fluoride (756), sulprofos (1408), tar oils (alternative name) (758), tau-fluvalinate (398), tazimcarb (1412), TDE (1414), tebufenozide (762), tebufenpyrad (763), tebupirimfos (764), teflubenzuron (768), tefluthrin (769), temephos (770), TEPP (1417), terallethrin (1418), terbam (alternative name), terbufos (773), tetrachloroethane [CCN], tetrachlorvinphos (777), tetramethrin (787), theta-cypermethrin (204), thiacloprid (791), thiafenox (alternative name), thiamethoxam (792), thicrofos (1428), thiocarboxime (1431), thiocyclam (798), thiocyclam hydrogen oxalate (798), thiodicarb (799), thiofanox (800), thiometon (801), thionazin (1434), thiosultap (803), thiosultap-sodium (803), thuringiensin (alternative name) [CCN], tolfenpyrad (809), tralomethrin (812), transfluthrin (813), transpermethrin (1440), triamiphos (1441), triazamate (818), triazophos (820), triazuron (alternative name), trichlorfon (824), trichlormetaphos-3 (alternative name) [CCN], trichloronat (1452), trifenofos (1455), triflumuron (835), trimethacarb (840), triprene (1459), vamidothion (847), vaniliprole [CCN], veratridine (alternative name) (725), veratrine (alternative name) (725), XMC (853), xylylcarb (854), YI-5302 (compound code), zeta-cypermethrin (205), zetamethrin (alternative name), zinc phosphide (640), zolaprofos (1469) and ZXI 8901 (development code) (858),
a molluscicide selected from the group of substances consisting of bis(tributyltin)oxide (IUPAC name) (913), bromoacetamide [CCN], calcium arsenate [CCN], cloethocarb (999), copper acetoarsenite [CCN], copper sulfate (172), fentin (347), ferric phosphate (IUPAC name) (352), metaldehyde (518), methiocarb (530), niclosamide (576), niclosamide-olamine (576), pentachlorophenol (623), sodium pentachlorophenoxide (623), tazimcarb (1412), thiodicarb (799), tributyltin oxide (913), trifenmorph (1454), trimethacarb (840), triphenyltin acetate (IUPAC name) (347) and triphenyltin hydroxide (IUPAC name) (347),
a nematicide selected from the group of substances consisting of 1,2-dibromo-3-chloropropane (IUPAC/Chemical Abstracts name) (1045), 1,2-dichloropropane (IUPAC/Chemical Abstracts name) (1062), 1,2-dichloropropane with 1,3-dichloropropene (IUPAC name) (1063), 1,3-dichloropropene (233), 3,4-dichlorotetrahydrothiophene 1,1-dioxide (IUPAC/Chemical Abstracts name) (1065), 3-(4-chlorophenyl)-5-methylrhodanine (IUPAC name) (980), 5-methyl-6-thioxo-1,3,5-thiadiazinan-3-ylacetic acid (IUPAC name) (1286), 6-isopentenylaminopurine (alternative name) (210), abamectin (1), acetoprole [CCN], alanycarb (15), aldicarb (16), aldoxycarb (863), AZ 60541 (compound code), benclothiaz [CCN], benomyl (62), butylpyridaben (alternative name), cadusafos (109), carbofuran (118), carbon disulfide (945), carbosulfan (119), chloropicrin (141), chlorpyrifos (145), cloethocarb (999), cytokinins (alternative name) (210), dazomet (216), DBCP (1045), DCIP (218), diamidafos (1044), dichlofenthion (1051), dicliphos (alternative name), dimethoate (262), doramectin (alternative name) [CCN], emamectin (291), emamectin benzoate (291), eprinomectin (alternative name) [CCN], ethoprophos (312), ethylene dibromide (316), fenamiphos (326), fenpyrad (alternative name), fensulfothion (1158), fosthiazate (408), fosthietan (1196), furfural (alternative name) [CCN], GY-81 (development code) (423), heterophos [CCN], iodomethane (IUPAC name) (542), isamidofos (1230), isazofos (1231), ivermectin (alternative name) [CCN], kinetin (alternative name) (210), mecarphon (1258), metam (519), metam-potassium (alternative name) (519), metam-sodium (519), methyl bromide (537), methyl isothiocyanate (543), milbemycin oxime (alternative name) [CCN], moxidectin (alternative name) [CCN], Myrothecium verrucaria composition (alternative name) (565), NC-184 (compound code), oxamyl (602), phorate (636), phosphamidon (639), phosphocarb [CCN], sebufos (alternative name), selamectin (alternative name) [CCN], spinosad (737), terbam (alternative name), terbufos (773), tetrachlorothiophene (IUPAC/Chemical Abstracts name) (1422), thiafenox (alternative name), thionazin (1434), triazophos (820), triazuron (alternative name), xylenols [CCN], YI-5302 (compound code) and zeatin (alternative name) (210),
a nitrification inhibitor selected from the group of substances consisting of potassium ethylxanthate [CCN] and nitrapyrin (580),
a plant activator selected from the group of substances consisting of acibenzolar (6), acibenzolar-5-methyl (6), probenazole (658) and Reynoutria sachalinensis extract (alternative name) (720),
a rodenticide selected from the group of substances consisting of 2-isovalerylindan-1,3-dione (IUPAC name) (1246), 4-(quinoxalin-2-ylamino)benzenesulfonamide (IUPAC name) (748), alpha-chlorohydrin [CCN], aluminium phosphide (640), antu (880), arsenous oxide (882), barium carbonate (891), bisthiosemi (912), brodifacoum (89), bromadiolone (91), bromethalin (92), calcium cyamide (444), chloralose (127), chlorophacinone (140), cholecalciferol (alternative name) (850), coumachlor (1004), coumafuryl (1005), coumatetralyl (175), crimidine (1009), difenacoum (246), difethialone (249), diphacinone (273), ergocalciferol (301), flocoumafen (357), fluoroacetamide (379), flupropadine (1183), flupropadine hydrochloride (1183), gamma-HCH (430), HCH (430), hydrogen cyamide (444), iodomethane (IUPAC name) (542), lindane (430), magnesium phosphide (IUPAC name) (640), methyl bromide (537), norbormide (1318), phosacetim (1336), phosphine (IUPAC name) (640), phosphorus [CCN], pindone (1341), potassium arsenite [CCN], pyrinuron (1371), scilliroside (1390), sodium arsenite [CCN], sodium cyamide (444), sodium fluoro-acetate (735), strychnine (745), thallium sulfate [CCN], warfarin (851) and zinc phosphide (640),
a synergist selected from the group of substances consisting of 2-(2-butoxyethoxy)ethyl piperonylate (IUPAC name) (934), 5-(1,3-benzodioxol-5-yl)-3-hexylcyclohex-2-enone (IUPAC name) (903), farnesol with nerolidol (alternative name) (324), MB-599 (development code) (498), MGK 264 (development code) (296), piperonyl butoxide (649), piprotal (1343), propyl isomer (1358), S421 (development code) (724), sesamex (1393), sesasmolin (1394) and sulfoxide (1406),
an animal repellent selected from the group of substances consisting of anthraquinone (32), chloralose (127), copper naphthenate [CCN], copper oxychloride (171), diazinon (227), dicyclopentadiene (chemical name) (1069), guazatine (422), guazatine acetates (422), methiocarb (530), pyridin-4-amine (IUPAC name) (23), thiram (804), trimethacarb (840), zinc naphthenate [CCN] and ziram (856),
a virucide selected from the group of substances consisting of imanin (alternative name) [CCN] and ribavirin (alternative name) [CCN],
and a wound protectant selected from the group of substances consisting of mercuric oxide (512), octhilinone (590) and thiophanate-methyl (802).

A very especially preferred embodiment of the subject-matter {1.1.12} of the invention is {1.1.12.2} a pesticidal composition comprising a mixture consisting of at least two substances, namely one compound (A) and at least one compound (B), as active ingredient and at least one auxiliary, wherein the compound (A) is the compound of formula (A-12) and the compound (B) is a compound selected from the group of substances consisting of abamectin (1), cyromazine (209), diafenthiuron (226), diazinon (227), emamectin benzoate (291), fenoxycarb (340), fosthiazate (408), lambda-cyhalothrin (198), lufenuron (490), methidathion (529), profenofos (662), pymetrozine (688), tefluthrin (769) and thiamethoxam (792).

The compound of formula (A-12) is known, for example, from the PCT Application WO-03/015519.

A preferred embodiment of the subject-matter {1.1} of the invention is {1.1.13} a pesticidal composition comprising a mixture consisting of at least two substances, namely one compound (A) and at least one compound (B), as active ingredient and at least one auxiliary, wherein the compound (A) is the compound of formula (A-13) 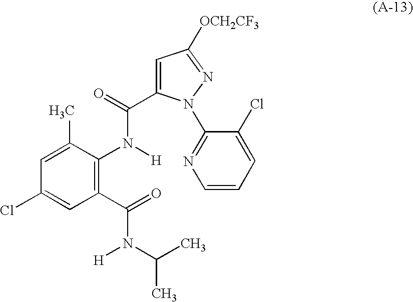
and the compound (B) is a compound selected from the group of substances consisting of an adjuvant, an acaricide, an algicide, an anthelmintic, an avicide, a bactericide, a biological agent, a soil sterilant, a chemosterilant, an insect pheromone, an insect repellent, an insecticide, a molluscicide, a nematicide, a nitrification inhibitor, a plant activator, a rodenticide, a synergist, an animal repellent, a virucide and a wound protectant.

An especially preferred embodiment of the subject-matter {1.1.13} of the invention is {1.1.13.1} a pesticidal composition comprising a mixture consisting of at least two substances, namely one compound (A) and at least one compound (B), as active ingredient and at least one auxiliary, wherein the compound (A) is the compound of formula (A-13) and the compound (B) is a compound selected from the group of substances consisting of
an adjuvant selected from the group of substances consisting of petroleum oils (alternative name) (628),
an acaricide selected from the group of substances consisting of 1,1-bis(4-chlorophenyl)-2-ethoxyethanol (IUPAC name) (910), 2,4-dichlorophenyl benzenesulfonate (IUPAC/Chemical Abstracts name) (1059), 2-fluoro-N-methyl-N-1-naphthylacetamide (IUPAC name) (1295), 4-chlorophenyl phenyl sulfone (IUPAC name) (981), abamectin (1), acequinocyl (3), acetoprole [CCN], acrinathrin (9), aldicarb (16), aldoxycarb (863), alpha-cypermethrin (202), amidithion (870), amidoflumet [CCN], amidothioate (872), amiton (875), amiton hydrogen oxalate (875), amitraz (24), aramite (881), arsenous oxide (882), AVI 382 (compound code), AZ 60541 (compound code), azinphos-ethyl (44), azinphos-methyl (45), azobenzene (IUPAC name) (888), azocyclotin (46), azothoate (889), benomyl (62), benoxafos (alternative name) [CCN], benzoximate (71), benzyl benzoate (IUPAC name) [CCN], bifenazate (74), bifenthrin (76), binapacryl (907), brofenvalerate (alternative name), bromocyclen (918), bromophos (920), bromophos-ethyl (921), bromopropylate (94), buprofezin (99), butocarboxim (103), butoxycarboxim (104), butylpyridaben (alternative name), calcium polysulfide (IUPAC name) (111), camphechlor (941), carbanolate (943), carbaryl (115), carbofuran (118), carbophenothion (947), CGA 50'439 (development code) (125), chinomethionat (126), chlorbenside (959), chlordimeform (964), chlordimeform hydrochloride (964), chlorfenapyr (130), chlorfenethol (968), chlorfenson (970), chlorfensulphide (971), chlorfenvinphos (131), chlorobenzilate (975), chloromebuform (977), chloromethiuron (978), chloropropylate (983), chlorpyrifos (145), chlorpyrifos-methyl (146), chlorthiophos (994), cinerin I (696), cinerin II (696), cinerins (696), clofentezine (158), closantel (alternative name) [CCN], coumaphos (174), crotamiton (alternative name) [CCN], crotoxyphos (1010), cufraneb (1013), cyanthoate (1020), cyhalothrin (196), cyhexatin (199), cypermethrin (201), DCPM (1032), DDT (219), demephion (1037), demephion-O (1037), demephion-S (1037), demeton (1038), demeton-methyl (224), demeton-O (1038), demeton-O-methyl (224), demeton-S (1038), demeton-5-methyl (224), demeton-5-methylsulphon (1039), diafenthiuron (226), dialifos (1042), diazinon (227), dichlofluanid (230), dichlorvos (236), dicliphos (alternative name), dicofol (242), dicrotophos (243), dienochlor (1071), dimefox (1081), dimethoate (262), dinactin (alternative name) (653), dinex (1089), dinex-diclexine (1089), dinobuton (269), dinocap (270), dinocap-4 [CCN], dinocap-6 [CCN], dinocton (1090), dinopenton (1092), dinosulfon (1097), dinoterbon (1098), dioxathion (1102), diphenyl sulfone (IUPAC name) (1103), disulfuram (alternative name) [CCN], disulfoton (278), DNOC (282), dofenapyn (1113), doramectin (alternative name) [CCN], endosulfan (294), endothion (1121), EPN (297), eprinomectin (alternative name) [CCN], ethion (309), ethoate-methyl (1134), etoxazole (320), etrimfos (1142), fenazaflor (1147), fenazaquin (328), fenbutatin oxide (330), fenothiocarb (337), fenpropathrin (342), fenpyrad (alternative name), fenpyroximate (345), fenson (1157), fentrifanil (1161), fenvalerate (349), fipronil (354), fluacrypyrim (360), fluazuron (1166), flubenzimine (1167), flucycloxuron (366), flucythrinate (367), fluenetil (1169), flufenoxuron (370), flumethrin (372), fluorbenside (1174), fluvalinate (1184), FMC 1137 (development code) (1185), formetanate (405), formetanate hydrochloride (405), formothion (1192), formparanate (1193), gamma-HCH (430), glyodin (1205), halfenprox (424), heptenophos (432), hexadecyl cyclopropanecarboxylate (IUPAC/Chemical Abstracts name) (1216), hexythiazox (441), iodomethane (IUPAC name) (542), isocarbophos (alternative name) (473), isopropyl O-(methoxyaminothiophosphoryl)salicylate (IUPAC name) (473), ivermectin (alternative name) [CCN], jasmolin I (696), jasmolin II (696), jodfenphos (1248), lindane (430), lufenuron (490), malathion (492), malonoben (1254), mecarbam (502), mephosfolan (1261), mesulfen (alternative name) [CCN], methacrifos (1266), methamidophos (527), methidathion (529), methiocarb (530), methomyl (531), methyl bromide (537), metolcarb (550), mevinphos (556), mexacarbate (1290), milbemectin (557), milbemycin oxime (alternative name) [CCN], mipafox (1293), monocrotophos (561), morphothion (1300), moxidectin (alternative name) [CCN], naled (567), NC-184 (compound code), nifluridide (1309), nikkomycins (alternative name) [CCN], nitrilacarb (1313), nitrilacarb 1:1 zinc chloride complex (1313), NNI-0101 (compound code), NNI-0250 (compound code), omethoate (594), oxamyl (602), oxydeprofos (1324), oxydisulfoton (1325), pp′-DDT (219), parathion (615), permethrin (626), petroleum oils (alternative name) (628), phenkapton (1330), phenthoate (631), phorate (636), phosalone (637), phosfolan (1338), phosmet (638), phosphamidon (639), phoxim (642), pirimiphos-methyl (652), polychloroterpenes (traditional name) (1347), polynactins (alternative name) (653), proclonol (1350), profenofos (662), promacyl (1354), propargite (671), propetamphos (673), propoxur (678), prothidathion (1360), prothoate (1362), pyrethrin I (696), pyrethrin II (696), pyrethrins (696), pyridaben (699), pyridaphenthion (701), pyrimidifen (706), pyrimitate (1370), quinalphos (711), quintiofos (1381), R-1492 (development code) (1382), RA-17 (development code) (1383), rotenone (722), schradan (1389), sebufos (alternative name), selamectin (alternative name) [CCN], SI-0009 (compound code), sophamide (1402), spirodiclofen (738), spiromesifen (739), SSI-121 (development code) (1404), sulfuram (alternative name) [CCN], sulfluramid (750), sulfotep (753), sulfur (754), SZI-121 (development code) (757), tau-fluvalinate (398), tebufenpyrad (763), TEPP (1417), terbam (alternative name), tetrachlorvinphos (777), tetradifon (786), tetranactin (alternative name) (653), tetrasul (1425), thiafenox (alternative name), thiocarboxime (1431), thiofanox (800), thiometon (801), thioquinox (1436), thuringiensin (alternative name) [CCN], triamiphos (1441), triarathene (1443), triazophos (820), triazuron (alternative name), trichlorfon (824), trifenofos (1455), trinactin (alternative name) (653), vamidothion (847), vaniliprole [CCN] and YI-5302 (compound code),
an algicide selected from the group of substances consisting of bethoxazin [CCN], copper dioctanoate (IUPAC name) (170), copper sulfate (172), cybutryne [CCN], dichlone (1052), dichlorophen (232), endothal (295), fentin (347), hydrated lime [CCN], nabam (566), quinoclamine (714), quinonamid (1379), simazine (730), triphenyltin acetate (IUPAC name) (347) and triphenyltin hydroxide (IUPAC name) (347),
an anthelmintic selected from the group of substances consisting of abamectin (1), crufomate (1011), doramectin (alternative name) [CCN], emamectin (291), emamectin benzoate (291), eprinomectin (alternative name) [CCN], ivermectin (alternative name) [CCN], milbemycin oxime (alternative name) [CCN], moxidectin (alternative name) [CCN], piperazine [CCN], selamectin (alternative name) [CCN], spinosad (737) and thiophanate (1435),
an avicide selected from the group of substances consisting of chloralose (127), endrin (1122), fenthion (346), pyridin-4-amine (IUPAC name) (23) and strychnine (745),
a bactericide selected from the group of substances consisting of 1-hydroxy-1H-pyridine-2-thione (IUPAC name) (1222), 4-(quinoxalin-2-ylamino)benzenesulfonamide (IUPAC name) (748), 8-hydroxyquinoline sulfate (446), bronopol (97), copper dioctanoate (IUPAC name) (170), copper hydroxide (IUPAC name) (169), cresol [CCN], dichlorophen (232), dipyrithione (1105), dodicin (1112), fenaminosulf (1144), formaldehyde (404), hydrargaphen (alternative name) [CCN], kasugamycin (483), kasugamycin hydrochloride hydrate (483), nickel bis(dimethyldithiocarbamate) (IUPAC name) (1308), nitrapyrin (580), octhilinone (590), oxolinic acid (606), oxytetracycline (611), potassium hydroxyquinoline sulfate (446), probenazole (658), streptomycin (744), streptomycin sesquisulfate (744), tecloftalam (766) and thiomersal (alternative name) [CCN],
a biological agent selected from the group of substances consisting of Adoxophyes orana GV (alternative name) (12), Agrobacterium radiobacter (alternative name) (13), Amblyseius spp. (alternative name) (19), Anagrapha falcifera NPV (alternative name) (28), Anagrus atomus (alternative name) (29), Aphelinus abdominalis (alternative name) (33), Aphidius colemani (alternative name) (34), Aphidoletes aphidimyza (alternative name) (35), Autographa californica NPV (alternative name) (38), Bacillus firmus (alternative name) (48), Bacillus sphaericus Neide (scientific name) (49), Bacillus thuringiensis Berliner (scientific name) (51), Bacillus thuringiensis subsp. aizawai (scientific name) (51), Bacillus thuringiensis subsp. israelensis (scientific name) (51), Bacillus thuringiensis subsp. japonensis (scientific name) (51), Bacillus thuringiensis subsp. kurstaki (scientific name) (51), Bacillus thuringiensis subsp. tenebrionis (scientific name) (51), Beauveria bassiana (alternative name) (53), Beauveria brongniartii (alternative name) (54), Chrysoperla carnea (alternative name) (151), Cryptolaemus montrouzieri (alternative name) (178), Cydia pomonella GV (alternative name) (191), Dacnusa sibirica (alternative name) (212), Diglyphus isaea (alternative name) (254), Encarsia formosa (scientific name) (293), Eretmocerus eremicus (alternative name) (300), Helicoverpa zea NPV (alternative name) (431), Heterorhabditis bacteriophora and H. megidis (alternative name) (433), Hippodamia convergens (alternative name) (442), Leptomastix dactylopii (alternative name) (488), Macrolophus caliginosus (alternative name) (491), Mamestra brassicae NPV (alternative name) (494), Metaphycus helvolus (alternative name) (522), Metarhizium anisopliae var. acridum (scientific name) (523), Metarhizium anisopliae var. anisopliae (scientific name) (523), Neodiprion sertifer NPV and N. lecontei NPV (alternative name) (575), Orius spp. (alternative name) (596), Paecilomyces fumosoroseus (alternative name) (613), Phytoseiulus persimilis (alternative name) (644), Spodoptera exigua multicapsid nuclear polyhedrosis virus (scientific name) (741), Steinernema bibionis (alternative name) (742), Steinernema carpocapsae (alternative name) (742), Steinernema feltiae (alternative name) (742), Steinernema glaseri (alternative name) (742), Steinernema riobrave (alternative name) (742), Steinernema riobravis (alternative name) (742), Steinernema scapterisci (alternative name) (742), Steinernema spp. (alternative name) (742), Trichogramma spp. (alternative name) (826), Typhlodromus occidentalis (alternative name) (844) and Verticillium lecanii (alternative name) (848),
a soil sterilant selected from the group of substances consisting of iodomethane (IUPAC name) (542) and methyl bromide (537),
a chemosterilant selected from the group of substances consisting of apholate [CCN], bisazir (alternative name) [CCN], busulfan (alternative name) [CCN], diflubenzuron (250), dimatif (alternative name) [CCN], hemel [CCN], hempa [CCN], metepa [CCN], methiotepa [CCN], methyl apholate [CCN], morzid [CCN], penfluoron (alternative name) [CCN], tepa [CCN], thiohempa (alternative name) [CCN], thiotepa (alternative name) [CCN], tretamine (alternative name) [CCN] and uredepa (alternative name) [CCN],
an insect pheromone selected from the group of substances consisting of (E)-dec-5-en-1-yl acetate with (E)-dec-5-en-1-ol (IUPAC name) (222), (E)-tridec-4-en-1-yl acetate (IUPAC name) (829), (E)-6-methylhept-2-en-4-ol (IUPAC name) (541), (E,Z)-tetradeca-4,10-dien-1-yl acetate (IUPAC name) (779), (Z)-dodec-7-en-1-yl acetate (IUPAC name) (285), (Z)-hexadec-11-enal (IUPAC name) (436), (Z)-hexadec-11-en-1-yl acetate (IUPAC name) (437), (Z)-hexadec-13-en-11-yn-1-yl acetate (IUPAC name) (438), (Z)-icos-13-en-10-one (IUPAC name) (448), (Z)-tetradec-7-en-1-al (IUPAC name) (782), (Z)-tetradec-9-en-1-ol (IUPAC name) (783), (Z)-tetradec-9-en-1-yl acetate (IUPAC name) (784), (7E,9Z)-dodeca-7,9-dien-1-yl acetate (IUPAC name) (283), (9Z,11E)-tetradeca-9,11-dien-1-yl acetate (IUPAC name) (780), (9Z,12E)-tetradeca-9,12-dien-1-yl acetate (IUPAC name) (781), 14-methyloctadec-1-ene (IUPAC name) (545), 4-methylnonan-5-ol with 4-methylnonan-5-one (IUPAC name) (544), alpha-multistriatin (alternative name) [CCN], brevicomin (alternative name) [CCN], codlelure (alternative name) [CCN], codlemone (alternative name) (167), cuelure (alternative name) (179), disparlure (277), dodec-8-en-1-yl acetate (IUPAC name) (286), dodec-9-en-1-yl acetate (IUPAC name) (287), dodeca-8,10-dien-1-yl acetate (IUPAC name) (284), dominicalure (alternative name) [CCN], ethyl 4-methyloctanoate (IUPAC name) (317), eugenol (alternative name) [CCN], frontalin (alternative name) [CCN], gossyplure (alternative name) (420), grandlure (421), grandlure I (alternative name) (421), grandlure II (alternative name) (421), grandlure III (alternative name) (421), grandlure IV (alternative name) (421), hexylure [CCN], ipsdienol (alternative name) [CCN], ipsenol (alternative name) [CCN], japonilure (alternative name) (481), lineatin (alternative name) [CCN], litlure (alternative name) [CCN], looplure (alternative name) [CCN], medlure [CCN], megatomoic acid (alternative name) [CCN], methyl eugenol (alternative name) (540), muscalure (563), octadeca-2,13-dien-1-yl acetate (IUPAC name) (588), octadeca-3,13-dien-1-yl acetate (IUPAC name) (589), orfralure (alternative name) [CCN], oryctalure (alternative name) (317), ostramone (alternative name) [CCN], siglure [CCN], sordidin (alternative name) (736), sulcatol (alternative name) [CCN], tetradec-11-en-1-yl acetate (IUPAC name) (785), trimedlure (839), trimedlure A (alternative name) (839), trimedlure B₁ (alternative name) (839), trimedlure B₂ (alternative name) (839), trimedlure C (alternative name) (839) and trunc-call (alternative name) [CCN],
an insect repellent selected from the group of substances consisting of 2-(octylthio)-ethanol (IUPAC name) (591), butopyronoxyl (933), butoxy(polypropylene glycol) (936), dibutyl adipate (IUPAC name) (1046), dibutyl phthalate (1047), dibutyl succinate (IUPAC name) (1048), diethyltoluamide [CCN], dimethyl carbate [CCN], dimethyl phthalate [CCN], ethyl hexanediol (1137), hexamide [CCN], methoquin-butyl (1276), methylneodecanamide [CCN], oxamate [CCN] and picaridin [CCN],
an insecticide selected from the group of substances consisting of 1,1-dichloro-1-nitroethane (IUPAC/Chemical Abstracts name) (1058), 1,1-dichloro-2,2-bis(4-ethylphenyl)-ethane (IUPAC name) (1056), 1,2-dichloropropane (IUPAC/Chemical Abstracts name) (1062), 1,2-dichloropropane with 1,3-dichloropropene (IUPAC name) (1063), 1-bromo-2-chloroethane (IUPAC/Chemical Abstracts name) (916), 2,2,2-trichloro-1-(3,4-dichloro-phenyl)ethyl acetate (IUPAC name) (1451), 2,2-dichlorovinyl 2-ethylsulfinylethyl methyl phosphate (IUPAC name) (1066), 2-(1,3-dithiolan-2-yl)phenyl dimethylcarbamate (IUPAC/Chemical Abstracts name) (1109), 2-(2-butoxyethoxy)ethyl thiocyanate (IUPAC/Chemical Abstracts name) (935), 2-(4,5-dimethyl-1,3-dioxolan-2-yl)phenyl methylcarbamate (IUPAC/Chemical Abstracts name) (1084), 2-(4-chloro-3,5-xylyloxy)ethanol (IUPAC name) (986), 2-chlorovinyl diethyl phosphate (IUPAC name) (984), 2-imidazolidone (IUPAC name) (1225), 2-isovalerylindan-1,3-dione (IUPAC name) (1246), 2-methyl(prop-2-ynyl)aminophenyl methylcarbamate (IUPAC name) (1284), 2-thiocyanatoethyl laurate (IUPAC name) (1433), 3-bromo-1-chloroprop-1-ene (IUPAC name) (917), 3-methyl-1-phenylpyrazol-5-yl dimethyl-carbamate (IUPAC name) (1283), 4-methyl(prop-2-ynyl)amino-3,5-xylyl methylcarbamate (IUPAC name) (1285), 5,5-dimethyl-3-oxocyclohex-1-enyl dimethylcarbamate (IUPAC name) (1085), abamectin (1), acephate (2), acetamiprid (4), acethion (alternative name) [CCN], acetoprole [CCN], acrinathrin (9), acrylonitrile (IUPAC name) (861), alanycarb (15), aldicarb (16), aldoxycarb (863), aldrin (864), allethrin (17), allosamidin (alternative name) [CCN], allyxycarb (866), alpha-cypermethrin (202), alpha-ecdysone (alternative name) [CCN], aluminium phosphide (640), amidithion (870), amidothioate (872), aminocarb (873), amiton (875), amiton hydrogen oxalate (875), amitraz (24), anabasine (877), athidathion (883), AVI 382 (compound code), AZ 60541 (compound code), azadirachtin (alternative name) (41), azamethiphos (42), azinphos-ethyl (44), azinphos-methyl (45), azothoate (889), Bacillus thuringiensis delta endotoxins (alternative name) (52), barium hexafluorosilicate (alternative name) [CCN], barium polysulfide (IUPAC/Chemical Abstracts name) (892), barthrin [CCN], BAS 320 I (compound code), Bayer 22/190 (development code) (893), Bayer 22408 (development code) (894), bendiocarb (58), benfuracarb (60), bensultap (66), beta-cyfluthrin (194), beta-cypermethrin (203), bifenthrin (76), bioallethrin (78), bioallethrin S-cyclopentenyl isomer (alternative name) (79), bioethanomethrin [CCN], biopermethrin (908), bioresmethrin (80), bis(2-chloroethyl)ether (IUPAC name) (909), bistrifluoron (83), borax (86), brofenvalerate (alternative name), bromfenvinfos (914), bromocyclen (918), bromo-DDT (alternative name) [CCN], bromophos (920), bromophos-ethyl (921), bufencarb (924), buprofezin (99), butacarb (926), butathiofos (927), butocarboxim (103), butonate (932), butoxycarboxim (104), butylpyridaben (alternative name), cadusafos (109), calcium arsenate [CCN], calcium cyamide (444), calcium polysulfide (IUPAC name) (111), camphechlor (941), carbanolate (943), carbaryl (115), carbofuran (118), carbon disulfide (IUPAC/Chemical Abstracts name) (945), carbon tetrachloride (IUPAC name) (946), carbophenothion (947), carbosulfan (119), cartap (123), cartap hydrochloride (123), cevadine (alternative name) (725), chlorbicyclen (960), chlordane (128), chlordecone (963), chlordimeform (964), chlordimeform hydrochloride (964), chlorethoxyfos (129), chlorfenapyr (130), chlorfenvinphos (131), chlorfluazuron (132), chlormephos (136), chloroform [CCN], chloropicrin (141), chlorphoxim (989), chlorprazophos (990), chlorpyrifos (145), chlorpyrifos-methyl (146), chlorthiophos (994), chromafenozide (150), cinerin I (696), cinerin II (696), cinerins (696), cis-resmethrin (alternative name), cismethrin (80), clocythrin (alternative name), cloethocarb (999), closantel (alternative name) [CCN], clothianidin (165), copper acetoarsenite [CCN], copper arsenate [CCN], copper oleate [CCN], coumaphos (174), coumithoate (1006), crotamiton (alternative name) [CCN], crotoxyphos (1010), crufomate (1011), cryolite (alternative name) (177), CS 708 (development code) (1012), cyanofenphos (1019), cyanophos (184), cyanthoate (1020), cyclethrin [CCN], cycloprothrin (188), cyfluthrin (193), cyhalothrin (196), cypermethrin (201), cyphenothrin (206), cyromazine (209), cythioate (alternative name) [CCN], d-limonene (alternative name) [CCN], d-tetramethrin (alternative name) (788), DAEP (1031), dazomet (216), DDT (219), decarbofuran (1034), deltamethrin (223), demephion (1037), demephion-O (1037), demephion-S (1037), demeton (1038), demeton-methyl (224), demeton-O (1038), demeton-O-methyl (224), demeton-S (1038), demeton-5-methyl (224), demeton-5-methylsulphon (1039), diafenthiuron (226), dialifos (1042), diamidafos (1044), diazinon (227), dicapthon (1050), dichlofenthion (1051), dichlorvos (236), dicliphos (alternative name), dicresyl (alternative name) [CCN], dicrotophos (243), dicyclanil (244), dieldrin (1070), diethyl 5-methylpyrazol-3-yl phosphate (IUPAC name) (1076), diflubenzuron (250), dilor (alternative name) [CCN], dimefluthrin [CCN], dimefox (1081), dimetan (1085), dimethoate (262), dimethrin (1083), dimethylvinphos (265), dimetilan (1086), dinex (1089), dinex-diclexine (1089), dinoprop (1093), dinosam (1094), dinoseb (1095), dinotefuran (271), diofenolan (1099), dioxabenzofos (1100), dioxacarb (1101), dioxathion (1102), disulfoton (278), dithicrofos (1108), DNOC (282), doramectin (alternative name) [CCN], DSP (1115), ecdysterone (alternative name) [CCN], EI 1642 (development code) (1118), emamectin (291), emamectin benzoate (291), EMPC (1120), empenthrin (292), endosulfan (294), endothion (1121), endrin (1122), EPBP (1123), EPN (297), epofenonane (1124), eprinomectin (alternative name) [CCN], esfenvalerate (302), etaphos (alternative name) [CCN], ethiofencarb (308), ethion (309), ethiprole (310), ethoate-methyl (1134), ethoprophos (312), ethyl formate (IUPAC name) [CCN], ethyl-DDD (alternative name) (1056), ethylene dibromide (316), ethylene dichloride (chemical name) (1136), ethylene oxide [CCN], etofenprox (319), etrimfos (1142), EXD (1143), famphur (323), fenamiphos (326), fenazaflor (1147), fenchlorphos (1148), fenethacarb (1149), fenfluthrin (1150), fenitrothion (335), fenobucarb (336), fenoxacrim (1153), fenoxycarb (340), fenpirithrin (1155), fenpropathrin (342), fenpyrad (alternative name), fensulfothion (1158), fenthion (346), fenthion-ethyl [CCN], fenvalerate (349), fipronil (354), flonicamid (358), flucofuron (1168), flucycloxuron (366), flucythrinate (367), fluenetil (1169), flufenerim [CCN], flufenoxuron (370), flufenprox (1171), flumethrin (372), fluvalinate (1184), FMC 1137 (development code) (1185), fonofos (1191), formetanate (405), formetanate hydrochloride (405), formothion (1192), formparanate (1193), fosmethilan (1194), fospirate (1195), fosthiazate (408), fosthietan (1196), furathiocarb (412), furethrin (1200), gamma-cyhalothrin (197), gamma-HCH (430), guazatine (422), guazatine acetates (422), GY-81 (development code) (423), halfenprox (424), halofenozide (425), HCH (430), HEOD (1070), heptachlor (1211), heptenophos (432), heterophos [CCN], hexaflumuron (439), HHDN (864), hydramethylnon (443), hydrogen cyamide (444), hydroprene (445), hyquincarb (1223), imidacloprid (458), imiprothrin (460), indoxacarb (465), iodomethane (IUPAC name) (542), IPSP (1229), isazofos (1231), isobenzan (1232), isocarbophos (alternative name) (473), isodrin (1235), isofenphos (1236), isolane (1237), isoprocarb (472), isopropyl O-(methoxyaminothiophosphoryl)salicylate (IUPAC name) (473), isoprothiolane (474), isothioate (1244), isoxathion (480), ivermectin (alternative name) [CCN], jasmolin I (696), jasmolin II (696), jodfenphos (1248), juvenile hormone I (alternative name) [CCN], juvenile hormone II (alternative name) [CCN], juvenile hormone III (alternative name) [CCN], kelevan (1249), kinoprene (484), lambda-cyhalothrin (198), lead arsenate [CCN], leptophos (1250), lindane (430), lirimfos (1251), lufenuron (490), lythidathion (1253), m-cumenyl methylcarbamate (IUPAC name) (1014), magnesium phosphide (IUPAC name) (640), malathion (492), malonoben (1254), mazidox (1255), mecarbam (502), mecarphon (1258), menazon (1260), mephosfolan (1261), mercurous chloride (513), mesulfenfos (1263), metam (519), metam-potassium (alternative name) (519), metam-sodium (519), methacrifos (1266), methamidophos (527), methanesulfonyl fluoride (IUPAC/Chemical Abstracts name) (1268), methidathion (529), methiocarb (530), methocrotophos (1273), methomyl (531), methoprene (532), methoquin-butyl (1276), methothrin (alternative name) (533), methoxychlor (534), methoxyfenozide (535), methyl bromide (537), methyl isothiocyanate (543), methylchloroform (alternative name) [CCN], methylene chloride [CCN], metofluthrin [CCN], metolcarb (550), metoxadiazone (1288), mevinphos (556), mexacarbate (1290), milbemectin (557), milbemycin oxime (alternative name) [CCN], mipafox (1293), mirex (1294), monocrotophos (561), morphothion (1300), moxidectin (alternative name) [CCN], naftalofos (alternative name) [CCN], naled (567), naphthalene (IUPAC/Chemical Abstracts name) (1303), NC-170 (development code) (1306), NC-184 (compound code), nicotine (578), nicotine sulfate (578), nifluridide (1309), nitenpyram (579), nithiazine (1311), nitrilacarb (1313), nitrilacarb 1:1 zinc chloride complex (1313), NNI-0101 (compound code), NNI-0250 (compound code), nornicotine (traditional name) (1319), novaluron (585), noviflumuron (586), O-2,5-dichloro-4-iodophenyl O-ethyl ethylphosphonothioate (IUPAC name) (1057), O,O-diethyl O-4-methyl-2-oxo-2H-chromen-7-yl phosphorothioate (IUPAC name) (1074), O,O-diethyl O-6-methyl-2-propylpyrimidin-4-yl phosphorothioate (IUPAC name) (1075), O,O,O′,O′-tetrapropyl dithiopyrophosphate (IUPAC name) (1424), oleic acid (IUPAC name) (593), omethoate (594), oxamyl (602), oxydemeton-methyl (609), oxydeprofos (1324), oxydisulfoton (1325), pp′-DDT (219), para-dichlorobenzene [CCN], parathion (615), parathion-methyl (616), penfluoron (alternative name) [CCN], pentachlorophenol (623), pentachlorophenyl laurate (IUPAC name) (623), permethrin (626), petroleum oils (alternative name) (628), PH 60-38 (development code) (1328), phenkapton (1330), phenothrin (630), phenthoate (631), phorate (636), phosalone (637), phosfolan (1338), phosmet (638), phosnichlor (1339), phosphamidon (639), phosphine (IUPAC name) (640), phoxim (642), phoxim-methyl (1340), pirimetaphos (1344), pirimicarb (651), pirimiphos-ethyl (1345), pirimiphos-methyl (652), polychlorodicyclopentadiene isomers (IUPAC name) (1346), polychloroterpenes (traditional name) (1347), potassium arsenite [CCN], potassium thiocyanate [CCN], prallethrin (655), precocene I (alternative name) [CCN], precocene II (alternative name) [CCN], precocene III (alternative name) [CCN], primidophos (1349), profenofos (662), profluthrin [CCN], promacyl (1354), promecarb (1355), propaphos (1356), propetamphos (673), propoxur (678), prothidathion (1360), prothiofos (686), prothoate (1362), protrifenbute [CCN], pymetrozine (688), pyraclofos (689), pyrazophos (693), pyresmethrin (1367), pyrethrin I (696), pyrethrin II (696), pyrethrins (696), pyridaben (699), pyridalyl (700), pyridaphenthion (701), pyrimidifen (706), pyrimitate (1370), pyriproxyfen (708), quassia (alternative name) [CCN], quinalphos (711), quinalphos-methyl (1376), quinothion (1380), quintiofos (1381), R-1492 (development code) (1382), rafoxanide (alternative name) [CCN], resmethrin (719), rotenone (722), RU 15525 (development code) (723), RU 25475 (development code) (1386), ryania (alternative name) (1387), ryanodine (traditional name) (1387), sabadilla (alternative name) (725), schradan (1389), sebufos (alternative name), selamectin (alternative name) [CCN], SI-0009 (compound code), silafluofen (728), SN 72129 (development code) (1397), sodium arsenite [CCN], sodium cyamide (444), sodium fluoride (IUPAC/Chemical Abstracts name) (1399), sodium hexafluorosilicate (1400), sodium pentachlorophenoxide (623), sodium selenate (IUPAC name) (1401), sodium thiocyanate [CCN], sophamide (1402), spinosad (737), spiromesifen (739), sulcofuron (746), sulcofuron-sodium (746), sulfluramid (750), sulfotep (753), sulfuryl fluoride (756), sulprofos (1408), tar oils (alternative name) (758), tau-fluvalinate (398), tazimcarb (1412), TDE (1414), tebufenozide (762), tebufenpyrad (763), tebupirimfos (764), teflubenzuron (768), tefluthrin (769), temephos (770), TEPP (1417), terallethrin (1418), terbam (alternative name), terbufos (773), tetrachloroethane [CCN], tetrachlorvinphos (777), tetramethrin (787), theta-cypermethrin (204), thiacloprid (791), thiafenox (alternative name), thiamethoxam (792), thicrofos (1428), thiocarboxime (1431), thiocyclam (798), thiocyclam hydrogen oxalate (798), thiodicarb (799), thiofanox (800), thiometon (801), thionazin (1434), thiosultap (803), thiosultap-sodium (803), thuringiensin (alternative name) [CCN], tolfenpyrad (809), tralomethrin (812), transfluthrin (813), transpermethrin (1440), triamiphos (1441), triazamate (818), triazophos (820), triazuron (alternative name), trichlorfon (824), trichlormetaphos-3 (alternative name) [CCN], trichloronat (1452), trifenofos (1455), triflumuron (835), trimethacarb (840), triprene (1459), vamidothion (847), vaniliprole [CCN], veratridine (alternative name) (725), veratrine (alternative name) (725), XMC (853), xylylcarb (854), YI-5302 (compound code), zeta-cypermethrin (205), zetamethrin (alternative name), zinc phosphide (640), zolaprofos (1469) and ZXI 8901 (development code) (858),
a molluscicide selected from the group of substances consisting of bis(tributyltin)oxide (IUPAC name) (913), bromoacetamide [CCN], calcium arsenate [CCN], cloethocarb (999), copper acetoarsenite [CCN], copper sulfate (172), fentin (347), ferric phosphate (IUPAC name) (352), metaldehyde (518), methiocarb (530), niclosamide (576), niclosamide-olamine (576), pentachlorophenol (623), sodium pentachlorophenoxide (623), tazimcarb (1412), thiodicarb (799), tributyltin oxide (913), trifenmorph (1454), trimethacarb (840), triphenyltin acetate (IUPAC name) (347) and triphenyltin hydroxide (IUPAC name) (347),
a nematicide selected from the group of substances consisting of 1,2-dibromo-3-chloropropane (IUPAC/Chemical Abstracts name) (1045), 1,2-dichloropropane (IUPAC/Chemical Abstracts name) (1062), 1,2-dichloropropane with 1,3-dichloropropene (IUPAC name) (1063), 1,3-dichloropropene (233), 3,4-dichlorotetrahydrothiophene 1,1-dioxide (IUPAC/Chemical Abstracts name) (1065), 3-(4-chlorophenyl)-5-methylrhodanine (IUPAC name) (980), 5-methyl-6-thioxo-1,3,5-thiadiazinan-3-ylacetic acid (IUPAC name) (1286), 6-isopentenylaminopurine (alternative name) (210), abamectin (1), acetoprole [CCN], alanycarb (15), aldicarb (16), aldoxycarb (863), AZ 60541 (compound code), benclothiaz [CCN], benomyl (62), butylpyridaben (alternative name), cadusafos (109), carbofuran (118), carbon disulfide (945), carbosulfan (119), chloropicrin (141), chlorpyrifos (145), cloethocarb (999), cytokinins (alternative name) (210), dazomet (216), DBCP (1045), DCIP (218), diamidafos (1044), dichlofenthion (1051), dicliphos (alternative name), dimethoate (262), doramectin (alternative name) [CCN], emamectin (291), emamectin benzoate (291), eprinomectin (alternative name) [CCN], ethoprophos (312), ethylene dibromide (316), fenamiphos (326), fenpyrad (alternative name), fensulfothion (1158), fosthiazate (408), fosthietan (1196), furfural (alternative name) [CCN], GY-81 (development code) (423), heterophos [CCN], iodomethane (IUPAC name) (542), isamidofos (1230), isazofos (1231), ivermectin (alternative name) [CCN], kinetin (alternative name) (210), mecarphon (1258), metam (519), metam-potassium (alternative name) (519), metam-sodium (519), methyl bromide (537), methyl isothiocyanate (543), milbemycin oxime (alternative name) [CCN], moxidectin (alternative name) [CCN], Myrothecium verrucaria composition (alternative name) (565), NC-184 (compound code), oxamyl (602), phorate (636), phosphamidon (639), phosphocarb [CCN], sebufos (alternative name), selamectin (alternative name) [CCN], spinosad (737), terbam (alternative name), terbufos (773), tetrachlorothiophene (IUPAC/Chemical Abstracts name) (1422), thiafenox (alternative name), thionazin (1434), triazophos (820), triazuron (alternative name), xylenols [CCN], YI-5302 (compound code) and zeatin (alternative name) (210),
a nitrification inhibitor selected from the group of substances consisting of potassium ethylxanthate [CCN] and nitrapyrin (580),
a plant activator selected from the group of substances consisting of acibenzolar (6), acibenzolar-5-methyl (6), probenazole (658) and Reynoutria sachalinensis extract (alternative name) (720),
a rodenticide selected from the group of substances consisting of 2-isovalerylindan-1,3-dione (IUPAC name) (1246), 4-(quinoxalin-2-ylamino)benzenesulfonamide (IUPAC name) (748), alpha-chlorohydrin [CCN], aluminium phosphide (640), antu (880), arsenous oxide (882), barium carbonate (891), bisthiosemi (912), brodifacoum (89), bromadiolone (91), bromethalin (92), calcium cyamide (444), chloralose (127), chlorophacinone (140), cholecalciferol (alternative name) (850), coumachlor (1004), coumafuryl (1005), coumatetralyl (175), crimidine (1009), difenacoum (246), difethialone (249), diphacinone (273), ergocalciferol (301), flocoumafen (357), fluoroacetamide (379), flupropadine (1183), flupropadine hydrochloride (1183), gamma-HCH (430), HCH (430), hydrogen cyamide (444), iodomethane (IUPAC name) (542), lindane (430), magnesium phosphide (IUPAC name) (640), methyl bromide (537), norbormide (1318), phosacetim (1336), phosphine (IUPAC name) (640), phosphorus [CCN], pindone (1341), potassium arsenite [CCN], pyrinuron (1371), scilliroside (1390), sodium arsenite [CCN], sodium cyamide (444), sodium fluoro-acetate (735), strychnine (745), thallium sulfate [CCN], warfarin (851) and zinc phosphide (640),
a synergist selected from the group of substances consisting of 2-(2-butoxyethoxy)ethyl piperonylate (IUPAC name) (934), 5-(1,3-benzodioxol-5-yl)-3-hexylcyclohex-2-enone (IUPAC name) (903), farnesol with nerolidol (alternative name) (324), MB-599 (development code) (498), MGK 264 (development code) (296), piperonyl butoxide (649), piprotal (1343), propyl isomer (1358), S421 (development code) (724), sesamex (1393), sesasmolin (1394) and sulfoxide (1406),
an animal repellent selected from the group of substances consisting of anthraquinone (32), chloralose (127), copper naphthenate [CCN], copper oxychloride (171), diazinon (227), dicyclopentadiene (chemical name) (1069), guazatine (422), guazatine acetates (422), methiocarb (530), pyridin-4-amine (IUPAC name) (23), thiram (804), trimethacarb (840), zinc naphthenate [CCN] and ziram (856),
a virucide selected from the group of substances consisting of imanin (alternative name) [CCN] and ribavirin (alternative name) [CCN],
and a wound protectant selected from the group of substances consisting of mercuric oxide (512), octhilinone (590) and thiophanate-methyl (802).

A very especially preferred embodiment of the subject-matter {1.1.13} of the invention is {1.1.13.2} a pesticidal composition comprising a mixture consisting of at least two substances, namely one compound (A) and at least one compound (B), as active ingredient and at least one auxiliary, wherein the compound (A) is the compound of formula (A-13) and the compound (B) is a compound selected from the group of substances consisting of abamectin (1), cyromazine (209), diafenthiuron (226), diazinon (227), emamectin benzoate (291), fenoxycarb (340), fosthiazate (408), lambda-cyhalothrin (198), lufenuron (490), methidathion (529), profenofos (662), pymetrozine (688), tefluthrin (769) and thiamethoxam (792).

The compound of formula (A-13) is known, for example, from the PCT Application WO-03/015519.

A preferred embodiment of the subject-matter {1.1} of the invention is {1.1.14} a pesticidal composition comprising a mixture consisting of at least two substances, namely one compound (A) and at least one compound (B), as active ingredient and at least one auxiliary, wherein the compound (A) is the compound of formula (A-14) 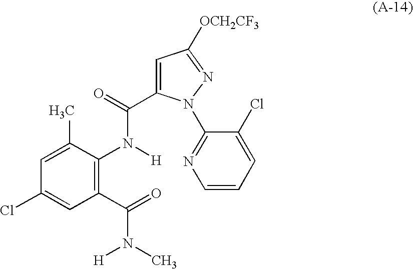
and the compound (B) is a compound selected from the group of substances consisting of an adjuvant, an acaricide, an algicide, an anthelmintic, an avicide, a bactericide, a biological agent, a soil sterilant, a chemosterilant, an insect pheromone, an insect repellent, an insecticide, a molluscicide, a nematicide, a nitrification inhibitor, a plant activator, a rodenticide, a synergist, an animal repellent, a virucide and a wound protectant.

An especially preferred embodiment of the subject-matter {1.1.14} of the invention is {1.1.14.1} a pesticidal composition comprising a mixture consisting of at least two substances, namely one compound (A) and at least one compound (B), as active ingredient and at least one auxiliary, wherein the compound (A) is the compound of formula (A-14) and the compound (B) is a compound selected from the group of substances consisting of
an adjuvant selected from the group of substances consisting of petroleum oils (alternative name) (628),
an acaricide selected from the group of substances consisting of 1,1-bis(4-chlorophenyl)-2-ethoxyethanol (IUPAC name) (910), 2,4-dichlorophenyl benzenesulfonate (IUPAC/Chemical Abstracts name) (1059), 2-fluoro-N-methyl-N-1-naphthylacetamide (IUPAC name) (1295), 4-chlorophenyl phenyl sulfone (IUPAC name) (981), abamectin (1), acequinocyl (3), acetoprole [CCN], acrinathrin (9), aldicarb (16), aldoxycarb (863), alpha-cypermethrin (202), amidithion (870), amidoflumet [CCN], amidothioate (872), amiton (875), amiton hydrogen oxalate (875), amitraz (24), aramite (881), arsenous oxide (882), AVI 382 (compound code), AZ 60541 (compound code), azinphos-ethyl (44), azinphos-methyl (45), azobenzene (IUPAC name) (888), azocyclotin (46), azothoate (889), benomyl (62), benoxafos (alternative name) [CCN], benzoximate (71), benzyl benzoate (IUPAC name) [CCN], bifenazate (74), bifenthrin (76), binapacryl (907), brofenvalerate (alternative name), bromocyclen (918), bromophos (920), bromophos-ethyl (921), bromopropylate (94), buprofezin (99), butocarboxim (103), butoxycarboxim (104), butylpyridaben (alternative name), calcium polysulfide (IUPAC name) (111), camphechlor (941), carbanolate (943), carbaryl (115), carbofuran (118), carbophenothion (947), CGA 50'439 (development code) (125), chinomethionat (126), chlorbenside (959), chlordimeform (964), chlordimeform hydrochloride (964), chlorfenapyr (130), chlorfenethol (968), chlorfenson (970), chlorfensulphide (971), chlorfenvinphos (131), chlorobenzilate (975), chloromebuform (977), chloromethiuron (978), chloropropylate (983), chlorpyrifos (145), chlorpyrifos-methyl (146), chlorthiophos (994), cinerin I (696), cinerin II (696), cinerins (696), clofentezine (158), closantel (alternative name) [CCN], coumaphos (174), crotamiton (alternative name) [CCN], crotoxyphos (1010), cufraneb (1013), cyanthoate (1020), cyhalothrin (196), cyhexatin (199), cypermethrin (201), DCPM (1032), DDT (219), demephion (1037), demephion-O (1037), demephion-S (1037), demeton (1038), demeton-methyl (224), demeton-O (1038), demeton-O-methyl (224), demeton-S (1038), demeton-5-methyl (224), demeton-5-methylsulphon (1039), diafenthiuron (226), dialifos (1042), diazinon (227), dichlofluanid (230), dichlorvos (236), dicliphos (alternative name), dicofol (242), dicrotophos (243), dienochlor (1071), dimefox (1081), dimethoate (262), dinactin (alternative name) (653), dinex (1089), dinex-diclexine (1089), dinobuton (269), dinocap (270), dinocap-4 [CCN], dinocap-6 [CCN], dinocton (1090), dinopenton (1092), dinosulfon (1097), dinoterbon (1098), dioxathion (1102), diphenyl sulfone (IUPAC name) (1103), disulfuram (alternative name) [CCN], disulfoton (278), DNOC (282), dofenapyn (1113), doramectin (alternative name) [CCN], endosulfan (294), endothion (1121), EPN (297), eprinomectin (alternative name) [CCN], ethion (309), ethoate-methyl (1134), etoxazole (320), etrimfos (1142), fenazaflor (1147), fenazaquin (328), fenbutatin oxide (330), fenothiocarb (337), fenpropathrin (342), fenpyrad (alternative name), fenpyroximate (345), fenson (1157), fentrifanil (1161), fenvalerate (349), fipronil (354), fluacrypyrim (360), fluazuron (1166), flubenzimine (1167), flucycloxuron (366), flucythrinate (367), fluenetil (1169), flufenoxuron (370), flumethrin (372), fluorbenside (1174), fluvalinate (1184), FMC 1137 (development code) (1185), formetanate (405), formetanate hydrochloride (405), formothion (1192), formparanate (1193), gamma-HCH (430), glyodin (1205), halfenprox (424), heptenophos (432), hexadecyl cyclopropanecarboxylate (IUPAC/Chemical Abstracts name) (1216), hexythiazox (441), iodomethane (IUPAC name) (542), isocarbophos (alternative name) (473), isopropyl O-(methoxyaminothiophosphoryl)salicylate (IUPAC name) (473), ivermectin (alternative name) [CCN], jasmolin I (696), jasmolin II (696), jodfenphos (1248), lindane (430), lufenuron (490), malathion (492), malonoben (1254), mecarbam (502), mephosfolan (1261), mesulfen (alternative name) [CCN], methacrifos (1266), methamidophos (527), methidathion (529), methiocarb (530), methomyl (531), methyl bromide (537), metolcarb (550), mevinphos (556), mexacarbate (1290), milbemectin (557), milbemycin oxime (alternative name) [CCN], mipafox (1293), monocrotophos (561), morphothion (1300), moxidectin (alternative name) [CCN], naled (567), NC-184 (compound code), nifluridide (1309), nikkomycins (alternative name) [CCN], nitrilacarb (1313), nitrilacarb 1:1 zinc chloride complex (1313), NNI-0101 (compound code), NNI-0250 (compound code), omethoate (594), oxamyl (602), oxydeprofos (1324), oxydisulfoton (1325), pp′-DDT (219), parathion (615), permethrin (626), petroleum oils (alternative name) (628), phenkapton (1330), phenthoate (631), phorate (636), phosalone (637), phosfolan (1338), phosmet (638), phosphamidon (639), phoxim (642), pirimiphos-methyl (652), polychloroterpenes (traditional name) (1347), polynactins (alternative name) (653), proclonol (1350), profenofos (662), promacyl (1354), propargite (671), propetamphos (673), propoxur (678), prothidathion (1360), prothoate (1362), pyrethrin I (696), pyrethrin II (696), pyrethrins (696), pyridaben (699), pyridaphenthion (701), pyrimidifen (706), pyrimitate (1370), quinalphos (711), quintiofos (1381), R-1492 (development code) (1382), RA-17 (development code) (1383), rotenone (722), schradan (1389), sebufos (alternative name), selamectin (alternative name) [CCN], SI-0009 (compound code), sophamide (1402), spirodiclofen (738), spiromesifen (739), SSI-121 (development code) (1404), sulfuram (alternative name) [CCN], sulfluramid (750), sulfotep (753), sulfur (754), SZI-121 (development code) (757), tau-fluvalinate (398), tebufenpyrad (763), TEPP (1417), terbam (alternative name), tetrachlorvinphos (777), tetradifon (786), tetranactin (alternative name) (653), tetrasul (1425), thiafenox (alternative name), thiocarboxime (1431), thiofanox (800), thiometon (801), thioquinox (1436), thuringiensin (alternative name) [CCN], triamiphos (1441), triarathene (1443), triazophos (820), triazuron (alternative name), trichlorfon (824), trifenofos (1455), trinactin (alternative name) (653), vamidothion (847), vaniliprole [CCN] and YI-5302 (compound code),
an algicide selected from the group of substances consisting of bethoxazin [CCN], copper dioctanoate (IUPAC name) (170), copper sulfate (172), cybutryne [CCN], dichlone (1052), dichlorophen (232), endothal (295), fentin (347), hydrated lime [CCN], nabam (566), quinoclamine (714), quinonamid (1379), simazine (730), triphenyltin acetate (IUPAC name) (347) and triphenyltin hydroxide (IUPAC name) (347),
an anthelmintic selected from the group of substances consisting of abamectin (1), crufomate (1011), doramectin (alternative name) [CCN], emamectin (291), emamectin benzoate (291), eprinomectin (alternative name) [CCN], ivermectin (alternative name) [CCN], milbemycin oxime (alternative name) [CCN], moxidectin (alternative name) [CCN], piperazine [CCN], selamectin (alternative name) [CCN], spinosad (737) and thiophanate (1435),
an avicide selected from the group of substances consisting of chloralose (127), endrin (1122), fenthion (346), pyridin-4-amine (IUPAC name) (23) and strychnine (745),
a bactericide selected from the group of substances consisting of 1-hydroxy-1H-pyridine-2-thione (IUPAC name) (1222), 4-(quinoxalin-2-ylamino)benzenesulfonamide (IUPAC name) (748), 8-hydroxyquinoline sulfate (446), bronopol (97), copper dioctanoate (IUPAC name) (170), copper hydroxide (IUPAC name) (169), cresol [CCN], dichlorophen (232), dipyrithione (1105), dodicin (1112), fenaminosulf (1144), formaldehyde (404), hydrargaphen (alternative name) [CCN], kasugamycin (483), kasugamycin hydrochloride hydrate (483), nickel bis(dimethyldithiocarbamate) (IUPAC name) (1308), nitrapyrin (580), octhilinone (590), oxolinic acid (606), oxytetracycline (611), potassium hydroxyquinoline sulfate (446), probenazole (658), streptomycin (744), streptomycin sesquisulfate (744), tecloftalam (766) and thiomersal (alternative name) [CCN],
a biological agent selected from the group of substances consisting of Adoxophyes orana GV (alternative name) (12), Agrobacterium radiobacter (alternative name) (13), Amblyseius spp. (alternative name) (19), Anagrapha falcifera NPV (alternative name) (28), Anagrus atomus (alternative name) (29), Aphelinus abdominalis (alternative name) (33), Aphidius colemani (alternative name) (34), Aphidoletes aphidimyza (alternative name) (35), Autographa californica NPV (alternative name) (38), Bacillus firmus (alternative name) (48), Bacillus sphaericus Neide (scientific name) (49), Bacillus thuringiensis Berliner (scientific name) (51), Bacillus thuringiensis subsp. aizawai (scientific name) (51), Bacillus thuringiensis subsp. israelensis (scientific name) (51), Bacillus thuringiensis subsp. japonensis (scientific name) (51), Bacillus thuringiensis subsp. kurstaki (scientific name) (51), Bacillus thuringiensis subsp. tenebrionis (scientific name) (51), Beauveria bassiana (alternative name) (53), Beauveria brongniartii (alternative name) (54), Chrysoperla carnea (alternative name) (151), Cryptolaemus montrouzieri (alternative name) (178), Cydia pomonella GV (alternative name) (191), Dacnusa sibirica (alternative name) (212), Diglyphus isaea (alternative name) (254), Encarsia formosa (scientific name) (293), Eretmocerus eremicus (alternative name) (300), Helicoverpa zea NPV (alternative name) (431), Heterorhabditis bacteriophora and H. megidis (alternative name) (433), Hippodamia convergens (alternative name) (442), Leptomastix dactylopii (alternative name) (488), Macrolophus caliginosus (alternative name) (491), Mamestra brassicae NPV (alternative name) (494), Metaphycus helvolus (alternative name) (522), Metarhizium anisopliae var. acridum (scientific name) (523), Metarhizium anisopliae var. anisopliae (scientific name) (523), Neodiprion sertifer NPV and N. lecontei NPV (alternative name) (575), Orius spp. (alternative name) (596), Paecilomyces fumosoroseus (alternative name) (613), Phytoseiulus persimilis (alternative name) (644), Spodoptera exigua multicapsid nuclear polyhedrosis virus (scientific name) (741), Steinernema bibionis (alternative name) (742), Steinernema carpocapsae (alternative name) (742), Steinernema feltiae (alternative name) (742), Steinernema glaseri (alternative name) (742), Steinernema riobrave (alternative name) (742), Steinernema riobravis (alternative name) (742), Steinernema scapterisci (alternative name) (742), Steinernema spp. (alternative name) (742), Trichogramma spp. (alternative name) (826), Typhlodromus occidentalis (alternative name) (844) and Verticillium lecanii (alternative name) (848),
a soil sterilant selected from the group of substances consisting of iodomethane (IUPAC name) (542) and methyl bromide (537),
a chemosterilant selected from the group of substances consisting of apholate [CCN], bisazir (alternative name) [CCN], busulfan (alternative name) [CCN], diflubenzuron (250), dimatif (alternative name) [CCN], hemel [CCN], hempa [CCN], metepa [CCN], methiotepa [CCN], methyl apholate [CCN], morzid [CCN], penfluoron (alternative name) [CCN], tepa [CCN], thiohempa (alternative name) [CCN], thiotepa (alternative name) [CCN], tretamine (alternative name) [CCN] and uredepa (alternative name) [CCN],
an insect pheromone selected from the group of substances consisting of (E)-dec-5-en-1-yl acetate with (E)-dec-5-en-1-ol (IUPAC name) (222), (E)-tridec-4-en-1-yl acetate (IUPAC name) (829), (E)-6-methylhept-2-en-4-ol (IUPAC name) (541), (E,Z)-tetradeca-4,10-dien-1-yl acetate (IUPAC name) (779), (Z)-dodec-7-en-1-yl acetate (IUPAC name) (285), (Z)-hexadec-11-enal (IUPAC name) (436), (Z)-hexadec-11-en-1-yl acetate (IUPAC name) (437), (Z)-hexadec-13-en-11-yn-1-yl acetate (IUPAC name) (438), (Z)-icos-13-en-10-one (IUPAC name) (448), (Z)-tetradec-7-en-1-al (IUPAC name) (782), (Z)-tetradec-9-en-1-ol (IUPAC name) (783), (Z)-tetradec-9-en-1-yl acetate (IUPAC name) (784), (7E,9Z)-dodeca-7,9-dien-1-yl acetate (IUPAC name) (283), (9Z,11E)-tetradeca-9,11-dien-1-yl acetate (IUPAC name) (780), (9Z,12E)-tetradeca-9,12-dien-1-yl acetate (IUPAC name) (781), 14-methyloctadec-1-ene (IUPAC name) (545), 4-methylnonan-5-ol with 4-methylnonan-5-one (IUPAC name) (544), alpha-multistriatin (alternative name) [CCN], brevicomin (alternative name) [CCN], codlelure (alternative name) [CCN], codlemone (alternative name) (167), cuelure (alternative name) (179), disparlure (277), dodec-8-en-1-yl acetate (IUPAC name) (286), dodec-9-en-1-yl acetate (IUPAC name) (287), dodeca-8,10-dien-1-yl acetate (IUPAC name) (284), dominicalure (alternative name) [CCN], ethyl 4-methyloctanoate (IUPAC name) (317), eugenol (alternative name) [CCN], frontalin (alternative name) [CCN], gossyplure (alternative name) (420), grandlure (421), grandlure I (alternative name) (421), grandlure II (alternative name) (421), grandlure III (alternative name) (421), grandlure IV (alternative name) (421), hexylure [CCN], ipsdienol (alternative name) [CCN], ipsenol (alternative name) [CCN], japonilure (alternative name) (481), lineatin (alternative name) [CCN], litlure (alternative name) [CCN], looplure (alternative name) [CCN], medlure [CCN], megatomoic acid (alternative name) [CCN], methyl eugenol (alternative name) (540), muscalure (563), octadeca-2,13-dien-1-yl acetate (IUPAC name) (588), octadeca-3,13-dien-1-yl acetate (IUPAC name) (589), orfralure (alternative name) [CCN], oryctalure (alternative name) (317), ostramone (alternative name) [CCN], siglure [CCN], sordidin (alternative name) (736), sulcatol (alternative name) [CCN], tetradec-11-en-1-yl acetate (IUPAC name) (785), trimedlure (839), trimedlure A (alternative name) (839), trimedlure B₁ (alternative name) (839), trimedlure B₂ (alternative name) (839), trimedlure C (alternative name) (839) and trunc-call (alternative name) [CCN],
an insect repellent selected from the group of substances consisting of 2-(octylthio)-ethanol (IUPAC name) (591), butopyronoxyl (933), butoxy(polypropylene glycol) (936), dibutyl adipate (IUPAC name) (1046), dibutyl phthalate (1047), dibutyl succinate (IUPAC name) (1048), diethyltoluamide [CCN], dimethyl carbate [CCN], dimethyl phthalate [CCN], ethyl hexanediol (1137), hexamide [CCN], methoquin-butyl (1276), methylneodecanamide [CCN], oxamate [CCN] and picaridin [CCN],
an insecticide selected from the group of substances consisting of 1,1-dichloro-1-nitroethane (IUPAC/Chemical Abstracts name) (1058), 1,1-dichloro-2,2-bis(4-ethylphenyl)-ethane (IUPAC name) (1056), 1,2-dichloropropane (IUPAC/Chemical Abstracts name) (1062), 1,2-dichloropropane with 1,3-dichloropropene (IUPAC name) (1063), 1-bromo-2-chloroethane (IUPAC/Chemical Abstracts name) (916), 2,2,2-trichloro-1-(3,4-dichloro-phenyl)ethyl acetate (IUPAC name) (1451), 2,2-dichlorovinyl 2-ethylsulfinylethyl methyl phosphate (IUPAC name) (1066), 2-(1,3-dithiolan-2-yl)phenyl dimethylcarbamate (IUPAC/Chemical Abstracts name) (1109), 2-(2-butoxyethoxy)ethyl thiocyanate (IUPAC/Chemical Abstracts name) (935), 2-(4,5-dimethyl-1,3-dioxolan-2-yl)phenyl methylcarbamate (IUPAC/Chemical Abstracts name) (1084), 2-(4-chloro-3,5-xylyloxy)ethanol (IUPAC name) (986), 2-chlorovinyl diethyl phosphate (IUPAC name) (984), 2-imidazolidone (IUPAC name) (1225), 2-isovalerylindan-1,3-dione (IUPAC name) (1246), 2-methyl(prop-2-ynyl)aminophenyl methylcarbamate (IUPAC name) (1284), 2-thiocyanatoethyl laurate (IUPAC name) (1433), 3-bromo-1-chloroprop-1-ene (IUPAC name) (917), 3-methyl-1-phenylpyrazol-5-yl dimethyl-carbamate (IUPAC name) (1283), 4-methyl(prop-2-ynyl)amino-3,5-xylyl methylcarbamate (IUPAC name) (1285), 5,5-dimethyl-3-oxocyclohex-1-enyl dimethylcarbamate (IUPAC name) (1085), abamectin (1), acephate (2), acetamiprid (4), acethion (alternative name) [CCN], acetoprole [CCN], acrinathrin (9), acrylonitrile (IUPAC name) (861), alanycarb (15), aldicarb (16), aldoxycarb (863), aldrin (864), allethrin (17), allosamidin (alternative name) [CCN], allyxycarb (866), alpha-cypermethrin (202), alpha-ecdysone (alternative name) [CCN], aluminium phosphide (640), amidithion (870), amidothioate (872), aminocarb (873), amiton (875), amiton hydrogen oxalate (875), amitraz (24), anabasine (877), athidathion (883), AVI 382 (compound code), AZ 60541 (compound code), azadirachtin (alternative name) (41), azamethiphos (42), azinphos-ethyl (44), azinphos-methyl (45), azothoate (889), Bacillus thuringiensis delta endotoxins (alternative name) (52), barium hexafluorosilicate (alternative name) [CCN], barium polysulfide (IUPAC/Chemical Abstracts name) (892), barthrin [CCN], BAS 320 I (compound code), Bayer 22/190 (development code) (893), Bayer 22408 (development code) (894), bendiocarb (58), benfuracarb (60), bensultap (66), beta-cyfluthrin (194), beta-cypermethrin (203), bifenthrin (76), bioallethrin (78), bioallethrin S-cyclopentenyl isomer (alternative name) (79), bioethanomethrin [CCN], biopermethrin (908), bioresmethrin (80), bis(2-chloroethyl)ether (IUPAC name) (909), bistrifluoron (83), borax (86), brofenvalerate (alternative name), bromfenvinfos (914), bromocyclen (918), bromo-DDT (alternative name) [CCN], bromophos (920), bromophos-ethyl (921), bufencarb (924), buprofezin (99), butacarb (926), butathiofos (927), butocarboxim (103), butonate (932), butoxycarboxim (104), butylpyridaben (alternative name), cadusafos (109), calcium arsenate [CCN], calcium cyamide (444), calcium polysulfide (IUPAC name) (111), camphechlor (941), carbanolate (943), carbaryl (115), carbofuran (118), carbon disulfide (IUPAC/Chemical Abstracts name) (945), carbon tetrachloride (IUPAC name) (946), carbophenothion (947), carbosulfan (119), cartap (123), cartap hydrochloride (123), cevadine (alternative name) (725), chlorbicyclen (960), chlordane (128), chlordecone (963), chlordimeform (964), chlordimeform hydrochloride (964), chlorethoxyfos (129), chlorfenapyr (130), chlorfenvinphos (131), chlorfluazuron (132), chlormephos (136), chloroform [CCN], chloropicrin (141), chlorphoxim (989), chlorprazophos (990), chlorpyrifos (145), chlorpyrifos-methyl (146), chlorthiophos (994), chromafenozide (150), cinerin I (696), cinerin II (696), cinerins (696), cis-resmethrin (alternative name), cismethrin (80), clocythrin (alternative name), cloethocarb (999), closantel (alternative name) [CCN], clothianidin (165), copper acetoarsenite [CCN], copper arsenate [CCN], copper oleate [CCN], coumaphos (174), coumithoate (1006), crotamiton (alternative name) [CCN], crotoxyphos (1010), crufomate (1011), cryolite (alternative name) (177), CS 708 (development code) (1012), cyanofenphos (1019), cyanophos (184), cyanthoate (1020), cyclethrin [CCN], cycloprothrin (188), cyfluthrin (193), cyhalothrin (196), cypermethrin (201), cyphenothrin (206), cyromazine (209), cythioate (alternative name) [CCN], d-limonene (alternative name) [CCN], d-tetramethrin (alternative name) (788), DAEP (1031), dazomet (216), DDT (219), decarbofuran (1034), deltamethrin (223), demephion (1037), demephion-O (1037), demephion-S (1037), demeton (1038), demeton-methyl (224), demeton-O (1038), demeton-O-methyl (224), demeton-S (1038), demeton-5-methyl (224), demeton-5-methylsulphon (1039), diafenthiuron (226), dialifos (1042), diamidafos (1044), diazinon (227), dicapthon (1050), dichlofenthion (1051), dichlorvos (236), dicliphos (alternative name), dicresyl (alternative name) [CCN], dicrotophos (243), dicyclanil (244), dieldrin (1070), diethyl 5-methylpyrazol-3-yl phosphate (IUPAC name) (1076), diflubenzuron (250), dilor (alternative name) [CCN], dimefluthrin [CCN], dimefox (1081), dimetan (1085), dimethoate (262), dimethrin (1083), dimethylvinphos (265), dimetilan (1086), dinex (1089), dinex-diclexine (1089), dinoprop (1093), dinosam (1094), dinoseb (1095), dinotefuran (271), diofenolan (1099), dioxabenzofos (1100), dioxacarb (1101), dioxathion (1102), disulfoton (278), dithicrofos (1108), DNOC (282), doramectin (alternative name) [CCN], DSP (1115), ecdysterone (alternative name) [CCN], EI 1642 (development code) (1118), emamectin (291), emamectin benzoate (291), EMPC (1120), empenthrin (292), endosulfan (294), endothion (1121), endrin (1122), EPBP (1123), EPN (297), epofenonane (1124), eprinomectin (alternative name) [CCN], esfenvalerate (302), etaphos (alternative name) [CCN], ethiofencarb (308), ethion (309), ethiprole (310), ethoate-methyl (1134), ethoprophos (312), ethyl formate (IUPAC name) [CCN], ethyl-DDD (alternative name) (1056), ethylene dibromide (316), ethylene dichloride (chemical name) (1136), ethylene oxide [CCN], etofenprox (319), etrimfos (1142), EXD (1143), famphur (323), fenamiphos (326), fenazaflor (1147), fenchlorphos (1148), fenethacarb (1149), fenfluthrin (1150), fenitrothion (335), fenobucarb (336), fenoxacrim (1153), fenoxycarb (340), fenpirithrin (1155), fenpropathrin (342), fenpyrad (alternative name), fensulfothion (1158), fenthion (346), fenthion-ethyl [CCN], fenvalerate (349), fipronil (354), flonicamid (358), flucofuron (1168), flucycloxuron (366), flucythrinate (367), fluenetil (1169), flufenerim [CCN], flufenoxuron (370), flufenprox (1171), flumethrin (372), fluvalinate (1184), FMC 1137 (development code) (1185), fonofos (1191), formetanate (405), formetanate hydrochloride (405), formothion (1192), formparanate (1193), fosmethilan (1194), fospirate (1195), fosthiazate (408), fosthietan (1196), furathiocarb (412), furethrin (1200), gamma-cyhalothrin (197), gamma-HCH (430), guazatine (422), guazatine acetates (422), GY-81 (development code) (423), halfenprox (424), halofenozide (425), HCH (430), HEOD (1070), heptachlor (1211), heptenophos (432), heterophos [CCN], hexaflumuron (439), HHDN (864), hydramethylnon (443), hydrogen cyamide (444), hydroprene (445), hyquincarb (1223), imidacloprid (458), imiprothrin (460), indoxacarb (465), iodomethane (IUPAC name) (542), IPSP (1229), isazofos (1231), isobenzan (1232), isocarbophos (alternative name) (473), isodrin (1235), isofenphos (1236), isolane (1237), isoprocarb (472), isopropyl O-(methoxyaminothiophosphoryl)salicylate (IUPAC name) (473), isoprothiolane (474), isothioate (1244), isoxathion (480), ivermectin (alternative name) [CCN], jasmolin I (696), jasmolin II (696), jodfenphos (1248), juvenile hormone I (alternative name) [CCN], juvenile hormone II (alternative name) [CCN], juvenile hormone III (alternative name) [CCN], kelevan (1249), kinoprene (484), lambda-cyhalothrin (198), lead arsenate [CCN], leptophos (1250), lindane (430), lirimfos (1251), lufenuron (490), lythidathion (1253), m-cumenyl methylcarbamate (IUPAC name) (1014), magnesium phosphide (IUPAC name) (640), malathion (492), malonoben (1254), mazidox (1255), mecarbam (502), mecarphon (1258), menazon (1260), mephosfolan (1261), mercurous chloride (513), mesulfenfos (1263), metam (519), metam-potassium (alternative name) (519), metam-sodium (519), methacrifos (1266), methamidophos (527), methanesulfonyl fluoride (IUPAC/Chemical Abstracts name) (1268), methidathion (529), methiocarb (530), methocrotophos (1273), methomyl (531), methoprene (532), methoquin-butyl (1276), methothrin (alternative name) (533), methoxychlor (534), methoxyfenozide (535), methyl bromide (537), methyl isothiocyanate (543), methylchloroform (alternative name) [CCN], methylene chloride [CCN], metofluthrin [CCN], metolcarb (550), metoxadiazone (1288), mevinphos (556), mexacarbate (1290), milbemectin (557), milbemycin oxime (alternative name) [CCN], mipafox (1293), mirex (1294), monocrotophos (561), morphothion (1300), moxidectin (alternative name) [CCN], naftalofos (alternative name) [CCN], naled (567), naphthalene (IUPAC/Chemical Abstracts name) (1303), NC-170 (development code) (1306), NC-184 (compound code), nicotine (578), nicotine sulfate (578), nifluridide (1309), nitenpyram (579), nithiazine (1311), nitrilacarb (1313), nitrilacarb 1:1 zinc chloride complex (1313), NNI-0101 (compound code), NNI-0250 (compound code), nornicotine (traditional name) (1319), novaluron (585), noviflumuron (586), O-2,5-dichloro-4-iodophenyl O-ethyl ethylphosphonothioate (IUPAC name) (1057), O,O-diethyl O-4-methyl-2-oxo-2H-chromen-7-yl phosphorothioate (IUPAC name) (1074), O,O-diethyl O-6-methyl-2-propylpyrimidin-4-yl phosphorothioate (IUPAC name) (1075), O,O,O′,O′-tetrapropyl dithiopyrophosphate (IUPAC name) (1424), oleic acid (IUPAC name) (593), omethoate (594), oxamyl (602), oxydemeton-methyl (609), oxydeprofos (1324), oxydisulfoton (1325), pp′-DDT (219), para-dichlorobenzene [CCN], parathion (615), parathion-methyl (616), penfluoron (alternative name) [CCN], pentachlorophenol (623), pentachlorophenyl laurate (IUPAC name) (623), permethrin (626), petroleum oils (alternative name) (628), PH 60-38 (development code) (1328), phenkapton (1330), phenothrin (630), phenthoate (631), phorate (636), phosalone (637), phosfolan (1338), phosmet (638), phosnichlor (1339), phosphamidon (639), phosphine (IUPAC name) (640), phoxim (642), phoxim-methyl (1340), pirimetaphos (1344), pirimicarb (651), pirimiphos-ethyl (1345), pirimiphos-methyl (652), polychlorodicyclopentadiene isomers (IUPAC name) (1346), polychloroterpenes (traditional name) (1347), potassium arsenite [CCN], potassium thiocyanate [CCN], prallethrin (655), precocene I (alternative name) [CCN], precocene II (alternative name) [CCN], precocene III (alternative name) [CCN], primidophos (1349), profenofos (662), profluthrin [CCN], promacyl (1354), promecarb (1355), propaphos (1356), propetamphos (673), propoxur (678), prothidathion (1360), prothiofos (686), prothoate (1362), protrifenbute [CCN], pymetrozine (688), pyraclofos (689), pyrazophos (693), pyresmethrin (1367), pyrethrin I (696), pyrethrin II (696), pyrethrins (696), pyridaben (699), pyridalyl (700), pyridaphenthion (701), pyrimidifen (706), pyrimitate (1370), pyriproxyfen (708), quassia (alternative name) [CCN], quinalphos (711), quinalphos-methyl (1376), quinothion (1380), quintiofos (1381), R-1492 (development code) (1382), rafoxanide (alternative name) [CCN], resmethrin (719), rotenone (722), RU 15525 (development code) (723), RU 25475 (development code) (1386), ryania (alternative name) (1387), ryanodine (traditional name) (1387), sabadilla (alternative name) (725), schradan (1389), sebufos (alternative name), selamectin (alternative name) [CCN], SI-0009 (compound code), silafluofen (728), SN 72129 (development code) (1397), sodium arsenite [CCN], sodium cyamide (444), sodium fluoride (IUPAC/Chemical Abstracts name) (1399), sodium hexafluorosilicate (1400), sodium pentachlorophenoxide (623), sodium selenate (IUPAC name) (1401), sodium thiocyanate [CCN], sophamide (1402), spinosad (737), spiromesifen (739), sulcofuron (746), sulcofuron-sodium (746), sulfluramid (750), sulfotep (753), sulfuryl fluoride (756), sulprofos (1408), tar oils (alternative name) (758), tau-fluvalinate (398), tazimcarb (1412), TDE (1414), tebufenozide (762), tebufenpyrad (763), tebupirimfos (764), teflubenzuron (768), tefluthrin (769), temephos (770), TEPP (1417), terallethrin (1418), terbam (alternative name), terbufos (773), tetrachloroethane [CCN], tetrachlorvinphos (777), tetramethrin (787), theta-cypermethrin (204), thiacloprid (791), thiafenox (alternative name), thiamethoxam (792), thicrofos (1428), thiocarboxime (1431), thiocyclam (798), thiocyclam hydrogen oxalate (798), thiodicarb (799), thiofanox (800), thiometon (801), thionazin (1434), thiosultap (803), thiosultap-sodium (803), thuringiensin (alternative name) [CCN], tolfenpyrad (809), tralomethrin (812), transfluthrin (813), transpermethrin (1440), triamiphos (1441), triazamate (818), triazophos (820), triazuron (alternative name), trichlorfon (824), trichlormetaphos-3 (alternative name) [CCN], trichloronat (1452), trifenofos (1455), triflumuron (835), trimethacarb (840), triprene (1459), vamidothion (847), vaniliprole [CCN], veratridine (alternative name) (725), veratrine (alternative name) (725), XMC (853), xylylcarb (854), YI-5302 (compound code), zeta-cypermethrin (205), zetamethrin (alternative name), zinc phosphide (640), zolaprofos (1469) and ZXI 8901 (development code) (858),
a molluscicide selected from the group of substances consisting of bis(tributyltin)oxide (IUPAC name) (913), bromoacetamide [CCN], calcium arsenate [CCN], cloethocarb (999), copper acetoarsenite [CCN], copper sulfate (172), fentin (347), ferric phosphate (IUPAC name) (352), metaldehyde (518), methiocarb (530), niclosamide (576), niclosamide-olamine (576), pentachlorophenol (623), sodium pentachlorophenoxide (623), tazimcarb (1412), thiodicarb (799), tributyltin oxide (913), trifenmorph (1454), trimethacarb (840), triphenyltin acetate (IUPAC name) (347) and triphenyltin hydroxide (IUPAC name) (347),
a nematicide selected from the group of substances consisting of 1,2-dibromo-3-chloropropane (IUPAC/Chemical Abstracts name) (1045), 1,2-dichloropropane (IUPAC/Chemical Abstracts name) (1062), 1,2-dichloropropane with 1,3-dichloropropene (IUPAC name) (1063), 1,3-dichloropropene (233), 3,4-dichlorotetrahydrothiophene 1,1-dioxide (IUPAC/Chemical Abstracts name) (1065), 3-(4-chlorophenyl)-5-methylrhodanine (IUPAC name) (980), 5-methyl-6-thioxo-1,3,5-thiadiazinan-3-ylacetic acid (IUPAC name) (1286), 6-isopentenylaminopurine (alternative name) (210), abamectin (1), acetoprole [CCN], alanycarb (15), aldicarb (16), aldoxycarb (863), AZ 60541 (compound code), benclothiaz [CCN], benomyl (62), butylpyridaben (alternative name), cadusafos (109), carbofuran (118), carbon disulfide (945), carbosulfan (119), chloropicrin (141), chlorpyrifos (145), cloethocarb (999), cytokinins (alternative name) (210), dazomet (216), DBCP (1045), DCIP (218), diamidafos (1044), dichlofenthion (1051), dicliphos (alternative name), dimethoate (262), doramectin (alternative name) [CCN], emamectin (291), emamectin benzoate (291), eprinomectin (alternative name) [CCN], ethoprophos (312), ethylene dibromide (316), fenamiphos (326), fenpyrad (alternative name), fensulfothion (1158), fosthiazate (408), fosthietan (1196), furfural (alternative name) [CCN], GY-81 (development code) (423), heterophos [CCN], iodomethane (IUPAC name) (542), isamidofos (1230), isazofos (1231), ivermectin (alternative name) [CCN], kinetin (alternative name) (210), mecarphon (1258), metam (519), metam-potassium (alternative name) (519), metam-sodium (519), methyl bromide (537), methyl isothiocyanate (543), milbemycin oxime (alternative name) [CCN], moxidectin (alternative name) [CCN], Myrothecium verrucaria composition (alternative name) (565), NC-184 (compound code), oxamyl (602), phorate (636), phosphamidon (639), phosphocarb [CCN], sebufos (alternative name), selamectin (alternative name) [CCN], spinosad (737), terbam (alternative name), terbufos (773), tetrachlorothiophene (IUPAC/Chemical Abstracts name) (1422), thiafenox (alternative name), thionazin (1434), triazophos (820), triazuron (alternative name), xylenols [CCN], YI-5302 (compound code) and zeatin (alternative name) (210),
a nitrification inhibitor selected from the group of substances consisting of potassium ethylxanthate [CCN] and nitrapyrin (580),
a plant activator selected from the group of substances consisting of acibenzolar (6), acibenzolar-5-methyl (6), probenazole (658) and Reynoutria sachalinensis extract (alternative name) (720),
a rodenticide selected from the group of substances consisting of 2-isovalerylindan-1,3-dione (IUPAC name) (1246), 4-(quinoxalin-2-ylamino)benzenesulfonamide (IUPAC name) (748), alpha-chlorohydrin [CCN], aluminium phosphide (640), antu (880), arsenous oxide (882), barium carbonate (891), bisthiosemi (912), brodifacoum (89), bromadiolone (91), bromethalin (92), calcium cyamide (444), chloralose (127), chlorophacinone (140), cholecalciferol (alternative name) (850), coumachlor (1004), coumafuryl (1005), coumatetralyl (175), crimidine (1009), difenacoum (246), difethialone (249), diphacinone (273), ergocalciferol (301), flocoumafen (357), fluoroacetamide (379), flupropadine (1183), flupropadine hydrochloride (1183), gamma-HCH (430), HCH (430), hydrogen cyamide (444), iodomethane (IUPAC name) (542), lindane (430), magnesium phosphide (IUPAC name) (640), methyl bromide (537), norbormide (1318), phosacetim (1336), phosphine (IUPAC name) (640), phosphorus [CCN], pindone (1341), potassium arsenite [CCN], pyrinuron (1371), scilliroside (1390), sodium arsenite [CCN], sodium cyamide (444), sodium fluoro-acetate (735), strychnine (745), thallium sulfate [CCN], warfarin (851) and zinc phosphide (640),
a synergist selected from the group of substances consisting of 2-(2-butoxyethoxy)ethyl piperonylate (IUPAC name) (934), 5-(1,3-benzodioxol-5-yl)-3-hexylcyclohex-2-enone (IUPAC name) (903), farnesol with nerolidol (alternative name) (324), MB-599 (development code) (498), MGK 264 (development code) (296), piperonyl butoxide (649), piprotal (1343), propyl isomer (1358), S421 (development code) (724), sesamex (1393), sesasmolin (1394) and sulfoxide (1406),
an animal repellent selected from the group of substances consisting of anthraquinone (32), chloralose (127), copper naphthenate [CCN], copper oxychloride (171), diazinon (227), dicyclopentadiene (chemical name) (1069), guazatine (422), guazatine acetates (422), methiocarb (530), pyridin-4-amine (IUPAC name) (23), thiram (804), trimethacarb (840), zinc naphthenate [CCN] and ziram (856),
a virucide selected from the group of substances consisting of imanin (alternative name) [CCN] and ribavirin (alternative name) [CCN],
and a wound protectant selected from the group of substances consisting of mercuric oxide (512), octhilinone (590) and thiophanate-methyl (802).

A very especially preferred embodiment of the subject-matter {1.1.14} of the invention is {1.1.14.2} a pesticidal composition comprising a mixture consisting of at least two substances, namely one compound (A) and at least one compound (B), as active ingredient and at least one auxiliary, wherein the compound (A) is the compound of formula (A-14) and the compound (B) is a compound selected from the group of substances consisting of abamectin (1), cyromazine (209), diafenthiuron (226), diazinon (227), emamectin benzoate (291), fenoxycarb (340), fosthiazate (408), lambda-cyhalothrin (198), lufenuron (490), methidathion (529), profenofos (662), pymetrozine (688), tefluthrin (769) and thiamethoxam (792).

The compound of formula (A-14) is known, for example, from the PCT Application WO-03/015519.

A preferred embodiment of the subject-matter {1.1} of the invention is {1.1.15} a pesticidal composition comprising a mixture consisting of at least two substances, namely one compound (A) and at least one compound (B), as active ingredient and at least one auxiliary, wherein the compound (A) is the compound of formula (A-15) 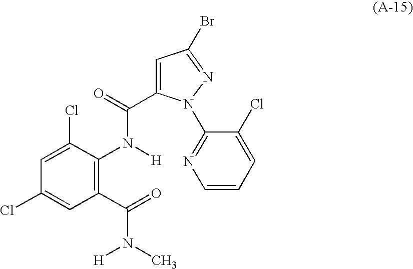
and the compound (B) is a compound selected from the group of substances consisting of an adjuvant, an acaricide, an algicide, an anthelmintic, an avicide, a bactericide, a biological agent, a soil sterilant, a chemosterilant, an insect pheromone, an insect repellent, an insecticide, a molluscicide, a nematicide, a nitrification inhibitor, a plant activator, a rodenticide, a synergist, an animal repellent, a virucide and a wound protectant.

An especially preferred embodiment of the subject-matter {1.1.15} of the invention is {1.1.15.1} a pesticidal composition comprising a mixture consisting of at least two substances, namely one compound (A) and at least one compound (B), as active ingredient and at least one auxiliary, wherein the compound (A) is the compound of formula (A-15) and the compound (B) is a compound selected from the group of substances consisting of
an adjuvant selected from the group of substances consisting of petroleum oils (alternative name) (628),
an acaricide selected from the group of substances consisting of 1,1-bis(4-chlorophenyl)-2-ethoxyethanol (IUPAC name) (910), 2,4-dichlorophenyl benzenesulfonate (IUPAC/Chemical Abstracts name) (1059), 2-fluoro-N-methyl-N-1-naphthylacetamide (IUPAC name) (1295), 4-chlorophenyl phenyl sulfone (IUPAC name) (981), abamectin (1), acequinocyl (3), acetoprole [CCN], acrinathrin (9), aldicarb (16), aldoxycarb (863), alpha-cypermethrin (202), amidithion (870), amidoflumet [CCN], amidothioate (872), amiton (875), amiton hydrogen oxalate (875), amitraz (24), aramite (881), arsenous oxide (882), AVI 382 (compound code), AZ 60541 (compound code), azinphos-ethyl (44), azinphos-methyl (45), azobenzene (IUPAC name) (888), azocyclotin (46), azothoate (889), benomyl (62), benoxafos (alternative name) [CCN], benzoximate (71), benzyl benzoate (IUPAC name) [CCN], bifenazate (74), bifenthrin (76), binapacryl (907), brofenvalerate (alternative name), bromocyclen (918), bromophos (920), bromophos-ethyl (921), bromopropylate (94), buprofezin (99), butocarboxim (103), butoxycarboxim (104), butylpyridaben (alternative name), calcium polysulfide (IUPAC name) (111), camphechlor (941), carbanolate (943), carbaryl (115), carbofuran (118), carbophenothion (947), CGA 50'439 (development code) (125), chinomethionat (126), chlorbenside (959), chlordimeform (964), chlordimeform hydrochloride (964), chlorfenapyr (130), chlorfenethol (968), chlorfenson (970), chlorfensulphide (971), chlorfenvinphos (131), chlorobenzilate (975), chloromebuform (977), chloromethiuron (978), chloropropylate (983), chlorpyrifos (145), chlorpyrifos-methyl (146), chlorthiophos (994), cinerin I (696), cinerin II (696), cinerins (696), clofentezine (158), closantel (alternative name) [CCN], coumaphos (174), crotamiton (alternative name) [CCN], crotoxyphos (1010), cufraneb (1013), cyanthoate (1020), cyhalothrin (196), cyhexatin (199), cypermethrin (201), DCPM (1032), DDT (219), demephion (1037), demephion-O (1037), demephion-S (1037), demeton (1038), demeton-methyl (224), demeton-O (1038), demeton-O-methyl (224), demeton-S (1038), demeton-5-methyl (224), demeton-5-methylsulphon (1039), diafenthiuron (226), dialifos (1042), diazinon (227), dichlofluanid (230), dichlorvos (236), dicliphos (alternative name), dicofol (242), dicrotophos (243), dienochlor (1071), dimefox (1081), dimethoate (262), dinactin (alternative name) (653), dinex (1089), dinex-diclexine (1089), dinobuton (269), dinocap (270), dinocap-4 [CCN], dinocap-6 [CCN], dinocton (1090), dinopenton (1092), dinosulfon (1097), dinoterbon (1098), dioxathion (1102), diphenyl sulfone (IUPAC name) (1103), disulfuram (alternative name) [CCN], disulfoton (278), DNOC (282), dofenapyn (1113), doramectin (alternative name) [CCN], endosulfan (294), endothion (1121), EPN (297), eprinomectin (alternative name) [CCN], ethion (309), ethoate-methyl (1134), etoxazole (320), etrimfos (1142), fenazaflor (1147), fenazaquin (328), fenbutatin oxide (330), fenothiocarb (337), fenpropathrin (342), fenpyrad (alternative name), fenpyroximate (345), fenson (1157), fentrifanil (1161), fenvalerate (349), fipronil (354), fluacrypyrim (360), fluazuron (1166), flubenzimine (1167), flucycloxuron (366), flucythrinate (367), fluenetil (1169), flufenoxuron (370), flumethrin (372), fluorbenside (1174), fluvalinate (1184), FMC 1137 (development code) (1185), formetanate (405), formetanate hydrochloride (405), formothion (1192), formparanate (1193), gamma-HCH (430), glyodin (1205), halfenprox (424), heptenophos (432), hexadecyl cyclopropanecarboxylate (IUPAC/Chemical Abstracts name) (1216), hexythiazox (441), iodomethane (IUPAC name) (542), isocarbophos (alternative name) (473), isopropyl O-(methoxyaminothiophosphoryl)salicylate (IUPAC name) (473), ivermectin (alternative name) [CCN], jasmolin I (696), jasmolin II (696), jodfenphos (1248), lindane (430), lufenuron (490), malathion (492), malonoben (1254), mecarbam (502), mephosfolan (1261), mesulfen (alternative name) [CCN], methacrifos (1266), methamidophos (527), methidathion (529), methiocarb (530), methomyl (531), methyl bromide (537), metolcarb (550), mevinphos (556), mexacarbate (1290), milbemectin (557), milbemycin oxime (alternative name) [CCN], mipafox (1293), monocrotophos (561), morphothion (1300), moxidectin (alternative name) [CCN], naled (567), NC-184 (compound code), nifluridide (1309), nikkomycins (alternative name) [CCN], nitrilacarb (1313), nitrilacarb 1:1 zinc chloride complex (1313), NNI-0101 (compound code), NNI-0250 (compound code), omethoate (594), oxamyl (602), oxydeprofos (1324), oxydisulfoton (1325), pp′-DDT (219), parathion (615), permethrin (626), petroleum oils (alternative name) (628), phenkapton (1330), phenthoate (631), phorate (636), phosalone (637), phosfolan (1338), phosmet (638), phosphamidon (639), phoxim (642), pirimiphos-methyl (652), polychloroterpenes (traditional name) (1347), polynactins (alternative name) (653), proclonol (1350), profenofos (662), promacyl (1354), propargite (671), propetamphos (673), propoxur (678), prothidathion (1360), prothoate (1362), pyrethrin I (696), pyrethrin II (696), pyrethrins (696), pyridaben (699), pyridaphenthion (701), pyrimidifen (706), pyrimitate (1370), quinalphos (711), quintiofos (1381), R-1492 (development code) (1382), RA-17 (development code) (1383), rotenone (722), schradan (1389), sebufos (alternative name), selamectin (alternative name) [CCN], SI-0009 (compound code), sophamide (1402), spirodiclofen (738), spiromesifen (739), SSI-121 (development code) (1404), sulfuram (alternative name) [CCN], sulfluramid (750), sulfotep (753), sulfur (754), SZI-121 (development code) (757), tau-fluvalinate (398), tebufenpyrad (763), TEPP (1417), terbam (alternative name), tetrachlorvinphos (777), tetradifon (786), tetranactin (alternative name) (653), tetrasul (1425), thiafenox (alternative name), thiocarboxime (1431), thiofanox (800), thiometon (801), thioquinox (1436), thuringiensin (alternative name) [CCN], triamiphos (1441), triarathene (1443), triazophos (820), triazuron (alternative name), trichlorfon (824), trifenofos (1455), trinactin (alternative name) (653), vamidothion (847), vaniliprole [CCN] and YI-5302 (compound code),
an algicide selected from the group of substances consisting of bethoxazin [CCN], copper dioctanoate (IUPAC name) (170), copper sulfate (172), cybutryne [CCN], dichlone (1052), dichlorophen (232), endothal (295), fentin (347), hydrated lime [CCN], nabam (566), quinoclamine (714), quinonamid (1379), simazine (730), triphenyltin acetate (IUPAC name) (347) and triphenyltin hydroxide (IUPAC name) (347),
an anthelmintic selected from the group of substances consisting of abamectin (1), crufomate (1011), doramectin (alternative name) [CCN], emamectin (291), emamectin benzoate (291), eprinomectin (alternative name) [CCN], ivermectin (alternative name) [CCN], milbemycin oxime (alternative name) [CCN], moxidectin (alternative name) [CCN], piperazine [CCN], selamectin (alternative name) [CCN], spinosad (737) and thiophanate (1435),
an avicide selected from the group of substances consisting of chloralose (127), endrin (1122), fenthion (346), pyridin-4-amine (IUPAC name) (23) and strychnine (745),
a bactericide selected from the group of substances consisting of 1-hydroxy-1H-pyridine-2-thione (IUPAC name) (1222), 4-(quinoxalin-2-ylamino)benzenesulfonamide (IUPAC name) (748), 8-hydroxyquinoline sulfate (446), bronopol (97), copper dioctanoate (IUPAC name) (170), copper hydroxide (IUPAC name) (169), cresol [CCN], dichlorophen (232), dipyrithione (1105), dodicin (1112), fenaminosulf (1144), formaldehyde (404), hydrargaphen (alternative name) [CCN], kasugamycin (483), kasugamycin hydrochloride hydrate (483), nickel bis(dimethyldithiocarbamate) (IUPAC name) (1308), nitrapyrin (580), octhilinone (590), oxolinic acid (606), oxytetracycline (611), potassium hydroxyquinoline sulfate (446), probenazole (658), streptomycin (744), streptomycin sesquisulfate (744), tecloftalam (766) and thiomersal (alternative name) [CCN],
a biological agent selected from the group of substances consisting of Adoxophyes orana GV (alternative name) (12), Agrobacterium radiobacter (alternative name) (13), Amblyseius spp. (alternative name) (19), Anagrapha falcifera NPV (alternative name) (28), Anagrus atomus (alternative name) (29), Aphelinus abdominalis (alternative name) (33), Aphidius colemani (alternative name) (34), Aphidoletes aphidimyza (alternative name) (35), Autographa californica NPV (alternative name) (38), Bacillus firmus (alternative name) (48), Bacillus sphaericus Neide (scientific name) (49), Bacillus thuringiensis Berliner (scientific name) (51), Bacillus thuringiensis subsp. aizawai (scientific name) (51), Bacillus thuringiensis subsp. israelensis (scientific name) (51), Bacillus thuringiensis subsp. japonensis (scientific name) (51), Bacillus thuringiensis subsp. kurstaki (scientific name) (51), Bacillus thuringiensis subsp. tenebrionis (scientific name) (51), Beauveria bassiana (alternative name) (53), Beauveria brongniartii (alternative name) (54), Chrysoperla carnea (alternative name) (151), Cryptolaemus montrouzieri (alternative name) (178), Cydia pomonella GV (alternative name) (191), Dacnusa sibirica (alternative name) (212), Diglyphus isaea (alternative name) (254), Encarsia formosa (scientific name) (293), Eretmocerus eremicus (alternative name) (300), Helicoverpa zea NPV (alternative name) (431), Heterorhabditis bacteriophora and H. megidis (alternative name) (433), Hippodamia convergens (alternative name) (442), Leptomastix dactylopii (alternative name) (488), Macrolophus caliginosus (alternative name) (491), Mamestra brassicae NPV (alternative name) (494), Metaphycus helvolus (alternative name) (522), Metarhizium anisopliae var. acridum (scientific name) (523), Metarhizium anisopliae var. anisopliae (scientific name) (523), Neodiprion sertifer NPV and N. lecontei NPV (alternative name) (575), Orius spp. (alternative name) (596), Paecilomyces fumosoroseus (alternative name) (613), Phytoseiulus persimilis (alternative name) (644), Spodoptera exigua multicapsid nuclear polyhedrosis virus (scientific name) (741), Steinernema bibionis (alternative name) (742), Steinernema carpocapsae (alternative name) (742), Steinernema feltiae (alternative name) (742), Steinernema glaseri (alternative name) (742), Steinernema riobrave (alternative name) (742), Steinernema riobravis (alternative name) (742), Steinernema scapterisci (alternative name) (742), Steinernema spp. (alternative name) (742), Trichogramma spp. (alternative name) (826), Typhlodromus occidentalis (alternative name) (844) and Verticillium lecanii (alternative name) (848),
a soil sterilant selected from the group of substances consisting of iodomethane (IUPAC name) (542) and methyl bromide (537),
a chemosterilant selected from the group of substances consisting of apholate [CCN], bisazir (alternative name) [CCN], busulfan (alternative name) [CCN], diflubenzuron (250), dimatif (alternative name) [CCN], hemel [CCN], hempa [CCN], metepa [CCN], methiotepa [CCN], methyl apholate [CCN], morzid [CCN], penfluoron (alternative name) [CCN], tepa [CCN], thiohempa (alternative name) [CCN], thiotepa (alternative name) [CCN], tretamine (alternative name) [CCN] and uredepa (alternative name) [CCN],
an insect pheromone selected from the group of substances consisting of (E)-dec-5-en-1-yl acetate with (E)-dec-5-en-1-ol (IUPAC name) (222), (E)-tridec-4-en-1-yl acetate (IUPAC name) (829), (E)-6-methylhept-2-en-4-ol (IUPAC name) (541), (E,Z)-tetradeca-4,10-dien-1-yl acetate (IUPAC name) (779), (Z)-dodec-7-en-1-yl acetate (IUPAC name) (285), (Z)-hexadec-11-enal (IUPAC name) (436), (Z)-hexadec-11-en-1-yl acetate (IUPAC name) (437), (Z)-hexadec-13-en-11-yn-1-yl acetate (IUPAC name) (438), (Z)-icos-13-en-10-one (IUPAC name) (448), (Z)-tetradec-7-en-1-al (IUPAC name) (782), (Z)-tetradec-9-en-1-ol (IUPAC name) (783), (Z)-tetradec-9-en-1-yl acetate (IUPAC name) (784), (7E,9Z)-dodeca-7,9-dien-1-yl acetate (IUPAC name) (283), (9Z,11E)-tetradeca-9,11-dien-1-yl acetate (IUPAC name) (780), (9Z,12E)-tetradeca-9,12-dien-1-yl acetate (IUPAC name) (781), 14-methyloctadec-1-ene (IUPAC name) (545), 4-methylnonan-5-ol with 4-methylnonan-5-one (IUPAC name) (544), alpha-multistriatin (alternative name) [CCN], brevicomin (alternative name) [CCN], codlelure (alternative name) [CCN], codlemone (alternative name) (167), cuelure (alternative name) (179), disparlure (277), dodec-8-en-1-yl acetate (IUPAC name) (286), dodec-9-en-1-yl acetate (IUPAC name) (287), dodeca-8,10-dien-1-yl acetate (IUPAC name) (284), dominicalure (alternative name) [CCN], ethyl 4-methyloctanoate (IUPAC name) (317), eugenol (alternative name) [CCN], frontalin (alternative name) [CCN], gossyplure (alternative name) (420), grandlure (421), grandlure I (alternative name) (421), grandlure II (alternative name) (421), grandlure III (alternative name) (421), grandlure IV (alternative name) (421), hexylure [CCN], ipsdienol (alternative name) [CCN], ipsenol (alternative name) [CCN], japonilure (alternative name) (481), lineatin (alternative name) [CCN], litlure (alternative name) [CCN], looplure (alternative name) [CCN], medlure [CCN], megatomoic acid (alternative name) [CCN], methyl eugenol (alternative name) (540), muscalure (563), octadeca-2,13-dien-1-yl acetate (IUPAC name) (588), octadeca-3,13-dien-1-yl acetate (IUPAC name) (589), orfralure (alternative name) [CCN], oryctalure (alternative name) (317), ostramone (alternative name) [CCN], siglure [CCN], sordidin (alternative name) (736), sulcatol (alternative name) [CCN], tetradec-11-en-1-yl acetate (IUPAC name) (785), trimedlure (839), trimedlure A (alternative name) (839), trimedlure B₁ (alternative name) (839), trimedlure B₂ (alternative name) (839), trimedlure C (alternative name) (839) and trunc-call (alternative name) [CCN],
an insect repellent selected from the group of substances consisting of 2-(octylthio)-ethanol (IUPAC name) (591), butopyronoxyl (933), butoxy(polypropylene glycol) (936), dibutyl adipate (IUPAC name) (1046), dibutyl phthalate (1047), dibutyl succinate (IUPAC name) (1048), diethyltoluamide [CCN], dimethyl carbate [CCN], dimethyl phthalate [CCN], ethyl hexanediol (1137), hexamide [CCN], methoquin-butyl (1276), methylneodecanamide [CCN], oxamate [CCN] and picaridin [CCN],
an insecticide selected from the group of substances consisting of 1,1-dichloro-1-nitroethane (IUPAC/Chemical Abstracts name) (1058), 1,1-dichloro-2,2-bis(4-ethylphenyl)-ethane (IUPAC name) (1056), 1,2-dichloropropane (IUPAC/Chemical Abstracts name) (1062), 1,2-dichloropropane with 1,3-dichloropropene (IUPAC name) (1063), 1-bromo-2-chloroethane (IUPAC/Chemical Abstracts name) (916), 2,2,2-trichloro-1-(3,4-dichloro-phenyl)ethyl acetate (IUPAC name) (1451), 2,2-dichlorovinyl 2-ethylsulfinylethyl methyl phosphate (IUPAC name) (1066), 2-(1,3-dithiolan-2-yl)phenyl dimethylcarbamate (IUPAC/Chemical Abstracts name) (1109), 2-(2-butoxyethoxy)ethyl thiocyanate (IUPAC/Chemical Abstracts name) (935), 2-(4,5-dimethyl-1,3-dioxolan-2-yl)phenyl methylcarbamate (IUPAC/Chemical Abstracts name) (1084), 2-(4-chloro-3,5-xylyloxy)ethanol (IUPAC name) (986), 2-chlorovinyl diethyl phosphate (IUPAC name) (984), 2-imidazolidone (IUPAC name) (1225), 2-isovalerylindan-1,3-dione (IUPAC name) (1246), 2-methyl(prop-2-ynyl)aminophenyl methylcarbamate (IUPAC name) (1284), 2-thiocyanatoethyl laurate (IUPAC name) (1433), 3-bromo-1-chloroprop-1-ene (IUPAC name) (917), 3-methyl-1-phenylpyrazol-5-yl dimethyl-carbamate (IUPAC name) (1283), 4-methyl(prop-2-ynyl)amino-3,5-xylyl methylcarbamate (IUPAC name) (1285), 5,5-dimethyl-3-oxocyclohex-1-enyl dimethylcarbamate (IUPAC name) (1085), abamectin (1), acephate (2), acetamiprid (4), acethion (alternative name) [CCN], acetoprole [CCN], acrinathrin (9), acrylonitrile (IUPAC name) (861), alanycarb (15), aldicarb (16), aldoxycarb (863), aldrin (864), allethrin (17), allosamidin (alternative name) [CCN], allyxycarb (866), alpha-cypermethrin (202), alpha-ecdysone (alternative name) [CCN], aluminium phosphide (640), amidithion (870), amidothioate (872), aminocarb (873), amiton (875), amiton hydrogen oxalate (875), amitraz (24), anabasine (877), athidathion (883), AVI 382 (compound code), AZ 60541 (compound code), azadirachtin (alternative name) (41), azamethiphos (42), azinphos-ethyl (44), azinphos-methyl (45), azothoate (889), Bacillus thuringiensis delta endotoxins (alternative name) (52), barium hexafluorosilicate (alternative name) [CCN], barium polysulfide (IUPAC/Chemical Abstracts name) (892), barthrin [CCN], BAS 320 I (compound code), Bayer 22/190 (development code) (893), Bayer 22408 (development code) (894), bendiocarb (58), benfuracarb (60), bensultap (66), beta-cyfluthrin (194), beta-cypermethrin (203), bifenthrin (76), bioallethrin (78), bioallethrin S-cyclopentenyl isomer (alternative name) (79), bioethanomethrin [CCN], biopermethrin (908), bioresmethrin (80), bis(2-chloroethyl)ether (IUPAC name) (909), bistrifluoron (83), borax (86), brofenvalerate (alternative name), bromfenvinfos (914), bromocyclen (918), bromo-DDT (alternative name) [CCN], bromophos (920), bromophos-ethyl (921), bufencarb (924), buprofezin (99), butacarb (926), butathiofos (927), butocarboxim (103), butonate (932), butoxycarboxim (104), butylpyridaben (alternative name), cadusafos (109), calcium arsenate [CCN], calcium cyamide (444), calcium polysulfide (IUPAC name) (111), camphechlor (941), carbanolate (943), carbaryl (115), carbofuran (118), carbon disulfide (IUPAC/Chemical Abstracts name) (945), carbon tetrachloride (IUPAC name) (946), carbophenothion (947), carbosulfan (119), cartap (123), cartap hydrochloride (123), cevadine (alternative name) (725), chlorbicyclen (960), chlordane (128), chlordecone (963), chlordimeform (964), chlordimeform hydrochloride (964), chlorethoxyfos (129), chlorfenapyr (130), chlorfenvinphos (131), chlorfluazuron (132), chlormephos (136), chloroform [CCN], chloropicrin (141), chlorphoxim (989), chlorprazophos (990), chlorpyrifos (145), chlorpyrifos-methyl (146), chlorthiophos (994), chromafenozide (150), cinerin I (696), cinerin II (696), cinerins (696), cis-resmethrin (alternative name), cismethrin (80), clocythrin (alternative name), cloethocarb (999), closantel (alternative name) [CCN], clothianidin (165), copper acetoarsenite [CCN], copper arsenate [CCN], copper oleate [CCN], coumaphos (174), coumithoate (1006), crotamiton (alternative name) [CCN], crotoxyphos (1010), crufomate (1011), cryolite (alternative name) (177), CS 708 (development code) (1012), cyanofenphos (1019), cyanophos (184), cyanthoate (1020), cyclethrin [CCN], cycloprothrin (188), cyfluthrin (193), cyhalothrin (196), cypermethrin (201), cyphenothrin (206), cyromazine (209), cythioate (alternative name) [CCN], d-limonene (alternative name) [CCN], d-tetramethrin (alternative name) (788), DAEP (1031), dazomet (216), DDT (219), decarbofuran (1034), deltamethrin (223), demephion (1037), demephion-O (1037), demephion-S (1037), demeton (1038), demeton-methyl (224), demeton-O (1038), demeton-O-methyl (224), demeton-S (1038), demeton-5-methyl (224), demeton-5-methylsulphon (1039), diafenthiuron (226), dialifos (1042), diamidafos (1044), diazinon (227), dicapthon (1050), dichlofenthion (1051), dichlorvos (236), dicliphos (alternative name), dicresyl (alternative name) [CCN], dicrotophos (243), dicyclanil (244), dieldrin (1070), diethyl 5-methylpyrazol-3-yl phosphate (IUPAC name) (1076), diflubenzuron (250), dilor (alternative name) [CCN], dimefluthrin [CCN], dimefox (1081), dimetan (1085), dimethoate (262), dimethrin (1083), dimethylvinphos (265), dimetilan (1086), dinex (1089), dinex-diclexine (1089), dinoprop (1093), dinosam (1094), dinoseb (1095), dinotefuran (271), diofenolan (1099), dioxabenzofos (1100), dioxacarb (1101), dioxathion (1102), disulfoton (278), dithicrofos (1108), DNOC (282), doramectin (alternative name) [CCN], DSP (1115), ecdysterone (alternative name) [CCN], EI 1642 (development code) (1118), emamectin (291), emamectin benzoate (291), EMPC (1120), empenthrin (292), endosulfan (294), endothion (1121), endrin (1122), EPBP (1123), EPN (297), epofenonane (1124), eprinomectin (alternative name) [CCN], esfenvalerate (302), etaphos (alternative name) [CCN], ethiofencarb (308), ethion (309), ethiprole (310), ethoate-methyl (1134), ethoprophos (312), ethyl formate (IUPAC name) [CCN], ethyl-DDD (alternative name) (1056), ethylene dibromide (316), ethylene dichloride (chemical name) (1136), ethylene oxide [CCN], etofenprox (319), etrimfos (1142), EXD (1143), famphur (323), fenamiphos (326), fenazaflor (1147), fenchlorphos (1148), fenethacarb (1149), fenfluthrin (1150), fenitrothion (335), fenobucarb (336), fenoxacrim (1153), fenoxycarb (340), fenpirithrin (1155), fenpropathrin (342), fenpyrad (alternative name), fensulfothion (1158), fenthion (346), fenthion-ethyl [CCN], fenvalerate (349), fipronil (354), flonicamid (358), flucofuron (1168), flucycloxuron (366), flucythrinate (367), fluenetil (1169), flufenerim [CCN], flufenoxuron (370), flufenprox (1171), flumethrin (372), fluvalinate (1184), FMC 1137 (development code) (1185), fonofos (1191), formetanate (405), formetanate hydrochloride (405), formothion (1192), formparanate (1193), fosmethilan (1194), fospirate (1195), fosthiazate (408), fosthietan (1196), furathiocarb (412), furethrin (1200), gamma-cyhalothrin (197), gamma-HCH (430), guazatine (422), guazatine acetates (422), GY-81 (development code) (423), halfenprox (424), halofenozide (425), HCH (430), HEOD (1070), heptachlor (1211), heptenophos (432), heterophos [CCN], hexaflumuron (439), HHDN (864), hydramethylnon (443), hydrogen cyamide (444), hydroprene (445), hyquincarb (1223), imidacloprid (458), imiprothrin (460), indoxacarb (465), iodomethane (IUPAC name) (542), IPSP (1229), isazofos (1231), isobenzan (1232), isocarbophos (alternative name) (473), isodrin (1235), isofenphos (1236), isolane (1237), isoprocarb (472), isopropyl O-(methoxyaminothiophosphoryl)salicylate (IUPAC name) (473), isoprothiolane (474), isothioate (1244), isoxathion (480), ivermectin (alternative name) [CCN], jasmolin I (696), jasmolin II (696), jodfenphos (1248), juvenile hormone I (alternative name) [CCN], juvenile hormone II (alternative name) [CCN], juvenile hormone III (alternative name) [CCN], kelevan (1249), kinoprene (484), lambda-cyhalothrin (198), lead arsenate [CCN], leptophos (1250), lindane (430), lirimfos (1251), lufenuron (490), lythidathion (1253), m-cumenyl methylcarbamate (IUPAC name) (1014), magnesium phosphide (IUPAC name) (640), malathion (492), malonoben (1254), mazidox (1255), mecarbam (502), mecarphon (1258), menazon (1260), mephosfolan (1261), mercurous chloride (513), mesulfenfos (1263), metam (519), metam-potassium (alternative name) (519), metam-sodium (519), methacrifos (1266), methamidophos (527), methanesulfonyl fluoride (IUPAC/Chemical Abstracts name) (1268), methidathion (529), methiocarb (530), methocrotophos (1273), methomyl (531), methoprene (532), methoquin-butyl (1276), methothrin (alternative name) (533), methoxychlor (534), methoxyfenozide (535), methyl bromide (537), methyl isothiocyanate (543), methylchloroform (alternative name) [CCN], methylene chloride [CCN], metofluthrin [CCN], metolcarb (550), metoxadiazone (1288), mevinphos (556), mexacarbate (1290), milbemectin (557), milbemycin oxime (alternative name) [CCN], mipafox (1293), mirex (1294), monocrotophos (561), morphothion (1300), moxidectin (alternative name) [CCN], naftalofos (alternative name) [CCN], naled (567), naphthalene (IUPAC/Chemical Abstracts name) (1303), NC-170 (development code) (1306), NC-184 (compound code), nicotine (578), nicotine sulfate (578), nifluridide (1309), nitenpyram (579), nithiazine (1311), nitrilacarb (1313), nitrilacarb 1:1 zinc chloride complex (1313), NNI-0101 (compound code), NNI-0250 (compound code), nornicotine (traditional name) (1319), novaluron (585), noviflumuron (586), O-2,5-dichloro-4-iodophenyl O-ethyl ethylphosphonothioate (IUPAC name) (1057), O,O-diethyl O-4-methyl-2-oxo-2H-chromen-7-yl phosphorothioate (IUPAC name) (1074), O,O-diethyl O-6-methyl-2-propylpyrimidin-4-yl phosphorothioate (IUPAC name) (1075), O,O,O′,O′-tetrapropyl dithiopyrophosphate (IUPAC name) (1424), oleic acid (IUPAC name) (593), omethoate (594), oxamyl (602), oxydemeton-methyl (609), oxydeprofos (1324), oxydisulfoton (1325), pp′-DDT (219), para-dichlorobenzene [CCN], parathion (615), parathion-methyl (616), penfluoron (alternative name) [CCN], pentachlorophenol (623), pentachlorophenyl laurate (IUPAC name) (623), permethrin (626), petroleum oils (alternative name) (628), PH 60-38 (development code) (1328), phenkapton (1330), phenothrin (630), phenthoate (631), phorate (636), phosalone (637), phosfolan (1338), phosmet (638), phosnichlor (1339), phosphamidon (639), phosphine (IUPAC name) (640), phoxim (642), phoxim-methyl (1340), pirimetaphos (1344), pirimicarb (651), pirimiphos-ethyl (1345), pirimiphos-methyl (652), polychlorodicyclopentadiene isomers (IUPAC name) (1346), polychloroterpenes (traditional name) (1347), potassium arsenite [CCN], potassium thiocyanate [CCN], prallethrin (655), precocene I (alternative name) [CCN], precocene II (alternative name) [CCN], precocene III (alternative name) [CCN], primidophos (1349), profenofos (662), profluthrin [CCN], promacyl (1354), promecarb (1355), propaphos (1356), propetamphos (673), propoxur (678), prothidathion (1360), prothiofos (686), prothoate (1362), protrifenbute [CCN], pymetrozine (688), pyraclofos (689), pyrazophos (693), pyresmethrin (1367), pyrethrin I (696), pyrethrin II (696), pyrethrins (696), pyridaben (699), pyridalyl (700), pyridaphenthion (701), pyrimidifen (706), pyrimitate (1370), pyriproxyfen (708), quassia (alternative name) [CCN], quinalphos (711), quinalphos-methyl (1376), quinothion (1380), quintiofos (1381), R-1492 (development code) (1382), rafoxanide (alternative name) [CCN], resmethrin (719), rotenone (722), RU 15525 (development code) (723), RU 25475 (development code) (1386), ryania (alternative name) (1387), ryanodine (traditional name) (1387), sabadilla (alternative name) (725), schradan (1389), sebufos (alternative name), selamectin (alternative name) [CCN], SI-0009 (compound code), silafluofen (728), SN 72129 (development code) (1397), sodium arsenite [CCN], sodium cyamide (444), sodium fluoride (IUPAC/Chemical Abstracts name) (1399), sodium hexafluorosilicate (1400), sodium pentachlorophenoxide (623), sodium selenate (IUPAC name) (1401), sodium thiocyanate [CCN], sophamide (1402), spinosad (737), spiromesifen (739), sulcofuron (746), sulcofuron-sodium (746), sulfluramid (750), sulfotep (753), sulfuryl fluoride (756), sulprofos (1408), tar oils (alternative name) (758), tau-fluvalinate (398), tazimcarb (1412), TDE (1414), tebufenozide (762), tebufenpyrad (763), tebupirimfos (764), teflubenzuron (768), tefluthrin (769), temephos (770), TEPP (1417), terallethrin (1418), terbam (alternative name), terbufos (773), tetrachloroethane [CCN], tetrachlorvinphos (777), tetramethrin (787), theta-cypermethrin (204), thiacloprid (791), thiafenox (alternative name), thiamethoxam (792), thicrofos (1428), thiocarboxime (1431), thiocyclam (798), thiocyclam hydrogen oxalate (798), thiodicarb (799), thiofanox (800), thiometon (801), thionazin (1434), thiosultap (803), thiosultap-sodium (803), thuringiensin (alternative name) [CCN], tolfenpyrad (809), tralomethrin (812), transfluthrin (813), transpermethrin (1440), triamiphos (1441), triazamate (818), triazophos (820), triazuron (alternative name), trichlorfon (824), trichlormetaphos-3 (alternative name) [CCN], trichloronat (1452), trifenofos (1455), triflumuron (835), trimethacarb (840), triprene (1459), vamidothion (847), vaniliprole [CCN], veratridine (alternative name) (725), veratrine (alternative name) (725), XMC (853), xylylcarb (854), YI-5302 (compound code), zeta-cypermethrin (205), zetamethrin (alternative name), zinc phosphide (640), zolaprofos (1469) and ZXI 8901 (development code) (858),
a molluscicide selected from the group of substances consisting of bis(tributyltin)oxide (IUPAC name) (913), bromoacetamide [CCN], calcium arsenate [CCN], cloethocarb (999), copper acetoarsenite [CCN], copper sulfate (172), fentin (347), ferric phosphate (IUPAC name) (352), metaldehyde (518), methiocarb (530), niclosamide (576), niclosamide-olamine (576), pentachlorophenol (623), sodium pentachlorophenoxide (623), tazimcarb (1412), thiodicarb (799), tributyltin oxide (913), trifenmorph (1454), trimethacarb (840), triphenyltin acetate (IUPAC name) (347) and triphenyltin hydroxide (IUPAC name) (347),
a nematicide selected from the group of substances consisting of 1,2-dibromo-3-chloropropane (IUPAC/Chemical Abstracts name) (1045), 1,2-dichloropropane (IUPAC/Chemical Abstracts name) (1062), 1,2-dichloropropane with 1,3-dichloropropene (IUPAC name) (1063), 1,3-dichloropropene (233), 3,4-dichlorotetrahydrothiophene 1,1-dioxide (IUPAC/Chemical Abstracts name) (1065), 3-(4-chlorophenyl)-5-methylrhodanine (IUPAC name) (980), 5-methyl-6-thioxo-1,3,5-thiadiazinan-3-ylacetic acid (IUPAC name) (1286), 6-isopentenylaminopurine (alternative name) (210), abamectin (1), acetoprole [CCN], alanycarb (15), aldicarb (16), aldoxycarb (863), AZ 60541 (compound code), benclothiaz [CCN], benomyl (62), butylpyridaben (alternative name), cadusafos (109), carbofuran (118), carbon disulfide (945), carbosulfan (119), chloropicrin (141), chlorpyrifos (145), cloethocarb (999), cytokinins (alternative name) (210), dazomet (216), DBCP (1045), DCIP (218), diamidafos (1044), dichlofenthion (1051), dicliphos (alternative name), dimethoate (262), doramectin (alternative name) [CCN], emamectin (291), emamectin benzoate (291), eprinomectin (alternative name) [CCN], ethoprophos (312), ethylene dibromide (316), fenamiphos (326), fenpyrad (alternative name), fensulfothion (1158), fosthiazate (408), fosthietan (1196), furfural (alternative name) [CCN], GY-81 (development code) (423), heterophos [CCN], iodomethane (IUPAC name) (542), isamidofos (1230), isazofos (1231), ivermectin (alternative name) [CCN], kinetin (alternative name) (210), mecarphon (1258), metam (519), metam-potassium (alternative name) (519), metam-sodium (519), methyl bromide (537), methyl isothiocyanate (543), milbemycin oxime (alternative name) [CCN], moxidectin (alternative name) [CCN], Myrothecium verrucaria composition (alternative name) (565), NC-184 (compound code), oxamyl (602), phorate (636), phosphamidon (639), phosphocarb [CCN], sebufos (alternative name), selamectin (alternative name) [CCN], spinosad (737), terbam (alternative name), terbufos (773), tetrachlorothiophene (IUPAC/Chemical Abstracts name) (1422), thiafenox (alternative name), thionazin (1434), triazophos (820), triazuron (alternative name), xylenols [CCN], YI-5302 (compound code) and zeatin (alternative name) (210),
a nitrification inhibitor selected from the group of substances consisting of potassium ethylxanthate [CCN] and nitrapyrin (580),
a plant activator selected from the group of substances consisting of acibenzolar (6), acibenzolar-5-methyl (6), probenazole (658) and Reynoutria sachalinensis extract (alternative name) (720),
a rodenticide selected from the group of substances consisting of 2-isovalerylindan-1,3-dione (IUPAC name) (1246), 4-(quinoxalin-2-ylamino)benzenesulfonamide (IUPAC name) (748), alpha-chlorohydrin [CCN], aluminium phosphide (640), antu (880), arsenous oxide (882), barium carbonate (891), bisthiosemi (912), brodifacoum (89), bromadiolone (91), bromethalin (92), calcium cyamide (444), chloralose (127), chlorophacinone (140), cholecalciferol (alternative name) (850), coumachlor (1004), coumafuryl (1005), coumatetralyl (175), crimidine (1009), difenacoum (246), difethialone (249), diphacinone (273), ergocalciferol (301), flocoumafen (357), fluoroacetamide (379), flupropadine (1183), flupropadine hydrochloride (1183), gamma-HCH (430), HCH (430), hydrogen cyamide (444), iodomethane (IUPAC name) (542), lindane (430), magnesium phosphide (IUPAC name) (640), methyl bromide (537), norbormide (1318), phosacetim (1336), phosphine (IUPAC name) (640), phosphorus [CCN], pindone (1341), potassium arsenite [CCN], pyrinuron (1371), scilliroside (1390), sodium arsenite [CCN], sodium cyamide (444), sodium fluoro-acetate (735), strychnine (745), thallium sulfate [CCN], warfarin (851) and zinc phosphide (640),
a synergist selected from the group of substances consisting of 2-(2-butoxyethoxy)ethyl piperonylate (IUPAC name) (934), 5-(1,3-benzodioxol-5-yl)-3-hexylcyclohex-2-enone (IUPAC name) (903), farnesol with nerolidol (alternative name) (324), MB-599 (development code) (498), MGK 264 (development code) (296), piperonyl butoxide (649), piprotal (1343), propyl isomer (1358), S421 (development code) (724), sesamex (1393), sesasmolin (1394) and sulfoxide (1406),
an animal repellent selected from the group of substances consisting of anthraquinone (32), chloralose (127), copper naphthenate [CCN], copper oxychloride (171), diazinon (227), dicyclopentadiene (chemical name) (1069), guazatine (422), guazatine acetates (422), methiocarb (530), pyridin-4-amine (IUPAC name) (23), thiram (804), trimethacarb (840), zinc naphthenate [CCN] and ziram (856),
a virucide selected from the group of substances consisting of imanin (alternative name) [CCN] and ribavirin (alternative name) [CCN], and a wound protectant selected from the group of substances consisting of mercuric oxide (512), octhilinone (590) and thiophanate-methyl (802).

A very especially preferred embodiment of the subject-matter {1.1.15} of the invention is {1.1.15.2} a pesticidal composition comprising a mixture consisting of at least two substances, namely one compound (A) and at least one compound (B), as active ingredient and at least one auxiliary, wherein the compound (A) is the compound of formula (A-15) and the compound (B) is a compound selected from the group of substances consisting of abamectin (1), cyromazine (209), diafenthiuron (226), diazinon (227), emamectin benzoate (291), fenoxycarb (340), fosthiazate (408), lambda-cyhalothrin (198), lufenuron (490), methidathion (529), profenofos (662), pymetrozine (688), tefluthrin (769) and thiamethoxam (792).

The compound of formula (A-15) is known, for example, from the PCT Application WO-03/015519.

A preferred embodiment of the subject-matter {1.1} of the invention is {1.1.16} a pesticidal composition comprising a mixture consisting of at least two substances, namely one compound (A) and at least one compound (B), as active ingredient and at least one auxiliary, wherein the compound (A) is the compound of formula (A-16) 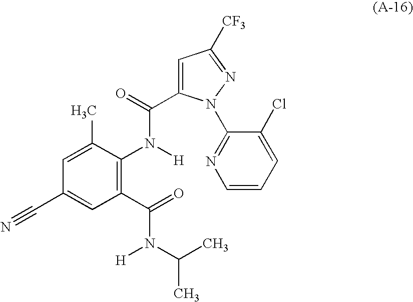
and the compound (B) is a compound selected from the group of substances consisting of an adjuvant, an acaricide, an algicide, an anthelmintic, an avicide, a bactericide, a biological agent, a soil sterilant, a chemosterilant, an insect pheromone, an insect repellent, an insecticide, a molluscicide, a nematicide, a nitrification inhibitor, a plant activator, a rodenticide, a synergist, an animal repellent, a virucide and a wound protectant.

An especially preferred embodiment of the subject-matter {1.1.16} of the invention is {1.1.16.1} a pesticidal composition comprising a mixture consisting of at least two substances, namely one compound (A) and at least one compound (B), as active ingredient and at least one auxiliary, wherein the compound (A) is the compound of formula (A-16) and the compound (B) is a compound selected from the group of substances consisting of
an adjuvant selected from the group of substances consisting of petroleum oils (alternative name) (628),
an acaricide selected from the group of substances consisting of 1,1-bis(4-chlorophenyl)-2-ethoxyethanol (IUPAC name) (910), 2,4-dichlorophenyl benzenesulfonate (IUPAC/Chemical Abstracts name) (1059), 2-fluoro-N-methyl-N-1-naphthylacetamide (IUPAC name) (1295), 4-chlorophenyl phenyl sulfone (IUPAC name) (981), abamectin (1), acequinocyl (3), acetoprole [CCN], acrinathrin (9), aldicarb (16), aldoxycarb (863), alpha-cypermethrin (202), amidithion (870), amidoflumet [CCN], amidothioate (872), amiton (875), amiton hydrogen oxalate (875), amitraz (24), aramite (881), arsenous oxide (882), AVI 382 (compound code), AZ 60541 (compound code), azinphos-ethyl (44), azinphos-methyl (45), azobenzene (IUPAC name) (888), azocyclotin (46), azothoate (889), benomyl (62), benoxafos (alternative name) [CCN], benzoximate (71), benzyl benzoate (IUPAC name) [CCN], bifenazate (74), bifenthrin (76), binapacryl (907), brofenvalerate (alternative name), bromocyclen (918), bromophos (920), bromophos-ethyl (921), bromopropylate (94), buprofezin (99), butocarboxim (103), butoxycarboxim (104), butylpyridaben (alternative name), calcium polysulfide (IUPAC name) (111), camphechlor (941), carbanolate (943), carbaryl (115), carbofuran (118), carbophenothion (947), CGA 50'439 (development code) (125), chinomethionat (126), chlorbenside (959), chlordimeform (964), chlordimeform hydrochloride (964), chlorfenapyr (130), chlorfenethol (968), chlorfenson (970), chlorfensulphide (971), chlorfenvinphos (131), chlorobenzilate (975), chloromebuform (977), chloromethiuron (978), chloropropylate (983), chlorpyrifos (145), chlorpyrifos-methyl (146), chlorthiophos (994), cinerin I (696), cinerin II (696), cinerins (696), clofentezine (158), closantel (alternative name) [CCN], coumaphos (174), crotamiton (alternative name) [CCN], crotoxyphos (1010), cufraneb (1013), cyanthoate (1020), cyhalothrin (196), cyhexatin (199), cypermethrin (201), DCPM (1032), DDT (219), demephion (1037), demephion-O (1037), demephion-S (1037), demeton (1038), demeton-methyl (224), demeton-O (1038), demeton-O-methyl (224), demeton-S (1038), demeton-5-methyl (224), demeton-5-methylsulphon (1039), diafenthiuron (226), dialifos (1042), diazinon (227), dichlofluanid (230), dichlorvos (236), dicliphos (alternative name), dicofol (242), dicrotophos (243), dienochlor (1071), dimefox (1081), dimethoate (262), dinactin (alternative name) (653), dinex (1089), dinex-diclexine (1089), dinobuton (269), dinocap (270), dinocap-4 [CCN], dinocap-6 [CCN], dinocton (1090), dinopenton (1092), dinosulfon (1097), dinoterbon (1098), dioxathion (1102), diphenyl sulfone (IUPAC name) (1103), disulfuram (alternative name) [CCN], disulfoton (278), DNOC (282), dofenapyn (1113), doramectin (alternative name) [CCN], endosulfan (294), endothion (1121), EPN (297), eprinomectin (alternative name) [CCN], ethion (309), ethoate-methyl (1134), etoxazole (320), etrimfos (1142), fenazaflor (1147), fenazaquin (328), fenbutatin oxide (330), fenothiocarb (337), fenpropathrin (342), fenpyrad (alternative name), fenpyroximate (345), fenson (1157), fentrifanil (1161), fenvalerate (349), fipronil (354), fluacrypyrim (360), fluazuron (1166), flubenzimine (1167), flucycloxuron (366), flucythrinate (367), fluenetil (1169), flufenoxuron (370), flumethrin (372), fluorbenside (1174), fluvalinate (1184), FMC 1137 (development code) (1185), formetanate (405), formetanate hydrochloride (405), formothion (1192), formparanate (1193), gamma-HCH (430), glyodin (1205), halfenprox (424), heptenophos (432), hexadecyl cyclopropanecarboxylate (IUPAC/Chemical Abstracts name) (1216), hexythiazox (441), iodomethane (IUPAC name) (542), isocarbophos (alternative name) (473), isopropyl O-(methoxyaminothiophosphoryl)salicylate (IUPAC name) (473), ivermectin (alternative name) [CCN], jasmolin I (696), jasmolin II (696), jodfenphos (1248), lindane (430), lufenuron (490), malathion (492), malonoben (1254), mecarbam (502), mephosfolan (1261), mesulfen (alternative name) [CCN], methacrifos (1266), methamidophos (527), methidathion (529), methiocarb (530), methomyl (531), methyl bromide (537), metolcarb (550), mevinphos (556), mexacarbate (1290), milbemectin (557), milbemycin oxime (alternative name) [CCN], mipafox (1293), monocrotophos (561), morphothion (1300), moxidectin (alternative name) [CCN], naled (567), NC-184 (compound code), nifluridide (1309), nikkomycins (alternative name) [CCN], nitrilacarb (1313), nitrilacarb 1:1 zinc chloride complex (1313), NNI-0101 (compound code), NNI-0250 (compound code), omethoate (594), oxamyl (602), oxydeprofos (1324), oxydisulfoton (1325), pp′-DDT (219), parathion (615), permethrin (626), petroleum oils (alternative name) (628), phenkapton (1330), phenthoate (631), phorate (636), phosalone (637), phosfolan (1338), phosmet (638), phosphamidon (639), phoxim (642), pirimiphos-methyl (652), polychloroterpenes (traditional name) (1347), polynactins (alternative name) (653), proclonol (1350), profenofos (662), promacyl (1354), propargite (671), propetamphos (673), propoxur (678), prothidathion (1360), prothoate (1362), pyrethrin I (696), pyrethrin II (696), pyrethrins (696), pyridaben (699), pyridaphenthion (701), pyrimidifen (706), pyrimitate (1370), quinalphos (711), quintiofos (1381), R-1492 (development code) (1382), RA-17 (development code) (1383), rotenone (722), schradan (1389), sebufos (alternative name), selamectin (alternative name) [CCN], SI-0009 (compound code), sophamide (1402), spirodiclofen (738), spiromesifen (739), SSI-121 (development code) (1404), sulfuram (alternative name) [CCN], sulfluramid (750), sulfotep (753), sulfur (754), SZI-121 (development code) (757), tau-fluvalinate (398), tebufenpyrad (763), TEPP (1417), terbam (alternative name), tetrachlorvinphos (777), tetradifon (786), tetranactin (alternative name) (653), tetrasul (1425), thiafenox (alternative name), thiocarboxime (1431), thiofanox (800), thiometon (801), thioquinox (1436), thuringiensin (alternative name) [CCN], triamiphos (1441), triarathene (1443), triazophos (820), triazuron (alternative name), trichlorfon (824), trifenofos (1455), trinactin (alternative name) (653), vamidothion (847), vaniliprole [CCN] and YI-5302 (compound code),
an algicide selected from the group of substances consisting of bethoxazin [CCN], copper dioctanoate (IUPAC name) (170), copper sulfate (172), cybutryne [CCN], dichlone (1052), dichlorophen (232), endothal (295), fentin (347), hydrated lime [CCN], nabam (566), quinoclamine (714), quinonamid (1379), simazine (730), triphenyltin acetate (IUPAC name) (347) and triphenyltin hydroxide (IUPAC name) (347),
an anthelmintic selected from the group of substances consisting of abamectin (1), crufomate (1011), doramectin (alternative name) [CCN], emamectin (291), emamectin benzoate (291), eprinomectin (alternative name) [CCN], ivermectin (alternative name) [CCN], milbemycin oxime (alternative name) [CCN], moxidectin (alternative name) [CCN], piperazine [CCN], selamectin (alternative name) [CCN], spinosad (737) and thiophanate (1435),
an avicide selected from the group of substances consisting of chloralose (127), endrin (1122), fenthion (346), pyridin-4-amine (IUPAC name) (23) and strychnine (745),
a bactericide selected from the group of substances consisting of 1-hydroxy-1H-pyridine-2-thione (IUPAC name) (1222), 4-(quinoxalin-2-ylamino)benzenesulfonamide (IUPAC name) (748), 8-hydroxyquinoline sulfate (446), bronopol (97), copper dioctanoate (IUPAC name) (170), copper hydroxide (IUPAC name) (169), cresol [CCN], dichlorophen (232), dipyrithione (1105), dodicin (1112), fenaminosulf (1144), formaldehyde (404), hydrargaphen (alternative name) [CCN], kasugamycin (483), kasugamycin hydrochloride hydrate (483), nickel bis(dimethyldithiocarbamate) (IUPAC name) (1308), nitrapyrin (580), octhilinone (590), oxolinic acid (606), oxytetracycline (611), potassium hydroxyquinoline sulfate (446), probenazole (658), streptomycin (744), streptomycin sesquisulfate (744), tecloftalam (766) and thiomersal (alternative name) [CCN],
a biological agent selected from the group of substances consisting of Adoxophyes orana GV (alternative name) (12), Agrobacterium radiobacter (alternative name) (13), Amblyseius spp. (alternative name) (19), Anagrapha falcifera NPV (alternative name) (28), Anagrus atomus (alternative name) (29), Aphelinus abdominalis (alternative name) (33), Aphidius colemani (alternative name) (34), Aphidoletes aphidimyza (alternative name) (35), Autographa californica NPV (alternative name) (38), Bacillus firmus (alternative name) (48), Bacillus sphaericus Neide (scientific name) (49), Bacillus thuringiensis Berliner (scientific name) (51), Bacillus thuringiensis subsp. aizawai (scientific name) (51), Bacillus thuringiensis subsp. israelensis (scientific name) (51), Bacillus thuringiensis subsp. japonensis (scientific name) (51), Bacillus thuringiensis subsp. kurstaki (scientific name) (51), Bacillus thuringiensis subsp. tenebrionis (scientific name) (51), Beauveria bassiana (alternative name) (53), Beauveria brongniartii (alternative name) (54), Chrysoperla carnea (alternative name) (151), Cryptolaemus montrouzieri (alternative name) (178), Cydia pomonella GV (alternative name) (191), Dacnusa sibirica (alternative name) (212), Diglyphus isaea (alternative name) (254), Encarsia formosa (scientific name) (293), Eretmocerus eremicus (alternative name) (300), Helicoverpa zea NPV (alternative name) (431), Heterorhabditis bacteriophora and H. megidis (alternative name) (433), Hippodamia convergens (alternative name) (442), Leptomastix dactylopii (alternative name) (488), Macrolophus caliginosus (alternative name) (491), Mamestra brassicae NPV (alternative name) (494), Metaphycus helvolus (alternative name) (522), Metarhizium anisopliae var. acridum (scientific name) (523), Metarhizium anisopliae var. anisopliae (scientific name) (523), Neodiprion sertifer NPV and N. lecontei NPV (alternative name) (575), Orius spp. (alternative name) (596), Paecilomyces fumosoroseus (alternative name) (613), Phytoseiulus persimilis (alternative name) (644), Spodoptera exigua multicapsid nuclear polyhedrosis virus (scientific name) (741), Steinernema bibionis (alternative name) (742), Steinernema carpocapsae (alternative name) (742), Steinernema feltiae (alternative name) (742), Steinernema glaseri (alternative name) (742), Steinernema riobrave (alternative name) (742), Steinernema riobravis (alternative name) (742), Steinernema scapterisci (alternative name) (742), Steinernema spp. (alternative name) (742), Trichogramma spp. (alternative name) (826), Typhlodromus occidentalis (alternative name) (844) and Verticillium lecanii (alternative name) (848), a soil sterilant selected from the group of substances consisting of iodomethane (IUPAC name) (542) and methyl bromide (537),
a chemosterilant selected from the group of substances consisting of apholate [CCN], bisazir (alternative name) [CCN], busulfan (alternative name) [CCN], diflubenzuron (250), dimatif (alternative name) [CCN], hemel [CCN], hempa [CCN], metepa [CCN], methiotepa [CCN], methyl apholate [CCN], morzid [CCN], penfluoron (alternative name) [CCN], tepa [CCN], thiohempa (alternative name) [CCN], thiotepa (alternative name) [CCN], tretamine (alternative name) [CCN] and uredepa (alternative name) [CCN],
an insect pheromone selected from the group of substances consisting of (E)-dec-5-en-1-yl acetate with (E)-dec-5-en-1-ol (IUPAC name) (222), (E)-tridec-4-en-1-yl acetate (IUPAC name) (829), (E)-6-methylhept-2-en-4-ol (IUPAC name) (541), (E,Z)-tetradeca-4,10-dien-1-yl acetate (IUPAC name) (779), (Z)-dodec-7-en-1-yl acetate (IUPAC name) (285), (Z)-hexadec-11-enal (IUPAC name) (436), (Z)-hexadec-11-en-1-yl acetate (IUPAC name) (437), (Z)-hexadec-13-en-11-yn-1-yl acetate (IUPAC name) (438), (Z)-icos-13-en-10-one (IUPAC name) (448), (Z)-tetradec-7-en-1-al (IUPAC name) (782), (Z)-tetradec-9-en-1-ol (IUPAC name) (783), (Z)-tetradec-9-en-1-yl acetate (IUPAC name) (784), (7E,9Z)-dodeca-7,9-dien-1-yl acetate (IUPAC name) (283), (9Z,11E)-tetradeca-9,11-dien-1-yl acetate (IUPAC name) (780), (9Z,12E)-tetradeca-9,12-dien-1-yl acetate (IUPAC name) (781), 14-methyloctadec-1-ene (IUPAC name) (545), 4-methylnonan-5-ol with 4-methylnonan-5-one (IUPAC name) (544), alpha-multistriatin (alternative name) [CCN], brevicomin (alternative name) [CCN], codlelure (alternative name) [CCN], codlemone (alternative name) (167), cuelure (alternative name) (179), disparlure (277), dodec-8-en-1-yl acetate (IUPAC name) (286), dodec-9-en-1-yl acetate (IUPAC name) (287), dodeca-8,10-dien-1-yl acetate (IUPAC name) (284), dominicalure (alternative name) [CCN], ethyl 4-methyloctanoate (IUPAC name) (317), eugenol (alternative name) [CCN], frontalin (alternative name) [CCN], gossyplure (alternative name) (420), grandlure (421), grandlure I (alternative name) (421), grandlure II (alternative name) (421), grandlure III (alternative name) (421), grandlure IV (alternative name) (421), hexylure [CCN], ipsdienol (alternative name) [CCN], ipsenol (alternative name) [CCN], japonilure (alternative name) (481), lineatin (alternative name) [CCN], litlure (alternative name) [CCN], looplure (alternative name) [CCN], medlure [CCN], megatomoic acid (alternative name) [CCN], methyl eugenol (alternative name) (540), muscalure (563), octadeca-2,13-dien-1-yl acetate (IUPAC name) (588), octadeca-3,13-dien-1-yl acetate (IUPAC name) (589), orfralure (alternative name) [CCN], oryctalure (alternative name) (317), ostramone (alternative name) [CCN], siglure [CCN], sordidin (alternative name) (736), sulcatol (alternative name) [CCN], tetradec-11-en-1-yl acetate (IUPAC name) (785), trimedlure (839), trimedlure A (alternative name) (839), trimedlure B₁ (alternative name) (839), trimedlure B₂ (alternative name) (839), trimedlure C (alternative name) (839) and trunc-call (alternative name) [CCN],
an insect repellent selected from the group of substances consisting of 2-(octylthio)-ethanol (IUPAC name) (591), butopyronoxyl (933), butoxy(polypropylene glycol) (936), dibutyl adipate (IUPAC name) (1046), dibutyl phthalate (1047), dibutyl succinate (IUPAC name) (1048), diethyltoluamide [CCN], dimethyl carbate [CCN], dimethyl phthalate [CCN], ethyl hexanediol (1137), hexamide [CCN], methoquin-butyl (1276), methylneodecanamide [CCN], oxamate [CCN] and picaridin [CCN],
an insecticide selected from the group of substances consisting of 1,1-dichloro-1-nitroethane (IUPAC/Chemical Abstracts name) (1058), 1,1-dichloro-2,2-bis(4-ethylphenyl)-ethane (IUPAC name) (1056), 1,2-dichloropropane (IUPAC/Chemical Abstracts name) (1062), 1,2-dichloropropane with 1,3-dichloropropene (IUPAC name) (1063), 1-bromo-2-chloroethane (IUPAC/Chemical Abstracts name) (916), 2,2,2-trichloro-1-(3,4-dichloro-phenyl)ethyl acetate (IUPAC name) (1451), 2,2-dichlorovinyl 2-ethylsulfinylethyl methyl phosphate (IUPAC name) (1066), 2-(1,3-dithiolan-2-yl)phenyl dimethylcarbamate (IUPAC/Chemical Abstracts name) (1109), 2-(2-butoxyethoxy)ethyl thiocyanate (IUPAC/Chemical Abstracts name) (935), 2-(4,5-dimethyl-1,3-dioxolan-2-yl)phenyl methylcarbamate (IUPAC/Chemical Abstracts name) (1084), 2-(4-chloro-3,5-xylyloxy)ethanol (IUPAC name) (986), 2-chlorovinyl diethyl phosphate (IUPAC name) (984), 2-imidazolidone (IUPAC name) (1225), 2-isovalerylindan-1,3-dione (IUPAC name) (1246), 2-methyl(prop-2-ynyl)aminophenyl methylcarbamate (IUPAC name) (1284), 2-thiocyanatoethyl laurate (IUPAC name) (1433), 3-bromo-1-chloroprop-1-ene (IUPAC name) (917), 3-methyl-1-phenylpyrazol-5-yl dimethyl-carbamate (IUPAC name) (1283), 4-methyl(prop-2-ynyl)amino-3,5-xylyl methylcarbamate (IUPAC name) (1285), 5,5-dimethyl-3-oxocyclohex-1-enyl dimethylcarbamate (IUPAC name) (1085), abamectin (1), acephate (2), acetamiprid (4), acethion (alternative name) [CCN], acetoprole [CCN], acrinathrin (9), acrylonitrile (IUPAC name) (861), alanycarb (15), aldicarb (16), aldoxycarb (863), aldrin (864), allethrin (17), allosamidin (alternative name) [CCN], allyxycarb (866), alpha-cypermethrin (202), alpha-ecdysone (alternative name) [CCN], aluminium phosphide (640), amidithion (870), amidothioate (872), aminocarb (873), amiton (875), amiton hydrogen oxalate (875), amitraz (24), anabasine (877), athidathion (883), AVI 382 (compound code), AZ 60541 (compound code), azadirachtin (alternative name) (41), azamethiphos (42), azinphos-ethyl (44), azinphos-methyl (45), azothoate (889), Bacillus thuringiensis delta endotoxins (alternative name) (52), barium hexafluorosilicate (alternative name) [CCN], barium polysulfide (IUPAC/Chemical Abstracts name) (892), barthrin [CCN], BAS 320 I (compound code), Bayer 22/190 (development code) (893), Bayer 22408 (development code) (894), bendiocarb (58), benfuracarb (60), bensultap (66), beta-cyfluthrin (194), beta-cypermethrin (203), bifenthrin (76), bioallethrin (78), bioallethrin S-cyclopentenyl isomer (alternative name) (79), bioethanomethrin [CCN], biopermethrin (908), bioresmethrin (80), bis(2-chloroethyl)ether (IUPAC name) (909), bistrifluoron (83), borax (86), brofenvalerate (alternative name), bromfenvinfos (914), bromocyclen (918), bromo-DDT (alternative name) [CCN], bromophos (920), bromophos-ethyl (921), bufencarb (924), buprofezin (99), butacarb (926), butathiofos (927), butocarboxim (103), butonate (932), butoxycarboxim (104), butylpyridaben (alternative name), cadusafos (109), calcium arsenate [CCN], calcium cyamide (444), calcium polysulfide (IUPAC name) (111), camphechlor (941), carbanolate (943), carbaryl (115), carbofuran (118), carbon disulfide (IUPAC/Chemical Abstracts name) (945), carbon tetrachloride (IUPAC name) (946), carbophenothion (947), carbosulfan (119), cartap (123), cartap hydrochloride (123), cevadine (alternative name) (725), chlorbicyclen (960), chlordane (128), chlordecone (963), chlordimeform (964), chlordimeform hydrochloride (964), chlorethoxyfos (129), chlorfenapyr (130), chlorfenvinphos (131), chlorfluazuron (132), chlormephos (136), chloroform [CCN], chloropicrin (141), chlorphoxim (989), chlorprazophos (990), chlorpyrifos (145), chlorpyrifos-methyl (146), chlorthiophos (994), chromafenozide (150), cinerin I (696), cinerin II (696), cinerins (696), cis-resmethrin (alternative name), cismethrin (80), clocythrin (alternative name), cloethocarb (999), closantel (alternative name) [CCN], clothianidin (165), copper acetoarsenite [CCN], copper arsenate [CCN], copper oleate [CCN], coumaphos (174), coumithoate (1006), crotamiton (alternative name) [CCN], crotoxyphos (1010), crufomate (1011), cryolite (alternative name) (177), CS 708 (development code) (1012), cyanofenphos (1019), cyanophos (184), cyanthoate (1020), cyclethrin [CCN], cycloprothrin (188), cyfluthrin (193), cyhalothrin (196), cypermethrin (201), cyphenothrin (206), cyromazine (209), cythioate (alternative name) [CCN], d-limonene (alternative name) [CCN], d-tetramethrin (alternative name) (788), DAEP (1031), dazomet (216), DDT (219), decarbofuran (1034), deltamethrin (223), demephion (1037), demephion-O (1037), demephion-S (1037), demeton (1038), demeton-methyl (224), demeton-O (1038), demeton-O-methyl (224), demeton-S (1038), demeton-5-methyl (224), demeton-5-methylsulphon (1039), diafenthiuron (226), dialifos (1042), diamidafos (1044), diazinon (227), dicapthon (1050), dichlofenthion (1051), dichlorvos (236), dicliphos (alternative name), dicresyl (alternative name) [CCN], dicrotophos (243), dicyclanil (244), dieldrin (1070), diethyl 5-methylpyrazol-3-yl phosphate (IUPAC name) (1076), diflubenzuron (250), dilor (alternative name) [CCN], dimefluthrin [CCN], dimefox (1081), dimetan (1085), dimethoate (262), dimethrin (1083), dimethylvinphos (265), dimetilan (1086), dinex (1089), dinex-diclexine (1089), dinoprop (1093), dinosam (1094), dinoseb (1095), dinotefuran (271), diofenolan (1099), dioxabenzofos (1100), dioxacarb (1101), dioxathion (1102), disulfoton (278), dithicrofos (1108), DNOC (282), doramectin (alternative name) [CCN], DSP (1115), ecdysterone (alternative name) [CCN], EI 1642 (development code) (1118), emamectin (291), emamectin benzoate (291), EMPC (1120), empenthrin (292), endosulfan (294), endothion (1121), endrin (1122), EPBP (1123), EPN (297), epofenonane (1124), eprinomectin (alternative name) [CCN], esfenvalerate (302), etaphos (alternative name) [CCN], ethiofencarb (308), ethion (309), ethiprole (310), ethoate-methyl (1134), ethoprophos (312), ethyl formate (IUPAC name) [CCN], ethyl-DDD (alternative name) (1056), ethylene dibromide (316), ethylene dichloride (chemical name) (1136), ethylene oxide [CCN], etofenprox (319), etrimfos (1142), EXD (1143), famphur (323), fenamiphos (326), fenazaflor (1147), fenchlorphos (1148), fenethacarb (1149), fenfluthrin (1150), fenitrothion (335), fenobucarb (336), fenoxacrim (1153), fenoxycarb (340), fenpirithrin (1155), fenpropathrin (342), fenpyrad (alternative name), fensulfothion (1158), fenthion (346), fenthion-ethyl [CCN], fenvalerate (349), fipronil (354), flonicamid (358), flucofuron (1168), flucycloxuron (366), flucythrinate (367), fluenetil (1169), flufenerim [CCN], flufenoxuron (370), flufenprox (1171), flumethrin (372), fluvalinate (1184), FMC 1137 (development code) (1185), fonofos (1191), formetanate (405), formetanate hydrochloride (405), formothion (1192), formparanate (1193), fosmethilan (1194), fospirate (1195), fosthiazate (408), fosthietan (1196), furathiocarb (412), furethrin (1200), gamma-cyhalothrin (197), gamma-HCH (430), guazatine (422), guazatine acetates (422), GY-81 (development code) (423), halfenprox (424), halofenozide (425), HCH (430), HEOD (1070), heptachlor (1211), heptenophos (432), heterophos [CCN], hexaflumuron (439), HHDN (864), hydramethylnon (443), hydrogen cyamide (444), hydroprene (445), hyquincarb (1223), imidacloprid (458), imiprothrin (460), indoxacarb (465), iodomethane (IUPAC name) (542), IPSP (1229), isazofos (1231), isobenzan (1232), isocarbophos (alternative name) (473), isodrin (1235), isofenphos (1236), isolane (1237), isoprocarb (472), isopropyl O-(methoxyaminothiophosphoryl)salicylate (IUPAC name) (473), isoprothiolane (474), isothioate (1244), isoxathion (480), ivermectin (alternative name) [CCN], jasmolin I (696), jasmolin II (696), jodfenphos (1248), juvenile hormone I (alternative name) [CCN], juvenile hormone II (alternative name) [CCN], juvenile hormone III (alternative name) [CCN], kelevan (1249), kinoprene (484), lambda-cyhalothrin (198), lead arsenate [CCN], leptophos (1250), lindane (430), lirimfos (1251), lufenuron (490), lythidathion (1253), m-cumenyl methylcarbamate (IUPAC name) (1014), magnesium phosphide (IUPAC name) (640), malathion (492), malonoben (1254), mazidox (1255), mecarbam (502), mecarphon (1258), menazon (1260), mephosfolan (1261), mercurous chloride (513), mesulfenfos (1263), metam (519), metam-potassium (alternative name) (519), metam-sodium (519), methacrifos (1266), methamidophos (527), methanesulfonyl fluoride (IUPAC/Chemical Abstracts name) (1268), methidathion (529), methiocarb (530), methocrotophos (1273), methomyl (531), methoprene (532), methoquin-butyl (1276), methothrin (alternative name) (533), methoxychlor (534), methoxyfenozide (535), methyl bromide (537), methyl isothiocyanate (543), methylchloroform (alternative name) [CCN], methylene chloride [CCN], metofluthrin [CCN], metolcarb (550), metoxadiazone (1288), mevinphos (556), mexacarbate (1290), milbemectin (557), milbemycin oxime (alternative name) [CCN], mipafox (1293), mirex (1294), monocrotophos (561), morphothion (1300), moxidectin (alternative name) [CCN], naftalofos (alternative name) [CCN], naled (567), naphthalene (IUPAC/Chemical Abstracts name) (1303), NC-170 (development code) (1306), NC-184 (compound code), nicotine (578), nicotine sulfate (578), nifluridide (1309), nitenpyram (579), nithiazine (1311), nitrilacarb (1313), nitrilacarb 1:1 zinc chloride complex (1313), NNI-0101 (compound code), NNI-0250 (compound code), nornicotine (traditional name) (1319), novaluron (585), noviflumuron (586), O-2,5-dichloro-4-iodophenyl O-ethyl ethylphosphonothioate (IUPAC name) (1057), O,O-diethyl O-4-methyl-2-oxo-2H-chromen-7-yl phosphorothioate (IUPAC name) (1074), O,O-diethyl O-6-methyl-2-propylpyrimidin-4-yl phosphorothioate (IUPAC name) (1075), O,O,O′,O′-tetrapropyl dithiopyrophosphate (IUPAC name) (1424), oleic acid (IUPAC name) (593), omethoate (594), oxamyl (602), oxydemeton-methyl (609), oxydeprofos (1324), oxydisulfoton (1325), pp′-DDT (219), para-dichlorobenzene [CCN], parathion (615), parathion-methyl (616), penfluoron (alternative name) [CCN], pentachlorophenol (623), pentachlorophenyl laurate (IUPAC name) (623), permethrin (626), petroleum oils (alternative name) (628), PH 60-38 (development code) (1328), phenkapton (1330), phenothrin (630), phenthoate (631), phorate (636), phosalone (637), phosfolan (1338), phosmet (638), phosnichlor (1339), phosphamidon (639), phosphine (IUPAC name) (640), phoxim (642), phoxim-methyl (1340), pirimetaphos (1344), pirimicarb (651), pirimiphos-ethyl (1345), pirimiphos-methyl (652), polychlorodicyclopentadiene isomers (IUPAC name) (1346), polychloroterpenes (traditional name) (1347), potassium arsenite [CCN], potassium thiocyanate [CCN], prallethrin (655), precocene I (alternative name) [CCN], precocene II (alternative name) [CCN], precocene III (alternative name) [CCN], primidophos (1349), profenofos (662), profluthrin [CCN], promacyl (1354), promecarb (1355), propaphos (1356), propetamphos (673), propoxur (678), prothidathion (1360), prothiofos (686), prothoate (1362), protrifenbute [CCN], pymetrozine (688), pyraclofos (689), pyrazophos (693), pyresmethrin (1367), pyrethrin I (696), pyrethrin II (696), pyrethrins (696), pyridaben (699), pyridalyl (700), pyridaphenthion (701), pyrimidifen (706), pyrimitate (1370), pyriproxyfen (708), quassia (alternative name) [CCN], quinalphos (711), quinalphos-methyl (1376), quinothion (1380), quintiofos (1381), R-1492 (development code) (1382), rafoxanide (alternative name) [CCN], resmethrin (719), rotenone (722), RU 15525 (development code) (723), RU 25475 (development code) (1386), ryania (alternative name) (1387), ryanodine (traditional name) (1387), sabadilla (alternative name) (725), schradan (1389), sebufos (alternative name), selamectin (alternative name) [CCN], SI-0009 (compound code), silafluofen (728), SN 72129 (development code) (1397), sodium arsenite [CCN], sodium cyamide (444), sodium fluoride (IUPAC/Chemical Abstracts name) (1399), sodium hexafluorosilicate (1400), sodium pentachlorophenoxide (623), sodium selenate (IUPAC name) (1401), sodium thiocyanate [CCN], sophamide (1402), spinosad (737), spiromesifen (739), sulcofuron (746), sulcofuron-sodium (746), sulfluramid (750), sulfotep (753), sulfuryl fluoride (756), sulprofos (1408), tar oils (alternative name) (758), tau-fluvalinate (398), tazimcarb (1412), TDE (1414), tebufenozide (762), tebufenpyrad (763), tebupirimfos (764), teflubenzuron (768), tefluthrin (769), temephos (770), TEPP (1417), terallethrin (1418), terbam (alternative name), terbufos (773), tetrachloroethane [CCN], tetrachlorvinphos (777), tetramethrin (787), theta-cypermethrin (204), thiacloprid (791), thiafenox (alternative name), thiamethoxam (792), thicrofos (1428), thiocarboxime (1431), thiocyclam (798), thiocyclam hydrogen oxalate (798), thiodicarb (799), thiofanox (800), thiometon (801), thionazin (1434), thiosultap (803), thiosultap-sodium (803), thuringiensin (alternative name) [CCN], tolfenpyrad (809), tralomethrin (812), transfluthrin (813), transpermethrin (1440), triamiphos (1441), triazamate (818), triazophos (820), triazuron (alternative name), trichlorfon (824), trichlormetaphos-3 (alternative name) [CCN], trichloronat (1452), trifenofos (1455), triflumuron (835), trimethacarb (840), triprene (1459), vamidothion (847), vaniliprole [CCN], veratridine (alternative name) (725), veratrine (alternative name) (725), XMC (853), xylylcarb (854), YI-5302 (compound code), zeta-cypermethrin (205), zetamethrin (alternative name), zinc phosphide (640), zolaprofos (1469) and ZXI 8901 (development code) (858),
a molluscicide selected from the group of substances consisting of bis(tributyltin)oxide (IUPAC name) (913), bromoacetamide [CCN], calcium arsenate [CCN], cloethocarb (999), copper acetoarsenite [CCN], copper sulfate (172), fentin (347), ferric phosphate (IUPAC name) (352), metaldehyde (518), methiocarb (530), niclosamide (576), niclosamide-olamine (576), pentachlorophenol (623), sodium pentachlorophenoxide (623), tazimcarb (1412), thiodicarb (799), tributyltin oxide (913), trifenmorph (1454), trimethacarb (840), triphenyltin acetate (IUPAC name) (347) and triphenyltin hydroxide (IUPAC name) (347),
a nematicide selected from the group of substances consisting of 1,2-dibromo-3-chloropropane (IUPAC/Chemical Abstracts name) (1045), 1,2-dichloropropane (IUPAC/Chemical Abstracts name) (1062), 1,2-dichloropropane with 1,3-dichloropropene (IUPAC name) (1063), 1,3-dichloropropene (233), 3,4-dichlorotetrahydrothiophene 1,1-dioxide (IUPAC/Chemical Abstracts name) (1065), 3-(4-chlorophenyl)-5-methylrhodanine (IUPAC name) (980), 5-methyl-6-thioxo-1,3,5-thiadiazinan-3-ylacetic acid (IUPAC name) (1286), 6-isopentenylaminopurine (alternative name) (210), abamectin (1), acetoprole [CCN], alanycarb (15), aldicarb (16), aldoxycarb (863), AZ 60541 (compound code), benclothiaz [CCN], benomyl (62), butylpyridaben (alternative name), cadusafos (109), carbofuran (118), carbon disulfide (945), carbosulfan (119), chloropicrin (141), chlorpyrifos (145), cloethocarb (999), cytokinins (alternative name) (210), dazomet (216), DBCP (1045), DCIP (218), diamidafos (1044), dichlofenthion (1051), dicliphos (alternative name), dimethoate (262), doramectin (alternative name) [CCN], emamectin (291), emamectin benzoate (291), eprinomectin (alternative name) [CCN], ethoprophos (312), ethylene dibromide (316), fenamiphos (326), fenpyrad (alternative name), fensulfothion (1158), fosthiazate (408), fosthietan (1196), furfural (alternative name) [CCN], GY-81 (development code) (423), heterophos [CCN], iodomethane (IUPAC name) (542), isamidofos (1230), isazofos (1231), ivermectin (alternative name) [CCN], kinetin (alternative name) (210), mecarphon (1258), metam (519), metam-potassium (alternative name) (519), metam-sodium (519), methyl bromide (537), methyl isothiocyanate (543), milbemycin oxime (alternative name) [CCN], moxidectin (alternative name) [CCN], Myrothecium verrucaria composition (alternative name) (565), NC-184 (compound code), oxamyl (602), phorate (636), phosphamidon (639), phosphocarb [CCN], sebufos (alternative name), selamectin (alternative name) [CCN], spinosad (737), terbam (alternative name), terbufos (773), tetrachlorothiophene (IUPAC/Chemical Abstracts name) (1422), thiafenox (alternative name), thionazin (1434), triazophos (820), triazuron (alternative name), xylenols [CCN], YI-5302 (compound code) and zeatin (alternative name) (210),
a nitrification inhibitor selected from the group of substances consisting of potassium ethylxanthate [CCN] and nitrapyrin (580),
a plant activator selected from the group of substances consisting of acibenzolar (6), acibenzolar-5-methyl (6), probenazole (658) and Reynoutria sachalinensis extract (alternative name) (720),
a rodenticide selected from the group of substances consisting of 2-isovalerylindan-1,3-dione (IUPAC name) (1246), 4-(quinoxalin-2-ylamino)benzenesulfonamide (IUPAC name) (748), alpha-chlorohydrin [CCN], aluminium phosphide (640), antu (880), arsenous oxide (882), barium carbonate (891), bisthiosemi (912), brodifacoum (89), bromadiolone (91), bromethalin (92), calcium cyamide (444), chloralose (127), chlorophacinone (140), cholecalciferol (alternative name) (850), coumachlor (1004), coumafuryl (1005), coumatetralyl (175), crimidine (1009), difenacoum (246), difethialone (249), diphacinone (273), ergocalciferol (301), flocoumafen (357), fluoroacetamide (379), flupropadine (1183), flupropadine hydrochloride (1183), gamma-HCH (430), HCH (430), hydrogen cyamide (444), iodomethane (IUPAC name) (542), lindane (430), magnesium phosphide (IUPAC name) (640), methyl bromide (537), norbormide (1318), phosacetim (1336), phosphine (IUPAC name) (640), phosphorus [CCN], pindone (1341), potassium arsenite [CCN], pyrinuron (1371), scilliroside (1390), sodium arsenite [CCN], sodium cyamide (444), sodium fluoro-acetate (735), strychnine (745), thallium sulfate [CCN], warfarin (851) and zinc phosphide (640),
a synergist selected from the group of substances consisting of 2-(2-butoxyethoxy)ethyl piperonylate (IUPAC name) (934), 5-(1,3-benzodioxol-5-yl)-3-hexylcyclohex-2-enone (IUPAC name) (903), farnesol with nerolidol (alternative name) (324), MB-599 (development code) (498), MGK 264 (development code) (296), piperonyl butoxide (649), piprotal (1343), propyl isomer (1358), S421 (development code) (724), sesamex (1393), sesasmolin (1394) and sulfoxide (1406),
an animal repellent selected from the group of substances consisting of anthraquinone (32), chloralose (127), copper naphthenate [CCN], copper oxychloride (171), diazinon (227), dicyclopentadiene (chemical name) (1069), guazatine (422), guazatine acetates (422), methiocarb (530), pyridin-4-amine (IUPAC name) (23), thiram (804), trimethacarb (840), zinc naphthenate [CCN] and ziram (856),
a virucide selected from the group of substances consisting of imanin (alternative name) [CCN] and ribavirin (alternative name) [CCN],
and a wound protectant selected from the group of substances consisting of mercuric oxide (512), octhilinone (590) and thiophanate-methyl (802).

A very especially preferred embodiment of the subject-matter {1.1.16} of the invention is {1.1.16.2} a pesticidal composition comprising a mixture consisting of at least two substances, namely one compound (A) and at least one compound (B), as active ingredient and at least one auxiliary, wherein the compound (A) is the compound of formula (A-16) and the compound (B) is a compound selected from the group of substances consisting of abamectin (1), cyromazine (209), diafenthiuron (226), diazinon (227), emamectin benzoate (291), fenoxycarb (340), fosthiazate (408), lambda-cyhalothrin (198), lufenuron (490), methidathion (529), profenofos (662), pymetrozine (688), tefluthrin (769) and thiamethoxam (792).

The compound of formula (A-16) is known, for example, from the PCT Application WO-04/067528.

A preferred embodiment of the subject-matter {11.1} of the invention is {1.1.17} a pesticidal composition comprising a mixture consisting of at least two substances, namely one compound (A) and at least one compound (B), as active ingredient and at least one auxiliary, wherein the compound (A) is the compound of formula (A-17) 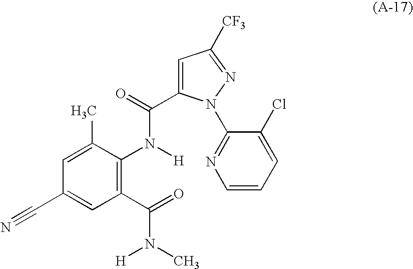
and the compound (B) is a compound selected from the group of substances consisting of an adjuvant, an acaricide, an algicide, an anthelmintic, an avicide, a bactericide, a biological agent, a soil sterilant, a chemosterilant, an insect pheromone, an insect repellent, an insecticide, a molluscicide, a nematicide, a nitrification inhibitor, a plant activator, a rodenticide, a synergist, an animal repellent, a virucide and a wound protectant.

An especially preferred embodiment of the subject-matter {1.1.17} of the invention is {1.1.17.1} a pesticidal composition comprising a mixture consisting of at least two substances, namely one compound (A) and at least one compound (B), as active ingredient and at least one auxiliary, wherein the compound (A) is the compound of formula (A-17) and the compound (B) is a compound selected from the group of substances consisting of
an adjuvant selected from the group of substances consisting of petroleum oils (alternative name) (628),
an acaricide selected from the group of substances consisting of 1,1-bis(4-chlorophenyl)-2-ethoxyethanol (IUPAC name) (910), 2,4-dichlorophenyl benzenesulfonate (IUPAC/Chemical Abstracts name) (1059), 2-fluoro-N-methyl-N-1-naphthylacetamide (IUPAC name) (1295), 4-chlorophenyl phenyl sulfone (IUPAC name) (981), abamectin (1), acequinocyl (3), acetoprole [CCN], acrinathrin (9), aldicarb (16), aldoxycarb (863), alpha-cypermethrin (202), amidithion (870), amidoflumet [CCN], amidothioate (872), amiton (875), amiton hydrogen oxalate (875), amitraz (24), aramite (881), arsenous oxide (882), AVI 382 (compound code), AZ 60541 (compound code), azinphos-ethyl (44), azinphos-methyl (45), azobenzene (IUPAC name) (888), azocyclotin (46), azothoate (889), benomyl (62), benoxafos (alternative name) [CCN], benzoximate (71), benzyl benzoate (IUPAC name) [CCN], bifenazate (74), bifenthrin (76), binapacryl (907), brofenvalerate (alternative name), bromocyclen (918), bromophos (920), bromophos-ethyl (921), bromopropylate (94), buprofezin (99), butocarboxim (103), butoxycarboxim (104), butylpyridaben (alternative name), calcium polysulfide (IUPAC name) (111), camphechlor (941), carbanolate (943), carbaryl (115), carbofuran (118), carbophenothion (947), CGA 50'439 (development code) (125), chinomethionat (126), chlorbenside (959), chlordimeform (964), chlordimeform hydrochloride (964), chlorfenapyr (130), chlorfenethol (968), chlorfenson (970), chlorfensulphide (971), chlorfenvinphos (131), chlorobenzilate (975), chloromebuform (977), chloromethiuron (978), chloropropylate (983), chlorpyrifos (145), chlorpyrifos-methyl (146), chlorthiophos (994), cinerin I (696), cinerin II (696), cinerins (696), clofentezine (158), closantel (alternative name) [CCN], coumaphos (174), crotamiton (alternative name) [CCN], crotoxyphos (1010), cufraneb (1013), cyanthoate (1020), cyhalothrin (196), cyhexatin (199), cypermethrin (201), DCPM (1032), DDT (219), demephion (1037), demephion-O (1037), demephion-S (1037), demeton (1038), demeton-methyl (224), demeton-O (1038), demeton-O-methyl (224), demeton-S (1038), demeton-5-methyl (224), demeton-5-methylsulphon (1039), diafenthiuron (226), dialifos (1042), diazinon (227), dichlofluanid (230), dichlorvos (236), dicliphos (alternative name), dicofol (242), dicrotophos (243), dienochlor (1071), dimefox (1081), dimethoate (262), dinactin (alternative name) (653), dinex (1089), dinex-diclexine (1089), dinobuton (269), dinocap (270), dinocap-4 [CCN], dinocap-6 [CCN], dinocton (1090), dinopenton (1092), dinosulfon (1097), dinoterbon (1098), dioxathion (1102), diphenyl sulfone (IUPAC name) (1103), disulfuram (alternative name) [CCN], disulfoton (278), DNOC (282), dofenapyn (1113), doramectin (alternative name) [CCN], endosulfan (294), endothion (1121), EPN (297), eprinomectin (alternative name) [CCN], ethion (309), ethoate-methyl (1134), etoxazole (320), etrimfos (1142), fenazaflor (1147), fenazaquin (328), fenbutatin oxide (330), fenothiocarb (337), fenpropathrin (342), fenpyrad (alternative name), fenpyroximate (345), fenson (1157), fentrifanil (1161), fenvalerate (349), fipronil (354), fluacrypyrim (360), fluazuron (1166), flubenzimine (1167), flucycloxuron (366), flucythrinate (367), fluenetil (1169), flufenoxuron (370), flumethrin (372), fluorbenside (1174), fluvalinate (1184), FMC 1137 (development code) (1185), formetanate (405), formetanate hydrochloride (405), formothion (1192), formparanate (1193), gamma-HCH (430), glyodin (1205), halfenprox (424), heptenophos (432), hexadecyl cyclopropanecarboxylate (IUPAC/Chemical Abstracts name) (1216), hexythiazox (441), iodomethane (IUPAC name) (542), isocarbophos (alternative name) (473), isopropyl O-(methoxyaminothiophosphoryl)salicylate (IUPAC name) (473), ivermectin (alternative name) [CCN], jasmolin I (696), jasmolin II (696), jodfenphos (1248), lindane (430), lufenuron (490), malathion (492), malonoben (1254), mecarbam (502), mephosfolan (1261), mesulfen (alternative name) [CCN], methacrifos (1266), methamidophos (527), methidathion (529), methiocarb (530), methomyl (531), methyl bromide (537), metolcarb (550), mevinphos (556), mexacarbate (1290), milbemectin (557), milbemycin oxime (alternative name) [CCN], mipafox (1293), monocrotophos (561), morphothion (1300), moxidectin (alternative name) [CCN], naled (567), NC-184 (compound code), nifluridide (1309), nikkomycins (alternative name) [CCN], nitrilacarb (1313), nitrilacarb 1:1 zinc chloride complex (1313), NNI-0101 (compound code), NNI-0250 (compound code), omethoate (594), oxamyl (602), oxydeprofos (1324), oxydisulfoton (1325), pp′-DDT (219), parathion (615), permethrin (626), petroleum oils (alternative name) (628), phenkapton (1330), phenthoate (631), phorate (636), phosalone (637), phosfolan (1338), phosmet (638), phosphamidon (639), phoxim (642), pirimiphos-methyl (652), polychloroterpenes (traditional name) (1347), polynactins (alternative name) (653), proclonol (1350), profenofos (662), promacyl (1354), propargite (671), propetamphos (673), propoxur (678), prothidathion (1360), prothoate (1362), pyrethrin I (696), pyrethrin II (696), pyrethrins (696), pyridaben (699), pyridaphenthion (701), pyrimidifen (706), pyrimitate (1370), quinalphos (711), quintiofos (1381), R-1492 (development code) (1382), RA-17 (development code) (1383), rotenone (722), schradan (1389), sebufos (alternative name), selamectin (alternative name) [CCN], SI-0009 (compound code), sophamide (1402), spirodiclofen (738), spiromesifen (739), SSI-121 (development code) (1404), sulfuram (alternative name) [CCN], sulfluramid (750), sulfotep (753), sulfur (754), SZI-121 (development code) (757), tau-fluvalinate (398), tebufenpyrad (763), TEPP (1417), terbam (alternative name), tetrachlorvinphos (777), tetradifon (786), tetranactin (alternative name) (653), tetrasul (1425), thiafenox (alternative name), thiocarboxime (1431), thiofanox (800), thiometon (801), thioquinox (1436), thuringiensin (alternative name) [CCN], triamiphos (1441), triarathene (1443), triazophos (820), triazuron (alternative name), trichlorfon (824), trifenofos (1455), trinactin (alternative name) (653), vamidothion (847), vaniliprole [CCN] and YI-5302 (compound code),
an algicide selected from the group of substances consisting of bethoxazin [CCN], copper dioctanoate (IUPAC name) (170), copper sulfate (172), cybutryne [CCN], dichlone (1052), dichlorophen (232), endothal (295), fentin (347), hydrated lime [CCN], nabam (566), quinoclamine (714), quinonamid (1379), simazine (730), triphenyltin acetate (IUPAC name) (347) and triphenyltin hydroxide (IUPAC name) (347),
an anthelmintic selected from the group of substances consisting of abamectin (1), crufomate (1011), doramectin (alternative name) [CCN], emamectin (291), emamectin benzoate (291), eprinomectin (alternative name) [CCN], ivermectin (alternative name) [CCN], milbemycin oxime (alternative name) [CCN], moxidectin (alternative name) [CCN], piperazine [CCN], selamectin (alternative name) [CCN], spinosad (737) and thiophanate (1435),
an avicide selected from the group of substances consisting of chloralose (127), endrin (1122), fenthion (346), pyridin-4-amine (IUPAC name) (23) and strychnine (745),
a bactericide selected from the group of substances consisting of 1-hydroxy-1H-pyridine-2-thione (IUPAC name) (1222), 4-(quinoxalin-2-ylamino)benzenesulfonamide (IUPAC name) (748), 8-hydroxyquinoline sulfate (446), bronopol (97), copper dioctanoate (IUPAC name) (170), copper hydroxide (IUPAC name) (169), cresol [CCN], dichlorophen (232), dipyrithione (1105), dodicin (1112), fenaminosulf (1144), formaldehyde (404), hydrargaphen (alternative name) [CCN], kasugamycin (483), kasugamycin hydrochloride hydrate (483), nickel bis(dimethyldithiocarbamate) (IUPAC name) (1308), nitrapyrin (580), octhilinone (590), oxolinic acid (606), oxytetracycline (611), potassium hydroxyquinoline sulfate (446), probenazole (658), streptomycin (744), streptomycin sesquisulfate (744), tecloftalam (766) and thiomersal (alternative name) [CCN],
a biological agent selected from the group of substances consisting of Adoxophyes orana GV (alternative name) (12), Agrobacterium radiobacter (alternative name) (13), Amblyseius spp. (alternative name) (19), Anagrapha falcifera NPV (alternative name) (28), Anagrus atomus (alternative name) (29), Aphelinus abdominalis (alternative name) (33), Aphidius colemani (alternative name) (34), Aphidoletes aphidimyza (alternative name) (35), Autographa californica NPV (alternative name) (38), Bacillus firmus (alternative name) (48), Bacillus sphaericus Neide (scientific name) (49), Bacillus thuringiensis Berliner (scientific name) (51), Bacillus thuringiensis subsp. aizawai (scientific name) (51), Bacillus thuringiensis subsp. israelensis (scientific name) (51), Bacillus thuringiensis subsp. japonensis (scientific name) (51), Bacillus thuringiensis subsp. kurstaki (scientific name) (51), Bacillus thuringiensis subsp. tenebrionis (scientific name) (51), Beauveria bassiana (alternative name) (53), Beauveria brongniartii (alternative name) (54), Chrysoperla carnea (alternative name) (151), Cryptolaemus montrouzieri (alternative name) (178), Cydia pomonella GV (alternative name) (191), Dacnusa sibirica (alternative name) (212), Diglyphus isaea (alternative name) (254), Encarsia formosa (scientific name) (293), Eretmocerus eremicus (alternative name) (300), Helicoverpa zea NPV (alternative name) (431), Heterorhabditis bacteriophora and H. megidis (alternative name) (433), Hippodamia convergens (alternative name) (442), Leptomastix dactylopii (alternative name) (488), Macrolophus caliginosus (alternative name) (491), Mamestra brassicae NPV (alternative name) (494), Metaphycus helvolus (alternative name) (522), Metarhizium anisopliae var. acridum (scientific name) (523), Metarhizium anisopliae var. anisopliae (scientific name) (523), Neodiprion sertifer NPV and N. lecontei NPV (alternative name) (575), Orius spp. (alternative name) (596), Paecilomyces fumosoroseus (alternative name) (613), Phytoseiulus persimilis (alternative name) (644), Spodoptera exigua multicapsid nuclear polyhedrosis virus (scientific name) (741), Steinernema bibionis (alternative name) (742), Steinernema carpocapsae (alternative name) (742), Steinernema feltiae (alternative name) (742), Steinernema glaseri (alternative name) (742), Steinernema riobrave (alternative name) (742), Steinernema riobravis (alternative name) (742), Steinernema scapterisci (alternative name) (742), Steinernema spp. (alternative name) (742), Trichogramma spp. (alternative name) (826), Typhlodromus occidentalis (alternative name) (844) and Verticillium lecanii (alternative name) (848),
a soil sterilant selected from the group of substances consisting of iodomethane (IUPAC name) (542) and methyl bromide (537),
a chemosterilant selected from the group of substances consisting of apholate [CCN], bisazir (alternative name) [CCN], busulfan (alternative name) [CCN], diflubenzuron (250), dimatif (alternative name) [CCN], hemel [CCN], hempa [CCN], metepa [CCN], methiotepa [CCN], methyl apholate [CCN], morzid [CCN], penfluoron (alternative name) [CCN], tepa [CCN], thiohempa (alternative name) [CCN], thiotepa (alternative name) [CCN], tretamine (alternative name) [CCN] and uredepa (alternative name) [CCN],
an insect pheromone selected from the group of substances consisting of (E)-dec-5-en-1-yl acetate with (E)-dec-5-en-1-ol (IUPAC name) (222), (E)-tridec-4-en-1-yl acetate (IUPAC name) (829), (E)-6-methylhept-2-en-4-ol (IUPAC name) (541), (E,Z)-tetradeca-4,10-dien-1-yl acetate (IUPAC name) (779), (Z)-dodec-7-en-1-yl acetate (IUPAC name) (285), (Z)-hexadec-11-enal (IUPAC name) (436), (Z)-hexadec-11-en-1-yl acetate (IUPAC name) (437), (Z)-hexadec-13-en-11-yn-1-yl acetate (IUPAC name) (438), (Z)-icos-13-en-10-one (IUPAC name) (448), (Z)-tetradec-7-en-1-al (IUPAC name) (782), (Z)-tetradec-9-en-1-ol (IUPAC name) (783), (Z)-tetradec-9-en-1-yl acetate (IUPAC name) (784), (7E,9Z)-dodeca-7,9-dien-1-yl acetate (IUPAC name) (283), (9Z,11E)-tetradeca-9,11-dien-1-yl acetate (IUPAC name) (780), (9Z,12E)-tetradeca-9,12-dien-1-yl acetate (IUPAC name) (781), 14-methyloctadec-1-ene (IUPAC name) (545), 4-methylnonan-5-ol with 4-methylnonan-5-one (IUPAC name) (544), alpha-multistriatin (alternative name) [CCN], brevicomin (alternative name) [CCN], codlelure (alternative name) [CCN], codlemone (alternative name) (167), cuelure (alternative name) (179), disparlure (277), dodec-8-en-1-yl acetate (IUPAC name) (286), dodec-9-en-1-yl acetate (IUPAC name) (287), dodeca-8,10-dien-1-yl acetate (IUPAC name) (284), dominicalure (alternative name) [CCN], ethyl 4-methyloctanoate (IUPAC name) (317), eugenol (alternative name) [CCN], frontalin (alternative name) [CCN], gossyplure (alternative name) (420), grandlure (421), grandlure I (alternative name) (421), grandlure II (alternative name) (421), grandlure III (alternative name) (421), grandlure IV (alternative name) (421), hexylure [CCN], ipsdienol (alternative name) [CCN], ipsenol (alternative name) [CCN], japonilure (alternative name) (481), lineatin (alternative name) [CCN], litlure (alternative name) [CCN], looplure (alternative name) [CCN], medlure [CCN], megatomoic acid (alternative name) [CCN], methyl eugenol (alternative name) (540), muscalure (563), octadeca-2,13-dien-1-yl acetate (IUPAC name) (588), octadeca-3,13-dien-1-yl acetate (IUPAC name) (589), orfralure (alternative name) [CCN], oryctalure (alternative name) (317), ostramone (alternative name) [CCN], siglure [CCN], sordidin (alternative name) (736), sulcatol (alternative name) [CCN], tetradec-11-en-1-yl acetate (IUPAC name) (785), trimedlure (839), trimedlure A (alternative name) (839), trimedlure B₁ (alternative name) (839), trimedlure B₂ (alternative name) (839), trimedlure C (alternative name) (839) and trunc-call (alternative name) [CCN],
an insect repellent selected from the group of substances consisting of 2-(octylthio)-ethanol (IUPAC name) (591), butopyronoxyl (933), butoxy(polypropylene glycol) (936), dibutyl adipate (IUPAC name) (1046), dibutyl phthalate (1047), dibutyl succinate (IUPAC name) (1048), diethyltoluamide [CCN], dimethyl carbate [CCN], dimethyl phthalate [CCN], ethyl hexanediol (1137), hexamide [CCN], methoquin-butyl (1276), methylneodecanamide [CCN], oxamate [CCN] and picaridin [CCN],
an insecticide selected from the group of substances consisting of 1,1-dichloro-1-nitroethane (IUPAC/Chemical Abstracts name) (1058), 1,1-dichloro-2,2-bis(4-ethylphenyl)-ethane (IUPAC name) (1056), 1,2-dichloropropane (IUPAC/Chemical Abstracts name) (1062), 1,2-dichloropropane with 1,3-dichloropropene (IUPAC name) (1063), 1-bromo-2-chloroethane (IUPAC/Chemical Abstracts name) (916), 2,2,2-trichloro-1-(3,4-dichloro-phenyl)ethyl acetate (IUPAC name) (1451), 2,2-dichlorovinyl 2-ethylsulfinylethyl methyl phosphate (IUPAC name) (1066), 2-(1,3-dithiolan-2-yl)phenyl dimethylcarbamate (IUPAC/Chemical Abstracts name) (1109), 2-(2-butoxyethoxy)ethyl thiocyanate (IUPAC/Chemical Abstracts name) (935), 2-(4,5-dimethyl-1,3-dioxolan-2-yl)phenyl methylcarbamate (IUPAC/Chemical Abstracts name) (1084), 2-(4-chloro-3,5-xylyloxy)ethanol (IUPAC name) (986), 2-chlorovinyl diethyl phosphate (IUPAC name) (984), 2-imidazolidone (IUPAC name) (1225), 2-isovalerylindan-1,3-dione (IUPAC name) (1246), 2-methyl(prop-2-ynyl)aminophenyl methylcarbamate (IUPAC name) (1284), 2-thiocyanatoethyl laurate (IUPAC name) (1433), 3-bromo-1-chloroprop-1-ene (IUPAC name) (917), 3-methyl-1-phenylpyrazol-5-yl dimethyl-carbamate (IUPAC name) (1283), 4-methyl(prop-2-ynyl)amino-3,5-xylyl methylcarbamate (IUPAC name) (1285), 5,5-dimethyl-3-oxocyclohex-1-enyl dimethylcarbamate (IUPAC name) (1085), abamectin (1), acephate (2), acetamiprid (4), acethion (alternative name) [CCN], acetoprole [CCN], acrinathrin (9), acrylonitrile (IUPAC name) (861), alanycarb (15), aldicarb (16), aldoxycarb (863), aldrin (864), allethrin (17), allosamidin (alternative name) [CCN], allyxycarb (866), alpha-cypermethrin (202), alpha-ecdysone (alternative name) [CCN], aluminium phosphide (640), amidithion (870), amidothioate (872), aminocarb (873), amiton (875), amiton hydrogen oxalate (875), amitraz (24), anabasine (877), athidathion (883), AVI 382 (compound code), AZ 60541 (compound code), azadirachtin (alternative name) (41), azamethiphos (42), azinphos-ethyl (44), azinphos-methyl (45), azothoate (889), Bacillus thuringiensis delta endotoxins (alternative name) (52), barium hexafluorosilicate (alternative name) [CCN], barium polysulfide (IUPAC/Chemical Abstracts name) (892), barthrin [CCN], BAS 320 I (compound code), Bayer 22/190 (development code) (893), Bayer 22408 (development code) (894), bendiocarb (58), benfuracarb (60), bensultap (66), beta-cyfluthrin (194), beta-cypermethrin (203), bifenthrin (76), bioallethrin (78), bioallethrin S-cyclopentenyl isomer (alternative name) (79), bioethanomethrin [CCN], biopermethrin (908), bioresmethrin (80), bis(2-chloroethyl)ether (IUPAC name) (909), bistrifluoron (83), borax (86), brofenvalerate (alternative name), bromfenvinfos (914), bromocyclen (918), bromo-DDT (alternative name) [CCN], bromophos (920), bromophos-ethyl (921), bufencarb (924), buprofezin (99), butacarb (926), butathiofos (927), butocarboxim (103), butonate (932), butoxycarboxim (104), butylpyridaben (alternative name), cadusafos (109), calcium arsenate [CCN], calcium cyamide (444), calcium polysulfide (IUPAC name) (111), camphechlor (941), carbanolate (943), carbaryl (115), carbofuran (118), carbon disulfide (IUPAC/Chemical Abstracts name) (945), carbon tetrachloride (IUPAC name) (946), carbophenothion (947), carbosulfan (119), cartap (123), cartap hydrochloride (123), cevadine (alternative name) (725), chlorbicyclen (960), chlordane (128), chlordecone (963), chlordimeform (964), chlordimeform hydrochloride (964), chlorethoxyfos (129), chlorfenapyr (130), chlorfenvinphos (131), chlorfluazuron (132), chlormephos (136), chloroform [CCN], chloropicrin (141), chlorphoxim (989), chlorprazophos (990), chlorpyrifos (145), chlorpyrifos-methyl (146), chlorthiophos (994), chromafenozide (150), cinerin I (696), cinerin II (696), cinerins (696), cis-resmethrin (alternative name), cismethrin (80), clocythrin (alternative name), cloethocarb (999), closantel (alternative name) [CCN], clothianidin (165), copper acetoarsenite [CCN], copper arsenate [CCN], copper oleate [CCN], coumaphos (174), coumithoate (1006), crotamiton (alternative name) [CCN], crotoxyphos (1010), crufomate (1011), cryolite (alternative name) (177), CS 708 (development code) (1012), cyanofenphos (1019), cyanophos (184), cyanthoate (1020), cyclethrin [CCN], cycloprothrin (188), cyfluthrin (193), cyhalothrin (196), cypermethrin (201), cyphenothrin (206), cyromazine (209), cythioate (alternative name) [CCN], d-limonene (alternative name) [CCN], d-tetramethrin (alternative name) (788), DAEP (1031), dazomet (216), DDT (219), decarbofuran (1034), deltamethrin (223), demephion (1037), demephion-O (1037), demephion-S (1037), demeton (1038), demeton-methyl (224), demeton-O (1038), demeton-O-methyl (224), demeton-S (1038), demeton-5-methyl (224), demeton-5-methylsulphon (1039), diafenthiuron (226), dialifos (1042), diamidafos (1044), diazinon (227), dicapthon (1050), dichlofenthion (1051), dichlorvos (236), dicliphos (alternative name), dicresyl (alternative name) [CCN], dicrotophos (243), dicyclanil (244), dieldrin (1070), diethyl 5-methylpyrazol-3-yl phosphate (IUPAC name) (1076), diflubenzuron (250), dilor (alternative name) [CCN], dimefluthrin [CCN], dimefox (1081), dimetan (1085), dimethoate (262), dimethrin (1083), dimethylvinphos (265), dimetilan (1086), dinex (1089), dinex-diclexine (1089), dinoprop (1093), dinosam (1094), dinoseb (1095), dinotefuran (271), diofenolan (1099), dioxabenzofos (1100), dioxacarb (1101), dioxathion (1102), disulfoton (278), dithicrofos (1108), DNOC (282), doramectin (alternative name) [CCN], DSP (1115), ecdysterone (alternative name) [CCN], EI 1642 (development code) (1118), emamectin (291), emamectin benzoate (291), EMPC (1120), empenthrin (292), endosulfan (294), endothion (1121), endrin (1122), EPBP (1123), EPN (297), epofenonane (1124), eprinomectin (alternative name) [CCN], esfenvalerate (302), etaphos (alternative name) [CCN], ethiofencarb (308), ethion (309), ethiprole (310), ethoate-methyl (1134), ethoprophos (312), ethyl formate (IUPAC name) [CCN], ethyl-DDD (alternative name) (1056), ethylene dibromide (316), ethylene dichloride (chemical name) (1136), ethylene oxide [CCN], etofenprox (319), etrimfos (1142), EXD (1143), famphur (323), fenamiphos (326), fenazaflor (1147), fenchlorphos (1148), fenethacarb (1149), fenfluthrin (1150), fenitrothion (335), fenobucarb (336), fenoxacrim (1153), fenoxycarb (340), fenpirithrin (1155), fenpropathrin (342), fenpyrad (alternative name), fensulfothion (1158), fenthion (346), fenthion-ethyl [CCN], fenvalerate (349), fipronil (354), flonicamid (358), flucofuron (1168), flucycloxuron (366), flucythrinate (367), fluenetil (1169), flufenerim [CCN], flufenoxuron (370), flufenprox (1171), flumethrin (372), fluvalinate (1184), FMC 1137 (development code) (1185), fonofos (1191), formetanate (405), formetanate hydrochloride (405), formothion (1192), formparanate (1193), fosmethilan (1194), fospirate (1195), fosthiazate (408), fosthietan (1196), furathiocarb (412), furethrin (1200), gamma-cyhalothrin (197), gamma-HCH (430), guazatine (422), guazatine acetates (422), GY-81 (development code) (423), halfenprox (424), halofenozide (425), HCH (430), HEOD (1070), heptachlor (1211), heptenophos (432), heterophos [CCN], hexaflumuron (439), HHDN (864), hydramethylnon (443), hydrogen cyamide (444), hydroprene (445), hyquincarb (1223), imidacloprid (458), imiprothrin (460), indoxacarb (465), iodomethane (IUPAC name) (542), IPSP (1229), isazofos (1231), isobenzan (1232), isocarbophos (alternative name) (473), isodrin (1235), isofenphos (1236), isolane (1237), isoprocarb (472), isopropyl O-(methoxyaminothiophosphoryl)salicylate (IUPAC name) (473), isoprothiolane (474), isothioate (1244), isoxathion (480), ivermectin (alternative name) [CCN], jasmolin I (696), jasmolin II (696), jodfenphos (1248), juvenile hormone I (alternative name) [CCN], juvenile hormone II (alternative name) [CCN], juvenile hormone III (alternative name) [CCN], kelevan (1249), kinoprene (484), lambda-cyhalothrin (198), lead arsenate [CCN], leptophos (1250), lindane (430), lirimfos (1251), lufenuron (490), lythidathion (1253), m-cumenyl methylcarbamate (IUPAC name) (1014), magnesium phosphide (IUPAC name) (640), malathion (492), malonoben (1254), mazidox (1255), mecarbam (502), mecarphon (1258), menazon (1260), mephosfolan (1261), mercurous chloride (513), mesulfenfos (1263), metam (519), metam-potassium (alternative name) (519), metam-sodium (519), methacrifos (1266), methamidophos (527), methanesulfonyl fluoride (IUPAC/Chemical Abstracts name) (1268), methidathion (529), methiocarb (530), methocrotophos (1273), methomyl (531), methoprene (532), methoquin-butyl (1276), methothrin (alternative name) (533), methoxychlor (534), methoxyfenozide (535), methyl bromide (537), methyl isothiocyanate (543), methylchloroform (alternative name) [CCN], methylene chloride [CCN], metofluthrin [CCN], metolcarb (550), metoxadiazone (1288), mevinphos (556), mexacarbate (1290), milbemectin (557), milbemycin oxime (alternative name) [CCN], mipafox (1293), mirex (1294), monocrotophos (561), morphothion (1300), moxidectin (alternative name) [CCN], naftalofos (alternative name) [CCN], naled (567), naphthalene (IUPAC/Chemical Abstracts name) (1303), NC-170 (development code) (1306), NC-184 (compound code), nicotine (578), nicotine sulfate (578), nifluridide (1309), nitenpyram (579), nithiazine (1311), nitrilacarb (1313), nitrilacarb 1:1 zinc chloride complex (1313), NNI-0101 (compound code), NNI-0250 (compound code), nornicotine (traditional name) (1319), novaluron (585), noviflumuron (586), O-2,5-dichloro-4-iodophenyl O-ethyl ethylphosphonothioate (IUPAC name) (1057), O,O-diethyl O-4-methyl-2-oxo-2H-chromen-7-yl phosphorothioate (IUPAC name) (1074), O,O-diethyl O-6-methyl-2-propylpyrimidin-4-yl phosphorothioate (IUPAC name) (1075), O,O,O′,O′-tetrapropyl dithiopyrophosphate (IUPAC name) (1424), oleic acid (IUPAC name) (593), omethoate (594), oxamyl (602), oxydemeton-methyl (609), oxydeprofos (1324), oxydisulfoton (1325), pp′-DDT (219), para-dichlorobenzene [CCN], parathion (615), parathion-methyl (616), penfluoron (alternative name) [CCN], pentachlorophenol (623), pentachlorophenyl laurate (IUPAC name) (623), permethrin (626), petroleum oils (alternative name) (628), PH 60-38 (development code) (1328), phenkapton (1330), phenothrin (630), phenthoate (631), phorate (636), phosalone (637), phosfolan (1338), phosmet (638), phosnichlor (1339), phosphamidon (639), phosphine (IUPAC name) (640), phoxim (642), phoxim-methyl (1340), pirimetaphos (1344), pirimicarb (651), pirimiphos-ethyl (1345), pirimiphos-methyl (652), polychlorodicyclopentadiene isomers (IUPAC name) (1346), polychloroterpenes (traditional name) (1347), potassium arsenite [CCN], potassium thiocyanate [CCN], prallethrin (655), precocene I (alternative name) [CCN], precocene II (alternative name) [CCN], precocene III (alternative name) [CCN], primidophos (1349), profenofos (662), profluthrin [CCN], promacyl (1354), promecarb (1355), propaphos (1356), propetamphos (673), propoxur (678), prothidathion (1360), prothiofos (686), prothoate (1362), protrifenbute [CCN], pymetrozine (688), pyraclofos (689), pyrazophos (693), pyresmethrin (1367), pyrethrin I (696), pyrethrin II (696), pyrethrins (696), pyridaben (699), pyridalyl (700), pyridaphenthion (701), pyrimidifen (706), pyrimitate (1370), pyriproxyfen (708), quassia (alternative name) [CCN], quinalphos (711), quinalphos-methyl (1376), quinothion (1380), quintiofos (1381), R-1492 (development code) (1382), rafoxanide (alternative name) [CCN], resmethrin (719), rotenone (722), RU 15525 (development code) (723), RU 25475 (development code) (1386), ryania (alternative name) (1387), ryanodine (traditional name) (1387), sabadilla (alternative name) (725), schradan (1389), sebufos (alternative name), selamectin (alternative name) [CCN], SI-0009 (compound code), silafluofen (728), SN 72129 (development code) (1397), sodium arsenite [CCN], sodium cyamide (444), sodium fluoride (IUPAC/Chemical Abstracts name) (1399), sodium hexafluorosilicate (1400), sodium pentachlorophenoxide (623), sodium selenate (IUPAC name) (1401), sodium thiocyanate [CCN], sophamide (1402), spinosad (737), spiromesifen (739), sulcofuron (746), sulcofuron-sodium (746), sulfluramid (750), sulfotep (753), sulfuryl fluoride (756), sulprofos (1408), tar oils (alternative name) (758), tau-fluvalinate (398), tazimcarb (1412), TDE (1414), tebufenozide (762), tebufenpyrad (763), tebupirimfos (764), teflubenzuron (768), tefluthrin (769), temephos (770), TEPP (1417), terallethrin (1418), terbam (alternative name), terbufos (773), tetrachloroethane [CCN], tetrachlorvinphos (777), tetramethrin (787), theta-cypermethrin (204), thiacloprid (791), thiafenox (alternative name), thiamethoxam (792), thicrofos (1428), thiocarboxime (1431), thiocyclam (798), thiocyclam hydrogen oxalate (798), thiodicarb (799), thiofanox (800), thiometon (801), thionazin (1434), thiosultap (803), thiosultap-sodium (803), thuringiensin (alternative name) [CCN], tolfenpyrad (809), tralomethrin (812), transfluthrin (813), transpermethrin (1440), triamiphos (1441), triazamate (818), triazophos (820), triazuron (alternative name), trichlorfon (824), trichlormetaphos-3 (alternative name) [CCN], trichloronat (1452), trifenofos (1455), triflumuron (835), trimethacarb (840), triprene (1459), vamidothion (847), vaniliprole [CCN], veratridine (alternative name) (725), veratrine (alternative name) (725), XMC (853), xylylcarb (854), YI-5302 (compound code), zeta-cypermethrin (205), zetamethrin (alternative name), zinc phosphide (640), zolaprofos (1469) and ZXI 8901 (development code) (858),
a molluscicide selected from the group of substances consisting of bis(tributyltin)oxide (IUPAC name) (913), bromoacetamide [CCN], calcium arsenate [CCN], cloethocarb (999), copper acetoarsenite [CCN], copper sulfate (172), fentin (347), ferric phosphate (IUPAC name) (352), metaldehyde (518), methiocarb (530), niclosamide (576), niclosamide-olamine (576), pentachlorophenol (623), sodium pentachlorophenoxide (623), tazimcarb (1412), thiodicarb (799), tributyltin oxide (913), trifenmorph (1454), trimethacarb (840), triphenyltin acetate (IUPAC name) (347) and triphenyltin hydroxide (IUPAC name) (347),
a nematicide selected from the group of substances consisting of 1,2-dibromo-3-chloropropane (IUPAC/Chemical Abstracts name) (1045), 1,2-dichloropropane (IUPAC/Chemical Abstracts name) (1062), 1,2-dichloropropane with 1,3-dichloropropene (IUPAC name) (1063), 1,3-dichloropropene (233), 3,4-dichlorotetrahydrothiophene 1,1-dioxide (IUPAC/Chemical Abstracts name) (1065), 3-(4-chlorophenyl)-5-methylrhodanine (IUPAC name) (980), 5-methyl-6-thioxo-1,3,5-thiadiazinan-3-ylacetic acid (IUPAC name) (1286), 6-isopentenylaminopurine (alternative name) (210), abamectin (1), acetoprole [CCN], alanycarb (15), aldicarb (16), aldoxycarb (863), AZ 60541 (compound code), benclothiaz [CCN], benomyl (62), butylpyridaben (alternative name), cadusafos (109), carbofuran (118), carbon disulfide (945), carbosulfan (119), chloropicrin (141), chlorpyrifos (145), cloethocarb (999), cytokinins (alternative name) (210), dazomet (216), DBCP (1045), DCIP (218), diamidafos (1044), dichlofenthion (1051), dicliphos (alternative name), dimethoate (262), doramectin (alternative name) [CCN], emamectin (291), emamectin benzoate (291), eprinomectin (alternative name) [CCN], ethoprophos (312), ethylene dibromide (316), fenamiphos (326), fenpyrad (alternative name), fensulfothion (1158), fosthiazate (408), fosthietan (1196), furfural (alternative name) [CCN], GY-81 (development code) (423), heterophos [CCN], iodomethane (IUPAC name) (542), isamidofos (1230), isazofos (1231), ivermectin (alternative name) [CCN], kinetin (alternative name) (210), mecarphon (1258), metam (519), metam-potassium (alternative name) (519), metam-sodium (519), methyl bromide (537), methyl isothiocyanate (543), milbemycin oxime (alternative name) [CCN], moxidectin (alternative name) [CCN], Myrothecium verrucaria composition (alternative name) (565), NC-184 (compound code), oxamyl (602), phorate (636), phosphamidon (639), phosphocarb [CCN], sebufos (alternative name), selamectin (alternative name) [CCN], spinosad (737), terbam (alternative name), terbufos (773), tetrachlorothiophene (IUPAC/Chemical Abstracts name) (1422), thiafenox (alternative name), thionazin (1434), triazophos (820), triazuron (alternative name), xylenols [CCN], YI-5302 (compound code) and zeatin (alternative name) (210),
a nitrification inhibitor selected from the group of substances consisting of potassium ethylxanthate [CCN] and nitrapyrin (580),
a plant activator selected from the group of substances consisting of acibenzolar (6), acibenzolar-5-methyl (6), probenazole (658) and Reynoutria sachalinensis extract (alternative name) (720),
a rodenticide selected from the group of substances consisting of 2-isovalerylindan-1,3-dione (IUPAC name) (1246), 4-(quinoxalin-2-ylamino)benzenesulfonamide (IUPAC name) (748), alpha-chlorohydrin [CCN], aluminium phosphide (640), antu (880), arsenous oxide (882), barium carbonate (891), bisthiosemi (912), brodifacoum (89), bromadiolone (91), bromethalin (92), calcium cyamide (444), chloralose (127), chlorophacinone (140), cholecalciferol (alternative name) (850), coumachlor (1004), coumafuryl (1005), coumatetralyl (175), crimidine (1009), difenacoum (246), difethialone (249), diphacinone (273), ergocalciferol (301), flocoumafen (357), fluoroacetamide (379), flupropadine (1183), flupropadine hydrochloride (1183), gamma-HCH (430), HCH (430), hydrogen cyamide (444), iodomethane (IUPAC name) (542), lindane (430), magnesium phosphide (IUPAC name) (640), methyl bromide (537), norbormide (1318), phosacetim (1336), phosphine (IUPAC name) (640), phosphorus [CCN], pindone (1341), potassium arsenite [CCN], pyrinuron (1371), scilliroside (1390), sodium arsenite [CCN], sodium cyamide (444), sodium fluoro-acetate (735), strychnine (745), thallium sulfate [CCN], warfarin (851) and zinc phosphide (640),
a synergist selected from the group of substances consisting of 2-(2-butoxyethoxy)ethyl piperonylate (IUPAC name) (934), 5-(1,3-benzodioxol-5-yl)-3-hexylcyclohex-2-enone (IUPAC name) (903), farnesol with nerolidol (alternative name) (324), MB-599 (development code) (498), MGK 264 (development code) (296), piperonyl butoxide (649), piprotal (1343), propyl isomer (1358), S421 (development code) (724), sesamex (1393), sesasmolin (1394) and sulfoxide (1406),
an animal repellent selected from the group of substances consisting of anthraquinone (32), chloralose (127), copper naphthenate [CCN], copper oxychloride (171), diazinon (227), dicyclopentadiene (chemical name) (1069), guazatine (422), guazatine acetates (422), methiocarb (530), pyridin-4-amine (IUPAC name) (23), thiram (804), trimethacarb (840), zinc naphthenate [CCN] and ziram (856),
a virucide selected from the group of substances consisting of imanin (alternative name) [CCN] and ribavirin (alternative name) [CCN],
and a wound protectant selected from the group of substances consisting of mercuric oxide (512), octhilinone (590) and thiophanate-methyl (802).

A very especially preferred embodiment of the subject-matter {1.1.17} of the invention is {1.1.17.2} a pesticidal composition comprising a mixture consisting of at least two substances, namely one compound (A) and at least one compound (B), as active ingredient and at least one auxiliary, wherein the compound (A) is the compound of formula (A-17) and the compound (B) is a compound selected from the group of substances consisting of abamectin (1), cyromazine (209), diafenthiuron (226), diazinon (227), emamectin benzoate (291), fenoxycarb (340), fosthiazate (408), lambda-cyhalothrin (198), lufenuron (490), methidathion (529), profenofos (662), pymetrozine (688), tefluthrin (769) and thiamethoxam (792).

The compound of formula (A-17) is known, for example, from the PCT Application WO-04/067528.

A preferred embodiment of the subject-matter {1.1} of the invention is {1.1.18} a pesticidal composition comprising a mixture consisting of at least two substances, namely one compound (A) and at least one compound (B), as active ingredient and at least one auxiliary, wherein the compound (A) is the compound of formula (A-18) 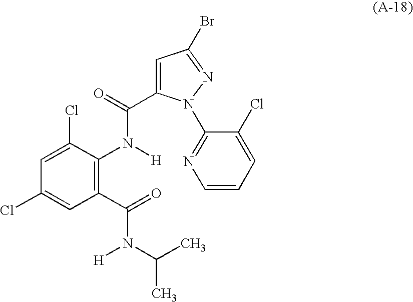
and the compound (B) is a compound selected from the group of substances consisting of an adjuvant, an acaricide, an algicide, an anthelmintic, an avicide, a bactericide, a biological agent, a soil sterilant, a chemosterilant, an insect pheromone, an insect repellent, an insecticide, a molluscicide, a nematicide, a nitrification inhibitor, a plant activator, a rodenticide, a synergist, an animal repellent, a virucide and a wound protectant.

An especially preferred embodiment of the subject-matter {1.1.18} of the invention is {1.1.18.1} a pesticidal composition comprising a mixture consisting of at least two substances, namely one compound (A) and at least one compound (B), as active ingredient and at least one auxiliary, wherein the compound (A) is the compound of formula (A-18) and the compound (B) is a compound selected from the group of substances consisting of
an adjuvant selected from the group of substances consisting of petroleum oils (alternative name) (628),
an acaricide selected from the group of substances consisting of 1,1-bis(4-chlorophenyl)-2-ethoxyethanol (IUPAC name) (910), 2,4-dichlorophenyl benzenesulfonate (IUPAC/Chemical Abstracts name) (1059), 2-fluoro-N-methyl-N-1-naphthylacetamide (IUPAC name) (1295), 4-chlorophenyl phenyl sulfone (IUPAC name) (981), abamectin (1), acequinocyl (3), acetoprole [CCN], acrinathrin (9), aldicarb (16), aldoxycarb (863), alpha-cypermethrin (202), amidithion (870), amidoflumet [CCN], amidothioate (872), amiton (875), amiton hydrogen oxalate (875), amitraz (24), aramite (881), arsenous oxide (882), AVI 382 (compound code), AZ 60541 (compound code), azinphos-ethyl (44), azinphos-methyl (45), azobenzene (IUPAC name) (888), azocyclotin (46), azothoate (889), benomyl (62), benoxafos (alternative name) [CCN], benzoximate (71), benzyl benzoate (IUPAC name) [CCN], bifenazate (74), bifenthrin (76), binapacryl (907), brofenvalerate (alternative name), bromocyclen (918), bromophos (920), bromophos-ethyl (921), bromopropylate (94), buprofezin (99), butocarboxim (103), butoxycarboxim (104), butylpyridaben (alternative name), calcium polysulfide (IUPAC name) (111), camphechlor (941), carbanolate (943), carbaryl (115), carbofuran (118), carbophenothion (947), CGA 50'439 (development code) (125), chinomethionat (126), chlorbenside (959), chlordimeform (964), chlordimeform hydrochloride (964), chlorfenapyr (130), chlorfenethol (968), chlorfenson (970), chlorfensulphide (971), chlorfenvinphos (131), chlorobenzilate (975), chloromebuform (977), chloromethiuron (978), chloropropylate (983), chlorpyrifos (145), chlorpyrifos-methyl (146), chlorthiophos (994), cinerin I (696), cinerin II (696), cinerins (696), clofentezine (158), closantel (alternative name) [CCN], coumaphos (174), crotamiton (alternative name) [CCN], crotoxyphos (1010), cufraneb (1013), cyanthoate (1020), cyhalothrin (196), cyhexatin (199), cypermethrin (201), DCPM (1032), DDT (219), demephion (1037), demephion-O (1037), demephion-S (1037), demeton (1038), demeton-methyl (224), demeton-O (1038), demeton-O-methyl (224), demeton-S (1038), demeton-5-methyl (224), demeton-5-methylsulphon (1039), diafenthiuron (226), dialifos (1042), diazinon (227), dichlofluanid (230), dichlorvos (236), dicliphos (alternative name), dicofol (242), dicrotophos (243), dienochlor (1071), dimefox (1081), dimethoate (262), dinactin (alternative name) (653), dinex (1089), dinex-diclexine (1089), dinobuton (269), dinocap (270), dinocap-4 [CCN], dinocap-6 [CCN], dinocton (1090), dinopenton (1092), dinosulfon (1097), dinoterbon (1098), dioxathion (1102), diphenyl sulfone (IUPAC name) (1103), disulfuram (alternative name) [CCN], disulfoton (278), DNOC (282), dofenapyn (1113), doramectin (alternative name) [CCN], endosulfan (294), endothion (1121), EPN (297), eprinomectin (alternative name) [CCN], ethion (309), ethoate-methyl (1134), etoxazole (320), etrimfos (1142), fenazaflor (1147), fenazaquin (328), fenbutatin oxide (330), fenothiocarb (337), fenpropathrin (342), fenpyrad (alternative name), fenpyroximate (345), fenson (1157), fentrifanil (1161), fenvalerate (349), fipronil (354), fluacrypyrim (360), fluazuron (1166), flubenzimine (1167), flucycloxuron (366), flucythrinate (367), fluenetil (1169), flufenoxuron (370), flumethrin (372), fluorbenside (1174), fluvalinate (1184), FMC 1137 (development code) (1185), formetanate (405), formetanate hydrochloride (405), formothion (1192), formparanate (1193), gamma-HCH (430), glyodin (1205), halfenprox (424), heptenophos (432), hexadecyl cyclopropanecarboxylate (IUPAC/Chemical Abstracts name) (1216), hexythiazox (441), iodomethane (IUPAC name) (542), isocarbophos (alternative name) (473), isopropyl O-(methoxyaminothiophosphoryl)salicylate (IUPAC name) (473), ivermectin (alternative name) [CCN], jasmolin I (696), jasmolin II (696), jodfenphos (1248), lindane (430), lufenuron (490), malathion (492), malonoben (1254), mecarbam (502), mephosfolan (1261), mesulfen (alternative name) [CCN], methacrifos (1266), methamidophos (527), methidathion (529), methiocarb (530), methomyl (531), methyl bromide (537), metolcarb (550), mevinphos (556), mexacarbate (1290), milbemectin (557), milbemycin oxime (alternative name) [CCN], mipafox (1293), monocrotophos (561), morphothion (1300), moxidectin (alternative name) [CCN], naled (567), NC-184 (compound code), nifluridide (1309), nikkomycins (alternative name) [CCN], nitrilacarb (1313), nitrilacarb 1:1 zinc chloride complex (1313), NNI-0101 (compound code), NNI-0250 (compound code), omethoate (594), oxamyl (602), oxydeprofos (1324), oxydisulfoton (1325), pp′-DDT (219), parathion (615), permethrin (626), petroleum oils (alternative name) (628), phenkapton (1330), phenthoate (631), phorate (636), phosalone (637), phosfolan (1338), phosmet (638), phosphamidon (639), phoxim (642), pirimiphos-methyl (652), polychloroterpenes (traditional name) (1347), polynactins (alternative name) (653), proclonol (1350), profenofos (662), promacyl (1354), propargite (671), propetamphos (673), propoxur (678), prothidathion (1360), prothoate (1362), pyrethrin I (696), pyrethrin II (696), pyrethrins (696), pyridaben (699), pyridaphenthion (701), pyrimidifen (706), pyrimitate (1370), quinalphos (711), quintiofos (1381), R-1492 (development code) (1382), RA-17 (development code) (1383), rotenone (722), schradan (1389), sebufos (alternative name), selamectin (alternative name) [CCN], SI-0009 (compound code), sophamide (1402), spirodiclofen (738), spiromesifen (739), SSI-121 (development code) (1404), sulfuram (alternative name) [CCN], sulfluramid (750), sulfotep (753), sulfur (754), SZI-121 (development code) (757), tau-fluvalinate (398), tebufenpyrad (763), TEPP (1417), terbam (alternative name), tetrachlorvinphos (777), tetradifon (786), tetranactin (alternative name) (653), tetrasul (1425), thiafenox (alternative name), thiocarboxime (1431), thiofanox (800), thiometon (801), thioquinox (1436), thuringiensin (alternative name) [CCN], triamiphos (1441), triarathene (1443), triazophos (820), triazuron (alternative name), trichlorfon (824), trifenofos (1455), trinactin (alternative name) (653), vamidothion (847), vaniliprole [CCN] and YI-5302 (compound code),
an algicide selected from the group of substances consisting of bethoxazin [CCN], copper dioctanoate (IUPAC name) (170), copper sulfate (172), cybutryne [CCN], dichlone (1052), dichlorophen (232), endothal (295), fentin (347), hydrated lime [CCN], nabam (566), quinoclamine (714), quinonamid (1379), simazine (730), triphenyltin acetate (IUPAC name) (347) and triphenyltin hydroxide (IUPAC name) (347),
an anthelmintic selected from the group of substances consisting of abamectin (1), crufomate (1011), doramectin (alternative name) [CCN], emamectin (291), emamectin benzoate (291), eprinomectin (alternative name) [CCN], ivermectin (alternative name) [CCN], milbemycin oxime (alternative name) [CCN], moxidectin (alternative name) [CCN], piperazine [CCN], selamectin (alternative name) [CCN], spinosad (737) and thiophanate (1435),
an avicide selected from the group of substances consisting of chloralose (127), endrin (1122), fenthion (346), pyridin-4-amine (IUPAC name) (23) and strychnine (745),
a bactericide selected from the group of substances consisting of 1-hydroxy-1H-pyridine-2-thione (IUPAC name) (1222), 4-(quinoxalin-2-ylamino)benzenesulfonamide (IUPAC name) (748), 8-hydroxyquinoline sulfate (446), bronopol (97), copper dioctanoate (IUPAC name) (170), copper hydroxide (IUPAC name) (169), cresol [CCN], dichlorophen (232), dipyrithione (1105), dodicin (1112), fenaminosulf (1144), formaldehyde (404), hydrargaphen (alternative name) [CCN], kasugamycin (483), kasugamycin hydrochloride hydrate (483), nickel bis(dimethyldithiocarbamate) (IUPAC name) (1308), nitrapyrin (580), octhilinone (590), oxolinic acid (606), oxytetracycline (611), potassium hydroxyquinoline sulfate (446), probenazole (658), streptomycin (744), streptomycin sesquisulfate (744), tecloftalam (766) and thiomersal (alternative name) [CCN],
a biological agent selected from the group of substances consisting of Adoxophyes orana GV (alternative name) (12), Agrobacterium radiobacter (alternative name) (13), Amblyseius spp. (alternative name) (19), Anagrapha falcifera NPV (alternative name) (28), Anagrus atomus (alternative name) (29), Aphelinus abdominalis (alternative name) (33), Aphidius colemani (alternative name) (34), Aphidoletes aphidimyza (alternative name) (35), Autographa californica NPV (alternative name) (38), Bacillus firmus (alternative name) (48), Bacillus sphaericus Neide (scientific name) (49), Bacillus thuringiensis Berliner (scientific name) (51), Bacillus thuringiensis subsp. aizawai (scientific name) (51), Bacillus thuringiensis subsp. israelensis (scientific name) (51), Bacillus thuringiensis subsp. japonensis (scientific name) (51), Bacillus thuringiensis subsp. kurstaki (scientific name) (51), Bacillus thuringiensis subsp. tenebrionis (scientific name) (51), Beauveria bassiana (alternative name) (53), Beauveria brongniartii (alternative name) (54), Chrysoperla carnea (alternative name) (151), Cryptolaemus montrouzieri (alternative name) (178), Cydia pomonella GV (alternative name) (191), Dacnusa sibirica (alternative name) (212), Diglyphus isaea (alternative name) (254), Encarsia formosa (scientific name) (293), Eretmocerus eremicus (alternative name) (300), Helicoverpa zea NPV (alternative name) (431), Heterorhabditis bacteriophora and H. megidis (alternative name) (433), Hippodamia convergens (alternative name) (442), Leptomastix dactylopii (alternative name) (488), Macrolophus caliginosus (alternative name) (491), Mamestra brassicae NPV (alternative name) (494), Metaphycus helvolus (alternative name) (522), Metarhizium anisopliae var. acridum (scientific name) (523), Metarhizium anisopliae var. anisopliae (scientific name) (523), Neodiprion sertifer NPV and N. lecontei NPV (alternative name) (575), Orius spp. (alternative name) (596), Paecilomyces fumosoroseus (alternative name) (613), Phytoseiulus persimilis (alternative name) (644), Spodoptera exigua multicapsid nuclear polyhedrosis virus (scientific name) (741), Steinernema bibionis (alternative name) (742), Steinernema carpocapsae (alternative name) (742), Steinernema feltiae (alternative name) (742), Steinernema glaseri (alternative name) (742), Steinernema riobrave (alternative name) (742), Steinernema riobravis (alternative name) (742), Steinernema scapterisci (alternative name) (742), Steinernema spp. (alternative name) (742), Trichogramma spp. (alternative name) (826), Typhlodromus occidentalis (alternative name) (844) and Verticillium lecanii (alternative name) (848),
a soil sterilant selected from the group of substances consisting of iodomethane (IUPAC name) (542) and methyl bromide (537),
a chemosterilant selected from the group of substances consisting of apholate [CCN], bisazir (alternative name) [CCN], busulfan (alternative name) [CCN], diflubenzuron (250), dimatif (alternative name) [CCN], hemel [CCN], hempa [CCN], metepa [CCN], methiotepa [CCN], methyl apholate [CCN], morzid [CCN], penfluoron (alternative name) [CCN], tepa [CCN], thiohempa (alternative name) [CCN], thiotepa (alternative name) [CCN], tretamine (alternative name) [CCN] and uredepa (alternative name) [CCN],
an insect pheromone selected from the group of substances consisting of (E)-dec-5-en-1-yl acetate with (E)-dec-5-en-1-ol (IUPAC name) (222), (E)-tridec-4-en-1-yl acetate (IUPAC name) (829), (E)-6-methylhept-2-en-4-ol (IUPAC name) (541), (E,Z)-tetradeca-4,10-dien-1-yl acetate (IUPAC name) (779), (Z)-dodec-7-en-1-yl acetate (IUPAC name) (285), (Z)-hexadec-11-enal (IUPAC name) (436), (Z)-hexadec-11-en-1-yl acetate (IUPAC name) (437), (Z)-hexadec-13-en-11-yn-1-yl acetate (IUPAC name) (438), (Z)-icos-13-en-10-one (IUPAC name) (448), (Z)-tetradec-7-en-1-al (IUPAC name) (782), (Z)-tetradec-9-en-1-ol (IUPAC name) (783), (Z)-tetradec-9-en-1-yl acetate (IUPAC name) (784), (7E,9Z)-dodeca-7,9-dien-1-yl acetate (IUPAC name) (283), (9Z,11E)-tetradeca-9,11-dien-1-yl acetate (IUPAC name) (780), (9Z,12E)-tetradeca-9,12-dien-1-yl acetate (IUPAC name) (781), 14-methyloctadec-1-ene (IUPAC name) (545), 4-methylnonan-5-ol with 4-methylnonan-5-one (IUPAC name) (544), alpha-multistriatin (alternative name) [CCN], brevicomin (alternative name) [CCN], codlelure (alternative name) [CCN], codlemone (alternative name) (167), cuelure (alternative name) (179), disparlure (277), dodec-8-en-1-yl acetate (IUPAC name) (286), dodec-9-en-1-yl acetate (IUPAC name) (287), dodeca-8,10-dien-1-yl acetate (IUPAC name) (284), dominicalure (alternative name) [CCN], ethyl 4-methyloctanoate (IUPAC name) (317), eugenol (alternative name) [CCN], frontalin (alternative name) [CCN], gossyplure (alternative name) (420), grandlure (421), grandlure I (alternative name) (421), grandlure II (alternative name) (421), grandlure III (alternative name) (421), grandlure IV (alternative name) (421), hexylure [CCN], ipsdienol (alternative name) [CCN], ipsenol (alternative name) [CCN], japonilure (alternative name) (481), lineatin (alternative name) [CCN], litlure (alternative name) [CCN], looplure (alternative name) [CCN], medlure [CCN], megatomoic acid (alternative name) [CCN], methyl eugenol (alternative name) (540), muscalure (563), octadeca-2,13-dien-1-yl acetate (IUPAC name) (588), octadeca-3,13-dien-1-yl acetate (IUPAC name) (589), orfralure (alternative name) [CCN], oryctalure (alternative name) (317), ostramone (alternative name) [CCN], siglure [CCN], sordidin (alternative name) (736), sulcatol (alternative name) [CCN], tetradec-11-en-1-yl acetate (IUPAC name) (785), trimedlure (839), trimedlure A (alternative name) (839), trimedlure B₁ (alternative name) (839), trimedlure B₂ (alternative name) (839), trimedlure C (alternative name) (839) and trunc-call (alternative name) [CCN],
an insect repellent selected from the group of substances consisting of 2-(octylthio)-ethanol (IUPAC name) (591), butopyronoxyl (933), butoxy(polypropylene glycol) (936), dibutyl adipate (IUPAC name) (1046), dibutyl phthalate (1047), dibutyl succinate (IUPAC name) (1048), diethyltoluamide [CCN], dimethyl carbate [CCN], dimethyl phthalate [CCN], ethyl hexanediol (1137), hexamide [CCN], methoquin-butyl (1276), methylneodecanamide [CCN], oxamate [CCN] and picaridin [CCN],
an insecticide selected from the group of substances consisting of 1,1-dichloro-1-nitroethane (IUPAC/Chemical Abstracts name) (1058), 1,1-dichloro-2,2-bis(4-ethylphenyl)-ethane (IUPAC name) (1056), 1,2-dichloropropane (IUPAC/Chemical Abstracts name) (1062), 1,2-dichloropropane with 1,3-dichloropropene (IUPAC name) (1063), 1-bromo-2-chloroethane (IUPAC/Chemical Abstracts name) (916), 2,2,2-trichloro-1-(3,4-dichloro-phenyl)ethyl acetate (IUPAC name) (1451), 2,2-dichlorovinyl 2-ethylsulfinylethyl methyl phosphate (IUPAC name) (1066), 2-(1,3-dithiolan-2-yl)phenyl dimethylcarbamate (IUPAC/Chemical Abstracts name) (1109), 2-(2-butoxyethoxy)ethyl thiocyanate (IUPAC/Chemical Abstracts name) (935), 2-(4,5-dimethyl-1,3-dioxolan-2-yl)phenyl methylcarbamate (IUPAC/Chemical Abstracts name) (1084), 2-(4-chloro-3,5-xylyloxy)ethanol (IUPAC name) (986), 2-chlorovinyl diethyl phosphate (IUPAC name) (984), 2-imidazolidone (IUPAC name) (1225), 2-isovalerylindan-1,3-dione (IUPAC name) (1246), 2-methyl(prop-2-ynyl)aminophenyl methylcarbamate (IUPAC name) (1284), 2-thiocyanatoethyl laurate (IUPAC name) (1433), 3-bromo-1-chloroprop-1-ene (IUPAC name) (917), 3-methyl-1-phenylpyrazol-5-yl dimethyl-carbamate (IUPAC name) (1283), 4-methyl(prop-2-ynyl)amino-3,5-xylyl methylcarbamate (IUPAC name) (1285), 5,5-dimethyl-3-oxocyclohex-1-enyl dimethylcarbamate (IUPAC name) (1085), abamectin (1), acephate (2), acetamiprid (4), acethion (alternative name) [CCN], acetoprole [CCN], acrinathrin (9), acrylonitrile (IUPAC name) (861), alanycarb (15), aldicarb (16), aldoxycarb (863), aldrin (864), allethrin (17), allosamidin (alternative name) [CCN], allyxycarb (866), alpha-cypermethrin (202), alpha-ecdysone (alternative name) [CCN], aluminium phosphide (640), amidithion (870), amidothioate (872), aminocarb (873), amiton (875), amiton hydrogen oxalate (875), amitraz (24), anabasine (877), athidathion (883), AVI 382 (compound code), AZ 60541 (compound code), azadirachtin (alternative name) (41), azamethiphos (42), azinphos-ethyl (44), azinphos-methyl (45), azothoate (889), Bacillus thuringiensis delta endotoxins (alternative name) (52), barium hexafluorosilicate (alternative name) [CCN], barium polysulfide (IUPAC/Chemical Abstracts name) (892), barthrin [CCN], BAS 320 I (compound code), Bayer 22/190 (development code) (893), Bayer 22408 (development code) (894), bendiocarb (58), benfuracarb (60), bensultap (66), beta-cyfluthrin (194), beta-cypermethrin (203), bifenthrin (76), bioallethrin (78), bioallethrin S-cyclopentenyl isomer (alternative name) (79), bioethanomethrin [CCN], biopermethrin (908), bioresmethrin (80), bis(2-chloroethyl)ether (IUPAC name) (909), bistrifluoron (83), borax (86), brofenvalerate (alternative name), bromfenvinfos (914), bromocyclen (918), bromo-DDT (alternative name) [CCN], bromophos (920), bromophos-ethyl (921), bufencarb (924), buprofezin (99), butacarb (926), butathiofos (927), butocarboxim (103), butonate (932), butoxycarboxim (104), butylpyridaben (alternative name), cadusafos (109), calcium arsenate [CCN], calcium cyamide (444), calcium polysulfide (IUPAC name) (111), camphechlor (941), carbanolate (943), carbaryl (115), carbofuran (118), carbon disulfide (IUPAC/Chemical Abstracts name) (945), carbon tetrachloride (IUPAC name) (946), carbophenothion (947), carbosulfan (119), cartap (123), cartap hydrochloride (123), cevadine (alternative name) (725), chlorbicyclen (960), chlordane (128), chlordecone (963), chlordimeform (964), chlordimeform hydrochloride (964), chlorethoxyfos (129), chlorfenapyr (130), chlorfenvinphos (131), chlorfluazuron (132), chlormephos (136), chloroform [CCN], chloropicrin (141), chlorphoxim (989), chlorprazophos (990), chlorpyrifos (145), chlorpyrifos-methyl (146), chlorthiophos (994), chromafenozide (150), cinerin I (696), cinerin II (696), cinerins (696), cis-resmethrin (alternative name), cismethrin (80), clocythrin (alternative name), cloethocarb (999), closantel (alternative name) [CCN], clothianidin (165), copper acetoarsenite [CCN], copper arsenate [CCN], copper oleate [CCN], coumaphos (174), coumithoate (1006), crotamiton (alternative name) [CCN], crotoxyphos (1010), crufomate (1011), cryolite (alternative name) (177), CS 708 (development code) (1012), cyanofenphos (1019), cyanophos (184), cyanthoate (1020), cyclethrin [CCN], cycloprothrin (188), cyfluthrin (193), cyhalothrin (196), cypermethrin (201), cyphenothrin (206), cyromazine (209), cythioate (alternative name) [CCN], d-limonene (alternative name) [CCN], d-tetramethrin (alternative name) (788), DAEP (1031), dazomet (216), DDT (219), decarbofuran (1034), deltamethrin (223), demephion (1037), demephion-O (1037), demephion-S (1037), demeton (1038), demeton-methyl (224), demeton-O (1038), demeton-O-methyl (224), demeton-S (1038), demeton-5-methyl (224), demeton-5-methylsulphon (1039), diafenthiuron (226), dialifos (1042), diamidafos (1044), diazinon (227), dicapthon (1050), dichlofenthion (1051), dichlorvos (236), dicliphos (alternative name), dicresyl (alternative name) [CCN], dicrotophos (243), dicyclanil (244), dieldrin (1070), diethyl 5-methylpyrazol-3-yl phosphate (IUPAC name) (1076), diflubenzuron (250), dilor (alternative name) [CCN], dimefluthrin [CCN], dimefox (1081), dimetan (1085), dimethoate (262), dimethrin (1083), dimethylvinphos (265), dimetilan (1086), dinex (1089), dinex-diclexine (1089), dinoprop (1093), dinosam (1094), dinoseb (1095), dinotefuran (271), diofenolan (1099), dioxabenzofos (1100), dioxacarb (1101), dioxathion (1102), disulfoton (278), dithicrofos (1108), DNOC (282), doramectin (alternative name) [CCN], DSP (1115), ecdysterone (alternative name) [CCN], EI 1642 (development code) (1118), emamectin (291), emamectin benzoate (291), EMPC (1120), empenthrin (292), endosulfan (294), endothion (1121), endrin (1122), EPBP (1123), EPN (297), epofenonane (1124), eprinomectin (alternative name) [CCN], esfenvalerate (302), etaphos (alternative name) [CCN], ethiofencarb (308), ethion (309), ethiprole (310), ethoate-methyl (1134), ethoprophos (312), ethyl formate (IUPAC name) [CCN], ethyl-DDD (alternative name) (1056), ethylene dibromide (316), ethylene dichloride (chemical name) (1136), ethylene oxide [CCN], etofenprox (319), etrimfos (1142), EXD (1143), famphur (323), fenamiphos (326), fenazaflor (1147), fenchlorphos (1148), fenethacarb (1149), fenfluthrin (1150), fenitrothion (335), fenobucarb (336), fenoxacrim (1153), fenoxycarb (340), fenpirithrin (1155), fenpropathrin (342), fenpyrad (alternative name), fensulfothion (1158), fenthion (346), fenthion-ethyl [CCN], fenvalerate (349), fipronil (354), flonicamid (358), flucofuron (1168), flucycloxuron (366), flucythrinate (367), fluenetil (1169), flufenerim [CCN], flufenoxuron (370), flufenprox (1171), flumethrin (372), fluvalinate (1184), FMC 1137 (development code) (1185), fonofos (1191), formetanate (405), formetanate hydrochloride (405), formothion (1192), formparanate (1193), fosmethilan (1194), fospirate (1195), fosthiazate (408), fosthietan (1196), furathiocarb (412), furethrin (1200), gamma-cyhalothrin (197), gamma-HCH (430), guazatine (422), guazatine acetates (422), GY-81 (development code) (423), halfenprox (424), halofenozide (425), HCH (430), HEOD (1070), heptachlor (1211), heptenophos (432), heterophos [CCN], hexaflumuron (439), HHDN (864), hydramethylnon (443), hydrogen cyamide (444), hydroprene (445), hyquincarb (1223), imidacloprid (458), imiprothrin (460), indoxacarb (465), iodomethane (IUPAC name) (542), IPSP (1229), isazofos (1231), isobenzan (1232), isocarbophos (alternative name) (473), isodrin (1235), isofenphos (1236), isolane (1237), isoprocarb (472), isopropyl O-(methoxyaminothiophosphoryl)salicylate (IUPAC name) (473), isoprothiolane (474), isothioate (1244), isoxathion (480), ivermectin (alternative name) [CCN], jasmolin I (696), jasmolin II (696), jodfenphos (1248), juvenile hormone I (alternative name) [CCN], juvenile hormone II (alternative name) [CCN], juvenile hormone III (alternative name) [CCN], kelevan (1249), kinoprene (484), lambda-cyhalothrin (198), lead arsenate [CCN], leptophos (1250), lindane (430), lirimfos (1251), lufenuron (490), lythidathion (1253), m-cumenyl methylcarbamate (IUPAC name) (1014), magnesium phosphide (IUPAC name) (640), malathion (492), malonoben (1254), mazidox (1255), mecarbam (502), mecarphon (1258), menazon (1260), mephosfolan (1261), mercurous chloride (513), mesulfenfos (1263), metam (519), metam-potassium (alternative name) (519), metam-sodium (519), methacrifos (1266), methamidophos (527), methanesulfonyl fluoride (IUPAC/Chemical Abstracts name) (1268), methidathion (529), methiocarb (530), methocrotophos (1273), methomyl (531), methoprene (532), methoquin-butyl (1276), methothrin (alternative name) (533), methoxychlor (534), methoxyfenozide (535), methyl bromide (537), methyl isothiocyanate (543), methylchloroform (alternative name) [CCN], methylene chloride [CCN], metofluthrin [CCN], metolcarb (550), metoxadiazone (1288), mevinphos (556), mexacarbate (1290), milbemectin (557), milbemycin oxime (alternative name) [CCN], mipafox (1293), mirex (1294), monocrotophos (561), morphothion (1300), moxidectin (alternative name) [CCN], naftalofos (alternative name) [CCN], naled (567), naphthalene (IUPAC/Chemical Abstracts name) (1303), NC-170 (development code) (1306), NC-184 (compound code), nicotine (578), nicotine sulfate (578), nifluridide (1309), nitenpyram (579), nithiazine (1311), nitrilacarb (1313), nitrilacarb 1:1 zinc chloride complex (1313), NNI-0101 (compound code), NNI-0250 (compound code), nornicotine (traditional name) (1319), novaluron (585), noviflumuron (586), O-2,5-dichloro-4-iodophenyl O-ethyl ethylphosphonothioate (IUPAC name) (1057), O,O-diethyl O-4-methyl-2-oxo-2H-chromen-7-yl phosphorothioate (IUPAC name) (1074), O,O-diethyl O-6-methyl-2-propylpyrimidin-4-yl phosphorothioate (IUPAC name) (1075), O,O,O′,O′-tetrapropyl dithiopyrophosphate (IUPAC name) (1424), oleic acid (IUPAC name) (593), omethoate (594), oxamyl (602), oxydemeton-methyl (609), oxydeprofos (1324), oxydisulfoton (1325), pp′-DDT (219), para-dichlorobenzene [CCN], parathion (615), parathion-methyl (616), penfluoron (alternative name) [CCN], pentachlorophenol (623), pentachlorophenyl laurate (IUPAC name) (623), permethrin (626), petroleum oils (alternative name) (628), PH 60-38 (development code) (1328), phenkapton (1330), phenothrin (630), phenthoate (631), phorate (636), phosalone (637), phosfolan (1338), phosmet (638), phosnichlor (1339), phosphamidon (639), phosphine (IUPAC name) (640), phoxim (642), phoxim-methyl (1340), pirimetaphos (1344), pirimicarb (651), pirimiphos-ethyl (1345), pirimiphos-methyl (652), polychlorodicyclopentadiene isomers (IUPAC name) (1346), polychloroterpenes (traditional name) (1347), potassium arsenite [CCN], potassium thiocyanate [CCN], prallethrin (655), precocene I (alternative name) [CCN], precocene II (alternative name) [CCN], precocene III (alternative name) [CCN], primidophos (1349), profenofos (662), profluthrin [CCN], promacyl (1354), promecarb (1355), propaphos (1356), propetamphos (673), propoxur (678), prothidathion (1360), prothiofos (686), prothoate (1362), protrifenbute [CCN], pymetrozine (688), pyraclofos (689), pyrazophos (693), pyresmethrin (1367), pyrethrin I (696), pyrethrin II (696), pyrethrins (696), pyridaben (699), pyridalyl (700), pyridaphenthion (701), pyrimidifen (706), pyrimitate (1370), pyriproxyfen (708), quassia (alternative name) [CCN], quinalphos (711), quinalphos-methyl (1376), quinothion (1380), quintiofos (1381), R-1492 (development code) (1382), rafoxanide (alternative name) [CCN], resmethrin (719), rotenone (722), RU 15525 (development code) (723), RU 25475 (development code) (1386), ryania (alternative name) (1387), ryanodine (traditional name) (1387), sabadilla (alternative name) (725), schradan (1389), sebufos (alternative name), selamectin (alternative name) [CCN], SI-0009 (compound code), silafluofen (728), SN 72129 (development code) (1397), sodium arsenite [CCN], sodium cyamide (444), sodium fluoride (IUPAC/Chemical Abstracts name) (1399), sodium hexafluorosilicate (1400), sodium pentachlorophenoxide (623), sodium selenate (IUPAC name) (1401), sodium thiocyanate [CCN], sophamide (1402), spinosad (737), spiromesifen (739), sulcofuron (746), sulcofuron-sodium (746), sulfluramid (750), sulfotep (753), sulfuryl fluoride (756), sulprofos (1408), tar oils (alternative name) (758), tau-fluvalinate (398), tazimcarb (1412), TDE (1414), tebufenozide (762), tebufenpyrad (763), tebupirimfos (764), teflubenzuron (768), tefluthrin (769), temephos (770), TEPP (1417), terallethrin (1418), terbam (alternative name), terbufos (773), tetrachloroethane [CCN], tetrachlorvinphos (777), tetramethrin (787), theta-cypermethrin (204), thiacloprid (791), thiafenox (alternative name), thiamethoxam (792), thicrofos (1428), thiocarboxime (1431), thiocyclam (798), thiocyclam hydrogen oxalate (798), thiodicarb (799), thiofanox (800), thiometon (801), thionazin (1434), thiosultap (803), thiosultap-sodium (803), thuringiensin (alternative name) [CCN], tolfenpyrad (809), tralomethrin (812), transfluthrin (813), transpermethrin (1440), triamiphos (1441), triazamate (818), triazophos (820), triazuron (alternative name), trichlorfon (824), trichlormetaphos-3 (alternative name) [CCN], trichloronat (1452), trifenofos (1455), triflumuron (835), trimethacarb (840), triprene (1459), vamidothion (847), vaniliprole [CCN], veratridine (alternative name) (725), veratrine (alternative name) (725), XMC (853), xylylcarb (854), YI-5302 (compound code), zeta-cypermethrin (205), zetamethrin (alternative name), zinc phosphide (640), zolaprofos (1469) and ZXI 8901 (development code) (858),
a molluscicide selected from the group of substances consisting of bis(tributyltin)oxide (IUPAC name) (913), bromoacetamide [CCN], calcium arsenate [CCN], cloethocarb (999), copper acetoarsenite [CCN], copper sulfate (172), fentin (347), ferric phosphate (IUPAC name) (352), metaldehyde (518), methiocarb (530), niclosamide (576), niclosamide-olamine (576), pentachlorophenol (623), sodium pentachlorophenoxide (623), tazimcarb (1412), thiodicarb (799), tributyltin oxide (913), trifenmorph (1454), trimethacarb (840), triphenyltin acetate (IUPAC name) (347) and triphenyltin hydroxide (IUPAC name) (347),
a nematicide selected from the group of substances consisting of 1,2-dibromo-3-chloropropane (IUPAC/Chemical Abstracts name) (1045), 1,2-dichloropropane (IUPAC/Chemical Abstracts name) (1062), 1,2-dichloropropane with 1,3-dichloropropene (IUPAC name) (1063), 1,3-dichloropropene (233), 3,4-dichlorotetrahydrothiophene 1,1-dioxide (IUPAC/Chemical Abstracts name) (1065), 3-(4-chlorophenyl)-5-methylrhodanine (IUPAC name) (980), 5-methyl-6-thioxo-1,3,5-thiadiazinan-3-ylacetic acid (IUPAC name) (1286), 6-isopentenylaminopurine (alternative name) (210), abamectin (1), acetoprole [CCN], alanycarb (15), aldicarb (16), aldoxycarb (863), AZ 60541 (compound code), benclothiaz [CCN], benomyl (62), butylpyridaben (alternative name), cadusafos (109), carbofuran (118), carbon disulfide (945), carbosulfan (119), chloropicrin (141), chlorpyrifos (145), cloethocarb (999), cytokinins (alternative name) (210), dazomet (216), DBCP (1045), DCIP (218), diamidafos (1044), dichlofenthion (1051), dicliphos (alternative name), dimethoate (262), doramectin (alternative name) [CCN], emamectin (291), emamectin benzoate (291), eprinomectin (alternative name) [CCN], ethoprophos (312), ethylene dibromide (316), fenamiphos (326), fenpyrad (alternative name), fensulfothion (1158), fosthiazate (408), fosthietan (1196), furfural (alternative name) [CCN], GY-81 (development code) (423), heterophos [CCN], iodomethane (IUPAC name) (542), isamidofos (1230), isazofos (1231), ivermectin (alternative name) [CCN], kinetin (alternative name) (210), mecarphon (1258), metam (519), metam-potassium (alternative name) (519), metam-sodium (519), methyl bromide (537), methyl isothiocyanate (543), milbemycin oxime (alternative name) [CCN], moxidectin (alternative name) [CCN], Myrothecium verrucaria composition (alternative name) (565), NC-184 (compound code), oxamyl (602), phorate (636), phosphamidon (639), phosphocarb [CCN], sebufos (alternative name), selamectin (alternative name) [CCN], spinosad (737), terbam (alternative name), terbufos (773), tetrachlorothiophene (IUPAC/Chemical Abstracts name) (1422), thiafenox (alternative name), thionazin (1434), triazophos (820), triazuron (alternative name), xylenols [CCN], YI-5302 (compound code) and zeatin (alternative name) (210),
a nitrification inhibitor selected from the group of substances consisting of potassium ethylxanthate [CCN] and nitrapyrin (580),
a plant activator selected from the group of substances consisting of acibenzolar (6), acibenzolar-5-methyl (6), probenazole (658) and Reynoutria sachalinensis extract (alternative name) (720),
a rodenticide selected from the group of substances consisting of 2-isovalerylindan-1,3-dione (IUPAC name) (1246), 4-(quinoxalin-2-ylamino)benzenesulfonamide (IUPAC name) (748), alpha-chlorohydrin [CCN], aluminium phosphide (640), antu (880), arsenous oxide (882), barium carbonate (891), bisthiosemi (912), brodifacoum (89), bromadiolone (91), bromethalin (92), calcium cyamide (444), chloralose (127), chlorophacinone (140), cholecalciferol (alternative name) (850), coumachlor (1004), coumafuryl (1005), coumatetralyl (175), crimidine (1009), difenacoum (246), difethialone (249), diphacinone (273), ergocalciferol (301), flocoumafen (357), fluoroacetamide (379), flupropadine (1183), flupropadine hydrochloride (1183), gamma-HCH (430), HCH (430), hydrogen cyamide (444), iodomethane (IUPAC name) (542), lindane (430), magnesium phosphide (IUPAC name) (640), methyl bromide (537), norbormide (1318), phosacetim (1336), phosphine (IUPAC name) (640), phosphorus [CCN], pindone (1341), potassium arsenite [CCN], pyrinuron (1371), scilliroside (1390), sodium arsenite [CCN], sodium cyamide (444), sodium fluoro-acetate (735), strychnine (745), thallium sulfate [CCN], warfarin (851) and zinc phosphide (640),
a synergist selected from the group of substances consisting of 2-(2-butoxyethoxy)ethyl piperonylate (IUPAC name) (934), 5-(1,3-benzodioxol-5-yl)-3-hexylcyclohex-2-enone (IUPAC name) (903), farnesol with nerolidol (alternative name) (324), MB-599 (development code) (498), MGK 264 (development code) (296), piperonyl butoxide (649), piprotal (1343), propyl isomer (1358), S421 (development code) (724), sesamex (1393), sesasmolin (1394) and sulfoxide (1406),
an animal repellent selected from the group of substances consisting of anthraquinone (32), chloralose (127), copper naphthenate [CCN], copper oxychloride (171), diazinon (227), dicyclopentadiene (chemical name) (1069), guazatine (422), guazatine acetates (422), methiocarb (530), pyridin-4-amine (IUPAC name) (23), thiram (804), trimethacarb (840), zinc naphthenate [CCN] and ziram (856),
a virucide selected from the group of substances consisting of imanin (alternative name) [CCN] and ribavirin (alternative name) [CCN],
and a wound protectant selected from the group of substances consisting of mercuric oxide (512), octhilinone (590) and thiophanate-methyl (802).

A very especially preferred embodiment of the subject-matter {1.1.18} of the invention is {1.1.18.2} a pesticidal composition comprising a mixture consisting of at least two substances, namely one compound (A) and at least one compound (B), as active ingredient and at least one auxiliary, wherein the compound (A) is the compound of formula (A-18) and the compound (B) is a compound selected from the group of substances consisting of abamectin (1), cyromazine (209), diafenthiuron (226), diazinon (227), emamectin benzoate (291), fenoxycarb (340), fosthiazate (408), lambda-cyhalothrin (198), lufenuron (490), methidathion (529), profenofos (662), pymetrozine (688), tefluthrin (769) and thiamethoxam (792).

The compound of formula (A-18) is known, for example, from the PCT Application WO-03/015519.

A preferred embodiment of the subject-matter {1.1} of the invention is {1.1.19} a pesticidal composition comprising a mixture consisting of at least two substances, namely one compound (A) and at least one compound (B), as active ingredient and at least one auxiliary, wherein the compound (A) is the compound of formula (A-19) 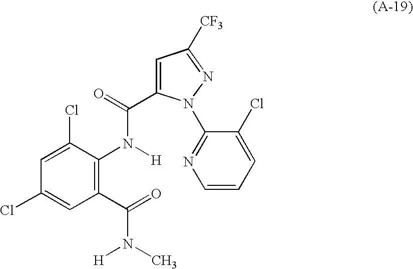
and the compound (B) is a compound selected from the group of substances consisting of an adjuvant, an acaricide, an algicide, an anthelmintic, an avicide, a bactericide, a biological agent, a soil sterilant, a chemosterilant, an insect pheromone, an insect repellent, an insecticide, a molluscicide, a nematicide, a nitrification inhibitor, a plant activator, a rodenticide, a synergist, an animal repellent, a virucide and a wound protectant.

An especially preferred embodiment of the subject-matter {1.1.19} of the invention is {1.1.19.1} a pesticidal composition comprising a mixture consisting of at least two substances, namely one compound (A) and at least one compound (B), as active ingredient and at least one auxiliary, wherein the compound (A) is the compound of formula (A-19) and the compound (B) is a compound selected from the group of substances consisting of
an adjuvant selected from the group of substances consisting of petroleum oils (alternative name) (628),
an acaricide selected from the group of substances consisting of 1,1-bis(4-chlorophenyl)-2-ethoxyethanol (IUPAC name) (910), 2,4-dichlorophenyl benzenesulfonate (IUPAC/Chemical Abstracts name) (1059), 2-fluoro-N-methyl-N-1-naphthylacetamide (IUPAC name) (1295), 4-chlorophenyl phenyl sulfone (IUPAC name) (981), abamectin (1), acequinocyl (3), acetoprole [CCN], acrinathrin (9), aldicarb (16), aldoxycarb (863), alpha-cypermethrin (202), amidithion (870), amidoflumet [CCN], amidothioate (872), amiton (875), amiton hydrogen oxalate (875), amitraz (24), aramite (881), arsenous oxide (882), AVI 382 (compound code), AZ 60541 (compound code), azinphos-ethyl (44), azinphos-methyl (45), azobenzene (IUPAC name) (888), azocyclotin (46), azothoate (889), benomyl (62), benoxafos (alternative name) [CCN], benzoximate (71), benzyl benzoate (IUPAC name) [CCN], bifenazate (74), bifenthrin (76), binapacryl (907), brofenvalerate (alternative name), bromocyclen (918), bromophos (920), bromophos-ethyl (921), bromopropylate (94), buprofezin (99), butocarboxim (103), butoxycarboxim (104), butylpyridaben (alternative name), calcium polysulfide (IUPAC name) (111), camphechlor (941), carbanolate (943), carbaryl (115), carbofuran (118), carbophenothion (947), CGA 50'439 (development code) (125), chinomethionat (126), chlorbenside (959), chlordimeform (964), chlordimeform hydrochloride (964), chlorfenapyr (130), chlorfenethol (968), chlorfenson (970), chlorfensulphide (971), chlorfenvinphos (131), chlorobenzilate (975), chloromebuform (977), chloromethiuron (978), chloropropylate (983), chlorpyrifos (145), chlorpyrifos-methyl (146), chlorthiophos (994), cinerin I (696), cinerin II (696), cinerins (696), clofentezine (158), closantel (alternative name) [CCN], coumaphos (174), crotamiton (alternative name) [CCN], crotoxyphos (1010), cufraneb (1013), cyanthoate (1020), cyhalothrin (196), cyhexatin (199), cypermethrin (201), DCPM (1032), DDT (219), demephion (1037), demephion-O (1037), demephion-S (1037), demeton (1038), demeton-methyl (224), demeton-O (1038), demeton-O-methyl (224), demeton-S (1038), demeton-5-methyl (224), demeton-5-methylsulphon (1039), diafenthiuron (226), dialifos (1042), diazinon (227), dichlofluanid (230), dichlorvos (236), dicliphos (alternative name), dicofol (242), dicrotophos (243), dienochlor (1071), dimefox (1081), dimethoate (262), dinactin (alternative name) (653), dinex (1089), dinex-diclexine (1089), dinobuton (269), dinocap (270), dinocap-4 [CCN], dinocap-6 [CCN], dinocton (1090), dinopenton (1092), dinosulfon (1097), dinoterbon (1098), dioxathion (1102), diphenyl sulfone (IUPAC name) (1103), disulfuram (alternative name) [CCN], disulfoton (278), DNOC (282), dofenapyn (1113), doramectin (alternative name) [CCN], endosulfan (294), endothion (1121), EPN (297), eprinomectin (alternative name) [CCN], ethion (309), ethoate-methyl (1134), etoxazole (320), etrimfos (1142), fenazaflor (1147), fenazaquin (328), fenbutatin oxide (330), fenothiocarb (337), fenpropathrin (342), fenpyrad (alternative name), fenpyroximate (345), fenson (1157), fentrifanil (1161), fenvalerate (349), fipronil (354), fluacrypyrim (360), fluazuron (1166), flubenzimine (1167), flucycloxuron (366), flucythrinate (367), fluenetil (1169), flufenoxuron (370), flumethrin (372), fluorbenside (1174), fluvalinate (1184), FMC 1137 (development code) (1185), formetanate (405), formetanate hydrochloride (405), formothion (1192), formparanate (1193), gamma-HCH (430), glyodin (1205), halfenprox (424), heptenophos (432), hexadecyl cyclopropanecarboxylate (IUPAC/Chemical Abstracts name) (1216), hexythiazox (441), iodomethane (IUPAC name) (542), isocarbophos (alternative name) (473), isopropyl O-(methoxyaminothiophosphoryl)salicylate (IUPAC name) (473), ivermectin (alternative name) [CCN], jasmolin I (696), jasmolin II (696), jodfenphos (1248), lindane (430), lufenuron (490), malathion (492), malonoben (1254), mecarbam (502), mephosfolan (1261), mesulfen (alternative name) [CCN], methacrifos (1266), methamidophos (527), methidathion (529), methiocarb (530), methomyl (531), methyl bromide (537), metolcarb (550), mevinphos (556), mexacarbate (1290), milbemectin (557), milbemycin oxime (alternative name) [CCN], mipafox (1293), monocrotophos (561), morphothion (1300), moxidectin (alternative name) [CCN], naled (567), NC-184 (compound code), nifluridide (1309), nikkomycins (alternative name) [CCN], nitrilacarb (1313), nitrilacarb 1:1 zinc chloride complex (1313), NNI-0101 (compound code), NNI-0250 (compound code), omethoate (594), oxamyl (602), oxydeprofos (1324), oxydisulfoton (1325), pp′-DDT (219), parathion (615), permethrin (626), petroleum oils (alternative name) (628), phenkapton (1330), phenthoate (631), phorate (636), phosalone (637), phosfolan (1338), phosmet (638), phosphamidon (639), phoxim (642), pirimiphos-methyl (652), polychloroterpenes (traditional name) (1347), polynactins (alternative name) (653), proclonol (1350), profenofos (662), promacyl (1354), propargite (671), propetamphos (673), propoxur (678), prothidathion (1360), prothoate (1362), pyrethrin I (696), pyrethrin II (696), pyrethrins (696), pyridaben (699), pyridaphenthion (701), pyrimidifen (706), pyrimitate (1370), quinalphos (711), quintiofos (1381), R-1492 (development code) (1382), RA-17 (development code) (1383), rotenone (722), schradan (1389), sebufos (alternative name), selamectin (alternative name) [CCN], SI-0009 (compound code), sophamide (1402), spirodiclofen (738), spiromesifen (739), SSI-121 (development code) (1404), sulfuram (alternative name) [CCN], sulfluramid (750), sulfotep (753), sulfur (754), SZI-121 (development code) (757), tau-fluvalinate (398), tebufenpyrad (763), TEPP (1417), terbam (alternative name), tetrachlorvinphos (777), tetradifon (786), tetranactin (alternative name) (653), tetrasul (1425), thiafenox (alternative name), thiocarboxime (1431), thiofanox (800), thiometon (801), thioquinox (1436), thuringiensin (alternative name) [CCN], triamiphos (1441), triarathene (1443), triazophos (820), triazuron (alternative name), trichlorfon (824), trifenofos (1455), trinactin (alternative name) (653), vamidothion (847), vaniliprole [CCN] and YI-5302 (compound code),
an algicide selected from the group of substances consisting of bethoxazin [CCN], copper dioctanoate (IUPAC name) (170), copper sulfate (172), cybutryne [CCN], dichlone (1052), dichlorophen (232), endothal (295), fentin (347), hydrated lime [CCN], nabam (566), quinoclamine (714), quinonamid (1379), simazine (730), triphenyltin acetate (IUPAC name) (347) and triphenyltin hydroxide (IUPAC name) (347),
an anthelmintic selected from the group of substances consisting of abamectin (1), crufomate (1011), doramectin (alternative name) [CCN], emamectin (291), emamectin benzoate (291), eprinomectin (alternative name) [CCN], ivermectin (alternative name) [CCN], milbemycin oxime (alternative name) [CCN], moxidectin (alternative name) [CCN], piperazine [CCN], selamectin (alternative name) [CCN], spinosad (737) and thiophanate (1435),
an avicide selected from the group of substances consisting of chloralose (127), endrin (1122), fenthion (346), pyridin-4-amine (IUPAC name) (23) and strychnine (745),
a bactericide selected from the group of substances consisting of 1-hydroxy-1H-pyridine-2-thione (IUPAC name) (1222), 4-(quinoxalin-2-ylamino)benzenesulfonamide (IUPAC name) (748), 8-hydroxyquinoline sulfate (446), bronopol (97), copper dioctanoate (IUPAC name) (170), copper hydroxide (IUPAC name) (169), cresol [CCN], dichlorophen (232), dipyrithione (1105), dodicin (1112), fenaminosulf (1144), formaldehyde (404), hydrargaphen (alternative name) [CCN], kasugamycin (483), kasugamycin hydrochloride hydrate (483), nickel bis(dimethyldithiocarbamate) (IUPAC name) (1308), nitrapyrin (580), octhilinone (590), oxolinic acid (606), oxytetracycline (611), potassium hydroxyquinoline sulfate (446), probenazole (658), streptomycin (744), streptomycin sesquisulfate (744), tecloftalam (766) and thiomersal (alternative name) [CCN],
a biological agent selected from the group of substances consisting of Adoxophyes orana GV (alternative name) (12), Agrobacterium radiobacter (alternative name) (13), Amblyseius spp. (alternative name) (19), Anagrapha falcifera NPV (alternative name) (28), Anagrus atomus (alternative name) (29), Aphelinus abdominalis (alternative name) (33), Aphidius colemani (alternative name) (34), Aphidoletes aphidimyza (alternative name) (35), Autographa californica NPV (alternative name) (38), Bacillus firmus (alternative name) (48), Bacillus sphaericus Neide (scientific name) (49), Bacillus thuringiensis Berliner (scientific name) (51), Bacillus thuringiensis subsp. aizawai (scientific name) (51), Bacillus thuringiensis subsp. israelensis (scientific name) (51), Bacillus thuringiensis subsp. japonensis (scientific name) (51), Bacillus thuringiensis subsp. kurstaki (scientific name) (51), Bacillus thuringiensis subsp. tenebrionis (scientific name) (51), Beauveria bassiana (alternative name) (53), Beauveria brongniartii (alternative name) (54), Chrysoperla carnea (alternative name) (151), Cryptolaemus montrouzieri (alternative name) (178), Cydia pomonella GV (alternative name) (191), Dacnusa sibirica (alternative name) (212), Diglyphus isaea (alternative name) (254), Encarsia formosa (scientific name) (293), Eretmocerus eremicus (alternative name) (300), Helicoverpa zea NPV (alternative name) (431), Heterorhabditis bacteriophora and H. megidis (alternative name) (433), Hippodamia convergens (alternative name) (442), Leptomastix dactylopii (alternative name) (488), Macrolophus caliginosus (alternative name) (491), Mamestra brassicae NPV (alternative name) (494), Metaphycus helvolus (alternative name) (522), Metarhizium anisopliae var. acridum (scientific name) (523), Metarhizium anisopliae var. anisopliae (scientific name) (523), Neodiprion sertifer NPV and N. lecontei NPV (alternative name) (575), Orius spp. (alternative name) (596), Paecilomyces fumosoroseus (alternative name) (613), Phytoseiulus persimilis (alternative name) (644), Spodoptera exigua multicapsid nuclear polyhedrosis virus (scientific name) (741), Steinernema bibionis (alternative name) (742), Steinernema carpocapsae (alternative name) (742), Steinernema feltiae (alternative name) (742), Steinernema glaseri (alternative name) (742), Steinernema riobrave (alternative name) (742), Steinernema riobravis (alternative name) (742), Steinernema scapterisci (alternative name) (742), Steinernema spp. (alternative name) (742), Trichogramma spp. (alternative name) (826), Typhlodromus occidentalis (alternative name) (844) and Verticillium lecanii (alternative name) (848),
a soil sterilant selected from the group of substances consisting of iodomethane (IUPAC name) (542) and methyl bromide (537),
a chemosterilant selected from the group of substances consisting of apholate [CCN], bisazir (alternative name) [CCN], busulfan (alternative name) [CCN], diflubenzuron (250), dimatif (alternative name) [CCN], hemel [CCN], hempa [CCN], metepa [CCN], methiotepa [CCN], methyl apholate [CCN], morzid [CCN], penfluoron (alternative name) [CCN], tepa [CCN], thiohempa (alternative name) [CCN], thiotepa (alternative name) [CCN], tretamine (alternative name) [CCN] and uredepa (alternative name) [CCN],
an insect pheromone selected from the group of substances consisting of (E)-dec-5-en-1-yl acetate with (E)-dec-5-en-1-ol (IUPAC name) (222), (E)-tridec-4-en-1-yl acetate (IUPAC name) (829), (E)-6-methylhept-2-en-4-ol (IUPAC name) (541), (E,Z)-tetradeca-4,10-dien-1-yl acetate (IUPAC name) (779), (Z)-dodec-7-en-1-yl acetate (IUPAC name) (285), (Z)-hexadec-11-enal (IUPAC name) (436), (Z)-hexadec-11-en-1-yl acetate (IUPAC name) (437), (Z)-hexadec-13-en-11-yn-1-yl acetate (IUPAC name) (438), (Z)-icos-13-en-10-one (IUPAC name) (448), (Z)-tetradec-7-en-1-al (IUPAC name) (782), (Z)-tetradec-9-en-1-ol (IUPAC name) (783), (Z)-tetradec-9-en-1-yl acetate (IUPAC name) (784), (7E,9Z)-dodeca-7,9-dien-1-yl acetate (IUPAC name) (283), (9Z,11E)-tetradeca-9,11-dien-1-yl acetate (IUPAC name) (780), (9Z,12E)-tetradeca-9,12-dien-1-yl acetate (IUPAC name) (781), 14-methyloctadec-1-ene (IUPAC name) (545), 4-methylnonan-5-ol with 4-methylnonan-5-one (IUPAC name) (544), alpha-multistriatin (alternative name) [CCN], brevicomin (alternative name) [CCN], codlelure (alternative name) [CCN], codlemone (alternative name) (167), cuelure (alternative name) (179), disparlure (277), dodec-8-en-1-yl acetate (IUPAC name) (286), dodec-9-en-1-yl acetate (IUPAC name) (287), dodeca-8,10-dien-1-yl acetate (IUPAC name) (284), dominicalure (alternative name) [CCN], ethyl 4-methyloctanoate (IUPAC name) (317), eugenol (alternative name) [CCN], frontalin (alternative name) [CCN], gossyplure (alternative name) (420), grandlure (421), grandlure I (alternative name) (421), grandlure II (alternative name) (421), grandlure III (alternative name) (421), grandlure IV (alternative name) (421), hexylure [CCN], ipsdienol (alternative name) [CCN], ipsenol (alternative name) [CCN], japonilure (alternative name) (481), lineatin (alternative name) [CCN], litlure (alternative name) [CCN], looplure (alternative name) [CCN], medlure [CCN], megatomoic acid (alternative name) [CCN], methyl eugenol (alternative name) (540), muscalure (563), octadeca-2,13-dien-1-yl acetate (IUPAC name) (588), octadeca-3,13-dien-1-yl acetate (IUPAC name) (589), orfralure (alternative name) [CCN], oryctalure (alternative name) (317), ostramone (alternative name) [CCN], siglure [CCN], sordidin (alternative name) (736), sulcatol (alternative name) [CCN], tetradec-11-en-1-yl acetate (IUPAC name) (785), trimedlure (839), trimedlure A (alternative name) (839), trimedlure B₁ (alternative name) (839), trimedlure B₂ (alternative name) (839), trimedlure C (alternative name) (839) and trunc-call (alternative name) [CCN],
an insect repellent selected from the group of substances consisting of 2-(octylthio)-ethanol (IUPAC name) (591), butopyronoxyl (933), butoxy(polypropylene glycol) (936), dibutyl adipate (IUPAC name) (1046), dibutyl phthalate (1047), dibutyl succinate (IUPAC name) (1048), diethyltoluamide [CCN], dimethyl carbate [CCN], dimethyl phthalate [CCN], ethyl hexanediol (1137), hexamide [CCN], methoquin-butyl (1276), methylneodecanamide [CCN], oxamate [CCN] and picaridin [CCN],
an insecticide selected from the group of substances consisting of 1,1-dichloro-1-nitroethane (IUPAC/Chemical Abstracts name) (1058), 1,1-dichloro-2,2-bis(4-ethylphenyl)-ethane (IUPAC name) (1056), 1,2-dichloropropane (IUPAC/Chemical Abstracts name) (1062), 1,2-dichloropropane with 1,3-dichloropropene (IUPAC name) (1063), 1-bromo-2-chloroethane (IUPAC/Chemical Abstracts name) (916), 2,2,2-trichloro-1-(3,4-dichloro-phenyl)ethyl acetate (IUPAC name) (1451), 2,2-dichlorovinyl 2-ethylsulfinylethyl methyl phosphate (IUPAC name) (1066), 2-(1,3-dithiolan-2-yl)phenyl dimethylcarbamate (IUPAC/Chemical Abstracts name) (1109), 2-(2-butoxyethoxy)ethyl thiocyanate (IUPAC/Chemical Abstracts name) (935), 2-(4,5-dimethyl-1,3-dioxolan-2-yl)phenyl methylcarbamate (IUPAC/Chemical Abstracts name) (1084), 2-(4-chloro-3,5-xylyloxy)ethanol (IUPAC name) (986), 2-chlorovinyl diethyl phosphate (IUPAC name) (984), 2-imidazolidone (IUPAC name) (1225), 2-isovalerylindan-1,3-dione (IUPAC name) (1246), 2-methyl(prop-2-ynyl)aminophenyl methylcarbamate (IUPAC name) (1284), 2-thiocyanatoethyl laurate (IUPAC name) (1433), 3-bromo-1-chloroprop-1-ene (IUPAC name) (917), 3-methyl-1-phenylpyrazol-5-yl dimethyl-carbamate (IUPAC name) (1283), 4-methyl(prop-2-ynyl)amino-3,5-xylyl methylcarbamate (IUPAC name) (1285), 5,5-dimethyl-3-oxocyclohex-1-enyl dimethylcarbamate (IUPAC name) (1085), abamectin (1), acephate (2), acetamiprid (4), acethion (alternative name) [CCN], acetoprole [CCN], acrinathrin (9), acrylonitrile (IUPAC name) (861), alanycarb (15), aldicarb (16), aldoxycarb (863), aldrin (864), allethrin (17), allosamidin (alternative name) [CCN], allyxycarb (866), alpha-cypermethrin (202), alpha-ecdysone (alternative name) [CCN], aluminium phosphide (640), amidithion (870), amidothioate (872), aminocarb (873), amiton (875), amiton hydrogen oxalate (875), amitraz (24), anabasine (877), athidathion (883), AVI 382 (compound code), AZ 60541 (compound code), azadirachtin (alternative name) (41), azamethiphos (42), azinphos-ethyl (44), azinphos-methyl (45), azothoate (889), Bacillus thuringiensis delta endotoxins (alternative name) (52), barium hexafluorosilicate (alternative name) [CCN], barium polysulfide (IUPAC/Chemical Abstracts name) (892), barthrin [CCN], BAS 320 I (compound code), Bayer 22/190 (development code) (893), Bayer 22408 (development code) (894), bendiocarb (58), benfuracarb (60), bensultap (66), beta-cyfluthrin (194), beta-cypermethrin (203), bifenthrin (76), bioallethrin (78), bioallethrin S-cyclopentenyl isomer (alternative name) (79), bioethanomethrin [CCN], biopermethrin (908), bioresmethrin (80), bis(2-chloroethyl)ether (IUPAC name) (909), bistrifluoron (83), borax (86), brofenvalerate (alternative name), bromfenvinfos (914), bromocyclen (918), bromo-DDT (alternative name) [CCN], bromophos (920), bromophos-ethyl (921), bufencarb (924), buprofezin (99), butacarb (926), butathiofos (927), butocarboxim (103), butonate (932), butoxycarboxim (104), butylpyridaben (alternative name), cadusafos (109), calcium arsenate [CCN], calcium cyamide (444), calcium polysulfide (IUPAC name) (111), camphechlor (941), carbanolate (943), carbaryl (115), carbofuran (118), carbon disulfide (IUPAC/Chemical Abstracts name) (945), carbon tetrachloride (IUPAC name) (946), carbophenothion (947), carbosulfan (119), cartap (123), cartap hydrochloride (123), cevadine (alternative name) (725), chlorbicyclen (960), chlordane (128), chlordecone (963), chlordimeform (964), chlordimeform hydrochloride (964), chlorethoxyfos (129), chlorfenapyr (130), chlorfenvinphos (131), chlorfluazuron (132), chlormephos (136), chloroform [CCN], chloropicrin (141), chlorphoxim (989), chlorprazophos (990), chlorpyrifos (145), chlorpyrifos-methyl (146), chlorthiophos (994), chromafenozide (150), cinerin I (696), cinerin II (696), cinerins (696), cis-resmethrin (alternative name), cismethrin (80), clocythrin (alternative name), cloethocarb (999), closantel (alternative name) [CCN], clothianidin (165), copper acetoarsenite [CCN], copper arsenate [CCN], copper oleate [CCN], coumaphos (174), coumithoate (1006), crotamiton (alternative name) [CCN], crotoxyphos (1010), crufomate (1011), cryolite (alternative name) (177), CS 708 (development code) (1012), cyanofenphos (1019), cyanophos (184), cyanthoate (1020), cyclethrin [CCN], cycloprothrin (188), cyfluthrin (193), cyhalothrin (196), cypermethrin (201), cyphenothrin (206), cyromazine (209), cythioate (alternative name) [CCN], d-limonene (alternative name) [CCN], d-tetramethrin (alternative name) (788), DAEP (1031), dazomet (216), DDT (219), decarbofuran (1034), deltamethrin (223), demephion (1037), demephion-O (1037), demephion-S (1037), demeton (1038), demeton-methyl (224), demeton-O (1038), demeton-O-methyl (224), demeton-S (1038), demeton-5-methyl (224), demeton-5-methylsulphon (1039), diafenthiuron (226), dialifos (1042), diamidafos (1044), diazinon (227), dicapthon (1050), dichlofenthion (1051), dichlorvos (236), dicliphos (alternative name), dicresyl (alternative name) [CCN], dicrotophos (243), dicyclanil (244), dieldrin (1070), diethyl 5-methylpyrazol-3-yl phosphate (IUPAC name) (1076), diflubenzuron (250), dilor (alternative name) [CCN], dimefluthrin [CCN], dimefox (1081), dimetan (1085), dimethoate (262), dimethrin (1083), dimethylvinphos (265), dimetilan (1086), dinex (1089), dinex-diclexine (1089), dinoprop (1093), dinosam (1094), dinoseb (1095), dinotefuran (271), diofenolan (1099), dioxabenzofos (1100), dioxacarb (1101), dioxathion (1102), disulfoton (278), dithicrofos (1108), DNOC (282), doramectin (alternative name) [CCN], DSP (1115), ecdysterone (alternative name) [CCN], EI 1642 (development code) (1118), emamectin (291), emamectin benzoate (291), EMPC (1120), empenthrin (292), endosulfan (294), endothion (1121), endrin (1122), EPBP (1123), EPN (297), epofenonane (1124), eprinomectin (alternative name) [CCN], esfenvalerate (302), etaphos (alternative name) [CCN], ethiofencarb (308), ethion (309), ethiprole (310), ethoate-methyl (1134), ethoprophos (312), ethyl formate (IUPAC name) [CCN], ethyl-DDD (alternative name) (1056), ethylene dibromide (316), ethylene dichloride (chemical name) (1136), ethylene oxide [CCN], etofenprox (319), etrimfos (1142), EXD (1143), famphur (323), fenamiphos (326), fenazaflor (1147), fenchlorphos (1148), fenethacarb (1149), fenfluthrin (1150), fenitrothion (335), fenobucarb (336), fenoxacrim (1153), fenoxycarb (340), fenpirithrin (1155), fenpropathrin (342), fenpyrad (alternative name), fensulfothion (1158), fenthion (346), fenthion-ethyl [CCN], fenvalerate (349), fipronil (354), flonicamid (358), flucofuron (1168), flucycloxuron (366), flucythrinate (367), fluenetil (1169), flufenerim [CCN], flufenoxuron (370), flufenprox (1171), flumethrin (372), fluvalinate (1184), FMC 1137 (development code) (1185), fonofos (1191), formetanate (405), formetanate hydrochloride (405), formothion (1192), formparanate (1193), fosmethilan (1194), fospirate (1195), fosthiazate (408), fosthietan (1196), furathiocarb (412), furethrin (1200), gamma-cyhalothrin (197), gamma-HCH (430), guazatine (422), guazatine acetates (422), GY-81 (development code) (423), halfenprox (424), halofenozide (425), HCH (430), HEOD (1070), heptachlor (1211), heptenophos (432), heterophos [CCN], hexaflumuron (439), HHDN (864), hydramethylnon (443), hydrogen cyamide (444), hydroprene (445), hyquincarb (1223), imidacloprid (458), imiprothrin (460), indoxacarb (465), iodomethane (IUPAC name) (542), IPSP (1229), isazofos (1231), isobenzan (1232), isocarbophos (alternative name) (473), isodrin (1235), isofenphos (1236), isolane (1237), isoprocarb (472), isopropyl O-(methoxyaminothiophosphoryl)salicylate (IUPAC name) (473), isoprothiolane (474), isothioate (1244), isoxathion (480), ivermectin (alternative name) [CCN], jasmolin I (696), jasmolin II (696), jodfenphos (1248), juvenile hormone I (alternative name) [CCN], juvenile hormone II (alternative name) [CCN], juvenile hormone III (alternative name) [CCN], kelevan (1249), kinoprene (484), lambda-cyhalothrin (198), lead arsenate [CCN], leptophos (1250), lindane (430), lirimfos (1251), lufenuron (490), lythidathion (1253), m-cumenyl methylcarbamate (IUPAC name) (1014), magnesium phosphide (IUPAC name) (640), malathion (492), malonoben (1254), mazidox (1255), mecarbam (502), mecarphon (1258), menazon (1260), mephosfolan (1261), mercurous chloride (513), mesulfenfos (1263), metam (519), metam-potassium (alternative name) (519), metam-sodium (519), methacrifos (1266), methamidophos (527), methanesulfonyl fluoride (IUPAC/Chemical Abstracts name) (1268), methidathion (529), methiocarb (530), methocrotophos (1273), methomyl (531), methoprene (532), methoquin-butyl (1276), methothrin (alternative name) (533), methoxychlor (534), methoxyfenozide (535), methyl bromide (537), methyl isothiocyanate (543), methylchloroform (alternative name) [CCN], methylene chloride [CCN], metofluthrin [CCN], metolcarb (550), metoxadiazone (1288), mevinphos (556), mexacarbate (1290), milbemectin (557), milbemycin oxime (alternative name) [CCN], mipafox (1293), mirex (1294), monocrotophos (561), morphothion (1300), moxidectin (alternative name) [CCN], naftalofos (alternative name) [CCN], naled (567), naphthalene (IUPAC/Chemical Abstracts name) (1303), NC-170 (development code) (1306), NC-184 (compound code), nicotine (578), nicotine sulfate (578), nifluridide (1309), nitenpyram (579), nithiazine (1311), nitrilacarb (1313), nitrilacarb 1:1 zinc chloride complex (1313), NNI-0101 (compound code), NNI-0250 (compound code), nornicotine (traditional name) (1319), novaluron (585), noviflumuron (586), O-2,5-dichloro-4-iodophenyl O-ethyl ethylphosphonothioate (IUPAC name) (1057), O,O-diethyl O-4-methyl-2-oxo-2H-chromen-7-yl phosphorothioate (IUPAC name) (1074), O,O-diethyl O-6-methyl-2-propylpyrimidin-4-yl phosphorothioate (IUPAC name) (1075), O,O,O′,O′-tetrapropyl dithiopyrophosphate (IUPAC name) (1424), oleic acid (IUPAC name) (593), omethoate (594), oxamyl (602), oxydemeton-methyl (609), oxydeprofos (1324), oxydisulfoton (1325), pp′-DDT (219), para-dichlorobenzene [CCN], parathion (615), parathion-methyl (616), penfluoron (alternative name) [CCN], pentachlorophenol (623), pentachlorophenyl laurate (IUPAC name) (623), permethrin (626), petroleum oils (alternative name) (628), PH 60-38 (development code) (1328), phenkapton (1330), phenothrin (630), phenthoate (631), phorate (636), phosalone (637), phosfolan (1338), phosmet (638), phosnichlor (1339), phosphamidon (639), phosphine (IUPAC name) (640), phoxim (642), phoxim-methyl (1340), pirimetaphos (1344), pirimicarb (651), pirimiphos-ethyl (1345), pirimiphos-methyl (652), polychlorodicyclopentadiene isomers (IUPAC name) (1346), polychloroterpenes (traditional name) (1347), potassium arsenite [CCN], potassium thiocyanate [CCN], prallethrin (655), precocene I (alternative name) [CCN], precocene II (alternative name) [CCN], precocene III (alternative name) [CCN], primidophos (1349), profenofos (662), profluthrin [CCN], promacyl (1354), promecarb (1355), propaphos (1356), propetamphos (673), propoxur (678), prothidathion (1360), prothiofos (686), prothoate (1362), protrifenbute [CCN], pymetrozine (688), pyraclofos (689), pyrazophos (693), pyresmethrin (1367), pyrethrin I (696), pyrethrin II (696), pyrethrins (696), pyridaben (699), pyridalyl (700), pyridaphenthion (701), pyrimidifen (706), pyrimitate (1370), pyriproxyfen (708), quassia (alternative name) [CCN], quinalphos (711), quinalphos-methyl (1376), quinothion (1380), quintiofos (1381), R-1492 (development code) (1382), rafoxanide (alternative name) [CCN], resmethrin (719), rotenone (722), RU 15525 (development code) (723), RU 25475 (development code) (1386), ryania (alternative name) (1387), ryanodine (traditional name) (1387), sabadilla (alternative name) (725), schradan (1389), sebufos (alternative name), selamectin (alternative name) [CCN], SI-0009 (compound code), silafluofen (728), SN 72129 (development code) (1397), sodium arsenite [CCN], sodium cyamide (444), sodium fluoride (IUPAC/Chemical Abstracts name) (1399), sodium hexafluorosilicate (1400), sodium pentachlorophenoxide (623), sodium selenate (IUPAC name) (1401), sodium thiocyanate [CCN], sophamide (1402), spinosad (737), spiromesifen (739), sulcofuron (746), sulcofuron-sodium (746), sulfluramid (750), sulfotep (753), sulfuryl fluoride (756), sulprofos (1408), tar oils (alternative name) (758), tau-fluvalinate (398), tazimcarb (1412), TDE (1414), tebufenozide (762), tebufenpyrad (763), tebupirimfos (764), teflubenzuron (768), tefluthrin (769), temephos (770), TEPP (1417), terallethrin (1418), terbam (alternative name), terbufos (773), tetrachloroethane [CCN], tetrachlorvinphos (777), tetramethrin (787), theta-cypermethrin (204), thiacloprid (791), thiafenox (alternative name), thiamethoxam (792), thicrofos (1428), thiocarboxime (1431), thiocyclam (798), thiocyclam hydrogen oxalate (798), thiodicarb (799), thiofanox (800), thiometon (801), thionazin (1434), thiosultap (803), thiosultap-sodium (803), thuringiensin (alternative name) [CCN], tolfenpyrad (809), tralomethrin (812), transfluthrin (813), transpermethrin (1440), triamiphos (1441), triazamate (818), triazophos (820), triazuron (alternative name), trichlorfon (824), trichlormetaphos-3 (alternative name) [CCN], trichloronat (1452), trifenofos (1455), triflumuron (835), trimethacarb (840), triprene (1459), vamidothion (847), vaniliprole [CCN], veratridine (alternative name) (725), veratrine (alternative name) (725), XMC (853), xylylcarb (854), YI-5302 (compound code), zeta-cypermethrin (205), zetamethrin (alternative name), zinc phosphide (640), zolaprofos (1469) and ZXI 8901 (development code) (858),
a molluscicide selected from the group of substances consisting of bis(tributyltin)oxide (IUPAC name) (913), bromoacetamide [CCN], calcium arsenate [CCN], cloethocarb (999), copper acetoarsenite [CCN], copper sulfate (172), fentin (347), ferric phosphate (IUPAC name) (352), metaldehyde (518), methiocarb (530), niclosamide (576), niclosamide-olamine (576), pentachlorophenol (623), sodium pentachlorophenoxide (623), tazimcarb (1412), thiodicarb (799), tributyltin oxide (913), trifenmorph (1454), trimethacarb (840), triphenyltin acetate (IUPAC name) (347) and triphenyltin hydroxide (IUPAC name) (347),
a nematicide selected from the group of substances consisting of 1,2-dibromo-3-chloropropane (IUPAC/Chemical Abstracts name) (1045), 1,2-dichloropropane (IUPAC/Chemical Abstracts name) (1062), 1,2-dichloropropane with 1,3-dichloropropene (IUPAC name) (1063), 1,3-dichloropropene (233), 3,4-dichlorotetrahydrothiophene 1,1-dioxide (IUPAC/Chemical Abstracts name) (1065), 3-(4-chlorophenyl)-5-methylrhodanine (IUPAC name) (980), 5-methyl-6-thioxo-1,3,5-thiadiazinan-3-ylacetic acid (IUPAC name) (1286), 6-isopentenylaminopurine (alternative name) (210), abamectin (1), acetoprole [CCN], alanycarb (15), aldicarb (16), aldoxycarb (863), AZ 60541 (compound code), benclothiaz [CCN], benomyl (62), butylpyridaben (alternative name), cadusafos (109), carbofuran (118), carbon disulfide (945), carbosulfan (119), chloropicrin (141), chlorpyrifos (145), cloethocarb (999), cytokinins (alternative name) (210), dazomet (216), DBCP (1045), DCIP (218), diamidafos (1044), dichlofenthion (1051), dicliphos (alternative name), dimethoate (262), doramectin (alternative name) [CCN], emamectin (291), emamectin benzoate (291), eprinomectin (alternative name) [CCN], ethoprophos (312), ethylene dibromide (316), fenamiphos (326), fenpyrad (alternative name), fensulfothion (1158), fosthiazate (408), fosthietan (1196), furfural (alternative name) [CCN], GY-81 (development code) (423), heterophos [CCN], iodomethane (IUPAC name) (542), isamidofos (1230), isazofos (1231), ivermectin (alternative name) [CCN], kinetin (alternative name) (210), mecarphon (1258), metam (519), metam-potassium (alternative name) (519), metam-sodium (519), methyl bromide (537), methyl isothiocyanate (543), milbemycin oxime (alternative name) [CCN], moxidectin (alternative name) [CCN], Myrothecium verrucaria composition (alternative name) (565), NC-184 (compound code), oxamyl (602), phorate (636), phosphamidon (639), phosphocarb [CCN], sebufos (alternative name), selamectin (alternative name) [CCN], spinosad (737), terbam (alternative name), terbufos (773), tetrachlorothiophene (IUPAC/Chemical Abstracts name) (1422), thiafenox (alternative name), thionazin (1434), triazophos (820), triazuron (alternative name), xylenols [CCN], YI-5302 (compound code) and zeatin (alternative name) (210),
a nitrification inhibitor selected from the group of substances consisting of potassium ethylxanthate [CCN] and nitrapyrin (580),
a plant activator selected from the group of substances consisting of acibenzolar (6), acibenzolar-5-methyl (6), probenazole (658) and Reynoutria sachalinensis extract (alternative name) (720),
a rodenticide selected from the group of substances consisting of 2-isovalerylindan-1,3-dione (IUPAC name) (1246), 4-(quinoxalin-2-ylamino)benzenesulfonamide (IUPAC name) (748), alpha-chlorohydrin [CCN], aluminium phosphide (640), antu (880), arsenous oxide (882), barium carbonate (891), bisthiosemi (912), brodifacoum (89), bromadiolone (91), bromethalin (92), calcium cyamide (444), chloralose (127), chlorophacinone (140), cholecalciferol (alternative name) (850), coumachlor (1004), coumafuryl (1005), coumatetralyl (175), crimidine (1009), difenacoum (246), difethialone (249), diphacinone (273), ergocalciferol (301), flocoumafen (357), fluoroacetamide (379), flupropadine (1183), flupropadine hydrochloride (1183), gamma-HCH (430), HCH (430), hydrogen cyamide (444), iodomethane (IUPAC name) (542), lindane (430), magnesium phosphide (IUPAC name) (640), methyl bromide (537), norbormide (1318), phosacetim (1336), phosphine (IUPAC name) (640), phosphorus [CCN], pindone (1341), potassium arsenite [CCN], pyrinuron (1371), scilliroside (1390), sodium arsenite [CCN], sodium cyamide (444), sodium fluoro-acetate (735), strychnine (745), thallium sulfate [CCN], warfarin (851) and zinc phosphide (640),
a synergist selected from the group of substances consisting of 2-(2-butoxyethoxy)ethyl piperonylate (IUPAC name) (934), 5-(1,3-benzodioxol-5-yl)-3-hexylcyclohex-2-enone (IUPAC name) (903), farnesol with nerolidol (alternative name) (324), MB-599 (development code) (498), MGK 264 (development code) (296), piperonyl butoxide (649), piprotal (1343), propyl isomer (1358), S421 (development code) (724), sesamex (1393), sesasmolin (1394) and sulfoxide (1406),
an animal repellent selected from the group of substances consisting of anthraquinone (32), chloralose (127), copper naphthenate [CCN], copper oxychloride (171), diazinon (227), dicyclopentadiene (chemical name) (1069), guazatine (422), guazatine acetates (422), methiocarb (530), pyridin-4-amine (IUPAC name) (23), thiram (804), trimethacarb (840), zinc naphthenate [CCN] and ziram (856),
a virucide selected from the group of substances consisting of imanin (alternative name) [CCN] and ribavirin (alternative name) [CCN],
and a wound protectant selected from the group of substances consisting of mercuric oxide (512), octhilinone (590) and thiophanate-methyl (802).

A very especially preferred embodiment of the subject-matter {1.1.19} of the invention is {1.1.19.2} a pesticidal composition comprising a mixture consisting of at least two substances, namely one compound (A) and at least one compound (B), as active ingredient and at least one auxiliary, wherein the compound (A) is the compound of formula (A-19) and the compound (B) is a compound selected from the group of substances consisting of abamectin (1), cyromazine (209), diafenthiuron (226), diazinon (227), emamectin benzoate (291), fenoxycarb (340), fosthiazate (408), lambda-cyhalothrin (198), lufenuron (490), methidathion (529), profenofos (662), pymetrozine (688), tefluthrin (769) and thiamethoxam (792).

The compound of formula (A-19) is known, for example, from the PCT Application WO-03/015519.

A preferred embodiment of the subject-matter {1.1} of the invention is {1.1.20} a pesticidal composition comprising a mixture consisting of at least two substances, namely one compound (A) and at least one compound (B), as active ingredient and at least one auxiliary, wherein the compound (A) is the compound of formula (A-20) 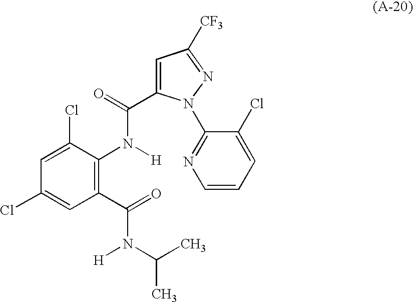
and the compound (B) is a compound selected from the group of substances consisting of an adjuvant, an acaricide, an algicide, an anthelmintic, an avicide, a bactericide, a biological agent, a soil sterilant, a chemosterilant, an insect pheromone, an insect repellent, an insecticide, a molluscicide, a nematicide, a nitrification inhibitor, a plant activator, a rodenticide, a synergist, an animal repellent, a virucide and a wound protectant.

An especially preferred embodiment of the subject-matter {1.1.20} of the invention is {1.1.20.1} a pesticidal composition comprising a mixture consisting of at least two substances, namely one compound (A) and at least one compound (B), as active ingredient and at least one auxiliary, wherein the compound (A) is the compound of formula (A-20) and the compound (B) is a compound selected from the group of substances consisting of
an adjuvant selected from the group of substances consisting of petroleum oils (alternative name) (628),
an acaricide selected from the group of substances consisting of 1,1-bis(4-chlorophenyl)-2-ethoxyethanol (IUPAC name) (910), 2,4-dichlorophenyl benzenesulfonate (IUPAC/Chemical Abstracts name) (1059), 2-fluoro-N-methyl-N-1-naphthylacetamide (IUPAC name) (1295), 4-chlorophenyl phenyl sulfone (IUPAC name) (981), abamectin (1), acequinocyl (3), acetoprole [CCN], acrinathrin (9), aldicarb (16), aldoxycarb (863), alpha-cypermethrin (202), amidithion (870), amidoflumet [CCN], amidothioate (872), amiton (875), amiton hydrogen oxalate (875), amitraz (24), aramite (881), arsenous oxide (882), AVI 382 (compound code), AZ 60541 (compound code), azinphos-ethyl (44), azinphos-methyl (45), azobenzene (IUPAC name) (888), azocyclotin (46), azothoate (889), benomyl (62), benoxafos (alternative name) [CCN], benzoximate (71), benzyl benzoate (IUPAC name) [CCN], bifenazate (74), bifenthrin (76), binapacryl (907), brofenvalerate (alternative name), bromocyclen (918), bromophos (920), bromophos-ethyl (921), bromopropylate (94), buprofezin (99), butocarboxim (103), butoxycarboxim (104), butylpyridaben (alternative name), calcium polysulfide (IUPAC name) (111), camphechlor (941), carbanolate (943), carbaryl (115), carbofuran (118), carbophenothion (947), CGA 50'439 (development code) (125), chinomethionat (126), chlorbenside (959), chlordimeform (964), chlordimeform hydrochloride (964), chlorfenapyr (130), chlorfenethol (968), chlorfenson (970), chlorfensulphide (971), chlorfenvinphos (131), chlorobenzilate (975), chloromebuform (977), chloromethiuron (978), chloropropylate (983), chlorpyrifos (145), chlorpyrifos-methyl (146), chlorthiophos (994), cinerin I (696), cinerin II (696), cinerins (696), clofentezine (158), closantel (alternative name) [CCN], coumaphos (174), crotamiton (alternative name) [CCN], crotoxyphos (1010), cufraneb (1013), cyanthoate (1020), cyhalothrin (196), cyhexatin (199), cypermethrin (201), DCPM (1032), DDT (219), demephion (1037), demephion-O (1037), demephion-S (1037), demeton (1038), demeton-methyl (224), demeton-O (1038), demeton-O-methyl (224), demeton-S (1038), demeton-5-methyl (224), demeton-5-methylsulphon (1039), diafenthiuron (226), dialifos (1042), diazinon (227), dichlofluanid (230), dichlorvos (236), dicliphos (alternative name), dicofol (242), dicrotophos (243), dienochlor (1071), dimefox (1081), dimethoate (262), dinactin (alternative name) (653), dinex (1089), dinex-diclexine (1089), dinobuton (269), dinocap (270), dinocap-4 [CCN], dinocap-6 [CCN], dinocton (1090), dinopenton (1092), dinosulfon (1097), dinoterbon (1098), dioxathion (1102), diphenyl sulfone (IUPAC name) (1103), disulfuram (alternative name) [CCN], disulfoton (278), DNOC (282), dofenapyn (1113), doramectin (alternative name) [CCN], endosulfan (294), endothion (1121), EPN (297), eprinomectin (alternative name) [CCN], ethion (309), ethoate-methyl (1134), etoxazole (320), etrimfos (1142), fenazaflor (1147), fenazaquin (328), fenbutatin oxide (330), fenothiocarb (337), fenpropathrin (342), fenpyrad (alternative name), fenpyroximate (345), fenson (1157), fentrifanil (1161), fenvalerate (349), fipronil (354), fluacrypyrim (360), fluazuron (1166), flubenzimine (1167), flucycloxuron (366), flucythrinate (367), fluenetil (1169), flufenoxuron (370), flumethrin (372), fluorbenside (1174), fluvalinate (1184), FMC 1137 (development code) (1185), formetanate (405), formetanate hydrochloride (405), formothion (1192), formparanate (1193), gamma-HCH (430), glyodin (1205), halfenprox (424), heptenophos (432), hexadecyl cyclopropanecarboxylate (IUPAC/Chemical Abstracts name) (1216), hexythiazox (441), iodomethane (IUPAC name) (542), isocarbophos (alternative name) (473), isopropyl O-(methoxyaminothiophosphoryl)salicylate (IUPAC name) (473), ivermectin (alternative name) [CCN], jasmolin I (696), jasmolin II (696), jodfenphos (1248), lindane (430), lufenuron (490), malathion (492), malonoben (1254), mecarbam (502), mephosfolan (1261), mesulfen (alternative name) [CCN], methacrifos (1266), methamidophos (527), methidathion (529), methiocarb (530), methomyl (531), methyl bromide (537), metolcarb (550), mevinphos (556), mexacarbate (1290), milbemectin (557), milbemycin oxime (alternative name) [CCN], mipafox (1293), monocrotophos (561), morphothion (1300), moxidectin (alternative name) [CCN], naled (567), NC-184 (compound code), nifluridide (1309), nikkomycins (alternative name) [CCN], nitrilacarb (1313), nitrilacarb 1:1 zinc chloride complex (1313), NNI-0101 (compound code), NNI-0250 (compound code), omethoate (594), oxamyl (602), oxydeprofos (1324), oxydisulfoton (1325), pp′-DDT (219), parathion (615), permethrin (626), petroleum oils (alternative name) (628), phenkapton (1330), phenthoate (631), phorate (636), phosalone (637), phosfolan (1338), phosmet (638), phosphamidon (639), phoxim (642), pirimiphos-methyl (652), polychloroterpenes (traditional name) (1347), polynactins (alternative name) (653), proclonol (1350), profenofos (662), promacyl (1354), propargite (671), propetamphos (673), propoxur (678), prothidathion (1360), prothoate (1362), pyrethrin I (696), pyrethrin II (696), pyrethrins (696), pyridaben (699), pyridaphenthion (701), pyrimidifen (706), pyrimitate (1370), quinalphos (711), quintiofos (1381), R-1492 (development code) (1382), RA-17 (development code) (1383), rotenone (722), schradan (1389), sebufos (alternative name), selamectin (alternative name) [CCN], SI-0009 (compound code), sophamide (1402), spirodiclofen (738), spiromesifen (739), SSI-121 (development code) (1404), sulfuram (alternative name) [CCN], sulfluramid (750), sulfotep (753), sulfur (754), SZI-121 (development code) (757), tau-fluvalinate (398), tebufenpyrad (763), TEPP (1417), terbam (alternative name), tetrachlorvinphos (777), tetradifon (786), tetranactin (alternative name) (653), tetrasul (1425), thiafenox (alternative name), thiocarboxime (1431), thiofanox (800), thiometon (801), thioquinox (1436), thuringiensin (alternative name) [CCN], triamiphos (1441), triarathene (1443), triazophos (820), triazuron (alternative name), trichlorfon (824), trifenofos (1455), trinactin (alternative name) (653), vamidothion (847), vaniliprole [CCN] and YI-5302 (compound code),
an algicide selected from the group of substances consisting of bethoxazin [CCN], copper dioctanoate (IUPAC name) (170), copper sulfate (172), cybutryne [CCN], dichlone (1052), dichlorophen (232), endothal (295), fentin (347), hydrated lime [CCN], nabam (566), quinoclamine (714), quinonamid (1379), simazine (730), triphenyltin acetate (IUPAC name) (347) and triphenyltin hydroxide (IUPAC name) (347),
an anthelmintic selected from the group of substances consisting of abamectin (1), crufomate (1011), doramectin (alternative name) [CCN], emamectin (291), emamectin benzoate (291), eprinomectin (alternative name) [CCN], ivermectin (alternative name) [CCN], milbemycin oxime (alternative name) [CCN], moxidectin (alternative name) [CCN], piperazine [CCN], selamectin (alternative name) [CCN], spinosad (737) and thiophanate (1435),
an avicide selected from the group of substances consisting of chloralose (127), endrin (1122), fenthion (346), pyridin-4-amine (IUPAC name) (23) and strychnine (745),
a bactericide selected from the group of substances consisting of 1-hydroxy-1H-pyridine-2-thione (IUPAC name) (1222), 4-(quinoxalin-2-ylamino)benzenesulfonamide (IUPAC name) (748), 8-hydroxyquinoline sulfate (446), bronopol (97), copper dioctanoate (IUPAC name) (170), copper hydroxide (IUPAC name) (169), cresol [CCN], dichlorophen (232), dipyrithione (1105), dodicin (1112), fenaminosulf (1144), formaldehyde (404), hydrargaphen (alternative name) [CCN], kasugamycin (483), kasugamycin hydrochloride hydrate (483), nickel bis(dimethyldithiocarbamate) (IUPAC name) (1308), nitrapyrin (580), octhilinone (590), oxolinic acid (606), oxytetracycline (611), potassium hydroxyquinoline sulfate (446), probenazole (658), streptomycin (744), streptomycin sesquisulfate (744), tecloftalam (766) and thiomersal (alternative name) [CCN],
a biological agent selected from the group of substances consisting of Adoxophyes orana GV (alternative name) (12), Agrobacterium radiobacter (alternative name) (13), Amblyseius spp. (alternative name) (19), Anagrapha falcifera NPV (alternative name) (28), Anagrus atomus (alternative name) (29), Aphelinus abdominalis (alternative name) (33), Aphidius colemani (alternative name) (34), Aphidoletes aphidimyza (alternative name) (35), Autographa californica NPV (alternative name) (38), Bacillus firmus (alternative name) (48), Bacillus sphaericus Neide (scientific name) (49), Bacillus thuringiensis Berliner (scientific name) (51), Bacillus thuringiensis subsp. aizawai (scientific name) (51), Bacillus thuringiensis subsp. israelensis (scientific name) (51), Bacillus thuringiensis subsp. japonensis (scientific name) (51), Bacillus thuringiensis subsp. kurstaki (scientific name) (51), Bacillus thuringiensis subsp. tenebrionis (scientific name) (51), Beauveria bassiana (alternative name) (53), Beauveria brongniartii (alternative name) (54), Chrysoperla carnea (alternative name) (151), Cryptolaemus montrouzieri (alternative name) (178), Cydia pomonella GV (alternative name) (191), Dacnusa sibirica (alternative name) (212), Diglyphus isaea (alternative name) (254), Encarsia formosa (scientific name) (293), Eretmocerus eremicus (alternative name) (300), Helicoverpa zea NPV (alternative name) (431), Heterorhabditis bacteriophora and H. megidis (alternative name) (433), Hippodamia convergens (alternative name) (442), Leptomastix dactylopii (alternative name) (488), Macrolophus caliginosus (alternative name) (491), Mamestra brassicae NPV (alternative name) (494), Metaphycus helvolus (alternative name) (522), Metarhizium anisopliae var. acridum (scientific name) (523), Metarhizium anisopliae var. anisopliae (scientific name) (523), Neodiprion sertifer NPV and N. lecontei NPV (alternative name) (575), Orius spp. (alternative name) (596), Paecilomyces fumosoroseus (alternative name) (613), Phytoseiulus persimilis (alternative name) (644), Spodoptera exigua multicapsid nuclear polyhedrosis virus (scientific name) (741), Steinernema bibionis (alternative name) (742), Steinernema carpocapsae (alternative name) (742), Steinernema feltiae (alternative name) (742), Steinernema glaseri (alternative name) (742), Steinernema riobrave (alternative name) (742), Steinernema riobravis (alternative name) (742), Steinernema scapterisci (alternative name) (742), Steinernema spp. (alternative name) (742), Trichogramma spp. (alternative name) (826), Typhlodromus occidentalis (alternative name) (844) and Verticillium lecanii (alternative name) (848),
a soil sterilant selected from the group of substances consisting of iodomethane (IUPAC name) (542) and methyl bromide (537),
a chemosterilant selected from the group of substances consisting of apholate [CCN], bisazir (alternative name) [CCN], busulfan (alternative name) [CCN], diflubenzuron (250), dimatif (alternative name) [CCN], hemel [CCN], hempa [CCN], metepa [CCN], methiotepa [CCN], methyl apholate [CCN], morzid [CCN], penfluoron (alternative name) [CCN], tepa [CCN], thiohempa (alternative name) [CCN], thiotepa (alternative name) [CCN], tretamine (alternative name) [CCN] and uredepa (alternative name) [CCN],
an insect pheromone selected from the group of substances consisting of (E)-dec-5-en-1-yl acetate with (E)-dec-5-en-1-ol (IUPAC name) (222), (E)-tridec-4-en-1-yl acetate (IUPAC name) (829), (E)-6-methylhept-2-en-4-ol (IUPAC name) (541), (E,Z)-tetradeca-4,10-dien-1-yl acetate (IUPAC name) (779), (Z)-dodec-7-en-1-yl acetate (IUPAC name) (285), (Z)-hexadec-11-enal (IUPAC name) (436), (Z)-hexadec-11-en-1-yl acetate (IUPAC name) (437), (Z)-hexadec-13-en-11-yn-1-yl acetate (IUPAC name) (438), (Z)-icos-13-en-10-one (IUPAC name) (448), (Z)-tetradec-7-en-1-al (IUPAC name) (782), (Z)-tetradec-9-en-1-ol (IUPAC name) (783), (Z)-tetradec-9-en-1-yl acetate (IUPAC name) (784), (7E,9Z)-dodeca-7,9-dien-1-yl acetate (IUPAC name) (283), (9Z,11E)-tetradeca-9,11-dien-1-yl acetate (IUPAC name) (780), (9Z,12E)-tetradeca-9,12-dien-1-yl acetate (IUPAC name) (781), 14-methyloctadec-1-ene (IUPAC name) (545), 4-methylnonan-5-ol with 4-methylnonan-5-one (IUPAC name) (544), alpha-multistriatin (alternative name) [CCN], brevicomin (alternative name) [CCN], codlelure (alternative name) [CCN], codlemone (alternative name) (167), cuelure (alternative name) (179), disparlure (277), dodec-8-en-1-yl acetate (IUPAC name) (286), dodec-9-en-1-yl acetate (IUPAC name) (287), dodeca-8,10-dien-1-yl acetate (IUPAC name) (284), dominicalure (alternative name) [CCN], ethyl 4-methyloctanoate (IUPAC name) (317), eugenol (alternative name) [CCN], frontalin (alternative name) [CCN], gossyplure (alternative name) (420), grandlure (421), grandlure I (alternative name) (421), grandlure II (alternative name) (421), grandlure III (alternative name) (421), grandlure IV (alternative name) (421), hexylure [CCN], ipsdienol (alternative name) [CCN], ipsenol (alternative name) [CCN], japonilure (alternative name) (481), lineatin (alternative name) [CCN], litlure (alternative name) [CCN], looplure (alternative name) [CCN], medlure [CCN], megatomoic acid (alternative name) [CCN], methyl eugenol (alternative name) (540), muscalure (563), octadeca-2,13-dien-1-yl acetate (IUPAC name) (588), octadeca-3,13-dien-1-yl acetate (IUPAC name) (589), orfralure (alternative name) [CCN], oryctalure (alternative name) (317), ostramone (alternative name) [CCN], siglure [CCN], sordidin (alternative name) (736), sulcatol (alternative name) [CCN], tetradec-11-en-1-yl acetate (IUPAC name) (785), trimedlure (839), trimedlure A (alternative name) (839), trimedlure B₁ (alternative name) (839), trimedlure B₂ (alternative name) (839), trimedlure C (alternative name) (839) and trunc-call (alternative name) [CCN],
an insect repellent selected from the group of substances consisting of 2-(octylthio)-ethanol (IUPAC name) (591), butopyronoxyl (933), butoxy(polypropylene glycol) (936), dibutyl adipate (IUPAC name) (1046), dibutyl phthalate (1047), dibutyl succinate (IUPAC name) (1048), diethyltoluamide [CCN], dimethyl carbate [CCN], dimethyl phthalate [CCN], ethyl hexanediol (1137), hexamide [CCN], methoquin-butyl (1276), methylneodecanamide [CCN], oxamate [CCN] and picaridin [CCN],
an insecticide selected from the group of substances consisting of 1,1-dichloro-1-nitroethane (IUPAC/Chemical Abstracts name) (1058), 1,1-dichloro-2,2-bis(4-ethylphenyl)-ethane (IUPAC name) (1056), 1,2-dichloropropane (IUPAC/Chemical Abstracts name) (1062), 1,2-dichloropropane with 1,3-dichloropropene (IUPAC name) (1063), 1-bromo-2-chloroethane (IUPAC/Chemical Abstracts name) (916), 2,2,2-trichloro-1-(3,4-dichloro-phenyl)ethyl acetate (IUPAC name) (1451), 2,2-dichlorovinyl 2-ethylsulfinylethyl methyl phosphate (IUPAC name) (1066), 2-(1,3-dithiolan-2-yl)phenyl dimethylcarbamate (IUPAC/Chemical Abstracts name) (1109), 2-(2-butoxyethoxy)ethyl thiocyanate (IUPAC/Chemical Abstracts name) (935), 2-(4,5-dimethyl-1,3-dioxolan-2-yl)phenyl methylcarbamate (IUPAC/Chemical Abstracts name) (1084), 2-(4-chloro-3,5-xylyloxy)ethanol (IUPAC name) (986), 2-chlorovinyl diethyl phosphate (IUPAC name) (984), 2-imidazolidone (IUPAC name) (1225), 2-isovalerylindan-1,3-dione (IUPAC name) (1246), 2-methyl(prop-2-ynyl)aminophenyl methylcarbamate (IUPAC name) (1284), 2-thiocyanatoethyl laurate (IUPAC name) (1433), 3-bromo-1-chloroprop-1-ene (IUPAC name) (917), 3-methyl-1-phenylpyrazol-5-yl dimethyl-carbamate (IUPAC name) (1283), 4-methyl(prop-2-ynyl)amino-3,5-xylyl methylcarbamate (IUPAC name) (1285), 5,5-dimethyl-3-oxocyclohex-1-enyl dimethylcarbamate (IUPAC name) (1085), abamectin (1), acephate (2), acetamiprid (4), acethion (alternative name) [CCN], acetoprole [CCN], acrinathrin (9), acrylonitrile (IUPAC name) (861), alanycarb (15), aldicarb (16), aldoxycarb (863), aldrin (864), allethrin (17), allosamidin (alternative name) [CCN], allyxycarb (866), alpha-cypermethrin (202), alpha-ecdysone (alternative name) [CCN], aluminium phosphide (640), amidithion (870), amidothioate (872), aminocarb (873), amiton (875), amiton hydrogen oxalate (875), amitraz (24), anabasine (877), athidathion (883), AVI 382 (compound code), AZ 60541 (compound code), azadirachtin (alternative name) (41), azamethiphos (42), azinphos-ethyl (44), azinphos-methyl (45), azothoate (889), Bacillus thuringiensis delta endotoxins (alternative name) (52), barium hexafluorosilicate (alternative name) [CCN], barium polysulfide (IUPAC/Chemical Abstracts name) (892), barthrin [CCN], BAS 320 I (compound code), Bayer 22/190 (development code) (893), Bayer 22408 (development code) (894), bendiocarb (58), benfuracarb (60), bensultap (66), beta-cyfluthrin (194), beta-cypermethrin (203), bifenthrin (76), bioallethrin (78), bioallethrin S-cyclopentenyl isomer (alternative name) (79), bioethanomethrin [CCN], biopermethrin (908), bioresmethrin (80), bis(2-chloroethyl)ether (IUPAC name) (909), bistrifluoron (83), borax (86), brofenvalerate (alternative name), bromfenvinfos (914), bromocyclen (918), bromo-DDT (alternative name) [CCN], bromophos (920), bromophos-ethyl (921), bufencarb (924), buprofezin (99), butacarb (926), butathiofos (927), butocarboxim (103), butonate (932), butoxycarboxim (104), butylpyridaben (alternative name), cadusafos (109), calcium arsenate [CCN], calcium cyamide (444), calcium polysulfide (IUPAC name) (111), camphechlor (941), carbanolate (943), carbaryl (115), carbofuran (118), carbon disulfide (IUPAC/Chemical Abstracts name) (945), carbon tetrachloride (IUPAC name) (946), carbophenothion (947), carbosulfan (119), cartap (123), cartap hydrochloride (123), cevadine (alternative name) (725), chlorbicyclen (960), chlordane (128), chlordecone (963), chlordimeform (964), chlordimeform hydrochloride (964), chlorethoxyfos (129), chlorfenapyr (130), chlorfenvinphos (131), chlorfluazuron (132), chlormephos (136), chloroform [CCN], chloropicrin (141), chlorphoxim (989), chlorprazophos (990), chlorpyrifos (145), chlorpyrifos-methyl (146), chlorthiophos (994), chromafenozide (150), cinerin I (696), cinerin II (696), cinerins (696), cis-resmethrin (alternative name), cismethrin (80), clocythrin (alternative name), cloethocarb (999), closantel (alternative name) [CCN], clothianidin (165), copper acetoarsenite [CCN], copper arsenate [CCN], copper oleate [CCN], coumaphos (174), coumithoate (1006), crotamiton (alternative name) [CCN], crotoxyphos (1010), crufomate (1011), cryolite (alternative name) (177), CS 708 (development code) (1012), cyanofenphos (1019), cyanophos (184), cyanthoate (1020), cyclethrin [CCN], cycloprothrin (188), cyfluthrin (193), cyhalothrin (196), cypermethrin (201), cyphenothrin (206), cyromazine (209), cythioate (alternative name) [CCN], d-limonene (alternative name) [CCN], d-tetramethrin (alternative name) (788), DAEP (1031), dazomet (216), DDT (219), decarbofuran (1034), deltamethrin (223), demephion (1037), demephion-O (1037), demephion-S (1037), demeton (1038), demeton-methyl (224), demeton-O (1038), demeton-O-methyl (224), demeton-S (1038), demeton-5-methyl (224), demeton-5-methylsulphon (1039), diafenthiuron (226), dialifos (1042), diamidafos (1044), diazinon (227), dicapthon (1050), dichlofenthion (1051), dichlorvos (236), dicliphos (alternative name), dicresyl (alternative name) [CCN], dicrotophos (243), dicyclanil (244), dieldrin (1070), diethyl 5-methylpyrazol-3-yl phosphate (IUPAC name) (1076), diflubenzuron (250), dilor (alternative name) [CCN], dimefluthrin [CCN], dimefox (1081), dimetan (1085), dimethoate (262), dimethrin (1083), dimethylvinphos (265), dimetilan (1086), dinex (1089), dinex-diclexine (1089), dinoprop (1093), dinosam (1094), dinoseb (1095), dinotefuran (271), diofenolan (1099), dioxabenzofos (1100), dioxacarb (1101), dioxathion (1102), disulfoton (278), dithicrofos (1108), DNOC (282), doramectin (alternative name) [CCN], DSP (1115), ecdysterone (alternative name) [CCN], EI 1642 (development code) (1118), emamectin (291), emamectin benzoate (291), EMPC (1120), empenthrin (292), endosulfan (294), endothion (1121), endrin (1122), EPBP (1123), EPN (297), epofenonane (1124), eprinomectin (alternative name) [CCN], esfenvalerate (302), etaphos (alternative name) [CCN], ethiofencarb (308), ethion (309), ethiprole (310), ethoate-methyl (1134), ethoprophos (312), ethyl formate (IUPAC name) [CCN], ethyl-DDD (alternative name) (1056), ethylene dibromide (316), ethylene dichloride (chemical name) (1136), ethylene oxide [CCN], etofenprox (319), etrimfos (1142), EXD (1143), famphur (323), fenamiphos (326), fenazaflor (1147), fenchlorphos (1148), fenethacarb (1149), fenfluthrin (1150), fenitrothion (335), fenobucarb (336), fenoxacrim (1153), fenoxycarb (340), fenpirithrin (1155), fenpropathrin (342), fenpyrad (alternative name), fensulfothion (1158), fenthion (346), fenthion-ethyl [CCN], fenvalerate (349), fipronil (354), flonicamid (358), flucofuron (1168), flucycloxuron (366), flucythrinate (367), fluenetil (1169), flufenerim [CCN], flufenoxuron (370), flufenprox (1171), flumethrin (372), fluvalinate (1184), FMC 1137 (development code) (1185), fonofos (1191), formetanate (405), formetanate hydrochloride (405), formothion (1192), formparanate (1193), fosmethilan (1194), fospirate (1195), fosthiazate (408), fosthietan (1196), furathiocarb (412), furethrin (1200), gamma-cyhalothrin (197), gamma-HCH (430), guazatine (422), guazatine acetates (422), GY-81 (development code) (423), halfenprox (424), halofenozide (425), HCH (430), HEOD (1070), heptachlor (1211), heptenophos (432), heterophos [CCN], hexaflumuron (439), HHDN (864), hydramethylnon (443), hydrogen cyamide (444), hydroprene (445), hyquincarb (1223), imidacloprid (458), imiprothrin (460), indoxacarb (465), iodomethane (IUPAC name) (542), IPSP (1229), isazofos (1231), isobenzan (1232), isocarbophos (alternative name) (473), isodrin (1235), isofenphos (1236), isolane (1237), isoprocarb (472), isopropyl O-(methoxyaminothiophosphoryl)salicylate (IUPAC name) (473), isoprothiolane (474), isothioate (1244), isoxathion (480), ivermectin (alternative name) [CCN], jasmolin I (696), jasmolin II (696), jodfenphos (1248), juvenile hormone I (alternative name) [CCN], juvenile hormone II (alternative name) [CCN], juvenile hormone III (alternative name) [CCN], kelevan (1249), kinoprene (484), lambda-cyhalothrin (198), lead arsenate [CCN], leptophos (1250), lindane (430), lirimfos (1251), lufenuron (490), lythidathion (1253), m-cumenyl methylcarbamate (IUPAC name) (1014), magnesium phosphide (IUPAC name) (640), malathion (492), malonoben (1254), mazidox (1255), mecarbam (502), mecarphon (1258), menazon (1260), mephosfolan (1261), mercurous chloride (513), mesulfenfos (1263), metam (519), metam-potassium (alternative name) (519), metam-sodium (519), methacrifos (1266), methamidophos (527), methanesulfonyl fluoride (IUPAC/Chemical Abstracts name) (1268), methidathion (529), methiocarb (530), methocrotophos (1273), methomyl (531), methoprene (532), methoquin-butyl (1276), methothrin (alternative name) (533), methoxychlor (534), methoxyfenozide (535), methyl bromide (537), methyl isothiocyanate (543), methylchloroform (alternative name) [CCN], methylene chloride [CCN], metofluthrin [CCN], metolcarb (550), metoxadiazone (1288), mevinphos (556), mexacarbate (1290), milbemectin (557), milbemycin oxime (alternative name) [CCN], mipafox (1293), mirex (1294), monocrotophos (561), morphothion (1300), moxidectin (alternative name) [CCN], naftalofos (alternative name) [CCN], naled (567), naphthalene (IUPAC/Chemical Abstracts name) (1303), NC-170 (development code) (1306), NC-184 (compound code), nicotine (578), nicotine sulfate (578), nifluridide (1309), nitenpyram (579), nithiazine (1311), nitrilacarb (1313), nitrilacarb 1:1 zinc chloride complex (1313), NNI-0101 (compound code), NNI-0250 (compound code), nornicotine (traditional name) (1319), novaluron (585), noviflumuron (586), O-2,5-dichloro-4-iodophenyl O-ethyl ethylphosphonothioate (IUPAC name) (1057), O,O-diethyl O-4-methyl-2-oxo-2H-chromen-7-yl phosphorothioate (IUPAC name) (1074), O,O-diethyl O-6-methyl-2-propylpyrimidin-4-yl phosphorothioate (IUPAC name) (1075), O,O,O′,O′-tetrapropyl dithiopyrophosphate (IUPAC name) (1424), oleic acid (IUPAC name) (593), omethoate (594), oxamyl (602), oxydemeton-methyl (609), oxydeprofos (1324), oxydisulfoton (1325), pp′-DDT (219), para-dichlorobenzene [CCN], parathion (615), parathion-methyl (616), penfluoron (alternative name) [CCN], pentachlorophenol (623), pentachlorophenyl laurate (IUPAC name) (623), permethrin (626), petroleum oils (alternative name) (628), PH 60-38 (development code) (1328), phenkapton (1330), phenothrin (630), phenthoate (631), phorate (636), phosalone (637), phosfolan (1338), phosmet (638), phosnichlor (1339), phosphamidon (639), phosphine (IUPAC name) (640), phoxim (642), phoxim-methyl (1340), pirimetaphos (1344), pirimicarb (651), pirimiphos-ethyl (1345), pirimiphos-methyl (652), polychlorodicyclopentadiene isomers (IUPAC name) (1346), polychloroterpenes (traditional name) (1347), potassium arsenite [CCN], potassium thiocyanate [CCN], prallethrin (655), precocene I (alternative name) [CCN], precocene II (alternative name) [CCN], precocene III (alternative name) [CCN], primidophos (1349), profenofos (662), profluthrin [CCN], promacyl (1354), promecarb (1355), propaphos (1356), propetamphos (673), propoxur (678), prothidathion (1360), prothiofos (686), prothoate (1362), protrifenbute [CCN], pymetrozine (688), pyraclofos (689), pyrazophos (693), pyresmethrin (1367), pyrethrin I (696), pyrethrin II (696), pyrethrins (696), pyridaben (699), pyridalyl (700), pyridaphenthion (701), pyrimidifen (706), pyrimitate (1370), pyriproxyfen (708), quassia (alternative name) [CCN], quinalphos (711), quinalphos-methyl (1376), quinothion (1380), quintiofos (1381), R-1492 (development code) (1382), rafoxanide (alternative name) [CCN], resmethrin (719), rotenone (722), RU 15525 (development code) (723), RU 25475 (development code) (1386), ryania (alternative name) (1387), ryanodine (traditional name) (1387), sabadilla (alternative name) (725), schradan (1389), sebufos (alternative name), selamectin (alternative name) [CCN], SI-0009 (compound code), silafluofen (728), SN 72129 (development code) (1397), sodium arsenite [CCN], sodium cyamide (444), sodium fluoride (IUPAC/Chemical Abstracts name) (1399), sodium hexafluorosilicate (1400), sodium pentachlorophenoxide (623), sodium selenate (IUPAC name) (1401), sodium thiocyanate [CCN], sophamide (1402), spinosad (737), spiromesifen (739), sulcofuron (746), sulcofuron-sodium (746), sulfluramid (750), sulfotep (753), sulfuryl fluoride (756), sulprofos (1408), tar oils (alternative name) (758), tau-fluvalinate (398), tazimcarb (1412), TDE (1414), tebufenozide (762), tebufenpyrad (763), tebupirimfos (764), teflubenzuron (768), tefluthrin (769), temephos (770), TEPP (1417), terallethrin (1418), terbam (alternative name), terbufos (773), tetrachloroethane [CCN], tetrachlorvinphos (777), tetramethrin (787), theta-cypermethrin (204), thiacloprid (791), thiafenox (alternative name), thiamethoxam (792), thicrofos (1428), thiocarboxime (1431), thiocyclam (798), thiocyclam hydrogen oxalate (798), thiodicarb (799), thiofanox (800), thiometon (801), thionazin (1434), thiosultap (803), thiosultap-sodium (803), thuringiensin (alternative name) [CCN], tolfenpyrad (809), tralomethrin (812), transfluthrin (813), transpermethrin (1440), triamiphos (1441), triazamate (818), triazophos (820), triazuron (alternative name), trichlorfon (824), trichlormetaphos-3 (alternative name) [CCN], trichloronat (1452), trifenofos (1455), triflumuron (835), trimethacarb (840), triprene (1459), vamidothion (847), vaniliprole [CCN], veratridine (alternative name) (725), veratrine (alternative name) (725), XMC (853), xylylcarb (854), YI-5302 (compound code), zeta-cypermethrin (205), zetamethrin (alternative name), zinc phosphide (640), zolaprofos (1469) and ZXI 8901 (development code) (858),
a molluscicide selected from the group of substances consisting of bis(tributyltin)oxide (IUPAC name) (913), bromoacetamide [CCN], calcium arsenate [CCN], cloethocarb (999), copper acetoarsenite [CCN], copper sulfate (172), fentin (347), ferric phosphate (IUPAC name) (352), metaldehyde (518), methiocarb (530), niclosamide (576), niclosamide-olamine (576), pentachlorophenol (623), sodium pentachlorophenoxide (623), tazimcarb (1412), thiodicarb (799), tributyltin oxide (913), trifenmorph (1454), trimethacarb (840), triphenyltin acetate (IUPAC name) (347) and triphenyltin hydroxide (IUPAC name) (347),
a nematicide selected from the group of substances consisting of 1,2-dibromo-3-chloropropane (IUPAC/Chemical Abstracts name) (1045), 1,2-dichloropropane (IUPAC/Chemical Abstracts name) (1062), 1,2-dichloropropane with 1,3-dichloropropene (IUPAC name) (1063), 1,3-dichloropropene (233), 3,4-dichlorotetrahydrothiophene 1,1-dioxide (IUPAC/Chemical Abstracts name) (1065), 3-(4-chlorophenyl)-5-methylrhodanine (IUPAC name) (980), 5-methyl-6-thioxo-1,3,5-thiadiazinan-3-ylacetic acid (IUPAC name) (1286), 6-isopentenylaminopurine (alternative name) (210), abamectin (1), acetoprole [CCN], alanycarb (15), aldicarb (16), aldoxycarb (863), AZ 60541 (compound code), benclothiaz [CCN], benomyl (62), butylpyridaben (alternative name), cadusafos (109), carbofuran (118), carbon disulfide (945), carbosulfan (119), chloropicrin (141), chlorpyrifos (145), cloethocarb (999), cytokinins (alternative name) (210), dazomet (216), DBCP (1045), DCIP (218), diamidafos (1044), dichlofenthion (1051), dicliphos (alternative name), dimethoate (262), doramectin (alternative name) [CCN], emamectin (291), emamectin benzoate (291), eprinomectin (alternative name) [CCN], ethoprophos (312), ethylene dibromide (316), fenamiphos (326), fenpyrad (alternative name), fensulfothion (1158), fosthiazate (408), fosthietan (1196), furfural (alternative name) [CCN], GY-81 (development code) (423), heterophos [CCN], iodomethane (IUPAC name) (542), isamidofos (1230), isazofos (1231), ivermectin (alternative name) [CCN], kinetin (alternative name) (210), mecarphon (1258), metam (519), metam-potassium (alternative name) (519), metam-sodium (519), methyl bromide (537), methyl isothiocyanate (543), milbemycin oxime (alternative name) [CCN], moxidectin (alternative name) [CCN], Myrothecium verrucaria composition (alternative name) (565), NC-184 (compound code), oxamyl (602), phorate (636), phosphamidon (639), phosphocarb [CCN], sebufos (alternative name), selamectin (alternative name) [CCN], spinosad (737), terbam (alternative name), terbufos (773), tetrachlorothiophene (IUPAC/Chemical Abstracts name) (1422), thiafenox (alternative name), thionazin (1434), triazophos (820), triazuron (alternative name), xylenols [CCN], YI-5302 (compound code) and zeatin (alternative name) (210),
a nitrification inhibitor selected from the group of substances consisting of potassium ethylxanthate [CCN] and nitrapyrin (580),
a plant activator selected from the group of substances consisting of acibenzolar (6), acibenzolar-5-methyl (6), probenazole (658) and Reynoutria sachalinensis extract (alternative name) (720),
a rodenticide selected from the group of substances consisting of 2-isovalerylindan-1,3-dione (IUPAC name) (1246), 4-(quinoxalin-2-ylamino)benzenesulfonamide (IUPAC name) (748), alpha-chlorohydrin [CCN], aluminium phosphide (640), antu (880), arsenous oxide (882), barium carbonate (891), bisthiosemi (912), brodifacoum (89), bromadiolone (91), bromethalin (92), calcium cyamide (444), chloralose (127), chlorophacinone (140), cholecalciferol (alternative name) (850), coumachlor (1004), coumafuryl (1005), coumatetralyl (175), crimidine (1009), difenacoum (246), difethialone (249), diphacinone (273), ergocalciferol (301), flocoumafen (357), fluoroacetamide (379), flupropadine (1183), flupropadine hydrochloride (1183), gamma-HCH (430), HCH (430), hydrogen cyamide (444), iodomethane (IUPAC name) (542), lindane (430), magnesium phosphide (IUPAC name) (640), methyl bromide (537), norbormide (1318), phosacetim (1336), phosphine (IUPAC name) (640), phosphorus [CCN], pindone (1341), potassium arsenite [CCN], pyrinuron (1371), scilliroside (1390), sodium arsenite [CCN], sodium cyamide (444), sodium fluoro-acetate (735), strychnine (745), thallium sulfate [CCN], warfarin (851) and zinc phosphide (640),
a synergist selected from the group of substances consisting of 2-(2-butoxyethoxy)ethyl piperonylate (IUPAC name) (934), 5-(1,3-benzodioxol-5-yl)-3-hexylcyclohex-2-enone (IUPAC name) (903), farnesol with nerolidol (alternative name) (324), MB-599 (development code) (498), MGK 264 (development code) (296), piperonyl butoxide (649), piprotal (1343), propyl isomer (1358), S421 (development code) (724), sesamex (1393), sesasmolin (1394) and sulfoxide (1406),
an animal repellent selected from the group of substances consisting of anthraquinone (32), chloralose (127), copper naphthenate [CCN], copper oxychloride (171), diazinon (227), dicyclopentadiene (chemical name) (1069), guazatine (422), guazatine acetates (422), methiocarb (530), pyridin-4-amine (IUPAC name) (23), thiram (804), trimethacarb (840), zinc naphthenate [CCN] and ziram (856),
a virucide selected from the group of substances consisting of imanin (alternative name) [CCN] and ribavirin (alternative name) [CCN],
and a wound protectant selected from the group of substances consisting of mercuric oxide (512), octhilinone (590) and thiophanate-methyl (802).

A very especially preferred embodiment of the subject-matter {1.1.20} of the invention is {1.1.20.2} a pesticidal composition comprising a mixture consisting of at least two substances, namely one compound (A) and at least one compound (B), as active ingredient and at least one auxiliary, wherein the compound (A) is the compound of formula (A-20) and the compound (B) is a compound selected from the group of substances consisting of abamectin (1), cyromazine (209), diafenthiuron (226), diazinon (227), emamectin benzoate (291), fenoxycarb (340), fosthiazate (408), lambda-cyhalothrin (198), lufenuron (490), methidathion (529), profenofos (662), pymetrozine (688), tefluthrin (769) and thiamethoxam (792).

The compound of formula (A-20) is known, for example, from the PCT Application WO-03/015519.

A preferred embodiment of the subject-matter {1.1} of the invention is {1.1.21} a pesticidal composition comprising a mixture consisting of at least two substances, namely one compound (A) and at least one compound (B), as active ingredient and at least one auxiliary, wherein the compound (A) is the compound of formula (A-21) 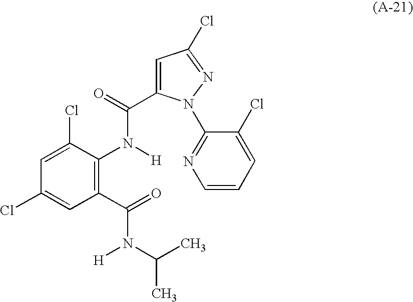
and the compound (B) is a compound selected from the group of substances consisting of an adjuvant, an acaricide, an algicide, an anthelmintic, an avicide, a bactericide, a biological agent, a soil sterilant, a chemosterilant, an insect pheromone, an insect repellent, an insecticide, a molluscicide, a nematicide, a nitrification inhibitor, a plant activator, a rodenticide, a synergist, an animal repellent, a virucide and a wound protectant.

An especially preferred embodiment of the subject-matter {1.1.21} of the invention is {1.1.21.1} a pesticidal composition comprising a mixture consisting of at least two substances, namely one compound (A) and at least one compound (B), as active ingredient and at least one auxiliary, wherein the compound (A) is the compound of formula (A-21) and the compound (B) is a compound selected from the group of substances consisting of
an adjuvant selected from the group of substances consisting of petroleum oils (alternative name) (628),
an acaricide selected from the group of substances consisting of 1,1-bis(4-chlorophenyl)-2-ethoxyethanol (IUPAC name) (910), 2,4-dichlorophenyl benzenesulfonate (IUPAC/Chemical Abstracts name) (1059), 2-fluoro-N-methyl-N-1-naphthylacetamide (IUPAC name) (1295), 4-chlorophenyl phenyl sulfone (IUPAC name) (981), abamectin (1), acequinocyl (3), acetoprole [CCN], acrinathrin (9), aldicarb (16), aldoxycarb (863), alpha-cypermethrin (202), amidithion (870), amidoflumet [CCN], amidothioate (872), amiton (875), amiton hydrogen oxalate (875), amitraz (24), aramite (881), arsenous oxide (882), AVI 382 (compound code), AZ 60541 (compound code), azinphos-ethyl (44), azinphos-methyl (45), azobenzene (IUPAC name) (888), azocyclotin (46), azothoate (889), benomyl (62), benoxafos (alternative name) [CCN], benzoximate (71), benzyl benzoate (IUPAC name) [CCN], bifenazate (74), bifenthrin (76), binapacryl (907), brofenvalerate (alternative name), bromocyclen (918), bromophos (920), bromophos-ethyl (921), bromopropylate (94), buprofezin (99), butocarboxim (103), butoxycarboxim (104), butylpyridaben (alternative name), calcium polysulfide (IUPAC name) (111), camphechlor (941), carbanolate (943), carbaryl (115), carbofuran (118), carbophenothion (947), CGA 50'439 (development code) (125), chinomethionat (126), chlorbenside (959), chlordimeform (964), chlordimeform hydrochloride (964), chlorfenapyr (130), chlorfenethol (968), chlorfenson (970), chlorfensulphide (971), chlorfenvinphos (131), chlorobenzilate (975), chloromebuform (977), chloromethiuron (978), chloropropylate (983), chlorpyrifos (145), chlorpyrifos-methyl (146), chlorthiophos (994), cinerin I (696), cinerin II (696), cinerins (696), clofentezine (158), closantel (alternative name) [CCN], coumaphos (174), crotamiton (alternative name) [CCN], crotoxyphos (1010), cufraneb (1013), cyanthoate (1020), cyhalothrin (196), cyhexatin (199), cypermethrin (201), DCPM (1032), DDT (219), demephion (1037), demephion-O (1037), demephion-S (1037), demeton (1038), demeton-methyl (224), demeton-O (1038), demeton-O-methyl (224), demeton-S (1038), demeton-5-methyl (224), demeton-5-methylsulphon (1039), diafenthiuron (226), dialifos (1042), diazinon (227), dichlofluanid (230), dichlorvos (236), dicliphos (alternative name), dicofol (242), dicrotophos (243), dienochlor (1071), dimefox (1081), dimethoate (262), dinactin (alternative name) (653), dinex (1089), dinex-diclexine (1089), dinobuton (269), dinocap (270), dinocap-4 [CCN], dinocap-6 [CCN], dinocton (1090), dinopenton (1092), dinosulfon (1097), dinoterbon (1098), dioxathion (1102), diphenyl sulfone (IUPAC name) (1103), disulfuram (alternative name) [CCN], disulfoton (278), DNOC (282), dofenapyn (1113), doramectin (alternative name) [CCN], endosulfan (294), endothion (1121), EPN (297), eprinomectin (alternative name) [CCN], ethion (309), ethoate-methyl (1134), etoxazole (320), etrimfos (1142), fenazaflor (1147), fenazaquin (328), fenbutatin oxide (330), fenothiocarb (337), fenpropathrin (342), fenpyrad (alternative name), fenpyroximate (345), fenson (1157), fentrifanil (1161), fenvalerate (349), fipronil (354), fluacrypyrim (360), fluazuron (1166), flubenzimine (1167), flucycloxuron (366), flucythrinate (367), fluenetil (1169), flufenoxuron (370), flumethrin (372), fluorbenside (1174), fluvalinate (1184), FMC 1137 (development code) (1185), formetanate (405), formetanate hydrochloride (405), formothion (1192), formparanate (1193), gamma-HCH (430), glyodin (1205), halfenprox (424), heptenophos (432), hexadecyl cyclopropanecarboxylate (IUPAC/Chemical Abstracts name) (1216), hexythiazox (441), iodomethane (IUPAC name) (542), isocarbophos (alternative name) (473), isopropyl O-(methoxyaminothiophosphoryl)salicylate (IUPAC name) (473), ivermectin (alternative name) [CCN], jasmolin I (696), jasmolin II (696), jodfenphos (1248), lindane (430), lufenuron (490), malathion (492), malonoben (1254), mecarbam (502), mephosfolan (1261), mesulfen (alternative name) [CCN], methacrifos (1266), methamidophos (527), methidathion (529), methiocarb (530), methomyl (531), methyl bromide (537), metolcarb (550), mevinphos (556), mexacarbate (1290), milbemectin (557), milbemycin oxime (alternative name) [CCN], mipafox (1293), monocrotophos (561), morphothion (1300), moxidectin (alternative name) [CCN], naled (567), NC-184 (compound code), nifluridide (1309), nikkomycins (alternative name) [CCN], nitrilacarb (1313), nitrilacarb 1:1 zinc chloride complex (1313), NNI-0101 (compound code), NNI-0250 (compound code), omethoate (594), oxamyl (602), oxydeprofos (1324), oxydisulfoton (1325), pp′-DDT (219), parathion (615), permethrin (626), petroleum oils (alternative name) (628), phenkapton (1330), phenthoate (631), phorate (636), phosalone (637), phosfolan (1338), phosmet (638), phosphamidon (639), phoxim (642), pirimiphos-methyl (652), polychloroterpenes (traditional name) (1347), polynactins (alternative name) (653), proclonol (1350), profenofos (662), promacyl (1354), propargite (671), propetamphos (673), propoxur (678), prothidathion (1360), prothoate (1362), pyrethrin I (696), pyrethrin II (696), pyrethrins (696), pyridaben (699), pyridaphenthion (701), pyrimidifen (706), pyrimitate (1370), quinalphos (711), quintiofos (1381), R-1492 (development code) (1382), RA-17 (development code) (1383), rotenone (722), schradan (1389), sebufos (alternative name), selamectin (alternative name) [CCN], SI-0009 (compound code), sophamide (1402), spirodiclofen (738), spiromesifen (739), SSI-121 (development code) (1404), sulfuram (alternative name) [CCN], sulfluramid (750), sulfotep (753), sulfur (754), SZI-121 (development code) (757), tau-fluvalinate (398), tebufenpyrad (763), TEPP (1417), terbam (alternative name), tetrachlorvinphos (777), tetradifon (786), tetranactin (alternative name) (653), tetrasul (1425), thiafenox (alternative name), thiocarboxime (1431), thiofanox (800), thiometon (801), thioquinox (1436), thuringiensin (alternative name) [CCN], triamiphos (1441), triarathene (1443), triazophos (820), triazuron (alternative name), trichlorfon (824), trifenofos (1455), trinactin (alternative name) (653), vamidothion (847), vaniliprole [CCN] and YI-5302 (compound code),
an algicide selected from the group of substances consisting of bethoxazin [CCN], copper dioctanoate (IUPAC name) (170), copper sulfate (172), cybutryne [CCN], dichlone (1052), dichlorophen (232), endothal (295), fentin (347), hydrated lime [CCN], nabam (566), quinoclamine (714), quinonamid (1379), simazine (730), triphenyltin acetate (IUPAC name) (347) and triphenyltin hydroxide (IUPAC name) (347),
an anthelmintic selected from the group of substances consisting of abamectin (1), crufomate (1011), doramectin (alternative name) [CCN], emamectin (291), emamectin benzoate (291), eprinomectin (alternative name) [CCN], ivermectin (alternative name) [CCN], milbemycin oxime (alternative name) [CCN], moxidectin (alternative name) [CCN], piperazine [CCN], selamectin (alternative name) [CCN], spinosad (737) and thiophanate (1435),
an avicide selected from the group of substances consisting of chloralose (127), endrin (1122), fenthion (346), pyridin-4-amine (IUPAC name) (23) and strychnine (745),
a bactericide selected from the group of substances consisting of 1-hydroxy-1H-pyridine-2-thione (IUPAC name) (1222), 4-(quinoxalin-2-ylamino)benzenesulfonamide (IUPAC name) (748), 8-hydroxyquinoline sulfate (446), bronopol (97), copper dioctanoate (IUPAC name) (170), copper hydroxide (IUPAC name) (169), cresol [CCN], dichlorophen (232), dipyrithione (1105), dodicin (1112), fenaminosulf (1144), formaldehyde (404), hydrargaphen (alternative name) [CCN], kasugamycin (483), kasugamycin hydrochloride hydrate (483), nickel bis(dimethyldithiocarbamate) (IUPAC name) (1308), nitrapyrin (580), octhilinone (590), oxolinic acid (606), oxytetracycline (611), potassium hydroxyquinoline sulfate (446), probenazole (658), streptomycin (744), streptomycin sesquisulfate (744), tecloftalam (766) and thiomersal (alternative name) [CCN],
a biological agent selected from the group of substances consisting of Adoxophyes orana GV (alternative name) (12), Agrobacterium radiobacter (alternative name) (13), Amblyseius spp. (alternative name) (19), Anagrapha falcifera NPV (alternative name) (28), Anagrus atomus (alternative name) (29), Aphelinus abdominalis (alternative name) (33), Aphidius colemani (alternative name) (34), Aphidoletes aphidimyza (alternative name) (35), Autographa californica NPV (alternative name) (38), Bacillus firmus (alternative name) (48), Bacillus sphaericus Neide (scientific name) (49), Bacillus thuringiensis Berliner (scientific name) (51), Bacillus thuringiensis subsp. aizawai (scientific name) (51), Bacillus thuringiensis subsp. israelensis (scientific name) (51), Bacillus thuringiensis subsp. japonensis (scientific name) (51), Bacillus thuringiensis subsp. kurstaki (scientific name) (51), Bacillus thuringiensis subsp. tenebrionis (scientific name) (51), Beauveria bassiana (alternative name) (53), Beauveria brongniartii (alternative name) (54), Chrysoperla carnea (alternative name) (151), Cryptolaemus montrouzieri (alternative name) (178), Cydia pomonella GV (alternative name) (191), Dacnusa sibirica (alternative name) (212), Diglyphus isaea (alternative name) (254), Encarsia formosa (scientific name) (293), Eretmocerus eremicus (alternative name) (300), Helicoverpa zea NPV (alternative name) (431), Heterorhabditis bacteriophora and H. megidis (alternative name) (433), Hippodamia convergens (alternative name) (442), Leptomastix dactylopii (alternative name) (488), Macrolophus caliginosus (alternative name) (491), Mamestra brassicae NPV (alternative name) (494), Metaphycus helvolus (alternative name) (522), Metarhizium anisopliae var. acridum (scientific name) (523), Metarhizium anisopliae var. anisopliae (scientific name) (523), Neodiprion sertifer NPV and N. lecontei NPV (alternative name) (575), Orius spp. (alternative name) (596), Paecilomyces fumosoroseus (alternative name) (613), Phytoseiulus persimilis (alternative name) (644), Spodoptera exigua multicapsid nuclear polyhedrosis virus (scientific name) (741), Steinernema bibionis (alternative name) (742), Steinernema carpocapsae (alternative name) (742), Steinernema feltiae (alternative name) (742), Steinernema glaseri (alternative name) (742), Steinernema riobrave (alternative name) (742), Steinernema riobravis (alternative name) (742), Steinernema scapterisci (alternative name) (742), Steinernema spp. (alternative name) (742), Trichogramma spp. (alternative name) (826), Typhlodromus occidentalis (alternative name) (844) and Verticillium lecanii (alternative name) (848),
a soil sterilant selected from the group of substances consisting of iodomethane (IUPAC name) (542) and methyl bromide (537),
a chemosterilant selected from the group of substances consisting of apholate [CCN], bisazir (alternative name) [CCN], busulfan (alternative name) [CCN], diflubenzuron (250), dimatif (alternative name) [CCN], hemel [CCN], hempa [CCN], metepa [CCN], methiotepa [CCN], methyl apholate [CCN], morzid [CCN], penfluoron (alternative name) [CCN], tepa [CCN], thiohempa (alternative name) [CCN], thiotepa (alternative name) [CCN], tretamine (alternative name) [CCN] and uredepa (alternative name) [CCN],
an insect pheromone selected from the group of substances consisting of (E)-dec-5-en-1-yl acetate with (E)-dec-5-en-1-ol (IUPAC name) (222), (E)-tridec-4-en-1-yl acetate (IUPAC name) (829), (E)-6-methylhept-2-en-4-ol (IUPAC name) (541), (E,Z)-tetradeca-4,10-dien-1-yl acetate (IUPAC name) (779), (Z)-dodec-7-en-1-yl acetate (IUPAC name) (285), (Z)-hexadec-11-enal (IUPAC name) (436), (Z)-hexadec-11-en-1-yl acetate (IUPAC name) (437), (Z)-hexadec-13-en-11-yn-1-yl acetate (IUPAC name) (438), (Z)-icos-13-en-10-one (IUPAC name) (448), (Z)-tetradec-7-en-1-al (IUPAC name) (782), (Z)-tetradec-9-en-1-ol (IUPAC name) (783), (Z)-tetradec-9-en-1-yl acetate (IUPAC name) (784), (7E,9Z)-dodeca-7,9-dien-1-yl acetate (IUPAC name) (283), (9Z,11E)-tetradeca-9,11-dien-1-yl acetate (IUPAC name) (780), (9Z,12E)-tetradeca-9,12-dien-1-yl acetate (IUPAC name) (781), 14-methyloctadec-1-ene (IUPAC name) (545), 4-methylnonan-5-ol with 4-methylnonan-5-one (IUPAC name) (544), alpha-multistriatin (alternative name) [CCN], brevicomin (alternative name) [CCN], codlelure (alternative name) [CCN], codlemone (alternative name) (167), cuelure (alternative name) (179), disparlure (277), dodec-8-en-1-yl acetate (IUPAC name) (286), dodec-9-en-1-yl acetate (IUPAC name) (287), dodeca-8,10-dien-1-yl acetate (IUPAC name) (284), dominicalure (alternative name) [CCN], ethyl 4-methyloctanoate (IUPAC name) (317), eugenol (alternative name) [CCN], frontalin (alternative name) [CCN], gossyplure (alternative name) (420), grandlure (421), grandlure I (alternative name) (421), grandlure II (alternative name) (421), grandlure III (alternative name) (421), grandlure IV (alternative name) (421), hexylure [CCN], ipsdienol (alternative name) [CCN], ipsenol (alternative name) [CCN], japonilure (alternative name) (481), lineatin (alternative name) [CCN], litlure (alternative name) [CCN], looplure (alternative name) [CCN], medlure [CCN], megatomoic acid (alternative name) [CCN], methyl eugenol (alternative name) (540), muscalure (563), octadeca-2,13-dien-1-yl acetate (IUPAC name) (588), octadeca-3,13-dien-1-yl acetate (IUPAC name) (589), orfralure (alternative name) [CCN], oryctalure (alternative name) (317), ostramone (alternative name) [CCN], siglure [CCN], sordidin (alternative name) (736), sulcatol (alternative name) [CCN], tetradec-11-en-1-yl acetate (IUPAC name) (785), trimedlure (839), trimedlure A (alternative name) (839), trimedlure B₁ (alternative name) (839), trimedlure B₂ (alternative name) (839), trimedlure C (alternative name) (839) and trunc-call (alternative name) [CCN],
an insect repellent selected from the group of substances consisting of 2-(octylthio)-ethanol (IUPAC name) (591), butopyronoxyl (933), butoxy(polypropylene glycol) (936), dibutyl adipate (IUPAC name) (1046), dibutyl phthalate (1047), dibutyl succinate (IUPAC name) (1048), diethyltoluamide [CCN], dimethyl carbate [CCN], dimethyl phthalate [CCN], ethyl hexanediol (1137), hexamide [CCN], methoquin-butyl (1276), methylneodecanamide [CCN], oxamate [CCN] and picaridin [CCN],
an insecticide selected from the group of substances consisting of 1,1-dichloro-1-nitroethane (IUPAC/Chemical Abstracts name) (1058), 1,1-dichloro-2,2-bis(4-ethylphenyl)-ethane (IUPAC name) (1056), 1,2-dichloropropane (IUPAC/Chemical Abstracts name) (1062), 1,2-dichloropropane with 1,3-dichloropropene (IUPAC name) (1063), 1-bromo-2-chloroethane (IUPAC/Chemical Abstracts name) (916), 2,2,2-trichloro-1-(3,4-dichloro-phenyl)ethyl acetate (IUPAC name) (1451), 2,2-dichlorovinyl 2-ethylsulfinylethyl methyl phosphate (IUPAC name) (1066), 2-(1,3-dithiolan-2-yl)phenyl dimethylcarbamate (IUPAC/Chemical Abstracts name) (1109), 2-(2-butoxyethoxy)ethyl thiocyanate (IUPAC/Chemical Abstracts name) (935), 2-(4,5-dimethyl-1,3-dioxolan-2-yl)phenyl methylcarbamate (IUPAC/Chemical Abstracts name) (1084), 2-(4-chloro-3,5-xylyloxy)ethanol (IUPAC name) (986), 2-chlorovinyl diethyl phosphate (IUPAC name) (984), 2-imidazolidone (IUPAC name) (1225), 2-isovalerylindan-1,3-dione (IUPAC name) (1246), 2-methyl(prop-2-ynyl)aminophenyl methylcarbamate (IUPAC name) (1284), 2-thiocyanatoethyl laurate (IUPAC name) (1433), 3-bromo-1-chloroprop-1-ene (IUPAC name) (917), 3-methyl-1-phenylpyrazol-5-yl dimethyl-carbamate (IUPAC name) (1283), 4-methyl(prop-2-ynyl)amino-3,5-xylyl methylcarbamate (IUPAC name) (1285), 5,5-dimethyl-3-oxocyclohex-1-enyl dimethylcarbamate (IUPAC name) (1085), abamectin (1), acephate (2), acetamiprid (4), acethion (alternative name) [CCN], acetoprole [CCN], acrinathrin (9), acrylonitrile (IUPAC name) (861), alanycarb (15), aldicarb (16), aldoxycarb (863), aldrin (864), allethrin (17), allosamidin (alternative name) [CCN], allyxycarb (866), alpha-cypermethrin (202), alpha-ecdysone (alternative name) [CCN], aluminium phosphide (640), amidithion (870), amidothioate (872), aminocarb (873), amiton (875), amiton hydrogen oxalate (875), amitraz (24), anabasine (877), athidathion (883), AVI 382 (compound code), AZ 60541 (compound code), azadirachtin (alternative name) (41), azamethiphos (42), azinphos-ethyl (44), azinphos-methyl (45), azothoate (889), Bacillus thuringiensis delta endotoxins (alternative name) (52), barium hexafluorosilicate (alternative name) [CCN], barium polysulfide (IUPAC/Chemical Abstracts name) (892), barthrin [CCN], BAS 320 I (compound code), Bayer 22/190 (development code) (893), Bayer 22408 (development code) (894), bendiocarb (58), benfuracarb (60), bensultap (66), beta-cyfluthrin (194), beta-cypermethrin (203), bifenthrin (76), bioallethrin (78), bioallethrin S-cyclopentenyl isomer (alternative name) (79), bioethanomethrin [CCN], biopermethrin (908), bioresmethrin (80), bis(2-chloroethyl)ether (IUPAC name) (909), bistrifluoron (83), borax (86), brofenvalerate (alternative name), bromfenvinfos (914), bromocyclen (918), bromo-DDT (alternative name) [CCN], bromophos (920), bromophos-ethyl (921), bufencarb (924), buprofezin (99), butacarb (926), butathiofos (927), butocarboxim (103), butonate (932), butoxycarboxim (104), butylpyridaben (alternative name), cadusafos (109), calcium arsenate [CCN], calcium cyamide (444), calcium polysulfide (IUPAC name) (111), camphechlor (941), carbanolate (943), carbaryl (115), carbofuran (118), carbon disulfide (IUPAC/Chemical Abstracts name) (945), carbon tetrachloride (IUPAC name) (946), carbophenothion (947), carbosulfan (119), cartap (123), cartap hydrochloride (123), cevadine (alternative name) (725), chlorbicyclen (960), chlordane (128), chlordecone (963), chlordimeform (964), chlordimeform hydrochloride (964), chlorethoxyfos (129), chlorfenapyr (130), chlorfenvinphos (131), chlorfluazuron (132), chlormephos (136), chloroform [CCN], chloropicrin (141), chlorphoxim (989), chlorprazophos (990), chlorpyrifos (145), chlorpyrifos-methyl (146), chlorthiophos (994), chromafenozide (150), cinerin I (696), cinerin II (696), cinerins (696), cis-resmethrin (alternative name), cismethrin (80), clocythrin (alternative name), cloethocarb (999), closantel (alternative name) [CCN], clothianidin (165), copper acetoarsenite [CCN], copper arsenate [CCN], copper oleate [CCN], coumaphos (174), coumithoate (1006), crotamiton (alternative name) [CCN], crotoxyphos (1010), crufomate (1011), cryolite (alternative name) (177), CS 708 (development code) (1012), cyanofenphos (1019), cyanophos (184), cyanthoate (1020), cyclethrin [CCN], cycloprothrin (188), cyfluthrin (193), cyhalothrin (196), cypermethrin (201), cyphenothrin (206), cyromazine (209), cythioate (alternative name) [CCN], d-limonene (alternative name) [CCN], d-tetramethrin (alternative name) (788), DAEP (1031), dazomet (216), DDT (219), decarbofuran (1034), deltamethrin (223), demephion (1037), demephion-O (1037), demephion-S (1037), demeton (1038), demeton-methyl (224), demeton-O (1038), demeton-O-methyl (224), demeton-S (1038), demeton-5-methyl (224), demeton-5-methylsulphon (1039), diafenthiuron (226), dialifos (1042), diamidafos (1044), diazinon (227), dicapthon (1050), dichlofenthion (1051), dichlorvos (236), dicliphos (alternative name), dicresyl (alternative name) [CCN], dicrotophos (243), dicyclanil (244), dieldrin (1070), diethyl 5-methylpyrazol-3-yl phosphate (IUPAC name) (1076), diflubenzuron (250), dilor (alternative name) [CCN], dimefluthrin [CCN], dimefox (1081), dimetan (1085), dimethoate (262), dimethrin (1083), dimethylvinphos (265), dimetilan (1086), dinex (1089), dinex-diclexine (1089), dinoprop (1093), dinosam (1094), dinoseb (1095), dinotefuran (271), diofenolan (1099), dioxabenzofos (1100), dioxacarb (1101), dioxathion (1102), disulfoton (278), dithicrofos (1108), DNOC (282), doramectin (alternative name) [CCN], DSP (1115), ecdysterone (alternative name) [CCN], EI 1642 (development code) (1118), emamectin (291), emamectin benzoate (291), EMPC (1120), empenthrin (292), endosulfan (294), endothion (1121), endrin (1122), EPBP (1123), EPN (297), epofenonane (1124), eprinomectin (alternative name) [CCN], esfenvalerate (302), etaphos (alternative name) [CCN], ethiofencarb (308), ethion (309), ethiprole (310), ethoate-methyl (1134), ethoprophos (312), ethyl formate (IUPAC name) [CCN], ethyl-DDD (alternative name) (1056), ethylene dibromide (316), ethylene dichloride (chemical name) (1136), ethylene oxide [CCN], etofenprox (319), etrimfos (1142), EXD (1143), famphur (323), fenamiphos (326), fenazaflor (1147), fenchlorphos (1148), fenethacarb (1149), fenfluthrin (1150), fenitrothion (335), fenobucarb (336), fenoxacrim (1153), fenoxycarb (340), fenpirithrin (1155), fenpropathrin (342), fenpyrad (alternative name), fensulfothion (1158), fenthion (346), fenthion-ethyl [CCN], fenvalerate (349), fipronil (354), flonicamid (358), flucofuron (1168), flucycloxuron (366), flucythrinate (367), fluenetil (1169), flufenerim [CCN], flufenoxuron (370), flufenprox (1171), flumethrin (372), fluvalinate (1184), FMC 1137 (development code) (1185), fonofos (1191), formetanate (405), formetanate hydrochloride (405), formothion (1192), formparanate (1193), fosmethilan (1194), fospirate (1195), fosthiazate (408), fosthietan (1196), furathiocarb (412), furethrin (1200), gamma-cyhalothrin (197), gamma-HCH (430), guazatine (422), guazatine acetates (422), GY-81 (development code) (423), halfenprox (424), halofenozide (425), HCH (430), HEOD (1070), heptachlor (1211), heptenophos (432), heterophos [CCN], hexaflumuron (439), HHDN (864), hydramethylnon (443), hydrogen cyamide (444), hydroprene (445), hyquincarb (1223), imidacloprid (458), imiprothrin (460), indoxacarb (465), iodomethane (IUPAC name) (542), IPSP (1229), isazofos (1231), isobenzan (1232), isocarbophos (alternative name) (473), isodrin (1235), isofenphos (1236), isolane (1237), isoprocarb (472), isopropyl O-(methoxyaminothiophosphoryl)salicylate (IUPAC name) (473), isoprothiolane (474), isothioate (1244), isoxathion (480), ivermectin (alternative name) [CCN], jasmolin I (696), jasmolin II (696), jodfenphos (1248), juvenile hormone I (alternative name) [CCN], juvenile hormone II (alternative name) [CCN], juvenile hormone III (alternative name) [CCN], kelevan (1249), kinoprene (484), lambda-cyhalothrin (198), lead arsenate [CCN], leptophos (1250), lindane (430), lirimfos (1251), lufenuron (490), lythidathion (1253), m-cumenyl methylcarbamate (IUPAC name) (1014), magnesium phosphide (IUPAC name) (640), malathion (492), malonoben (1254), mazidox (1255), mecarbam (502), mecarphon (1258), menazon (1260), mephosfolan (1261), mercurous chloride (513), mesulfenfos (1263), metam (519), metam-potassium (alternative name) (519), metam-sodium (519), methacrifos (1266), methamidophos (527), methanesulfonyl fluoride (IUPAC/Chemical Abstracts name) (1268), methidathion (529), methiocarb (530), methocrotophos (1273), methomyl (531), methoprene (532), methoquin-butyl (1276), methothrin (alternative name) (533), methoxychlor (534), methoxyfenozide (535), methyl bromide (537), methyl isothiocyanate (543), methylchloroform (alternative name) [CCN], methylene chloride [CCN], metofluthrin [CCN], metolcarb (550), metoxadiazone (1288), mevinphos (556), mexacarbate (1290), milbemectin (557), milbemycin oxime (alternative name) [CCN], mipafox (1293), mirex (1294), monocrotophos (561), morphothion (1300), moxidectin (alternative name) [CCN], naftalofos (alternative name) [CCN], naled (567), naphthalene (IUPAC/Chemical Abstracts name) (1303), NC-170 (development code) (1306), NC-184 (compound code), nicotine (578), nicotine sulfate (578), nifluridide (1309), nitenpyram (579), nithiazine (1311), nitrilacarb (1313), nitrilacarb 1:1 zinc chloride complex (1313), NNI-0101 (compound code), NNI-0250 (compound code), nornicotine (traditional name) (1319), novaluron (585), noviflumuron (586), O-2,5-dichloro-4-iodophenyl O-ethyl ethylphosphonothioate (IUPAC name) (1057), O,O-diethyl O-4-methyl-2-oxo-2H-chromen-7-yl phosphorothioate (IUPAC name) (1074), O,O-diethyl O-6-methyl-2-propylpyrimidin-4-yl phosphorothioate (IUPAC name) (1075), O,O,O′,O′-tetrapropyl dithiopyrophosphate (IUPAC name) (1424), oleic acid (IUPAC name) (593), omethoate (594), oxamyl (602), oxydemeton-methyl (609), oxydeprofos (1324), oxydisulfoton (1325), pp′-DDT (219), para-dichlorobenzene [CCN], parathion (615), parathion-methyl (616), penfluoron (alternative name) [CCN], pentachlorophenol (623), pentachlorophenyl laurate (IUPAC name) (623), permethrin (626), petroleum oils (alternative name) (628), PH 60-38 (development code) (1328), phenkapton (1330), phenothrin (630), phenthoate (631), phorate (636), phosalone (637), phosfolan (1338), phosmet (638), phosnichlor (1339), phosphamidon (639), phosphine (IUPAC name) (640), phoxim (642), phoxim-methyl (1340), pirimetaphos (1344), pirimicarb (651), pirimiphos-ethyl (1345), pirimiphos-methyl (652), polychlorodicyclopentadiene isomers (IUPAC name) (1346), polychloroterpenes (traditional name) (1347), potassium arsenite [CCN], potassium thiocyanate [CCN], prallethrin (655), precocene I (alternative name) [CCN], precocene II (alternative name) [CCN], precocene III (alternative name) [CCN], primidophos (1349), profenofos (662), profluthrin [CCN], promacyl (1354), promecarb (1355), propaphos (1356), propetamphos (673), propoxur (678), prothidathion (1360), prothiofos (686), prothoate (1362), protrifenbute [CCN], pymetrozine (688), pyraclofos (689), pyrazophos (693), pyresmethrin (1367), pyrethrin I (696), pyrethrin II (696), pyrethrins (696), pyridaben (699), pyridalyl (700), pyridaphenthion (701), pyrimidifen (706), pyrimitate (1370), pyriproxyfen (708), quassia (alternative name) [CCN], quinalphos (711), quinalphos-methyl (1376), quinothion (1380), quintiofos (1381), R-1492 (development code) (1382), rafoxanide (alternative name) [CCN], resmethrin (719), rotenone (722), RU 15525 (development code) (723), RU 25475 (development code) (1386), ryania (alternative name) (1387), ryanodine (traditional name) (1387), sabadilla (alternative name) (725), schradan (1389), sebufos (alternative name), selamectin (alternative name) [CCN], SI-0009 (compound code), silafluofen (728), SN 72129 (development code) (1397), sodium arsenite [CCN], sodium cyamide (444), sodium fluoride (IUPAC/Chemical Abstracts name) (1399), sodium hexafluorosilicate (1400), sodium pentachlorophenoxide (623), sodium selenate (IUPAC name) (1401), sodium thiocyanate [CCN], sophamide (1402), spinosad (737), spiromesifen (739), sulcofuron (746), sulcofuron-sodium (746), sulfluramid (750), sulfotep (753), sulfuryl fluoride (756), sulprofos (1408), tar oils (alternative name) (758), tau-fluvalinate (398), tazimcarb (1412), TDE (1414), tebufenozide (762), tebufenpyrad (763), tebupirimfos (764), teflubenzuron (768), tefluthrin (769), temephos (770), TEPP (1417), terallethrin (1418), terbam (alternative name), terbufos (773), tetrachloroethane [CCN], tetrachlorvinphos (777), tetramethrin (787), theta-cypermethrin (204), thiacloprid (791), thiafenox (alternative name), thiamethoxam (792), thicrofos (1428), thiocarboxime (1431), thiocyclam (798), thiocyclam hydrogen oxalate (798), thiodicarb (799), thiofanox (800), thiometon (801), thionazin (1434), thiosultap (803), thiosultap-sodium (803), thuringiensin (alternative name) [CCN], tolfenpyrad (809), tralomethrin (812), transfluthrin (813), transpermethrin (1440), triamiphos (1441), triazamate (818), triazophos (820), triazuron (alternative name), trichlorfon (824), trichlormetaphos-3 (alternative name) [CCN], trichloronat (1452), trifenofos (1455), triflumuron (835), trimethacarb (840), triprene (1459), vamidothion (847), vaniliprole [CCN], veratridine (alternative name) (725), veratrine (alternative name) (725), XMC (853), xylylcarb (854), YI-5302 (compound code), zeta-cypermethrin (205), zetamethrin (alternative name), zinc phosphide (640), zolaprofos (1469) and ZXI 8901 (development code) (858),
a molluscicide selected from the group of substances consisting of bis(tributyltin)oxide (IUPAC name) (913), bromoacetamide [CCN], calcium arsenate [CCN], cloethocarb (999), copper acetoarsenite [CCN], copper sulfate (172), fentin (347), ferric phosphate (IUPAC name) (352), metaldehyde (518), methiocarb (530), niclosamide (576), niclosamide-olamine (576), pentachlorophenol (623), sodium pentachlorophenoxide (623), tazimcarb (1412), thiodicarb (799), tributyltin oxide (913), trifenmorph (1454), trimethacarb (840), triphenyltin acetate (IUPAC name) (347) and triphenyltin hydroxide (IUPAC name) (347),
a nematicide selected from the group of substances consisting of 1,2-dibromo-3-chloropropane (IUPAC/Chemical Abstracts name) (1045), 1,2-dichloropropane (IUPAC/Chemical Abstracts name) (1062), 1,2-dichloropropane with 1,3-dichloropropene (IUPAC name) (1063), 1,3-dichloropropene (233), 3,4-dichlorotetrahydrothiophene 1,1-dioxide (IUPAC/Chemical Abstracts name) (1065), 3-(4-chlorophenyl)-5-methylrhodanine (IUPAC name) (980), 5-methyl-6-thioxo-1,3,5-thiadiazinan-3-ylacetic acid (IUPAC name) (1286), 6-isopentenylaminopurine (alternative name) (210), abamectin (1), acetoprole [CCN], alanycarb (15), aldicarb (16), aldoxycarb (863), AZ 60541 (compound code), benclothiaz [CCN], benomyl (62), butylpyridaben (alternative name), cadusafos (109), carbofuran (118), carbon disulfide (945), carbosulfan (119), chloropicrin (141), chlorpyrifos (145), cloethocarb (999), cytokinins (alternative name) (210), dazomet (216), DBCP (1045), DCIP (218), diamidafos (1044), dichlofenthion (1051), dicliphos (alternative name), dimethoate (262), doramectin (alternative name) [CCN], emamectin (291), emamectin benzoate (291), eprinomectin (alternative name) [CCN], ethoprophos (312), ethylene dibromide (316), fenamiphos (326), fenpyrad (alternative name), fensulfothion (1158), fosthiazate (408), fosthietan (1196), furfural (alternative name) [CCN], GY-81 (development code) (423), heterophos [CCN], iodomethane (IUPAC name) (542), isamidofos (1230), isazofos (1231), ivermectin (alternative name) [CCN], kinetin (alternative name) (210), mecarphon (1258), metam (519), metam-potassium (alternative name) (519), metam-sodium (519), methyl bromide (537), methyl isothiocyanate (543), milbemycin oxime (alternative name) [CCN], moxidectin (alternative name) [CCN], Myrothecium verrucaria composition (alternative name) (565), NC-184 (compound code), oxamyl (602), phorate (636), phosphamidon (639), phosphocarb [CCN], sebufos (alternative name), selamectin (alternative name) [CCN], spinosad (737), terbam (alternative name), terbufos (773), tetrachlorothiophene (IUPAC/Chemical Abstracts name) (1422), thiafenox (alternative name), thionazin (1434), triazophos (820), triazuron (alternative name), xylenols [CCN], YI-5302 (compound code) and zeatin (alternative name) (210),
a nitrification inhibitor selected from the group of substances consisting of potassium ethylxanthate [CCN] and nitrapyrin (580),
a plant activator selected from the group of substances consisting of acibenzolar (6), acibenzolar-5-methyl (6), probenazole (658) and Reynoutria sachalinensis extract (alternative name) (720),
a rodenticide selected from the group of substances consisting of 2-isovalerylindan-1,3-dione (IUPAC name) (1246), 4-(quinoxalin-2-ylamino)benzenesulfonamide (IUPAC name) (748), alpha-chlorohydrin [CCN], aluminium phosphide (640), antu (880), arsenous oxide (882), barium carbonate (891), bisthiosemi (912), brodifacoum (89), bromadiolone (91), bromethalin (92), calcium cyamide (444), chloralose (127), chlorophacinone (140), cholecalciferol (alternative name) (850), coumachlor (1004), coumafuryl (1005), coumatetralyl (175), crimidine (1009), difenacoum (246), difethialone (249), diphacinone (273), ergocalciferol (301), flocoumafen (357), fluoroacetamide (379), flupropadine (1183), flupropadine hydrochloride (1183), gamma-HCH (430), HCH (430), hydrogen cyamide (444), iodomethane (IUPAC name) (542), lindane (430), magnesium phosphide (IUPAC name) (640), methyl bromide (537), norbormide (1318), phosacetim (1336), phosphine (IUPAC name) (640), phosphorus [CCN], pindone (1341), potassium arsenite [CCN], pyrinuron (1371), scilliroside (1390), sodium arsenite [CCN], sodium cyamide (444), sodium fluoro-acetate (735), strychnine (745), thallium sulfate [CCN], warfarin (851) and zinc phosphide (640),
a synergist selected from the group of substances consisting of 2-(2-butoxyethoxy)ethyl piperonylate (IUPAC name) (934), 5-(1,3-benzodioxol-5-yl)-3-hexylcyclohex-2-enone (IUPAC name) (903), farnesol with nerolidol (alternative name) (324), MB-599 (development code) (498), MGK 264 (development code) (296), piperonyl butoxide (649), piprotal (1343), propyl isomer (1358), S421 (development code) (724), sesamex (1393), sesasmolin (1394) and sulfoxide (1406),
an animal repellent selected from the group of substances consisting of anthraquinone (32), chloralose (127), copper naphthenate [CCN], copper oxychloride (171), diazinon (227), dicyclopentadiene (chemical name) (1069), guazatine (422), guazatine acetates (422), methiocarb (530), pyridin-4-amine (IUPAC name) (23), thiram (804), trimethacarb (840), zinc naphthenate [CCN] and ziram (856),
a virucide selected from the group of substances consisting of imanin (alternative name) [CCN] and ribavirin (alternative name) [CCN],
and a wound protectant selected from the group of substances consisting of mercuric oxide (512), octhilinone (590) and thiophanate-methyl (802).

A very especially preferred embodiment of the subject-matter {1.1.21} of the invention is {1.1.21.2} a pesticidal composition comprising a mixture consisting of at least two substances, namely one compound (A) and at least one compound (B), as active ingredient and at least one auxiliary, wherein the compound (A) is the compound of formula (A-21) and the compound (B) is a compound selected from the group of substances consisting of abamectin (1), cyromazine (209), diafenthiuron (226), diazinon (227), emamectin benzoate (291), fenoxycarb (340), fosthiazate (408), lambda-cyhalothrin (198), lufenuron (490), methidathion (529), profenofos (662), pymetrozine (688), tefluthrin (769) and thiamethoxam (792).

The compound of formula (A-21) is known, for example, from the PCT Application WO-03/015519.

A preferred embodiment of the subject-matter {1.1} of the invention is {1.1.22} a pesticidal composition comprising a mixture consisting of at least two substances, namely one compound (A) and at least one compound (B), as active ingredient and at least one auxiliary, wherein the compound (A) is the compound of formula (A-22) 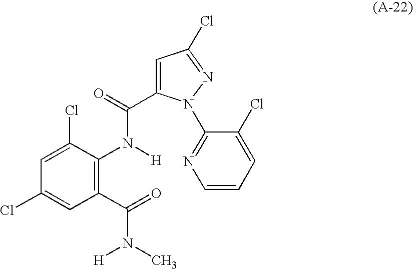
and the compound (B) is a compound selected from the group of substances consisting of an adjuvant, an acaricide, an algicide, an anthelmintic, an avicide, a bactericide, a biological agent, a soil sterilant, a chemosterilant, an insect pheromone, an insect repellent, an insecticide, a molluscicide, a nematicide, a nitrification inhibitor, a plant activator, a rodenticide, a synergist, an animal repellent, a virucide and a wound protectant.

An especially preferred embodiment of the subject-matter {1.1.22} of the invention is {1.1.22.1} a pesticidal composition comprising a mixture consisting of at least two substances, namely one compound (A) and at least one compound (B), as active ingredient and at least one auxiliary, wherein the compound (A) is the compound of formula (A-22) and the compound (B) is a compound selected from the group of substances consisting of
an adjuvant selected from the group of substances consisting of petroleum oils (alternative name) (628),
an acaricide selected from the group of substances consisting of 1,1-bis(4-chlorophenyl)-2-ethoxyethanol (IUPAC name) (910), 2,4-dichlorophenyl benzenesulfonate (IUPAC/Chemical Abstracts name) (1059), 2-fluoro-N-methyl-N-1-naphthylacetamide (IUPAC name) (1295), 4-chlorophenyl phenyl sulfone (IUPAC name) (981), abamectin (1), acequinocyl (3), acetoprole [CCN], acrinathrin (9), aldicarb (16), aldoxycarb (863), alpha-cypermethrin (202), amidithion (870), amidoflumet [CCN], amidothioate (872), amiton (875), amiton hydrogen oxalate (875), amitraz (24), aramite (881), arsenous oxide (882), AVI 382 (compound code), AZ 60541 (compound code), azinphos-ethyl (44), azinphos-methyl (45), azobenzene (IUPAC name) (888), azocyclotin (46), azothoate (889), benomyl (62), benoxafos (alternative name) [CCN], benzoximate (71), benzyl benzoate (IUPAC name) [CCN], bifenazate (74), bifenthrin (76), binapacryl (907), brofenvalerate (alternative name), bromocyclen (918), bromophos (920), bromophos-ethyl (921), bromopropylate (94), buprofezin (99), butocarboxim (103), butoxycarboxim (104), butylpyridaben (alternative name), calcium polysulfide (IUPAC name) (111), camphechlor (941), carbanolate (943), carbaryl (115), carbofuran (118), carbophenothion (947), CGA 50'439 (development code) (125), chinomethionat (126), chlorbenside (959), chlordimeform (964), chlordimeform hydrochloride (964), chlorfenapyr (130), chlorfenethol (968), chlorfenson (970), chlorfensulphide (971), chlorfenvinphos (131), chlorobenzilate (975), chloromebuform (977), chloromethiuron (978), chloropropylate (983), chlorpyrifos (145), chlorpyrifos-methyl (146), chlorthiophos (994), cinerin I (696), cinerin II (696), cinerins (696), clofentezine (158), closantel (alternative name) [CCN], coumaphos (174), crotamiton (alternative name) [CCN], crotoxyphos (1010), cufraneb (1013), cyanthoate (1020), cyhalothrin (196), cyhexatin (199), cypermethrin (201), DCPM (1032), DDT (219), demephion (1037), demephion-O (1037), demephion-S (1037), demeton (1038), demeton-methyl (224), demeton-O (1038), demeton-O-methyl (224), demeton-S (1038), demeton-5-methyl (224), demeton-5-methylsulphon (1039), diafenthiuron (226), dialifos (1042), diazinon (227), dichlofluanid (230), dichlorvos (236), dicliphos (alternative name), dicofol (242), dicrotophos (243), dienochlor (1071), dimefox (1081), dimethoate (262), dinactin (alternative name) (653), dinex (1089), dinex-diclexine (1089), dinobuton (269), dinocap (270), dinocap-4 [CCN], dinocap-6 [CCN], dinocton (1090), dinopenton (1092), dinosulfon (1097), dinoterbon (1098), dioxathion (1102), diphenyl sulfone (IUPAC name) (1103), disulfuram (alternative name) [CCN], disulfoton (278), DNOC (282), dofenapyn (1113), doramectin (alternative name) [CCN], endosulfan (294), endothion (1121), EPN (297), eprinomectin (alternative name) [CCN], ethion (309), ethoate-methyl (1134), etoxazole (320), etrimfos (1142), fenazaflor (1147), fenazaquin (328), fenbutatin oxide (330), fenothiocarb (337), fenpropathrin (342), fenpyrad (alternative name), fenpyroximate (345), fenson (1157), fentrifanil (1161), fenvalerate (349), fipronil (354), fluacrypyrim (360), fluazuron (1166), flubenzimine (1167), flucycloxuron (366), flucythrinate (367), fluenetil (1169), flufenoxuron (370), flumethrin (372), fluorbenside (1174), fluvalinate (1184), FMC 1137 (development code) (1185), formetanate (405), formetanate hydrochloride (405), formothion (1192), formparanate (1193), gamma-HCH (430), glyodin (1205), halfenprox (424), heptenophos (432), hexadecyl cyclopropanecarboxylate (IUPAC/Chemical Abstracts name) (1216), hexythiazox (441), iodomethane (IUPAC name) (542), isocarbophos (alternative name) (473), isopropyl O-(methoxyaminothiophosphoryl)salicylate (IUPAC name) (473), ivermectin (alternative name) [CCN], jasmolin I (696), jasmolin II (696), jodfenphos (1248), lindane (430), lufenuron (490), malathion (492), malonoben (1254), mecarbam (502), mephosfolan (1261), mesulfen (alternative name) [CCN], methacrifos (1266), methamidophos (527), methidathion (529), methiocarb (530), methomyl (531), methyl bromide (537), metolcarb (550), mevinphos (556), mexacarbate (1290), milbemectin (557), milbemycin oxime (alternative name) [CCN], mipafox (1293), monocrotophos (561), morphothion (1300), moxidectin (alternative name) [CCN], naled (567), NC-184 (compound code), nifluridide (1309), nikkomycins (alternative name) [CCN], nitrilacarb (1313), nitrilacarb 1:1 zinc chloride complex (1313), NNI-0101 (compound code), NNI-0250 (compound code), omethoate (594), oxamyl (602), oxydeprofos (1324), oxydisulfoton (1325), pp′-DDT (219), parathion (615), permethrin (626), petroleum oils (alternative name) (628), phenkapton (1330), phenthoate (631), phorate (636), phosalone (637), phosfolan (1338), phosmet (638), phosphamidon (639), phoxim (642), pirimiphos-methyl (652), polychloroterpenes (traditional name) (1347), polynactins (alternative name) (653), proclonol (1350), profenofos (662), promacyl (1354), propargite (671), propetamphos (673), propoxur (678), prothidathion (1360), prothoate (1362), pyrethrin I (696), pyrethrin II (696), pyrethrins (696), pyridaben (699), pyridaphenthion (701), pyrimidifen (706), pyrimitate (1370), quinalphos (711), quintiofos (1381), R-1492 (development code) (1382), RA-17 (development code) (1383), rotenone (722), schradan (1389), sebufos (alternative name), selamectin (alternative name) [CCN], SI-0009 (compound code), sophamide (1402), spirodiclofen (738), spiromesifen (739), SSI-121 (development code) (1404), sulfuram (alternative name) [CCN], sulfluramid (750), sulfotep (753), sulfur (754), SZI-121 (development code) (757), tau-fluvalinate (398), tebufenpyrad (763), TEPP (1417), terbam (alternative name), tetrachlorvinphos (777), tetradifon (786), tetranactin (alternative name) (653), tetrasul (1425), thiafenox (alternative name), thiocarboxime (1431), thiofanox (800), thiometon (801), thioquinox (1436), thuringiensin (alternative name) [CCN], triamiphos (1441), triarathene (1443), triazophos (820), triazuron (alternative name), trichlorfon (824), trifenofos (1455), trinactin (alternative name) (653), vamidothion (847), vaniliprole [CCN] and YI-5302 (compound code),
an algicide selected from the group of substances consisting of bethoxazin [CCN], copper dioctanoate (IUPAC name) (170), copper sulfate (172), cybutryne [CCN], dichlone (1052), dichlorophen (232), endothal (295), fentin (347), hydrated lime [CCN], nabam (566), quinoclamine (714), quinonamid (1379), simazine (730), triphenyltin acetate (IUPAC name) (347) and triphenyltin hydroxide (IUPAC name) (347),
an anthelmintic selected from the group of substances consisting of abamectin (1), crufomate (1011), doramectin (alternative name) [CCN], emamectin (291), emamectin benzoate (291), eprinomectin (alternative name) [CCN], ivermectin (alternative name) [CCN], milbemycin oxime (alternative name) [CCN], moxidectin (alternative name) [CCN], piperazine [CCN], selamectin (alternative name) [CCN], spinosad (737) and thiophanate (1435),
an avicide selected from the group of substances consisting of chloralose (127), endrin (1122), fenthion (346), pyridin-4-amine (IUPAC name) (23) and strychnine (745),
a bactericide selected from the group of substances consisting of 1-hydroxy-1H-pyridine-2-thione (IUPAC name) (1222), 4-(quinoxalin-2-ylamino)benzenesulfonamide (IUPAC name) (748), 8-hydroxyquinoline sulfate (446), bronopol (97), copper dioctanoate (IUPAC name) (170), copper hydroxide (IUPAC name) (169), cresol [CCN], dichlorophen (232), dipyrithione (1105), dodicin (1112), fenaminosulf (1144), formaldehyde (404), hydrargaphen (alternative name) [CCN], kasugamycin (483), kasugamycin hydrochloride hydrate (483), nickel bis(dimethyldithiocarbamate) (IUPAC name) (1308), nitrapyrin (580), octhilinone (590), oxolinic acid (606), oxytetracycline (611), potassium hydroxyquinoline sulfate (446), probenazole (658), streptomycin (744), streptomycin sesquisulfate (744), tecloftalam (766) and thiomersal (alternative name) [CCN],
a biological agent selected from the group of substances consisting of Adoxophyes orana GV (alternative name) (12), Agrobacterium radiobacter (alternative name) (13), Amblyseius spp. (alternative name) (19), Anagrapha falcifera NPV (alternative name) (28), Anagrus atomus (alternative name) (29), Aphelinus abdominalis (alternative name) (33), Aphidius colemani (alternative name) (34), Aphidoletes aphidimyza (alternative name) (35), Autographa californica NPV (alternative name) (38), Bacillus firmus (alternative name) (48), Bacillus sphaericus Neide (scientific name) (49), Bacillus thuringiensis Berliner (scientific name) (51), Bacillus thuringiensis subsp. aizawai (scientific name) (51), Bacillus thuringiensis subsp. israelensis (scientific name) (51), Bacillus thuringiensis subsp. japonensis (scientific name) (51), Bacillus thuringiensis subsp. kurstaki (scientific name) (51), Bacillus thuringiensis subsp. tenebrionis (scientific name) (51), Beauveria bassiana (alternative name) (53), Beauveria brongniartii (alternative name) (54), Chrysoperla carnea (alternative name) (151), Cryptolaemus montrouzieri (alternative name) (178), Cydia pomonella GV (alternative name) (191), Dacnusa sibirica (alternative name) (212), Diglyphus isaea (alternative name) (254), Encarsia formosa (scientific name) (293), Eretmocerus eremicus (alternative name) (300), Helicoverpa zea NPV (alternative name) (431), Heterorhabditis bacteriophora and H. megidis (alternative name) (433), Hippodamia convergens (alternative name) (442), Leptomastix dactylopii (alternative name) (488), Macrolophus caliginosus (alternative name) (491), Mamestra brassicae NPV (alternative name) (494), Metaphycus helvolus (alternative name) (522), Metarhizium anisopliae var. acridum (scientific name) (523), Metarhizium anisopliae var. anisopliae (scientific name) (523), Neodiprion sertifer NPV and N. lecontei NPV (alternative name) (575), Orius spp. (alternative name) (596), Paecilomyces fumosoroseus (alternative name) (613), Phytoseiulus persimilis (alternative name) (644), Spodoptera exigua multicapsid nuclear polyhedrosis virus (scientific name) (741), Steinernema bibionis (alternative name) (742), Steinernema carpocapsae (alternative name) (742), Steinernema feltiae (alternative name) (742), Steinernema glaseri (alternative name) (742), Steinernema riobrave (alternative name) (742), Steinernema riobravis (alternative name) (742), Steinernema scapterisci (alternative name) (742), Steinernema spp. (alternative name) (742), Trichogramma spp. (alternative name) (826), Typhlodromus occidentalis (alternative name) (844) and Verticillium lecanii (alternative name) (848),
a soil sterilant selected from the group of substances consisting of iodomethane (IUPAC name) (542) and methyl bromide (537),
a chemosterilant selected from the group of substances consisting of apholate [CCN], bisazir (alternative name) [CCN], busulfan (alternative name) [CCN], diflubenzuron (250), dimatif (alternative name) [CCN], hemel [CCN], hempa [CCN], metepa [CCN], methiotepa [CCN], methyl apholate [CCN], morzid [CCN], penfluoron (alternative name) [CCN], tepa [CCN], thiohempa (alternative name) [CCN], thiotepa (alternative name) [CCN], tretamine (alternative name) [CCN] and uredepa (alternative name) [CCN],
an insect pheromone selected from the group of substances consisting of (E)-dec-5-en-1-yl acetate with (E)-dec-5-en-1-ol (IUPAC name) (222), (E)-tridec-4-en-1-yl acetate (IUPAC name) (829), (E)-6-methylhept-2-en-4-ol (IUPAC name) (541), (E,Z)-tetradeca-4,10-dien-1-yl acetate (IUPAC name) (779), (Z)-dodec-7-en-1-yl acetate (IUPAC name) (285), (Z)-hexadec-11-enal (IUPAC name) (436), (Z)-hexadec-11-en-1-yl acetate (IUPAC name) (437), (Z)-hexadec-13-en-11-yn-1-yl acetate (IUPAC name) (438), (Z)-icos-13-en-10-one (IUPAC name) (448), (Z)-tetradec-7-en-1-al (IUPAC name) (782), (Z)-tetradec-9-en-1-ol (IUPAC name) (783), (Z)-tetradec-9-en-1-yl acetate (IUPAC name) (784), (7E,9Z)-dodeca-7,9-dien-1-yl acetate (IUPAC name) (283), (9Z,11E)-tetradeca-9,11-dien-1-yl acetate (IUPAC name) (780), (9Z,12E)-tetradeca-9,12-dien-1-yl acetate (IUPAC name) (781), 14-methyloctadec-1-ene (IUPAC name) (545), 4-methylnonan-5-ol with 4-methylnonan-5-one (IUPAC name) (544), alpha-multistriatin (alternative name) [CCN], brevicomin (alternative name) [CCN], codlelure (alternative name) [CCN], codlemone (alternative name) (167), cuelure (alternative name) (179), disparlure (277), dodec-8-en-1-yl acetate (IUPAC name) (286), dodec-9-en-1-yl acetate (IUPAC name) (287), dodeca-8,10-dien-1-yl acetate (IUPAC name) (284), dominicalure (alternative name) [CCN], ethyl 4-methyloctanoate (IUPAC name) (317), eugenol (alternative name) [CCN], frontalin (alternative name) [CCN], gossyplure (alternative name) (420), grandlure (421), grandlure I (alternative name) (421), grandlure II (alternative name) (421), grandlure III (alternative name) (421), grandlure IV (alternative name) (421), hexylure [CCN], ipsdienol (alternative name) [CCN], ipsenol (alternative name) [CCN], japonilure (alternative name) (481), lineatin (alternative name) [CCN], litlure (alternative name) [CCN], looplure (alternative name) [CCN], medlure [CCN], megatomoic acid (alternative name) [CCN], methyl eugenol (alternative name) (540), muscalure (563), octadeca-2,13-dien-1-yl acetate (IUPAC name) (588), octadeca-3,13-dien-1-yl acetate (IUPAC name) (589), orfralure (alternative name) [CCN], oryctalure (alternative name) (317), ostramone (alternative name) [CCN], siglure [CCN], sordidin (alternative name) (736), sulcatol (alternative name) [CCN], tetradec-11-en-1-yl acetate (IUPAC name) (785), trimedlure (839), trimedlure A (alternative name) (839), trimedlure B₁ (alternative name) (839), trimedlure B₂ (alternative name) (839), trimedlure C (alternative name) (839) and trunc-call (alternative name) [CCN],
an insect repellent selected from the group of substances consisting of 2-(octylthio)-ethanol (IUPAC name) (591), butopyronoxyl (933), butoxy(polypropylene glycol) (936), dibutyl adipate (IUPAC name) (1046), dibutyl phthalate (1047), dibutyl succinate (IUPAC name) (1048), diethyltoluamide [CCN], dimethyl carbate [CCN], dimethyl phthalate [CCN], ethyl hexanediol (1137), hexamide [CCN], methoquin-butyl (1276), methylneodecanamide [CCN], oxamate [CCN] and picaridin [CCN],
an insecticide selected from the group of substances consisting of 1,1-dichloro-1-nitroethane (IUPAC/Chemical Abstracts name) (1058), 1,1-dichloro-2,2-bis(4-ethylphenyl)-ethane (IUPAC name) (1056), 1,2-dichloropropane (IUPAC/Chemical Abstracts name) (1062), 1,2-dichloropropane with 1,3-dichloropropene (IUPAC name) (1063), 1-bromo-2-chloroethane (IUPAC/Chemical Abstracts name) (916), 2,2,2-trichloro-1-(3,4-dichloro-phenyl)ethyl acetate (IUPAC name) (1451), 2,2-dichlorovinyl 2-ethylsulfinylethyl methyl phosphate (IUPAC name) (1066), 2-(1,3-dithiolan-2-yl)phenyl dimethylcarbamate (IUPAC/Chemical Abstracts name) (1109), 2-(2-butoxyethoxy)ethyl thiocyanate (IUPAC/Chemical Abstracts name) (935), 2-(4,5-dimethyl-1,3-dioxolan-2-yl)phenyl methylcarbamate (IUPAC/Chemical Abstracts name) (1084), 2-(4-chloro-3,5-xylyloxy)ethanol (IUPAC name) (986), 2-chlorovinyl diethyl phosphate (IUPAC name) (984), 2-imidazolidone (IUPAC name) (1225), 2-isovalerylindan-1,3-dione (IUPAC name) (1246), 2-methyl(prop-2-ynyl)aminophenyl methylcarbamate (IUPAC name) (1284), 2-thiocyanatoethyl laurate (IUPAC name) (1433), 3-bromo-1-chloroprop-1-ene (IUPAC name) (917), 3-methyl-1-phenylpyrazol-5-yl dimethyl-carbamate (IUPAC name) (1283), 4-methyl(prop-2-ynyl)amino-3,5-xylyl methylcarbamate (IUPAC name) (1285), 5,5-dimethyl-3-oxocyclohex-1-enyl dimethylcarbamate (IUPAC name) (1085), abamectin (1), acephate (2), acetamiprid (4), acethion (alternative name) [CCN], acetoprole [CCN], acrinathrin (9), acrylonitrile (IUPAC name) (861), alanycarb (15), aldicarb (16), aldoxycarb (863), aldrin (864), allethrin (17), allosamidin (alternative name) [CCN], allyxycarb (866), alpha-cypermethrin (202), alpha-ecdysone (alternative name) [CCN], aluminium phosphide (640), amidithion (870), amidothioate (872), aminocarb (873), amiton (875), amiton hydrogen oxalate (875), amitraz (24), anabasine (877), athidathion (883), AVI 382 (compound code), AZ 60541 (compound code), azadirachtin (alternative name) (41), azamethiphos (42), azinphos-ethyl (44), azinphos-methyl (45), azothoate (889), Bacillus thuringiensis delta endotoxins (alternative name) (52), barium hexafluorosilicate (alternative name) [CCN], barium polysulfide (IUPAC/Chemical Abstracts name) (892), barthrin [CCN], BAS 320 I (compound code), Bayer 22/190 (development code) (893), Bayer 22408 (development code) (894), bendiocarb (58), benfuracarb (60), bensultap (66), beta-cyfluthrin (194), beta-cypermethrin (203), bifenthrin (76), bioallethrin (78), bioallethrin S-cyclopentenyl isomer (alternative name) (79), bioethanomethrin [CCN], biopermethrin (908), bioresmethrin (80), bis(2-chloroethyl)ether (IUPAC name) (909), bistrifluoron (83), borax (86), brofenvalerate (alternative name), bromfenvinfos (914), bromocyclen (918), bromo-DDT (alternative name) [CCN], bromophos (920), bromophos-ethyl (921), bufencarb (924), buprofezin (99), butacarb (926), butathiofos (927), butocarboxim (103), butonate (932), butoxycarboxim (104), butylpyridaben (alternative name), cadusafos (109), calcium arsenate [CCN], calcium cyamide (444), calcium polysulfide (IUPAC name) (111), camphechlor (941), carbanolate (943), carbaryl (115), carbofuran (118), carbon disulfide (IUPAC/Chemical Abstracts name) (945), carbon tetrachloride (IUPAC name) (946), carbophenothion (947), carbosulfan (119), cartap (123), cartap hydrochloride (123), cevadine (alternative name) (725), chlorbicyclen (960), chlordane (128), chlordecone (963), chlordimeform (964), chlordimeform hydrochloride (964), chlorethoxyfos (129), chlorfenapyr (130), chlorfenvinphos (131), chlorfluazuron (132), chlormephos (136), chloroform [CCN], chloropicrin (141), chlorphoxim (989), chlorprazophos (990), chlorpyrifos (145), chlorpyrifos-methyl (146), chlorthiophos (994), chromafenozide (150), cinerin I (696), cinerin II (696), cinerins (696), cis-resmethrin (alternative name), cismethrin (80), clocythrin (alternative name), cloethocarb (999), closantel (alternative name) [CCN], clothianidin (165), copper acetoarsenite [CCN], copper arsenate [CCN], copper oleate [CCN], coumaphos (174), coumithoate (1006), crotamiton (alternative name) [CCN], crotoxyphos (1010), crufomate (1011), cryolite (alternative name) (177), CS 708 (development code) (1012), cyanofenphos (1019), cyanophos (184), cyanthoate (1020), cyclethrin [CCN], cycloprothrin (188), cyfluthrin (193), cyhalothrin (196), cypermethrin (201), cyphenothrin (206), cyromazine (209), cythioate (alternative name) [CCN], d-limonene (alternative name) [CCN], d-tetramethrin (alternative name) (788), DAEP (1031), dazomet (216), DDT (219), decarbofuran (1034), deltamethrin (223), demephion (1037), demephion-O (1037), demephion-S (1037), demeton (1038), demeton-methyl (224), demeton-O (1038), demeton-O-methyl (224), demeton-S (1038), demeton-5-methyl (224), demeton-5-methylsulphon (1039), diafenthiuron (226), dialifos (1042), diamidafos (1044), diazinon (227), dicapthon (1050), dichlofenthion (1051), dichlorvos (236), dicliphos (alternative name), dicresyl (alternative name) [CCN], dicrotophos (243), dicyclanil (244), dieldrin (1070), diethyl 5-methylpyrazol-3-yl phosphate (IUPAC name) (1076), diflubenzuron (250), dilor (alternative name) [CCN], dimefluthrin [CCN], dimefox (1081), dimetan (1085), dimethoate (262), dimethrin (1083), dimethylvinphos (265), dimetilan (1086), dinex (1089), dinex-diclexine (1089), dinoprop (1093), dinosam (1094), dinoseb (1095), dinotefuran (271), diofenolan (1099), dioxabenzofos (1100), dioxacarb (1101), dioxathion (1102), disulfoton (278), dithicrofos (1108), DNOC (282), doramectin (alternative name) [CCN], DSP (1115), ecdysterone (alternative name) [CCN], EI 1642 (development code) (1118), emamectin (291), emamectin benzoate (291), EMPC (1120), empenthrin (292), endosulfan (294), endothion (1121), endrin (1122), EPBP (1123), EPN (297), epofenonane (1124), eprinomectin (alternative name) [CCN], esfenvalerate (302), etaphos (alternative name) [CCN], ethiofencarb (308), ethion (309), ethiprole (310), ethoate-methyl (1134), ethoprophos (312), ethyl formate (IUPAC name) [CCN], ethyl-DDD (alternative name) (1056), ethylene dibromide (316), ethylene dichloride (chemical name) (1136), ethylene oxide [CCN], etofenprox (319), etrimfos (1142), EXD (1143), famphur (323), fenamiphos (326), fenazaflor (1147), fenchlorphos (1148), fenethacarb (1149), fenfluthrin (1150), fenitrothion (335), fenobucarb (336), fenoxacrim (1153), fenoxycarb (340), fenpirithrin (1155), fenpropathrin (342), fenpyrad (alternative name), fensulfothion (1158), fenthion (346), fenthion-ethyl [CCN], fenvalerate (349), fipronil (354), flonicamid (358), flucofuron (1168), flucycloxuron (366), flucythrinate (367), fluenetil (1169), flufenerim [CCN], flufenoxuron (370), flufenprox (1171), flumethrin (372), fluvalinate (1184), FMC 1137 (development code) (1185), fonofos (1191), formetanate (405), formetanate hydrochloride (405), formothion (1192), formparanate (1193), fosmethilan (1194), fospirate (1195), fosthiazate (408), fosthietan (1196), furathiocarb (412), furethrin (1200), gamma-cyhalothrin (197), gamma-HCH (430), guazatine (422), guazatine acetates (422), GY-81 (development code) (423), halfenprox (424), halofenozide (425), HCH (430), HEOD (1070), heptachlor (1211), heptenophos (432), heterophos [CCN], hexaflumuron (439), HHDN (864), hydramethylnon (443), hydrogen cyamide (444), hydroprene (445), hyquincarb (1223), imidacloprid (458), imiprothrin (460), indoxacarb (465), iodomethane (IUPAC name) (542), IPSP (1229), isazofos (1231), isobenzan (1232), isocarbophos (alternative name) (473), isodrin (1235), isofenphos (1236), isolane (1237), isoprocarb (472), isopropyl O-(methoxyaminothiophosphoryl)salicylate (IUPAC name) (473), isoprothiolane (474), isothioate (1244), isoxathion (480), ivermectin (alternative name) [CCN], jasmolin I (696), jasmolin II (696), jodfenphos (1248), juvenile hormone I (alternative name) [CCN], juvenile hormone II (alternative name) [CCN], juvenile hormone III (alternative name) [CCN], kelevan (1249), kinoprene (484), lambda-cyhalothrin (198), lead arsenate [CCN], leptophos (1250), lindane (430), lirimfos (1251), lufenuron (490), lythidathion (1253), m-cumenyl methylcarbamate (IUPAC name) (1014), magnesium phosphide (IUPAC name) (640), malathion (492), malonoben (1254), mazidox (1255), mecarbam (502), mecarphon (1258), menazon (1260), mephosfolan (1261), mercurous chloride (513), mesulfenfos (1263), metam (519), metam-potassium (alternative name) (519), metam-sodium (519), methacrifos (1266), methamidophos (527), methanesulfonyl fluoride (IUPAC/Chemical Abstracts name) (1268), methidathion (529), methiocarb (530), methocrotophos (1273), methomyl (531), methoprene (532), methoquin-butyl (1276), methothrin (alternative name) (533), methoxychlor (534), methoxyfenozide (535), methyl bromide (537), methyl isothiocyanate (543), methylchloroform (alternative name) [CCN], methylene chloride [CCN], metofluthrin [CCN], metolcarb (550), metoxadiazone (1288), mevinphos (556), mexacarbate (1290), milbemectin (557), milbemycin oxime (alternative name) [CCN], mipafox (1293), mirex (1294), monocrotophos (561), morphothion (1300), moxidectin (alternative name) [CCN], naftalofos (alternative name) [CCN], naled (567), naphthalene (IUPAC/Chemical Abstracts name) (1303), NC-170 (development code) (1306), NC-184 (compound code), nicotine (578), nicotine sulfate (578), nifluridide (1309), nitenpyram (579), nithiazine (1311), nitrilacarb (1313), nitrilacarb 1:1 zinc chloride complex (1313), NNI-0101 (compound code), NNI-0250 (compound code), nornicotine (traditional name) (1319), novaluron (585), noviflumuron (586), O-2,5-dichloro-4-iodophenyl O-ethyl ethylphosphonothioate (IUPAC name) (1057), O,O-diethyl O-4-methyl-2-oxo-2H-chromen-7-yl phosphorothioate (IUPAC name) (1074), O,O-diethyl O-6-methyl-2-propylpyrimidin-4-yl phosphorothioate (IUPAC name) (1075), O,O,O′,O′-tetrapropyl dithiopyrophosphate (IUPAC name) (1424), oleic acid (IUPAC name) (593), omethoate (594), oxamyl (602), oxydemeton-methyl (609), oxydeprofos (1324), oxydisulfoton (1325), pp′-DDT (219), para-dichlorobenzene [CCN], parathion (615), parathion-methyl (616), penfluoron (alternative name) [CCN], pentachlorophenol (623), pentachlorophenyl laurate (IUPAC name) (623), permethrin (626), petroleum oils (alternative name) (628), PH 60-38 (development code) (1328), phenkapton (1330), phenothrin (630), phenthoate (631), phorate (636), phosalone (637), phosfolan (1338), phosmet (638), phosnichlor (1339), phosphamidon (639), phosphine (IUPAC name) (640), phoxim (642), phoxim-methyl (1340), pirimetaphos (1344), pirimicarb (651), pirimiphos-ethyl (1345), pirimiphos-methyl (652), polychlorodicyclopentadiene isomers (IUPAC name) (1346), polychloroterpenes (traditional name) (1347), potassium arsenite [CCN], potassium thiocyanate [CCN], prallethrin (655), precocene I (alternative name) [CCN], precocene II (alternative name) [CCN], precocene III (alternative name) [CCN], primidophos (1349), profenofos (662), profluthrin [CCN], promacyl (1354), promecarb (1355), propaphos (1356), propetamphos (673), propoxur (678), prothidathion (1360), prothiofos (686), prothoate (1362), protrifenbute [CCN], pymetrozine (688), pyraclofos (689), pyrazophos (693), pyresmethrin (1367), pyrethrin I (696), pyrethrin II (696), pyrethrins (696), pyridaben (699), pyridalyl (700), pyridaphenthion (701), pyrimidifen (706), pyrimitate (1370), pyriproxyfen (708), quassia (alternative name) [CCN], quinalphos (711), quinalphos-methyl (1376), quinothion (1380), quintiofos (1381), R-1492 (development code) (1382), rafoxanide (alternative name) [CCN], resmethrin (719), rotenone (722), RU 15525 (development code) (723), RU 25475 (development code) (1386), ryania (alternative name) (1387), ryanodine (traditional name) (1387), sabadilla (alternative name) (725), schradan (1389), sebufos (alternative name), selamectin (alternative name) [CCN], SI-0009 (compound code), silafluofen (728), SN 72129 (development code) (1397), sodium arsenite [CCN], sodium cyamide (444), sodium fluoride (IUPAC/Chemical Abstracts name) (1399), sodium hexafluorosilicate (1400), sodium pentachlorophenoxide (623), sodium selenate (IUPAC name) (1401), sodium thiocyanate [CCN], sophamide (1402), spinosad (737), spiromesifen (739), sulcofuron (746), sulcofuron-sodium (746), sulfluramid (750), sulfotep (753), sulfuryl fluoride (756), sulprofos (1408), tar oils (alternative name) (758), tau-fluvalinate (398), tazimcarb (1412), TDE (1414), tebufenozide (762), tebufenpyrad (763), tebupirimfos (764), teflubenzuron (768), tefluthrin (769), temephos (770), TEPP (1417), terallethrin (1418), terbam (alternative name), terbufos (773), tetrachloroethane [CCN], tetrachlorvinphos (777), tetramethrin (787), theta-cypermethrin (204), thiacloprid (791), thiafenox (alternative name), thiamethoxam (792), thicrofos (1428), thiocarboxime (1431), thiocyclam (798), thiocyclam hydrogen oxalate (798), thiodicarb (799), thiofanox (800), thiometon (801), thionazin (1434), thiosultap (803), thiosultap-sodium (803), thuringiensin (alternative name) [CCN], tolfenpyrad (809), tralomethrin (812), transfluthrin (813), transpermethrin (1440), triamiphos (1441), triazamate (818), triazophos (820), triazuron (alternative name), trichlorfon (824), trichlormetaphos-3 (alternative name) [CCN], trichloronat (1452), trifenofos (1455), triflumuron (835), trimethacarb (840), triprene (1459), vamidothion (847), vaniliprole [CCN], veratridine (alternative name) (725), veratrine (alternative name) (725), XMC (853), xylylcarb (854), YI-5302 (compound code), zeta-cypermethrin (205), zetamethrin (alternative name), zinc phosphide (640), zolaprofos (1469) and ZXI 8901 (development code) (858),
a molluscicide selected from the group of substances consisting of bis(tributyltin)oxide (IUPAC name) (913), bromoacetamide [CCN], calcium arsenate [CCN], cloethocarb (999), copper acetoarsenite [CCN], copper sulfate (172), fentin (347), ferric phosphate (IUPAC name) (352), metaldehyde (518), methiocarb (530), niclosamide (576), niclosamide-olamine (576), pentachlorophenol (623), sodium pentachlorophenoxide (623), tazimcarb (1412), thiodicarb (799), tributyltin oxide (913), trifenmorph (1454), trimethacarb (840), triphenyltin acetate (IUPAC name) (347) and triphenyltin hydroxide (IUPAC name) (347),
a nematicide selected from the group of substances consisting of 1,2-dibromo-3-chloropropane (IUPAC/Chemical Abstracts name) (1045), 1,2-dichloropropane (IUPAC/Chemical Abstracts name) (1062), 1,2-dichloropropane with 1,3-dichloropropene (IUPAC name) (1063), 1,3-dichloropropene (233), 3,4-dichlorotetrahydrothiophene 1,1-dioxide (IUPAC/Chemical Abstracts name) (1065), 3-(4-chlorophenyl)-5-methylrhodanine (IUPAC name) (980), 5-methyl-6-thioxo-1,3,5-thiadiazinan-3-ylacetic acid (IUPAC name) (1286), 6-isopentenylaminopurine (alternative name) (210), abamectin (1), acetoprole [CCN], alanycarb (15), aldicarb (16), aldoxycarb (863), AZ 60541 (compound code), benclothiaz [CCN], benomyl (62), butylpyridaben (alternative name), cadusafos (109), carbofuran (118), carbon disulfide (945), carbosulfan (119), chloropicrin (141), chlorpyrifos (145), cloethocarb (999), cytokinins (alternative name) (210), dazomet (216), DBCP (1045), DCIP (218), diamidafos (1044), dichlofenthion (1051), dicliphos (alternative name), dimethoate (262), doramectin (alternative name) [CCN], emamectin (291), emamectin benzoate (291), eprinomectin (alternative name) [CCN], ethoprophos (312), ethylene dibromide (316), fenamiphos (326), fenpyrad (alternative name), fensulfothion (1158), fosthiazate (408), fosthietan (1196), furfural (alternative name) [CCN], GY-81 (development code) (423), heterophos [CCN], iodomethane (IUPAC name) (542), isamidofos (1230), isazofos (1231), ivermectin (alternative name) [CCN], kinetin (alternative name) (210), mecarphon (1258), metam (519), metam-potassium (alternative name) (519), metam-sodium (519), methyl bromide (537), methyl isothiocyanate (543), milbemycin oxime (alternative name) [CCN], moxidectin (alternative name) [CCN], Myrothecium verrucaria composition (alternative name) (565), NC-184 (compound code), oxamyl (602), phorate (636), phosphamidon (639), phosphocarb [CCN], sebufos (alternative name), selamectin (alternative name) [CCN], spinosad (737), terbam (alternative name), terbufos (773), tetrachlorothiophene (IUPAC/Chemical Abstracts name) (1422), thiafenox (alternative name), thionazin (1434), triazophos (820), triazuron (alternative name), xylenols [CCN], YI-5302 (compound code) and zeatin (alternative name) (210),
a nitrification inhibitor selected from the group of substances consisting of potassium ethylxanthate [CCN] and nitrapyrin (580),
a plant activator selected from the group of substances consisting of acibenzolar (6), acibenzolar-5-methyl (6), probenazole (658) and Reynoutria sachalinensis extract (alternative name) (720),
a rodenticide selected from the group of substances consisting of 2-isovalerylindan-1,3-dione (IUPAC name) (1246), 4-(quinoxalin-2-ylamino)benzenesulfonamide (IUPAC name) (748), alpha-chlorohydrin [CCN], aluminium phosphide (640), antu (880), arsenous oxide (882), barium carbonate (891), bisthiosemi (912), brodifacoum (89), bromadiolone (91), bromethalin (92), calcium cyamide (444), chloralose (127), chlorophacinone (140), cholecalciferol (alternative name) (850), coumachlor (1004), coumafuryl (1005), coumatetralyl (175), crimidine (1009), difenacoum (246), difethialone (249), diphacinone (273), ergocalciferol (301), flocoumafen (357), fluoroacetamide (379), flupropadine (1183), flupropadine hydrochloride (1183), gamma-HCH (430), HCH (430), hydrogen cyamide (444), iodomethane (IUPAC name) (542), lindane (430), magnesium phosphide (IUPAC name) (640), methyl bromide (537), norbormide (1318), phosacetim (1336), phosphine (IUPAC name) (640), phosphorus [CCN], pindone (1341), potassium arsenite [CCN], pyrinuron (1371), scilliroside (1390), sodium arsenite [CCN], sodium cyamide (444), sodium fluoro-acetate (735), strychnine (745), thallium sulfate [CCN], warfarin (851) and zinc phosphide (640),
a synergist selected from the group of substances consisting of 2-(2-butoxyethoxy)ethyl piperonylate (IUPAC name) (934), 5-(1,3-benzodioxol-5-yl)-3-hexylcyclohex-2-enone (IUPAC name) (903), farnesol with nerolidol (alternative name) (324), MB-599 (development code) (498), MGK 264 (development code) (296), piperonyl butoxide (649), piprotal (1343), propyl isomer (1358), S421 (development code) (724), sesamex (1393), sesasmolin (1394) and sulfoxide (1406),
an animal repellent selected from the group of substances consisting of anthraquinone (32), chloralose (127), copper naphthenate [CCN], copper oxychloride (171), diazinon (227), dicyclopentadiene (chemical name) (1069), guazatine (422), guazatine acetates (422), methiocarb (530), pyridin-4-amine (IUPAC name) (23), thiram (804), trimethacarb (840), zinc naphthenate [CCN] and ziram (856),
a virucide selected from the group of substances consisting of imanin (alternative name) [CCN] and ribavirin (alternative name) [CCN],
and a wound protectant selected from the group of substances consisting of mercuric oxide (512), octhilinone (590) and thiophanate-methyl (802).

A very especially preferred embodiment of the subject-matter {1.1.22} of the invention is {1.1.22.2} a pesticidal composition comprising a mixture consisting of at least two substances, namely one compound (A) and at least one compound (B), as active ingredient and at least one auxiliary, wherein the compound (A) is the compound of formula (A-22) and the compound (B) is a compound selected from the group of substances consisting of abamectin (1), cyromazine (209), diafenthiuron (226), diazinon (227), emamectin benzoate (291), fenoxycarb (340), fosthiazate (408), lambda-cyhalothrin (198), lufenuron (490), methidathion (529), profenofos (662), pymetrozine (688), tefluthrin (769) and thiamethoxam (792).

The compound of formula (A-22) is known, for example, from the PCT Application WO-03/015519.

A preferred embodiment of the subject-matter {1.1} of the invention is {1.1.23} a pesticidal composition comprising a mixture consisting of at least two substances, namely one compound (A) and at least one compound (B), as active ingredient and at least one auxiliary, wherein the compound (A) is the compound of formula (A-23) 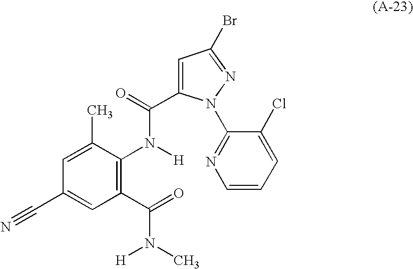
and the compound (B) is a compound selected from the group of substances consisting of an adjuvant, an acaricide, an algicide, an anthelmintic, an avicide, a bactericide, a biological agent, a soil sterilant, a chemosterilant, an insect pheromone, an insect repellent, an insecticide, a molluscicide, a nematicide, a nitrification inhibitor, a plant activator, a rodenticide, a synergist, an animal repellent, a virucide and a wound protectant.

An especially preferred embodiment of the subject-matter {1.1.23} of the invention is {1.1.23.1} a pesticidal composition comprising a mixture consisting of at least two substances, namely one compound (A) and at least one compound (B), as active ingredient and at least one auxiliary, wherein the compound (A) is the compound of formula (A-23) and the compound (B) is a compound selected from the group of substances consisting of
an adjuvant selected from the group of substances consisting of petroleum oils (alternative name) (628),
an acaricide selected from the group of substances consisting of 1,1-bis(4-chlorophenyl)-2-ethoxyethanol (IUPAC name) (910), 2,4-dichlorophenyl benzenesulfonate (IUPAC/Chemical Abstracts name) (1059), 2-fluoro-N-methyl-N-1-naphthylacetamide (IUPAC name) (1295), 4-chlorophenyl phenyl sulfone (IUPAC name) (981), abamectin (1), acequinocyl (3), acetoprole [CCN], acrinathrin (9), aldicarb (16), aldoxycarb (863), alpha-cypermethrin (202), amidithion (870), amidoflumet [CCN], amidothioate (872), amiton (875), amiton hydrogen oxalate (875), amitraz (24), aramite (881), arsenous oxide (882), AVI 382 (compound code), AZ 60541 (compound code), azinphos-ethyl (44), azinphos-methyl (45), azobenzene (IUPAC name) (888), azocyclotin (46), azothoate (889), benomyl (62), benoxafos (alternative name) [CCN], benzoximate (71), benzyl benzoate (IUPAC name) [CCN], bifenazate (74), bifenthrin (76), binapacryl (907), brofenvalerate (alternative name), bromocyclen (918), bromophos (920), bromophos-ethyl (921), bromopropylate (94), buprofezin (99), butocarboxim (103), butoxycarboxim (104), butylpyridaben (alternative name), calcium polysulfide (IUPAC name) (111), camphechlor (941), carbanolate (943), carbaryl (115), carbofuran (118), carbophenothion (947), CGA 50'439 (development code) (125), chinomethionat (126), chlorbenside (959), chlordimeform (964), chlordimeform hydrochloride (964), chlorfenapyr (130), chlorfenethol (968), chlorfenson (970), chlorfensulphide (971), chlorfenvinphos (131), chlorobenzilate (975), chloromebuform (977), chloromethiuron (978), chloropropylate (983), chlorpyrifos (145), chlorpyrifos-methyl (146), chlorthiophos (994), cinerin I (696), cinerin II (696), cinerins (696), clofentezine (158), closantel (alternative name) [CCN], coumaphos (174), crotamiton (alternative name) [CCN], crotoxyphos (1010), cufraneb (1013), cyanthoate (1020), cyhalothrin (196), cyhexatin (199), cypermethrin (201), DCPM (1032), DDT (219), demephion (1037), demephion-O (1037), demephion-S (1037), demeton (1038), demeton-methyl (224), demeton-O (1038), demeton-O-methyl (224), demeton-S (1038), demeton-5-methyl (224), demeton-5-methylsulphon (1039), diafenthiuron (226), dialifos (1042), diazinon (227), dichlofluanid (230), dichlorvos (236), dicliphos (alternative name), dicofol (242), dicrotophos (243), dienochlor (1071), dimefox (1081), dimethoate (262), dinactin (alternative name) (653), dinex (1089), dinex-diclexine (1089), dinobuton (269), dinocap (270), dinocap-4 [CCN], dinocap-6 [CCN], dinocton (1090), dinopenton (1092), dinosulfon (1097), dinoterbon (1098), dioxathion (1102), diphenyl sulfone (IUPAC name) (1103), disulfuram (alternative name) [CCN], disulfoton (278), DNOC (282), dofenapyn (1113), doramectin (alternative name) [CCN], endosulfan (294), endothion (1121), EPN (297), eprinomectin (alternative name) [CCN], ethion (309), ethoate-methyl (1134), etoxazole (320), etrimfos (1142), fenazaflor (1147), fenazaquin (328), fenbutatin oxide (330), fenothiocarb (337), fenpropathrin (342), fenpyrad (alternative name), fenpyroximate (345), fenson (1157), fentrifanil (1161), fenvalerate (349), fipronil (354), fluacrypyrim (360), fluazuron (1166), flubenzimine (1167), flucycloxuron (366), flucythrinate (367), fluenetil (1169), flufenoxuron (370), flumethrin (372), fluorbenside (1174), fluvalinate (1184), FMC 1137 (development code) (1185), formetanate (405), formetanate hydrochloride (405), formothion (1192), formparanate (1193), gamma-HCH (430), glyodin (1205), halfenprox (424), heptenophos (432), hexadecyl cyclopropanecarboxylate (IUPAC/Chemical Abstracts name) (1216), hexythiazox (441), iodomethane (IUPAC name) (542), isocarbophos (alternative name) (473), isopropyl O-(methoxyaminothiophosphoryl)salicylate (IUPAC name) (473), ivermectin (alternative name) [CCN], jasmolin I (696), jasmolin II (696), jodfenphos (1248), lindane (430), lufenuron (490), malathion (492), malonoben (1254), mecarbam (502), mephosfolan (1261), mesulfen (alternative name) [CCN], methacrifos (1266), methamidophos (527), methidathion (529), methiocarb (530), methomyl (531), methyl bromide (537), metolcarb (550), mevinphos (556), mexacarbate (1290), milbemectin (557), milbemycin oxime (alternative name) [CCN], mipafox (1293), monocrotophos (561), morphothion (1300), moxidectin (alternative name) [CCN], naled (567), NC-184 (compound code), nifluridide (1309), nikkomycins (alternative name) [CCN], nitrilacarb (1313), nitrilacarb 1:1 zinc chloride complex (1313), NNI-0101 (compound code), NNI-0250 (compound code), omethoate (594), oxamyl (602), oxydeprofos (1324), oxydisulfoton (1325), pp′-DDT (219), parathion (615), permethrin (626), petroleum oils (alternative name) (628), phenkapton (1330), phenthoate (631), phorate (636), phosalone (637), phosfolan (1338), phosmet (638), phosphamidon (639), phoxim (642), pirimiphos-methyl (652), polychloroterpenes (traditional name) (1347), polynactins (alternative name) (653), proclonol (1350), profenofos (662), promacyl (1354), propargite (671), propetamphos (673), propoxur (678), prothidathion (1360), prothoate (1362), pyrethrin I (696), pyrethrin II (696), pyrethrins (696), pyridaben (699), pyridaphenthion (701), pyrimidifen (706), pyrimitate (1370), quinalphos (711), quintiofos (1381), R-1492 (development code) (1382), RA-17 (development code) (1383), rotenone (722), schradan (1389), sebufos (alternative name), selamectin (alternative name) [CCN], SI-0009 (compound code), sophamide (1402), spirodiclofen (738), spiromesifen (739), SSI-121 (development code) (1404), sulfuram (alternative name) [CCN], sulfluramid (750), sulfotep (753), sulfur (754), SZI-121 (development code) (757), tau-fluvalinate (398), tebufenpyrad (763), TEPP (1417), terbam (alternative name), tetrachlorvinphos (777), tetradifon (786), tetranactin (alternative name) (653), tetrasul (1425), thiafenox (alternative name), thiocarboxime (1431), thiofanox (800), thiometon (801), thioquinox (1436), thuringiensin (alternative name) [CCN], triamiphos (1441), triarathene (1443), triazophos (820), triazuron (alternative name), trichlorfon (824), trifenofos (1455), trinactin (alternative name) (653), vamidothion (847), vaniliprole [CCN] and YI-5302 (compound code),
an algicide selected from the group of substances consisting of bethoxazin [CCN], copper dioctanoate (IUPAC name) (170), copper sulfate (172), cybutryne [CCN], dichlone (1052), dichlorophen (232), endothal (295), fentin (347), hydrated lime [CCN], nabam (566), quinoclamine (714), quinonamid (1379), simazine (730), triphenyltin acetate (IUPAC name) (347) and triphenyltin hydroxide (IUPAC name) (347),
an anthelmintic selected from the group of substances consisting of abamectin (1), crufomate (1011), doramectin (alternative name) [CCN], emamectin (291), emamectin benzoate (291), eprinomectin (alternative name) [CCN], ivermectin (alternative name) [CCN], milbemycin oxime (alternative name) [CCN], moxidectin (alternative name) [CCN], piperazine [CCN], selamectin (alternative name) [CCN], spinosad (737) and thiophanate (1435),
an avicide selected from the group of substances consisting of chloralose (127), endrin (1122), fenthion (346), pyridin-4-amine (IUPAC name) (23) and strychnine (745),
a bactericide selected from the group of substances consisting of 1-hydroxy-1H-pyridine-2-thione (IUPAC name) (1222), 4-(quinoxalin-2-ylamino)benzenesulfonamide (IUPAC name) (748), 8-hydroxyquinoline sulfate (446), bronopol (97), copper dioctanoate (IUPAC name) (170), copper hydroxide (IUPAC name) (169), cresol [CCN], dichlorophen (232), dipyrithione (1105), dodicin (1112), fenaminosulf (1144), formaldehyde (404), hydrargaphen (alternative name) [CCN], kasugamycin (483), kasugamycin hydrochloride hydrate (483), nickel bis(dimethyldithiocarbamate) (IUPAC name) (1308), nitrapyrin (580), octhilinone (590), oxolinic acid (606), oxytetracycline (611), potassium hydroxyquinoline sulfate (446), probenazole (658), streptomycin (744), streptomycin sesquisulfate (744), tecloftalam (766) and thiomersal (alternative name) [CCN],
a biological agent selected from the group of substances consisting of Adoxophyes orana GV (alternative name) (12), Agrobacterium radiobacter (alternative name) (13), Amblyseius spp. (alternative name) (19), Anagrapha falcifera NPV (alternative name) (28), Anagrus atomus (alternative name) (29), Aphelinus abdominalis (alternative name) (33), Aphidius colemani (alternative name) (34), Aphidoletes aphidimyza (alternative name) (35), Autographa californica NPV (alternative name) (38), Bacillus firmus (alternative name) (48), Bacillus sphaericus Neide (scientific name) (49), Bacillus thuringiensis Berliner (scientific name) (51), Bacillus thuringiensis subsp. aizawai (scientific name) (51), Bacillus thuringiensis subsp. israelensis (scientific name) (51), Bacillus thuringiensis subsp. japonensis (scientific name) (51), Bacillus thuringiensis subsp. kurstaki (scientific name) (51), Bacillus thuringiensis subsp. tenebrionis (scientific name) (51), Beauveria bassiana (alternative name) (53), Beauveria brongniartii (alternative name) (54), Chrysoperla carnea (alternative name) (151), Cryptolaemus montrouzieri (alternative name) (178), Cydia pomonella GV (alternative name) (191), Dacnusa sibirica (alternative name) (212), Diglyphus isaea (alternative name) (254), Encarsia formosa (scientific name) (293), Eretmocerus eremicus (alternative name) (300), Helicoverpa zea NPV (alternative name) (431), Heterorhabditis bacteriophora and H. megidis (alternative name) (433), Hippodamia convergens (alternative name) (442), Leptomastix dactylopii (alternative name) (488), Macrolophus caliginosus (alternative name) (491), Mamestra brassicae NPV (alternative name) (494), Metaphycus helvolus (alternative name) (522), Metarhizium anisopliae var. acridum (scientific name) (523), Metarhizium anisopliae var. anisopliae (scientific name) (523), Neodiprion sertifer NPV and N. lecontei NPV (alternative name) (575), Orius spp. (alternative name) (596), Paecilomyces fumosoroseus (alternative name) (613), Phytoseiulus persimilis (alternative name) (644), Spodoptera exigua multicapsid nuclear polyhedrosis virus (scientific name) (741), Steinernema bibionis (alternative name) (742), Steinernema carpocapsae (alternative name) (742), Steinernema feltiae (alternative name) (742), Steinernema glaseri (alternative name) (742), Steinernema riobrave (alternative name) (742), Steinernema riobravis (alternative name) (742), Steinernema scapterisci (alternative name) (742), Steinernema spp. (alternative name) (742), Trichogramma spp. (alternative name) (826), Typhlodromus occidentalis (alternative name) (844) and Verticillium lecanii (alternative name) (848),
a soil sterilant selected from the group of substances consisting of iodomethane (IUPAC name) (542) and methyl bromide (537),
a chemosterilant selected from the group of substances consisting of apholate [CCN], bisazir (alternative name) [CCN], busulfan (alternative name) [CCN], diflubenzuron (250), dimatif (alternative name) [CCN], hemel [CCN], hempa [CCN], metepa [CCN], methiotepa [CCN], methyl apholate [CCN], morzid [CCN], penfluoron (alternative name) [CCN], tepa [CCN], thiohempa (alternative name) [CCN], thiotepa (alternative name) [CCN], tretamine (alternative name) [CCN] and uredepa (alternative name) [CCN],
an insect pheromone selected from the group of substances consisting of (E)-dec-5-en-1-yl acetate with (E)-dec-5-en-1-ol (IUPAC name) (222), (E)-tridec-4-en-1-yl acetate (IUPAC name) (829), (E)-6-methylhept-2-en-4-ol (IUPAC name) (541), (E,Z)-tetradeca-4,10-dien-1-yl acetate (IUPAC name) (779), (Z)-dodec-7-en-1-yl acetate (IUPAC name) (285), (Z)-hexadec-11-enal (IUPAC name) (436), (Z)-hexadec-11-en-1-yl acetate (IUPAC name) (437), (Z)-hexadec-13-en-11-yn-1-yl acetate (IUPAC name) (438), (Z)-icos-13-en-10-one (IUPAC name) (448), (Z)-tetradec-7-en-1-al (IUPAC name) (782), (Z)-tetradec-9-en-1-ol (IUPAC name) (783), (Z)-tetradec-9-en-1-yl acetate (IUPAC name) (784), (7E,9Z)-dodeca-7,9-dien-1-yl acetate (IUPAC name) (283), (9Z,11E)-tetradeca-9,11-dien-1-yl acetate (IUPAC name) (780), (9Z,12E)-tetradeca-9,12-dien-1-yl acetate (IUPAC name) (781), 14-methyloctadec-1-ene (IUPAC name) (545), 4-methylnonan-5-ol with 4-methylnonan-5-one (IUPAC name) (544), alpha-multistriatin (alternative name) [CCN], brevicomin (alternative name) [CCN], codlelure (alternative name) [CCN], codlemone (alternative name) (167), cuelure (alternative name) (179), disparlure (277), dodec-8-en-1-yl acetate (IUPAC name) (286), dodec-9-en-1-yl acetate (IUPAC name) (287), dodeca-8,10-dien-1-yl acetate (IUPAC name) (284), dominicalure (alternative name) [CCN], ethyl 4-methyloctanoate (IUPAC name) (317), eugenol (alternative name) [CCN], frontalin (alternative name) [CCN], gossyplure (alternative name) (420), grandlure (421), grandlure I (alternative name) (421), grandlure II (alternative name) (421), grandlure III (alternative name) (421), grandlure IV (alternative name) (421), hexylure [CCN], ipsdienol (alternative name) [CCN], ipsenol (alternative name) [CCN], japonilure (alternative name) (481), lineatin (alternative name) [CCN], litlure (alternative name) [CCN], looplure (alternative name) [CCN], medlure [CCN], megatomoic acid (alternative name) [CCN], methyl eugenol (alternative name) (540), muscalure (563), octadeca-2,13-dien-1-yl acetate (IUPAC name) (588), octadeca-3,13-dien-1-yl acetate (IUPAC name) (589), orfralure (alternative name) [CCN], oryctalure (alternative name) (317), ostramone (alternative name) [CCN], siglure [CCN], sordidin (alternative name) (736), sulcatol (alternative name) [CCN], tetradec-11-en-1-yl acetate (IUPAC name) (785), trimedlure (839), trimedlure A (alternative name) (839), trimedlure B₁ (alternative name) (839), trimedlure B₂ (alternative name) (839), trimedlure C (alternative name) (839) and trunc-call (alternative name) [CCN],
an insect repellent selected from the group of substances consisting of 2-(octylthio)-ethanol (IUPAC name) (591), butopyronoxyl (933), butoxy(polypropylene glycol) (936), dibutyl adipate (IUPAC name) (1046), dibutyl phthalate (1047), dibutyl succinate (IUPAC name) (1048), diethyltoluamide [CCN], dimethyl carbate [CCN], dimethyl phthalate [CCN], ethyl hexanediol (1137), hexamide [CCN], methoquin-butyl (1276), methylneodecanamide [CCN], oxamate [CCN] and picaridin [CCN],
an insecticide selected from the group of substances consisting of 1,1-dichloro-1-nitroethane (IUPAC/Chemical Abstracts name) (1058), 1,1-dichloro-2,2-bis(4-ethylphenyl)-ethane (IUPAC name) (1056), 1,2-dichloropropane (IUPAC/Chemical Abstracts name) (1062), 1,2-dichloropropane with 1,3-dichloropropene (IUPAC name) (1063), 1-bromo-2-chloroethane (IUPAC/Chemical Abstracts name) (916), 2,2,2-trichloro-1-(3,4-dichloro-phenyl)ethyl acetate (IUPAC name) (1451), 2,2-dichlorovinyl 2-ethylsulfinylethyl methyl phosphate (IUPAC name) (1066), 2-(1,3-dithiolan-2-yl)phenyl dimethylcarbamate (IUPAC/Chemical Abstracts name) (1109), 2-(2-butoxyethoxy)ethyl thiocyanate (IUPAC/Chemical Abstracts name) (935), 2-(4,5-dimethyl-1,3-dioxolan-2-yl)phenyl methylcarbamate (IUPAC/Chemical Abstracts name) (1084), 2-(4-chloro-3,5-xylyloxy)ethanol (IUPAC name) (986), 2-chlorovinyl diethyl phosphate (IUPAC name) (984), 2-imidazolidone (IUPAC name) (1225), 2-isovalerylindan-1,3-dione (IUPAC name) (1246), 2-methyl(prop-2-ynyl)aminophenyl methylcarbamate (IUPAC name) (1284), 2-thiocyanatoethyl laurate (IUPAC name) (1433), 3-bromo-1-chloroprop-1-ene (IUPAC name) (917), 3-methyl-1-phenylpyrazol-5-yl dimethyl-carbamate (IUPAC name) (1283), 4-methyl(prop-2-ynyl)amino-3,5-xylyl methylcarbamate (IUPAC name) (1285), 5,5-dimethyl-3-oxocyclohex-1-enyl dimethylcarbamate (IUPAC name) (1085), abamectin (1), acephate (2), acetamiprid (4), acethion (alternative name) [CCN], acetoprole [CCN], acrinathrin (9), acrylonitrile (IUPAC name) (861), alanycarb (15), aldicarb (16), aldoxycarb (863), aldrin (864), allethrin (17), allosamidin (alternative name) [CCN], allyxycarb (866), alpha-cypermethrin (202), alpha-ecdysone (alternative name) [CCN], aluminium phosphide (640), amidithion (870), amidothioate (872), aminocarb (873), amiton (875), amiton hydrogen oxalate (875), amitraz (24), anabasine (877), athidathion (883), AVI 382 (compound code), AZ 60541 (compound code), azadirachtin (alternative name) (41), azamethiphos (42), azinphos-ethyl (44), azinphos-methyl (45), azothoate (889), Bacillus thuringiensis delta endotoxins (alternative name) (52), barium hexafluorosilicate (alternative name) [CCN], barium polysulfide (IUPAC/Chemical Abstracts name) (892), barthrin [CCN], BAS 320 I (compound code), Bayer 22/190 (development code) (893), Bayer 22408 (development code) (894), bendiocarb (58), benfuracarb (60), bensultap (66), beta-cyfluthrin (194), beta-cypermethrin (203), bifenthrin (76), bioallethrin (78), bioallethrin S-cyclopentenyl isomer (alternative name) (79), bioethanomethrin [CCN], biopermethrin (908), bioresmethrin (80), bis(2-chloroethyl)ether (IUPAC name) (909), bistrifluoron (83), borax (86), brofenvalerate (alternative name), bromfenvinfos (914), bromocyclen (918), bromo-DDT (alternative name) [CCN], bromophos (920), bromophos-ethyl (921), bufencarb (924), buprofezin (99), butacarb (926), butathiofos (927), butocarboxim (103), butonate (932), butoxycarboxim (104), butylpyridaben (alternative name), cadusafos (109), calcium arsenate [CCN], calcium cyamide (444), calcium polysulfide (IUPAC name) (111), camphechlor (941), carbanolate (943), carbaryl (115), carbofuran (118), carbon disulfide (IUPAC/Chemical Abstracts name) (945), carbon tetrachloride (IUPAC name) (946), carbophenothion (947), carbosulfan (119), cartap (123), cartap hydrochloride (123), cevadine (alternative name) (725), chlorbicyclen (960), chlordane (128), chlordecone (963), chlordimeform (964), chlordimeform hydrochloride (964), chlorethoxyfos (129), chlorfenapyr (130), chlorfenvinphos (131), chlorfluazuron (132), chlormephos (136), chloroform [CCN], chloropicrin (141), chlorphoxim (989), chlorprazophos (990), chlorpyrifos (145), chlorpyrifos-methyl (146), chlorthiophos (994), chromafenozide (150), cinerin I (696), cinerin II (696), cinerins (696), cis-resmethrin (alternative name), cismethrin (80), clocythrin (alternative name), cloethocarb (999), closantel (alternative name) [CCN], clothianidin (165), copper acetoarsenite [CCN], copper arsenate [CCN], copper oleate [CCN], coumaphos (174), coumithoate (1006), crotamiton (alternative name) [CCN], crotoxyphos (1010), crufomate (1011), cryolite (alternative name) (177), CS 708 (development code) (1012), cyanofenphos (1019), cyanophos (184), cyanthoate (1020), cyclethrin [CCN], cycloprothrin (188), cyfluthrin (193), cyhalothrin (196), cypermethrin (201), cyphenothrin (206), cyromazine (209), cythioate (alternative name) [CCN], d-limonene (alternative name) [CCN], d-tetramethrin (alternative name) (788), DAEP (1031), dazomet (216), DDT (219), decarbofuran (1034), deltamethrin (223), demephion (1037), demephion-O (1037), demephion-S (1037), demeton (1038), demeton-methyl (224), demeton-O (1038), demeton-O-methyl (224), demeton-S (1038), demeton-5-methyl (224), demeton-5-methylsulphon (1039), diafenthiuron (226), dialifos (1042), diamidafos (1044), diazinon (227), dicapthon (1050), dichlofenthion (1051), dichlorvos (236), dicliphos (alternative name), dicresyl (alternative name) [CCN], dicrotophos (243), dicyclanil (244), dieldrin (1070), diethyl 5-methylpyrazol-3-yl phosphate (IUPAC name) (1076), diflubenzuron (250), dilor (alternative name) [CCN], dimefluthrin [CCN], dimefox (1081), dimetan (1085), dimethoate (262), dimethrin (1083), dimethylvinphos (265), dimetilan (1086), dinex (1089), dinex-diclexine (1089), dinoprop (1093), dinosam (1094), dinoseb (1095), dinotefuran (271), diofenolan (1099), dioxabenzofos (1100), dioxacarb (1101), dioxathion (1102), disulfoton (278), dithicrofos (1108), DNOC (282), doramectin (alternative name) [CCN], DSP (1115), ecdysterone (alternative name) [CCN], EI 1642 (development code) (1118), emamectin (291), emamectin benzoate (291), EMPC (1120), empenthrin (292), endosulfan (294), endothion (1121), endrin (1122), EPBP (1123), EPN (297), epofenonane (1124), eprinomectin (alternative name) [CCN], esfenvalerate (302), etaphos (alternative name) [CCN], ethiofencarb (308), ethion (309), ethiprole (310), ethoate-methyl (1134), ethoprophos (312), ethyl formate (IUPAC name) [CCN], ethyl-DDD (alternative name) (1056), ethylene dibromide (316), ethylene dichloride (chemical name) (1136), ethylene oxide [CCN], etofenprox (319), etrimfos (1142), EXD (1143), famphur (323), fenamiphos (326), fenazaflor (1147), fenchlorphos (1148), fenethacarb (1149), fenfluthrin (1150), fenitrothion (335), fenobucarb (336), fenoxacrim (1153), fenoxycarb (340), fenpirithrin (1155), fenpropathrin (342), fenpyrad (alternative name), fensulfothion (1158), fenthion (346), fenthion-ethyl [CCN], fenvalerate (349), fipronil (354), flonicamid (358), flucofuron (1168), flucycloxuron (366), flucythrinate (367), fluenetil (1169), flufenerim [CCN], flufenoxuron (370), flufenprox (1171), flumethrin (372), fluvalinate (1184), FMC 1137 (development code) (1185), fonofos (1191), formetanate (405), formetanate hydrochloride (405), formothion (1192), formparanate (1193), fosmethilan (1194), fospirate (1195), fosthiazate (408), fosthietan (1196), furathiocarb (412), furethrin (1200), gamma-cyhalothrin (197), gamma-HCH (430), guazatine (422), guazatine acetates (422), GY-81 (development code) (423), halfenprox (424), halofenozide (425), HCH (430), HEOD (1070), heptachlor (1211), heptenophos (432), heterophos [CCN], hexaflumuron (439), HHDN (864), hydramethylnon (443), hydrogen cyamide (444), hydroprene (445), hyquincarb (1223), imidacloprid (458), imiprothrin (460), indoxacarb (465), iodomethane (IUPAC name) (542), IPSP (1229), isazofos (1231), isobenzan (1232), isocarbophos (alternative name) (473), isodrin (1235), isofenphos (1236), isolane (1237), isoprocarb (472), isopropyl O-(methoxyaminothiophosphoryl)salicylate (IUPAC name) (473), isoprothiolane (474), isothioate (1244), isoxathion (480), ivermectin (alternative name) [CCN], jasmolin I (696), jasmolin II (696), jodfenphos (1248), juvenile hormone I (alternative name) [CCN], juvenile hormone II (alternative name) [CCN], juvenile hormone III (alternative name) [CCN], kelevan (1249), kinoprene (484), lambda-cyhalothrin (198), lead arsenate [CCN], leptophos (1250), lindane (430), lirimfos (1251), lufenuron (490), lythidathion (1253), m-cumenyl methylcarbamate (IUPAC name) (1014), magnesium phosphide (IUPAC name) (640), malathion (492), malonoben (1254), mazidox (1255), mecarbam (502), mecarphon (1258), menazon (1260), mephosfolan (1261), mercurous chloride (513), mesulfenfos (1263), metam (519), metam-potassium (alternative name) (519), metam-sodium (519), methacrifos (1266), methamidophos (527), methanesulfonyl fluoride (IUPAC/Chemical Abstracts name) (1268), methidathion (529), methiocarb (530), methocrotophos (1273), methomyl (531), methoprene (532), methoquin-butyl (1276), methothrin (alternative name) (533), methoxychlor (534), methoxyfenozide (535), methyl bromide (537), methyl isothiocyanate (543), methylchloroform (alternative name) [CCN], methylene chloride [CCN], metofluthrin [CCN], metolcarb (550), metoxadiazone (1288), mevinphos (556), mexacarbate (1290), milbemectin (557), milbemycin oxime (alternative name) [CCN], mipafox (1293), mirex (1294), monocrotophos (561), morphothion (1300), moxidectin (alternative name) [CCN], naftalofos (alternative name) [CCN], naled (567), naphthalene (IUPAC/Chemical Abstracts name) (1303), NC-170 (development code) (1306), NC-184 (compound code), nicotine (578), nicotine sulfate (578), nifluridide (1309), nitenpyram (579), nithiazine (1311), nitrilacarb (1313), nitrilacarb 1:1 zinc chloride complex (1313), NNI-0101 (compound code), NNI-0250 (compound code), nornicotine (traditional name) (1319), novaluron (585), noviflumuron (586), O-2,5-dichloro-4-iodophenyl O-ethyl ethylphosphonothioate (IUPAC name) (1057), O,O-diethyl O-4-methyl-2-oxo-2H-chromen-7-yl phosphorothioate (IUPAC name) (1074), O,O-diethyl O-6-methyl-2-propylpyrimidin-4-yl phosphorothioate (IUPAC name) (1075), O,O,O′,O′-tetrapropyl dithiopyrophosphate (IUPAC name) (1424), oleic acid (IUPAC name) (593), omethoate (594), oxamyl (602), oxydemeton-methyl (609), oxydeprofos (1324), oxydisulfoton (1325), pp′-DDT (219), para-dichlorobenzene [CCN], parathion (615), parathion-methyl (616), penfluoron (alternative name) [CCN], pentachlorophenol (623), pentachlorophenyl laurate (IUPAC name) (623), permethrin (626), petroleum oils (alternative name) (628), PH 60-38 (development code) (1328), phenkapton (1330), phenothrin (630), phenthoate (631), phorate (636), phosalone (637), phosfolan (1338), phosmet (638), phosnichlor (1339), phosphamidon (639), phosphine (IUPAC name) (640), phoxim (642), phoxim-methyl (1340), pirimetaphos (1344), pirimicarb (651), pirimiphos-ethyl (1345), pirimiphos-methyl (652), polychlorodicyclopentadiene isomers (IUPAC name) (1346), polychloroterpenes (traditional name) (1347), potassium arsenite [CCN], potassium thiocyanate [CCN], prallethrin (655), precocene I (alternative name) [CCN], precocene II (alternative name) [CCN], precocene III (alternative name) [CCN], primidophos (1349), profenofos (662), profluthrin [CCN], promacyl (1354), promecarb (1355), propaphos (1356), propetamphos (673), propoxur (678), prothidathion (1360), prothiofos (686), prothoate (1362), protrifenbute [CCN], pymetrozine (688), pyraclofos (689), pyrazophos (693), pyresmethrin (1367), pyrethrin I (696), pyrethrin II (696), pyrethrins (696), pyridaben (699), pyridalyl (700), pyridaphenthion (701), pyrimidifen (706), pyrimitate (1370), pyriproxyfen (708), quassia (alternative name) [CCN], quinalphos (711), quinalphos-methyl (1376), quinothion (1380), quintiofos (1381), R-1492 (development code) (1382), rafoxanide (alternative name) [CCN], resmethrin (719), rotenone (722), RU 15525 (development code) (723), RU 25475 (development code) (1386), ryania (alternative name) (1387), ryanodine (traditional name) (1387), sabadilla (alternative name) (725), schradan (1389), sebufos (alternative name), selamectin (alternative name) [CCN], SI-0009 (compound code), silafluofen (728), SN 72129 (development code) (1397), sodium arsenite [CCN], sodium cyamide (444), sodium fluoride (IUPAC/Chemical Abstracts name) (1399), sodium hexafluorosilicate (1400), sodium pentachlorophenoxide (623), sodium selenate (IUPAC name) (1401), sodium thiocyanate [CCN], sophamide (1402), spinosad (737), spiromesifen (739), sulcofuron (746), sulcofuron-sodium (746), sulfluramid (750), sulfotep (753), sulfuryl fluoride (756), sulprofos (1408), tar oils (alternative name) (758), tau-fluvalinate (398), tazimcarb (1412), TDE (1414), tebufenozide (762), tebufenpyrad (763), tebupirimfos (764), teflubenzuron (768), tefluthrin (769), temephos (770), TEPP (1417), terallethrin (1418), terbam (alternative name), terbufos (773), tetrachloroethane [CCN], tetrachlorvinphos (777), tetramethrin (787), theta-cypermethrin (204), thiacloprid (791), thiafenox (alternative name), thiamethoxam (792), thicrofos (1428), thiocarboxime (1431), thiocyclam (798), thiocyclam hydrogen oxalate (798), thiodicarb (799), thiofanox (800), thiometon (801), thionazin (1434), thiosultap (803), thiosultap-sodium (803), thuringiensin (alternative name) [CCN], tolfenpyrad (809), tralomethrin (812), transfluthrin (813), transpermethrin (1440), triamiphos (1441), triazamate (818), triazophos (820), triazuron (alternative name), trichlorfon (824), trichlormetaphos-3 (alternative name) [CCN], trichloronat (1452), trifenofos (1455), triflumuron (835), trimethacarb (840), triprene (1459), vamidothion (847), vaniliprole [CCN], veratridine (alternative name) (725), veratrine (alternative name) (725), XMC (853), xylylcarb (854), YI-5302 (compound code), zeta-cypermethrin (205), zetamethrin (alternative name), zinc phosphide (640), zolaprofos (1469) and ZXI 8901 (development code) (858),
a molluscicide selected from the group of substances consisting of bis(tributyltin)oxide (IUPAC name) (913), bromoacetamide [CCN], calcium arsenate [CCN], cloethocarb (999), copper acetoarsenite [CCN], copper sulfate (172), fentin (347), ferric phosphate (IUPAC name) (352), metaldehyde (518), methiocarb (530), niclosamide (576), niclosamide-olamine (576), pentachlorophenol (623), sodium pentachlorophenoxide (623), tazimcarb (1412), thiodicarb (799), tributyltin oxide (913), trifenmorph (1454), trimethacarb (840), triphenyltin acetate (IUPAC name) (347) and triphenyltin hydroxide (IUPAC name) (347),
a nematicide selected from the group of substances consisting of 1,2-dibromo-3-chloropropane (IUPAC/Chemical Abstracts name) (1045), 1,2-dichloropropane (IUPAC/Chemical Abstracts name) (1062), 1,2-dichloropropane with 1,3-dichloropropene (IUPAC name) (1063), 1,3-dichloropropene (233), 3,4-dichlorotetrahydrothiophene 1,1-dioxide (IUPAC/Chemical Abstracts name) (1065), 3-(4-chlorophenyl)-5-methylrhodanine (IUPAC name) (980), 5-methyl-6-thioxo-1,3,5-thiadiazinan-3-ylacetic acid (IUPAC name) (1286), 6-isopentenylaminopurine (alternative name) (210), abamectin (1), acetoprole [CCN], alanycarb (15), aldicarb (16), aldoxycarb (863), AZ 60541 (compound code), benclothiaz [CCN], benomyl (62), butylpyridaben (alternative name), cadusafos (109), carbofuran (118), carbon disulfide (945), carbosulfan (119), chloropicrin (141), chlorpyrifos (145), cloethocarb (999), cytokinins (alternative name) (210), dazomet (216), DBCP (1045), DCIP (218), diamidafos (1044), dichlofenthion (1051), dicliphos (alternative name), dimethoate (262), doramectin (alternative name) [CCN], emamectin (291), emamectin benzoate (291), eprinomectin (alternative name) [CCN], ethoprophos (312), ethylene dibromide (316), fenamiphos (326), fenpyrad (alternative name), fensulfothion (1158), fosthiazate (408), fosthietan (1196), furfural (alternative name) [CCN], GY-81 (development code) (423), heterophos [CCN], iodomethane (IUPAC name) (542), isamidofos (1230), isazofos (1231), ivermectin (alternative name) [CCN], kinetin (alternative name) (210), mecarphon (1258), metam (519), metam-potassium (alternative name) (519), metam-sodium (519), methyl bromide (537), methyl isothiocyanate (543), milbemycin oxime (alternative name) [CCN], moxidectin (alternative name) [CCN], Myrothecium verrucaria composition (alternative name) (565), NC-184 (compound code), oxamyl (602), phorate (636), phosphamidon (639), phosphocarb [CCN], sebufos (alternative name), selamectin (alternative name) [CCN], spinosad (737), terbam (alternative name), terbufos (773), tetrachlorothiophene (IUPAC/Chemical Abstracts name) (1422), thiafenox (alternative name), thionazin (1434), triazophos (820), triazuron (alternative name), xylenols [CCN], YI-5302 (compound code) and zeatin (alternative name) (210),
a nitrification inhibitor selected from the group of substances consisting of potassium ethylxanthate [CCN] and nitrapyrin (580),
a plant activator selected from the group of substances consisting of acibenzolar (6), acibenzolar-5-methyl (6), probenazole (658) and Reynoutria sachalinensis extract (alternative name) (720),
a rodenticide selected from the group of substances consisting of 2-isovalerylindan-1,3-dione (IUPAC name) (1246), 4-(quinoxalin-2-ylamino)benzenesulfonamide (IUPAC name) (748), alpha-chlorohydrin [CCN], aluminium phosphide (640), antu (880), arsenous oxide (882), barium carbonate (891), bisthiosemi (912), brodifacoum (89), bromadiolone (91), bromethalin (92), calcium cyamide (444), chloralose (127), chlorophacinone (140), cholecalciferol (alternative name) (850), coumachlor (1004), coumafuryl (1005), coumatetralyl (175), crimidine (1009), difenacoum (246), difethialone (249), diphacinone (273), ergocalciferol (301), flocoumafen (357), fluoroacetamide (379), flupropadine (1183), flupropadine hydrochloride (1183), gamma-HCH (430), HCH (430), hydrogen cyamide (444), iodomethane (IUPAC name) (542), lindane (430), magnesium phosphide (IUPAC name) (640), methyl bromide (537), norbormide (1318), phosacetim (1336), phosphine (IUPAC name) (640), phosphorus [CCN], pindone (1341), potassium arsenite [CCN], pyrinuron (1371), scilliroside (1390), sodium arsenite [CCN], sodium cyamide (444), sodium fluoro-acetate (735), strychnine (745), thallium sulfate [CCN], warfarin (851) and zinc phosphide (640),
a synergist selected from the group of substances consisting of 2-(2-butoxyethoxy)ethyl piperonylate (IUPAC name) (934), 5-(1,3-benzodioxol-5-yl)-3-hexylcyclohex-2-enone (IUPAC name) (903), farnesol with nerolidol (alternative name) (324), MB-599 (development code) (498), MGK 264 (development code) (296), piperonyl butoxide (649), piprotal (1343), propyl isomer (1358), S421 (development code) (724), sesamex (1393), sesasmolin (1394) and sulfoxide (1406),
an animal repellent selected from the group of substances consisting of anthraquinone (32), chloralose (127), copper naphthenate [CCN], copper oxychloride (171), diazinon (227), dicyclopentadiene (chemical name) (1069), guazatine (422), guazatine acetates (422), methiocarb (530), pyridin-4-amine (IUPAC name) (23), thiram (804), trimethacarb (840), zinc naphthenate [CCN] and ziram (856),
a virucide selected from the group of substances consisting of imanin (alternative name) [CCN] and ribavirin (alternative name) [CCN],
and a wound protectant selected from the group of substances consisting of mercuric oxide (512), octhilinone (590) and thiophanate-methyl (802).

A very especially preferred embodiment of the subject-matter {1.1.23} of the invention is {1.1.23.2} a pesticidal composition comprising a mixture consisting of at least two substances, namely one compound (A) and at least one compound (B), as active ingredient and at least one auxiliary, wherein the compound (A) is the compound of formula (A-23) and the compound (B) is a compound selected from the group of substances consisting of abamectin (1), cyromazine (209), diafenthiuron (226), diazinon (227), emamectin benzoate (291), fenoxycarb (340), fosthiazate (408), lambda-cyhalothrin (198), lufenuron (490), methidathion (529), profenofos (662), pymetrozine (688), tefluthrin (769) and thiamethoxam (792).

The compound of formula (A-23) is known, for example, from the PCT Application WO-04/067528.

A preferred embodiment of the subject-matter {1.1} of the invention is {1.1.24} a pesticidal composition comprising a mixture consisting of at least two substances, namely one compound (A) and at least one compound (B), as active ingredient and at least one auxiliary, wherein the compound (A) is the compound of formula (A-24) 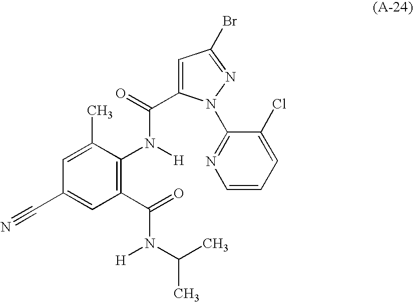
and the compound (B) is a compound selected from the group of substances consisting of an adjuvant, an acaricide, an algicide, an anthelmintic, an avicide, a bactericide, a biological agent, a soil sterilant, a chemosterilant, an insect pheromone, an insect repellent, an insecticide, a molluscicide, a nematicide, a nitrification inhibitor, a plant activator, a rodenticide, a synergist, an animal repellent, a virucide and a wound protectant.

An especially preferred embodiment of the subject-matter {1.1.24} of the invention is {1.1.24.1} a pesticidal composition comprising a mixture consisting of at least two substances, namely one compound (A) and at least one compound (B), as active ingredient and at least one auxiliary, wherein the compound (A) is the compound of formula (A-24) and the compound (B) is a compound selected from the group of substances consisting of
an adjuvant selected from the group of substances consisting of petroleum oils (alternative name) (628),
an acaricide selected from the group of substances consisting of 1,1-bis(4-chlorophenyl)-2-ethoxyethanol (IUPAC name) (910), 2,4-dichlorophenyl benzenesulfonate (IUPAC/Chemical Abstracts name) (1059), 2-fluoro-N-methyl-N-1-naphthylacetamide (IUPAC name) (1295), 4-chlorophenyl phenyl sulfone (IUPAC name) (981), abamectin (1), acequinocyl (3), acetoprole [CCN], acrinathrin (9), aldicarb (16), aldoxycarb (863), alpha-cypermethrin (202), amidithion (870), amidoflumet [CCN], amidothioate (872), amiton (875), amiton hydrogen oxalate (875), amitraz (24), aramite (881), arsenous oxide (882), AVI 382 (compound code), AZ 60541 (compound code), azinphos-ethyl (44), azinphos-methyl (45), azobenzene (IUPAC name) (888), azocyclotin (46), azothoate (889), benomyl (62), benoxafos (alternative name) [CCN], benzoximate (71), benzyl benzoate (IUPAC name) [CCN], bifenazate (74), bifenthrin (76), binapacryl (907), brofenvalerate (alternative name), bromocyclen (918), bromophos (920), bromophos-ethyl (921), bromopropylate (94), buprofezin (99), butocarboxim (103), butoxycarboxim (104), butylpyridaben (alternative name), calcium polysulfide (IUPAC name) (111), camphechlor (941), carbanolate (943), carbaryl (115), carbofuran (118), carbophenothion (947), CGA 50'439 (development code) (125), chinomethionat (126), chlorbenside (959), chlordimeform (964), chlordimeform hydrochloride (964), chlorfenapyr (130), chlorfenethol (968), chlorfenson (970), chlorfensulphide (971), chlorfenvinphos (131), chlorobenzilate (975), chloromebuform (977), chloromethiuron (978), chloropropylate (983), chlorpyrifos (145), chlorpyrifos-methyl (146), chlorthiophos (994), cinerin I (696), cinerin II (696), cinerins (696), clofentezine (158), closantel (alternative name) [CCN], coumaphos (174), crotamiton (alternative name) [CCN], crotoxyphos (1010), cufraneb (1013), cyanthoate (1020), cyhalothrin (196), cyhexatin (199), cypermethrin (201), DCPM (1032), DDT (219), demephion (1037), demephion-O (1037), demephion-S (1037), demeton (1038), demeton-methyl (224), demeton-O (1038), demeton-O-methyl (224), demeton-S (1038), demeton-5-methyl (224), demeton-5-methylsulphon (1039), diafenthiuron (226), dialifos (1042), diazinon (227), dichlofluanid (230), dichlorvos (236), dicliphos (alternative name), dicofol (242), dicrotophos (243), dienochlor (1071), dimefox (1081), dimethoate (262), dinactin (alternative name) (653), dinex (1089), dinex-diclexine (1089), dinobuton (269), dinocap (270), dinocap-4 [CCN], dinocap-6 [CCN], dinocton (1090), dinopenton (1092), dinosulfon (1097), dinoterbon (1098), dioxathion (1102), diphenyl sulfone (IUPAC name) (1103), disulfuram (alternative name) [CCN], disulfoton (278), DNOC (282), dofenapyn (1113), doramectin (alternative name) [CCN], endosulfan (294), endothion (1121), EPN (297), eprinomectin (alternative name) [CCN], ethion (309), ethoate-methyl (1134), etoxazole (320), etrimfos (1142), fenazaflor (1147), fenazaquin (328), fenbutatin oxide (330), fenothiocarb (337), fenpropathrin (342), fenpyrad (alternative name), fenpyroximate (345), fenson (1157), fentrifanil (1161), fenvalerate (349), fipronil (354), fluacrypyrim (360), fluazuron (1166), flubenzimine (1167), flucycloxuron (366), flucythrinate (367), fluenetil (1169), flufenoxuron (370), flumethrin (372), fluorbenside (1174), fluvalinate (1184), FMC 1137 (development code) (1185), formetanate (405), formetanate hydrochloride (405), formothion (1192), formparanate (1193), gamma-HCH (430), glyodin (1205), halfenprox (424), heptenophos (432), hexadecyl cyclopropanecarboxylate (IUPAC/Chemical Abstracts name) (1216), hexythiazox (441), iodomethane (IUPAC name) (542), isocarbophos (alternative name) (473), isopropyl O-(methoxyaminothiophosphoryl)salicylate (IUPAC name) (473), ivermectin (alternative name) [CCN], jasmolin I (696), jasmolin II (696), jodfenphos (1248), lindane (430), lufenuron (490), malathion (492), malonoben (1254), mecarbam (502), mephosfolan (1261), mesulfen (alternative name) [CCN], methacrifos (1266), methamidophos (527), methidathion (529), methiocarb (530), methomyl (531), methyl bromide (537), metolcarb (550), mevinphos (556), mexacarbate (1290), milbemectin (557), milbemycin oxime (alternative name) [CCN], mipafox (1293), monocrotophos (561), morphothion (1300), moxidectin (alternative name) [CCN], naled (567), NC-184 (compound code), nifluridide (1309), nikkomycins (alternative name) [CCN], nitrilacarb (1313), nitrilacarb 1:1 zinc chloride complex (1313), NNI-0101 (compound code), NNI-0250 (compound code), omethoate (594), oxamyl (602), oxydeprofos (1324), oxydisulfoton (1325), pp′-DDT (219), parathion (615), permethrin (626), petroleum oils (alternative name) (628), phenkapton (1330), phenthoate (631), phorate (636), phosalone (637), phosfolan (1338), phosmet (638), phosphamidon (639), phoxim (642), pirimiphos-methyl (652), polychloroterpenes (traditional name) (1347), polynactins (alternative name) (653), proclonol (1350), profenofos (662), promacyl (1354), propargite (671), propetamphos (673), propoxur (678), prothidathion (1360), prothoate (1362), pyrethrin I (696), pyrethrin II (696), pyrethrins (696), pyridaben (699), pyridaphenthion (701), pyrimidifen (706), pyrimitate (1370), quinalphos (711), quintiofos (1381), R-1492 (development code) (1382), RA-17 (development code) (1383), rotenone (722), schradan (1389), sebufos (alternative name), selamectin (alternative name) [CCN], SI-0009 (compound code), sophamide (1402), spirodiclofen (738), spiromesifen (739), SSI-121 (development code) (1404), sulfuram (alternative name) [CCN], sulfluramid (750), sulfotep (753), sulfur (754), SZI-121 (development code) (757), tau-fluvalinate (398), tebufenpyrad (763), TEPP (1417), terbam (alternative name), tetrachlorvinphos (777), tetradifon (786), tetranactin (alternative name) (653), tetrasul (1425), thiafenox (alternative name), thiocarboxime (1431), thiofanox (800), thiometon (801), thioquinox (1436), thuringiensin (alternative name) [CCN], triamiphos (1441), triarathene (1443), triazophos (820), triazuron (alternative name), trichlorfon (824), trifenofos (1455), trinactin (alternative name) (653), vamidothion (847), vaniliprole [CCN] and YI-5302 (compound code),
an algicide selected from the group of substances consisting of bethoxazin [CCN], copper dioctanoate (IUPAC name) (170), copper sulfate (172), cybutryne [CCN], dichlone (1052), dichlorophen (232), endothal (295), fentin (347), hydrated lime [CCN], nabam (566), quinoclamine (714), quinonamid (1379), simazine (730), triphenyltin acetate (IUPAC name) (347) and triphenyltin hydroxide (IUPAC name) (347),
an anthelmintic selected from the group of substances consisting of abamectin (1), crufomate (1011), doramectin (alternative name) [CCN], emamectin (291), emamectin benzoate (291), eprinomectin (alternative name) [CCN], ivermectin (alternative name) [CCN], milbemycin oxime (alternative name) [CCN], moxidectin (alternative name) [CCN], piperazine [CCN], selamectin (alternative name) [CCN], spinosad (737) and thiophanate (1435),
an avicide selected from the group of substances consisting of chloralose (127), endrin (1122), fenthion (346), pyridin-4-amine (IUPAC name) (23) and strychnine (745),
a bactericide selected from the group of substances consisting of 1-hydroxy-1H-pyridine-2-thione (IUPAC name) (1222), 4-(quinoxalin-2-ylamino)benzenesulfonamide (IUPAC name) (748), 8-hydroxyquinoline sulfate (446), bronopol (97), copper dioctanoate (IUPAC name) (170), copper hydroxide (IUPAC name) (169), cresol [CCN], dichlorophen (232), dipyrithione (1105), dodicin (1112), fenaminosulf (1144), formaldehyde (404), hydrargaphen (alternative name) [CCN], kasugamycin (483), kasugamycin hydrochloride hydrate (483), nickel bis(dimethyldithiocarbamate) (IUPAC name) (1308), nitrapyrin (580), octhilinone (590), oxolinic acid (606), oxytetracycline (611), potassium hydroxyquinoline sulfate (446), probenazole (658), streptomycin (744), streptomycin sesquisulfate (744), tecloftalam (766) and thiomersal (alternative name) [CCN],
a biological agent selected from the group of substances consisting of Adoxophyes orana GV (alternative name) (12), Agrobacterium radiobacter (alternative name) (13), Amblyseius spp. (alternative name) (19), Anagrapha falcifera NPV (alternative name) (28), Anagrus atomus (alternative name) (29), Aphelinus abdominalis (alternative name) (33), Aphidius colemani (alternative name) (34), Aphidoletes aphidimyza (alternative name) (35), Autographa californica NPV (alternative name) (38), Bacillus firmus (alternative name) (48), Bacillus sphaericus Neide (scientific name) (49), Bacillus thuringiensis Berliner (scientific name) (51), Bacillus thuringiensis subsp. aizawai (scientific name) (51), Bacillus thuringiensis subsp. israelensis (scientific name) (51), Bacillus thuringiensis subsp. japonensis (scientific name) (51), Bacillus thuringiensis subsp. kurstaki (scientific name) (51), Bacillus thuringiensis subsp. tenebrionis (scientific name) (51), Beauveria bassiana (alternative name) (53), Beauveria brongniartii (alternative name) (54), Chrysoperla carnea (alternative name) (151), Cryptolaemus montrouzieri (alternative name) (178), Cydia pomonella GV (alternative name) (191), Dacnusa sibirica (alternative name) (212), Diglyphus isaea (alternative name) (254), Encarsia formosa (scientific name) (293), Eretmocerus eremicus (alternative name) (300), Helicoverpa zea NPV (alternative name) (431), Heterorhabditis bacteriophora and H. megidis (alternative name) (433), Hippodamia convergens (alternative name) (442), Leptomastix dactylopii (alternative name) (488), Macrolophus caliginosus (alternative name) (491), Mamestra brassicae NPV (alternative name) (494), Metaphycus helvolus (alternative name) (522), Metarhizium anisopliae var. acridum (scientific name) (523), Metarhizium anisopliae var. anisopliae (scientific name) (523), Neodiprion sertifer NPV and N. lecontei NPV (alternative name) (575), Orius spp. (alternative name) (596), Paecilomyces fumosoroseus (alternative name) (613), Phytoseiulus persimilis (alternative name) (644), Spodoptera exigua multicapsid nuclear polyhedrosis virus (scientific name) (741), Steinernema bibionis (alternative name) (742), Steinernema carpocapsae (alternative name) (742), Steinernema feltiae (alternative name) (742), Steinernema glaseri (alternative name) (742), Steinernema riobrave (alternative name) (742), Steinernema riobravis (alternative name) (742), Steinernema scapterisci (alternative name) (742), Steinernema spp. (alternative name) (742), Trichogramma spp. (alternative name) (826), Typhlodromus occidentalis (alternative name) (844) and Verticillium lecanii (alternative name) (848),
a soil sterilant selected from the group of substances consisting of iodomethane (IUPAC name) (542) and methyl bromide (537),
a chemosterilant selected from the group of substances consisting of apholate [CCN], bisazir (alternative name) [CCN], busulfan (alternative name) [CCN], diflubenzuron (250), dimatif (alternative name) [CCN], hemel [CCN], hempa [CCN], metepa [CCN], methiotepa [CCN], methyl apholate [CCN], morzid [CCN], penfluoron (alternative name) [CCN], tepa [CCN], thiohempa (alternative name) [CCN], thiotepa (alternative name) [CCN], tretamine (alternative name) [CCN] and uredepa (alternative name) [CCN],
an insect pheromone selected from the group of substances consisting of (E)-dec-5-en-1-yl acetate with (E)-dec-5-en-1-ol (IUPAC name) (222), (E)-tridec-4-en-1-yl acetate (IUPAC name) (829), (E)-6-methylhept-2-en-4-ol (IUPAC name) (541), (E,Z)-tetradeca-4,10-dien-1-yl acetate (IUPAC name) (779), (Z)-dodec-7-en-1-yl acetate (IUPAC name) (285), (Z)-hexadec-11-enal (IUPAC name) (436), (Z)-hexadec-11-en-1-yl acetate (IUPAC name) (437), (Z)-hexadec-13-en-11-yn-1-yl acetate (IUPAC name) (438), (Z)-icos-13-en-10-one (IUPAC name) (448), (Z)-tetradec-7-en-1-al (IUPAC name) (782), (Z)-tetradec-9-en-1-ol (IUPAC name) (783), (Z)-tetradec-9-en-1-yl acetate (IUPAC name) (784), (7E,9Z)-dodeca-7,9-dien-1-yl acetate (IUPAC name) (283), (9Z,11E)-tetradeca-9,11-dien-1-yl acetate (IUPAC name) (780), (9Z,12E)-tetradeca-9,12-dien-1-yl acetate (IUPAC name) (781), 14-methyloctadec-1-ene (IUPAC name) (545), 4-methylnonan-5-ol with 4-methylnonan-5-one (IUPAC name) (544), alpha-multistriatin (alternative name) [CCN], brevicomin (alternative name) [CCN], codlelure (alternative name) [CCN], codlemone (alternative name) (167), cuelure (alternative name) (179), disparlure (277), dodec-8-en-1-yl acetate (IUPAC name) (286), dodec-9-en-1-yl acetate (IUPAC name) (287), dodeca-8,10-dien-1-yl acetate (IUPAC name) (284), dominicalure (alternative name) [CCN], ethyl 4-methyloctanoate (IUPAC name) (317), eugenol (alternative name) [CCN], frontalin (alternative name) [CCN], gossyplure (alternative name) (420), grandlure (421), grandlure I (alternative name) (421), grandlure II (alternative name) (421), grandlure III (alternative name) (421), grandlure IV (alternative name) (421), hexylure [CCN], ipsdienol (alternative name) [CCN], ipsenol (alternative name) [CCN], japonilure (alternative name) (481), lineatin (alternative name) [CCN], litlure (alternative name) [CCN], looplure (alternative name) [CCN], medlure [CCN], megatomoic acid (alternative name) [CCN], methyl eugenol (alternative name) (540), muscalure (563), octadeca-2,13-dien-1-yl acetate (IUPAC name) (588), octadeca-3,13-dien-1-yl acetate (IUPAC name) (589), orfralure (alternative name) [CCN], oryctalure (alternative name) (317), ostramone (alternative name) [CCN], siglure [CCN], sordidin (alternative name) (736), sulcatol (alternative name) [CCN], tetradec-11-en-1-yl acetate (IUPAC name) (785), trimedlure (839), trimedlure A (alternative name) (839), trimedlure B₁ (alternative name) (839), trimedlure B₂ (alternative name) (839), trimedlure C (alternative name) (839) and trunc-call (alternative name) [CCN],
an insect repellent selected from the group of substances consisting of 2-(octylthio)-ethanol (IUPAC name) (591), butopyronoxyl (933), butoxy(polypropylene glycol) (936), dibutyl adipate (IUPAC name) (1046), dibutyl phthalate (1047), dibutyl succinate (IUPAC name) (1048), diethyltoluamide [CCN], dimethyl carbate [CCN], dimethyl phthalate [CCN], ethyl hexanediol (1137), hexamide [CCN], methoquin-butyl (1276), methylneodecanamide [CCN], oxamate [CCN] and picaridin [CCN],
an insecticide selected from the group of substances consisting of 1,1-dichloro-1-nitroethane (IUPAC/Chemical Abstracts name) (1058), 1,1-dichloro-2,2-bis(4-ethylphenyl)-ethane (IUPAC name) (1056), 1,2-dichloropropane (IUPAC/Chemical Abstracts name) (1062), 1,2-dichloropropane with 1,3-dichloropropene (IUPAC name) (1063), 1-bromo-2-chloroethane (IUPAC/Chemical Abstracts name) (916), 2,2,2-trichloro-1-(3,4-dichloro-phenyl)ethyl acetate (IUPAC name) (1451), 2,2-dichlorovinyl 2-ethylsulfinylethyl methyl phosphate (IUPAC name) (1066), 2-(1,3-dithiolan-2-yl)phenyl dimethylcarbamate (IUPAC/Chemical Abstracts name) (1109), 2-(2-butoxyethoxy)ethyl thiocyanate (IUPAC/Chemical Abstracts name) (935), 2-(4,5-dimethyl-1,3-dioxolan-2-yl)phenyl methylcarbamate (IUPAC/Chemical Abstracts name) (1084), 2-(4-chloro-3,5-xylyloxy)ethanol (IUPAC name) (986), 2-chlorovinyl diethyl phosphate (IUPAC name) (984), 2-imidazolidone (IUPAC name) (1225), 2-isovalerylindan-1,3-dione (IUPAC name) (1246), 2-methyl(prop-2-ynyl)aminophenyl methylcarbamate (IUPAC name) (1284), 2-thiocyanatoethyl laurate (IUPAC name) (1433), 3-bromo-1-chloroprop-1-ene (IUPAC name) (917), 3-methyl-1-phenylpyrazol-5-yl dimethyl-carbamate (IUPAC name) (1283), 4-methyl(prop-2-ynyl)amino-3,5-xylyl methylcarbamate (IUPAC name) (1285), 5,5-dimethyl-3-oxocyclohex-1-enyl dimethylcarbamate (IUPAC name) (1085), abamectin (1), acephate (2), acetamiprid (4), acethion (alternative name) [CCN], acetoprole [CCN], acrinathrin (9), acrylonitrile (IUPAC name) (861), alanycarb (15), aldicarb (16), aldoxycarb (863), aldrin (864), allethrin (17), allosamidin (alternative name) [CCN], allyxycarb (866), alpha-cypermethrin (202), alpha-ecdysone (alternative name) [CCN], aluminium phosphide (640), amidithion (870), amidothioate (872), aminocarb (873), amiton (875), amiton hydrogen oxalate (875), amitraz (24), anabasine (877), athidathion (883), AVI 382 (compound code), AZ 60541 (compound code), azadirachtin (alternative name) (41), azamethiphos (42), azinphos-ethyl (44), azinphos-methyl (45), azothoate (889), Bacillus thuringiensis delta endotoxins (alternative name) (52), barium hexafluorosilicate (alternative name) [CCN], barium polysulfide (IUPAC/Chemical Abstracts name) (892), barthrin [CCN], BAS 320 I (compound code), Bayer 22/190 (development code) (893), Bayer 22408 (development code) (894), bendiocarb (58), benfuracarb (60), bensultap (66), beta-cyfluthrin (194), beta-cypermethrin (203), bifenthrin (76), bioallethrin (78), bioallethrin S-cyclopentenyl isomer (alternative name) (79), bioethanomethrin [CCN], biopermethrin (908), bioresmethrin (80), bis(2-chloroethyl)ether (IUPAC name) (909), bistrifluoron (83), borax (86), brofenvalerate (alternative name), bromfenvinfos (914), bromocyclen (918), bromo-DDT (alternative name) [CCN], bromophos (920), bromophos-ethyl (921), bufencarb (924), buprofezin (99), butacarb (926), butathiofos (927), butocarboxim (103), butonate (932), butoxycarboxim (104), butylpyridaben (alternative name), cadusafos (109), calcium arsenate [CCN], calcium cyamide (444), calcium polysulfide (IUPAC name) (111), camphechlor (941), carbanolate (943), carbaryl (115), carbofuran (118), carbon disulfide (IUPAC/Chemical Abstracts name) (945), carbon tetrachloride (IUPAC name) (946), carbophenothion (947), carbosulfan (119), cartap (123), cartap hydrochloride (123), cevadine (alternative name) (725), chlorbicyclen (960), chlordane (128), chlordecone (963), chlordimeform (964), chlordimeform hydrochloride (964), chlorethoxyfos (129), chlorfenapyr (130), chlorfenvinphos (131), chlorfluazuron (132), chlormephos (136), chloroform [CCN], chloropicrin (141), chlorphoxim (989), chlorprazophos (990), chlorpyrifos (145), chlorpyrifos-methyl (146), chlorthiophos (994), chromafenozide (150), cinerin I (696), cinerin II (696), cinerins (696), cis-resmethrin (alternative name), cismethrin (80), clocythrin (alternative name), cloethocarb (999), closantel (alternative name) [CCN], clothianidin (165), copper acetoarsenite [CCN], copper arsenate [CCN], copper oleate [CCN], coumaphos (174), coumithoate (1006), crotamiton (alternative name) [CCN], crotoxyphos (1010), crufomate (1011), cryolite (alternative name) (177), CS 708 (development code) (1012), cyanofenphos (1019), cyanophos (184), cyanthoate (1020), cyclethrin [CCN], cycloprothrin (188), cyfluthrin (193), cyhalothrin (196), cypermethrin (201), cyphenothrin (206), cyromazine (209), cythioate (alternative name) [CCN], d-limonene (alternative name) [CCN], d-tetramethrin (alternative name) (788), DAEP (1031), dazomet (216), DDT (219), decarbofuran (1034), deltamethrin (223), demephion (1037), demephion-O (1037), demephion-S (1037), demeton (1038), demeton-methyl (224), demeton-O (1038), demeton-O-methyl (224), demeton-S (1038), demeton-5-methyl (224), demeton-5-methylsulphon (1039), diafenthiuron (226), dialifos (1042), diamidafos (1044), diazinon (227), dicapthon (1050), dichlofenthion (1051), dichlorvos (236), dicliphos (alternative name), dicresyl (alternative name) [CCN], dicrotophos (243), dicyclanil (244), dieldrin (1070), diethyl 5-methylpyrazol-3-yl phosphate (IUPAC name) (1076), diflubenzuron (250), dilor (alternative name) [CCN], dimefluthrin [CCN], dimefox (1081), dimetan (1085), dimethoate (262), dimethrin (1083), dimethylvinphos (265), dimetilan (1086), dinex (1089), dinex-diclexine (1089), dinoprop (1093), dinosam (1094), dinoseb (1095), dinotefuran (271), diofenolan (1099), dioxabenzofos (1100), dioxacarb (1101), dioxathion (1102), disulfoton (278), dithicrofos (1108), DNOC (282), doramectin (alternative name) [CCN], DSP (1115), ecdysterone (alternative name) [CCN], EI 1642 (development code) (1118), emamectin (291), emamectin benzoate (291), EMPC (1120), empenthrin (292), endosulfan (294), endothion (1121), endrin (1122), EPBP (1123), EPN (297), epofenonane (1124), eprinomectin (alternative name) [CCN], esfenvalerate (302), etaphos (alternative name) [CCN], ethiofencarb (308), ethion (309), ethiprole (310), ethoate-methyl (1134), ethoprophos (312), ethyl formate (IUPAC name) [CCN], ethyl-DDD (alternative name) (1056), ethylene dibromide (316), ethylene dichloride (chemical name) (1136), ethylene oxide [CCN], etofenprox (319), etrimfos (1142), EXD (1143), famphur (323), fenamiphos (326), fenazaflor (1147), fenchlorphos (1148), fenethacarb (1149), fenfluthrin (1150), fenitrothion (335), fenobucarb (336), fenoxacrim (1153), fenoxycarb (340), fenpirithrin (1155), fenpropathrin (342), fenpyrad (alternative name), fensulfothion (1158), fenthion (346), fenthion-ethyl [CCN], fenvalerate (349), fipronil (354), flonicamid (358), flucofuron (1168), flucycloxuron (366), flucythrinate (367), fluenetil (1169), flufenerim [CCN], flufenoxuron (370), flufenprox (1171), flumethrin (372), fluvalinate (1184), FMC 1137 (development code) (1185), fonofos (1191), formetanate (405), formetanate hydrochloride (405), formothion (1192), formparanate (1193), fosmethilan (1194), fospirate (1195), fosthiazate (408), fosthietan (1196), furathiocarb (412), furethrin (1200), gamma-cyhalothrin (197), gamma-HCH (430), guazatine (422), guazatine acetates (422), GY-81 (development code) (423), halfenprox (424), halofenozide (425), HCH (430), HEOD (1070), heptachlor (1211), heptenophos (432), heterophos [CCN], hexaflumuron (439), HHDN (864), hydramethylnon (443), hydrogen cyamide (444), hydroprene (445), hyquincarb (1223), imidacloprid (458), imiprothrin (460), indoxacarb (465), iodomethane (IUPAC name) (542), IPSP (1229), isazofos (1231), isobenzan (1232), isocarbophos (alternative name) (473), isodrin (1235), isofenphos (1236), isolane (1237), isoprocarb (472), isopropyl O-(methoxyaminothiophosphoryl)salicylate (IUPAC name) (473), isoprothiolane (474), isothioate (1244), isoxathion (480), ivermectin (alternative name) [CCN], jasmolin I (696), jasmolin II (696), jodfenphos (1248), juvenile hormone I (alternative name) [CCN], juvenile hormone II (alternative name) [CCN], juvenile hormone III (alternative name) [CCN], kelevan (1249), kinoprene (484), lambda-cyhalothrin (198), lead arsenate [CCN], leptophos (1250), lindane (430), lirimfos (1251), lufenuron (490), lythidathion (1253), m-cumenyl methylcarbamate (IUPAC name) (1014), magnesium phosphide (IUPAC name) (640), malathion (492), malonoben (1254), mazidox (1255), mecarbam (502), mecarphon (1258), menazon (1260), mephosfolan (1261), mercurous chloride (513), mesulfenfos (1263), metam (519), metam-potassium (alternative name) (519), metam-sodium (519), methacrifos (1266), methamidophos (527), methanesulfonyl fluoride (IUPAC/Chemical Abstracts name) (1268), methidathion (529), methiocarb (530), methocrotophos (1273), methomyl (531), methoprene (532), methoquin-butyl (1276), methothrin (alternative name) (533), methoxychlor (534), methoxyfenozide (535), methyl bromide (537), methyl isothiocyanate (543), methylchloroform (alternative name) [CCN], methylene chloride [CCN], metofluthrin [CCN], metolcarb (550), metoxadiazone (1288), mevinphos (556), mexacarbate (1290), milbemectin (557), milbemycin oxime (alternative name) [CCN], mipafox (1293), mirex (1294), monocrotophos (561), morphothion (1300), moxidectin (alternative name) [CCN], naftalofos (alternative name) [CCN], naled (567), naphthalene (IUPAC/Chemical Abstracts name) (1303), NC-170 (development code) (1306), NC-184 (compound code), nicotine (578), nicotine sulfate (578), nifluridide (1309), nitenpyram (579), nithiazine (1311), nitrilacarb (1313), nitrilacarb 1:1 zinc chloride complex (1313), NNI-0101 (compound code), NNI-0250 (compound code), nornicotine (traditional name) (1319), novaluron (585), noviflumuron (586), O-2,5-dichloro-4-iodophenyl O-ethyl ethylphosphonothioate (IUPAC name) (1057), O,O-diethyl O-4-methyl-2-oxo-2H-chromen-7-yl phosphorothioate (IUPAC name) (1074), O,O-diethyl O-6-methyl-2-propylpyrimidin-4-yl phosphorothioate (IUPAC name) (1075), O,O,O′,O′-tetrapropyl dithiopyrophosphate (IUPAC name) (1424), oleic acid (IUPAC name) (593), omethoate (594), oxamyl (602), oxydemeton-methyl (609), oxydeprofos (1324), oxydisulfoton (1325), pp′-DDT (219), para-dichlorobenzene [CCN], parathion (615), parathion-methyl (616), penfluoron (alternative name) [CCN], pentachlorophenol (623), pentachlorophenyl laurate (IUPAC name) (623), permethrin (626), petroleum oils (alternative name) (628), PH 60-38 (development code) (1328), phenkapton (1330), phenothrin (630), phenthoate (631), phorate (636), phosalone (637), phosfolan (1338), phosmet (638), phosnichlor (1339), phosphamidon (639), phosphine (IUPAC name) (640), phoxim (642), phoxim-methyl (1340), pirimetaphos (1344), pirimicarb (651), pirimiphos-ethyl (1345), pirimiphos-methyl (652), polychlorodicyclopentadiene isomers (IUPAC name) (1346), polychloroterpenes (traditional name) (1347), potassium arsenite [CCN], potassium thiocyanate [CCN], prallethrin (655), precocene I (alternative name) [CCN], precocene II (alternative name) [CCN], precocene III (alternative name) [CCN], primidophos (1349), profenofos (662), profluthrin [CCN], promacyl (1354), promecarb (1355), propaphos (1356), propetamphos (673), propoxur (678), prothidathion (1360), prothiofos (686), prothoate (1362), protrifenbute [CCN], pymetrozine (688), pyraclofos (689), pyrazophos (693), pyresmethrin (1367), pyrethrin I (696), pyrethrin II (696), pyrethrins (696), pyridaben (699), pyridalyl (700), pyridaphenthion (701), pyrimidifen (706), pyrimitate (1370), pyriproxyfen (708), quassia (alternative name) [CCN], quinalphos (711), quinalphos-methyl (1376), quinothion (1380), quintiofos (1381), R-1492 (development code) (1382), rafoxanide (alternative name) [CCN], resmethrin (719), rotenone (722), RU 15525 (development code) (723), RU 25475 (development code) (1386), ryania (alternative name) (1387), ryanodine (traditional name) (1387), sabadilla (alternative name) (725), schradan (1389), sebufos (alternative name), selamectin (alternative name) [CCN], SI-0009 (compound code), silafluofen (728), SN 72129 (development code) (1397), sodium arsenite [CCN], sodium cyamide (444), sodium fluoride (IUPAC/Chemical Abstracts name) (1399), sodium hexafluorosilicate (1400), sodium pentachlorophenoxide (623), sodium selenate (IUPAC name) (1401), sodium thiocyanate [CCN], sophamide (1402), spinosad (737), spiromesifen (739), sulcofuron (746), sulcofuron-sodium (746), sulfluramid (750), sulfotep (753), sulfuryl fluoride (756), sulprofos (1408), tar oils (alternative name) (758), tau-fluvalinate (398), tazimcarb (1412), TDE (1414), tebufenozide (762), tebufenpyrad (763), tebupirimfos (764), teflubenzuron (768), tefluthrin (769), temephos (770), TEPP (1417), terallethrin (1418), terbam (alternative name), terbufos (773), tetrachloroethane [CCN], tetrachlorvinphos (777), tetramethrin (787), theta-cypermethrin (204), thiacloprid (791), thiafenox (alternative name), thiamethoxam (792), thicrofos (1428), thiocarboxime (1431), thiocyclam (798), thiocyclam hydrogen oxalate (798), thiodicarb (799), thiofanox (800), thiometon (801), thionazin (1434), thiosultap (803), thiosultap-sodium (803), thuringiensin (alternative name) [CCN], tolfenpyrad (809), tralomethrin (812), transfluthrin (813), transpermethrin (1440), triamiphos (1441), triazamate (818), triazophos (820), triazuron (alternative name), trichlorfon (824), trichlormetaphos-3 (alternative name) [CCN], trichloronat (1452), trifenofos (1455), triflumuron (835), trimethacarb (840), triprene (1459), vamidothion (847), vaniliprole [CCN], veratridine (alternative name) (725), veratrine (alternative name) (725), XMC (853), xylylcarb (854), YI-5302 (compound code), zeta-cypermethrin (205), zetamethrin (alternative name), zinc phosphide (640), zolaprofos (1469) and ZXI 8901 (development code) (858),
a molluscicide selected from the group of substances consisting of bis(tributyltin)oxide (IUPAC name) (913), bromoacetamide [CCN], calcium arsenate [CCN], cloethocarb (999), copper acetoarsenite [CCN], copper sulfate (172), fentin (347), ferric phosphate (IUPAC name) (352), metaldehyde (518), methiocarb (530), niclosamide (576), niclosamide-olamine (576), pentachlorophenol (623), sodium pentachlorophenoxide (623), tazimcarb (1412), thiodicarb (799), tributyltin oxide (913), trifenmorph (1454), trimethacarb (840), triphenyltin acetate (IUPAC name) (347) and triphenyltin hydroxide (IUPAC name) (347),
a nematicide selected from the group of substances consisting of 1,2-dibromo-3-chloropropane (IUPAC/Chemical Abstracts name) (1045), 1,2-dichloropropane (IUPAC/Chemical Abstracts name) (1062), 1,2-dichloropropane with 1,3-dichloropropene (IUPAC name) (1063), 1,3-dichloropropene (233), 3,4-dichlorotetrahydrothiophene 1,1-dioxide (IUPAC/Chemical Abstracts name) (1065), 3-(4-chlorophenyl)-5-methylrhodanine (IUPAC name) (980), 5-methyl-6-thioxo-1,3,5-thiadiazinan-3-ylacetic acid (IUPAC name) (1286), 6-isopentenylaminopurine (alternative name) (210), abamectin (1), acetoprole [CCN], alanycarb (15), aldicarb (16), aldoxycarb (863), AZ 60541 (compound code), benclothiaz [CCN], benomyl (62), butylpyridaben (alternative name), cadusafos (109), carbofuran (118), carbon disulfide (945), carbosulfan (119), chloropicrin (141), chlorpyrifos (145), cloethocarb (999), cytokinins (alternative name) (210), dazomet (216), DBCP (1045), DCIP (218), diamidafos (1044), dichlofenthion (1051), dicliphos (alternative name), dimethoate (262), doramectin (alternative name) [CCN], emamectin (291), emamectin benzoate (291), eprinomectin (alternative name) [CCN], ethoprophos (312), ethylene dibromide (316), fenamiphos (326), fenpyrad (alternative name), fensulfothion (1158), fosthiazate (408), fosthietan (1196), furfural (alternative name) [CCN], GY-81 (development code) (423), heterophos [CCN], iodomethane (IUPAC name) (542), isamidofos (1230), isazofos (1231), ivermectin (alternative name) [CCN], kinetin (alternative name) (210), mecarphon (1258), metam (519), metam-potassium (alternative name) (519), metam-sodium (519), methyl bromide (537), methyl isothiocyanate (543), milbemycin oxime (alternative name) [CCN], moxidectin (alternative name) [CCN], Myrothecium verrucaria composition (alternative name) (565), NC-184 (compound code), oxamyl (602), phorate (636), phosphamidon (639), phosphocarb [CCN], sebufos (alternative name), selamectin (alternative name) [CCN], spinosad (737), terbam (alternative name), terbufos (773), tetrachlorothiophene (IUPAC/Chemical Abstracts name) (1422), thiafenox (alternative name), thionazin (1434), triazophos (820), triazuron (alternative name), xylenols [CCN], YI-5302 (compound code) and zeatin (alternative name) (210),
a nitrification inhibitor selected from the group of substances consisting of potassium ethylxanthate [CCN] and nitrapyrin (580),
a plant activator selected from the group of substances consisting of acibenzolar (6), acibenzolar-5-methyl (6), probenazole (658) and Reynoutria sachalinensis extract (alternative name) (720),
a rodenticide selected from the group of substances consisting of 2-isovalerylindan-1,3-dione (IUPAC name) (1246), 4-(quinoxalin-2-ylamino)benzenesulfonamide (IUPAC name) (748), alpha-chlorohydrin [CCN], aluminium phosphide (640), antu (880), arsenous oxide (882), barium carbonate (891), bisthiosemi (912), brodifacoum (89), bromadiolone (91), bromethalin (92), calcium cyamide (444), chloralose (127), chlorophacinone (140), cholecalciferol (alternative name) (850), coumachlor (1004), coumafuryl (1005), coumatetralyl (175), crimidine (1009), difenacoum (246), difethialone (249), diphacinone (273), ergocalciferol (301), flocoumafen (357), fluoroacetamide (379), flupropadine (1183), flupropadine hydrochloride (1183), gamma-HCH (430), HCH (430), hydrogen cyamide (444), iodomethane (IUPAC name) (542), lindane (430), magnesium phosphide (IUPAC name) (640), methyl bromide (537), norbormide (1318), phosacetim (1336), phosphine (IUPAC name) (640), phosphorus [CCN], pindone (1341), potassium arsenite [CCN], pyrinuron (1371), scilliroside (1390), sodium arsenite [CCN], sodium cyamide (444), sodium fluoro-acetate (735), strychnine (745), thallium sulfate [CCN], warfarin (851) and zinc phosphide (640),
a synergist selected from the group of substances consisting of 2-(2-butoxyethoxy)ethyl piperonylate (IUPAC name) (934), 5-(1,3-benzodioxol-5-yl)-3-hexylcyclohex-2-enone (IUPAC name) (903), farnesol with nerolidol (alternative name) (324), MB-599 (development code) (498), MGK 264 (development code) (296), piperonyl butoxide (649), piprotal (1343), propyl isomer (1358), S421 (development code) (724), sesamex (1393), sesasmolin (1394) and sulfoxide (1406),
an animal repellent selected from the group of substances consisting of anthraquinone (32), chloralose (127), copper naphthenate [CCN], copper oxychloride (171), diazinon (227), dicyclopentadiene (chemical name) (1069), guazatine (422), guazatine acetates (422), methiocarb (530), pyridin-4-amine (IUPAC name) (23), thiram (804), trimethacarb (840), zinc naphthenate [CCN] and ziram (856),
a virucide selected from the group of substances consisting of imanin (alternative name) [CCN] and ribavirin (alternative name) [CCN],
and a wound protectant selected from the group of substances consisting of mercuric oxide (512), octhilinone (590) and thiophanate-methyl (802).

A very especially preferred embodiment of the subject-matter {1.1.24} of the invention is {1.1.24.2} a pesticidal composition comprising a mixture consisting of at least two substances, namely one compound (A) and at least one compound (B), as active ingredient and at least one auxiliary, wherein the compound (A) is the compound of formula (A-24) and the compound (B) is a compound selected from the group of substances consisting of abamectin (1), cyromazine (209), diafenthiuron (226), diazinon (227), emamectin benzoate (291), fenoxycarb (340), fosthiazate (408), lambda-cyhalothrin (198), lufenuron (490), methidathion (529), profenofos (662), pymetrozine (688), tefluthrin (769) and thiamethoxam (792).

The compound of formula (A-24) is known, for example, from the PCT Application WO-04/067528.

A preferred embodiment of the subject-matter {1.1} of the invention is {1.1.25} a pesticidal composition comprising a mixture consisting of at least two substances, namely one compound (A) and at least one compound (B), as active ingredient and at least one auxiliary, wherein the compound (A) is the compound of formula (A-25) 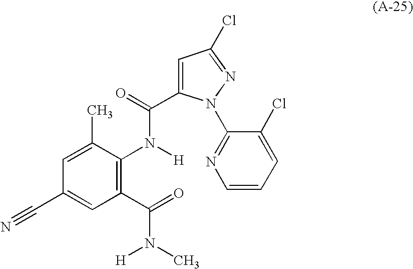
and the compound (B) is a compound selected from the group of substances consisting of an adjuvant, an acaricide, an algicide, an anthelmintic, an avicide, a bactericide, a biological agent, a soil sterilant, a chemosterilant, an insect pheromone, an insect repellent, an insecticide, a molluscicide, a nematicide, a nitrification inhibitor, a plant activator, a rodenticide, a synergist, an animal repellent, a virucide and a wound protectant.

An especially preferred embodiment of the subject-matter {1.1.25} of the invention is {1.1.25.1} a pesticidal composition comprising a mixture consisting of at least two substances, namely one compound (A) and at least one compound (B), as active ingredient and at least one auxiliary, wherein the compound (A) is the compound of formula (A-25) and the compound (B) is a compound selected from the group of substances consisting of
an adjuvant selected from the group of substances consisting of petroleum oils (alternative name) (628),
an acaricide selected from the group of substances consisting of 1,1-bis(4-chlorophenyl)-2-ethoxyethanol (IUPAC name) (910), 2,4-dichlorophenyl benzenesulfonate (IUPAC/Chemical Abstracts name) (1059), 2-fluoro-N-methyl-N-1-naphthylacetamide (IUPAC name) (1295), 4-chlorophenyl phenyl sulfone (IUPAC name) (981), abamectin (1), acequinocyl (3), acetoprole [CCN], acrinathrin (9), aldicarb (16), aldoxycarb (863), alpha-cypermethrin (202), amidithion (870), amidoflumet [CCN], amidothioate (872), amiton (875), amiton hydrogen oxalate (875), amitraz (24), aramite (881), arsenous oxide (882), AVI 382 (compound code), AZ 60541 (compound code), azinphos-ethyl (44), azinphos-methyl (45), azobenzene (IUPAC name) (888), azocyclotin (46), azothoate (889), benomyl (62), benoxafos (alternative name) [CCN], benzoximate (71), benzyl benzoate (IUPAC name) [CCN], bifenazate (74), bifenthrin (76), binapacryl (907), brofenvalerate (alternative name), bromocyclen (918), bromophos (920), bromophos-ethyl (921), bromopropylate (94), buprofezin (99), butocarboxim (103), butoxycarboxim (104), butylpyridaben (alternative name), calcium polysulfide (IUPAC name) (111), camphechlor (941), carbanolate (943), carbaryl (115), carbofuran (118), carbophenothion (947), CGA 50'439 (development code) (125), chinomethionat (126), chlorbenside (959), chlordimeform (964), chlordimeform hydrochloride (964), chlorfenapyr (130), chlorfenethol (968), chlorfenson (970), chlorfensulphide (971), chlorfenvinphos (131), chlorobenzilate (975), chloromebuform (977), chloromethiuron (978), chloropropylate (983), chlorpyrifos (145), chlorpyrifos-methyl (146), chlorthiophos (994), cinerin I (696), cinerin II (696), cinerins (696), clofentezine (158), closantel (alternative name) [CCN], coumaphos (174), crotamiton (alternative name) [CCN], crotoxyphos (1010), cufraneb (1013), cyanthoate (1020), cyhalothrin (196), cyhexatin (199), cypermethrin (201), DCPM (1032), DDT (219), demephion (1037), demephion-O (1037), demephion-S (1037), demeton (1038), demeton-methyl (224), demeton-O (1038), demeton-O-methyl (224), demeton-S (1038), demeton-5-methyl (224), demeton-5-methylsulphon (1039), diafenthiuron (226), dialifos (1042), diazinon (227), dichlofluanid (230), dichlorvos (236), dicliphos (alternative name), dicofol (242), dicrotophos (243), dienochlor (1071), dimefox (1081), dimethoate (262), dinactin (alternative name) (653), dinex (1089), dinex-diclexine (1089), dinobuton (269), dinocap (270), dinocap-4 [CCN], dinocap-6 [CCN], dinocton (1090), dinopenton (1092), dinosulfon (1097), dinoterbon (1098), dioxathion (1102), diphenyl sulfone (IUPAC name) (1103), disulfuram (alternative name) [CCN], disulfoton (278), DNOC (282), dofenapyn (1113), doramectin (alternative name) [CCN], endosulfan (294), endothion (1121), EPN (297), eprinomectin (alternative name) [CCN], ethion (309), ethoate-methyl (1134), etoxazole (320), etrimfos (1142), fenazaflor (1147), fenazaquin (328), fenbutatin oxide (330), fenothiocarb (337), fenpropathrin (342), fenpyrad (alternative name), fenpyroximate (345), fenson (1157), fentrifanil (1161), fenvalerate (349), fipronil (354), fluacrypyrim (360), fluazuron (1166), flubenzimine (1167), flucycloxuron (366), flucythrinate (367), fluenetil (1169), flufenoxuron (370), flumethrin (372), fluorbenside (1174), fluvalinate (1184), FMC 1137 (development code) (1185), formetanate (405), formetanate hydrochloride (405), formothion (1192), formparanate (1193), gamma-HCH (430), glyodin (1205), halfenprox (424), heptenophos (432), hexadecyl cyclopropanecarboxylate (IUPAC/Chemical Abstracts name) (1216), hexythiazox (441), iodomethane (IUPAC name) (542), isocarbophos (alternative name) (473), isopropyl O-(methoxyaminothiophosphoryl)salicylate (IUPAC name) (473), ivermectin (alternative name) [CCN], jasmolin I (696), jasmolin II (696), jodfenphos (1248), lindane (430), lufenuron (490), malathion (492), malonoben (1254), mecarbam (502), mephosfolan (1261), mesulfen (alternative name) [CCN], methacrifos (1266), methamidophos (527), methidathion (529), methiocarb (530), methomyl (531), methyl bromide (537), metolcarb (550), mevinphos (556), mexacarbate (1290), milbemectin (557), milbemycin oxime (alternative name) [CCN], mipafox (1293), monocrotophos (561), morphothion (1300), moxidectin (alternative name) [CCN], naled (567), NC-184 (compound code), nifluridide (1309), nikkomycins (alternative name) [CCN], nitrilacarb (1313), nitrilacarb 1:1 zinc chloride complex (1313), NNI-0101 (compound code), NNI-0250 (compound code), omethoate (594), oxamyl (602), oxydeprofos (1324), oxydisulfoton (1325), pp′-DDT (219), parathion (615), permethrin (626), petroleum oils (alternative name) (628), phenkapton (1330), phenthoate (631), phorate (636), phosalone (637), phosfolan (1338), phosmet (638), phosphamidon (639), phoxim (642), pirimiphos-methyl (652), polychloroterpenes (traditional name) (1347), polynactins (alternative name) (653), proclonol (1350), profenofos (662), promacyl (1354), propargite (671), propetamphos (673), propoxur (678), prothidathion (1360), prothoate (1362), pyrethrin I (696), pyrethrin II (696), pyrethrins (696), pyridaben (699), pyridaphenthion (701), pyrimidifen (706), pyrimitate (1370), quinalphos (711), quintiofos (1381), R-1492 (development code) (1382), RA-17 (development code) (1383), rotenone (722), schradan (1389), sebufos (alternative name), selamectin (alternative name) [CCN], SI-0009 (compound code), sophamide (1402), spirodiclofen (738), spiromesifen (739), SSI-121 (development code) (1404), sulfuram (alternative name) [CCN], sulfluramid (750), sulfotep (753), sulfur (754), SZI-121 (development code) (757), tau-fluvalinate (398), tebufenpyrad (763), TEPP (1417), terbam (alternative name), tetrachlorvinphos (777), tetradifon (786), tetranactin (alternative name) (653), tetrasul (1425), thiafenox (alternative name), thiocarboxime (1431), thiofanox (800), thiometon (801), thioquinox (1436), thuringiensin (alternative name) [CCN], triamiphos (1441), triarathene (1443), triazophos (820), triazuron (alternative name), trichlorfon (824), trifenofos (1455), trinactin (alternative name) (653), vamidothion (847), vaniliprole [CCN] and YI-5302 (compound code),
an algicide selected from the group of substances consisting of bethoxazin [CCN], copper dioctanoate (IUPAC name) (170), copper sulfate (172), cybutryne [CCN], dichlone (1052), dichlorophen (232), endothal (295), fentin (347), hydrated lime [CCN], nabam (566), quinoclamine (714), quinonamid (1379), simazine (730), triphenyltin acetate (IUPAC name) (347) and triphenyltin hydroxide (IUPAC name) (347),
an anthelmintic selected from the group of substances consisting of abamectin (1), crufomate (1011), doramectin (alternative name) [CCN], emamectin (291), emamectin benzoate (291), eprinomectin (alternative name) [CCN], ivermectin (alternative name) [CCN], milbemycin oxime (alternative name) [CCN], moxidectin (alternative name) [CCN], piperazine [CCN], selamectin (alternative name) [CCN], spinosad (737) and thiophanate (1435),
an avicide selected from the group of substances consisting of chloralose (127), endrin (1122), fenthion (346), pyridin-4-amine (IUPAC name) (23) and strychnine (745),
a bactericide selected from the group of substances consisting of 1-hydroxy-1H-pyridine-2-thione (IUPAC name) (1222), 4-(quinoxalin-2-ylamino)benzenesulfonamide (IUPAC name) (748), 8-hydroxyquinoline sulfate (446), bronopol (97), copper dioctanoate (IUPAC name) (170), copper hydroxide (IUPAC name) (169), cresol [CCN], dichlorophen (232), dipyrithione (1105), dodicin (1112), fenaminosulf (1144), formaldehyde (404), hydrargaphen (alternative name) [CCN], kasugamycin (483), kasugamycin hydrochloride hydrate (483), nickel bis(dimethyldithiocarbamate) (IUPAC name) (1308), nitrapyrin (580), octhilinone (590), oxolinic acid (606), oxytetracycline (611), potassium hydroxyquinoline sulfate (446), probenazole (658), streptomycin (744), streptomycin sesquisulfate (744), tecloftalam (766) and thiomersal (alternative name) [CCN],
a biological agent selected from the group of substances consisting of Adoxophyes orana GV (alternative name) (12), Agrobacterium radiobacter (alternative name) (13), Amblyseius spp. (alternative name) (19), Anagrapha falcifera NPV (alternative name) (28), Anagrus atomus (alternative name) (29), Aphelinus abdominalis (alternative name) (33), Aphidius colemani (alternative name) (34), Aphidoletes aphidimyza (alternative name) (35), Autographa californica NPV (alternative name) (38), Bacillus firmus (alternative name) (48), Bacillus sphaericus Neide (scientific name) (49), Bacillus thuringiensis Berliner (scientific name) (51), Bacillus thuringiensis subsp. aizawai (scientific name) (51), Bacillus thuringiensis subsp. israelensis (scientific name) (51), Bacillus thuringiensis subsp. japonensis (scientific name) (51), Bacillus thuringiensis subsp. kurstaki (scientific name) (51), Bacillus thuringiensis subsp. tenebrionis (scientific name) (51), Beauveria bassiana (alternative name) (53), Beauveria brongniartii (alternative name) (54), Chrysoperla carnea (alternative name) (151), Cryptolaemus montrouzieri (alternative name) (178), Cydia pomonella GV (alternative name) (191), Dacnusa sibirica (alternative name) (212), Diglyphus isaea (alternative name) (254), Encarsia formosa (scientific name) (293), Eretmocerus eremicus (alternative name) (300), Helicoverpa zea NPV (alternative name) (431), Heterorhabditis bacteriophora and H. megidis (alternative name) (433), Hippodamia convergens (alternative name) (442), Leptomastix dactylopii (alternative name) (488), Macrolophus caliginosus (alternative name) (491), Mamestra brassicae NPV (alternative name) (494), Metaphycus helvolus (alternative name) (522), Metarhizium anisopliae var. acridum (scientific name) (523), Metarhizium anisopliae var. anisopliae (scientific name) (523), Neodiprion sertifer NPV and N. lecontei NPV (alternative name) (575), Orius spp. (alternative name) (596), Paecilomyces fumosoroseus (alternative name) (613), Phytoseiulus persimilis (alternative name) (644), Spodoptera exigua multicapsid nuclear polyhedrosis virus (scientific name) (741), Steinernema bibionis (alternative name) (742), Steinernema carpocapsae (alternative name) (742), Steinernema feltiae (alternative name) (742), Steinernema glaseri (alternative name) (742), Steinernema riobrave (alternative name) (742), Steinernema riobravis (alternative name) (742), Steinernema scapterisci (alternative name) (742), Steinernema spp. (alternative name) (742), Trichogramma spp. (alternative name) (826), Typhlodromus occidentalis (alternative name) (844) and Verticillium lecanii (alternative name) (848),
a soil sterilant selected from the group of substances consisting of iodomethane (IUPAC name) (542) and methyl bromide (537),
a chemosterilant selected from the group of substances consisting of apholate [CCN], bisazir (alternative name) [CCN], busulfan (alternative name) [CCN], diflubenzuron (250), dimatif (alternative name) [CCN], hemel [CCN], hempa [CCN], metepa [CCN], methiotepa [CCN], methyl apholate [CCN], morzid [CCN], penfluoron (alternative name) [CCN], tepa [CCN], thiohempa (alternative name) [CCN], thiotepa (alternative name) [CCN], tretamine (alternative name) [CCN] and uredepa (alternative name) [CCN],
an insect pheromone selected from the group of substances consisting of (E)-dec-5-en-1-yl acetate with (E)-dec-5-en-1-ol (IUPAC name) (222), (E)-tridec-4-en-1-yl acetate (IUPAC name) (829), (E)-6-methylhept-2-en-4-ol (IUPAC name) (541), (E,Z)-tetradeca-4,10-dien-1-yl acetate (IUPAC name) (779), (Z)-dodec-7-en-1-yl acetate (IUPAC name) (285), (Z)-hexadec-11-enal (IUPAC name) (436), (Z)-hexadec-11-en-1-yl acetate (IUPAC name) (437), (Z)-hexadec-13-en-11-yn-1-yl acetate (IUPAC name) (438), (Z)-icos-13-en-10-one (IUPAC name) (448), (Z)-tetradec-7-en-1-al (IUPAC name) (782), (Z)-tetradec-9-en-1-ol (IUPAC name) (783), (Z)-tetradec-9-en-1-yl acetate (IUPAC name) (784), (7E,9Z)-dodeca-7,9-dien-1-yl acetate (IUPAC name) (283), (9Z,11E)-tetradeca-9,11-dien-1-yl acetate (IUPAC name) (780), (9Z,12E)-tetradeca-9,12-dien-1-yl acetate (IUPAC name) (781), 14-methyloctadec-1-ene (IUPAC name) (545), 4-methylnonan-5-ol with 4-methylnonan-5-one (IUPAC name) (544), alpha-multistriatin (alternative name) [CCN], brevicomin (alternative name) [CCN], codlelure (alternative name) [CCN], codlemone (alternative name) (167), cuelure (alternative name) (179), disparlure (277), dodec-8-en-1-yl acetate (IUPAC name) (286), dodec-9-en-1-yl acetate (IUPAC name) (287), dodeca-8,10-dien-1-yl acetate (IUPAC name) (284), dominicalure (alternative name) [CCN], ethyl 4-methyloctanoate (IUPAC name) (317), eugenol (alternative name) [CCN], frontalin (alternative name) [CCN], gossyplure (alternative name) (420), grandlure (421), grandlure I (alternative name) (421), grandlure II (alternative name) (421), grandlure III (alternative name) (421), grandlure IV (alternative name) (421), hexylure [CCN], ipsdienol (alternative name) [CCN], ipsenol (alternative name) [CCN], japonilure (alternative name) (481), lineatin (alternative name) [CCN], litlure (alternative name) [CCN], looplure (alternative name) [CCN], medlure [CCN], megatomoic acid (alternative name) [CCN], methyl eugenol (alternative name) (540), muscalure (563), octadeca-2,13-dien-1-yl acetate (IUPAC name) (588), octadeca-3,13-dien-1-yl acetate (IUPAC name) (589), orfralure (alternative name) [CCN], oryctalure (alternative name) (317), ostramone (alternative name) [CCN], siglure [CCN], sordidin (alternative name) (736), sulcatol (alternative name) [CCN], tetradec-11-en-1-yl acetate (IUPAC name) (785), trimedlure (839), trimedlure A (alternative name) (839), trimedlure B₁ (alternative name) (839), trimedlure B₂ (alternative name) (839), trimedlure C (alternative name) (839) and trunc-call (alternative name) [CCN],
an insect repellent selected from the group of substances consisting of 2-(octylthio)-ethanol (IUPAC name) (591), butopyronoxyl (933), butoxy(polypropylene glycol) (936), dibutyl adipate (IUPAC name) (1046), dibutyl phthalate (1047), dibutyl succinate (IUPAC name) (1048), diethyltoluamide [CCN], dimethyl carbate [CCN], dimethyl phthalate [CCN], ethyl hexanediol (1137), hexamide [CCN], methoquin-butyl (1276), methylneodecanamide [CCN], oxamate [CCN] and picaridin [CCN],
an insecticide selected from the group of substances consisting of 1,1-dichloro-1-nitroethane (IUPAC/Chemical Abstracts name) (1058), 1,1-dichloro-2,2-bis(4-ethylphenyl)-ethane (IUPAC name) (1056), 1,2-dichloropropane (IUPAC/Chemical Abstracts name) (1062), 1,2-dichloropropane with 1,3-dichloropropene (IUPAC name) (1063), 1-bromo-2-chloroethane (IUPAC/Chemical Abstracts name) (916), 2,2,2-trichloro-1-(3,4-dichloro-phenyl)ethyl acetate (IUPAC name) (1451), 2,2-dichlorovinyl 2-ethylsulfinylethyl methyl phosphate (IUPAC name) (1066), 2-(1,3-dithiolan-2-yl)phenyl dimethylcarbamate (IUPAC/Chemical Abstracts name) (1109), 2-(2-butoxyethoxy)ethyl thiocyanate (IUPAC/Chemical Abstracts name) (935), 2-(4,5-dimethyl-1,3-dioxolan-2-yl)phenyl methylcarbamate (IUPAC/Chemical Abstracts name) (1084), 2-(4-chloro-3,5-xylyloxy)ethanol (IUPAC name) (986), 2-chlorovinyl diethyl phosphate (IUPAC name) (984), 2-imidazolidone (IUPAC name) (1225), 2-isovalerylindan-1,3-dione (IUPAC name) (1246), 2-methyl(prop-2-ynyl)aminophenyl methylcarbamate (IUPAC name) (1284), 2-thiocyanatoethyl laurate (IUPAC name) (1433), 3-bromo-1-chloroprop-1-ene (IUPAC name) (917), 3-methyl-1-phenylpyrazol-5-yl dimethyl-carbamate (IUPAC name) (1283), 4-methyl(prop-2-ynyl)amino-3,5-xylyl methylcarbamate (IUPAC name) (1285), 5,5-dimethyl-3-oxocyclohex-1-enyl dimethylcarbamate (IUPAC name) (1085), abamectin (1), acephate (2), acetamiprid (4), acethion (alternative name) [CCN], acetoprole [CCN], acrinathrin (9), acrylonitrile (IUPAC name) (861), alanycarb (15), aldicarb (16), aldoxycarb (863), aldrin (864), allethrin (17), allosamidin (alternative name) [CCN], allyxycarb (866), alpha-cypermethrin (202), alpha-ecdysone (alternative name) [CCN], aluminium phosphide (640), amidithion (870), amidothioate (872), aminocarb (873), amiton (875), amiton hydrogen oxalate (875), amitraz (24), anabasine (877), athidathion (883), AVI 382 (compound code), AZ 60541 (compound code), azadirachtin (alternative name) (41), azamethiphos (42), azinphos-ethyl (44), azinphos-methyl (45), azothoate (889), Bacillus thuringiensis delta endotoxins (alternative name) (52), barium hexafluorosilicate (alternative name) [CCN], barium polysulfide (IUPAC/Chemical Abstracts name) (892), barthrin [CCN], BAS 320 I (compound code), Bayer 22/190 (development code) (893), Bayer 22408 (development code) (894), bendiocarb (58), benfuracarb (60), bensultap (66), beta-cyfluthrin (194), beta-cypermethrin (203), bifenthrin (76), bioallethrin (78), bioallethrin S-cyclopentenyl isomer (alternative name) (79), bioethanomethrin [CCN], biopermethrin (908), bioresmethrin (80), bis(2-chloroethyl)ether (IUPAC name) (909), bistrifluoron (83), borax (86), brofenvalerate (alternative name), bromfenvinfos (914), bromocyclen (918), bromo-DDT (alternative name) [CCN], bromophos (920), bromophos-ethyl (921), bufencarb (924), buprofezin (99), butacarb (926), butathiofos (927), butocarboxim (103), butonate (932), butoxycarboxim (104), butylpyridaben (alternative name), cadusafos (109), calcium arsenate [CCN], calcium cyamide (444), calcium polysulfide (IUPAC name) (111), camphechlor (941), carbanolate (943), carbaryl (115), carbofuran (118), carbon disulfide (IUPAC/Chemical Abstracts name) (945), carbon tetrachloride (IUPAC name) (946), carbophenothion (947), carbosulfan (119), cartap (123), cartap hydrochloride (123), cevadine (alternative name) (725), chlorbicyclen (960), chlordane (128), chlordecone (963), chlordimeform (964), chlordimeform hydrochloride (964), chlorethoxyfos (129), chlorfenapyr (130), chlorfenvinphos (131), chlorfluazuron (132), chlormephos (136), chloroform [CCN], chloropicrin (141), chlorphoxim (989), chlorprazophos (990), chlorpyrifos (145), chlorpyrifos-methyl (146), chlorthiophos (994), chromafenozide (150), cinerin I (696), cinerin II (696), cinerins (696), cis-resmethrin (alternative name), cismethrin (80), clocythrin (alternative name), cloethocarb (999), closantel (alternative name) [CCN], clothianidin (165), copper acetoarsenite [CCN], copper arsenate [CCN], copper oleate [CCN], coumaphos (174), coumithoate (1006), crotamiton (alternative name) [CCN], crotoxyphos (1010), crufomate (1011), cryolite (alternative name) (177), CS 708 (development code) (1012), cyanofenphos (1019), cyanophos (184), cyanthoate (1020), cyclethrin [CCN], cycloprothrin (188), cyfluthrin (193), cyhalothrin (196), cypermethrin (201), cyphenothrin (206), cyromazine (209), cythioate (alternative name) [CCN], d-limonene (alternative name) [CCN], d-tetramethrin (alternative name) (788), DAEP (1031), dazomet (216), DDT (219), decarbofuran (1034), deltamethrin (223), demephion (1037), demephion-O (1037), demephion-S (1037), demeton (1038), demeton-methyl (224), demeton-O (1038), demeton-O-methyl (224), demeton-S (1038), demeton-5-methyl (224), demeton-5-methylsulphon (1039), diafenthiuron (226), dialifos (1042), diamidafos (1044), diazinon (227), dicapthon (1050), dichlofenthion (1051), dichlorvos (236), dicliphos (alternative name), dicresyl (alternative name) [CCN], dicrotophos (243), dicyclanil (244), dieldrin (1070), diethyl 5-methylpyrazol-3-yl phosphate (IUPAC name) (1076), diflubenzuron (250), dilor (alternative name) [CCN], dimefluthrin [CCN], dimefox (1081), dimetan (1085), dimethoate (262), dimethrin (1083), dimethylvinphos (265), dimetilan (1086), dinex (1089), dinex-diclexine (1089), dinoprop (1093), dinosam (1094), dinoseb (1095), dinotefuran (271), diofenolan (1099), dioxabenzofos (1100), dioxacarb (1101), dioxathion (1102), disulfoton (278), dithicrofos (1108), DNOC (282), doramectin (alternative name) [CCN], DSP (1115), ecdysterone (alternative name) [CCN], EI 1642 (development code) (1118), emamectin (291), emamectin benzoate (291), EMPC (1120), empenthrin (292), endosulfan (294), endothion (1121), endrin (1122), EPBP (1123), EPN (297), epofenonane (1124), eprinomectin (alternative name) [CCN], esfenvalerate (302), etaphos (alternative name) [CCN], ethiofencarb (308), ethion (309), ethiprole (310), ethoate-methyl (1134), ethoprophos (312), ethyl formate (IUPAC name) [CCN], ethyl-DDD (alternative name) (1056), ethylene dibromide (316), ethylene dichloride (chemical name) (1136), ethylene oxide [CCN], etofenprox (319), etrimfos (1142), EXD (1143), famphur (323), fenamiphos (326), fenazaflor (1147), fenchlorphos (1148), fenethacarb (1149), fenfluthrin (1150), fenitrothion (335), fenobucarb (336), fenoxacrim (1153), fenoxycarb (340), fenpirithrin (1155), fenpropathrin (342), fenpyrad (alternative name), fensulfothion (1158), fenthion (346), fenthion-ethyl [CCN], fenvalerate (349), fipronil (354), flonicamid (358), flucofuron (1168), flucycloxuron (366), flucythrinate (367), fluenetil (1169), flufenerim [CCN], flufenoxuron (370), flufenprox (1171), flumethrin (372), fluvalinate (1184), FMC 1137 (development code) (1185), fonofos (1191), formetanate (405), formetanate hydrochloride (405), formothion (1192), formparanate (1193), fosmethilan (1194), fospirate (1195), fosthiazate (408), fosthietan (1196), furathiocarb (412), furethrin (1200), gamma-cyhalothrin (197), gamma-HCH (430), guazatine (422), guazatine acetates (422), GY-81 (development code) (423), halfenprox (424), halofenozide (425), HCH (430), HEOD (1070), heptachlor (1211), heptenophos (432), heterophos [CCN], hexaflumuron (439), HHDN (864), hydramethylnon (443), hydrogen cyamide (444), hydroprene (445), hyquincarb (1223), imidacloprid (458), imiprothrin (460), indoxacarb (465), iodomethane (IUPAC name) (542), IPSP (1229), isazofos (1231), isobenzan (1232), isocarbophos (alternative name) (473), isodrin (1235), isofenphos (1236), isolane (1237), isoprocarb (472), isopropyl O-(methoxyaminothiophosphoryl)salicylate (IUPAC name) (473), isoprothiolane (474), isothioate (1244), isoxathion (480), ivermectin (alternative name) [CCN], jasmolin I (696), jasmolin II (696), jodfenphos (1248), juvenile hormone I (alternative name) [CCN], juvenile hormone II (alternative name) [CCN], juvenile hormone III (alternative name) [CCN], kelevan (1249), kinoprene (484), lambda-cyhalothrin (198), lead arsenate [CCN], leptophos (1250), lindane (430), lirimfos (1251), lufenuron (490), lythidathion (1253), m-cumenyl methylcarbamate (IUPAC name) (1014), magnesium phosphide (IUPAC name) (640), malathion (492), malonoben (1254), mazidox (1255), mecarbam (502), mecarphon (1258), menazon (1260), mephosfolan (1261), mercurous chloride (513), mesulfenfos (1263), metam (519), metam-potassium (alternative name) (519), metam-sodium (519), methacrifos (1266), methamidophos (527), methanesulfonyl fluoride (IUPAC/Chemical Abstracts name) (1268), methidathion (529), methiocarb (530), methocrotophos (1273), methomyl (531), methoprene (532), methoquin-butyl (1276), methothrin (alternative name) (533), methoxychlor (534), methoxyfenozide (535), methyl bromide (537), methyl isothiocyanate (543), methylchloroform (alternative name) [CCN], methylene chloride [CCN], metofluthrin [CCN], metolcarb (550), metoxadiazone (1288), mevinphos (556), mexacarbate (1290), milbemectin (557), milbemycin oxime (alternative name) [CCN], mipafox (1293), mirex (1294), monocrotophos (561), morphothion (1300), moxidectin (alternative name) [CCN], naftalofos (alternative name) [CCN], naled (567), naphthalene (IUPAC/Chemical Abstracts name) (1303), NC-170 (development code) (1306), NC-184 (compound code), nicotine (578), nicotine sulfate (578), nifluridide (1309), nitenpyram (579), nithiazine (1311), nitrilacarb (1313), nitrilacarb 1:1 zinc chloride complex (1313), NNI-0101 (compound code), NNI-0250 (compound code), nornicotine (traditional name) (1319), novaluron (585), noviflumuron (586), O-2,5-dichloro-4-iodophenyl O-ethyl ethylphosphonothioate (IUPAC name) (1057), O,O-diethyl O-4-methyl-2-oxo-2H-chromen-7-yl phosphorothioate (IUPAC name) (1074), O,O-diethyl O-6-methyl-2-propylpyrimidin-4-yl phosphorothioate (IUPAC name) (1075), O,O,O′,O′-tetrapropyl dithiopyrophosphate (IUPAC name) (1424), oleic acid (IUPAC name) (593), omethoate (594), oxamyl (602), oxydemeton-methyl (609), oxydeprofos (1324), oxydisulfoton (1325), pp′-DDT (219), para-dichlorobenzene [CCN], parathion (615), parathion-methyl (616), penfluoron (alternative name) [CCN], pentachlorophenol (623), pentachlorophenyl laurate (IUPAC name) (623), permethrin (626), petroleum oils (alternative name) (628), PH 60-38 (development code) (1328), phenkapton (1330), phenothrin (630), phenthoate (631), phorate (636), phosalone (637), phosfolan (1338), phosmet (638), phosnichlor (1339), phosphamidon (639), phosphine (IUPAC name) (640), phoxim (642), phoxim-methyl (1340), pirimetaphos (1344), pirimicarb (651), pirimiphos-ethyl (1345), pirimiphos-methyl (652), polychlorodicyclopentadiene isomers (IUPAC name) (1346), polychloroterpenes (traditional name) (1347), potassium arsenite [CCN], potassium thiocyanate [CCN], prallethrin (655), precocene I (alternative name) [CCN], precocene II (alternative name) [CCN], precocene III (alternative name) [CCN], primidophos (1349), profenofos (662), profluthrin [CCN], promacyl (1354), promecarb (1355), propaphos (1356), propetamphos (673), propoxur (678), prothidathion (1360), prothiofos (686), prothoate (1362), protrifenbute [CCN], pymetrozine (688), pyraclofos (689), pyrazophos (693), pyresmethrin (1367), pyrethrin I (696), pyrethrin II (696), pyrethrins (696), pyridaben (699), pyridalyl (700), pyridaphenthion (701), pyrimidifen (706), pyrimitate (1370), pyriproxyfen (708), quassia (alternative name) [CCN], quinalphos (711), quinalphos-methyl (1376), quinothion (1380), quintiofos (1381), R-1492 (development code) (1382), rafoxanide (alternative name) [CCN], resmethrin (719), rotenone (722), RU 15525 (development code) (723), RU 25475 (development code) (1386), ryania (alternative name) (1387), ryanodine (traditional name) (1387), sabadilla (alternative name) (725), schradan (1389), sebufos (alternative name), selamectin (alternative name) [CCN], SI-0009 (compound code), silafluofen (728), SN 72129 (development code) (1397), sodium arsenite [CCN], sodium cyamide (444), sodium fluoride (IUPAC/Chemical Abstracts name) (1399), sodium hexafluorosilicate (1400), sodium pentachlorophenoxide (623), sodium selenate (IUPAC name) (1401), sodium thiocyanate [CCN], sophamide (1402), spinosad (737), spiromesifen (739), sulcofuron (746), sulcofuron-sodium (746), sulfluramid (750), sulfotep (753), sulfuryl fluoride (756), sulprofos (1408), tar oils (alternative name) (758), tau-fluvalinate (398), tazimcarb (1412), TDE (1414), tebufenozide (762), tebufenpyrad (763), tebupirimfos (764), teflubenzuron (768), tefluthrin (769), temephos (770), TEPP (1417), terallethrin (1418), terbam (alternative name), terbufos (773), tetrachloroethane [CCN], tetrachlorvinphos (777), tetramethrin (787), theta-cypermethrin (204), thiacloprid (791), thiafenox (alternative name), thiamethoxam (792), thicrofos (1428), thiocarboxime (1431), thiocyclam (798), thiocyclam hydrogen oxalate (798), thiodicarb (799), thiofanox (800), thiometon (801), thionazin (1434), thiosultap (803), thiosultap-sodium (803), thuringiensin (alternative name) [CCN], tolfenpyrad (809), tralomethrin (812), transfluthrin (813), transpermethrin (1440), triamiphos (1441), triazamate (818), triazophos (820), triazuron (alternative name), trichlorfon (824), trichlormetaphos-3 (alternative name) [CCN], trichloronat (1452), trifenofos (1455), triflumuron (835), trimethacarb (840), triprene (1459), vamidothion (847), vaniliprole [CCN], veratridine (alternative name) (725), veratrine (alternative name) (725), XMC (853), xylylcarb (854), YI-5302 (compound code), zeta-cypermethrin (205), zetamethrin (alternative name), zinc phosphide (640), zolaprofos (1469) and ZXI 8901 (development code) (858),
a molluscicide selected from the group of substances consisting of bis(tributyltin)oxide (IUPAC name) (913), bromoacetamide [CCN], calcium arsenate [CCN], cloethocarb (999), copper acetoarsenite [CCN], copper sulfate (172), fentin (347), ferric phosphate (IUPAC name) (352), metaldehyde (518), methiocarb (530), niclosamide (576), niclosamide-olamine (576), pentachlorophenol (623), sodium pentachlorophenoxide (623), tazimcarb (1412), thiodicarb (799), tributyltin oxide (913), trifenmorph (1454), trimethacarb (840), triphenyltin acetate (IUPAC name) (347) and triphenyltin hydroxide (IUPAC name) (347),
a nematicide selected from the group of substances consisting of 1,2-dibromo-3-chloropropane (IUPAC/Chemical Abstracts name) (1045), 1,2-dichloropropane (IUPAC/Chemical Abstracts name) (1062), 1,2-dichloropropane with 1,3-dichloropropene (IUPAC name) (1063), 1,3-dichloropropene (233), 3,4-dichlorotetrahydrothiophene 1,1-dioxide (IUPAC/Chemical Abstracts name) (1065), 3-(4-chlorophenyl)-5-methylrhodanine (IUPAC name) (980), 5-methyl-6-thioxo-1,3,5-thiadiazinan-3-ylacetic acid (IUPAC name) (1286), 6-isopentenylaminopurine (alternative name) (210), abamectin (1), acetoprole [CCN], alanycarb (15), aldicarb (16), aldoxycarb (863), AZ 60541 (compound code), benclothiaz [CCN], benomyl (62), butylpyridaben (alternative name), cadusafos (109), carbofuran (118), carbon disulfide (945), carbosulfan (119), chloropicrin (141), chlorpyrifos (145), cloethocarb (999), cytokinins (alternative name) (210), dazomet (216), DBCP (1045), DCIP (218), diamidafos (1044), dichlofenthion (1051), dicliphos (alternative name), dimethoate (262), doramectin (alternative name) [CCN], emamectin (291), emamectin benzoate (291), eprinomectin (alternative name) [CCN], ethoprophos (312), ethylene dibromide (316), fenamiphos (326), fenpyrad (alternative name), fensulfothion (1158), fosthiazate (408), fosthietan (1196), furfural (alternative name) [CCN], GY-81 (development code) (423), heterophos [CCN], iodomethane (IUPAC name) (542), isamidofos (1230), isazofos (1231), ivermectin (alternative name) [CCN], kinetin (alternative name) (210), mecarphon (1258), metam (519), metam-potassium (alternative name) (519), metam-sodium (519), methyl bromide (537), methyl isothiocyanate (543), milbemycin oxime (alternative name) [CCN], moxidectin (alternative name) [CCN], Myrothecium verrucaria composition (alternative name) (565), NC-184 (compound code), oxamyl (602), phorate (636), phosphamidon (639), phosphocarb [CCN], sebufos (alternative name), selamectin (alternative name) [CCN], spinosad (737), terbam (alternative name), terbufos (773), tetrachlorothiophene (IUPAC/Chemical Abstracts name) (1422), thiafenox (alternative name), thionazin (1434), triazophos (820), triazuron (alternative name), xylenols [CCN], YI-5302 (compound code) and zeatin (alternative name) (210),
a nitrification inhibitor selected from the group of substances consisting of potassium ethylxanthate [CCN] and nitrapyrin (580),
a plant activator selected from the group of substances consisting of acibenzolar (6), acibenzolar-5-methyl (6), probenazole (658) and Reynoutria sachalinensis extract (alternative name) (720),
a rodenticide selected from the group of substances consisting of 2-isovalerylindan-1,3-dione (IUPAC name) (1246), 4-(quinoxalin-2-ylamino)benzenesulfonamide (IUPAC name) (748), alpha-chlorohydrin [CCN], aluminium phosphide (640), antu (880), arsenous oxide (882), barium carbonate (891), bisthiosemi (912), brodifacoum (89), bromadiolone (91), bromethalin (92), calcium cyamide (444), chloralose (127), chlorophacinone (140), cholecalciferol (alternative name) (850), coumachlor (1004), coumafuryl (1005), coumatetralyl (175), crimidine (1009), difenacoum (246), difethialone (249), diphacinone (273), ergocalciferol (301), flocoumafen (357), fluoroacetamide (379), flupropadine (1183), flupropadine hydrochloride (1183), gamma-HCH (430), HCH (430), hydrogen cyamide (444), iodomethane (IUPAC name) (542), lindane (430), magnesium phosphide (IUPAC name) (640), methyl bromide (537), norbormide (1318), phosacetim (1336), phosphine (IUPAC name) (640), phosphorus [CCN], pindone (1341), potassium arsenite [CCN], pyrinuron (1371), scilliroside (1390), sodium arsenite [CCN], sodium cyamide (444), sodium fluoro-acetate (735), strychnine (745), thallium sulfate [CCN], warfarin (851) and zinc phosphide (640),
a synergist selected from the group of substances consisting of 2-(2-butoxyethoxy)ethyl piperonylate (IUPAC name) (934), 5-(1,3-benzodioxol-5-yl)-3-hexylcyclohex-2-enone (IUPAC name) (903), farnesol with nerolidol (alternative name) (324), MB-599 (development code) (498), MGK 264 (development code) (296), piperonyl butoxide (649), piprotal (1343), propyl isomer (1358), S421 (development code) (724), sesamex (1393), sesasmolin (1394) and sulfoxide (1406),
an animal repellent selected from the group of substances consisting of anthraquinone (32), chloralose (127), copper naphthenate [CCN], copper oxychloride (171), diazinon (227), dicyclopentadiene (chemical name) (1069), guazatine (422), guazatine acetates (422), methiocarb (530), pyridin-4-amine (IUPAC name) (23), thiram (804), trimethacarb (840), zinc naphthenate [CCN] and ziram (856),
a virucide selected from the group of substances consisting of imanin (alternative name) [CCN] and ribavirin (alternative name) [CCN],
and a wound protectant selected from the group of substances consisting of mercuric oxide (512), octhilinone (590) and thiophanate-methyl (802).

A very especially preferred embodiment of the subject-matter {1.1.25} of the invention is {1.1.25.2} a pesticidal composition comprising a mixture consisting of at least two substances, namely one compound (A) and at least one compound (B), as active ingredient and at least one auxiliary, wherein the compound (A) is the compound of formula (A-25) and the compound (B) is a compound selected from the group of substances consisting of abamectin (1), cyromazine (209), diafenthiuron (226), diazinon (227), emamectin benzoate (291), fenoxycarb (340), fosthiazate (408), lambda-cyhalothrin (198), lufenuron (490), methidathion (529), profenofos (662), pymetrozine (688), tefluthrin (769) and thiamethoxam (792).

The compound of formula (A-25) is known, for example, from the PCT Application WO-04/067528.

A preferred embodiment of the subject-matter {1.1} of the invention is {1.1.26} a pesticidal composition comprising a mixture consisting of at least two substances, namely one compound (A) and at least one compound (B), as active ingredient and at least one auxiliary, wherein the compound (A) is the compound of formula (A-26) 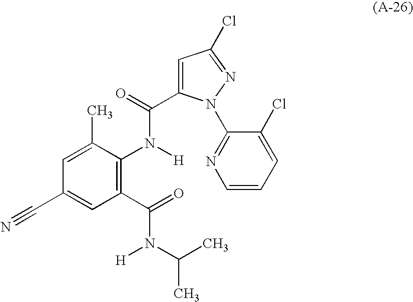
and the compound (B) is a compound selected from the group of substances consisting of an adjuvant, an acaricide, an algicide, an anthelmintic, an avicide, a bactericide, a biological agent, a soil sterilant, a chemosterilant, an insect pheromone, an insect repellent, an insecticide, a molluscicide, a nematicide, a nitrification inhibitor, a plant activator, a rodenticide, a synergist, an animal repellent, a virucide and a wound protectant.

An especially preferred embodiment of the subject-matter {1.1.26} of the invention is {1.1.26.1} a pesticidal composition comprising a mixture consisting of at least two substances, namely one compound (A) and at least one compound (B), as active ingredient and at least one auxiliary, wherein the compound (A) is the compound of formula (A-26) and the compound (B) is a compound selected from the group of substances consisting of
an adjuvant selected from the group of substances consisting of petroleum oils (alternative name) (628),
an acaricide selected from the group of substances consisting of 1,1-bis(4-chlorophenyl)-2-ethoxyethanol (IUPAC name) (910), 2,4-dichlorophenyl benzenesulfonate (IUPAC/Chemical Abstracts name) (1059), 2-fluoro-N-methyl-N-1-naphthylacetamide (IUPAC name) (1295), 4-chlorophenyl phenyl sulfone (IUPAC name) (981), abamectin (1), acequinocyl (3), acetoprole [CCN], acrinathrin (9), aldicarb (16), aldoxycarb (863), alpha-cypermethrin (202), amidithion (870), amidoflumet [CCN], amidothioate (872), amiton (875), amiton hydrogen oxalate (875), amitraz (24), aramite (881), arsenous oxide (882), AVI 382 (compound code), AZ 60541 (compound code), azinphos-ethyl (44), azinphos-methyl (45), azobenzene (IUPAC name) (888), azocyclotin (46), azothoate (889), benomyl (62), benoxafos (alternative name) [CCN], benzoximate (71), benzyl benzoate (IUPAC name) [CCN], bifenazate (74), bifenthrin (76), binapacryl (907), brofenvalerate (alternative name), bromocyclen (918), bromophos (920), bromophos-ethyl (921), bromopropylate (94), buprofezin (99), butocarboxim (103), butoxycarboxim (104), butylpyridaben (alternative name), calcium polysulfide (IUPAC name) (111), camphechlor (941), carbanolate (943), carbaryl (115), carbofuran (118), carbophenothion (947), CGA 50'439 (development code) (125), chinomethionat (126), chlorbenside (959), chlordimeform (964), chlordimeform hydrochloride (964), chlorfenapyr (130), chlorfenethol (968), chlorfenson (970), chlorfensulphide (971), chlorfenvinphos (131), chlorobenzilate (975), chloromebuform (977), chloromethiuron (978), chloropropylate (983), chlorpyrifos (145), chlorpyrifos-methyl (146), chlorthiophos (994), cinerin I (696), cinerin II (696), cinerins (696), clofentezine (158), closantel (alternative name) [CCN], coumaphos (174), crotamiton (alternative name) [CCN], crotoxyphos (1010), cufraneb (1013), cyanthoate (1020), cyhalothrin (196), cyhexatin (199), cypermethrin (201), DCPM (1032), DDT (219), demephion (1037), demephion-O (1037), demephion-S (1037), demeton (1038), demeton-methyl (224), demeton-O (1038), demeton-O-methyl (224), demeton-S (1038), demeton-5-methyl (224), demeton-5-methylsulphon (1039), diafenthiuron (226), dialifos (1042), diazinon (227), dichlofluanid (230), dichlorvos (236), dicliphos (alternative name), dicofol (242), dicrotophos (243), dienochlor (1071), dimefox (1081), dimethoate (262), dinactin (alternative name) (653), dinex (1089), dinex-diclexine (1089), dinobuton (269), dinocap (270), dinocap-4 [CCN], dinocap-6 [CCN], dinocton (1090), dinopenton (1092), dinosulfon (1097), dinoterbon (1098), dioxathion (1102), diphenyl sulfone (IUPAC name) (1103), disulfuram (alternative name) [CCN], disulfoton (278), DNOC (282), dofenapyn (1113), doramectin (alternative name) [CCN], endosulfan (294), endothion (1121), EPN (297), eprinomectin (alternative name) [CCN], ethion (309), ethoate-methyl (1134), etoxazole (320), etrimfos (1142), fenazaflor (1147), fenazaquin (328), fenbutatin oxide (330), fenothiocarb (337), fenpropathrin (342), fenpyrad (alternative name), fenpyroximate (345), fenson (1157), fentrifanil (1161), fenvalerate (349), fipronil (354), fluacrypyrim (360), fluazuron (1166), flubenzimine (1167), flucycloxuron (366), flucythrinate (367), fluenetil (1169), flufenoxuron (370), flumethrin (372), fluorbenside (1174), fluvalinate (1184), FMC 1137 (development code) (1185), formetanate (405), formetanate hydrochloride (405), formothion (1192), formparanate (1193), gamma-HCH (430), glyodin (1205), halfenprox (424), heptenophos (432), hexadecyl cyclopropanecarboxylate (IUPAC/Chemical Abstracts name) (1216), hexythiazox (441), iodomethane (IUPAC name) (542), isocarbophos (alternative name) (473), isopropyl O-(methoxyaminothiophosphoryl)salicylate (IUPAC name) (473), ivermectin (alternative name) [CCN], jasmolin I (696), jasmolin II (696), jodfenphos (1248), lindane (430), lufenuron (490), malathion (492), malonoben (1254), mecarbam (502), mephosfolan (1261), mesulfen (alternative name) [CCN], methacrifos (1266), methamidophos (527), methidathion (529), methiocarb (530), methomyl (531), methyl bromide (537), metolcarb (550), mevinphos (556), mexacarbate (1290), milbemectin (557), milbemycin oxime (alternative name) [CCN], mipafox (1293), monocrotophos (561), morphothion (1300), moxidectin (alternative name) [CCN], naled (567), NC-184 (compound code), nifluridide (1309), nikkomycins (alternative name) [CCN], nitrilacarb (1313), nitrilacarb 1:1 zinc chloride complex (1313), NNI-0101 (compound code), NNI-0250 (compound code), omethoate (594), oxamyl (602), oxydeprofos (1324), oxydisulfoton (1325), pp′-DDT (219), parathion (615), permethrin (626), petroleum oils (alternative name) (628), phenkapton (1330), phenthoate (631), phorate (636), phosalone (637), phosfolan (1338), phosmet (638), phosphamidon (639), phoxim (642), pirimiphos-methyl (652), polychloroterpenes (traditional name) (1347), polynactins (alternative name) (653), proclonol (1350), profenofos (662), promacyl (1354), propargite (671), propetamphos (673), propoxur (678), prothidathion (1360), prothoate (1362), pyrethrin I (696), pyrethrin II (696), pyrethrins (696), pyridaben (699), pyridaphenthion (701), pyrimidifen (706), pyrimitate (1370), quinalphos (711), quintiofos (1381), R-1492 (development code) (1382), RA-17 (development code) (1383), rotenone (722), schradan (1389), sebufos (alternative name), selamectin (alternative name) [CCN], SI-0009 (compound code), sophamide (1402), spirodiclofen (738), spiromesifen (739), SSI-121 (development code) (1404), sulfuram (alternative name) [CCN], sulfluramid (750), sulfotep (753), sulfur (754), SZI-121 (development code) (757), tau-fluvalinate (398), tebufenpyrad (763), TEPP (1417), terbam (alternative name), tetrachlorvinphos (777), tetradifon (786), tetranactin (alternative name) (653), tetrasul (1425), thiafenox (alternative name), thiocarboxime (1431), thiofanox (800), thiometon (801), thioquinox (1436), thuringiensin (alternative name) [CCN], triamiphos (1441), triarathene (1443), triazophos (820), triazuron (alternative name), trichlorfon (824), trifenofos (1455), trinactin (alternative name) (653), vamidothion (847), vaniliprole [CCN] and YI-5302 (compound code),
an algicide selected from the group of substances consisting of bethoxazin [CCN], copper dioctanoate (IUPAC name) (170), copper sulfate (172), cybutryne [CCN], dichlone (1052), dichlorophen (232), endothal (295), fentin (347), hydrated lime [CCN], nabam (566), quinoclamine (714), quinonamid (1379), simazine (730), triphenyltin acetate (IUPAC name) (347) and triphenyltin hydroxide (IUPAC name) (347),
an anthelmintic selected from the group of substances consisting of abamectin (1), crufomate (1011), doramectin (alternative name) [CCN], emamectin (291), emamectin benzoate (291), eprinomectin (alternative name) [CCN], ivermectin (alternative name) [CCN], milbemycin oxime (alternative name) [CCN], moxidectin (alternative name) [CCN], piperazine [CCN], selamectin (alternative name) [CCN], spinosad (737) and thiophanate (1435),
an avicide selected from the group of substances consisting of chloralose (127), endrin (1122), fenthion (346), pyridin-4-amine (IUPAC name) (23) and strychnine (745),
a bactericide selected from the group of substances consisting of 1-hydroxy-1H-pyridine-2-thione (IUPAC name) (1222), 4-(quinoxalin-2-ylamino)benzenesulfonamide (IUPAC name) (748), 8-hydroxyquinoline sulfate (446), bronopol (97), copper dioctanoate (IUPAC name) (170), copper hydroxide (IUPAC name) (169), cresol [CCN], dichlorophen (232), dipyrithione (1105), dodicin (1112), fenaminosulf (1144), formaldehyde (404), hydrargaphen (alternative name) [CCN], kasugamycin (483), kasugamycin hydrochloride hydrate (483), nickel bis(dimethyldithiocarbamate) (IUPAC name) (1308), nitrapyrin (580), octhilinone (590), oxolinic acid (606), oxytetracycline (611), potassium hydroxyquinoline sulfate (446), probenazole (658), streptomycin (744), streptomycin sesquisulfate (744), tecloftalam (766) and thiomersal (alternative name) [CCN],
a biological agent selected from the group of substances consisting of Adoxophyes orana GV (alternative name) (12), Agrobacterium radiobacter (alternative name) (13), Amblyseius spp. (alternative name) (19), Anagrapha falcifera NPV (alternative name) (28), Anagrus atomus (alternative name) (29), Aphelinus abdominalis (alternative name) (33), Aphidius colemani (alternative name) (34), Aphidoletes aphidimyza (alternative name) (35), Autographa californica NPV (alternative name) (38), Bacillus firmus (alternative name) (48), Bacillus sphaericus Neide (scientific name) (49), Bacillus thuringiensis Berliner (scientific name) (51), Bacillus thuringiensis subsp. aizawai (scientific name) (51), Bacillus thuringiensis subsp. israelensis (scientific name) (51), Bacillus thuringiensis subsp. japonensis (scientific name) (51), Bacillus thuringiensis subsp. kurstaki (scientific name) (51), Bacillus thuringiensis subsp. tenebrionis (scientific name) (51), Beauveria bassiana (alternative name) (53), Beauveria brongniartii (alternative name) (54), Chrysoperla carnea (alternative name) (151), Cryptolaemus montrouzieri (alternative name) (178), Cydia pomonella GV (alternative name) (191), Dacnusa sibirica (alternative name) (212), Diglyphus isaea (alternative name) (254), Encarsia formosa (scientific name) (293), Eretmocerus eremicus (alternative name) (300), Helicoverpa zea NPV (alternative name) (431), Heterorhabditis bacteriophora and H. megidis (alternative name) (433), Hippodamia convergens (alternative name) (442), Leptomastix dactylopii (alternative name) (488), Macrolophus caliginosus (alternative name) (491), Mamestra brassicae NPV (alternative name) (494), Metaphycus helvolus (alternative name) (522), Metarhizium anisopliae var. acridum (scientific name) (523), Metarhizium anisopliae var. anisopliae (scientific name) (523), Neodiprion sertifer NPV and N. lecontei NPV (alternative name) (575), Orius spp. (alternative name) (596), Paecilomyces fumosoroseus (alternative name) (613), Phytoseiulus persimilis (alternative name) (644), Spodoptera exigua multicapsid nuclear polyhedrosis virus (scientific name) (741), Steinernema bibionis (alternative name) (742), Steinernema carpocapsae (alternative name) (742), Steinernema feltiae (alternative name) (742), Steinernema glaseri (alternative name) (742), Steinernema riobrave (alternative name) (742), Steinernema riobravis (alternative name) (742), Steinernema scapterisci (alternative name) (742), Steinernema spp. (alternative name) (742), Trichogramma spp. (alternative name) (826), Typhlodromus occidentalis (alternative name) (844) and Verticillium lecanii (alternative name) (848),
a soil sterilant selected from the group of substances consisting of iodomethane (IUPAC name) (542) and methyl bromide (537),
a chemosterilant selected from the group of substances consisting of apholate [CCN], bisazir (alternative name) [CCN], busulfan (alternative name) [CCN], diflubenzuron (250), dimatif (alternative name) [CCN], hemel [CCN], hempa [CCN], metepa [CCN], methiotepa [CCN], methyl apholate [CCN], morzid [CCN], penfluoron (alternative name) [CCN], tepa [CCN], thiohempa (alternative name) [CCN], thiotepa (alternative name) [CCN], tretamine (alternative name) [CCN] and uredepa (alternative name) [CCN],
an insect pheromone selected from the group of substances consisting of (E)-dec-5-en-1-yl acetate with (E)-dec-5-en-1-ol (IUPAC name) (222), (E)-tridec-4-en-1-yl acetate (IUPAC name) (829), (E)-6-methylhept-2-en-4-ol (IUPAC name) (541), (E,Z)-tetradeca-4,10-dien-1-yl acetate (IUPAC name) (779), (Z)-dodec-7-en-1-yl acetate (IUPAC name) (285), (Z)-hexadec-11-enal (IUPAC name) (436), (Z)-hexadec-11-en-1-yl acetate (IUPAC name) (437), (Z)-hexadec-13-en-11-yn-1-yl acetate (IUPAC name) (438), (Z)-icos-13-en-10-one (IUPAC name) (448), (Z)-tetradec-7-en-1-al (IUPAC name) (782), (Z)-tetradec-9-en-1-ol (IUPAC name) (783), (Z)-tetradec-9-en-1-yl acetate (IUPAC name) (784), (7E,9Z)-dodeca-7,9-dien-1-yl acetate (IUPAC name) (283), (9Z,11E)-tetradeca-9,11-dien-1-yl acetate (IUPAC name) (780), (9Z,12E)-tetradeca-9,12-dien-1-yl acetate (IUPAC name) (781), 14-methyloctadec-1-ene (IUPAC name) (545), 4-methylnonan-5-ol with 4-methylnonan-5-one (IUPAC name) (544), alpha-multistriatin (alternative name) [CCN], brevicomin (alternative name) [CCN], codlelure (alternative name) [CCN], codlemone (alternative name) (167), cuelure (alternative name) (179), disparlure (277), dodec-8-en-1-yl acetate (IUPAC name) (286), dodec-9-en-1-yl acetate (IUPAC name) (287), dodeca-8,10-dien-1-yl acetate (IUPAC name) (284), dominicalure (alternative name) [CCN], ethyl 4-methyloctanoate (IUPAC name) (317), eugenol (alternative name) [CCN], frontalin (alternative name) [CCN], gossyplure (alternative name) (420), grandlure (421), grandlure I (alternative name) (421), grandlure II (alternative name) (421), grandlure III (alternative name) (421), grandlure IV (alternative name) (421), hexylure [CCN], ipsdienol (alternative name) [CCN], ipsenol (alternative name) [CCN], japonilure (alternative name) (481), lineatin (alternative name) [CCN], litlure (alternative name) [CCN], looplure (alternative name) [CCN], medlure [CCN], megatomoic acid (alternative name) [CCN], methyl eugenol (alternative name) (540), muscalure (563), octadeca-2,13-dien-1-yl acetate (IUPAC name) (588), octadeca-3,13-dien-1-yl acetate (IUPAC name) (589), orfralure (alternative name) [CCN], oryctalure (alternative name) (317), ostramone (alternative name) [CCN], siglure [CCN], sordidin (alternative name) (736), sulcatol (alternative name) [CCN], tetradec-11-en-1-yl acetate (IUPAC name) (785), trimedlure (839), trimedlure A (alternative name) (839), trimedlure B₁ (alternative name) (839), trimedlure B₂ (alternative name) (839), trimedlure C (alternative name) (839) and trunc-call (alternative name) [CCN],
an insect repellent selected from the group of substances consisting of 2-(octylthio)-ethanol (IUPAC name) (591), butopyronoxyl (933), butoxy(polypropylene glycol) (936), dibutyl adipate (IUPAC name) (1046), dibutyl phthalate (1047), dibutyl succinate (IUPAC name) (1048), diethyltoluamide [CCN], dimethyl carbate [CCN], dimethyl phthalate [CCN], ethyl hexanediol (1137), hexamide [CCN], methoquin-butyl (1276), methylneodecanamide [CCN], oxamate [CCN] and picaridin [CCN],
an insecticide selected from the group of substances consisting of 1,1-dichloro-1-nitroethane (IUPAC/Chemical Abstracts name) (1058), 1,1-dichloro-2,2-bis(4-ethylphenyl)-ethane (IUPAC name) (1056), 1,2-dichloropropane (IUPAC/Chemical Abstracts name) (1062), 1,2-dichloropropane with 1,3-dichloropropene (IUPAC name) (1063), 1-bromo-2-chloroethane (IUPAC/Chemical Abstracts name) (916), 2,2,2-trichloro-1-(3,4-dichloro-phenyl)ethyl acetate (IUPAC name) (1451), 2,2-dichlorovinyl 2-ethylsulfinylethyl methyl phosphate (IUPAC name) (1066), 2-(1,3-dithiolan-2-yl)phenyl dimethylcarbamate (IUPAC/Chemical Abstracts name) (1109), 2-(2-butoxyethoxy)ethyl thiocyanate (IUPAC/Chemical Abstracts name) (935), 2-(4,5-dimethyl-1,3-dioxolan-2-yl)phenyl methylcarbamate (IUPAC/Chemical Abstracts name) (1084), 2-(4-chloro-3,5-xylyloxy)ethanol (IUPAC name) (986), 2-chlorovinyl diethyl phosphate (IUPAC name) (984), 2-imidazolidone (IUPAC name) (1225), 2-isovalerylindan-1,3-dione (IUPAC name) (1246), 2-methyl(prop-2-ynyl)aminophenyl methylcarbamate (IUPAC name) (1284), 2-thiocyanatoethyl laurate (IUPAC name) (1433), 3-bromo-1-chloroprop-1-ene (IUPAC name) (917), 3-methyl-1-phenylpyrazol-5-yl dimethyl-carbamate (IUPAC name) (1283), 4-methyl(prop-2-ynyl)amino-3,5-xylyl methylcarbamate (IUPAC name) (1285), 5,5-dimethyl-3-oxocyclohex-1-enyl dimethylcarbamate (IUPAC name) (1085), abamectin (1), acephate (2), acetamiprid (4), acethion (alternative name) [CCN], acetoprole [CCN], acrinathrin (9), acrylonitrile (IUPAC name) (861), alanycarb (15), aldicarb (16), aldoxycarb (863), aldrin (864), allethrin (17), allosamidin (alternative name) [CCN], allyxycarb (866), alpha-cypermethrin (202), alpha-ecdysone (alternative name) [CCN], aluminium phosphide (640), amidithion (870), amidothioate (872), aminocarb (873), amiton (875), amiton hydrogen oxalate (875), amitraz (24), anabasine (877), athidathion (883), AVI 382 (compound code), AZ 60541 (compound code), azadirachtin (alternative name) (41), azamethiphos (42), azinphos-ethyl (44), azinphos-methyl (45), azothoate (889), Bacillus thuringiensis delta endotoxins (alternative name) (52), barium hexafluorosilicate (alternative name) [CCN], barium polysulfide (IUPAC/Chemical Abstracts name) (892), barthrin [CCN], BAS 320 I (compound code), Bayer 22/190 (development code) (893), Bayer 22408 (development code) (894), bendiocarb (58), benfuracarb (60), bensultap (66), beta-cyfluthrin (194), beta-cypermethrin (203), bifenthrin (76), bioallethrin (78), bioallethrin S-cyclopentenyl isomer (alternative name) (79), bioethanomethrin [CCN], biopermethrin (908), bioresmethrin (80), bis(2-chloroethyl)ether (IUPAC name) (909), bistrifluoron (83), borax (86), brofenvalerate (alternative name), bromfenvinfos (914), bromocyclen (918), bromo-DDT (alternative name) [CCN], bromophos (920), bromophos-ethyl (921), bufencarb (924), buprofezin (99), butacarb (926), butathiofos (927), butocarboxim (103), butonate (932), butoxycarboxim (104), butylpyridaben (alternative name), cadusafos (109), calcium arsenate [CCN], calcium cyamide (444), calcium polysulfide (IUPAC name) (111), camphechlor (941), carbanolate (943), carbaryl (115), carbofuran (118), carbon disulfide (IUPAC/Chemical Abstracts name) (945), carbon tetrachloride (IUPAC name) (946), carbophenothion (947), carbosulfan (119), cartap (123), cartap hydrochloride (123), cevadine (alternative name) (725), chlorbicyclen (960), chlordane (128), chlordecone (963), chlordimeform (964), chlordimeform hydrochloride (964), chlorethoxyfos (129), chlorfenapyr (130), chlorfenvinphos (131), chlorfluazuron (132), chlormephos (136), chloroform [CCN], chloropicrin (141), chlorphoxim (989), chlorprazophos (990), chlorpyrifos (145), chlorpyrifos-methyl (146), chlorthiophos (994), chromafenozide (150), cinerin I (696), cinerin II (696), cinerins (696), cis-resmethrin (alternative name), cismethrin (80), clocythrin (alternative name), cloethocarb (999), closantel (alternative name) [CCN], clothianidin (165), copper acetoarsenite [CCN], copper arsenate [CCN], copper oleate [CCN], coumaphos (174), coumithoate (1006), crotamiton (alternative name) [CCN], crotoxyphos (1010), crufomate (1011), cryolite (alternative name) (177), CS 708 (development code) (1012), cyanofenphos (1019), cyanophos (184), cyanthoate (1020), cyclethrin [CCN], cycloprothrin (188), cyfluthrin (193), cyhalothrin (196), cypermethrin (201), cyphenothrin (206), cyromazine (209), cythioate (alternative name) [CCN], d-limonene (alternative name) [CCN], d-tetramethrin (alternative name) (788), DAEP (1031), dazomet (216), DDT (219), decarbofuran (1034), deltamethrin (223), demephion (1037), demephion-O (1037), demephion-S (1037), demeton (1038), demeton-methyl (224), demeton-O (1038), demeton-O-methyl (224), demeton-S (1038), demeton-5-methyl (224), demeton-5-methylsulphon (1039), diafenthiuron (226), dialifos (1042), diamidafos (1044), diazinon (227), dicapthon (1050), dichlofenthion (1051), dichlorvos (236), dicliphos (alternative name), dicresyl (alternative name) [CCN], dicrotophos (243), dicyclanil (244), dieldrin (1070), diethyl 5-methylpyrazol-3-yl phosphate (IUPAC name) (1076), diflubenzuron (250), dilor (alternative name) [CCN], dimefluthrin [CCN], dimefox (1081), dimetan (1085), dimethoate (262), dimethrin (1083), dimethylvinphos (265), dimetilan (1086), dinex (1089), dinex-diclexine (1089), dinoprop (1093), dinosam (1094), dinoseb (1095), dinotefuran (271), diofenolan (1099), dioxabenzofos (1100), dioxacarb (1101), dioxathion (1102), disulfoton (278), dithicrofos (1108), DNOC (282), doramectin (alternative name) [CCN], DSP (1115), ecdysterone (alternative name) [CCN], EI 1642 (development code) (1118), emamectin (291), emamectin benzoate (291), EMPC (1120), empenthrin (292), endosulfan (294), endothion (1121), endrin (1122), EPBP (1123), EPN (297), epofenonane (1124), eprinomectin (alternative name) [CCN], esfenvalerate (302), etaphos (alternative name) [CCN], ethiofencarb (308), ethion (309), ethiprole (310), ethoate-methyl (1134), ethoprophos (312), ethyl formate (IUPAC name) [CCN], ethyl-DDD (alternative name) (1056), ethylene dibromide (316), ethylene dichloride (chemical name) (1136), ethylene oxide [CCN], etofenprox (319), etrimfos (1142), EXD (1143), famphur (323), fenamiphos (326), fenazaflor (1147), fenchlorphos (1148), fenethacarb (1149), fenfluthrin (1150), fenitrothion (335), fenobucarb (336), fenoxacrim (1153), fenoxycarb (340), fenpirithrin (1155), fenpropathrin (342), fenpyrad (alternative name), fensulfothion (1158), fenthion (346), fenthion-ethyl [CCN], fenvalerate (349), fipronil (354), flonicamid (358), flucofuron (1168), flucycloxuron (366), flucythrinate (367), fluenetil (1169), flufenerim [CCN], flufenoxuron (370), flufenprox (1171), flumethrin (372), fluvalinate (1184), FMC 1137 (development code) (1185), fonofos (1191), formetanate (405), formetanate hydrochloride (405), formothion (1192), formparanate (1193), fosmethilan (1194), fospirate (1195), fosthiazate (408), fosthietan (1196), furathiocarb (412), furethrin (1200), gamma-cyhalothrin (197), gamma-HCH (430), guazatine (422), guazatine acetates (422), GY-81 (development code) (423), halfenprox (424), halofenozide (425), HCH (430), HEOD (1070), heptachlor (1211), heptenophos (432), heterophos [CCN], hexaflumuron (439), HHDN (864), hydramethylnon (443), hydrogen cyamide (444), hydroprene (445), hyquincarb (1223), imidacloprid (458), imiprothrin (460), indoxacarb (465), iodomethane (IUPAC name) (542), IPSP (1229), isazofos (1231), isobenzan (1232), isocarbophos (alternative name) (473), isodrin (1235), isofenphos (1236), isolane (1237), isoprocarb (472), isopropyl O-(methoxyaminothiophosphoryl)salicylate (IUPAC name) (473), isoprothiolane (474), isothioate (1244), isoxathion (480), ivermectin (alternative name) [CCN], jasmolin I (696), jasmolin II (696), jodfenphos (1248), juvenile hormone I (alternative name) [CCN], juvenile hormone II (alternative name) [CCN], juvenile hormone III (alternative name) [CCN], kelevan (1249), kinoprene (484), lambda-cyhalothrin (198), lead arsenate [CCN], leptophos (1250), lindane (430), lirimfos (1251), lufenuron (490), lythidathion (1253), m-cumenyl methylcarbamate (IUPAC name) (1014), magnesium phosphide (IUPAC name) (640), malathion (492), malonoben (1254), mazidox (1255), mecarbam (502), mecarphon (1258), menazon (1260), mephosfolan (1261), mercurous chloride (513), mesulfenfos (1263), metam (519), metam-potassium (alternative name) (519), metam-sodium (519), methacrifos (1266), methamidophos (527), methanesulfonyl fluoride (IUPAC/Chemical Abstracts name) (1268), methidathion (529), methiocarb (530), methocrotophos (1273), methomyl (531), methoprene (532), methoquin-butyl (1276), methothrin (alternative name) (533), methoxychlor (534), methoxyfenozide (535), methyl bromide (537), methyl isothiocyanate (543), methylchloroform (alternative name) [CCN], methylene chloride [CCN], metofluthrin [CCN], metolcarb (550), metoxadiazone (1288), mevinphos (556), mexacarbate (1290), milbemectin (557), milbemycin oxime (alternative name) [CCN], mipafox (1293), mirex (1294), monocrotophos (561), morphothion (1300), moxidectin (alternative name) [CCN], naftalofos (alternative name) [CCN], naled (567), naphthalene (IUPAC/Chemical Abstracts name) (1303), NC-170 (development code) (1306), NC-184 (compound code), nicotine (578), nicotine sulfate (578), nifluridide (1309), nitenpyram (579), nithiazine (1311), nitrilacarb (1313), nitrilacarb 1:1 zinc chloride complex (1313), NNI-0101 (compound code), NNI-0250 (compound code), nornicotine (traditional name) (1319), novaluron (585), noviflumuron (586), O-2,5-dichloro-4-iodophenyl O-ethyl ethylphosphonothioate (IUPAC name) (1057), O,O-diethyl O-4-methyl-2-oxo-2H-chromen-7-yl phosphorothioate (IUPAC name) (1074), O,O-diethyl O-6-methyl-2-propylpyrimidin-4-yl phosphorothioate (IUPAC name) (1075), O,O,O′,O′-tetrapropyl dithiopyrophosphate (IUPAC name) (1424), oleic acid (IUPAC name) (593), omethoate (594), oxamyl (602), oxydemeton-methyl (609), oxydeprofos (1324), oxydisulfoton (1325), pp′-DDT (219), para-dichlorobenzene [CCN], parathion (615), parathion-methyl (616), penfluoron (alternative name) [CCN], pentachlorophenol (623), pentachlorophenyl laurate (IUPAC name) (623), permethrin (626), petroleum oils (alternative name) (628), PH 60-38 (development code) (1328), phenkapton (1330), phenothrin (630), phenthoate (631), phorate (636), phosalone (637), phosfolan (1338), phosmet (638), phosnichlor (1339), phosphamidon (639), phosphine (IUPAC name) (640), phoxim (642), phoxim-methyl (1340), pirimetaphos (1344), pirimicarb (651), pirimiphos-ethyl (1345), pirimiphos-methyl (652), polychlorodicyclopentadiene isomers (IUPAC name) (1346), polychloroterpenes (traditional name) (1347), potassium arsenite [CCN], potassium thiocyanate [CCN], prallethrin (655), precocene I (alternative name) [CCN], precocene II (alternative name) [CCN], precocene III (alternative name) [CCN], primidophos (1349), profenofos (662), profluthrin [CCN], promacyl (1354), promecarb (1355), propaphos (1356), propetamphos (673), propoxur (678), prothidathion (1360), prothiofos (686), prothoate (1362), protrifenbute [CCN], pymetrozine (688), pyraclofos (689), pyrazophos (693), pyresmethrin (1367), pyrethrin I (696), pyrethrin II (696), pyrethrins (696), pyridaben (699), pyridalyl (700), pyridaphenthion (701), pyrimidifen (706), pyrimitate (1370), pyriproxyfen (708), quassia (alternative name) [CCN], quinalphos (711), quinalphos-methyl (1376), quinothion (1380), quintiofos (1381), R-1492 (development code) (1382), rafoxanide (alternative name) [CCN], resmethrin (719), rotenone (722), RU 15525 (development code) (723), RU 25475 (development code) (1386), ryania (alternative name) (1387), ryanodine (traditional name) (1387), sabadilla (alternative name) (725), schradan (1389), sebufos (alternative name), selamectin (alternative name) [CCN], SI-0009 (compound code), silafluofen (728), SN 72129 (development code) (1397), sodium arsenite [CCN], sodium cyamide (444), sodium fluoride (IUPAC/Chemical Abstracts name) (1399), sodium hexafluorosilicate (1400), sodium pentachlorophenoxide (623), sodium selenate (IUPAC name) (1401), sodium thiocyanate [CCN], sophamide (1402), spinosad (737), spiromesifen (739), sulcofuron (746), sulcofuron-sodium (746), sulfluramid (750), sulfotep (753), sulfuryl fluoride (756), sulprofos (1408), tar oils (alternative name) (758), tau-fluvalinate (398), tazimcarb (1412), TDE (1414), tebufenozide (762), tebufenpyrad (763), tebupirimfos (764), teflubenzuron (768), tefluthrin (769), temephos (770), TEPP (1417), terallethrin (1418), terbam (alternative name), terbufos (773), tetrachloroethane [CCN], tetrachlorvinphos (777), tetramethrin (787), theta-cypermethrin (204), thiacloprid (791), thiafenox (alternative name), thiamethoxam (792), thicrofos (1428), thiocarboxime (1431), thiocyclam (798), thiocyclam hydrogen oxalate (798), thiodicarb (799), thiofanox (800), thiometon (801), thionazin (1434), thiosultap (803), thiosultap-sodium (803), thuringiensin (alternative name) [CCN], tolfenpyrad (809), tralomethrin (812), transfluthrin (813), transpermethrin (1440), triamiphos (1441), triazamate (818), triazophos (820), triazuron (alternative name), trichlorfon (824), trichlormetaphos-3 (alternative name) [CCN], trichloronat (1452), trifenofos (1455), triflumuron (835), trimethacarb (840), triprene (1459), vamidothion (847), vaniliprole [CCN], veratridine (alternative name) (725), veratrine (alternative name) (725), XMC (853), xylylcarb (854), YI-5302 (compound code), zeta-cypermethrin (205), zetamethrin (alternative name), zinc phosphide (640), zolaprofos (1469) and ZXI 8901 (development code) (858),
a molluscicide selected from the group of substances consisting of bis(tributyltin)oxide (IUPAC name) (913), bromoacetamide [CCN], calcium arsenate [CCN], cloethocarb (999), copper acetoarsenite [CCN], copper sulfate (172), fentin (347), ferric phosphate (IUPAC name) (352), metaldehyde (518), methiocarb (530), niclosamide (576), niclosamide-olamine (576), pentachlorophenol (623), sodium pentachlorophenoxide (623), tazimcarb (1412), thiodicarb (799), tributyltin oxide (913), trifenmorph (1454), trimethacarb (840), triphenyltin acetate (IUPAC name) (347) and triphenyltin hydroxide (IUPAC name) (347),
a nematicide selected from the group of substances consisting of 1,2-dibromo-3-chloropropane (IUPAC/Chemical Abstracts name) (1045), 1,2-dichloropropane (IUPAC/Chemical Abstracts name) (1062), 1,2-dichloropropane with 1,3-dichloropropene (IUPAC name) (1063), 1,3-dichloropropene (233), 3,4-dichlorotetrahydrothiophene 1,1-dioxide (IUPAC/Chemical Abstracts name) (1065), 3-(4-chlorophenyl)-5-methylrhodanine (IUPAC name) (980), 5-methyl-6-thioxo-1,3,5-thiadiazinan-3-ylacetic acid (IUPAC name) (1286), 6-isopentenylaminopurine (alternative name) (210), abamectin (1), acetoprole [CCN], alanycarb (15), aldicarb (16), aldoxycarb (863), AZ 60541 (compound code), benclothiaz [CCN], benomyl (62), butylpyridaben (alternative name), cadusafos (109), carbofuran (118), carbon disulfide (945), carbosulfan (119), chloropicrin (141), chlorpyrifos (145), cloethocarb (999), cytokinins (alternative name) (210), dazomet (216), DBCP (1045), DCIP (218), diamidafos (1044), dichlofenthion (1051), dicliphos (alternative name), dimethoate (262), doramectin (alternative name) [CCN], emamectin (291), emamectin benzoate (291), eprinomectin (alternative name) [CCN], ethoprophos (312), ethylene dibromide (316), fenamiphos (326), fenpyrad (alternative name), fensulfothion (1158), fosthiazate (408), fosthietan (1196), furfural (alternative name) [CCN], GY-81 (development code) (423), heterophos [CCN], iodomethane (IUPAC name) (542), isamidofos (1230), isazofos (1231), ivermectin (alternative name) [CCN], kinetin (alternative name) (210), mecarphon (1258), metam (519), metam-potassium (alternative name) (519), metam-sodium (519), methyl bromide (537), methyl isothiocyanate (543), milbemycin oxime (alternative name) [CCN], moxidectin (alternative name) [CCN], Myrothecium verrucaria composition (alternative name) (565), NC-184 (compound code), oxamyl (602), phorate (636), phosphamidon (639), phosphocarb [CCN], sebufos (alternative name), selamectin (alternative name) [CCN], spinosad (737), terbam (alternative name), terbufos (773), tetrachlorothiophene (IUPAC/Chemical Abstracts name) (1422), thiafenox (alternative name), thionazin (1434), triazophos (820), triazuron (alternative name), xylenols [CCN], YI-5302 (compound code) and zeatin (alternative name) (210),
a nitrification inhibitor selected from the group of substances consisting of potassium ethylxanthate [CCN] and nitrapyrin (580),
a plant activator selected from the group of substances consisting of acibenzolar (6), acibenzolar-5-methyl (6), probenazole (658) and Reynoutria sachalinensis extract (alternative name) (720),
a rodenticide selected from the group of substances consisting of 2-isovalerylindan-1,3-dione (IUPAC name) (1246), 4-(quinoxalin-2-ylamino)benzenesulfonamide (IUPAC name) (748), alpha-chlorohydrin [CCN], aluminium phosphide (640), antu (880), arsenous oxide (882), barium carbonate (891), bisthiosemi (912), brodifacoum (89), bromadiolone (91), bromethalin (92), calcium cyamide (444), chloralose (127), chlorophacinone (140), cholecalciferol (alternative name) (850), coumachlor (1004), coumafuryl (1005), coumatetralyl (175), crimidine (1009), difenacoum (246), difethialone (249), diphacinone (273), ergocalciferol (301), flocoumafen (357), fluoroacetamide (379), flupropadine (1183), flupropadine hydrochloride (1183), gamma-HCH (430), HCH (430), hydrogen cyamide (444), iodomethane (IUPAC name) (542), lindane (430), magnesium phosphide (IUPAC name) (640), methyl bromide (537), norbormide (1318), phosacetim (1336), phosphine (IUPAC name) (640), phosphorus [CCN], pindone (1341), potassium arsenite [CCN], pyrinuron (1371), scilliroside (1390), sodium arsenite [CCN], sodium cyamide (444), sodium fluoro-acetate (735), strychnine (745), thallium sulfate [CCN], warfarin (851) and zinc phosphide (640),
a synergist selected from the group of substances consisting of 2-(2-butoxyethoxy)ethyl piperonylate (IUPAC name) (934), 5-(1,3-benzodioxol-5-yl)-3-hexylcyclohex-2-enone (IUPAC name) (903), farnesol with nerolidol (alternative name) (324), MB-599 (development code) (498), MGK 264 (development code) (296), piperonyl butoxide (649), piprotal (1343), propyl isomer (1358), S421 (development code) (724), sesamex (1393), sesasmolin (1394) and sulfoxide (1406),
an animal repellent selected from the group of substances consisting of anthraquinone (32), chloralose (127), copper naphthenate [CCN], copper oxychloride (171), diazinon (227), dicyclopentadiene (chemical name) (1069), guazatine (422), guazatine acetates (422), methiocarb (530), pyridin-4-amine (IUPAC name) (23), thiram (804), trimethacarb (840), zinc naphthenate [CCN] and ziram (856),
a virucide selected from the group of substances consisting of imanin (alternative name) [CCN] and ribavirin (alternative name) [CCN],
and a wound protectant selected from the group of substances consisting of mercuric oxide (512), octhilinone (590) and thiophanate-methyl (802).

A very especially preferred embodiment of the subject-matter {1.1.26} of the invention is {1.1.26.2} a pesticidal composition comprising a mixture consisting of at least two substances, namely one compound (A) and at least one compound (B), as active ingredient and at least one auxiliary, wherein the compound (A) is the compound of formula (A-26) and the compound (B) is a compound selected from the group of substances consisting of abamectin (1), cyromazine (209), diafenthiuron (226), diazinon (227), emamectin benzoate (291), fenoxycarb (340), fosthiazate (408), lambda-cyhalothrin (198), lufenuron (490), methidathion (529), profenofos (662), pymetrozine (688), tefluthrin (769) and thiamethoxam (792).

The compound of formula (A-26) is known, for example, from the PCT Application WO-04/067528.

The compounds (B) are known. Where the compounds (B) are included in “The Pesticide Manual” [The Pesticide Manual—A World Compendium; Thirteenth Edition; Editor: C. D. S. Tomlin; The British Crop Protection Council], they are described therein under the entry number given in round brackets hereinabove for the particular compound (B); for example, the compound “abamectin” is described under entry number (1). Where “[CCN]” is added hereinabove to the particular compound (B), the compound (B) in question is included in the “Compendium of Pesticide Common Names”, which is accessible on the internet [A. Wood; Compendium of Pesticide Common Names, Copyright © 1995-2004]; for example, the compound “acetoprole” is described under the internet address http://www.alanwood. net/pesticides/acetoprole.html.

Most of the compounds (B) are referred to hereinabove by a so-called “common name”, the relevant “ISO common name” or another “common name” being used in individual cases. If the designation is not a “common name”, the nature of the designation used instead is given in round brackets for the particular compound (B); in that case, the IUPAC name, the IUPAC/Chemical Abstracts name, a “chemical name”, a “traditional name”, a “compound name” or a “development code” is used or, if neither one of those designations nor a “common name” is used, an “alternative name” is employed.

Where a compound (A) or a compound (B) can be present in tautomeric form, such a compound is understood hereinabove and hereinbelow also to include, where applicable, corresponding tautomeric forms, even when these are not specifically mentioned in each case.

Compounds (A) or compounds (B) having at least one basic centre are capable of forming, for example, acid addition salts, e.g. with strong inorganic acids, such as mineral acids, e.g. perchloric acid, sulfuric acid, nitric acid, nitrous acid, a phosphoric acid or a hydrohalic acid, with strong organic carboxylic acids, such as unsubstituted substituted, e.g. halo-substituted, C₁-C₄alkanecarboxylic acids, e.g. acetic acid, saturated or unsaturated dicarboxylic acids, e.g. oxalic, malonic, succinic, maleic, fumaric and phthalic acid, hydroxycarboxylic acids, e.g. ascorbic, lactic, malic, tartaric and citric acid, or benzoic acid, or with organic sulfonic acids, such as unsubstituted or substituted, e.g. halo-substituted, C₁-C₄alkane- or aryl-sulfonic acids, e.g. methane- or p-toluene-sulfonic acid. Compounds (A) or compounds (B) having at least one acid group are capable of forming, for example, salts with bases, e.g. metal salts, such as alkali metal or alkaline earth metal salts, e.g. sodium, potassium or magnesium salts, or salts with ammonia or an organic amine, such as morpholine, piperidine, pyrrolidine, a mono-, di- or tri-lower alkylamine, e.g. ethyl-, diethyl-, triethyl- or dimethyl-propyl-amine, or a mono-, di- or tri-hydroxy-lower alkylamine, e.g. mono-, di- or tri-ethanolamine. In addition, corresponding internal salts may optionally be formed. In the context of the invention, preference is given to agrochemically advantageous salts. In view of the close relationship between the compounds (A) or the compounds (B) in free form and in the form of their salts, hereinabove and hereinbelow any reference to the free compounds (A) or free compounds (B) or to their salts should be understood as including also the corresponding salts or the free compounds (A) or free compounds (B), respectively, where appropriate and expedient. The equivalent also applies to tautomers of compounds (A) or compounds (B) and to their salts.

The active ingredient mixture according to the invention [in the preferred case, where only at least one compound (B) is included in the mixture] comprises the compound (A) and the compound (B) preferably in a mixing ratio of from 100:1 to 1:6000, especially from 50:1 to 1:50, more especially in a ratio of from 20:1 to 1:20, even more especially from 10:1 to 1:10, very especially from 5:1 and 1:5, special preference being given to a ratio of from 2:1 to 1:2, and a ratio of from 4:1 to 2:1 being likewise preferred, above all in a ratio of 1:1, or 5:1, or 5:2, or 5:3, or 5:4, or 4:1, or 4:2, or 4:3, or 3:1, or 3:2, or 2:1, or 1:5, or 2:5, or 3:5, or 4:5, or 1:4, or 2:4, or 3:4, or 1:3, or 2:3, or 1:2, or 1:600, or 1:300, or 1:150, or 1:35, or 2:35, or 4:35, or 1:75, or 2:75, or 4:75, or 1:6000, or 1:3000, or 1:1500, or 1:350, or 2:350, or 4:350, or 1:750, or 2:750, or 4:750. Those mixing ratios are understood to include, on the one hand, ratios by weight and also, on other hand, molar ratios.

It has now been found, surprisingly, that the active ingredient mixture according to the invention not only brings about the additive enhancement of the spectrum of action with respect to the pests to be controlled that was in principle to be expected but achieves a synergistic effect which extends the range of action of the compound (A) and of the compound (B) in two ways. Firstly, the rates of application of the compound (A) and of the compound (B) are lowered whilst the action remains equally good. Secondly, the active ingredient mixture still achieves a high degree of pest control even where the two individual compounds have become totally ineffective in such a low application rate range. This allows, on the one hand, a substantial broadening of the spectrum of pests that can be controlled and, on the other hand, increased safety in use.

However, besides the actual synergistic action with respect to pesticidal activity, the pesticidal compositions according to the invention also have further surprising advantages which can also be described, in a wider sense, as synergistic activity. For example, pests can be controlled which cannot be controlled, or cannot be controlled with sufficient effectiveness, using an individual compound (A) or an individual compound (B). The active ingredient mixture according to the invention is also better tolerated by plants, that is to say, for example, it exhibits reduced phytotoxicity, compared to the individual compounds (A) and (B). Also, for example, insects can be controlled in their different development stages, which is not the case with some of the individual compounds (A) and (B), because those individual compounds can be used, for example, only as adulticides or only as larvicides against highly specific larval stages. Moreover, the pesticidal compositions according to the invention in some cases exhibit better behaviour during their production, for example during grinding or mixing, during their storage or during their use.

The compositions according to the invention exhibit, in the area of pest control, valuable preventive and/or curative activity with a very advantageous biocidal spectrum, even at low rates of concentration, while being well tolerated by warm-blooded organisms, fish and plants. The compositions according to the invention are effective especially against all or individual development stages of normally sensitive animal pests, but also of resistant animal pests, such as insects and representatives of the order Acarina. The insecticidal or acaricidal activity of the compositions according to the invention may manifest itself directly, i.e. in the mortality of the pests, which occurs immediately or only after some time, for example during moulting, or indirectly, for example in reduced oviposition and/or hatching rate, good activity corresponding to a mortality of at least 50 to 60%. For example, by appropriate selection of the compound (B), it is also possible to achieve in addition, for example, an algicidal, anthelmintic, avicidal, bactericidal, molluscicidal, nematicidal, plant-activating, rodenticidal or virucidal action of the compositions according to the invention.

The mentioned animal pests include, for example:

of the order Acarina, for example,

Acarus siro, Aceria sheldoni, Aculus schlechtendali, Amblyomma spp., Argas spp., Boophilus spp., Brevipalpus spp., Bryobia praetiosa, Calipitrimerus spp., Chorioptes spp., Dermanyssus gallinae, Eotetranychus carpini, Eriophyes spp., Hyalomma spp., Ixodes spp., Olygonychus pratensis, Ornithodoros spp., Panonychus spp., Phyllocoptruta oleivora, Polyphagotarsonemus latus, Psoroptes spp., Rhipicephalus spp., Rhizoglyphus spp., Sarcoptes spp., Tarsonemus spp. and Tetranychus spp.;

of the order Anoplura, for example,

Haematopinus spp., Linognathus spp., Pediculus spp., Pemphigus spp. and Phylloxera spp.;

of the order Coleoptera, for example

Agriotes spp., Anthonomus spp., Atomaria linearis, Chaetocnema tibialis, Cosmopolites spp., Curculio spp., Dermestes spp., Diabrotica spp., Epilachna spp., Eremnus spp., Leptinotarsa decemlineata, Lissorhoptrus spp., Melolontha spp., Orycaephilus spp., Otiorhynchus spp., Phlyctinus spp., Popillia spp., Psylliodes spp., Rhizopertha spp., Scarabeidae, Sitophilus spp., Sitotroga spp., Tenebrio spp., Tribolium spp. and Trogoderma spp.;

of the order Diptera, for example,

Aedes spp., Antherigona soccata, Bibio hortulanus, Calliphora erythrocephala, Ceratitis spp., Chrysomyia spp., Culex spp., Cuterebra spp., Dacus spp., Drosophila melanogaster, Fannia spp., Gastrophilus spp., Glossina spp., Hypoderma spp., Hyppobosca spp., Liriomyza spp., Lucilia spp., Melanagromyza spp., Musca spp., Oestrus spp., Orseolia spp., Oscinella frit, Pegomyia hyoscyami, Phorbia spp., Rhagoletis pomonella, Sciara spp., Stomoxys spp., Tabanus spp., Tannia spp. and Tipula spp.;

of the order Heteroptera, for example,

Cimex spp., Distantiella theobroma, Dysdercus spp., Euchistus spp., Eurygaster spp., Leptocorisa spp., Nezara spp., Piesma spp., Rhodnius spp., Sahlbergella singularis, Scotinophara spp. and Triatoma spp.;

of the order Homoptera, for example,

Aleurothrixus floccosus, Aleyrodes brassicae, Aonidiella spp., Aphididae, Aphis spp., Aspidiotus spp., Bemisia tabaci, Ceroplaster spp., Chrysomphalus aonidium, Chrysomphalus dictyospermi, Coccus hesperidum, Empoasca spp., Eriosoma lanigerum, Erythroneura spp., Gascardia spp., Laodelphax spp., Lecanium corni, Lepidosaphes spp., Macrosiphus spp., Myzus spp., Nephotettix spp., Nilaparvata spp., Parlatoria spp., Pemphigus spp., Planococcus spp., Pseudaulacaspis spp., Pseudococcus spp., Psylla spp., Pulvinaria aethiopica, Quadraspidiotus spp., Rhopalosiphum spp., Saissetia spp., Scaphoideus spp., Schizaphis spp., Sitobion spp., Trialeurodes vaporariorum, Trioza erytreae and Unaspis citri;

of the order Hymenoptera, for example,

Acromyrmex, Atta spp., Cephus spp., Diprion spp., Diprionidae, Gilpinia polytoma, Hoplocampa spp., Lasius spp., Monomorium pharaonis, Neodiprion spp., Solenopsis spp. and Vespa spp.;

of the order Isoptera, for example,

Reticulitermes spp.;

of the order Lepidoptera, for example,

Acleris spp., Adoxophyes spp., Aegeria spp., Agrotis spp., Alabama argillaceae, Amylois spp., Anticarsia gemmatalis, Archips spp., Argyrotaenia spp., Autographa spp., Busseola fusca, Cadra cautella, Carposina nipponensis, Chilo spp., Choristoneura spp., Clysia ambiguella, Cnaphalocrocis spp., Cnephasia spp., Cochylis spp., Coleophora spp., Crocidolomia binotalis, Cryptophlebia leucotreta, Cydia spp., Diatraea spp., Diparopsis castanea, Earias spp., Ephestia spp., Eucosma spp., Eupoecilia ambiguella, Euproctis spp., Euxoa spp., Grapholita spp., Hedya nubiferana, Heliothis spp., Hellula undalis, Hyphantria cunea, Keiferia lycopersicella, Leucoptera scitella, Lithocollethis spp., Lobesia botrana, Lymantria spp., Lyonetia spp., Malacosoma spp., Mamestra brassicae, Manduca sexta, Operophtera spp., Ostrinia nubilalis, Pammene spp., Pandemis spp., Panolis flammea, Pectinophora gossypiela, Phthorimaea operculella, Pieris rapae, Pieris spp., Plutella xylostella, Prays spp., Scirpophaga spp., Sesamia spp., Sparganothis spp., Spodoptera spp., Synanthedon spp., Thaumetopoea spp., Tortrix spp., Trichoplusia ni and Yponomeuta spp.;

of the order Mallophaga, for example,

Damalinea spp. and Trichodectes spp.;

of the order Orthoptera, for example,

Blatta spp., Blattella spp., Gryllotalpa spp., Leucophaea maderae, Locusta spp., Periplaneta spp. and Schistocerca spp.;

of the order Psocoptera, for example,

Liposcelis spp.;

of the order Siphonaptera, for example,

Ceratophyllus spp., Ctenocephalides spp. and Xenopsylla cheopis;

of the order Thysanoptera, for example,

Frankliniella spp., Hercinothrips spp., Scirtothrips aurantii, Taeniothrips spp., Thrips palmi and Thrips tabaci; and

of the order Thysanura, for example,

Lepisma saccharina.

Nematicidal action can be exhibited, for example, with respect to the following pests of the class Nematoda:

root knot nematodes, cyst-forming nematodes, stem nematodes or leaf nematodes;

pests of the families Filariidae or Setariidae; or

pests of the genera Ancylostoma, especially Ancylostoma caninum, Anguina, Aphelenchoides, Ascaridia, Ascaris, Bunostumum, Capillaria, Chabertia, Cooperia, Dictyocaulus, Dirofilaria, especially Dirofilaria immitis, Ditylenchus, Globodera, especially Globodera rostochiensis, Haemonchus, Heterakis, Heterodera, especially Heterodera avenae, Heterodera glycines, Heterodera schachtii or Heterodera trifolii, Longidorus, Meloidogyne, especially Meloidogyne incognita or Meloidogyne javanica, Nematodirus, Oesophagostonum, Ostertagia, Oxyuris, Parascaris, Pratylenchus, especially Pratylenchus neglectans or Pratylenchus penetrans, Radopholus, especially Radopholus similis, Strongyloides, Strongylus, Toxascaris, Toxocara, especially Toxocara canis, Trichodorus, Trichonema, Trichostrongylus, Trichuris, especially Trichuris vulpis, Tylenchulus, especially Tylenchulus semipenetrans, Uncinaria or Xiphinema.

The compositions according to the invention can be used to control, i.e. to inhibit or destroy, pests of the mentioned type occurring especially on plants, more especially on useful plants and ornamentals in agriculture, in horticulture and in forestry, or on parts of such plants, such as the fruits, blossoms, leaves, stems, tubers or roots, while in some cases parts of plants that grow later are still protected against those pests.

Target crops are especially cereals, e.g. wheat, barley, rye, oats, rice, maize and sorghum; beet, such as sugar beet and fodder beet; fruit, e.g. pomes, stone fruit and soft fruit, such as apples, pears, plums, peaches, almonds, cherries and berries, e.g. strawberries, raspberries and blackberries; leguminous plants, such as beans, lentils, peas and soybeans; oil plants, such as rape, mustard, poppy, olives, sunflowers, coconut, castor oil, cocoa and groundnuts; cucurbitaceae, such as marrows, cucumbers and melons; fibre plants, such as cotton, flax, hemp and jute; citrus fruits, such as oranges, lemons, grapefruit and mandarins; vegetables, such as spinach, lettuce, asparagus, cabbages, carrots, onions, tomatoes, potatoes and paprika; lauraceae, such as avocado, cinnamon and camphor; and tobacco, nuts, coffee, aubergines, sugar cane, tea, pepper, vines, hops, bananas, natural rubber plants and ornamentals.

The target crops may be crops of conventional plants or crops of genetically modified plants (“GM plants” or “GMOs”).

The compositions according to the invention are therefore also suitable for use in herbicide-resistant, pest-resistant and/or fungus-resistant transgenic crops of useful plants, especially cereals, cotton, soybeans, sugar beet, sugar cane, plantation crops (e.g. citrus fruits, coffee, bananas), rape, maize and rice.

Herbicide-resistant crops are to be understood as including those that have been made tolerant to herbicides or classes of herbicides (e.g. ALS-, GS-, EPSPS-, PPO- and HPPD-inhibitors) by means of conventional breeding or genetic engineering methods. An example of a crop that has been made tolerant by conventional breeding methods to, for example, imidazolinones such as imazamox is Clearfield® summer rape (canola). Examples of crops made tolerant to herbicides by genetic engineering methods are maize varieties resistant to, for example, glyphosate or glufosinate, which are commercially available under the trade names RoundupReady® and LibertyLink®, respectively.

In the context of the present invention, pest-resistant and/or fungus-resistant transgenic useful plants are expressly understood to include those useful plants which, in addition to having the pest resistance and/or fungus resistance, also have herbicide tolerance. Among the group of herbicide-tolerant useful plants preference is given, in accordance with the invention, to useful plants having tolerance with respect to glyphosate, glufosinate-ammonium, ALS (acetolactate synthase) inhibitors, such as sulfonylureas, e.g. primisulforon, prosulfuron and trifloxysulfuron, or bromoxynil, such as, for example, Bt11 maize or Herculex I® maize.

Pest-resistant transgenic crop plants are to be understood in the context of the present invention as being plants which have been so transformed by the use of recombinant DNA techniques that they are capable of synthesising one or more selectively acting toxins, such as are known, for example, from toxin-producing bacteria, especially those of the genus Bacillus.

Toxins that can be expressed by such transgenic plants include, for example, insecticidal proteins, e.g. insecticidal proteins from Bacillus cereus or Bacillus popliae; or insecticidal proteins from Bacillus thuringiensis, such as δ-endotoxins, e.g. CryIA(b), CryIA(c), CryIF, CryIF(a2), CryIIA(b), CryIIA, CryIIIB(b1) or Cry9c, or vegetative insecticidal proteins (VIP), e.g. VIP1, VIP2, VIP3 or VIP3A; or insecticidal proteins of bacteria that colonise nematodes, for example Photorhabdus spp. or Xenorhabdus spp., such as Photorhabdus luminescens, Xenorhabdus nematophilus; toxins produced by animals, such as scorpion toxins, arachnid toxins, wasp toxins and other insect-specific neurotoxins; toxins produced by fungi, such as Streptomycetes toxins; plant lectins, such as pea lectins, barley lectins or snowdrop lectins; agglutinins; proteinase inhibitors, such as trypsin inhibitors, serine protease inhibitors, patatin, cystatin, papain inhibitors; ribosome-inactivating proteins (RIP), such as ricin, maize-RIP, abrin, luffin, saporin or bryodin; steroid metabolism enzymes, such as 3-hydroxysteroidoxidase, ecdysteroid-UDP-glycosyl-transferase, cholesterol oxidases, ecdysone inhibitors, HMG-COA-reductase, ion channel blockers, such as blockers of sodium or calcium channels, juvenile hormone esterase, diuretic hormone receptors, stilbene synthase, bibenzyl synthase, chitinases and glucanases.

In the context of the present invention there are to be understood by δ-endotoxins, for example CryIA(b), CryIA(c), CryIF, CryIF(a2), CryIIA(b), CryIIA, CryIIIB(b1) or Cry9c, or vegetative insecticidal proteins (VIP), for example VIP1, VIP2, VIP3 or VIP3A, expressly also hybrid toxins, truncated toxins and modified toxins. Hybrid toxins are produced recombinantly by a new combination of different domains of those proteins (see, for example, WO 02/15701). An example of a truncated toxin is a truncated CryIA(b), which is expressed in Bt11 maize of Syngenta Seeds SAS, as described hereinbelow. In the case of modified toxins, one or more amino acids of the naturally occurring toxin is/are replaced. In such amino acid replacements, preferably non-naturally present protease recognition sequences are inserted into the toxin, such as, for example, in the case of CryIIIA055, a cathepsin-D-recognition sequence is inserted into a CryIIIA toxin (see WO 03/018810).

Examples of such toxins or transgenic plants capable of synthesising such toxins are disclosed, for example, in EP-A-0 374 753, WO 93/07278, WO 95/34656, EP-A-0 427 529, EP-A-451 878 and WO 03/052073.

The processes for the preparation of such transgenic plants are generally known to the person skilled in the art and are described, for example, in the publications mentioned above. CryI-type deoxyribonucleic acids and their preparation are known, for example, from WO 95/34656, EP-A-0 367 474, EP-A-0 401 979 and WO 90/13651.

The toxin contained in the transgenic plants provides the plants with tolerance to harmful insects. Such insects can occur in any taxonomic group of insects, but are especially commonly found in beetles (Coleoptera), two-winged insects (Diptera) and butterflies (Lepidoptera).

The following harmful insects from different taxonomic groups are especially common in maize crops:
Ostrinia nubilalis, European corn borer
Agrotis ipsilon, black cutworm
Helicoverpa zea, corn earworm
Spodoptera frugiperda, fall armyworm
Diatraea grandiosella, southwestern corn borer
Elasmopalpus lignosellus, lesser cornstalk borer
Diatraea saccharalis, sugarcane borer
Diabrotica virgifera virgifera, western corn rootworm
Diabrotica longicornis barberi, northern corn rootworm
Diabrotica undecimpunctata howardi, southern corn rootworm
Melanotus spp., wireworms
Cyclocephala borealis, northern masked chafer (white grub)
Cyclocephala immaculata, southern masked chafer (white grub)
Popillia japonica, Japanese beetle
Chaetocnema pulicaria, corn flea beetle
Sphenophorus maidis, maize billbug
Rhopalosiphum maidis, corn leaf aphid
Anuraphis maidiradicis, corn root aphid
Blissus leucopterus leucopterus, chinch bug
Melanoplus femurrubrum, red-legged grasshopper
Melanoplus sanguinipes, migratory grasshopper
Hylemya platura, seedcorn maggot
Agromyza parvicornis, corn blotch leafminer
Anaphothrips obscurus, grass thrips
Solenopsis milesta, thief ant
Tetranychus urticae, two-spotted spider mite

Transgenic plants containing one or more genes that code for an insecticidal resistance and express one or more toxins are known and some of them are commercially available. Examples of such plants are: YieldGard® (maize variety that expresses a CryIA(b) toxin); YieldGard Rootworm® (maize variety that expresses a CryIIIB(b1) toxin); YieldGard Plus® (maize variety that expresses a CryIA(b) and a CryIIIB(b1) toxin); Starlink® (maize variety that expresses a Cry9(c) toxin); Herculex I® (maize variety that expresses a CryIF(a2) toxin and the enzyme phosphinothricine N-acetyltransferase (PAT) to achieve tolerance to the herbicide glufosinate ammonium); NuCOTN 33B® (cotton variety that expresses a CryIA(c) toxin); Bollgard I® (cotton variety that expresses a CryIA(c) toxin); Bollgard II® (cotton variety that expresses a CryIA(c) and a CryIIA(b) toxin); VIPCOT® (cotton variety that expresses a VIP toxin); NewLeaf® (potato variety that expresses a CryIIIA toxin); NatureGard® and Protecta®.

Further examples of such transgenic crops are:

1. Bt11 Maize from Syngenta Seeds SAS, Chermin de L'Hobit 27, F-31 790 St. Sauveur, France, registration number C/FR/96/05/10. Genetically modified Zea mays which has been rendered resistant to attack by the European corn borer (Ostrinia nubilalis and Sesamia nonagrioides) by transgenic expression of a truncated CryIA(b) toxin. Bt11 maize also transgenically expresses the enzyme PAT to achieve tolerance to the herbicide glufosinate ammonium.

2. Bt176 Maize from Syngenta Seeds SAS, Chermin de L'Hobit 27, F-31 790 St. Sauveur, France, registration number C/FR/96/05/10. Genetically modified Zea mays which has been rendered resistant to attack by the European corn borer (Ostrinia nubilalis and Sesamia nonagrioides) by transgenic expression of a CryIA(b) toxin. Bt176 maize also transgenically expresses the enzyme PAT to achieve tolerance to the herbicide glufosinate ammonium.

3. MIR604 Maize from Syngenta Seeds SAS, Chermin de L'Hobit 27, F-31 790 St. Sauveur, France, registration number C/FR/96/05/10. Maize which has been rendered insect-resistant by transgenic expression of a modified CryIIIA toxin. This toxin is Cry3A055 modified by insertion of a cathepsin-D-protease recognition sequence. The preparation of such transgenic maize plants is described in WO 03/018810.

4. MON 863 Maize from Monsanto Europe S.A. 270-272 Avenue de Tervuren, B-1150 Brussels, Belgium, registration number C/DE/02/9. MON 863 expresses a CryIIIB(b1) toxin and has resistance to certain Coleoptera insects.

5. IPC 531 Cotton from Monsanto Europe S.A. 270-272 Avenue de Tervuren, B-1150 Brussels, Belgium, registration number C/ES/96/02.

6. 1507 Maize from Pioneer Overseas Corporation, Avenue Tedesco, 7 B-1160 Brussels, Belgium, registration number C/NL/00/10. Genetically modified maize for the expression of the protein Cry1F for achieving resistance to certain Lepidoptera insects and of the PAT protein for achieving tolerance to the herbicide glufosinate ammonium.

7. NK603×MON 810 Maize from Monsanto Europe S.A. 270-272 Avenue de Tervuren, B-1150 Brussels, Belgium, registration number C/GB/02/M3/03. Consists of conventionally bred hybrid maize varieties by crossing the genetically modified varieties NK603 and MON 810. NK603×MON 810 Maize transgenically expresses the protein CP4 EPSPS, obtained from Agrobacterium sp. strain CP4, which imparts tolerance to the herbicide Roundup® (contains glyphosate), and also a CryIA(b) toxin obtained from Bacillus thuringiensis subsp. kurstaki which brings about tolerance to certain Lepidoptera, including the European corn borer.

Transgenic crops of insect-resistant plants are also described in BATS (Zentrum für Biosicherheit und Nachhaltigkeit, Zentrum BATS, Clarastrasse 13, 4058 Basel, Switzerland) Report 2003, (http://bats.ch).

In the context of the present invention, fungus-resistant transgenic crop plants are to be understood as being those which have been so transformed by the use of recombinant DNA techniques that they are capable of synthesising antipathogenic substances having a selective action, such as, for example, the so-called “pathogenesis-related proteins” (PRPs, see e.g. EP-A-0 392 225). Examples of such antipathogenic substances and transgenic plants capable of synthesising such antipathogenic substances are known, for example, from EP-A-0 392 225, WO 95/33818 and EP-A-0 353 191. The methods of producing such transgenic plants are generally known to the person skilled in the art and are described, for example, in the publications mentioned above.

Antipathogenic substances which can be expressed by such transgenic plants include, for example, ion channel blockers, such as blockers for sodium and calcium channels, for example the viral KP1, KP4 or KP6 toxins; stilbene synthases; bibenzyl synthases; chitinases; glucanases; the so-called “pathogenesis-related proteins” (PRPs; see e.g. EP-A-0 392 225); antipathogenic substances produced by microorganisms, for example peptide antibiotics or heterocyclic antibiotics (see e.g. WO 95/33818) or protein or polypeptide factors involved in plant pathogen defence (so-called “plant disease resistance genes”, as described in WO 03/000906).

Further areas of use of the compositions according to the invention are the protection of stored goods and storerooms and the protection of raw materials, such as wood, textiles, floor coverings or buildings, and also in the hygiene sector, especially the protection of humans, domestic animals and productive livestock against pests of the mentioned type.

In the hygiene sector, the compositions according to the invention are active against ectoparasites such as hard ticks, soft ticks, mange mites, harvest mites, flies (biting and licking), parasitic fly larvae, lice, hair lice, bird lice and fleas.

Examples of such parasites are:

Of the order Anoplurida: Haematopinus spp., Linognathus spp., Pediculus spp. and Phtirus spp., Solenopotes spp.

Of the order Mallophagida: Trimenopon spp., Menopon spp., Trinoton spp., Bovicola spp., Werneckiella spp., Lepikentron spp., Damalina spp., Trichodectes spp. and Felicola spp. Of the order Diptera and the suborders Nematocerina and Brachycerina, for example Aedes spp., Anopheles spp., Culex spp., Simulium spp., Eusimulium spp., Phlebotomus spp., Lutzomyia spp., Culicoides spp., Chrysops spp., Hybomitra spp., Atylotus spp., Tabanus spp., Haematopota spp., Philipomyia spp., Braula spp., Musca spp., Hydrotaea spp., Stomoxys spp., Haematobia spp., Morellia spp., Fannia spp., Glossina spp., Calliphora spp., Lucilia spp., Chrysomyia spp., Wohifahrtia spp., Sarcophaga spp., Oestrus spp., Hypoderma spp., Gasterophilus spp., Hippobosca spp., Lipoptena spp. and Melophagus spp. Of the order Siphonapterida, for example Pulex spp., Ctenocephalides spp., Xenopsylla spp., Ceratophyllus spp.

Of the order Heteropterida, for example Cimex spp., Triatoma spp., Rhodnius spp., Panstrongylus spp.

Of the order Blattarida, for example Blatta orientalis, Periplaneta americana, Blattelagermanica and Supella spp.

Of the subclass Acaria (Acarida) and the orders Meta- and Meso-stigmata, for example Argas spp., Ornithodorus spp., Otobius spp., Ixodes spp., Amblyomma spp., Boophilus spp., Dermacentor spp., Haemophysalis spp., Hyalomma spp., Rhipicephalus spp., Dermanyssus spp., Raillietia spp., Pneumonyssus spp., Sternostoma spp. and Varroa spp.

Of the orders Actinedida (Prostigmata) and Acaridida (Astigmata), for example Acarapis spp., Cheyletiella spp., Ornithocheyletia spp., Myobia spp., Psorergates spp., Demodex spp., Trombicula spp., Listrophorus spp., Acarus spp., Tyrophagus spp., Caloglyphus spp., Hypodectes spp., Pterolichus spp., Psoroptes spp., Chorioptes spp., Otodectes spp., Sarcoptes spp., Notoedres spp., Knemidocoptes spp., Cytodites spp. and Laminosioptes spp.

The compositions according to the invention are also suitable for protecting against insect infestation in the case of materials such as wood, textiles, plastics, adhesives, glues, paints, paper and card, leather, floor coverings and buildings.

The compositions according to the invention can be used, for example, against the following pests: beetles such as Hylotrupes bajulus, Chlorophorus pilosis, Anobium punctatum, Xestobium rufovillosum, Ptilinuspecticornis, Dendrobium pertinex, Ernobius mollis, Priobium carpini, Lyctus brunneus, Lyctus africanus, Lyctus planicollis, Lyctus linearis, Lyctus pubescens, Trogoxylon aequale, Minthesrugicollis, Xyleborus spec., Tryptodendron spec., Apate monachus, Bostrychus capucins, Heterobostrychus brunneus, Sinoxylon spec. and Dinoderus minutus, and also hymenopterans such as Sirex juvencus, Urocerus gigas, Urocerus gigas taignus and Urocerus augur, and termites such as Kalotermes flavicollis, Cryptotermes brevis, Heterotermes indicola, Reticulitermes flavipes, Reticulitermes santonensis, Reticulitermes lucifugus, Mastotermes darwiniensis, Zootermopsis nevadensis and Coptotermes formosanus, and bristletails such as Lepisma saccharina.

The pesticidal compositions according to the invention are, for example, emulsifiable concentrates, suspension concentrates, directly sprayable or dilutable solutions, coatable pastes, dilute emulsions, powders for application in sprays, soluble powders, dispersible powders, wettable powders, dusts, granules or encapsulations in polymer substances, comprising one of the active ingredient mixtures according to the invention, the type of formulation being chosen in accordance with the intended objectives and prevailing circumstances.

The active ingredient mixture is used in those compositions in pure form, a solid active ingredient mixture, for example, in a specific particle size, or preferably together with—at least—one of the auxiliaries customary in formulation technology, such as extenders, for example solvents or solid carriers, or surface-active compounds (surfactants).

Suitable solvents are, for example: optionally partially hydrogenated aromatic hydrocarbons, preferably the fractions of alkylbenzenes containing 8 to 12 carbon atoms, such as xylene mixtures, alkylated naphthalenes or tetrahydronaphthalene, aliphatic or cycloaliphatic hydrocarbons, such as paraffins or cyclohexane, alcohols, such as ethanol, propanol or butanol, glycols and their ethers and esters, such as propylene glycol, dipropylene glycol ether, ethylene glycol or ethylene glycol monomethyl or monoethyl ether, ketones, such as cyclohexanone, isophorone or diacetone alcohol, strongly polar solvents, such as N-methyl-pyrrolid-2-one, dimethyl sulfoxide or N,N-dimethylformamide, water, vegetable oils or epoxidised vegetable oils, such as rapeseed oil, castor oil, coconut oil or soybean oil or epoxidised rapeseed oil, castor oil, coconut oil or soybean oil, and silicone oils.

The solid carriers used, e.g. for dusts and dispersible powders, are normally natural mineral fillers such as calcite, talcum, kaolin, montmorillonite or attapulgite. In order to improve the physical properties it is also possible to add highly dispersed silicic acids or highly dispersed absorbent polymers. Suitable granulated adsorptive carriers are porous types, such as pumice, broken brick, sepiolite or bentonite; and suitable nonsorbent carriers are calcite or sand. In addition, a great number of granulated materials of inorganic or organic nature can be used, especially dolomite or pulverised plant residues.

Depending on the nature of the active ingredient mixture to be formulated, suitable surface-active compounds are non-ionic, cationic and/or anionic surfactants or mixtures of surfactants having good emulsifying, dispersing and wetting properties. The surfactants listed below are to be regarded merely as examples; many more surfactants customarily employed in formulation technology and suitable for use according to the invention are described in the relevant literature.

Non-ionic surfactants are preferably polyglycol ether derivatives of aliphatic or cycloaliphatic alcohols, saturated or unsaturated fatty acids or alkylphenols, said derivatives containing about 3 to about 30 glycol ether groups and about 8 to about 20 carbon atoms in the (cyclo)aliphatic hydrocarbon moiety and about 6 to about 18 carbon atoms in the alkyl moiety of the alkylphenols. Further suitable non-ionic surfactants are water-soluble adducts of polyethylene oxide with polypropylene glycol, ethylenediaminopolypropylene glycol and alkylpolypropylene glycol containing 1 to about 10 carbon atoms in the alkyl chain, which adducts contain about 20 to about 250 ethylene glycol ether groups and about 10 to about 100 propylene glycol ether groups. These compounds usually contain 1 to about 5 ethylene glycol units per propylene glycol unit. Examples of non-ionic surfactants are nonylphenol polyethoxyethanol, castor oil polyglycol ethers, polypropylene/polyethylene oxide adducts, tributylphenoxypolyethoxyethanol, polyethylene glycol and octylphenoxypolyethoxyethanol. Fatty acid esters of polyoxyethylene sorbitan, e.g. polyoxyethylene sorbitan trioleate, are also suitable non-ionic surfactants.

Cationic surfactants are preferably quaternary ammonium salts which generally contain, as substituent, at least one C₈-C₂₂alkyl radical and, as further substituents, (unsubstituted or halogenated) lower alkyl or hydroxy-lower alkyl or benzyl radicals. The salts are preferably in the form of halides, methyl sulfates or ethyl sulfates. Examples are stearyltrimethylammonium chloride and benzyl bis(2-chloroethyl)ethylammonium bromide.

Suitable anionic surfactants are, for example, water-soluble soaps and water-soluble synthetic surface-active compounds. Suitable soaps are, for example, the alkali metal salts, alkaline earth metal salts or (unsubstituted or substituted) ammonium salts of fatty acids containing about 10 to about 22 carbon atoms, e.g. the sodium or potassium salts of oleic or stearic acid or of natural fatty acid mixtures which can be obtained e.g. from coconut oil or tall oil; mention may also be made of fatty acid methyltaurin salts. More frequently, however, synthetic surfactants are used, especially fatty sulfonates, fatty sulfates, sulfonated benzimidazole derivatives or alkylarylsulfonates. The fatty sulfonates and fatty sulfates are usually in the form of alkali metal salts, alkaline earth metal salts or (unsubstituted or substituted) ammonium salts and generally contain an alkyl radical containing about 8 to about 22 carbon atoms, which also includes the alkyl moiety of acyl radicals; there may be mentioned by way of example the sodium or calcium salts of lignosulfonic acid, of dodecyl sulfate or of a mixture of fatty alcohol sulfates obtained from natural fatty acids. These compounds also comprise the salts of sulfated and sulfonated fatty alcohol/ethylene oxide adducts. The sulfonated benzimidazole derivatives preferably contain 2 sulfonic acid groups and one fatty acid radical containing about 8 to about 22 carbon atoms. Examples of alkylarylsulfonates are the sodium, calcium or triethanolammonium salts of dodecylbenzenesulfonic acid, dibutylnaphthalenesulfonic acid or of a condensate of naphthalenesulfonic acid and formaldehyde. Also suitable are corresponding phosphates, e.g. salts of the phosphoric acid ester of an adduct of p-nonylphenol with 4 to 14 mol of ethylene oxide, or phospholipids.

The compositions according to the invention usually comprise 0.1 to 99%, especially 0.1 to 95%, of an active ingredient mixture according to the invention and 1 to 99.9%, especially 5 to 99.9%, of—at least—one solid or liquid auxiliary, it generally being possible for 0 to 25%, preferably 0.1 to 20%, of the composition to be surfactants (in each case percentages are by weight). Whereas commercial products in the form of concentrates will usually be preferred, the end user will normally employ dilute formulations, which have considerably lower active ingredient concentrations.

Preferred formulations have especially the following compositions (%=percent by weight):

Emulsifiable Concentrates:

| | |
|---|---|
| active ingredient mixture: | 1 to 90%, preferably 5 to 20% |
| surfactant: | 1 to 30%, preferably 10 to 20% |
| solvent: | 5 to 98%, preferably 70 to 85% |

Dusts:

| | |
|---|---|
| active ingredient mixture: | 0.1 to 10%, preferably 0.1 to 1% |
| solid carrier: | 99.9 to 90%, preferably 99.9 to 99% |

Suspension Concentrates:

| | |
|---|---|
| active ingredient mixture: | 5 to 75%, preferably 10 to 50% |
| water: | 94 to 24%, preferably 88 to 30% |
| surfactant: | 1 to 40%, preferably 2 to 30% |

Wettable Powders:

| | |
|---|---|
| active ingredient mixture: | 0.5 to 90%, preferably 1 to 80% |
| surfactant: | 0.5 to 20%, preferably 1 to 15% |
| solid carrier: | 5 to 99%, preferably 15 to 98% |

Granules:

| | |
|---|---|
| active ingredient mixture: | 0.5 to 30%, preferably 3 to 15% |
| solid carrier: | 99.5 to 70%, preferably 97 to 85% |

The compositions according to the invention may also comprise further solid or liquid auxiliaries, such as stabilisers, e.g. vegetable oils or epoxidised vegetable oils (e.g. epoxidised coconut oil, rapeseed oil or soybean oil), antifoams, e.g. silicone oil, preservatives, viscosity regulators, binders, tackifiers or fertilisers.

The compositions according to the invention are prepared in a manner known per se, in the absence of auxiliaries, for example by grinding, sieving and/or compressing a solid active ingredient mixture, and in the presence of at least one auxiliary, for example by intimately mixing and/or grinding the active ingredient mixture with the auxiliary/auxiliaries. The invention relates also to those processes for the preparation of the compositions and to the use of the compounds (A) and compounds (B) in the preparation of those compositions.

The invention relates also to the methods of application of the compositions, i.e. the methods of controlling pests of the mentioned type, such as spraying, atomising, dusting, coating, dressing, scattering or pouring, which are selected in accordance with the intended objectives and prevailing circumstances, and to the use of the compositions for controlling pests of the mentioned type. Typical rates of concentration are from 0.1 to 1000 ppm, preferably from 0.1 to 500 ppm, of active ingredient mixture. The rates of application per hectare are generally from 1 to 2000 g of active ingredient mixture per hectare, especially from 10 to 1000 g/ha, preferably from 20 to 600 g/ha. The rate of application may vary within wide limits and depends on the nature of the soil, the method of application (foliar application; seed dressing; application to the seed furrow), the crop plant, the pest to be controlled, the prevailing climatic conditions, and other factors governed by the method of application, the time of application and the target crop.

A preferred method of application in the area of crop protection is application to the foliage of the plants (foliar application), the number of applications and the rate of application depending on the risk of infestation by the pest in question. However, the active ingredient mixture can also penetrate the plants through the roots (systemic action) if the locus of the plants is impregnated with a liquid formulation or if the active ingredient mixture is incorporated in solid form into the locus of the plants, for example into the soil, e.g. in granular form (soil application). In paddy rice crops, such granules may be applied in metered amounts to the flooded rice field.

The compositions according to the invention are also suitable for protecting plant propagation material, e.g. seed material, such as fruit, tubers or grains, or plant seedlings, from pests of the mentioned type. The propagation material can be treated with the compositions before planting: seed material, for example, can be dressed before being sown. The compositions can also be applied to seed grains (coating), either by impregnating the grains with a liquid composition or by coating them with a solid composition. The compositions can also be applied to the planting site when the propagation material is being planted, for example to the seed furrow during sowing. The invention relates also to those methods of treating plant propagation material and to the plant propagation material thus treated.

The following Examples are intended to illustrate the invention. They do not limit the invention. Temperatures are given in degrees Celsius.

### FORMULATION EXAMPLES

### %=Percent by Weight; Active Ingredient Ratios=Ratios by Weight

EXAMPLE F1
Emulsifiable concentrates

| | a) | b) | c) |
|---|---|---|---|
| active ingredient mixture [compound (A): | 25% | 40% | 50% |
| compound (B) = 1:3] | | | |
| calcium dodecylbenzenesulfonate | 5% | 8% | 6% |
| castor oil polyethylene glycol ether | 5% | — | — |
| (36 mol of ethylene oxide) | | | |
| tributylphenoxypolyethylene glycol ether | — | 12% | 4% |
| (30 mol of ethylene oxide) | | | |
| cyclohexanone | — | 15% | 20% |
| xylene mixture | 65% | 25% | 20% |

Emulsions of any desired concentration can be prepared from such concentrates by dilution with water.

EXAMPLE F2
Solutions

| | a) | b) | c) | d) |
|---|---|---|---|---|
| active ingredient mixture [compound (A): | 80% | 10% | 5% | 95% |
| compound (B) = 1:10] | | | | |
| ethylene glycol monomethyl ether | 20% | — | — | — |
| polyethylene glycol (mol. wt. 400) | — | 70% | — | — |
| N-methylpyrrolid-2-one | — | 20% | — | — |
| epoxidised coconut oil | — | — | 1% | 5% |
| benzine (boiling range: 160-190°) | — | — | 94% | — |

The solutions are suitable for application in the form of micro-drops.

EXAMPLE F3
Granules

| | a) | b) | c) | d) |
|---|---|---|---|---|
| active ingredient mixture [compound (A): | 5% | 10% | 8% | 21% |
| compound (B) = 2:1] | | | | |
| kaolin | 94% | — | 79% | 54% |
| highly dispersed silicic acid | 1% | — | 13% | 7% |
| attapulgite | — | 90% | — | 18% |

The active ingredient mixture is dissolved in dichloromethane, the solution is sprayed onto the carrier, and the solvent is subsequently evaporated off in vacuo.

EXAMPLE F4
Dusts

| | a) | b) |
|---|---|---|
| active ingredient mixture [compound (A): | 2% | 5% |
| compound (B) = 1:1] | | |
| highly dispersed silicic acid | 1% | 5% |
| talcum | 97% | — |
| kaolin | — | 90% |

Ready-to-use dusts are obtained by intimately mixing the carriers with the active ingredient mixture.

EXAMPLE F5
Wettable powders

| | a) | b) | c) |
|---|---|---|---|
| active ingredient mixture [compound (A): | 25% | 50% | 75% |
| compound (B) = 1:7.5] | | | |
| sodium lignosulfonate | 5% | 5% | — |
| sodium lauryl sulfate | 3% | — | 5% |
| sodium diisobutylnaphthalenesulfonate | — | 6% | 10% |
| octylphenoxypolyethylene glycol ether | — | 2% | — |
| (7-8 mol of ethylene oxide) | | | |
| highly dispersed silicic acid | 5% | 10% | 10% |
| kaolin | 62% | 27% | — |

The active ingredient mixture is mixed with the additives and the mixture is thoroughly ground in a suitable mill, affording wettable powders which can be diluted with water to give suspensions of any desired concentration.

### EXAMPLE F6

### Extruder Granules

| | |
|---|---|
| active ingredient mixture [compound (A):compound (B) = 1:4] | 10% |
| sodium lignosulfonate | 2% |
| carboxymethylcellulose | 1% |
| kaolin | 87% |

The active ingredient mixture is mixed with the additives, and the mixture is ground, moistened with water, extruded and granulated and the granules are dried in a stream of air.

### EXAMPLE F7

### Coated Granules

| | |
|---|---|
| active ingredient mixture [compound (A):compound (B) = 1:2] | 3% |
| polyethylene glycol (mol. wt. 200) | 3% |
| kaolin | 94% |

The finely ground active ingredient mixture is uniformly applied, in a mixer, to the kaolin moistened with polyethylene glycol, yielding non-dusty coated granules.

### EXAMPLE F8

### Suspension Concentrate

| | |
|---|---|
| active ingredient mixture [compound (A):compound (B) = 2:7] | 40% |
| ethylene glycol | 10% |
| nonylphenoxypolyethylene glycol ether | 6% |
| (15 mol of ethylene oxide) | |
| sodium lignosulfonate | 10% |
| carboxymethylcellulose | 1% |
| 37% aqueous formaldehyde solution | 0.2% |
| silicone oil (75% aqueous emulsion) | 0.8% |
| water | 32% |

The finely ground active ingredient mixture is intimately mixed with the additives, giving a suspension concentrate from which suspensions of any desired concentration can be obtained by dilution with water.

It is often more practical for the compound (A) and the compound (B) to be formulated separately and for those formulations then to be brought together in the desired mixing ratio in the applicator in the form of a “tank mixture” in the desired amount of water shortly before application.

### BIOLOGICAL EXAMPLES

### %=Percent by Weight Unless Otherwise Specified

A synergistic effect exists whenever the action We of the active ingredient mixture of a compound (A) and a compound (B) is greater than the sum of the actions of the compound (A) applied alone and the compound (B) applied alone:
We>X+Y

The action to be expected We for a given active ingredient mixture comprising one compound (A) and at least one compound (B) can, however, also be calculated as follows (cf. COLBY, S. R., “Calculating synergistic and antagonistic response of herbicide combinations”, Weeds 15, pages 20-22, 1967):

$$We = X + \frac{Y ( 100 - X )}{100}$$

wherein:

X=percentage mortality on treatment with the compound (A) at a rate of application of p kg per hectare, compared with the untreated control (=0%).

Y=percentage mortality on treatment with the compound (B) at a rate of application of q kg per hectare, compared with the untreated control.

We=expected action (percentage mortality compared with the untreated control) on treatment with the compound (A) and with the compound (B) at a rate of application of p+q kg per hectare.

When the action actually observed is greater than the value to be expected We, there is a synergistic effect.

### EXAMPLE B1

### Action Against Aphis craccivora

Pea seedlings are infested with Aphis craccivora, subsequently sprayed with a spray mixture comprising 400 ppm of active ingredient mixture and then incubated at 20°. Evaluation is made 3 and 6 days later. The percentage reduction in population (% activity) is determined by comparing the number of dead aphids on the treated plants with that on untreated plants. Active ingredient mixtures according to the invention exhibit good activity in this test.

### EXAMPLE B2

### Action Against Diabrotica balteata

Maize seedlings are sprayed with an aqueous emulsion spray mixture comprising 400 ppm of active ingredient mixture. After the spray-coating has dried, the maize seedlings are populated with 10 Diabrotica balteata larvae (in the second stage) and then placed in a plastics container. The evaluation is made 6 days later. The percentage reduction in population (% activity) is determined by comparing the number of dead larvae on the treated plants with that on untreated plants.

Active ingredient mixtures according to the invention exhibit good activity in this test.

### EXAMPLE B3

### Action Against Heliothis virescens (Foliar Application)

Young soybean plants are sprayed with an aqueous emulsion spray mixture comprising 400 ppm of active ingredient mixture. After the spray-coating has dried, the plants are populated with 10 Heliothis virescens caterpillars (in the first stage) and then placed in a plastics container. Evaluation is made 6 days later. The percentage reduction in population and the percentage reduction in feeding damage (% activity) are determined by comparing the treated plants and untreated plants in respect of the number of dead caterpillars and the feeding damage.

Active ingredient mixtures according to the invention exhibit good activity in this test.

### EXAMPLE B4

### Action Against Heliothis virescens (Application to Eggs)

Heliothis virescens eggs deposited on cotton are sprayed with an aqueous emulsion spray mixture comprising 400 ppm of active ingredient mixture. After 8 days, the percentage hatching rate from the eggs and the survival rate of the caterpillars are evaluated (% reduction in population) by comparison with untreated control batches.

Active ingredient mixtures according to the invention exhibit good activity in this test.

### EXAMPLE B5

### Action Against Myzus persicae (Foliar Application)

Pea seedlings are infested with Myzus persicae, subsequently sprayed with a spray mixture comprising 400 ppm of active ingredient mixture and then incubated at 200. Evaluation is made 3 and 6 days later. The percentage reduction in population (% activity) is determined by comparing the number of dead aphids on the treated plants with that on untreated plants.

Active ingredient mixtures according to the invention exhibit good activity in this test.

### EXAMPLE B6

### Action Against Myzus persicae (Systemic Application)

Pea seedlings are infested with Myzus persicae; the roots are subsequently placed in a spray mixture comprising 400 ppm of active ingredient mixture and the seedlings are then incubated at 200. Evaluation is made 3 and 6 days later. The percentage reduction in population (% activity) is determined by comparing the number of dead aphids on the treated plants with that on untreated plants.

Active ingredient mixtures according to the invention exhibit good activity in this test.

### EXAMPLE B7

### Action Against Plutella xylostella Caterpillars

Young cabbage plants are sprayed with an aqueous emulsion spray mixture comprising 400 ppm of active ingredient mixture. After the spray-coating has dried, the plants are populated with 10 Plutella xylostella caterpillars (in the third stage) and then placed in a plastics container. Evaluation is made 3 days later. The percentage reduction in population and the percentage reduction in feeding damage (% activity) are determined by comparing the treated plants and untreated plants in respect of the number of dead caterpillars and the feeding damage.

Active ingredient mixtures according to the invention exhibit good activity in this test.

### EXAMPLE B8

### Action Against Spodoptera littoralis Caterpillars

Young soybean plants are sprayed with an aqueous emulsion spray mixture comprising 400 ppm of active ingredient mixture. After the spray-coating has dried, the plants are populated with 10 Spodoptera littoralis caterpillars (in the third stage) and then placed in a plastics container. Evaluation is made 3 days later. The percentage reduction in population and the percentage reduction in feeding damage (% activity) are determined by comparing the treated plants and untreated plants in respect of the number of dead caterpillars and the feeding damage.

Active ingredient mixtures according to the invention exhibit good activity in this test.

1-9. (canceled)

10. A pesticidal composition comprising a mixture consisting of at least two substances, namely one compound (A) and at least one compound (B), as active ingredient and at least one auxiliary, wherein the compound (A) is the compound of formula (A-10) 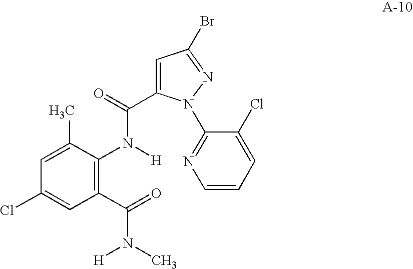
and the compound (B) is a compound selected from the group of substances consisting of an adjuvant, an acaricide, an algicide, an anthelmintic, an avicide, a bactericide, a biological agent, a soil sterilant, a chemosterilant, an insect pheromone, an insect repellant, an insecticide, a molluscicide, a nematicide, a nitrification inhibitor, a plant activator, a rodenticide, a synergist, an animal repellant, a virucide and a wound protectant.

11.-26. (canceled)

27. A composition according to claim 10 in which the compound (B) is an insecticide.

28. A composition according to claim 27 in which the compound (B) is selected from the group of substances consisting of abamectin, cyromazine, diafenthiuron, diazinon, emamectin benzoate, fenoxycarb, fosthiazate, lambda-cyhalothrin, lufenuron, methadithion, profenofos, pymetrozine, tefluthrin and thiamethoxam.

29. A composition according to claim 28 in which the compound (B) is selected from the group of substances consisting of abamectin, emamectin benzoate, lambda-cyhalothrin, tefluthrin and thiamethoxam.

30. A composition according to claim 10 in which the mixture comprises the compound (A) and the compound (B) in a mixing ratio of from 1:50 to 50:1.

31. A method of controlling pests which comprises applying an effective amount of a composition according to claim 10.

32. A method according to claim 31 in which the composition is applied by foliar application.

33. A method according to claim 31 in which the composition is applied to soil.

34. A method according to claim 31 in which the composition is applied to flooded rice field.

35. A method according to claim 31 in which the composition is applied to plant prorogation material.

36. A method according to claim 35 in which the plant prorogation material is seed.
